(19) United States
(12) Patent Application Publication
(10) Pub. No.: US 2022/0126864 A1
(43) Pub. Date: Apr. 28, 2022

(54) AUTONOMOUS VEHICLE SYSTEM

(71) Applicant: Intel Corporation, Santa Clara, CA (US)

(72) Inventors: Hassnaa Moustafa, Portland, OR (US); Darshana D. Salvi, Foster City, CA (US); Suhel Jaber, San Jose, CA (US); Darshan Iyer, Santa Clara, CA (US); Mehrnaz Khodam Hazrati, San Jose, CA (US); Pragya Agrawal, San Jose, CA (US); Naveen Aerrabotu, Fremont, CA (US); Petrus J. Van Beek, Fremont, CA (US); Monica Lucia Martinez-Canales, Los Altos, CA (US); Patricia Ann Robb, Prairie Grove, IL (US); Rita Chattopadhyay, Chandler, AZ (US); Jeffrey M. Ota, Morgan Hill, CA (US); Iman Saleh Moustafa, Mountain View, CA (US); Soila P. Kavulya, Hillsboro, OR (US); Karthik Reddy Sripathi, San Jose, CA (US); Mohamed Eltabakh, Nuremberg (DE); Igor Tatourian, Fountain Hills, AZ (US); Cynthia E. Kaschub, San Francisco, CA (US); Rita H. Wouhaybi, Portland, OR (US); Ignacio J. Alvarez, Portland, OR (US); Fatema S. Adenwala, Hillsboro, OR (US); Cagri C. Tanriover, Bethany, OR (US); Maria S. Elli, Hillsboro, OR (US); David J. Zage, Livermore, CA (US); Jithin Sankar Sankaran Kutty, Fremont, CA (US); Christopher E. Lopez-Araiza, San Jose, CA (US); Magdiel F. Galán-Oliveras, Gilbert, AZ (US); Li Chen, Hillsboro, OR (US); Bahareh Sadeghi, Portland, OR (US); Subramanian Anandaraj, Chandler, AZ (US); Pradeep Sakhamoori, Chandler, AZ (US)

(73) Assignee: Intel Corporation, Santa Clara, CA (US)

(21) Appl. No.: 17/434,710

(22) PCT Filed: Mar. 27, 2020
(86) PCT No.: PCT/US2020/025404

§ 371 Date: Aug. 27, 2021

Related U.S. Application Data
(60) Provisional application No. 62/826,955, filed on Mar. 29, 2019.

(51) Int. Cl. B60W 60/00; B60W 40/09; B60W 50/16; H04W 4/40; G06N 20/00

(52) U.S. Cl. CPC B60W 60/0013; B60W 40/09; B60W 2050/0083; H04W 4/40; G06N 20/00; B60W 50/16

(57) ABSTRACT

Sensor data is received from a plurality of sensors, where the plurality of sensors includes a first set of sensors and a second set of sensors, and at least a portion of the plurality of sensors are coupled to a vehicle. Control of the vehicle is automated based on at least a portion of the sensor data generated by the first set of sensors. Passenger attributes of one or more passengers within the autonomous vehicles are determined from sensor data generated by the second set of sensors. Attributes of the vehicle are modified based on the passenger attributes and the sensor data generated by the first set of sensors.

### CROSS-REFERENCE TO RELATED APPLICATIONS

This application claims the benefit of and priority from U.S. Provisional Patent Application No. 62/826,955 entitled “Autonomous Vehicle System” and filed Mar. 29, 2019, the entire disclosure of which is incorporated herein by reference.

### TECHNICAL FIELD

This disclosure relates in general to the field of computer systems and, more particularly, to computing systems enabling autonomous vehicles.

### BACKGROUND

Some vehicles are configured to operate in an autonomous mode in which the vehicle navigates through an environment with little or no input from a driver. Such a vehicle typically includes one or more sensors that are configured to sense information about the environment. The vehicle may use the sensed information to navigate through the environment. For example, if the sensors sense that the vehicle is approaching an obstacle, the vehicle may navigate around the obstacle.

### BRIEF DESCRIPTION OF THE DRAWINGS

FIG. 1 is a simplified illustration showing an example autonomous driving environment.

FIG. 2 is a simplified block diagram illustrating an example implementation of a vehicle (and corresponding in-vehicle computing system) equipped with autonomous driving functionality.

FIG. 3 illustrates an example portion of a neural network in accordance with certain embodiments.

FIG. 4 is a simplified block diagram illustrating example levels of autonomous driving, which may be supported in various vehicles (e.g., by their corresponding in-vehicle computing systems.

FIG. 5 is a simplified block diagram illustrating an example autonomous driving flow which may be implemented in some autonomous driving systems.

FIG. 6 is a simplified block diagram illustrating example modules provided in hardware and/or software of an autonomous vehicle to implement an autonomous driving pipeline.

FIG. 7 is a simplified block diagram illustrating a logical representation of an example recommendation system.

FIG. 8 is a simplified block diagram depicting an example lower level autonomous vehicle with various enhancement modes.

FIG. 9 is a simplified block diagram illustrating an example driving environment.

FIG. 10 is simplified block diagram illustrating an example enhanced autonomous driving system.

FIG. 11 is simplified block diagram illustrating an example frame transcoder.

FIG. 12 illustrates a representation of an example event detection machine learning model.

FIG. 13 illustrates a representation of an example scene classification machine learning model.

FIG. 14 illustrates aspects of an example autonomous driving system with a recommender system.

FIG. 15 is a simplified block diagram illustrating an autonomous vehicle and a variety of sensors in accordance with certain embodiments.

FIG. 16 is a simplified block diagram illustrating communication between systems during the delivery of an example remote valet service in accordance with certain embodiments.

FIG. 17 is a simplified block diagram illustrating cooperative reporting of information relating to pull-over event risk and road condition warnings which may be leveraged to launch remote valet services in accordance with certain embodiments.

FIG. 18 is a simplified block diagram illustrating example autonomous vehicle features including vehicle sensors, an artificial intelligence/machine learning-based autonomous driving stack, and logic to support triggering and generating handoff requests to systems capable of providing a remote valet service in accordance with certain embodiments.

FIG. 19 is a simplified block diagram illustrating an example sense, plan, act model for controlling autonomous vehicles in at least some embodiments.

FIG. 20 illustrates a simplified social norm understanding model in accordance with at least one embodiment.

FIG. 21 shows diagrams illustrating aspects of coordination between vehicles in an environment.

FIG. 22 is a block diagram illustrating example information exchange between two vehicles.

FIG. 23 is a simplified block diagram illustrating an example road intersection.

FIG. 24 illustrates an example of localized behavioral model consensus.

FIG. 25 is a simplified diagram showing an example process of rating and validating crowdsourced autonomous vehicle sensor data in accordance with at least one embodiment.

FIG. 26 is a flow diagram of an example process of rating sensor data of an autonomous vehicle in accordance with at least one embodiment.

FIG. 27 is a flow diagram of an example process of rating sensor data of an autonomous vehicle in accordance with at least one embodiment.

FIG. 28 is a simplified diagram of an example environment for autonomous vehicle data collection in accordance with at least one embodiment.

FIG. 29 is a simplified block diagram of an example crowdsourced data collection environment for autonomous vehicles in accordance with at least one embodiment.

FIG. 30 is a simplified diagram of an example heatmap for use in computing a sensor data goodness score in accordance with at least one embodiment.

FIG. 31 is a flow diagram of an example process of computing a goodness score for autonomous vehicle sensor data in accordance with at least one embodiment.

FIG. 32 illustrates an example “Pittsburgh Left” scenario.

FIG. 33 illustrates an example “road rage” scenario.

FIG. 34 is a simplified block diagram showing an irregular/anomalous behavior tracking model for an autonomous vehicle in accordance with at least one embodiment.

FIG. 35 illustrates an example contextual graph that tracks how often a driving pattern occurs in a given context.

FIG. 36 is a flow diagram of an example process of tracking irregular behaviors observed by vehicles in accordance with at least one embodiment.

FIG. 37 is a flow diagram of an example process of identifying contextual behavior patterns in accordance with at least one embodiment.

FIG. 38 is a simplified block diagram illustrating an example implementation of an intrusion detection system for an autonomous driving environment.

FIG. 39 illustrates an example manipulation of a computer vision analysis.

FIG. 40 is a block diagram of a simplified centralized vehicle control architecture for a vehicle according to at least one embodiment.

FIG. 41 is a simplified block diagram of an autonomous sensing and control pipeline.

FIG. 42 is a simplified block diagram illustrating an example x-by-wire architecture of a highly automated or autonomous vehicle.

FIG. 43 is a simplified block diagram illustrating an example safety reset architecture of a highly automated or autonomous vehicle according to at least one embodiment.

FIG. 44 is a simplified block diagram illustrating an example of a general safety architecture of a highly automated or autonomous vehicle according to at least one embodiment.

FIG. 45 is a simplified block diagram illustrating an example operational flow of a fault and intrusion detection system for highly automated and autonomous vehicles according to at least one embodiment.

FIG. 46 is a simplified flowchart that illustrates a high-level flow of example operations associated with a fault and intrusion detection system.

FIG. 47 is another simplified flowchart that illustrates a high-level flow of example operations associated with a fault and intrusion detection system.

FIGS. 48A-48B are simplified flowcharts showing example operations associated with a fault and intrusion detection system in an automated driving environment.

FIG. 49 depicts a flow of data categorization, scoring, and handling according to certain embodiments.

FIG. 50 depicts an example flow for handling data based on categorization in accordance with certain embodiments.

FIG. 51 depicts a system to intelligently generate synthetic data in accordance with certain embodiments.

FIG. 52 depicts a flow for generating synthetic data in accordance with certain embodiments.

FIG. 53 depicts a flow for generating adversarial samples and training a machine learning model based on the adversarial samples.

FIG. 54 depicts a flow for generating a simulated attack data set and training a classification model using the simulated attack data set in accordance with certain embodiments.

FIG. 55 illustrates operation of a non-linear classifier in accordance with certain embodiments.

FIG. 56 illustrates operation of a linear classifier in accordance with certain embodiments.

FIG. 57 depicts a flow for triggering an action based on an accuracy of a linear classifier.

FIG. 58 illustrates example Responsibility-Sensitive Safety (RSS) driving phases in accordance with certain embodiments.

FIG. 59 is a diagram of a system for modifying driver inputs to ensure RSS-compliant accelerations in accordance with certain embodiments.

FIG. 60 depicts a training phase for control-to-acceleration converter in accordance with certain embodiments.

FIG. 61 depicts an inference phase of a control-to-acceleration converter in accordance with certain embodiments.

FIG. 62 depicts a flow for providing acceptable control signals to a vehicle actuation system in accordance with certain embodiments.

FIG. 63 depicts a training phase to build a context model 1508 in accordance with certain embodiments.

FIG. 64 depicts a training phase to build a signal quality metric model in accordance with certain embodiments.

FIG. 65 depicts a training phase to build a handoff readiness model in accordance with certain embodiments.

FIG. 66 depicts an inference phase to determine a handoff decision based on sensor data in accordance with certain embodiments.

FIG. 67 depicts a flow for determining whether to handoff control of a vehicle in accordance with certain embodiments.

FIG. 68 depicts a training phase for a driver state model in accordance with certain embodiments.

FIG. 69 depicts a training phase for a handoff decision model in accordance with certain embodiments.

FIG. 70 depicts an inference phase for determining a handoff decision in accordance with certain embodiments.

FIG. 71 depicts a flow for generating a handoff decision in accordance with certain embodiments.

FIG. 72 illustrates a high-level block diagram of a framework for control of an autonomous vehicle in accordance with certain embodiments.

FIG. 73 is a diagram of an example process of controlling takeovers of an autonomous vehicle in accordance with certain embodiments.

FIG. 74 a diagram of an additional example process of controlling takeovers of an autonomous vehicle in accordance with certain embodiments.

FIG. 75 is a diagram of an example perception, plan, and act autonomous driving pipeline 2800 for an autonomous vehicle in accordance with certain embodiments.

FIG. 76 is a diagram of an example process of controlling takeover requests by human drivers of an autonomous vehicle in accordance with certain embodiments.

FIG. 77 depicts various levels of automation and associated amounts of participation required from a human driver in accordance with certain embodiments.

FIG. 78 illustrates a comprehensive cognitive supervisory system in accordance with certain embodiments.

FIG. 79 illustrates example autonomous level transitions in accordance with certain embodiments.

FIG. 80 illustrates an example of an architectural flow of data of an autonomous vehicle operating at an L4 autonomy level in accordance with certain embodiments.

FIG. 81 illustrates an example of a video signal to the driver in accordance with certain embodiments.

FIG. 82 illustrates of a flow of an example autonomous vehicle handoff situation in accordance with certain embodiments.

FIG. 83 illustrates an example of a flow for handing off control of an autonomous vehicle to a human driver in accordance with certain embodiments.

FIG. 84 is a diagram illustrating example Gated Recurrent Unit (GRU) and Long Short Term Memory (LSTM) architectures.

FIG. 85 depicts a system for anomaly detection in accordance with certain embodiments.

FIG. 86 depicts a flow for detecting anomalies in accordance with certain embodiments.

FIG. 87 illustrates an example of a method of restricting the autonomy level of a vehicle on a portion of a road, according to one embodiment.

FIG. 88 illustrates an example of a map wherein each area of the roadways listed shows a road safety score for that portion of the road.

FIG. 89 illustrates communication system for preserving privacy in computer vision systems of vehicles according to at least one embodiment described herein.

FIGS. 90A-90B illustrate example for a discriminator

FIG. 91 illustrates additional possible component and operational details of GAN configuration system according to at least one embodiment.

FIG. 92 shows example disguised images generated by using a StarGAN based model to modify different facial attributes of an input image.

FIG. 93 shows example disguised images generated by a StarGAN based model from an input image of a real face and results of a face recognition engine that evaluates the real and disguised images.

FIG. 94A shows example disguised images generated by a StarGAN based model from an input image of a real face and results of an emotion detection engine that evaluates the real and the disguised images.

FIG. 94B a listing of input parameters and output results that correspond to the example processing of the emotion detection engine for input image and disguised images illustrated in FIG. 94A.

FIG. 95 shows an example transformation of an input image of a real face to a disguised image as performed by an IcGAN based model.

FIG. 96 illustrates additional possible operational details of a configured GAN model implemented in a vehicle.

FIG. 97 illustrates an example operation of configured GAN model in vehicle to generate a disguised image and the use of the disguised image in machine learning tasks according to at least one embodiment.

FIG. 98 is a simplified flowchart that illustrates a high level of a possible flow of operations associated with configuring a Generative Adversarial Network (GAN) that is trained to perform attribute transfers on images of faces.

FIG. 99 is a simplified flowchart that illustrates a high level of a possible flow of operations associated with operations of a privacy-preserving computer vision system of a vehicle when a configured GAN model is implemented in the system.

FIG. 100 is a simplified flowchart that illustrates a high level of a possible flow of operations associated with operations that may occur when a configured GAN model is applied to an input image.

FIG. 101 illustrates an on-demand privacy compliance system for autonomous vehicles.

FIG. 102 illustrates a representation of data collected by a vehicle and objects defined to ensure privacy compliance for the data.

FIG. 103 shows an example policy template for on-demand privacy compliance system according to at least one embodiment.

FIG. 104 is a simplified block diagram illustrating possible components and a general flow of operations of a vehicle data system.

FIG. 105 illustrates features and activities of an edge or cloud vehicle data system, from a perspective of various possible human actors and hardware and/or software actors.

FIG. 106 is an example portal screen display of an on-demand privacy compliance system for creating policies for data collected by autonomous vehicles.

FIG. 107 shows an example image collected from a vehicle before and after applying a license plate blurring policy to the image.

FIG. 108 shows an example image collected from a vehicle before and after applying a face blurring policy to the image.

FIG. 109 is a simplified flowchart that illustrates a high-level possible flow of operations associated with tagging data collected at a vehicle in an on-demand privacy compliance system.

FIG. 110 is a simplified flowchart that illustrates a high-level possible flow of operations associated with policy enforcement in an on-demand privacy compliance system.

FIG. 111 is a simplified flowchart that illustrates a high-level possible flow of operations associated with policy enforcement in an on-demand privacy compliance system.

FIG. 112 is a simplified diagram of a control loop for automation of an autonomous vehicle in accordance with at least one embodiment.

FIG. 113 is a simplified diagram of a Generalized Data Input (GDI) for automation of an autonomous vehicle in accordance with at least one embodiment

FIG. 114 is a diagram of an example GDI sharing environment in accordance with at least one embodiment.

FIG. 115 is a diagram of an example blockchain topology in accordance with at least one embodiment.

FIG. 116 is a diagram of an example “chainless” block using a directed acyclic graph (DAG) topology in accordance with at least one embodiment.

FIG. 117 is a simplified block diagram of an example secure intra-vehicle communication protocol for an autonomous vehicle in accordance with at least one embodiment.

FIG. 118 is a simplified block diagram of an example secure inter-vehicle communication protocol for an autonomous vehicle in accordance with at least one embodiment.

FIG. 119 is a simplified block diagram of an example secure intra-vehicle communication protocol for an autonomous vehicle in accordance with at least one embodiment.

FIG. 120A depicts a system for determining sampling rates for a plurality of sensors in accordance with certain embodiments.

FIG. 120B depicts a machine learning algorithm to generate a context model in accordance with certain embodiments.

FIG. 121 depicts a fusion algorithm to generate a fusion-context dictionary in accordance with certain embodiments.

FIG. 122 depicts an inference phase for determining selective sampling and fused sensor weights in accordance with certain embodiments.

FIG. 123 illustrates differential weights of the sensors for various contexts.

FIG. 124A illustrates an approach for learning weights for sensors under different contexts in accordance with certain embodiments.

FIG. 124B illustrates a more detailed approach for learning weights for sensors under different contexts in accordance with certain embodiments.

FIG. 125 depicts a flow for determining a sampling policy in accordance with certain embodiments.

FIG. 126 is a simplified diagram of example VLC or Li-Fi communications between autonomous vehicles in accordance with at least one embodiment.

FIGS. 127A-127B are simplified diagrams of example VLC or Li-Fi sensor locations on an autonomous vehicle in accordance with at least one embodiment

FIG. 128 is a simplified diagram of example VLC or Li-Fi communication between a subject vehicle and a traffic vehicle in accordance with at least one embodiment.

FIG. 129 is a simplified diagram of example process of using VLC or Li-Fi information in a sensor fusion process of an autonomous vehicle in accordance with at least one embodiment.

FIG. 130A illustrates a processing pipeline for a single stream of sensor data coming from a single sensor.

FIG. 130B illustrates an example image obtained directly from LIDAR data.

FIG. 131 shows example parallel processing pipelines for processing multiple streams of sensor data.

FIG. 132 shows a processing pipeline where data from multiple sensors is being combined by the filtering action.

FIG. 133 shows a processing pipeline where data from multiple sensors is being combined by a fusion action after all actions of sensor abstraction outlined above.

FIG. 134 depicts a flow for generating training data including high-resolution and corresponding low-resolution images in accordance with certain embodiments.

FIG. 135 depicts a training phase for a model to generate high-resolution images from low-resolutions images in accordance with certain embodiments.

FIG. 136 depicts an inference phase for a model to generate high-resolution images from low-resolution images in accordance with certain embodiments.

FIG. 137 depicts a training phase for training a student model using knowledge distillation in accordance with certain embodiments.

FIG. 138 depicts an inference phase for a student model trained using knowledge distillation in accordance with certain embodiments.

FIG. 139 depicts a flow for increasing resolution of captured images for use in object detection in accordance with certain embodiments.

FIG. 140 depicts a flow for training a machine learning model based on an ensemble of methods in accordance with certain embodiments.

FIG. 141 illustrates an example of a situation in which an autonomous vehicle has occluded sensors, thereby making a driving situation potentially dangerous.

FIG. 142 illustrates an example high-level architecture diagram of a system that uses vehicle cooperation.

FIG. 143 illustrates an example of a situation in which multiple actions are contemplated by multiple vehicles.

FIG. 144 depicts a vehicle having dynamically adjustable image sensors and calibration markers.

FIG. 145 depicts the vehicle of FIG. 144 with a rotated image sensor.

FIG. 146 depicts a flow for adjusting an image sensor of a vehicle in accordance with certain embodiments.

FIG. 147 illustrates an example system for the handoff of an autonomous vehicle to a human driver in accordance with certain embodiments.

FIG. 148 illustrates an example route that a vehicle may take to get from point A to point B in accordance with certain embodiments.

FIG. 149 illustrates a flow that may be performed at least in part by a handoff handling module in accordance with certain embodiments.

FIG. 150 illustrates an example of sensor array on an example autonomous vehicle.

FIG. 151 illustrates an example of a Dynamic Autonomy Level Detection system.

FIG. 152 illustrates example maneuvering of an autonomous vehicle.

FIG. 153 illustrates an Ackermann model.

FIG. 154 illustrates an example of a vehicle with an attachment.

FIG. 155 illustrates an example of tracing new dimensions of an example vehicle to incorporate dimensions added by an extension coupled to the vehicle.

FIG. 156 illustrates an example of a vehicle model occlusion compensation flow according to at least one embodiment.

FIG. 157 is an example illustration of a processor according to an embodiment.

FIG. 158 illustrates an example computing system according to an embodiment.

### DESCRIPTION OF EXAMPLE EMBODIMENTS

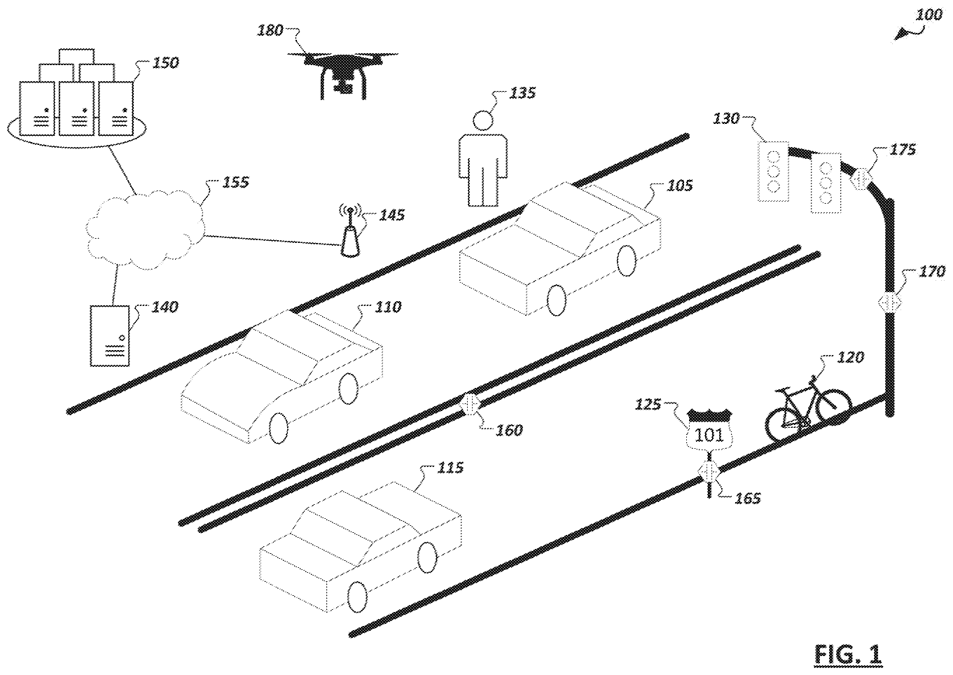

FIG. 1 is a simplified illustration 100 showing an example autonomous driving environment. Vehicles (e.g., 105, 110, 115, etc.) may be provided with varying levels of autonomous driving capabilities facilitated through in-vehicle computing systems with logic implemented in hardware, firmware, and/or software to enable respective autonomous driving stacks. Such autonomous driving stacks may allow vehicles to self-control or provide driver assistance to detect roadways, navigate from one point to another, detect other vehicles and road actors (e.g., pedestrians (e.g., 135), bicyclists, etc.), detect obstacles and hazards (e.g., 120), and road conditions (e.g., traffic, road conditions, weather conditions, etc.), and adjust control and guidance of the vehicle accordingly. Within the present disclosure, a “vehicle” may be a manned vehicle designed to carry one or more human passengers (e.g., cars, trucks, vans, buses, motorcycles, trains, aerial transport vehicles, ambulance, etc.), an unmanned vehicle to drive with or without human passengers (e.g., freight vehicles (e.g., trucks, rail-based vehicles, etc.), vehicles for transporting non-human passengers (e.g., livestock transports, etc.), and/or drones (e.g., land-based or aerial drones or robots, which are to move within a driving environment (e.g., to collect information concerning the driving environment, provide assistance with the automation of other vehicles, perform road maintenance tasks, provide industrial tasks, provide public safety and emergency response tasks, etc.). In some implementations, a vehicle may be a system configured to operate alternatively in multiple different modes (e.g., passenger vehicle, unmanned vehicle, or drone vehicle), among other examples. A vehicle may “drive” within an environment to move the vehicle along the ground (e.g., paved or unpaved road, path, or landscape), through water, or through the air. In this sense, a “road” or “roadway”, depending on the implementation, may embody an outdoor or indoor ground-based path, a water channel, or a defined aerial boundary. Accordingly, it should be appreciated that the following disclosure and related embodiments may apply equally to various contexts and vehicle implementation examples.

In some implementations, vehicles (e.g., 105, 110, 115) within the environment may be “connected” in that the in-vehicle computing systems include communication modules to support wireless communication using one or more technologies (e.g., IEEE 802.11 communications (e.g., WiFi), cellular data networks (e.g., 3rd Generation Partnership Project (3GPP) networks, Global System for Mobile Communication (GSM), general packet radio service, code division multiple access (CDMA), 4G, 5G, 6G, etc.), Bluetooth, millimeter wave (mmWave), ZigBee, Z-Wave, etc.), allowing the in-vehicle computing systems to connect to and communicate with other computing systems, such as the in-vehicle computing systems of other vehicles, roadside units, cloud-based computing systems, or other supporting infrastructure. For instance, in some implementations, vehicles (e.g., 105, 110, 115) may communicate with computing systems providing sensors, data, and services in support of the vehicles' own autonomous driving capabilities. For instance, as shown in the illustrative example of FIG. 1, supporting drones 180 (e.g., ground-based and/or aerial), roadside computing devices (e.g., 140), various external (to the vehicle, or “extraneous”) sensor devices (e.g., 160, 165, 170, 175, etc.), and other devices may be provided as autonomous driving infrastructure separate from the computing systems, sensors, and logic implemented on the vehicles (e.g., 105, 110, 115) to support and improve autonomous driving results provided through the vehicles, among other examples. Vehicles may also communicate with other connected vehicles over wireless communication channels to share data and coordinate movement within an autonomous driving environment, among other example communications.

As illustrated in the example of FIG. 1, autonomous driving infrastructure may incorporate a variety of different systems. Such systems may vary depending on the location, with more developed roadways (e.g., roadways controlled by specific municipalities or toll authorities, roadways in urban areas, sections of roadways known to be problematic for autonomous vehicles, etc.) having a greater number or more advanced supporting infrastructure devices than other sections of roadway, etc. For instance, supplemental sensor devices (e.g., 160, 165, 170, 175) may be provided, which include sensors for observing portions of roadways and vehicles moving within the environment and generating corresponding data describing or embodying the observations of the sensors. As examples, sensor devices may be embedded within the roadway itself (e.g., sensor 160), on roadside or overhead signage (e.g., sensor 165 on sign 125), sensors (e.g., 170, 175) attached to electronic roadside equipment or fixtures (e.g., traffic lights (e.g., 130), electronic road signs, electronic billboards, etc.), dedicated road side units (e.g., 140), among other examples. Sensor devices may also include communication capabilities to communicate their collected sensor data directly to nearby connected vehicles or to fog- or cloud-based computing systems (e.g., 140, 150). Vehicles may obtain sensor data collected by external sensor devices (e.g., 160, 165, 170, 175, 180), or data embodying observations or recommendations generated by other systems (e.g., 140, 150) based on sensor data from these sensor devices (e.g., 160, 165, 170, 175, 180), and use this data in sensor fusion, inference, path planning, and other tasks performed by the in-vehicle autonomous driving system. In some cases, such extraneous sensors and sensor data may, in actuality, be within the vehicle, such as in the form of an after-market sensor attached to the vehicle, a personal computing device (e.g., smartphone, wearable, etc.) carried or worn by passengers of the vehicle, etc. Other road actors, including pedestrians, bicycles, drones, unmanned aerial vehicles, robots, electronic scooters, etc., may also be provided with or carry sensors to generate sensor data describing an autonomous driving environment, which may be used and consumed by autonomous vehicles, cloud- or fog-based support systems (e.g., 140, 150), other sensor devices (e.g., 160, 165, 170, 175, 180), among other examples.

As autonomous vehicle systems may possess varying levels of functionality and sophistication, support infrastructure may be called upon to supplement not only the sensing capabilities of some vehicles, but also the computer and machine learning functionality enabling autonomous driving functionality of some vehicles. For instance, compute resources and autonomous driving logic used to facilitate machine learning model training and use of such machine learning models may be provided on the in-vehicle computing systems entirely or partially on both the in-vehicle systems and some external systems (e.g., 140, 150). For instance, a connected vehicle may communicate with road-side units, edge systems, or cloud-based devices (e.g., 140) local to a particular segment of roadway, with such devices (e.g., 140) capable of providing data (e.g., sensor data aggregated from local sensors (e.g., 160, 165, 170, 175, 180) or data reported from sensors of other vehicles), performing computations (as a service) on data provided by a vehicle to supplement the capabilities native to the vehicle, and/or push information to passing or approaching vehicles (e.g., based on sensor data collected at the device 140 or from nearby sensor devices, etc.). A connected vehicle (e.g., 105, 110, 115) may also or instead communicate with cloud-based computing systems (e.g., 150), which may provide similar memory, sensing, and computational resources to enhance those available at the vehicle. For instance, a cloud-based system (e.g., 150) may collect sensor data from a variety of devices in one or more locations and utilize this data to build and/or train machine-learning models which may be used at the cloud-based system (to provide results to various vehicles (e.g., 105, 110, 115) in communication with the cloud-based system 150, or to push to vehicles for use by their in-vehicle systems, among other example implementations. Access points (e.g., 145), such as cell-phone towers, road-side units, network access points mounted to various roadway infrastructure, access points provided by neighboring vehicles or buildings, and other access points, may be provided within an environment and used to facilitate communication over one or more local or wide area networks (e.g., 155) between cloud-based systems (e.g., 150) and various vehicles (e.g., 105, 110, 115). Through such infrastructure and computing systems, it should be appreciated that the examples, features, and solutions discussed herein may be performed entirely by one or more of such in-vehicle computing systems, fog-based or edge computing devices, or cloud-based computing systems, or by combinations of the foregoing through communication and cooperation between the systems.

In general, “servers,” “clients,” “computing devices,” “network elements,” “hosts,” “platforms”, “sensor devices,” “edge device,” “autonomous driving systems”, “autonomous vehicles”, “fog-based system”, “cloud-based system”, and “systems” generally, etc. discussed herein can include electronic computing devices operable to receive, transmit, process, store, or manage data and information associated with an autonomous driving environment. As used in this document, the term “computer,” “processor,” “processor device,” or “processing device” is intended to encompass any suitable processing apparatus, including central processing units (CPUs), graphical processing units (GPUs), application specific integrated circuits (ASICs), field programmable gate arrays (FPGAs), digital signal processors (DSPs), tensor processors and other matrix arithmetic processors, among other examples. For example, elements shown as single devices within the environment may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Any of the flows, methods, processes (or portions thereof) or functionality of any of the various components described below or illustrated in the figures may be performed by any suitable computing logic, such as one or more modules, engines, blocks, units, models, systems, or other suitable computing logic. Reference herein to a “module”, “engine”, “block”, “unit”, “model”, “system” or “logic” may refer to hardware, firmware, software and/or combinations of each to perform one or more functions. As an example, a module, engine, block, unit, model, system, or logic may include one or more hardware components, such as a micro-controller or processor, associated with a non-transitory medium to store code adapted to be executed by the micro-controller or processor. Therefore, reference to a module, engine, block, unit, model, system, or logic, in one embodiment, may refers to hardware, which is specifically configured to recognize and/or execute the code to be held on a non-transitory medium. Furthermore, in another embodiment, use of module, engine, block, unit, model, system, or logic refers to the non-transitory medium including the code, which is specifically adapted to be executed by the microcontroller or processor to perform predetermined operations. And as can be inferred, in yet another embodiment, a module, engine, block, unit, model, system, or logic may refer to the combination of the hardware and the non-transitory medium. In various embodiments, a module, engine, block, unit, model, system, or logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. A module, engine, block, unit, model, system, or logic may include one or more gates or other circuit components, which may be implemented by, e.g., transistors. In some embodiments, a module, engine, block, unit, model, system, or logic may be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. Furthermore, logic boundaries that are illustrated as separate commonly vary and potentially overlap. For example, a first and second module (or multiple engines, blocks, units, models, systems, or logics) may share hardware, software, firmware, or a combination thereof, while potentially retaining some independent hardware, software, or firmware.

The flows, methods, and processes described below and in the accompanying figures are merely representative of functions that may be performed in particular embodiments. In other embodiments, additional functions may be performed in the flows, methods, and processes. Various embodiments of the present disclosure contemplate any suitable signaling mechanisms for accomplishing the functions described herein. Some of the functions illustrated herein may be repeated, combined, modified, or deleted within the flows, methods, and processes where appropriate. Additionally, functions may be performed in any suitable order within the flows, methods, and processes without departing from the scope of particular embodiments.

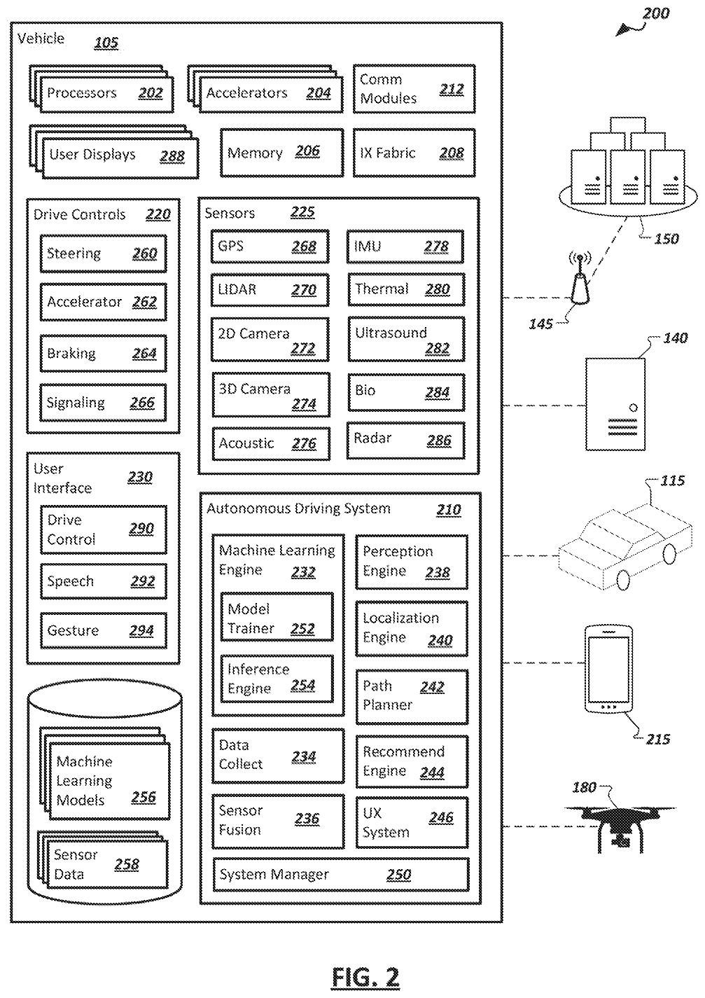

With reference now to FIG. 2, a simplified block diagram 200 is shown illustrating an example implementation of a vehicle (and corresponding in-vehicle computing system) 105 equipped with autonomous driving functionality. In one example, a vehicle 105 may be equipped with one or more processors 202, such as central processing units (CPUs), graphical processing units (GPUs), application specific integrated circuits (ASICs), field programmable gate arrays (FPGAs), digital signal processors (DSPs), tensor processors and other matrix arithmetic processors, among other examples. Such processors 202 may be coupled to or have integrated hardware accelerator devices (e.g., 204), which may be provided with hardware to accelerate certain processing and memory access functions, such as functions relating to machine learning inference or training (including any of the machine learning inference or training described below), processing of particular sensor data (e.g., camera image data, LIDAR point clouds, etc.), performing certain arithmetic functions pertaining to autonomous driving (e.g., matrix arithmetic, convolutional arithmetic, etc.), among other examples. One or more memory elements (e.g., 206) may be provided to store machine-executable instructions implementing all or a portion of any one of the modules or sub-modules of an autonomous driving stack implemented on the vehicle, as well as storing machine learning models (e.g., 256), sensor data (e.g., 258), and other data received, generated, or used in connection with autonomous driving functionality to be performed by the vehicle (or used in connection with the examples and solutions discussed herein). Various communication modules (e.g., 212) may also be provided, implemented in hardware circuitry and/or software to implement communication capabilities used by the vehicle's system to communicate with other extraneous computing systems over one or more network channels employing one or more network communication technologies. These various processors 202, accelerators 204, memory devices 206, and network communication modules 212, may be interconnected on the vehicle system through one or more interconnect fabrics or links (e.g., 208), such as fabrics utilizing technologies such as a Peripheral Component Interconnect Express (PCIe), Ethernet, OpenCAPI™, Gen-Z™, UPI, Universal Serial Bus, (USB), Cache Coherent Interconnect for Accelerators (CCIX™), Advanced Micro Device™'s (AMD™) Infinity™, Common Communication Interface (CCI), or Qualcomm™'s Centriq™ interconnect, among others.

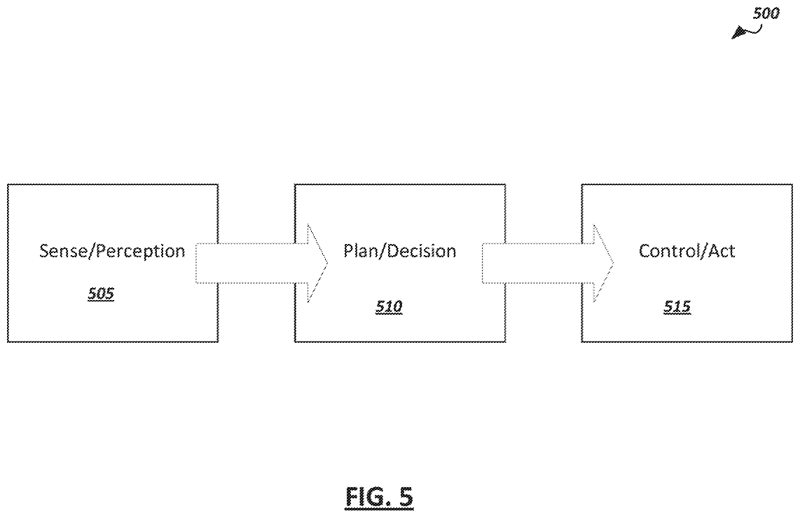

Continuing with the example of FIG. 2, an example vehicle (and corresponding in-vehicle computing system) 105 may include an in-vehicle processing system 210, driving controls (e.g., 220), sensors (e.g., 225), and user/passenger interface(s) (e.g., 230), among other example modules implemented functionality of the autonomous vehicle in hardware and/or software. For instance, an in-vehicle processing system 210, in some implementations, may implement all or a portion of an autonomous driving stack and process flow (e.g., as shown and discussed in the example of FIG. 5). The autonomous driving stack may be implemented in hardware, firmware or software. A machine learning engine 232 may be provided to utilize various machine learning models (e.g., 256) provided at the vehicle 105 in connection with one or more autonomous functions and features provided and implemented at or for the vehicle, such as discussed in the examples herein. Such machine learning models 256 may include artificial neural network models, convolutional neural networks, decision tree-based models, support vector machines (SVMs), Bayesian models, deep learning models, and other example models. In some implementations, an example machine learning engine 232 may include one or more model trainer engines 252 to participate in training (e.g., initial training, continuous training, etc.) of one or more of the machine learning models 256. One or more inference engines 254 may also be provided to utilize the trained machine learning models 256 to derive various inferences, predictions, classifications, and other results. In some embodiments, the machine learning model training or inference described herein may be performed off-vehicle, such as by computing system 140 or 150.

The machine learning engine(s) 232 provided at the vehicle may be utilized to support and provide results for use by other logical components and modules of the in-vehicle processing system 210 implementing an autonomous driving stack and other autonomous-driving-related features. For instance, a data collection module 234 may be provided with logic to determine sources from which data is to be collected (e.g., for inputs in the training or use of various machine learning models 256 used by the vehicle). For instance, the particular source (e.g., internal sensors (e.g., 225) or extraneous sources (e.g., 115, 140, 150, 180, 215, etc.)) may be selected, as well as the frequency and fidelity at which the data may be sampled is selected. In some cases, such selections and configurations may be made at least partially autonomously by the data collection module 234 using one or more corresponding machine learning models (e.g., to collect data as appropriate given a particular detected scenario).

A sensor fusion module 236 may also be used to govern the use and processing of the various sensor inputs utilized by the machine learning engine 232 and other modules (e.g., 238, 240, 242, 244, 246, etc.) of the in-vehicle processing system. One or more sensor fusion modules (e.g., 236) may be provided, which may derive an output from multiple sensor data sources (e.g., on the vehicle or extraneous to the vehicle). The sources may be homogenous or heterogeneous types of sources (e.g., multiple inputs from multiple instances of a common type of sensor, or from instances of multiple different types of sensors). An example sensor fusion module 236 may apply direct fusion, indirect fusion, among other example sensor fusion techniques. The output of the sensor fusion may, in some cases by fed as an input (along with potentially additional inputs) to another module of the in-vehicle processing system and/or one or more machine learning models in connection with providing autonomous driving functionality or other functionality, such as described in the example solutions discussed herein.

A perception engine 238 may be provided in some examples, which may take as inputs various sensor data (e.g., 258) including data, in some instances, from extraneous sources and/or sensor fusion module 236 to perform object recognition and/or tracking of detected objects, among other example functions corresponding to autonomous perception of the environment encountered (or to be encountered) by the vehicle 105. Perception engine 238 may perform object recognition from sensor data inputs using deep learning, such as through one or more convolutional neural networks and other machine learning models 256. Object tracking may also be performed to autonomously estimate, from sensor data inputs, whether an object is moving and, if so, along what trajectory. For instance, after a given object is recognized, a perception engine 238 may detect how the given object moves in relation to the vehicle. Such functionality may be used, for instance, to detect objects such as other vehicles, pedestrians, wildlife, cyclists, etc. moving within an environment, which may affect the path of the vehicle on a roadway, among other example uses.

A localization engine 240 may also be included within an in-vehicle processing system 210 in some implementation. In some cases, localization engine 240 may be implemented as a sub-component of a perception engine 238. The localization engine 240 may also make use of one or more machine learning models 256 and sensorfusion (e.g., of LIDAR and GPS data, etc.) to determine a high confidence location of the vehicle and the space it occupies within a given physical space (or “environment”).

A vehicle 105 may further include a path planner 242, which may make use of the results of various other modules, such as data collection 234, sensor fusion 236, perception engine 238, and localization engine (e.g., 240) among others (e.g., recommendation engine 244) to determine a path plan and/or action plan for the vehicle, which may be used by drive controls (e.g., 220) to control the driving of the vehicle 105 within an environment. For instance, a path planner 242 may utilize these inputs and one or more machine learning models to determine probabilities of various events within a driving environment to determine effective real-time plans to act within the environment.

In some implementations, the vehicle 105 may include one or more recommendation engines 244 to generate various recommendations from sensor data generated by the vehicle's 105 own sensors (e.g., 225) as well as sensor data from extraneous sensors (e.g., on sensor devices 115, 180, 215, etc.). Some recommendations may be determined by the recommendation engine 244, which may be provided as inputs to other components of the vehicle's autonomous driving stack to influence determinations that are made by these components. For instance, a recommendation may be determined, which, when considered by a path planner 242, causes the path planner 242 to deviate from decisions or plans it would ordinarily otherwise determine, but for the recommendation. Recommendations may also be generated by recommendation engines (e.g., 244) based on considerations of passenger comfort and experience. In some cases, interior features within the vehicle may be manipulated predictively and autonomously based on these recommendations (which are determined from sensor data (e.g., 258) captured by the vehicle's sensors and/or extraneous sensors, etc.

As introduced above, some vehicle implementations may include user/passenger experience engines (e.g., 246), which may utilize sensor data and outputs of other modules within the vehicle's autonomous driving stack to control a control unit of the vehicle in order to change driving maneuvers and effect changes to the vehicle's cabin environment to enhance the experience of passengers within the vehicle based on the observations captured by the sensor data (e.g., 258). In some instances, aspects of user interfaces (e.g., 230) provided on the vehicle to enable users to interact with the vehicle and its autonomous driving system may be enhanced. In some cases, informational presentations may be generated and provided through user displays (e.g., audio, visual, and/or tactile presentations) to help affect and improve passenger experiences within a vehicle (e.g., 105) among other example uses.

In some cases, a system manager 250 may also be provided, which monitors information collected by various sensors on the vehicle to detect issues relating to the performance of a vehicle's autonomous driving system. For instance, computational errors, sensor outages and issues, availability and quality of communication channels (e.g., provided through communication modules 212), vehicle system checks (e.g., issues relating to the motor, transmission, battery, cooling system, electrical system, tires, etc.), or other operational events may be detected by the system manager 250. Such issues may be identified in system report data generated by the system manager 250, which may be utilized, in some cases as inputs to machine learning models 256 and related autonomous driving modules (e.g., 232, 234, 236, 238, 240, 242, 244, 246, etc.) to enable vehicle system health and issues to also be considered along with other information collected in sensor data 258 in the autonomous driving functionality of the vehicle 105.

In some implementations, an autonomous driving stack of a vehicle 105 may be coupled with drive controls 220 to affect how the vehicle is driven, including steering controls (e.g., 260), accelerator/throttle controls (e.g., 262), braking controls (e.g., 264), signaling controls (e.g., 266), among other examples. In some cases, a vehicle may also be controlled wholly or partially based on user inputs. For instance, user interfaces (e.g., 230), may include driving controls (e.g., a physical or virtual steering wheel, accelerator, brakes, clutch, etc.) to allow a human driver to take control from the autonomous driving system (e.g., in a handover or following a driver assist action). Other sensors may be utilized to accept user/passenger inputs, such as speech detection 292, gesture detection cameras 294, and other examples. User interfaces (e.g., 230) may capture the desires and intentions of the passenger-users and the autonomous driving stack of the vehicle 105 may consider these as additional inputs in controlling the driving of the vehicle (e.g., drive controls 220). In some implementations, drive controls may be governed by external computing systems, such as in cases where a passenger utilizes an external device (e.g., a smartphone or tablet) to provide driving direction or control, or in cases of a remote valet service, where an external driver or system takes over control of the vehicle (e.g., based on an emergency event), among other example implementations.

As discussed above, the autonomous driving stack of a vehicle may utilize a variety of sensor data (e.g., 258) generated by various sensors provided on and external to the vehicle. As an example, a vehicle 105 may possess an array of sensors 225 to collect various information relating to the exterior of the vehicle and the surrounding environment, vehicle system status, conditions within the vehicle, and other information usable by the modules of the vehicle's processing system 210. For instance, such sensors 225 may include global positioning (GPS) sensors 268, light detection and ranging (LIDAR) sensors 270, two-dimensional (2D) cameras 272, three-dimensional (3D) or stereo cameras 274, acoustic sensors 276, inertial measurement unit (IMU) sensors 278, thermal sensors 280, ultrasound sensors 282, bio sensors 284 (e.g., facial recognition, voice recognition, heart rate sensors, body temperature sensors, emotion detection sensors, etc.), radar sensors 286, weather sensors (not shown), among other example sensors. Such sensors may be utilized in combination to determine various attributes and conditions of the environment in which the vehicle operates (e.g., weather, obstacles, traffic, road conditions, etc.), the passengers within the vehicle (e.g., passenger or driver awareness or alertness, passenger comfort or mood, passenger health or physiological conditions, etc.), other contents of the vehicle (e.g., packages, livestock, freight, luggage, etc.), subsystems of the vehicle, among other examples. Sensor data 258 may also (or instead) be generated by sensors that are not integrally coupled to the vehicle, including sensors on other vehicles (e.g., 115) (which may be communicated to the vehicle 105 through vehicle-to-vehicle communications or other techniques), sensors on ground-based or aerial drones 180, sensors of user devices 215 (e.g., a smartphone or wearable) carried by human users inside or outside the vehicle 105, and sensors mounted or provided with other roadside elements, such as a roadside unit (e.g., 140), road sign, traffic light, streetlight, etc. Sensor data from such extraneous sensor devices may be provided directly from the sensor devices to the vehicle or may be provided through data aggregation devices or as results generated based on these sensors by other computing systems (e.g., 140, 150), among other example implementations.

In some implementations, an autonomous vehicle system 105 may interface with and leverage information and services provided by other computing systems to enhance, enable, or otherwise support the autonomous driving functionality of the device 105. In some instances, some autonomous driving features (including some of the example solutions discussed herein) may be enabled through services, computing logic, machine learning models, data, or other resources of computing systems external to a vehicle. When such external systems are unavailable to a vehicle, it may be that these features are at least temporarily disabled. For instance, external computing systems may be provided and leveraged, which are hosted in road-side units or fog-based edge devices (e.g., 140), other (e.g., higher-level) vehicles (e.g., 115), and cloud-based systems 150 (e.g., accessible through various network access points (e.g., 145)). A roadside unit 140 or cloud-based system 150 (or other cooperating system, with which a vehicle (e.g., 105) interacts may include all or a portion of the logic illustrated as belonging to an example in-vehicle processing system (e.g., 210), along with potentially additional functionality and logic. For instance, a cloud-based computing system, road side unit 140, or other computing system may include a machine learning engine supporting either or both model training and inference engine logic. For instance, such external systems may possess higher-end computing resources and more developed or up-to-date machine learning models, allowing these services to provide superior results to what would be generated natively on a vehicle's processing system 210. For instance, an in-vehicle processing system 210 may rely on the machine learning training, machine learning inference, and/or machine learning models provided through a cloud-based service for certain tasks and handling certain scenarios. Indeed, it should be appreciated that one or more of the modules discussed and illustrated as belonging to vehicle 105 may, in some implementations, be alternatively or redundantly provided within a cloud-based, fog-based, or other computing system supporting an autonomous driving environment.

Various embodiments herein may utilize one or more machine learning models to perform functions of the autonomous vehicle stack (or other functions described herein). A machine learning model may be executed by a computing system to progressively improve performance of a specific task. In some embodiments, parameters of a machine learning model may be adjusted during a training phase based on training data. A trained machine learning model may then be used during an inference phase to make predictions or decisions based on input data.

The machine learning models described herein may take any suitable form or utilize any suitable techniques. For example, any of the machine learning models may utilize supervised learning, semi-supervised learning, unsupervised learning, or reinforcement learning techniques.

In supervised learning, the model may be built using a training set of data that contains both the inputs and corresponding desired outputs. Each training instance may include one or more inputs and a desired output. Training may include iterating through training instances and using an objective function to teach the model to predict the output for new inputs. In semi-supervised learning, a portion of the inputs in the training set may be missing the desired outputs.

In unsupervised learning, the model may be built from a set of data which contains only inputs and no desired outputs. The unsupervised model may be used to find structure in the data (e.g., grouping or clustering of data points) by discovering patterns in the data. Techniques that may be implemented in an unsupervised learning model include, e.g., self-organizing maps, nearest-neighbor mapping, k-means clustering, and singular value decomposition.

Reinforcement learning models may be given positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

Various embodiments described herein may utilize one or more classification models. In a classification model, the outputs may be restricted to a limited set of values. The classification model may output a class for an input set of one or more input values. References herein to classification models may contemplate a model that implements, e.g., any one or more of the following techniques: linear classifiers (e.g., logistic regression or naïve Bayes classifier), support vector machines, decision trees, boosted trees, random forest, neural networks, or nearest neighbor.

Various embodiments described herein may utilize one or more regression models. A regression model may output a numerical value from a continuous range based on an input set of one or more values. References herein to regression models may contemplate a model that implements, e.g., any one or more of the following techniques (or other suitable techniques): linear regression, decision trees, random forest, or neural networks.

In various embodiments, any of the machine learning models discussed herein may utilize one or more neural networks. A neural network may include a group of neural units loosely modeled after the structure of a biological brain which includes large clusters of neurons connected by synapses. In a neural network, neural units are connected to other neural units via links which may be excitatory or inhibitory in their effect on the activation state of connected neural units. A neural unit may perform a function utilizing the values of its inputs to update a membrane potential of the neural unit. A neural unit may propagate a spike signal to connected neural units when a threshold associated with the neural unit is surpassed. A neural network may be trained or otherwise adapted to perform various data processing tasks (including tasks performed by the autonomous vehicle stack), such as computer vision tasks, speech recognition tasks, or other suitable computing tasks.

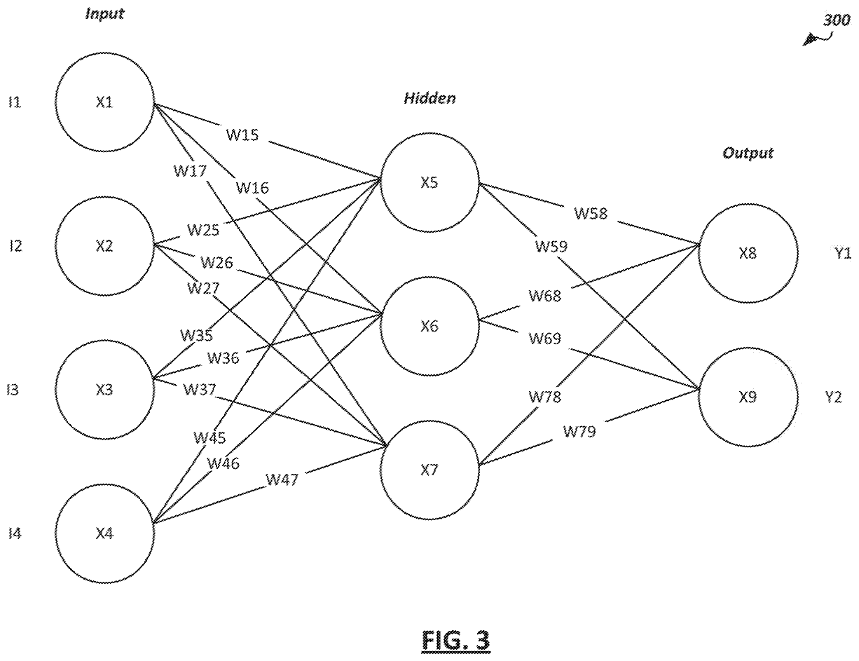

FIG. 3 illustrates an example portion of a neural network 300 in accordance with certain embodiments. The neural network 300 includes neural units X1-X9. Neural units X1-X4 are input neural units that respectively receive primary inputs I1-I4 (which may be held constant while the neural network 300 processes an output). Any suitable primary inputs may be used. As one example, when neural network 300 performs image processing, a primary input value may be the value of a pixel from an image (and the value of the primary input may stay constant while the image is processed). As another example, when neural network 300 performs speech processing the primary input value applied to a particular input neural unit may change over time based on changes to the input speech.

While a specific topology and connectivity scheme is shown in FIG. 3, the teachings of the present disclosure may be used in neural networks having any suitable topology and/or connectivity. For example, a neural network may be a feedforward neural network, a recurrent network, or other neural network with any suitable connectivity between neural units. As another example, although the neural network is depicted as having an input layer, a hidden layer, and an output layer, a neural network may have any suitable layers arranged in any suitable fashion In the embodiment depicted, each link between two neural units has a synapse weight indicating the strength of the relationship between the two neural units. The synapse weights are depicted as WXY, where X indicates the pre-synaptic neural unit and Y indicates the post-synaptic neural unit. Links between the neural units may be excitatory or inhibitory in their effect on the activation state of connected neural units. For example, a spike that propagates from X1 to X5 may increase or decrease the membrane potential of X5 depending on the value of W15. In various embodiments, the connections may be directed or undirected.

In various embodiments, during each time-step of a neural network, a neural unit may receive any suitable inputs, such as a bias value or one or more input spikes from one or more of the neural units that are connected via respective synapses to the neural unit (this set of neural units are referred to as fan-in neural units of the neural unit). The bias value applied to a neural unit may be a function of a primary input applied to an input neural unit and/or some other value applied to a neural unit (e.g., a constant value that may be adjusted during training or other operation of the neural network). In various embodiments, each neural unit may be associated with its own bias value or a bias value could be applied to multiple neural units.

The neural unit may perform a function utilizing the values of its inputs and its current membrane potential. For example, the inputs may be added to the current membrane potential of the neural unit to generate an updated membrane potential. As another example, a non-linear function, such as a sigmoid transfer function, may be applied to the inputs and the current membrane potential. Any other suitable function may be used. The neural unit then updates its membrane potential based on the output of the function.

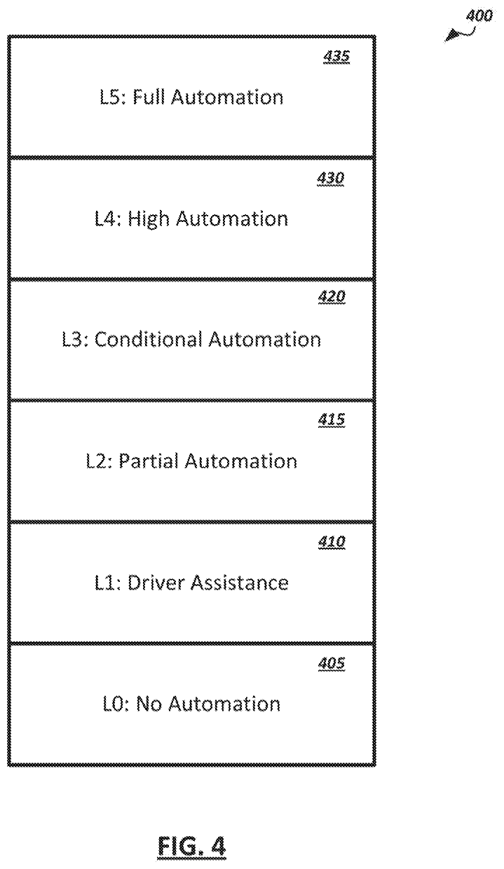

Turning to FIG. 4, a simplified block diagram 400 is shown illustrating example levels of autonomous driving, which may be supported in various vehicles (e.g., by their corresponding in-vehicle computing systems. For instance, a range of levels may be defined (e.g., L0-L5 (405-435)), with level 5 (L5) corresponding to vehicles with the highest level of autonomous driving functionality (e.g., full automation), and level 0 (L0) corresponding the lowest level of autonomous driving functionality (e.g., no automation). For instance, an L5 vehicle (e.g., 435) may possess a fully-autonomous computing system capable of providing autonomous driving performance in every driving scenario equal to or better than would be provided by a human driver, including in extreme road conditions and weather. An L4 vehicle (e.g., 430) may also be considered fully-autonomous and capable of autonomously performing safety-critical driving functions and effectively monitoring roadway conditions throughout an entire trip from a starting location to a destination. L4 vehicles may differ from L5 vehicles, in that an L4's autonomous capabilities are defined within the limits of the vehicle's “operational design domain,” which may not include all driving scenarios. L3 vehicles (e.g., 420) provide autonomous driving functionality to completely shift safety-critical functions to the vehicle in a set of specific traffic and environment conditions, but which still expect the engagement and availability of human drivers to handle driving in all other scenarios. Accordingly, L3 vehicles may provide handover protocols to orchestrate the transfer of control from a human driver to the autonomous driving stack and back. L2 vehicles (e.g., 415) provide driver assistance functionality, which allow the driver to occasionally disengage from physically operating the vehicle, such that both the hands and feet of the driver may disengage periodically from the physical controls of the vehicle. L1 vehicles (e.g., 410) provide driver assistance of one or more specific functions (e.g., steering, braking, etc.), but still require constant driver control of most functions of the vehicle. L0 vehicles may be considered not autonomous—the human driver controls all of the driving functionality of the vehicle (although such vehicles may nonetheless participate passively within autonomous driving environments, such as by providing sensor data to higher level vehicles, using sensor data to enhance GPS and infotainment services within the vehicle, etc.). In some implementations, a single vehicle may support operation at multiple autonomous driving levels. For instance, a driver may control and select which supported level of autonomy is used during a given trip (e.g., L4 or a lower level). In other cases, a vehicle may autonomously toggle between levels, for instance, based on conditions affecting the roadway or the vehicle's autonomous driving system. For example, in response to detecting that one or more sensors have been compromised, an L5 or L4 vehicle may shift to a lower mode (e.g., L2 or lower) to involve a human passenger in light of the sensor issue, among other examples.

FIG. 5 is a simplified block diagram 500 illustrating an example autonomous driving flow which may be implemented in some autonomous driving systems. For instance, an autonomous driving flow implemented in an autonomous (or semi-autonomous) vehicle may include a sensing and perception stage 505, a planning and decision stage 510, and a control and action phase 515. During a sensing and perception stage 505 data is generated by various sensors and collected for use by the autonomous driving system. Data collection, in some instances, may include data filtering and receiving sensor from external sources. This stage may also include sensor fusion operations and object recognition and other perception tasks, such as localization, performed using one or more machine learning models. A planning and decision stage 510 may utilize the sensor data and results of various perception operations to make probabilistic predictions of the roadway(s) ahead and determine a real time path plan based on these predictions. A planning and decision stage 510 may additionally include making decisions relating to the path plan in reaction to the detection of obstacles and other events to decide on whether and what action to take to safely navigate the determined path in light of these events. Based on the path plan and decisions of the planning and decision stage 510, a control and action stage 515 may convert these determinations into actions, through actuators to manipulate driving controls including steering, acceleration, and braking, as well as secondary controls, such as turn signals, sensor cleaners, windshield wipers, headlights, etc.

In higher level autonomous vehicles, the in-vehicle processing system implementing an autonomous driving stack allows driving decisions to be made and controlled without the direct input of the passengers in the vehicle, with the vehicle's system instead relying on the application of models, including machine learning models, which may take as inputs data collected automatically by sensors on the vehicle, data from other vehicles or nearby infrastructure (e.g., roadside sensors and cameras, etc.), and data (e.g., map data) describing the geography and maps of routes the vehicle may take. The models relied upon by the autonomous vehicle's systems may also be developed through training on data sets that describe other preceding trips (by the vehicle or other vehicles), whose ground truth may also be based on the perspective of the vehicle and the results it observes or senses through its sensors. In some implementations, the “success” of an autonomous vehicle's operation can thus be machine-centric or overly pragmatic-rightfully focused on providing safe and reliable transportation from point A to point B, while potentially being agnostic to the unique preferences and variable human contexts of the passengers. For instance, while autonomous vehicles are equipped with diverse sensors, these sensors primarily focus on vehicle safety, such as detecting surrounding vehicles and obstacles and traffic events, to help determine safe and reliable path plans and decisions within the traditional sense-plan-act autonomous driving pipeline. Passenger experience and recommendations to influence the autonomous driving mode to enhance passengers experience is general lacking in existing implementations. In this sense, human-driven vehicles may provide a more passenger- and human-conscious traveling experience, as the human driver is likely better aware of human contexts affecting the driver and their passengers, such that the human driver is able to adjust driving style to offer the passengers a better experience (e.g., adjusting acceleration, steering, and braking style; avoiding roadways that make passengers car sick or nervous (e.g., based on which passengers are in the vehicle, where they are seated, the weather outside, etc.); among other adjustments. These remaining advantages of human driving may serve as another hurdle preventing the widespread adoption of autonomous vehicles.

In some implementations, an autonomous vehicle may be provided with a recommendation system implemented using computing hardware, firmware, or software resident on the vehicle (e.g., implemented on or using the in-vehicle computing system of the vehicle), which may enhance functionality of an autonomous vehicle to leverage sensors provided on and within the vehicle to detect passenger contexts and preferences and adjust performance, route chosen, and internal environment settings of the vehicle to address these passenger events and attributes. For instance, sensors originally provided to support core driving autonomy functions of a vehicle may be leveraged to detect environment attributes inside and outside the vehicle, as well as attributes of the passengers within the vehicle. Further, additional sensors may be provided to enhance the set of inputs, which may be considered in determining not only core autonomous path planning and decision making, but also in providing an improved and customized user experience to passengers. The recommendation system may thus be tied to the autonomous driving pipeline to use similar inputs to attempt to avoid instances of passenger inconvenience or discomfort and ensure a positive passenger experience. In addition to influencing the driving behavior of the vehicle, the recommendation system may also actuate features within the vehicle cabin to enhance the passenger experience (e.g., opening windows, providing ventilation, providing air filtering, adjusting lighting, dynamically adjusting display screens positioning, dynamically adjusting seating positioning, adjusting audio levels, etc.). Such adjustments can be responsive to attributes and events detected in the environment surrounding the vehicle or within the passenger cabin.

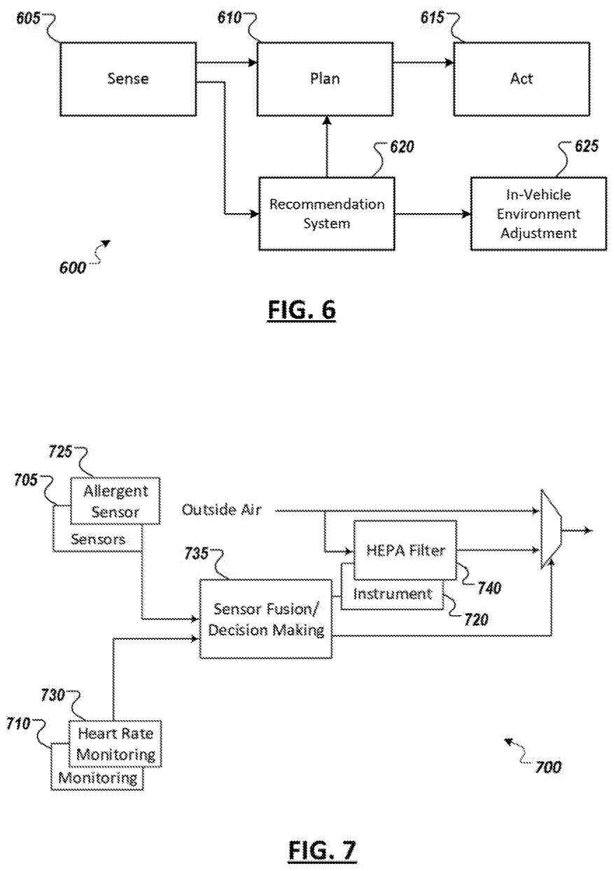

Turning to the simplified block diagram shown in FIG. 6, modules provided in hardware and/or software of an autonomous vehicle implement an autonomous driving pipeline including sensing 605 (where data is sampled from a suite of sensors provided on the vehicle and/or within an environment surrounding the vehicle) an environment, planning 610 a path plan or maneuver within the environment based on the sensor data, and acting 615 to cause instrumentation on the vehicle to carry out the planned path or maneuver. In some implementations, a recommendation system 620 may be coupled to the autonomous driving pipeline (605, 610, 615). In some implementations, the recommendation system 620 may leverage information collected from sensors primarily utilized in the core autonomous driving pipeline as well as additional sensor external and/or internal to the vehicle to collect information concerning conditions, which may impact passenger experience. For instance, the sense phase 605 of the pipeline may be expanded to have information from the external sensors of the vehicle on external environment conditions that can impact passengers experience such as weather conditions, allergen levels, external temperatures, road surface conditions (e.g., wet, dusty, clear, salted, etc.), road characteristics (e.g., curviness, embankments, grade, etc.), elevation, humidity, darkness, angle of the sun, light conditions, among other examples. Additionally, sensors positioned within the vehicle may also contribute to the sense phase 605 of the pipeline provide information such as biometrics of the passengers (e.g., eye tracking, body temperature, heart rate, body temperatures, posture, emotion, etc.); identity recognition of the passengers; detect positioning of instruments, screens, seats, and other physical components of the vehicle with which passengers interact; detect atmospheric conditions within the vehicle cabin; among other examples.

In the modified pipeline illustrated in the example of FIG. 6, the recommender system phase 620 performs sensor information fusion for the expanded sense phase information and sends a recommendation to the plan phase 610 that can take several forms to enhance passenger experience and mitigate against passenger discomfort. The plan phase 610 may consider the recommendation provided by the recommendation system 620 to augment the plan determined by the plan phase 610.

The recommendation system 620 may also be used to augment or direct operation of devices within the vehicle, which may be used by the users while the vehicle is in motion through an in-vehicle environment adjustment phase 625. As an illustrative example, on a curvy road, it may be detected that a passenger is using a VR/AR headset, and the autonomous vehicle may signal the headset to cause the screen inside the headset to tilt to adjust the visual to make the ride and viewing experience smoother. For passengers detected within the vehicle as being prone to motion sickness, rolling or curvy roads may prompt the vehicle to automate the inflow of air, present an alert for the passenger to direct their eyes forward, among other responsive actions. As yet another example, a bio monitor (e.g., heart rate or breathing monitor) carried by the passenger or provided within the vehicle can be used to detect breathing difficulties being experienced by a passenger and may conclude from additional sensors or data identifying allergen conditions, that the breathing difficulties relate to the allergen levels, automatically triggering any asthma attacks because of allergen levels. Once detected, this can trigger HEPA filter air purification inside the car, among other examples.

As should be apparent from the preceding examples, sensors used by the vehicle's recommendation system may include some sensors that are not integrated or provided originally with the vehicle. For instance, wearable devices, smart phones, media players, and other devices carried by the user or positioned after-market within the vehicle may include sensors and communicate with the in-vehicle computing system implementing the autonomous driving pipeline to provide data collected by these devices in the sense phase 605. Similarly, the outputs of the recommendation system 620 may be provided to not only trigger actions of the vehicle's integrated components, but also extraneous devices (e.g., smart phones, AR/VR headsets, wearable devices, after market components, etc.).

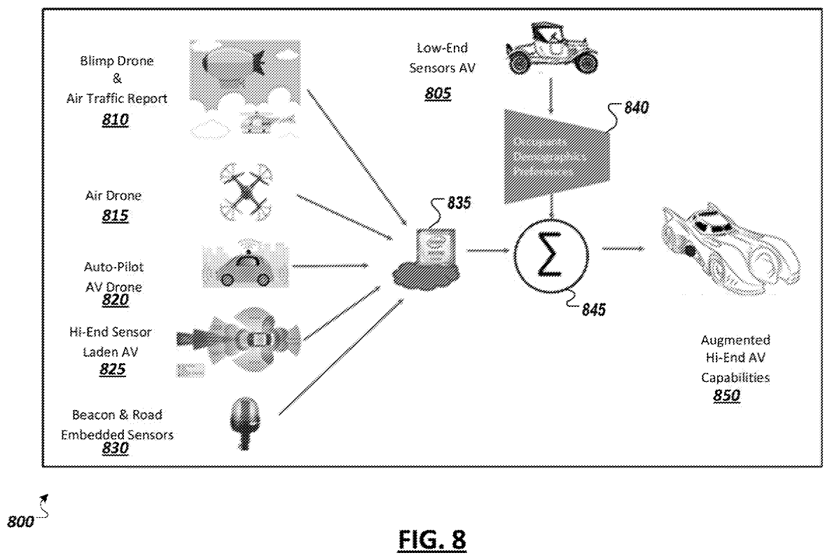

Turning to FIG. 7, a simplified block diagram 700 is shown illustrating a logical representation of a recommendation system. Generally, various sensors 705 may be provided, such as discussed above, and data generated from these sensors may be provided to a sensor fusion/decision making block 735. Passenger monitoring sensors 710 may also be provided. Such sensor may be used to biometrically identify specific passengers within the vehicle. Detecting individual passengers can allow the recommendation system, in some implementations, to access corresponding passenger preference and attribute data, which may also be used in considered by the recommendation system. As with vehicle and environment sensors (e.g., 705), multiple different biometric and passenger monitoring sensors (e.g., 710) may be provided and the data generated from these sensors may be collectively processed using sensorfusion/decision making logic 735. This information may be used to augment and enhance autonomous driving and path planning actions by the autonomous vehicle to enhance the passenger experience. The sensor fusion logic (e.g., 753) may also be utilized to provide in-cabin services and make adjustments to instruments (e.g., 720) in-cabin not directly related to the autonomous driving system, but, which nonetheless can assist in enhancing the user experience and comfort.

In this specific example illustrated in FIG. 7, the recommendation system may be used to assist certain users who suffer from allergies to airborne allergens. For instance, sensors 705 may include an allergen sensor 725, which may detect the presence and concentration of allergens in air within the cabin of the vehicle or in the atmosphere outside the vehicle. Biometric monitors (e.g., 710) may be provided to identify a particular user within the vehicle, from which personal attribute information may obtained, including alerts regarding susceptibility to allergies, asthma, or other sensitivities to certain allergens. In this example, passenger monitors/sensors 710 may include a heart rate monitor 730, which may detect increases in heart rate of passengers within the vehicle (which in some cases may be attributable to the passenger struggling to breath due to an allergy or asthma attack. The sensor fusion block 735, in this example, may take this sensor data (from 725 and 730) as inputs and cause a HEPA filter instrument 740 to be activated to attempt to alleviate the issue with allergies. It should be appreciated that the example of FIG. 7 involving allergen filtering is but one illustrative example of one of many different passenger experience enhancements, which may be realized through the use of a recommendation system integrated with the autonomous driving pipeline provided within a vehicle, among other examples.

In addition to providing inputs to vehicle systems to enable in-vehicle features to be adjusted to enhance passenger comfort and experience, an example recommender system may also utilize information collected from an autonomous vehicle's sensors to provide recommendations of relevance to the passengers given their current route or characteristics, emotions, or events detected as affecting the passengers. For instance, the vehicle may detect identities of the passengers in the vehicle (e.g., through biomarkers, such as through facial or voice recognition) and determine, from preference data of the group of passengers, a recommendation of a particular hotel or restaurant that the recommender system computes as likely satisfying the group of passengers in the vehicle and which is on or near the path being taken by the vehicle, among a variety of other potential concierge-type services, and other services. Indeed, as the gap between humans and machines narrows, humans are progressively welcoming, accepting, and trusting of machines and their capabilities. For instance, reliance on computing logic capable of handling queries and recommending information on matters such as shortest/fastest route navigation to a destination, closest ‘coffee’ shop, offer movies recommendations, or where to go for the upcoming anniversary celebration, etc. may be implemented through an example recommender system (e.g., utilizing passengers' profile and preference information).

It may be anticipated that, as systems and services improve, and users become more accustomed with interfacing and using these systems, user expectations may become ever more demanding. Likewise, as autonomous vehicles become more prevalent and widely adopted, it is likely that passenger-users will have similarly high expectations for a system they literally entrust their lives and safety to. Implementing such autonomous vehicles, upon which a user may trust, may depend on sophisticated in-vehicle computing resources interfacing with a myriad of high-end sensors, such as cameras, radars, LIDAR sensors, 5G communication, Hi-Def GPS, as well as sensors and monitors (and accompanying logic) capable of recognition the ‘locale’ of the vehicle's (and its passengers') surrounding environment, the weather, terrain, road conditions, as well as the identity of the occupants inside the vehicle (e.g., ‘solo’ driving, with family, or co-workers, etc.). It is expected that such high level autonomous vehicles will command high manufacturing and programming costs (and overall cost), as well as costly and high-tech maintenance and a finely orchestrated, tuned collection for maximum, reliable, accurate performance and Quality-of-Service (QoS). As such, higher level autonomous vehicles (at least in their early generations prior to widespread adoption) may be prohibitively costly to the average household, and overly risky to the insurance industry, given developing maintenance and replacement costs. Accordingly, it is possible that low-level autonomous vehicle solutions (e.g., L1-L2) emerge as popular choices in advance of higher-level autonomous vehicle solutions (e.g., L3-L5) dominating the marketplace. For instance, partially autonomous (or even non-autonomous) vehicles may be provided with integrated or after-market lower-end and lower cost solutions with comparable QoS service.

In some implementations, higher-level autonomous vehicles may possess communication functionality to communicate over wireless communication channels with neighboring vehicles and computing systems within these neighboring vehicles, to share information collected and analyzed by the autonomous vehicle as well as plans, events, and other environmental information determined by the autonomous vehicle. In some implementations, the presence of high-end autonomous vehicles in a heterogenous autonomous/non-autonomous driving environment may be leveraged to collaborate with and impart autonomous driving “knowledge” to lower-end vehicles' computers. Additionally, in some cases, roadside computing systems or cloud-based computing systems may be utilized to communicate with lower-end vehicle's computing systems to augment the intelligence and functionality of these vehicles. Such solutions and systems may help minimize the dependency of lower level cares on high-end sensor suites, as well as native support for a defined minimum set of capabilities and services to help close any gaps in providing core autonomous driving functionality to other neighboring vehicles. In addition to assisting with the provision of information and data for use in delivering autonomous driving functionality to neighboring vehicles, a higher-level autonomous vehicle possessing a recommendation system, such as described herein, may likewise share results and services enabled through its recommendation system to neighboring vehicle systems.

With the advent of smartphone, artificial intelligence, social media, and a growing number of other websites and software services, there is a demand for recommender systems in a variety of industries. Within the realm of driving and travel (e.g., within autonomous vehicles), a set of frequent and expected travel-related queries and services may be defined, which may be tied to information accessible through various sensors on a vehicle outfitted with autonomous driving logic. Returning to FIG. 6, a collection of sensors in a sense phase 605 may be primarily provided to feed the capabilities for autonomous vehicle systems' core path planning, missing planning, and decision-making functions. Accordingly, the planning phase 610 may support path planning, alert of potential autonomous vehicle level challenges, among other functions. Additionally, sensors in the sense phase 605 may also collect information which reflects the status, identity, and conditions of occupants of the vehicle; environmental conditions relating to the occupants' comfort (e.g., heat, cold, humidity, etc.); safety (e.g., vehicle restraint engagement status, travel through an accident-prone area, flash flood danger, travel through high-crime areas); among other information. Occupant identification sensors (e.g., to identify specific users, emotions of users, and/or demographic information of the occupants, etc.) may also enable preferences of the occupant(s) to be identified (e.g., by accessing corresponding preference settings or models for the specific occupants or based on the single- or multi-modal attributes of the occupants) and utilized in generating recommendations (e.g., restaurant recommendations, activity recommendations, path planning modifications, retail recommendations, etc.) using recommendation system 620.

In some implementations, through an example recommendation system 620, the in-vehicle autonomous vehicle system may additionally provide identification of weather concerns along a route (e.g., rain, fog, snow, extreme temperatures); recommendations of places to eat, places to stay, points of interest, service stations, retail, etc. along a path; adjustments to the in-vehicle environment customized to the identified passengers; among other example services. Input utilized to derive such services may be shared with those applicable within the context of the system's core autonomous driving functionality, such as would be relied on for navigation and alternate route mission planning. In some implementations, recommendation system may be utilized to generate alerts for presentation on the vehicle's audio and/or graphic displays, such as to alert a driver of potential areas of concerns, prepare one or more passengers for a handover or pullover event, warn passengers of the likelihood of such events, warn passengers of potential downgrades in the autonomous driving level (e.g., from L5 to L4, L4 to L3, etc.) based on driving conditions detected ahead (and also, in some implementations, user preference information (identifying the user's risk and manual driving tolerances)), among other examples. In some instances, the recommendation system may generate results and recommendations for consumption by the autonomous vehicle (e.g., either or both the planning phase logic (e.g., 610) and in-vehicle environment adjustment block (e.g., 625)) at varying intervals or frequencies. Similarly, when sharing such recommendations with neighboring vehicles, some shared recommendation information may be satisfied at a lesser rate of update, while others, such as weather and traffic conditions, involve more frequent, up to the minute rate of refresh, with high communication bandwidth support and precise positioning reporting from the vehicle, for which vehicles of lower-level type sensors may be hard-pressed to natively support. In some instances, the rate of recommendation information delivery from a higher-level autonomous vehicle to a lower-level autonomous vehicle may be based on an identification (by the higher-level vehicle) of the particular capabilities of the neighboring vehicle. For instance, a neighboring vehicle may be provided with some processing functionality and sensors allowing the higher-level vehicle, upon identifying these capabilities, to send different recommendation types and/or send recommendations at a different frequency than it would when interfacing with another lower-level autonomous vehicle model.

Turning to FIG. 8, a simplified block diagram 800 is shown illustrating the enhancement of a lower level autonomous vehicle with various enhancement modes, each capable of providing various modes of environment description, that when combined, complement/supplement the low-level capabilities of a lower-end autonomous vehicle, for a specific set of conditions that personalizes the occupants criteria, effectively enhancing, or artificially augmenting, its overall recommender response, which may be operate on a particular region or locale or other set of conditions. As shown in this example, lower-end sensors 805 outfitted on a particular lower-level autonomous (or non-autonomous) vehicle may be supplemented through various extraneous higher-capability sensors (e.g., 810-830). Such sensors, including some with specific functions, may complement the sensors (e.g., 805) of lower-end autonomous vehicles and even provide data to after-market recommendation systems provided on low-capability or non-autonomous legacy vehicles.

In some implementations, data generated by these various sensors may be provided for consumption and/or hosting by one or more cloud- or fog-based computing environments (e.g., 835). In some implementations, such a solution may serve to democratize and/or generalize data collected within environments in which autonomous vehicles are present. Aggregating collection of at least a portion of this data may further allow additional processing to be performed and data collection and offload to maximized, such as to address specific needs of varying “client” vehicles interfacing with these services (e.g., 835), for instance, to obtain types of sensor-induced data for the type missing, demographics, context, delivery of agglomerated results, results unique to a particular region or area, among other examples. Such components, or a subset of them, may provide the cloud (e.g., 835) with various levels of sensory information, to help cross-correlate information collected within the environment, and effectively integrate the various data and sensors as a service for client autonomous vehicles with lower-end sensor capabilities, permanently or temporarily damaged/disabled sensors (including on high-end autonomous vehicles), or vehicles possessing less than a full suite of high-level sensing or compute capabilities, among other examples.

As noted above, various extraneous sensors may be utilized to build a more robust collection of sensor inputs, which may be aggregated, cross-correlated, and/or bundled as data- or autonomous driving support-as-a-service. In some examples, sensors may include aerial drones (e.g., 815), blimp drones (e.g., 810), or other flying devices with sensors providing aerial traffic and/or environmental support. Aerial drones may provide aerial traffic analysis, including communication capabilities to provide fast alerts to a cloud- or fog-based service or to in-range autonomous vehicles devices directly. Such traffic information may include examples such as traffic reports, safety reports, accident reports, emergency alerts, wrong-way driver alerts, road-rage alerts, etc. Blimp drones (e.g., 810) may provide similar information and services provided by aerial drones, but may be capable of being deployed in more turbulent weather. Auto-pilot, ground-based drone and other vehicles (e.g., 820) may also be provided (e.g., an unmanned drone vehicle, a smart snow plow, smart street sweeper, public transportation vehicle, public safety vehicle, etc.), which may systematically or routinely navigate various road segments and may be outfitted with sensors to detect conditions in these road segments to assist in capturing information on traffic flow, the state of roads (e.g., detecting pot holes, bridge conditions, road debris, ice or snow, smog levels, road grade, allergen levels, etc.). As mentioned above, sensors of other autonomous passenger vehicles, such as high level autonomous vehicles (e.g., 825) may also be leveraged, as well as beacon, roadside, and road-embedded sensors (e.g., 830). Beacon, roadside, and road-embedded sensors (e.g., 830) may be provide as stationary or movable sensors positioned within urban areas and key rural areas (e.g., near areas prone to flash floods, wildlife and livestock crossings, avalanches, etc.) to detect information and provide data describing traffic flow, weather, safety information, commercial and retail promotional information, tourism information, among other information. In some cases, these sensors may be integrated in or be coupled to other roadway features, such as road signs, traffic lights, billboards, bus stops, etc. Additionally, various extraneous devices (e.g., 810-830) may also serve as an access point for a lower-level vehicle to access and receive data from a cloud service (e.g., 835) aggregating data and providing recommendation services based on this data (e.g., based on the vehicle being in the proximity of one of these other devices (e.g., 810-830) when querying or being pushed recommendation data, among other example implementations.

In some implementations, data provided to an in-vehicle computing system of a vehicle (e.g., 805) may be timed, filtered, and curated based on the specific characteristics and capabilities of that vehicle. Additionally, passenger information may be collected at the vehicle and may be shared (e.g., in a secured, anonymized manner) with extraneous systems (e.g., 810-830) and data shared with the vehicle may be further filtered and/or curated based on preference information determined for the vehicle's occupants. In addition to occupant specific factors (e.g., how many passengers, demographics of the passengers, the relationships of the passengers to each other, etc.), additional factors influencing the amount and type of support provided to a lower-level vehicle may include the time of day (e.g., rush hour, meal times, times corresponding to a work or school commute, etc.), the length of the travel (e.g., long distance or short), and sensor and autonomy level information of the particular model of the vehicle, etc. As shown in FIG. 8, when coupling (at 845) the information collected from a lower-level vehicle's sensors and the compute capabilities of the vehicle with the information and services provided through other sensors (e.g., at 810-830) and the compute resources of other systems (e.g., 810-835) to enhance the capabilities, QoS, safety and comfort of such lower-level vehicles (at 850) at a lower, more accessible cost. In some cases, these robust recommendation capabilities may be extended to lower-level vehicles, which, like with some higher-level autonomous vehicles, may also detect and further consider occupant-specific preferences and settings (at 840) when delivering these recommendations. In some implementations, recommendation services provided or supported by such systems extraneous to the vehicle may be provided as part of a municipal, regional, or national infrastructure, in connection with advertisement platforms (e.g., billboards), or as a cloud-based sensor- or recommendation-system-as-a-service, among other example implementations. Recommendation services and supplemental sensor data and outputs, in some implementations, may be provided for consumption by a lighter-weight recommendation system, in-vehicle GPS system, or other system, such that the information and functionality of this existing system is enhanced and augments by the information and computing logic provided outside the vehicle (e.g., by 810-835), among other instances.

While in the preceding example recommender systems are described, which allow a vehicle to leverage multiple sensors provided by multiple other devices to build more robust recommendations for lower-level autonomous vehicles, in some implementations, similar infrastructure may be further utilized to also support recommender systems on high-level autonomous vehicles. In some instances, a high-level autonomous vehicle may not only support autonomous operation at its highest level (e.g., L4 or L5), but may also support autonomous driving functionality at relatively lower levels (e.g., L3). Indeed, depending on the road conditions, sensor integrity, driver preference, and other factors, the autonomous driving stack implemented through a vehicle's in-vehicle computing system may be programmed to support operation in multiple different autonomous driving levels and may be manually or automatically (e.g., in response to a detected event or condition) toggled between levels. For instance, although a user may generally wish to remain in the highest supported level of the vehicle (e.g., always use L4), the reality of the vehicle's sensor conditions and the outside driving environment may constrain the user to lower, human-assisted levels of autonomy during some periods of time and in some circumstances. As an example, if sensors of an L4 autonomous vehicle are splashed with mud or coated in salt on icy roads, critical sensors supporting the L4 mode may be (temporarily) compromised, forcing the vehicle to function in a lower autonomous driving level, among other examples.

In some implementations, a recommender system or other components of an on-board computer of the vehicle, may be utilized to detect and even predict instances where the vehicle would potentially need to downgrade its autonomous driving level. In some examples, in response to detecting such a condition, the recommender system may interface with other devices or a service aggregating sensor data collected through sensors of other devices to provide additional information to the autonomous vehicle and fill-in missing information typically collected by one of its compromised sensors and used by the autonomous vehicle to support a higher autonomy mode. In one examples, in order to support such functionality, a recommender system may be provided, which informs the car of its capabilities. In some cases, this recommender system may be different from a recommender system provided on the same car for providing recommendations for consumption by users and/or to enhance passenger comfort, such as described in some of the examples herein. Indeed, as with other recommender systems, the core sense, plan, act pipeline (e.g., as illustrated in FIG. 6) may be leveraged by the recommender system. Sensor status may be determined in some cases by a system diagnostic tool. In other cases, plan logic or other machine learning logic of the autonomous vehicle may detect that data received from various sensors indicates that the specific sensors are in some way compromised (e.g., obstructed, malfunctioning, disabled, etc.). Based on the sensors status detected, the vehicle's system may determine, in real-time, the status of the vehicle and its autonomous driving functionality. Indeed, the system may determine the current maximum level of autonomy usable based on this status information. Recommendations may then be generated based on this determined status of the vehicle's sensors and its autonomous driving capabilities. Indeed, since sensing capabilities may change over the course of the life of the vehicle and even during the course of an individual drive, the status and the corresponding recommendations generated by a recommender system may change from drive to drive. In some cases, the recommender system may generate recommendations to use a specific one of multiple supported autonomy levels, based on the detected scenario and system status. As the autonomous driving level will lower as sensor information is unavailable or of lower quality, the recommender system may attempt to obtain and use sensor data generated and communicated from other devices or services extraneous to the vehicle (e.g., crowdsourced data, updates from the cloud), and use this information to fill the holes in the vehicle's own functionality and thereby restore or raise the level of autonomy of the vehicle.

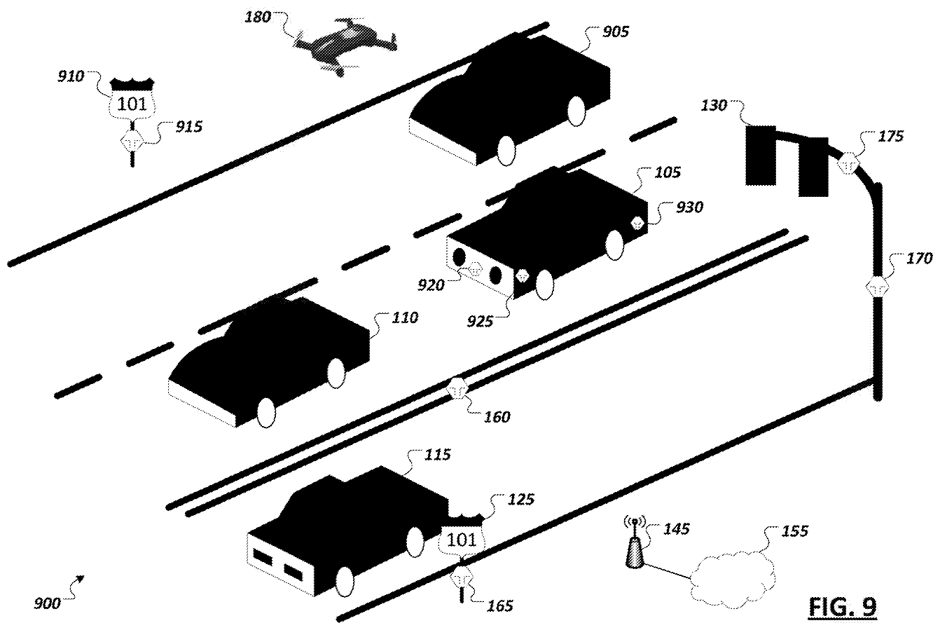

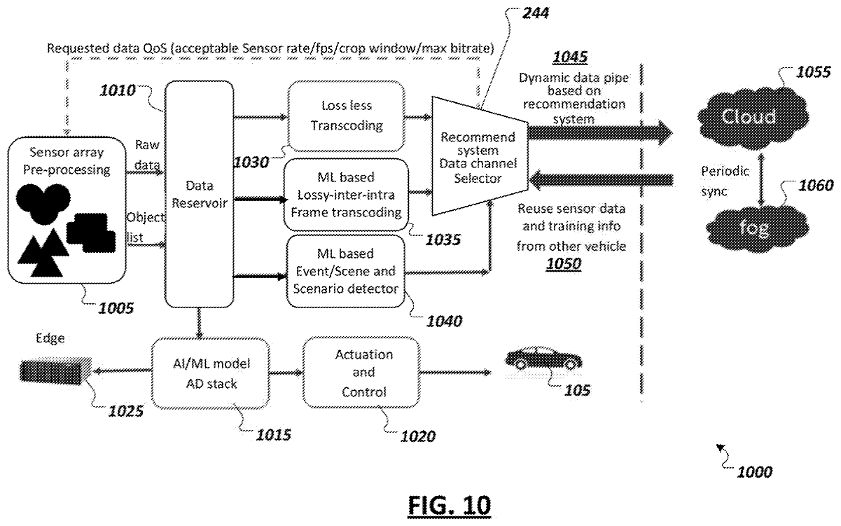

Turning to FIG. 9, a simplified block diagram 900 is shown illustrating an example driving environment in a particular locale including one or more vehicles (e.g., 105, 110, 115, 905, etc.), as well as other devices (e.g., 130, 180, etc.) and structures (e.g., 125, 910, etc.) provided with sensors (e.g., 160, 165, 170, 915, etc.), which collect information that may be relevant and usable as inputs (or to generate inputs) to the autonomous driving logic of a vehicle. In this example, an autonomous vehicle 105 is provided, which may support autonomous driving up to a particular level (e.g., L4). Various sensors (e.g., 920, 925, 930, etc.) may be provided on the vehicle 105 to provide the data used by the autonomous driving pipeline implemented in a computing system on the vehicle 105 to determine paths and decisions to be carried out by the vehicle 105.

In one implementation, the in-vehicle system may detect that one or more of the sensors (e.g., 920, 925, 930) of the vehicle 105 have been compromised, making the data they generate of lesser reliability. In some cases, detecting that one or more sensors have become compromised may cause the vehicle's recommender system to downgrade its level of driving autonomy based on the decrease in reliable sensor data supporting the autonomous driving functionality of the vehicle 105. In other cases, in order to avoid or minimize the degree of the downgrade in the autonomous driving level of the vehicle 105, the vehicle may access sensor data, object recognition results, traffic recognition results, road condition recognition results, and other data generated by other devices (e.g., 110, 115, 125, 130, 180, 910, etc.) that is relevant to the present locale of the vehicle 105 or locales corresponding to a planned path or route of the vehicle 105. For instance, a sensor 925 may be detected as failing to operate properly and the vehicle's 105 system may access data generated by other devices (e.g., 110, 115, 125, 130, 180, 910, etc.) to replace or supplement the reduced fidelity caused by the compromised sensor 925. In some cases, the vehicle 105 may filter data available from other sources (e.g., 110, 115, 125, 130, 155, 180, 910, etc.) based on the location of the compromised sensor (e.g., to obtain data from sensors (e.g., 160, 165, 175, on vehicle 115, aerial done 180, etc.), which are most likely to provide information that would ordinarily be provided by the compromised sensor 925 (e.g., on the left side of the vehicle 105), among other examples. Further, rather than inundating the vehicle 105 with a constant stream of data in response to a faulty sensor, in some implementations, targeted guidance may be sent to the vehicle and similarly targeted recommendations made to correspond to potentially troublesome or challenging locations or events faced by the vehicle 105 in light of its compromised sensor(s).

As in other examples discussed herein, in some instances, sensor data and observations generated by the collection of sensors and their devices may be provided to and aggregated by backend services (e.g., in network 155). In some instances, various network access points (e.g., 145) may provide low-latency network communication channels through which vehicles (e.g., 105) may access the intelligence and information accumulated by the service. In some cases, the service may identify the type of vehicle (e.g., 105) and receive a report from the vehicle 105 identifying which sensors (e.g., 925) are compromised and utilize this information to appropriately filter and stage/time communications with the vehicle 105 based on what the service determines to be the specific needs or demands of the vehicle 105 (in light of the reported sensor issue). Regardless of the source of the supplemental data, the recommender system may utilize this supplemental information to assist in guiding the operation of the autonomous vehicle 105.

In some instances, it may take only moments from the status of one or more sensors to degrade from operable to compromised. For instance, it can take but a moment for a mud splash, an unexpected malfunction, poorly angled headlight or sunlight, etc. to compromise the integrity of a sensor. Transitioning to a recommender-recognized, lesser driving autonomy mode in that moment may be unduly demanding from an operational and practical perspective. Accordingly, in some implementations, a recommender system of a vehicle (e.g., 105) may possess predictive analytics and machine learning logic to predict instances where the use of the recommender system (and supplemental sensor and object recognition data) or change in autonomy level is more likely. For instance, one or more machine learning models may be provided to accept inputs from systems of the vehicle (e.g., 105) to predict when a trip is more likely to rely on such changes to the operation of the vehicle's higher level autonomous driving functionality. For instance, inputs may include sensor status information, system diagnostic information, sensor age or use statistics, weather information (e.g., which may result in sloppy roads, salt-treated roads, reduced visibility, etc.), road condition information (e.g., corresponding to roads that are more likely to hamper functioning of the sensors (e.g., dirt roads, roads with standing water, etc.), among other inputs. If such a likelihood is predicted, the vehicle may prepare systems (e.g., preemptively begin accepting data from other devices describing the current or upcoming stretches of road along a planned route) in case an issue arises with one or more of the sensors, allowing the vehicle to react promptly to a sensor issue and adjust operation of its autonomous driving logic, among other example implementations.

As noted in some of the examples herein, some autonomous driving implementations may utilize a system of sensors including sensors integrated or otherwise coupled to the vehicle (including sensors sensing conditions inside and outside the vehicle) and sensors outside and extraneous to a given autonomous vehicle. At least portions of this data may be communicated and shared with other actors, such as through vehicle-to-vehicle communication, communication between vehicles and roadside or traffic-sign/signal-mounted sensors, communication with backend sensor data aggregators and services, communications between drones and autonomous vehicles and/or sensor data aggregations services, among other examples. With higher-level autonomous systems utilizing high-end sensors, much of this data is large in size and high in resolution. Accordingly, such systems may generate huge amounts of data for collection and inter-device communication, making scaling and offloading of such amounts of data (e.g., to data centers, cloud- or fog-based services, and other devices an expensive operation. In some implementations, system protocols and logic may be provided to optimize and efficiently control data collection by dynamically determining best approaches within the system for data offloading (e.g., in terms of cost and time).

Table 1 shows a summary estimating some of the sensor data generated on an example of a single autonomous car. In this example, the total bandwidth can reach up to 40 Gbits per Second (e.g., ^{˜}20 TB/hr). Accordingly, when multiplying this by the theoretically millions of autonomous vehicles, which may someday occupy roadways, transmitting every bit of data collected and storing such a humongous amount of data (e.g., for deep learning models to train on) may be prohibitively very expensive. Additionally, existing network infrastructure may be overwhelmed by the continuous communication of such large amounts of data, jeopardizing the use of the same infrastructure to retrieve the data analyzed and respond/react to scenarios in real time.

TABLE 1
Sensors In Autonomous Car

| Sensor | Number of | Data Generated |
|---|---|---|
| Type | Sensors | per sensor |
| Radar | 6 | 15 Mbits/s |
| LIDAR | 5 | 100 Mbits/s |
| Camera | 12 | 3500 Mbits/s |

In one example, an autonomous driving system may be provided, whereby devices participating in the system (e.g., individual autonomous vehicles, drones, roadside sensor devices, systems hosting cloud-based autonomous driving support, etc.) are provided with logic to assist in intelligently reducing the overall amount of sensor data collected and offloaded (e.g., with unneeded data either not collected and/or stored locally in the vehicle) by leveraging machine learning models and logic to intelligently upload and transfer data. For instance, sensor data collection may be reduced by applying distributed machine learning training and transfer model techniques to reduce this cost/overhead. In such an approach the “conditions” for which additional data is “required” by any device may be specified and communicated with a machine learning engine on the device (e.g., a machine learning engine in the connected autonomous vehicle). As a result, the connected device will only collect and transport the sensor data that meets the specified conditions, which may be updated (e.g., dynamically) as the model continues to evolve and train. Further, in some implementations, machine learning-based intelligent sensor data upload may be implemented to intelligently filter and time the communication of sensor data from one device to another and/or from one device to the cloud. Traditional systems may either collect all the data for offline uploading (e.g., an end of the day data upload or upload during vehicle charging, parking, etc.) or online uploading (e.g., constant upload of data during the drive time whenever network connections are available). While some data may need to be transferred to the cloud or another device immediately or in (almost) real-time, transport of all the data in real time is not efficient, costly, and a waste of scarce wireless resources, jeopardizing the scalability of such a system. Accordingly, in an improved example autonomous system, participating sensor devices (e.g., connected vehicles) may utilize additional machine learning techniques to learn from such attributes as the time sensitivity of the data, availability of data transport options (e.g., cellular, wi-fi, the transport technology available (e.g., 4G, 5G), and the cost and available throughput of the channels) at different locations and times of the day, and other usages and preferences of vehicle users (and corresponding network and compute usage based on these usages (e.g., in-vehicle media streaming and gaming, etc.,) to determine an optimized option for when and how to transport what data to the cloud or another connected device.

Turning to FIG. 10, a simplified block diagram 1000 is shown illustrating an enhanced autonomous driving system including blocks (e.g., 1005, 1035, 1040, 244, etc.) providing functionality to intelligently manage the creation, storage, and offloading of sensor data generated by a sensor array 1005 on a corresponding autonomous vehicle. For instance, the sensor array 1005 may be composed of multiple different types of sensors (such as described herein) and may be further provided with pre-processing software and/or hardware to perform some object recognition and provide object list results as well as raw data. In some implementations, the pre-processing logic may also assist in optimizing data delivery and production. Data from the sensor array 1005 may be provided to an in-vehicle data reservoir 1010 (or memory), which may be accessed and used by other functional blocks of the autonomous driving system. For instance, an autonomous driving stack 1015 using various artificial intelligence logic and machine learning models may receive or retrieve the sensor data to generate outputs to the actuation and control block 1020 to autonomously steer, accelerate, and brake the vehicle 105. In some cases, results generated by the autonomous driving stack 1015 may be shared with other devices (e.g., 1025) extraneous to the vehicle 105.

Continuing with the example of FIG. 10, sensor data deposited in the data reservoir 1010 may also be processed to assist in reducing the footprint of the data for deliver to processes and services, which may not need the data at its original resolution. For instance, loss-less transcoding (at 1030) may be applied. In some implementations, machine learning-based lossy-inter-intra frame transcoding may be performed (using block 1035), as well as machine learning based event/scene and scenario detection (at 1040). Translated data generated by these blocks (e.g., 1030, 1035, 1040) may be provided to a recommender system 244 of the autonomous vehicle, which may be utilized to detect and predict attributes of communication channels and recipients of the prepared data. In some cases, a dynamic data pipe 1045 may be supported by the recommender system 244, which may be provided to cloud- and/or fog-based services and repositories (e.g., 1055, 1060) for further processing. Additionally, the recommender system 244 (as well as other components of the autonomous driving system) may make use of result data (e.g., 1050) from other sensor devices and cloud-based services (e.g., 1055, 1060), such as results from other machine-learning models that take, as inputs, sensor data from a multitude of autonomous vehicles and other sensor devices, among other examples.

In an illustrative embodiment, an autonomous driving system may consume at least the data collected by two sensors (e.g., front and rear cameras with 2 megapixel (MP) resolution running at 30 frames per second (fps)) and process and analyze the data using one or more machine learning models executed by the in-vehicle autonomous driving stack to path plan and respond to various scenarios. In some instances, autonomous vehicles may not natively possess models or logic “experienced” enough to fully operate in complex and dynamic environments, without constant data collection (from its own sensors and external sources) and continuous or incremental training of its models. Indeed, performing such maintenance using collected data may be a critical task, particular as autonomous vehicle deployment is in its infancy, among other example issues and benefits. In such a scenario, however, the amount of data that may be collected, preprocessed, and stored may be very expensive. For instance, in the case of ten autonomous cars driving for 4 hours daily, each with two camera sensors at 2MP resolution (24 bits per pixel) operating at 30 fps generates, 2880 MBits per second (360 Mbytes per sec) of data will be generated. In only four hours a total of 51.48 TB of data will be generated. In a year assuming average work days are 261 days, total amount of data being generated by these ten cars will be nearly 14 Peta Bytes of data.

In some implementations, a recommender system (e.g., 244) may detect conditions presently facing or expected to face a connected vehicle and may recommend and direct data handling procedures for other component of the autonomous driving system, including offloading of data to external systems, application of transcoding and compression to sensor data, and even the generation of the sensor data itself by the sensor array 1005. For instance, the recommender system 244 may recommend that operation of one or more of the sensors in the sensor array 1005 be adjusted based on the determined conditions in which the vehicle is found (e.g., conditions affecting the network resources and data sharing opportunities for the vehicle, conditions affecting the complexity of the autonomous driving tasks and classifications facing the vehicle along a planned path, etc.). For instance, the recommender system 244 may instruct one or more sensors in the sensor array to adjust the quality, resolution, or fidelity generated by the sensors based on these conditions, such as by specifying a minimally acceptable quality of the data based on the conditions (e.g., on the basis of the sensor's rate, frames per second, crop window, maximum bitrate, etc.), among other examples.

In some implementations, data resampling and pruning may be applied to reduce the amount of data output by sensor devices on an autonomous vehicle. For instance, due to high correlation between video frames generated by example camera sensors on an autonomous vehicle, resampling may be applied to reduce the size of data generated by such cameras by multiple factors (e.g., resampling the data from 30 fps to 1 fps reduces the data size by a factor 30). In some instances, lossless compression may also be applied (e.g., at 50x compression rate), such that when both resampling and compression are applied the net data reduction may result in compressed data that is approximately 0.05% of the original data size. Accordingly, from the preceding example, through down sampling and heavy preprocessing of the collected data (at a resolution where accurate training remains feasible), the amount of data may be reduced to approximately 6 Tera Bytes of data from the ten example cars with two 30 fps with 2MP camera sensors, among other examples.

The example above illustrates the difficulty in handling data generated from ten autonomous vehicles, each with only two camera sensors each. However, in more complex scenarios, thousands of autonomous vehicles may share the roadway and be outfitted with many more sensors of varying varieties. Accordingly, in such complex scenarios, thousands of peta bytes of data may be generated and communicated over wireless communication channels within an autonomous driving environment. Transmitting all this data and storing it in cloud systems for training purposes will be a very expensive and time-consuming task. Table 2 shows training durations for some example machine learning models, which may be employed in an autonomous driving system (e.g., with a GPU with 332 GFLOPS performance) and use the generated sensor data from multiple vehicles of sensor devices.

TABLE 2

| | Number of | | Train time | |
|---|---|---|---|---|
| | Parameters | | (for 100 | |
| Model | (in millions) | GFLOPS | Epochs) | |
| AlexNet | 60.97 | 1.34 | 6.3 | hrs. |
| VGG-16 | 138.36 | 14.7 | 69.59 | hrs. |
| GoogleNet | 7 | 1.6 | 7.54 | hrs. |
| V1 | | | | |
| ResNet-50 | 25.56 | 3.9 | 18.39 | hrs. |
| ResNet-152 | 60.19 | 11.4 | 53.76 | hrs. |
| Inception V4 | 42.71 | 12.35 | 58.24 | hrs. |

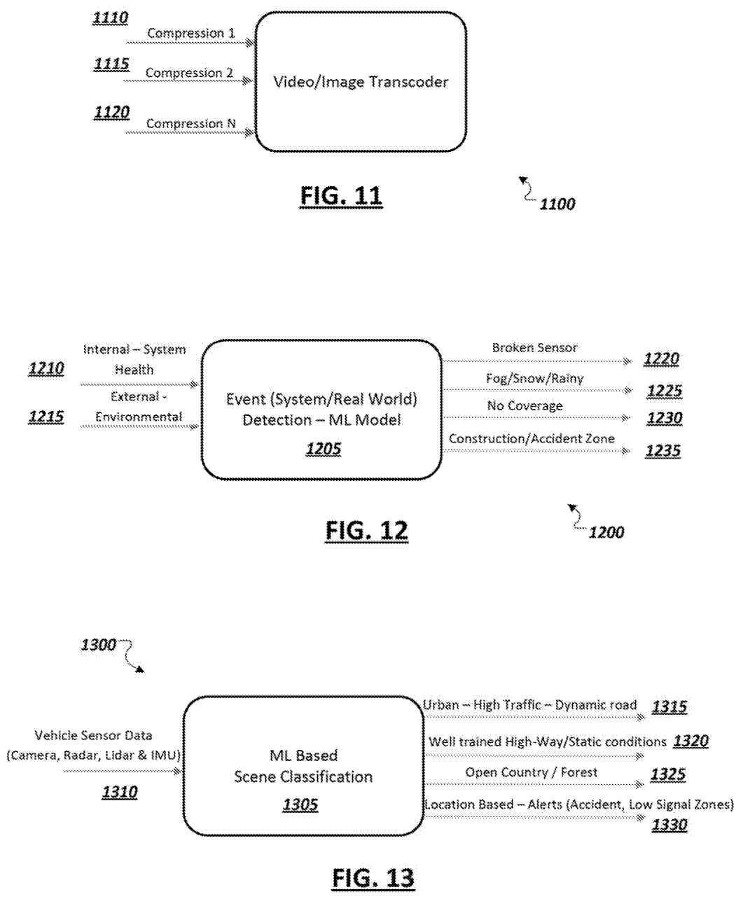

In some implementations, as illustrated by the simplified block diagram 1100 of FIG. 11, a machine learning-based lossy-inter-intra frame transcoder 1035 can perform concurrent data compression using standard codecs (JPEG2000, m-jpeg, mpeg4 and lossless mpeg4s) and also advanced machine-learning-based super compression. Data compression in this manner may help to transcode captured images to different profiles (e.g., bit-rate, frame rate, and transfer error constrains), among other example uses and examples of potential advantages. For instance, as an example, a high profile, low-compressed stream may be postponed to improve current network efficient when a vehicle is traveling through low bandwidth areas, among other example use cases and applications.

As shown by the simplified block diagrams 1200, 1300 of FIGS. 12 and 13, a machine-learning-based event or scenario detection engine (e.g., 1040) may be further used to improve data transfers and storage within an autonomous driving system. As introduced above, passive uncontrolled data collection and transmission may be very expensive. In some implementations, filtering data collection and transmission may be substantially on the basis of internal and/or external events based on machine-learning event and/or scene classifications (representing a recommendation in data collection). For instance, detecting an event such as one or more faulty sensors on a connected car, may cause an increase in communications with extraneous data sources (e.g., other connected cars or other sensor devices). As another example scenario or event, detecting a particular type of inclement weather (e.g., fog, snow, rain, etc.) may force the vehicle not to use ambiguous data, preserve and use high definition data, enhance its own sensor data with supplemental data from other external sources, among other examples. Such events may be detected by providing data from one or more sensors of the connected autonomous vehicle to one or more machine learning models (e.g., 1205). For instance, as shown in the example of FIG. 12, internal system health information 1210 may be provided (e.g., from one or more internal sensors and/or a system diagnostics module) along with data 1215 (from integrated or extraneous sensors) describing conditions of the external environment surrounding the vehicle (e.g., weather information, road conditions, traffic conditions, etc.) or describing environmental conditions along upcoming portions of a determined path plan, among other example inputs. The machine learning model 1205 may determine one or more types of events from these inputs, such as broken or otherwise compromised sensors (e.g., 1220) and weather (e.g., 1225) events, such as discussed above, as well as communication channel characteristics (1230) (e.g., such as areas of no coverage, unreliable signal, or low bandwidth wireless channels, which may force the vehicle to collect rich or higher-fidelity data for future use using event and classification models), and road condition and traffic events (e.g., 1235) (which may force the vehicle to prioritize real time classification and data transmission), among other examples.

Turning to the example of FIG. 13, a simplified block diagram 1300 illustrates a machine-learning-based scene classification block 1305, which may be incorporated in the autonomous driving system of a connected vehicle. Various sensor data 1310, such as camera data, radar data, LIDAR data, IMU data, and other sensor data, may be provided as inputs (e.g., multimodal inputs) to the classification model (e.g., a trained convolutional neural network), from which scene classifications may be output. For instance, the model, from the provided sensor information, may detect that the vehicle is currently in (or will soon be in (based on a path plan)) a locale possessing particular environmental features. These environmental features may influence a recommender system on the autonomous vehicle responsible for governing the data collection and offloading by the vehicle's autonomous driving system. For instance, the model 1305 may determine, from the inputs 1310, that the vehicle's environment is an urban environment characterized by high traffic and dynamic conditions (e.g., at 1315), well-trained highway characterized by largely static driving conditions (e.g., 1320), open country or forests characterized by largely untrained roadways and likely under-developed autonomous driving support infrastructure (e.g., 1325), among other examples. Indeed, location-based or -specific scenes or alerts (e.g., 1330) may also be detected from the sensor data 1310, such as low signal zones, accidents, abnormal obstacles or road obstructions, etc. The machine learning models of an example recommender system may accept as inputs, both the event classifications (e.g., from model 1205) and scene classifications (e.g., from model 1305) to determine whether and how to collect and offload sensor data and at what fidelity, frequency, etc. For instance, scenes and events where the autonomous driving system's decision making is likely to be more active (e.g., an urban setting in inclement weather) may result in the recommender system directing high-fidelity data collection, real-time classification of the sensor data, and high-bandwidth low latency communications with various external sensor devices and services, among other examples. As a contra case, on a highway in clear weather, where the sensors of the vehicle are detected to be fully functional, the recommender system may direct different handling of the collection, processing, and offloading of sensor data, among a myriad of other examples, which may be ultimately dictated by the confluence of factors detected for the scene and events facing an example autonomous vehicle.

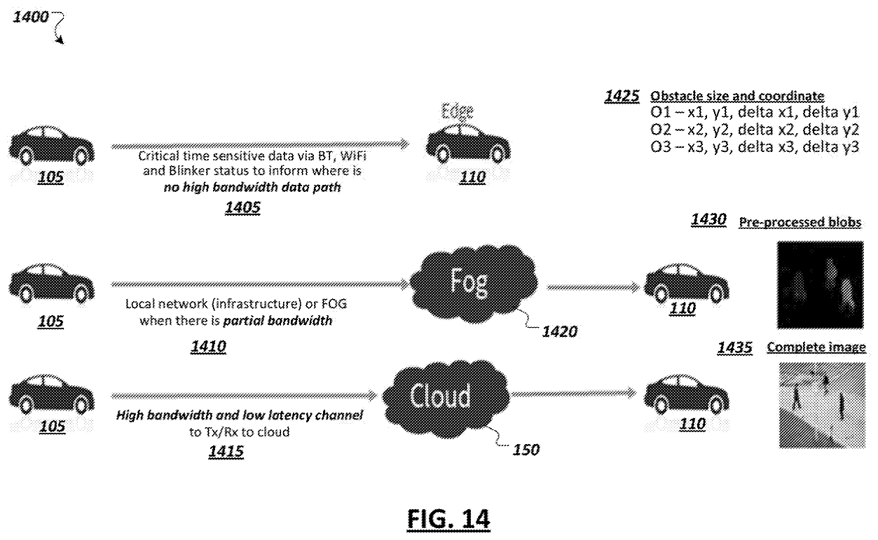

Turning to the simplified block diagram 1400 of FIG. 14, in addition to considering the circumstances of the autonomous vehicle and the immediate demands these circumstances may place on the path planning and decision making logic of the vehicle's autonomous driving system, the nature of the communication infrastructure available for sending and receiving data with other devices, vehicles, or services, may also be considered by a recommender system in determining how to direct data offloading and collection policies applied in that moment at the vehicle. For instance, a recommendation may be determined by the system for how an upcoming data upload is to take place in accordance with a dynamic data upload pipeline, which may likewise leverage one or more machine learning models to intelligently determine an optimized manner of performing the upload (e.g., rather than passively performing the upload in some predefined manner (e.g., at night, when parked, etc.). Such a dynamic, machine-learning-based approach may realize substantial cost and bandwidth savings both for the vehicle as well as the network infrastructure used for these uploads.

As illustrated in the example of FIG. 14, in some instances, a recommender system may adjust the manner of data uploads by an autonomous vehicle, for instance, by uploading at least some selected portion of sensor or result data generated at the vehicle to fog, cloud, or edge cloud systems (e.g., edge computing server, fog device, or road side unit). Such uploads may be based both on the amount of data to be uploaded, as well as the availability connectivity characteristics. An autonomous vehicle system may support communication with a variety of different devices and services through a variety of different communication technologies (e.g., Bluetooth, millimeter wave, WiFi, cellular data, etc.) and may further base offload determinations on the detected communication channel technologies available within an environment and the potential data offload or sharing partners (e.g., connecting to a road side unit through Bluetooth or WiFi, a fog element through mmWave, an edge computer server or cloud service through 5G, etc.). The time and network bandwidth to be consumed in the data transfer may also be computed and considered by a recommender system machine learning model in determining the vehicle's offload behavior. For instance, when multiple potential offload destinations are available, the recommender system may select from the multiple potential alternatives based on the connectivity characteristics detected within an environment. For instance, the recommender may select a particular destination for the offload and the particular communication channel or technology to use. The type and sensitivity of the data to be offloaded may also be considered by the recommender system (e.g., with mission critical data (e.g., post or during accidents) handled differently than data primarily offloaded for use in building maps), among other examples.

FIG. 14 shows various example recommendations an example recommender system may make for offloading data. For instance, at 1405, where critical time sensitive data is to be offloaded (e.g., to an edge device or another vehicle (e.g., 110)), but no high bandwidth data path is detected, the machine learning models applied by the recommender system may result in a recommendation to send the data in a low-resolution format (e.g., 1425), such as merely describing coordinates of abstract obstacles detected by the vehicle 105. In another example, where vehicle 105 has data to offload, but only a partial bandwidth condition is detected (at 1410), the recommender system may determine that the data is to be offloaded to local fog systems (e.g., 1420) in a preprocessed, lower bandwidth format (e.g., 1430). The fog resources 1420 may then make this data available to other devices (e.g., car 110) or even the providing vehicle 105 (e.g., at a later time). In yet another example, a low latency, high bandwidth channel may be detected (e.g., at a time when the vehicle is also detected to be driving in conditions where network communications and compute resources have capacity (e.g., during highway driving, when parked, etc.), and the offload may be performed with full-resolution data (e.g., 1435) directly to cloud-based backend systems (e.g., 150), among other examples.

While all of the functionality necessary for a vehicle to function autonomously may be provided natively through in-vehicle computing systems (and updated, when necessary, through periodic communications over wired or wireless home- or garage-based network connections), as wireless communication technologies and speeds advance, some autonomous vehicle implementations may rely more heavily on communications from extraneous data and compute resources (e.g., outside of or not natively integrated with the vehicle). For instance, with the coming of 5G carrier networks and expansion of 4G LTE coverage, implementations of connected autonomous vehicles and vehicle-to-everything (V2X) systems become more immediately achievable. For instance, given the premium on safety, the safety provided natively through autonomous driving systems on vehicles may be supplemented, augmented, and enhanced using systems external to the car to both provide enhanced and crowd-sourced intelligence, as well as to provide redundancy, such as through real-time high reliability applications.

An autonomous vehicle may communicate with and be directed by external computing systems. Such control may include low level of control such as the pushing of over-the-air (OTA) updates, where the vehicle can receive from a remote control/maintenance center (e.g., belonging to vehicle's or autonomous driving system's original equipment manufacturer (OEM) or provider) software and/or firmware updates (e.g., as opposed to taking the vehicle to the maintenance center to do that manually through a technician). In other, higher-control applications, complete control of an autonomous vehicle may be handed over to an external computing system or remote user/virtual driver on a remote computing terminal. For instance, such remote control may be offered as an on-demand “remote valet” service, for instance, when a handover of control from an autonomous vehicle to an in-vehicle passenger is not feasible or undesirable; to assist a vehicle whose autonomous driving system is struggling to accurately, efficiently, or safely navigate a particular portion of a route; or to assist with a pullover event or otherwise immobilized autonomous vehicle.

In some implementations, when an autonomous vehicle encounters a situation or an event, which the autonomous vehicle does not know how to reliably and safety handle, the vehicle may be programmed to initiate a pullover event, where the autonomous driving system directs the vehicle off the roadway (e.g., onto the shoulder of a road, in a parking space, etc.). In the future, when autonomous vehicles are found in greater numbers on roadways, an event that causes one autonomous vehicle to initiate a pullover may similarly affect other neighboring autonomous vehicles, leading to the possibility of multiple pullovers causing additional congestion and roadway gridlock, potentially paralyzing the roadway and autonomous driving on these roadways. While some instances may permit a handover event from the autonomous driving system to a human passenger to navigate the situation causing the pullover, in other implementations, a remote valet service may be triggered (e.g., when the vehicle is passenger-less (e.g., a drone vehicle, a vehicle underway to its passengers using a remote summoning feature, etc.)), among other example situations and implementations.

In accordance with the above, some implementations of an autonomous vehicle may support a remote valet mode, allowing the driving of the vehicle to be handed off to (from the vehicle's autonomous driving system) and controlled by a remote computing system over a network. For instance, remote control of the autonomous vehicle may be triggered on-demand by the autonomous vehicle when it faces a situation that it cannot handle (e.g., sensors not functioning, new road situation unknown for the vehicle, on-board system is incapable of making a decision, etc.). Such remote control may also be provided to the vehicle in emergency situations in which the vehicle requests remote control. A remote valet service may involve a human sitting remotely in a control and maintenance center provided with user endpoint systems operated to remotely control the vehicle. Such a system may be used to mitigate edge-cases where the autonomous vehicle may pull-over or remain immobile due to inability to make a maneuver given lack of actionable information of itself or its environment. Remote valet systems may also be equipped with functionality to also receive information from the autonomous system (e.g., to be provided with a view of the roadway being navigated by the vehicle, provide information concerning system status of the vehicle, passenger status of the vehicle, etc.), but may nonetheless function independent of the autonomous driving system of the vehicle. Such independence may allow the remote valet service itself to function even in the condition of full or substantial sensor failure at the autonomous vehicle, among other example use cases, benefits, and implementations.

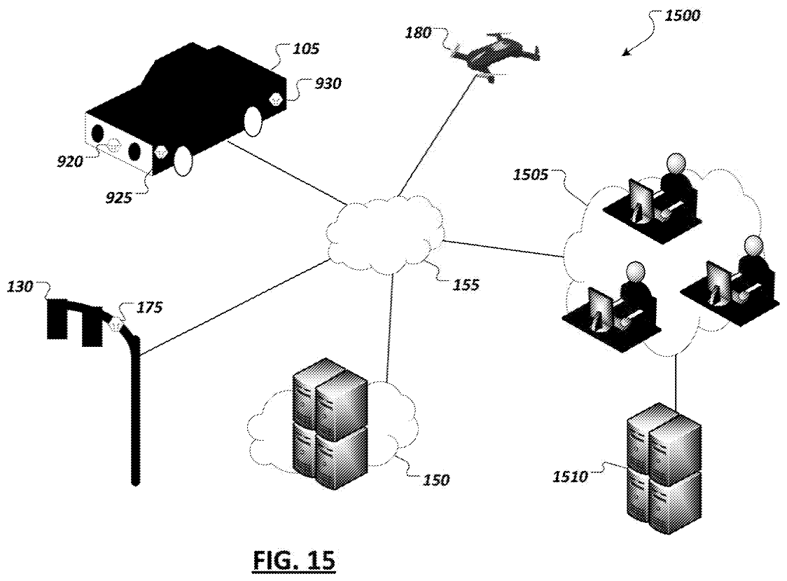

For instance, as shown in the simplified block diagram 1500 of FIG. 15, an autonomous vehicle 105 may include a variety of sensors (e.g., 920, 925, 930, etc.) and autonomous driving logic to enable the autonomous vehicle to self-drive within various environments. As introduced above, in some instances, it may be determined, by the autonomous vehicle (or at the request of a passenger within the autonomous vehicle) that the autonomous driving system of the vehicle 105 is unable to reliably, desirably, or safely navigate a portion of a route in a path plan. The autonomous vehicle 105 may include communications capabilities to interface with one or more networks (e.g., 155) and enable data to be exchanged between the vehicle 105 and one or more computing systems implementing a remote valet service 1505. The remote valet service 1505 may provide multiple user terminal devices, which may allow virtual driver users to observe conditions around the vehicle 105, based on sensor data (e.g., camera views or other sensor information) provided from sensors (e.g., 920, 925, 930, etc.) on the vehicle or sensors (e.g., 175) on other devices (e.g., road side systems (e.g., 130), aerial or ground-based drones (e.g., 180) and even sensors from other neighboring vehicles). The virtual driver may then provide inputs at the remote valet terminal to cause corresponding low latency, high priority data to be communicated (over network 155) to the vehicle 105 to control the steering, acceleration, and braking of the vehicle 105.

In some instances, the vehicle 105 may automatically request intervention and handover of control to a remote valet service 1505. In some cases, this request may be reactionary (e.g., in response to a pullover event, sensor outage, or emergency), while in other cases the request may be sent to preemptively cause the remote valet service 1505 to take over control of the vehicle (based on a prediction that a pullover event or other difficulty is likely given conditions ahead on a route. The vehicle 105 may leverage sensor data from its own sensors (e.g., 920, 925, 930, etc.), as well as data from other sensors and devices (e.g., 130, 180, etc.), as well as backend autonomous driving support services (e.g., cloud-based services 150), to determine, using one or more machine learning models, that conditions are such that control should be handed over to a remote valet service 1505.

In some cases, multiple remote valet services may exist, which may be leveraged by any one of multiple different autonomous vehicles. Indeed, multiple autonomous vehicles may connect to and be controlled by a single remote valet service simultaneously (e.g., with distinct remote drivers guiding each respective vehicle). In some cases, one remote valet service may advertise more availability than another. In some cases, remote valet service quality ratings may be maintained. In still other cases, connection quality and speed information may be maintained to identify real time connectivity conditions of each of multiple different remote valet services. Accordingly, in addition to detecting that a remote handover is needed or likely, an autonomous vehicle (e.g., 105) may also consider such inputs to determine which of potentially many available alternative remote valet services may be used and requested. In some implementations, the selection will be straightforward, such as in instances where the vehicle is associated with a particular one of the remote valet services (e.g., by way of an active subscription for remote valet services from a particular provider, the remote valet service being associated with the manufacturer of the car or its autonomous driving system, among other considerations).

Additionally, remote valet services may also tailor services to individual autonomous vehicles (e.g., 105) and their owners and passengers based on various attributes detected by the remote valet service (e.g., from information included in the request for handover, information gleaned from sensor data received in connection with the handover or remote control, etc.). For instance, tailored driving assistance user interfaces and controlled may be provided and presented to a virtual driver of the remote valet service based on the make and model of the vehicle being controlled, the version and implementation of the vehicle's autonomous driving system, which sensors on the vehicle remain operational and reliable, the specific conditions which precipitated the handoff (e.g., with specialist remote drivers being requested to assist in troubleshooting and navigating the vehicle out of difficult corner cases), among other example considerations.

In some implementations, remote valet services may be provided through a governmental agency as a public service. In other implementations, remote valet services may be provided as private sector commercial ventures. Accordingly, in connection with remote valet services provided in connection with a given vehicle's (e.g., 105) trip, metrics may be automatically collected and corresponding data generated (e.g., by sensors or monitors on either or both the vehicle (e.g., 105) and the remote valet system 1505) to describe the provided remote valet service. Such metrics and data may describe such characteristics of the remote valet service as the severity of the conditions which triggered the remote valet services (e.g., with more difficult problems commanding higher remote valet service fees), the mileage driven under remote valet service control, time under remote valet service control, the particular virtual drivers and tools used to facilitate the remote valet service, the source and amount of extraneous data used by the remote valet service (e.g., the amount of data requested and collected from sources (e.g., 175, 180) extraneous to the sensors (e.g., 920, 935, 930)), among other metrics, which may be considered and used to determine fees to be charged by the remote virtual service for its services. In some cases, fees may be paid by or split between the owner of the vehicle, the vehicle manufacturer, a vehicle warrantee provider, the provider of the vehicle's autonomous driving system, etc. In some cases, responsibility for the remote valet service charges may be determined automatically from data generated in connection with the handover request, so as to determine which party/parties are responsible forwhich amounts of the remote valet service fees, among other example implementations.

Data generated in connection with a handover request to a remote valet service, as well as data generated to record a remote valet service provided to a vehicle on a given trip may be collected and maintained on systems (e.g., 1510) of the remote valet service (e.g., 1505) or in cloud-based services (e.g., 150), which may aggregate and crowdsource results of remote valet services to improve both the provision of future remote valet services, as well as the autonomous driving models relied upon by vehicles to self-drive and request remote valet services, among other example uses.

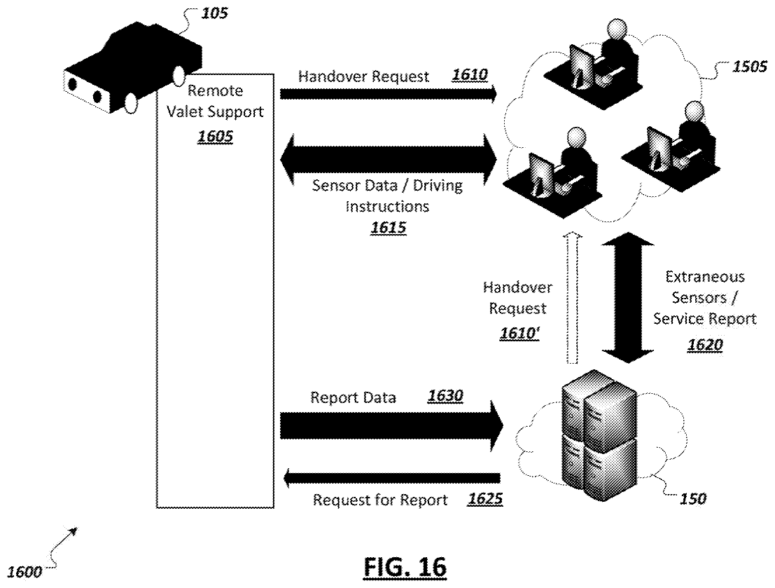

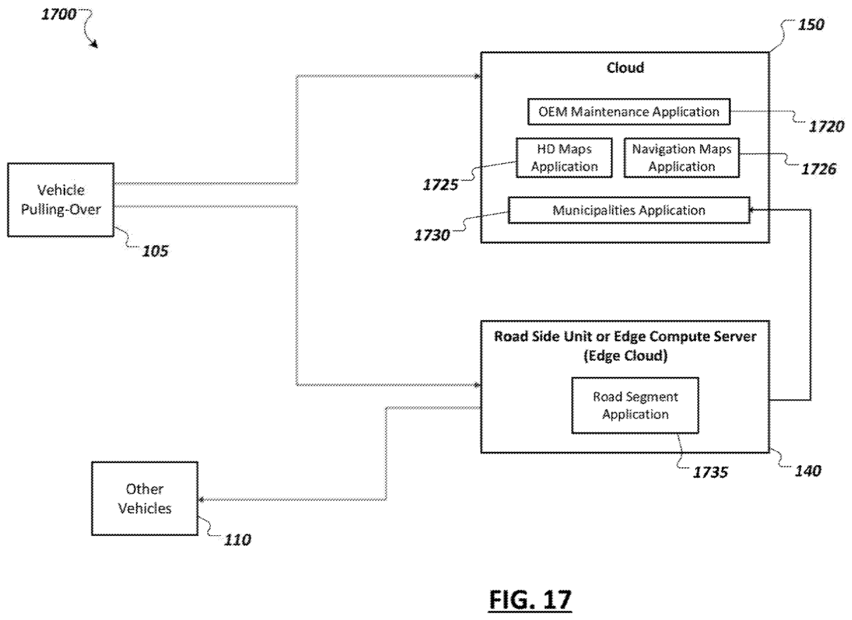

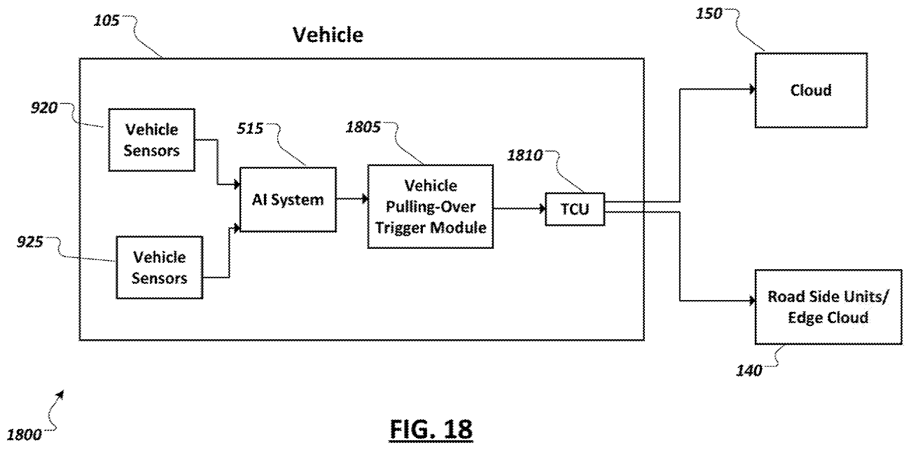

Turning to FIG. 16, a simplified block diagram 1600 is shown illustrating communication between systems during the delivery of an example remote valet service. For instance, a handover request 1610 may be sent from a vehicle (105) (e.g., a remote valet support block (e.g., 1605) of its autonomous driving system) over a network to a computing system providing or brokering remote valet services (provided through one or more remote value service systems (e.g., 1505). In other instances, a trusted third-party system (e.g., extraneous to the autonomous vehicle 105) may determine (e.g., through an ensemble of sensor data from various devices monitoring traffic involving the vehicle) that the vehicle 105 is in need of assistance. In some cases, a passenger within the vehicle may cause the remote valet service to be triggered (e.g., through a smartphone app) using a third-party service (e.g., a cloud-based service 150), which may send the handover request (e.g., 1605′) on behalf of the vehicle 105, among other example implementations. A secure, high-priority communication channel 1615 may be established between the vehicle 105 and the remote valet system 1505 to enable the remote valet service to be provided. For instance, sensor data (e.g., camera data, LIDAR data, etc.) collected by sensors on the vehicle 105 may be sent to provide a near real-time view of the vehicle's position and status, as well as it surrounding environment. In some cases, the data may include data from internal sensors of the vehicle 105 (e.g., to enable a view of the passengers of the vehicles and/or to facilitate live communication between passengers and the remote valet's virtual driver, among other example uses. The remote valet's virtual driver may respond to the information they receive describing live conditions of the vehicle 105 and use controls at their terminal to generate driving instruction data to be sent over the channel 1615 to the vehicle to remotely control the driving operations of the vehicle 105. The remote valet service may also obtain supplemental data (e.g., in addition to that received from the vehicle 105) from extraneous sources, such as road side units, other vehicles, drones, and other sensor devices. Such information may be provided over high priority channels (e.g., 1620) facilitated through one or more backend systems (e.g., 150). In some implementations, the remote valet system 1505 may determine, from the location of the vehicle 105, sets of sensors (which may change dynamically as the vehicle moves along a path under control of the remove valet driver), with which the remote valet system may establish another secure channel (e.g., 1620) and obtain live data describing the scene around the vehicle being controlled by the remove valet system. Accordingly, in some implementations, the remote valet service may use either or both sensor data from sensors on or extraneous to the vehicle 105 being controlled.

As noted above, in some implementations, an autonomous vehicle may detect instances when it should invoke a remote valet service for assistance. In some cases, this determination may be assisted by one or more backend services (e.g., 150). In some implementations, the vehicle may provide data to such services 150 (or to other cloud-based systems, repositories, and services) describing the conditions which precipitated the handover request (e.g., 1610). The vehicle may further provide a report (after or during the service) describing the performance of the remote valet system (e.g., describing maneuvers or paths taken by the remote valet, describing passenger satisfaction with the service, etc.). Such report data (e.g., 1630) may be later used to train machine learning models and otherwise enhance the services provided by the backend or cloud-based system (e.g., 150). Insights and improved models may be derived by the system 150 and then shared with the vehicle's autonomous driving system (as well as its remote valet support logic 1605). In some cases, the autonomous vehicle may record information describing the remote valet's maneuvers and reactions and use this to further train and improve models used in its own autonomous driving machine learning models. Similarly, report data (e.g., through 1620) may be provided from the remote valet system 1505 to cloud-based services or to the vehicle for use in enhancing the vehicle's (and other vehicles') autonomous driving logic and handover requests, among other example uses, such as described herein.

As an illustrative example, an autonomous vehicle (e.g., 105) may autonomously determine (or determine based on passenger feedback or feedback received or reported by a public safety officer, etc.) that the vehicle's autonomous driving system is unable to handle a particular situation, while driving along a route. Accordingly, a remote valet service may be triggered. In some cases, the remote valet service may be contacted in advance of an upcoming section of road based on a prediction that the section of road will be problematic. In some implementations, a handoff request may be performed by a block of logic supplementing autonomous driving system logic implementing a path planning phase in an autonomous driving pipeline (such as discussed in the example of FIG. 5). In some instances, once a remote valet handoff request is issued to a remote valet system, a communication module on the autonomous vehicle, such as a telematic control unit (TCU), may be used to connect to the remote valet service. In some implementations, remote valet service communication may be established as communications with an emergency service (similar to emergency call) specified during the manufacturing phase of the TCU. In this handoff request, the vehicle location may be provided. In some implementations, the handoff request and remote valet service may be implemented in an OEM-provided call/control center where the human virtual driver handling the “remote valet” takes action. In some implementations, in response to establishing a connection between the vehicle and the remote valet service, the remote valet may send a request to the vehicle to stream video from all its cameras for views of the surroundings in real-time. Other sensors (e.g., road cameras and road side sensors) in the same location may also be identified to provide data (e.g., addition streaming video) to supplement the information received from the vehicle. Based on the view of the vehicle surroundings and road conditions that are displayed in near real-time to the remote valet through the streamed video from vehicles (and possibly also from supplemental sources (e.g., road cameras)), the remote valet controls the vehicle (similar to video immersive games where the player sees the car's view and drives and control them with a wheel, handheld controller, etc.) to drive the vehicle to a destination. In some cases, the destination may correspond to a next section of a route determined to be less problematic, at which point control may be handed back to the autonomous driving system to control driving of the vehicle in a standard autonomous driving mode. In other cases, based on the circumstances and detected characteristics of the original handoff request, the remote valet service may direct the vehicle to a particular destination identified as equipped to address issues detected at the vehicle, such as driving a vehicle with compromised sensors or autonomous driving system to the nearest service center, or driving a vehicle with sick or injured passengers to a hospital, among other examples and use cases.

As noted above, in some implementations, an autonomous driving system of a vehicle may access data collected by other remote sensors devices (e.g., other autonomous vehicles, drones, road side units, weather monitors, etc.) to determine, preemptively likely conditions on upcoming stretches of road. In some cases, a variety of sensors may provide data to cloud-based systems to aggregate and process this collection of data to provide information to multiple autonomous vehicles concerning sections of roadway and conditions affecting these routes. As noted above, in some cases, cloud-based systems and other systems may receive inputs associated with previous pullover and remote valet handover events and may detect characteristics common to these events. In some implementations, machine learning models may be built and trained from this information and such machine learning models may be deployed on and executed by roadside units, cloud-based support systems, remote valet computing systems, or the in-vehicle systems of the autonomous vehicles themselves to provide logic for predictively determining potential remote valet handoffs. For instance, through sensor data accessed by a given autonomous vehicle, the vehicle may determine in advance the areas along each road, where frequent pull-overs have occurred and/or remote valet handoffs are common. In some instances, the autonomous vehicle may determine (e.g., from a corresponding machine learning model) that conditions reported for an upcoming section of road suggest a likelihood of a pull-over and/or remote valet handover (even if no pull-over and handover had occurred at that particular section of road previously). Using such information, an autonomous vehicle may preemptively take steps to prepare for a handover to an in-vehicle driver or to a remote valet service. In some cases, the autonomous vehicle may decide to change the path plan to avoid the troublesome section of road ahead (e.g., based on also detecting the unavailability communication resources which can support remote valet, a lack of availability reported for a preferred valet service, a user preference requesting that remote valet be avoided where possible, etc.). In some implementations, displays of the autonomous vehicle may present warnings or instructions to in-vehicle passengers regarding an upcoming, predicted issue and the possibility of a pull-over and/or remote valet handover. In some cases, this information may be presented in an interactive display through which a passenger may register their preference for handling the upcoming trip segment either through a handover to the passenger, handover to a remote valet service, selection of alternative route, or a pull-over event. In still other implementations, cloud-based knowledge reflecting troublesome segments of road may be communicated to road signs or in-vehicle road maps to indicate the trouble segments to drivers and other autonomous vehicles, among other example implementations.

Turning to FIG. 17, a simplified block diagram 1700 is shown illustrating cooperative reporting of information relating to pull-over event risk and road condition warnings, which may be further leveraged to launch remote valet services to assist autonomous vehicles through such hazardous and difficult scenarios. For instance, information may be collected for a pull-over request and/or remote valet event by the affected vehicles and/or surrounding sensor devices, and this information may be shared and leveraged to enhance autonomous driving systems. In the example of FIG. 17, when a pull-over or handoff occurs, the affected vehicle (e.g., 105) may assemble data generated and collected in association with this event and may share this information with cloud-based support systems (e.g., 150) and/or edge devices, such as a road side unit or edge computer (or edge cloud) server (e.g., 140).

FIG. 18 shows a simplified block diagram 1800 illustrating features of an example autonomous vehicle 105, which may include various vehicle sensors (e.g., 920, 925), an artificial intelligence/machine learning-based autonomous driving stack 515, and logic (e.g., 1805) to support triggering and generating handoff requests to systems capable of providing a remote valet service. A telematics control unit (TCU) 1810 may be provided through which the handoff request may be sent and communication established between the vehicle 105 and a virtual driver terminal providing the remote valet service.

When the autonomous driving engine (e.g., 515) determines a pull-over event or the remote valet support logic (e.g., 1805) determines that a handoff request should be sent, a signal may be sent to the TCU 1810) to send vehicle location and pull-over location to various cloud-based entities (or a single entity or gateway distributing this information to multiple entities or services. Indeed, many different services may make use of such information. For instance, a cloud-based application 1715 (e.g., associated with the vehicle OEM), in one example, may be the primary target or recipient for this information and may distribute portions of this information to other recipients. In other instances, the vehicle 105 may provide and distribute data itself to multiple different cloud-based application (e.g., one application per recipient). For instance, an OEM maintenance application (e.g., 1720) may utilize pull-over or hand-off information and make use of it for diagnostics and identifying corner cases in which the vehicle (and its models) cannot handle autonomous driving. In some examples, recipients of pull-over or handoff information may include maps application providers (e.g., 1725, 1726), including providers of traditional navigation maps, 3D maps, high definition (HD) maps, etc., who can receive this information through dedicated cloud apps either directly from the vehicle or through the OEM who receives the information directly from the vehicle. The map providers may leverage pull-over and handoff information for statistics that can help populate the maps with information on areas prone to pull-over events and difficult autonomous driving condition, such that this information may be continually updated. Further, HD maps may incorporate such information as a part of the high precision information per road segment that the HD maps provide, among other examples. Municipalities, governmental agencies, toll road providers, and other infrastructure companies and governing bodies (e.g., 1730) may also be recipients of pull-over and handoff information (e.g., directly from the vehicle 105, indirectly through another application or entity, or by capturing such information through associated roadside sensors and roadside support units, among other examples. Such agencies may utilize this information to trigger road maintenance, as evidence for new road and infrastructure projects, policing, tolls, to trigger deployment of signage or warnings, and other uses.

A pull-over or handoff event may also trigger information to be shared by a vehicle 105 with nearby roadside units, vehicles, and other sensor devices. An example roadside unit (e.g., 140) may leverage this information for instance to process this data with other data it receives and share this information or results of its analysis with other vehicles (e.g., 110) or systems in its proximity (e.g., through a road segment application 1735). For instance, the roadside unit may alert other vehicles of a risk of a pull-over event, prepare infrastructure to support communication with remote valet services, among other example actions. Roadside units may also store or communicate this information so that associated municipalities, maintenance providers, and agencies may access use this information (e.g., to dynamically adapt traffic signal timing, update digital signage, open additional traffic lanes, etc.).

As discussed above, various cloud- and edge-based computing systems may utilize pull-over and handoff information collected from various vehicles over time to improve models, which may be shared and used to improve recommender systems (e.g., to recommend a pull-over or remote valet handoff), enable predictive or preemptive remote valet handoffs, improve autonomous driving models, improve remote valet services, among other example uses and benefits.

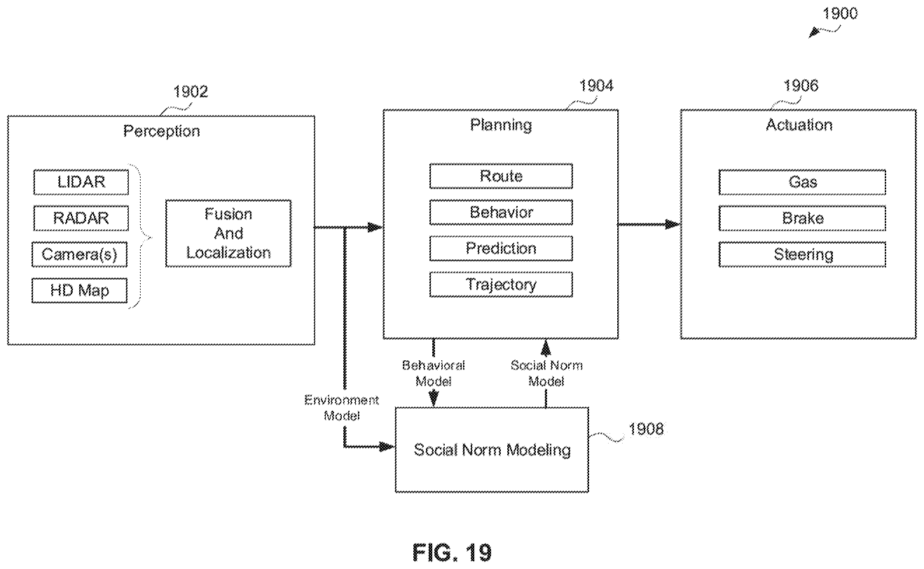

In some implementations, an autonomous driving stack may utilize a “sense, plan, act” model. For instance, FIG. 19 shows an example “sense, plan, act” model 1900 for controlling autonomous vehicles in accordance with at least one embodiment. The model 1900 may also be referred to as an autonomous vehicle control pipeline in some instances. In the example shown, the sensing/perception system 1902 consists of either a singular type or a multi-modal combination of sensors (e.g., LIDAR, radar, camera(s), HD map as shown, or other types of sensors) that allow a digital construction (via sensor fusion) of the environment, including moving and non-moving agents and their current position in relation to the sensing element. This allows an autonomous vehicle to construct an internal representation of its surroundings and place itself within that representation (which may be referred to as an environment model). The environment model may include, in some cases, three types of components: static information about the environment (which may be correlated with an HD map), dynamic information about the environment (e.g., moving objects on the road, which may be represented by current position information and velocity vectors), and Ego localization information representing where the autonomous vehicle fits within the model.

The environment model may then be fed into a planning system 1904 of an in-vehicle autonomous driving system, which takes the actively updated environment information and constructs a plan of action in response (which may include, e.g., route information, behavior information, prediction information, and trajectory information) to the predicted behavior of these environment conditions. The plan is then provided to an actuation system 1906, which can make the car act on said plan (e.g., by actuating the gas, brake, and steering systems of the autonomous vehicle).

In one or more aspects, a social norm modeling system 1908 exists between the sense and planning systems, and functions as parallel input into the planning system. The proposed social norm modeling system would serve as a to provide adaptive semantic behavioral understanding on the vehicle's environment with the goal to adapt the vehicle's behavior to the social norm observed in a particular location. For instance, in the example shown, the social norm modeling system 1908 receives the environment model generated by the perception system 1902 along with a behavioral model used by the planning system 1904, and uses such information as inputs to determine a social norm model, which may be provided back to the planning system 1904 for consideration.

The social norm modeling system 1908 may be capable of taking in sensory information from the sensing components of the vehicle and formulating location-based behavioral models of social driving norms. This information may be useful to addressing timid autonomous vehicle behavior as it may be utilized to quantify and interpret human driver behavior in a way that makes autonomous vehicles less risk-averse to what human drivers would consider normal road negotiation. For example, current models may take a calculated approach and thus measure the risk of collision when a certain action is taken; however, this approach alone can render an autonomous vehicle helpless when negotiating onto a highway in environments where aggressive driving is the social norm.

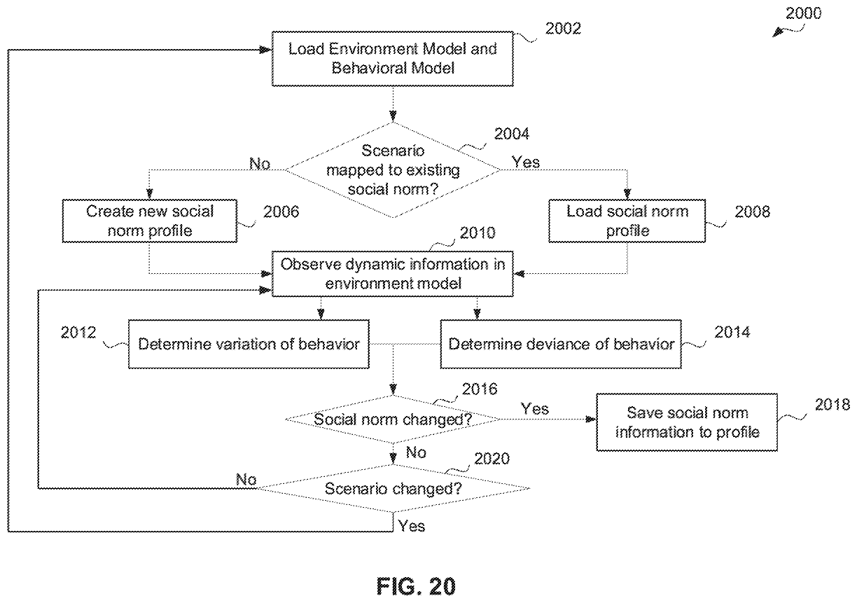

FIG. 20 illustrates a simplified social norm understanding model 2000 in accordance with at least one embodiment. The social norm understanding model may be implemented by a social norm modeling system of an autonomous vehicle control pipeline, such as the social norm modeling system 1908 of the autonomous vehicle control pipeline 1900.

In the example shown, the social norm modeling system first loads an environment model and a behavioral model for the autonomous vehicle at 2002. The environment model may be an environment model passed to the social norm modeling system from a perception system of an autonomous vehicle control pipeline (e.g., as shown in FIG. 19). The behavioral policy may be received from a planning phase of an autonomous vehicle control pipeline (e.g., as shown in FIG. 19). In some cases, a default behavioral policy used by the planning phase may be sent. In other cases, the behavioral policy may be based on the environment model passed to the planning system by the perception system.

At 2004, the social norm modeling system determines whether the scenario depicted by the environment model is mapped to an existing social norm profile. If so, the existing social norm profile is loaded for reference. If not, then a new social norm profile is created. The newly created social norm profile may include default constraints or other information to describe a social norm. Each social norm profile may be associated with a particular scenario/environment (e.g., number of cars around the autonomous vehicle, time of day, speed of surrounding vehicles, weather conditions, etc.), and may include constraints (described further below) or other information to describe the social norm with respect to a behavioral policy. Each social norm profile may also be associated with a particular geographical location. For instance, the same scenario may be presented in different geographical locations, but each scenario may have a different corresponding social norm profile because the observed behaviors may be quite different in the different locations.

Next, at 2010, the social norm modeling system observes dynamic information in the environment model. The dynamic information may include behavior information about dynamic obstacles (e.g., other vehicles or people on the road). The social norm modeling system then, in parallel: (1) determines or estimates a variation in the observed behavior displayed by the dynamic obstacles at 2012, and (2) determines or estimates a deviation of the observed behavior displayed by the dynamic obstacles from the behavior of the autonomous vehicle itself at 2014. For instance, the model may determine at 2012 whether the observed behavior of the other vehicles is within the current parameters of the behavioral model loaded at 2002, and may determine at 2014 whether the deviation between behavior of the vehicles is within current parameters of the behavioral model.

Based on the determined variation and deviation, the social norm understanding model may determine whether the observed social norm has changed from the social norm profile at 2016. If so, the new information (e.g., constraints as described below) may be saved to the social norm profile. If not, the model may determine whether the scenario has changed at 2020. If not, the model continues to observe the dynamic information and make determinations on the variance and deviation of observed behavior as described above. If the scenario changes, the model performs the process from the beginning, starting at 2002.

In some embodiments, the social norm understanding model 2000 may be responsible for generating social norms as observation-based constraints for the ego-vehicle behavioral policy. The generation of these constraints may be derived from temporal tracking behavior in the scenario of surrounding vehicles. In particular, two processes may be executed in parallel:
Estimation of a variation of behavior, which analyzes a Euclidean distance to the current behavior policy/model from the observations of every surrounding vehicle; and
Estimation of a deviation, which analyzes the responses of surrounding vehicles to the observed driving policies determining negative feedback (transgressions) that act as limits for the behavior.

The result of these two parallel processes may be used to determine the behavior boundary limits that form a social norm. This social norm (e.g., the boundary limits) may then be returned to the planning module to act as constraints fitting the particular driving scenario. Depending on the variation of behavior and the deviation observed in the parallel processes, the resulting social norm might apply tighter or loosened constraints to the behavioral planner enabling a more naturalistic driving behavior. In some cases, social norm construction may depend on scenario characteristics such as road geometry and signaling, as well as on the observed surrounding vehicles. Different social norms might emerge from the combination of road environments and number of vehicle participants interacting with the ego-vehicle. In some instances, the model may allow for changes in social norm that occur with time.

In one example implementation, a scenario might be composed of a roadmap geometry that specifies lanes as part of an HD map and vehicles placed in these lanes with states characterized by Xᵢ=[xᵢ,yᵢ,θᵢ,ϑᵢ], where (xᵢ,yᵢ) indicate a position, θᵢ indicates a direction, and ϑᵢ indicates a velocity for each vehicle i. Thus, a number m of vehicle states might be provided as a set (X₁, . . . , Xₘ). Trajectories for each of the vehicles might be calculated at time intervals using the following cost function:

$${J}_{i} = {\sum }_{t = 1}^{N - 1} ( {‖ {X}_{i , t} ‖}^{2} + {‖ Δ {u}_{i , t} ‖}^{2} )$$

Where Δuᵢ is the observed difference of vehicle control with respect to the behavioral model. The application of the cost function over a defined observation window N generates trajectory tryᵢ. Constraints to this trajectory planning can be retrieved from static obstacles as y_{i,k} min<y_{i,k}<y_{i,k} max, dynamic obstacles (safety constraints) (x_{i,k},)∈Sᵢ(x,y) or feasibility of a particular output u_{i,k}. Interaction between each of the vehicles can be observed as Σᵢ₌₁^{m}Jᵢ and from the observed interactions changes in the constraints can be derived (e.g., by minimizing the cost function Jᵢ). The derived constraints may be considered to be a “social norm” for the scenario, and may, in some embodiments, be passed to the planning system to be applied directly to the ego cost function for trajectory planning. Other implementations might use other cost functions to derive constraints. In some cases, for example, implementations may include using neural networks for learning the social norms, or partially-observable Markov decision process.

When understanding of the driving culture/social norm is known (e.g., for aggressive driving), planning systems can be adapted to alter their negotiation tactics in order to be more/less aggressive and accepting of risk since risk reduction comes from knowledge of the risk being expected by other agents on the road. Further, by monitoring social norms, the issue with autonomous driving systems being designed for particular geographic contexts may be resolved, as behavioral models can be designs for multiple geographic locations and improved as time passes. This approach also sets the foundation for the creation and distribution of social driving norms. As autonomous vehicles become the majority of the population on the road, this adaptive semantic behavioral understanding system can allow for shared behavioral models which can dictate road negotiation for all road actors.

Operations in the example processes shown in FIGS. 19, 20 may be performed by various aspects or components of the in-vehicle computing system of an example autonomous vehicle. The example processes may include additional or different operations, and the operations may be performed in the order shown or in another order. In some cases, one or more of the operations shown in FIGS. 19, 20 are implemented as processes that include multiple operations, sub-processes, or other types of routines. In some cases, operations can be combined, performed in another order, performed in parallel, iterated, or otherwise repeated or performed another manner.

Vehicle-to-vehicle communications (V2V) may be utilized by autonomous vehicles to realize risk-reduction. For instance, such communications may be used to broadcast events such as crashes, position of obstacles in the road. Other use cases may make use of remote sensing for collaborative tasks such as mapping or maneuver collaboration. On the second type of collaborative tasks, most of the concepts are restricted to very specific traffic situations or applications such as Cooperative Adaptive Cruise Control (C-ACC) used to coordinate platooning. C-ACC, for instance, employs longitudinal coordination to maintain a minimal time gap to the preceding vehicle and obtain traffic flow and fuel efficiency improvements. Other coordinated maneuvers may be supported in some systems, such as lane-changing and merging through a combination of longitudinal and lateral coordination in order to establish secure gaps in vehicle corridors and adjacent lanes. However, longitudinal and lateral coordinated control may not be enough at intersections where coordination of multiple vehicles and the application of right-of-way rules is needed to achieve cooperation. Existing solutions are useful for specific driving scenarios, but lack mechanisms for interoperability. Furthermore, most such solutions assume that each vehicle is connected and automated and that they are controlled by the same strategy. In this sense, machine learning models used in some autonomous driving systems assume a generic vehicle behavior and tailor the autonomous driving decisions based on these assumptions. Standard approaches to autonomous driving systems may also apply models that assume an ideal (e.g., that other cars are autonomous, that human drivers are law abiding, etc.), but such solutions are not applicable, however, in mixed traffic scenarios where human drivers and their behaviors cannot be controlled and may or may not comply with rules or traffic cooperation objectives.

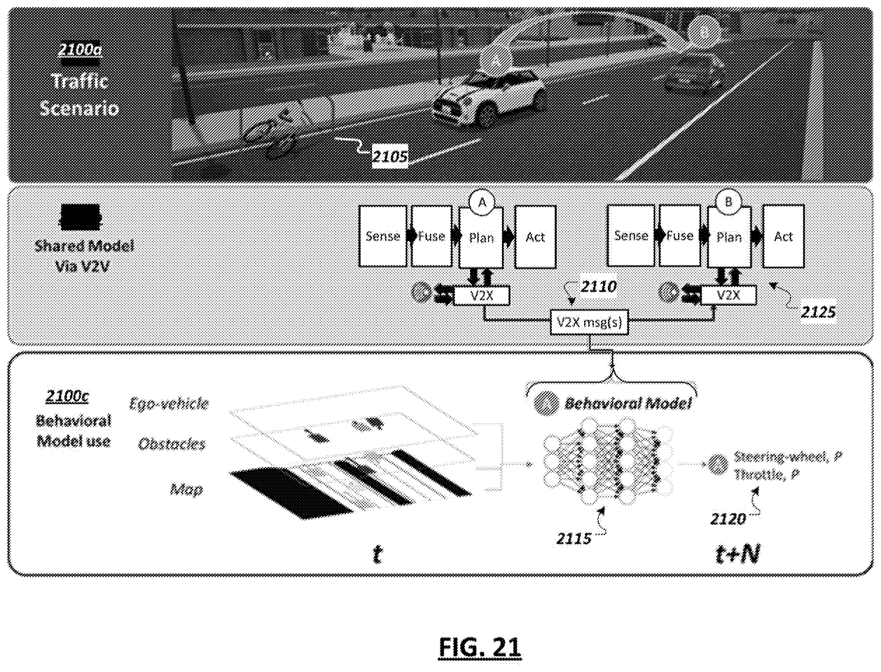

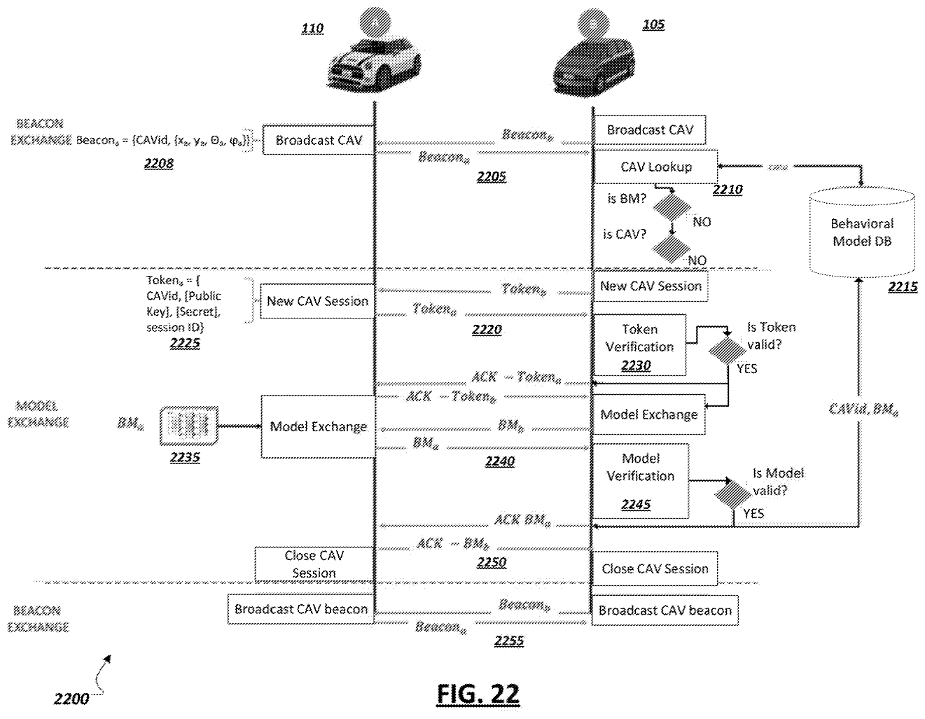

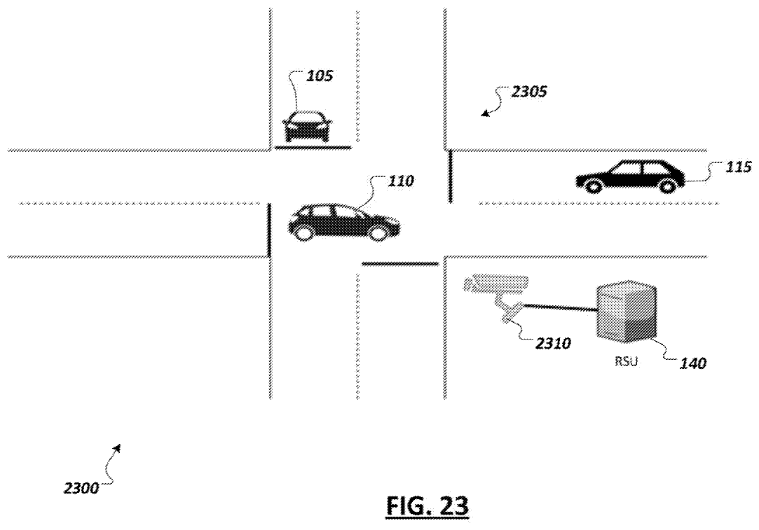

In some implementations, an in-vehicle autonomous driving system of a particular vehicle may be configured to perform maneuver coordination in fully automated or mixed traffic scenarios and make use of shared behavioral models communicated via V2X communication technologies (including Vehicle to Vehicle (V2V) or Infrastructure to Vehicle (I2V), etc.) in support of the autonomous driving decision-making and path planning functionality of the particular vehicle. For instance, as shown in FIG. 21, diagrams 2100a-c are shown illustrating aspects of coordination between vehicles in an environment where at least a portion of the vehicles are semi- or full-autonomous. For instance, behavioral models can be constructed using driving rules in the case of automated vehicles or via data learning processes deriving naturalistic driving behaviors. For instance, as discussed above, behavioral models can be provided that are capable of continuous development and improvement through adaptions based on observations from the environment serving as the basis for modifying learned constraints defined in the model. In the case of human-driven vehicles, where models might not exist, approximate behavioral models can be constructed over time using artificial neural networks. Such neural network models may continually learn and be refined based on the inputs provided to the model. For instance, example input parameters to such models may include road environment information (e.g., map data), position and velocity vectors of surrounding vehicles, ego vehicle initial position and velocity vector, driver identification information (e.g., demographics of human drivers), among other examples. Accordingly, when a vehicle shares its behavioral model with other vehicles, the version of the behavioral model may be one that has been refined and further tuned based on observations and further learning by the vehicle during on-road operation.

As shown in FIG. 21, diagram 2100a shows two vehicles A and B in a driving environment. V2V communication may be enabled to allow one or both of the vehicles to share observations and sensor data with the other. For instance, vehicle A may detect an obstacle (e.g., 2105) impacting a section of a roadway and may further detect the presence of another vehicle (e.g., vehicle B in or entering the same section of the roadway. In response, vehicle A may communicate information concerning the obstacle 2105 (e.g., its coordinates, a type of obstacle or hazard (e.g., an object, an accident, a weather event, a sign or traffic light outage, etc.), a computer-vision-based classification determined for the obstacle (e.g., that the obstacle is a bicycle), among other information. Additionally, as introduced above, the vehicles A and B may also utilize V2V or V2X communications to share behavioral models with the other vehicles. These models may be utilized by a receiving vehicle to determine probabilities that neighboring vehicles will take certain actions in certain situations. These determined probabilities may then be used as inputs to the vehicle's own machine learning or other (e.g., logic based such as rule based) models and autonomous driving logic to affect the decision-making and path-planning when in the presence of these neighboring vehicles.

FIG. 21 illustrates a flow for exchanging and using behavioral models within autonomous driving environments. For instance, as illustrated in diagram 2100a, two vehicles may identify the presence of each other within a section of a roadway and send information identifying, to the other vehicle, the sending vehicle's current position, pose, and speed, etc. To the extent behavioral models have not already been shared or obtained from the other vehicle, one or more behavioral models may be exchanged between the vehicles or with infrastructure intermediaries. As shown in diagram 2100c, behavioral models take as inputs mapping and other geographic data (e.g., identifying which potential paths are drivable), detected obstacles within these paths, and the state of the vehicle (e.g., its position, orientation, speed, acceleration, braking, etc.). Outputs generated by behavioral models can indicate a probability that the corresponding vehicle will take particular action (e.g., steer, brake, accelerate, etc.). Behavioral models can be generic or scenario specific (e.g., lane keeping, lane changing, ramp merging, or intersections models, etc.). For instance, the behavioral model may be a “universal” model in the sense that it is to classify, for any particular driving scenario, the probabilities of the corresponding vehicle's actions in the scenario. In other cases, multiple scenario- or location-specific behavioral models may be developed for a single vehicle (or vehicle make/model) and the collection of models may be exchanged (e.g., all at once as a package, situationally based on the location(s) or scenario(s) in which the vehicle encounters other vehicles, etc.). In such instances, a vehicle may first detect the scenario it is planning around (e.g., based on determinations made in the vehicle's own path planning phase) and use the results to identify a specific one of the other vehicle's shared models to identify the behavioral model that best “fits” the present scenario and use this behavioral model, among other example implementations.

Continuing with the example of FIG. 21, upon receiving the behavioral model for vehicle A, vehicle B may detect that vehicle A is in its vicinity and further detect current inputs for the behavioral model, such as from vehicle B's own sensor array, outside data sources (e.g., roadside units), or data shared V2V by vehicle A (e.g., through a beacon signal) describing the environment, obstacles, vehicle A's speed, etc. These inputs (e.g., 2110) may be provided as inputs to the share behavioral model (e.g., 2115) to derive a probability value P (e.g., 2120). This probability value 2120 may indicate the probability that vehicle A will perform a particular action (given the current environment and observed status of vehicle A), such as steering in a certain direction, accelerating, braking, maintaining speed, etc. This probability value 2120 may then be utilized by the autonomous driving stack (e.g., 2125) of vehicle B is planning its own path and making decisions relative to the presence of vehicle A. Accordingly, through the use of the shared behavioral model, vehicle B may alter the manner in which it determines actions to take within the driving environment from a default approach or programming that the autonomous driving stack 2125 uses when driving in the presence of vehicles for which a behavioral model is not available, among other example implementations.

Accordingly, in some implementations, to enable one vehicle to anticipate and plan (using its own machine learning capabilities) the actions and maneuvers of other vehicles, and in particular vehicles with different driving autonomy levels, the vehicle may obtain or otherwise access behavioral models for these other vehicles. Based on these neighboring vehicles' models, a vehicle sharing the road with these vehicles may predict how these vehicles will respond based on conditions observed in the environment, which affect each of the vehicles. By providing a vehicle with surrounding vehicles' behavioral models, the vehicle may be able to estimate future scenarios through projection of environmental conditions. In this manner, vehicles equipped with these additional behavioral models may plan a risk-optimized decision based on current observations and model-based predictions that present a lower uncertainty. Such a solution not only increases safety within the autonomous driving environment but may be computationally more efficient as the vehicle using these other models does not need to compute individual behavioral models based on probabilistic projections for the surrounding vehicles, but merely check if the projections are credible and modify its behavior accordingly.

Turning to FIG. 22, a block diagram 2200 is shown illustrating example information exchange between two vehicles 105, 110. In one example, connected vehicles may have multiple different modes for information exchange, including beacon exchange and model exchange. In one example, beacon exchange involves the broadcast of a beacon 2208 to signal the corresponding vehicle's identity (e.g., a connected autonomous vehicle identifier (CAVid)) together with a state vector representing the same vehicle's position, orientation, and heading). Model exchange may involve broadcasting to other vehicles (and roadside systems) the behavioral model of the broadcasting vehicle.

Given that a behavioral model may be acted upon by another vehicle to predict future vehicle behaviors and take corresponding action, in some cases, behavioral models may be accepted and used only when received from trusted vehicles. Accordingly, exchanges of models between vehicle may include a trust protocol to enable the devices to establish initial trustworthiness of behavioral models received from that vehicle. In some implementations, this trustworthiness value can change over time if the output behavior differs significantly from the observed vehicle behavior. Should the trustworthiness value fall below a certain threshold the model can be deemed not-suitable. As illustrated in FIG. 22, in some implementations, when two vehicles 105, 110 encounter one another within an environment, the two vehicles (e.g., 105, 110) identify the other through the respective CAVids broadcast using beacon exchange. A vehicle (e.g., 105) may determine, from the CAVid (e.g., at 2210), whether the other vehicle (e.g., 110) is a known vehicle (or its behavioral model is a known model), such that the vehicle 105 can identify and access the corresponding behavioral model (e.g., in a local cache or stored in a trusted (e.g., cloud- or fog-based) database (e.g., 2215)). Accordingly, in some implementations, a lookup may be performed, upon encountering another vehicle, to determine whether necessary behavioral models are in the database 2215 corresponding to an advertised CAVid included in the beacon signal. When it is determined that the vehicle 105 does not possess the behavioral model for the identified vehicle 110, the vehicles may begin a model exchange by establishing a session through exchange of tokens (at 2220). In one example, each token (e.g., 2225) may include the CAVid, public key, and a secret value, as well as a session ID. Each vehicle (e.g., 105, 110) may receive the token of the other and perform a verification 2230 of the token to make sure the token is a valid. Upon verification of the token signature an acknowledgement may be shared with the other vehicle, indicating that the vehicle trusts the other and would like to progress with the model exchange. In some implementations, model exchange may involve communication of a behavioral model (e.g., 2235) divided and communicated over multiple packets until the model exchange 2240 is completed (e.g., which may be indicated by an acknowledgement) in the last package. The session ID of the session may be used, when necessary, to enable data to be recovered should there be a loss of connectivity between the two vehicles. V2V or V2X communications may be utilized in the communications between the two vehicles. In some instances, the communication channel may be a low latency, high-throughput, such as a 5G wireless channel.

Upon receiving another vehicle's behavioral model, the vehicle may conduct a model verification 2245 for the model. Model verification 2245 may include checking the model for standards conformity and compatibility with the autonomous driving stack or machine learning engine of the receiving vehicle. In some instances, past inputs and recorded outputs of the receiving vehicle's behavioral model may be cached at the receiving vehicle and the receiving vehicle may verify the validity of the received behavioral model by applying these cached inputs to the received behavioral model and comparing the output with the cached output (e.g., validating the received behavioral model if the output is comparable). In other implementations, verification of the behavioral model 2245 may be performed by observing the performance of the corresponding vehicle (e.g., 110) and determining whether the observed performance corresponds to an expected performance determined through the behavioral model (e.g., by providing inputs corresponding to the present environment to the model and identifying if the output conforms with the observed behavior of the vehicle). In the example of FIG. 22, upon verification of a received behavioral model an acknowledgement (e.g., 2250) may be sent to the source vehicle and the session can be closed. From there on vehicles can continue to exchange beacons (at 2255) to identify their continued proximity as well as share other information (e.g., sensor data, outputs of their models, etc.).

While the example of FIG. 22 illustrates an instance where an unfamiliar vehicle is encountered and new behavioral models are shared, if two vehicles (e.g., 105, 110) have already shared behavioral models with each other in the past, the look-up in a cache or behavioral model database 2215 will yield a positive result and an acknowledgement message of model verification can be shared between the two vehicles. In some cases, behavioral models may be updated or expire, in which case vehicles may identify the update to another known vehicle (or vehicle model) and a model update exchange may be performed (e.g., in manner similar to a full model exchange in a new session), among other examples. In some cases, a vehicle (e.g., 105) may unilaterally determine that a previously-stored behavioral model for a particular other vehicle (e.g., 110) is out-of-date, incorrect, or defective based on detecting (in a subsequent encounter with the particular vehicle) that observed behavior of the particular vehicle does not conform with predicted behavior determined when applying the earlier-stored version of the behavioral model. Such a determination may cause the vehicle (e.g., 105) to request an updated version of the behavioral model (e.g., and trigger a model exchange similar to that illustrated in FIG. 22).

Through the exchange and collection of verified, accurate, and trusted behavioral models, a vehicle may utilize beacon exchange in the future to identify vehicles, which use a trusted, accurate behavioral model in navigating an environment and may thereby generate future predictions of the surrounding vehicle's behavior in an efficient way. In some instances, behavioral models and CAVids may be on a per-vehicle basis. In other examples, each instance of a particular autonomous vehicle model (e.g., make, model, and year) may be assumed to use the same behavioral model and thus a vehicle may use the verification of a single behavioral model associated with this car model in encounters with any instance of this car model, among other examples.

Behavioral models may be based on the machine learning models used to enable autonomous driving in the corresponding vehicle. In some cases, behavioral models may be instead based on rule engines or heuristics (and thus may be rule-based). In some cases, the behavioral models to be shared and exchanged with other vehicles may be different from the machine learning models actually used by the vehicle. For instance, as discussed above, behavioral models may be smaller, simpler “chunks” of an overall model, and may correspond to specific environments, scenarios, road segments, etc. As examples, scenario-specific behavioral models may include neural network models to show the probability of various actions of a corresponding vehicle in the context of the specific scenario (e.g., maneuvering an intersection, maneuvering a roundabout, handling takeover or pullover events, highway driving, driving in inclement weather, driving through elevation changes of various grades, lane changes, etc.). Accordingly, multiple behavioral models may be provided for a single vehicle and stored in memory of a particular vehicle using these models. Further, the use of these multiple models individually may enable faster and more efficient (and accurate) predictions by the particular vehicle compared to the use of a universal behavioral model modeling all potential behaviors of a particular vehicle, among other example implementations.

The exchange and collection of behavioral models may be extended, in some instances, to cover human-driven vehicles, including lower-level autonomous vehicles. In some instances, behavioral models for individual drivers, groups of drivers (drivers in a particular neighborhood or location, drivers of particular demographics, etc.), mixed models (dependent on whether the vehicle is operating in an autonomous mode or human driver mode), and other examples may be generated. For instance, a vehicle may include (as an OEM component or aftermarket component) a monitor to observe a human driver's performance and build a behavioral model for this driver or a group of drivers (e.g., by sharing the monitoring data with a cloud-based aggregator application). In other instances, roadside sensors and/or crowd-sourced sensor data may be utilized, which describes observed driving of individual human drivers or groups of drivers and a behavioral model may be built based on this information. Behavioral models for human drivers may be stored on an associated vehicle and shared with other vehicles in accordance with other exchanges of behavioral models, such as described in the examples above. In other instances, such as where the human driven car is not connected or does not support model exchanges, other systems may be utilized to share and promulgate behavioral models for human drivers, such as road-side units, peer-to-peer (e.g., V2V) distribution by other vehicles, among other examples.

As more road actors become self-driving, and city infrastructure becomes modernized, conflicts may develop between the various autonomous driving stacks and machine-learning-based behavioral models relied upon by these actors. Indeed, as different car and autonomous system providers compete with independent solutions, it may be desirous to facilitate coordination and consensus building between the various models utilized by these many vehicles and other actors. Government legislation and regulation and industry standardization may be developed in order to assist in facilitating safety and compatibility between various technologies. However, with multiple key players developing their own solutions, the question of improving overall safety on the road remains unanswered. Standards of safety are still in their adolescence, as there exists no clear way for policy makers and the public to validate the decisions made by these vehicles. Further, as autonomous vehicles improve their models and corresponding decision making, outdated models and solutions (e.g., included in vehicles during the infancy of autonomous driving) may pose a growing hazard on the road. This creates a problem with behavioral consensus, since older or malfunctioning autonomous vehicle road actors may utilize conflicting models and may not enjoy the benefits of improved functionality provided through newer, evolved models.

Given the young and developing autonomous vehicle industry and the infancy of 5G networks and infrastructure, V2X communications and solutions are similarly limited. For instance, current V2X solutions offered today are predominantly in the localization and mapping domain. As autonomous vehicles and supporting infrastructure become more mainstream, the opportunity to expand and develop new solutions that leverage cooperation and intercommunication between connected vehicles and their environment emerges. For instance, in some implementations, a consensus and supporting protocols may be implemented, such as to enable the building of consensus behavioral models, which may be shared and utilized to propagate “best” models to vehicles, such that machine learning models of vehicles continually evolve to adopt the safest, most efficient, and passenger friendly innovations and “knowledge.” For instance, high speed wireless networking technology (e.g., 5G networks) and improved street infrastructure may be utilized to aid such consensus systems.

In one example, a Byzantine Consensus algorithm may be defined and implemented among actors in an autonomous driving system to implement fault tolerant consensus. Such a consensus may be dependent on the majority of contributors (e.g., contributors of shared behavioral model) contributing accurate information to the consensus system. Accuracy of contributions may be problematic in an autonomous vehicle context since the total amount of road actors in a given intersection at a given time may potentially be low thus increasing the probability of a bad consensus (e.g., through model sharing between the few actors). In some implementations, compute nodes may be provided to coincide with segments of roadways and road-interchanges (e.g., intersections, roundabouts, etc.), such as in roadside units (e.g., 140), mounted on street lamps, nearby buildings, traffic signals, etc., among other example locations. In some cases, the compute nodes may be integrated with or connected to supplemental sensor devices, which may be capable of observing traffic corresponding to the road segment. Such road-side computing devices (referred to herein collectively as “road-side units” or “RSUs” for convenience) may be designated and configured to act as central point for collection of model contributions, distribution of models between vehicles, validation of the models across the incoming connected autonomous vehicles, and determining consensus from these models (and, where enabled, based on observations of the sensors of the RSU) at the corresponding road segment locations.

In some implementations, a road-side unit implementing a consensus node for a particular section of roadway may accept model-based behavior information from each vehicle's unique sensory and perception stack, and over time refine what the ideal behavioral model is for that road segment. In doing so, this central point can validate the accuracy of models in comparison to peers on the road at that time as well as peers who have previously negotiated that same section of road in the past. In this manner, the consensus node may consider models in a historical manner. This central node can then serve as a leader in a byzantine consensus communication for standardizing road safety amongst varying actors despite the varying amounts and distribution of accurate consensus contributors.

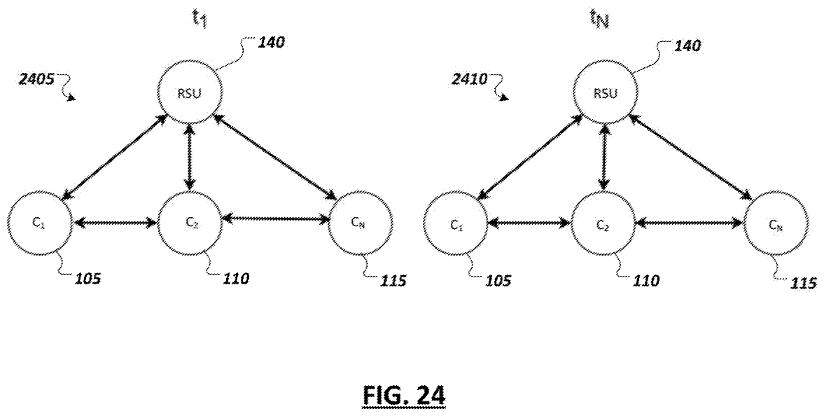

Turning to FIG. 23, a simplified block diagram 2300 is shown illustrating an example road intersection 2305. One or more road-side units (e.g., 140) may be provided to function as a consensus node for the road segment 2305. In this example, the consensus node device (e.g., 140) may include one or more sensors, such as camera 2310. In some implementations, the consensus node can be implemented as two or more distinct, collocated computing devices, which communicate and interoperate as a single device when performing consensus services for the corresponding road segment 2305, among other example implementations. Trustworthiness of the road-side unit(s) (e.g., 140) implementing the consensus node may be foundational, and the RSU 140 may be affiliated with a trusted actor, such as a government agency. In some implementations, an RSU 140 may be configured with hardware, firmware, and/or software to perform attestation transactions to attest its identity and trustworthiness to other computing systems associated with other nearby road actors (e.g., vehicles 105, 110, 115, etc.), among other example features. An example RSU may include compute and memory resources with hardware- and/or software-based logic to communicate wirelessly with other road actor systems, observe and capture behavioral model exchanges between vehicles (such as discussed above in the example of FIGS. 21 and 22), receive behavioral models directly from other road actors, determine (from the model inputs it receives) a consensus model (e.g., based on a byzantine consensus scheme or algorithm), and distribute the consensus model to road actors (e.g., 105, 110, 115) for their use in updating (or replacing) their internal models to optimize the road actor's navigation of the corresponding road segment (e.g., 2305).

It should be appreciated that an RSU implementing a consensus node may do so without supplemental sensor devices. However, in some implementations, an RSE sensor system (e.g., 2310) may provide useful inputs, which may be utilized by the RSE in building a consensus behavioral model. For instance, an RSU may utilize one or more sensors (e.g., 2310) to observe non-autonomous-vehicle road actors (e.g., non-autonomous vehicles, electric scooters and other small motorized transportation, cyclists, pedestrians, animal life, etc.) in order to create localized models (e.g., for a road segment (e.g., 2305)) and include these observations in the consensus model. For instance, it may be assumed that non-autonomous vehicles may be incapable of communicating a behavioral model, and a sensor system of the RSU may build behavioral models for non-autonomous vehicle, human drivers, and other road actors based on observations of its sensors (e.g., 2310). For instance, a sensor system and logic of an example RSU (e.g., 140) may enable recognition of particular non-autonomous vehicles or even recognition of particular human drivers and corresponding behavioral models may be developed based on the presence (and the frequency of these actors' presence) within the road environment. Consensus models may be built for this road segment 2305 to incorporate knowledge of how best to path plan and make decisions when such non-autonomous actors are detected by an autonomous vehicle (e.g., 105) applying the consensus model. In still other examples, non-autonomous vehicles may nonetheless be equipped with sensors (e.g., OEM or after-market), which may record actions of the vehicle or its driver and the environment conditions corresponding to these recorded actions (e.g., to enable detection of driving reactions to these conditions) and communicate this information to road side units to assist in contributing data, which may be used and integrated within consensus models generated by each of these RSUs for their respective locales or road segments. OEM and after-market systems may also be provided to enable some autonomous driving features in non-autonomous vehicles and/or to provide driver assistance, and such systems may be equipped with functionality to communicate with RSUs and obtain consensus models for use in augmenting the services and information provided through such driver assistance systems, among other example implementations.

Consensus contributors can be either autonomous vehicle or non-autonomous vehicle road actors. For instance, when vehicles (e.g., 105, 110, 115) are within range of each other and a road-side unit 140 governing the road segment (e.g., 2305), the vehicles may intercommunicate to each share their respective behavioral models and participate in a consensus negotiation. The RSU 140 may intervene within the negotiation to identify outdated, maliciously incorrect, or faulty models based on the consensus model developed by the RSU 140 over time. The consensus model is analogous to a statement of work, that guards against a minority of actors in a negotiation from dramatically worsening the quality of and overriding the cumulative knowledge embodied in the consensus model. Turning to FIG. 24, diagrams 2405, 2410 are shown illustrating that over time (t) localized behavioral model consensus may be collected and determined for a given road segment in light of a corresponding RSU's (e.g., 140) involvement in each consensus negotiation for the road segment. This historical consensus approach allows for improved road safety as autonomous vehicles of different makes and manufacturers, with varying autonomous driving systems can benefit from each other both in the present and in the past. Such a consensus-based system applies a holistic and time-tested approach to road safety through behavioral model sharing. Each road actor (e.g., 105, 110, 115), whether autonomous vehicle or non-autonomous vehicle is expected to observe the environment and make a decision as to how they should act independently. All consensus contributors (e.g., 105, 110, 115, 140, etc.) will also make an attempt at predicting the actions of other road actors through their respective sensory systems. Autonomous vehicles (e.g., 105, 110, 115) will then share their behavioral models with the RSU (e.g., 140), and each other as seen in the illustrations in diagrams 2405, 2410.

Through collaborative sharing of models within a consensus building scheme (e.g., based on a byzantine consensus model), autonomous vehicles may then utilize their own perception of the environment through the consensus behavioral model(s) and determine the other road actors' exact actions which allows them, as well as their peers, to validate whether their initial predictions of each other were accurate. This information and validation is also visible to the RSU, which is also involved in this consensus negotiation. With knowledge of riskier behavioral models which would result in collisions, voting can begin where distribution of a behavioral model that does not result in collision or misunderstanding of the environment including other road actors is provided. Hashes or seeds based off the selected model can be used to simplify comparison and avoid the re-running of local behavioral model predictions during the process. In some implementations, as the consensus node, RSU contribution to the consensus may be weighted based off of previous successful consensus negotiations to which it was involved in, and this should be taken into account by the other road actors. Validation of consensus can then be checked based on the actions of road actors.

As noted herein, high-definition maps may be utilized in various autonomous driving applications, including by the in-vehicle system itself, as well as external systems providing driving assistance to an autonomous vehicle (e.g., cloud- or road-side-based systems, remote valet systems, etc.). Accordingly, accuracy of the HD map used in autonomous driving/autonomous vehicle control is essential. To generate the HD map and to maintain it, it is important to get dynamic and up-to-date data. If there is any change in the environment (for example, there is a road work, accident, etc.) the HD map should be updated to reflect the change. In some implementations, data from a number of autonomous vehicles may be crowdsourced and used to update the HD map. However, in some cases, trust or confidence in the data received may be questionable. One challenge may include understanding and codifying the trustworthiness of the data received from each of the cars. For instance, the data coming from an autonomous vehicle may be of lower fidelity (e.g., coming from less capable sensors), unintentionally corrupted (e.g., random bit flip), or maliciously modified. Such low- (or no-) quality data in turn could corrupt the HD maps present in the servers.

Accordingly, in certain embodiments, the data collected by the various sensors of an autonomous vehicle may be compared with data present in a relevant tile of the HD map downloaded to the autonomous vehicle. If there is a difference between the collected data and the HD map data, the delta (difference of the HD map tile and the newly collected data) may be transferred to the server hosting the HD map so that the HD map tile at that particular location may be updated. Before transferring to the server, the data may be rated locally at each autonomous vehicle and again verified at the server before updating the HD map. Although described herein as the server validating autonomous vehicle sensor data before updating an HD map, in some cases, the delta information may also be sent to other autonomous vehicles near the autonomous vehicle that collected the data in order to update their HD maps quickly. The other autonomous vehicles may analyze the data in the same way the server does before updating their HD map.

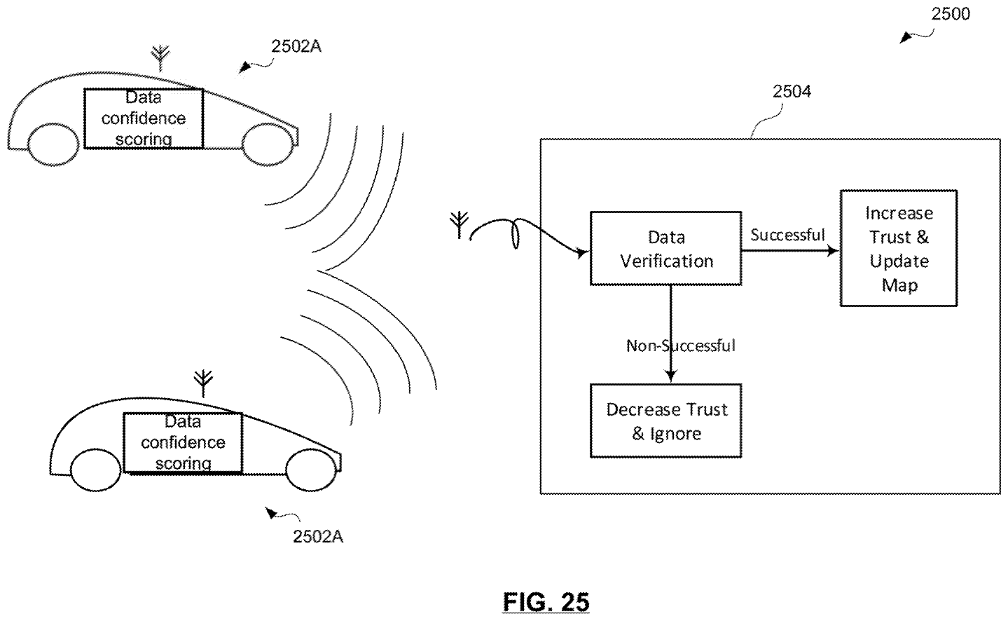

FIG. 25 is a simplified diagram showing an example process of rating and validating crowdsourced autonomous vehicle sensor data in accordance with at least one embodiment. In the example shown, each autonomous vehicle 2502 collects data from one or more sensors coupled thereto (e.g., camera(s), LIDAR, radar, etc.). The autonomous vehicles 2502 may use the sensor data to control one or more aspects of the autonomous vehicle. As each autonomous vehicle collects data from its one or more sensors, the autonomous vehicle may determine an amount of confidence placed in datum collected. For example, the confidence score may be based on information related to the collection of the sensor data, such as, for example, weather data at the time of data collection (e.g., camera information on a sunny day may get a larger confidence score than cameras on a foggy day), sensor device configuration information (e.g., a bitrate or resolution of the camera stream), sensor device operation information (e.g., bit error rate for a camera stream), sensor device authentication status information (e.g., whether the sensor device has been previously authenticated by the autonomous vehicle, as described further below), or local sensor corroboration information (e.g., information indicating that each of two or more cameras of the autonomous vehicle detected an object in the same video frame or at the same time).

The autonomous vehicle may calculate a confidence score, which may be maintained in metadata associated with the data. The confidence score may be a continuous scale between zero and one in some implementations (rather than a binary decision of trusting everything or trusting nothing), or between zero and another number (e.g., 10). Additionally, in cases where the collection device is capable of authentication or attestation (e.g., where the device is authenticated by the autonomous vehicle before the autonomous vehicle accepts the data from the device), the device's authentication/attestation status may be indicated in the metadata of the data collected by the sensor device (e.g., as a flag, a digital signature, or other type of information indicating the authentication status of the sensor device), allowing the server 2504 or other autonomous vehicle to more fully verify/validate/trust the data before using the data to update the HD map. In some cases, the autonomous vehicle itself may be authenticated (e.g., using digital signature techniques) by the server. In such cases, the data collected from different sensors of the autonomous vehicle may be aggregated, and in some cases authenticated, by the main processor or processing unit within the autonomous vehicle before being transferred or otherwise communicated to the server or to nearby autonomous vehicles.

The values for how to score different devices may be defined by a policy for collecting and aggregating the data. The policy may also indicate when the autonomous vehicle is to upload the newly collected data, e.g., to update the HD map. For example, the policy may state that the delta from the HD map tile and the newly collected data must be above a certain threshold to send the data back to the server for updating the HD map. For instance, construction site materials (barrels, equipment, etc.) may cause a large delta between the HD map data and collected data, while a pebble/rock in the road may cause a smaller delta, so the construction site-related data may be passed to the cloud while the pebble data might not. The policy may also indicate that the confidence score associated with the data must be above a certain threshold before uploading the data. As an example, the confidence score may be required to be above 0.8 (for example) for all data to be sent back/published to the server.

Once received from the autonomous vehicle, the server may perform additional verification actions before applying an update to the HD map with the delta information. For example, the server may verify the confidence score/metrics that were shared with the data (e.g., in its metadata). As long as the confidence score value(s) satisfy a server policy (e.g., all delta data used to update the map must have a confidence score greater than a threshold value, such as 0.9), then the server may consider the data for updating of the HD map. In some cases, the server may maintain a list of recently seen autonomous vehicles and may track a trust score/value for each of the autonomous vehicles along with the confidence score of the data for updating the map. In some embodiments, the trust score may be used as an additional filter for whether the server uses the data to update the HD map. In some cases, the trust score may be based on the confidence score of the data received. As an example, if the confidence score is above a first threshold, the trust score for the autonomous vehicle may be increased (e.g., incremented (+1)), and if the confidence score is below a second threshold (that is lower that the first threshold) then the trust score for the autonomous vehicle may be decreased (e.g., decremented (−1)). If the confidence score is between the first and second thresholds, then the trust score for the autonomous vehicle may remain the same. An IoT-based reputation system (e.g., EigenTrust or PeerTrust) can be utilized for this tracking, in some implementations. In some cases, the sensor data may be correlated with sensor data from other autonomous vehicles in the area to determine whether the sensor data is to be trusted.

In some embodiments, as each car publishes the data to the server, the autonomous vehicle may sign the data with pseudo-anonymous certificates. The autonomous vehicle may use one of the schemes designed for V2X communications, for example. In some cases, when the signed data is received at the server, as long as the data is not from a blacklisted autonomous vehicle, it may be passed to the HD map module for updating of the HD map. In other cases, whether the data is signed or not may be used in the determination of the trust score for the autonomous vehicle.

If the authentication and/or trust verification are not successful at the server, the trust score for the autonomous vehicle from which the data was received may be ranked low or decreased and the data may be ignored/not used to update the HD map. In some cases, the autonomous vehicle may be blacklisted if its trust score drops below a specified threshold value. If the authentication and/or trust verification is successful at the server, then the trust score for the autonomous vehicle may be increased and the data received from the autonomous vehicle may be used to update the HD map. Mechanisms as described herein can also enable transitivity of trust, allowing autonomous vehicles to use data from sources (e.g., other autonomous vehicles) that are more distant, and can be used for ranking any crowdsourced data required for any other purpose (e.g., training of machine learning models).

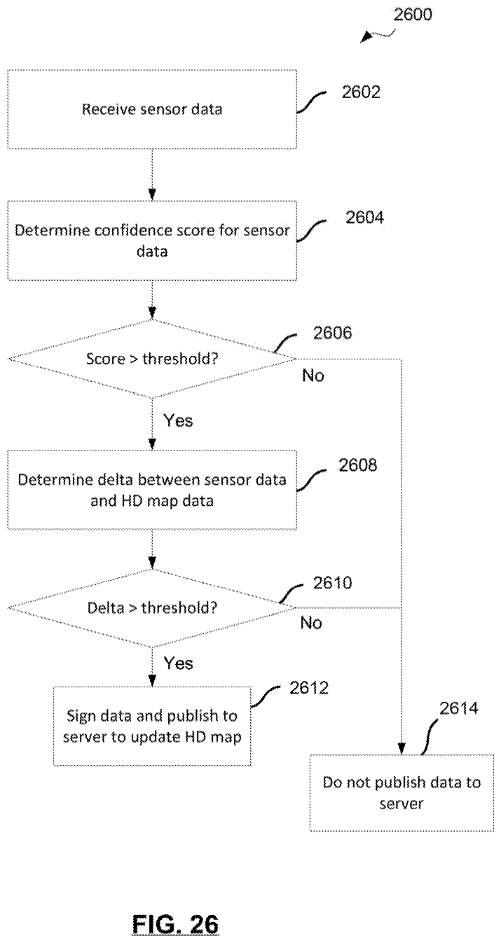

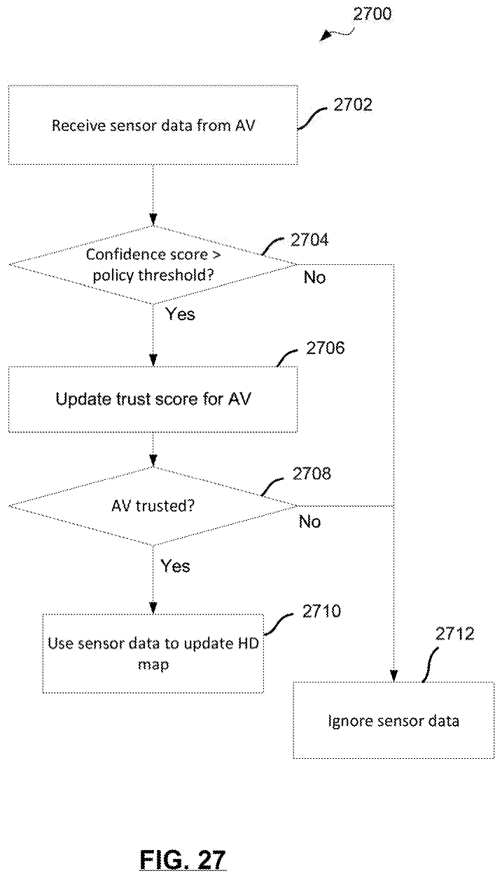

FIG. 26 is a flow diagram of an example process of rating sensor data of an autonomous vehicle in accordance with at least one embodiment. Operations in the example processes shown in FIG. 26 may be performed by various aspects or components of an autonomous vehicle. The example processes may include additional or different operations, and the operations may be performed in the order shown or in another order. In some cases, one or more of the operations shown in FIG. 26 are implemented as processes that include multiple operations, sub-processes, or other types of routines. In some cases, operations can be combined, performed in another order, performed in parallel, iterated, or otherwise repeated or performed another manner.

At 2602, sensor data is received from a sensor of an autonomous vehicle. The sensor data may include data from a camera device, a LIDAR sensor device, a radar device, or another type of autonomous vehicle sensor device.

At 2604, a confidence score for the sensor data is determined. The confidence score may be based on information obtained or gleaned from the sensor data received at 2602 or other sensor data (e.g., weather or other environmental information), sensors device authentication status information (e.g., whether the sensor device was authenticated by the autonomous vehicle before accepting its data), local sensor corroboration data, or other information that may be useful for determining whether to trust the sensor data obtained (e.g., device sensor capabilities or settings (e.g., camera video bitrate), bit error rate for sensor data received, etc.).

At 2606, it is determined whether the confidence score is above a threshold value. If so, a delta value between the sensor data received at 2602 and the HD map data is determined at 2608, and if the delta value is determined to be above a threshold at 2610, the autonomous vehicle signs the data and publishes the data to the server for updating of the HD map at 2612. If the confidence score is below its corresponding threshold value or the delta value is below its corresponding threshold value, then the data is not published to the server for updating of the HD map.

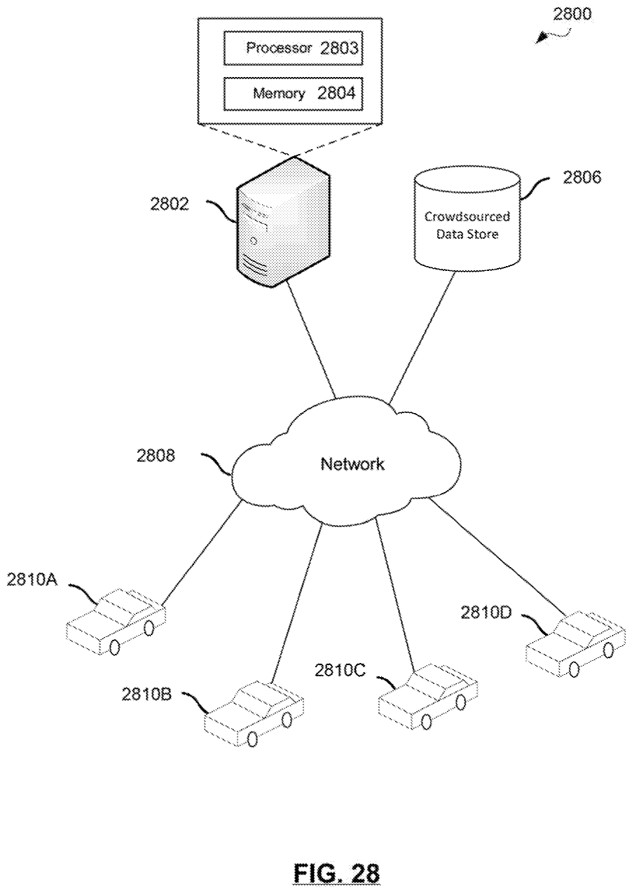

FIG. 27 is a flow diagram of an example process of rating sensor data of an autonomous vehicle in accordance with at least one embodiment. Operations in the example processes shown in FIG. 27 may be performed by various aspects or components of a server device, such as a server that maintains an HD map for autonomous vehicles, or by one or more components of an autonomous vehicle. The example processes may include additional or different operations, and the operations may be performed in the order shown or in another order. In some cases, one or more of the operations shown in FIG. 27 are implemented as processes that include multiple operations, sub-processes, or other types of routines. In some cases, operations can be combined, performed in another order, performed in parallel, iterated, or otherwise repeated or performed another manner.

At 2702, sensor data is received from an autonomous vehicle. The sensor data may include a confidence score associated with the sensor data that indicates a level of confidence in the datum collected by the sensor device. The confidence score may be computed according to the process 2600 described above. The confidence score may be included in metadata, in some cases.

At 2704, the confidence score is compared with a policy threshold. The confidence score is greater than the threshold, then a trust score for the autonomous vehicle is updated based on the confidence score at 2706. If not, then the sensor data is ignored at 2712.

At 2708, it is determined whether the autonomous vehicle is trusted based at least in part on the trust score. In some cases, determining whether the autonomous vehicle is trusted may be based on whether the autonomous vehicle has been blacklisted (e.g., as described above). In some cases, determining whether the autonomous vehicle is trusted may be based on a correlation of the sensor data of the autonomous vehicle with sensor data from other autonomous vehicles nearby (e.g., to verify that the sensor data is accurate). If the autonomous vehicle is trusted, then the sensor data may be used to update the HD map at 2710. If not, then the sensor data is ignored at 2712. Alternatively, the level of trust based on the trust score may be used to determine the level of trust the autonomous vehicle has on the sensor data and hence update the HD map based on a range or scale accordingly.

As discussed herein, crowdsourcing data collections may consist of building data sets with the help of a large group of autonomous vehicles. There are source and data suppliers who are willing to enrich the data with relevant, missing, or new information.

Obtaining data from a large group of autonomous vehicles can make data collection quick, in turn leading to faster model generation for autonomous vehicles. When crowdsourcing data, some of the data may be incomplete or inaccurate, and even when the data may be complete and accurate, it can still be difficult to manage such a large amount of data. Moreover, the crowdsourced data presents its own real-world challenges of not having balanced positive and negative categories along with the difference in noise levels induced by the diverse sensors used by different autonomous vehicles. Hence, it may be beneficial to score and rank the data collected by crowdsourcing in a way that helps identify its goodness.

Accordingly, in some aspects, crowdsourced data may be scored and ranked based on geolocation information for the autonomous vehicle. In some aspects, the crowdsourced data may be scored and ranked by considering location metadata in addition to vehicular metadata. By using geolocation information to score and rank data, location specific models may be generated as opposed to vehicle specific ones.

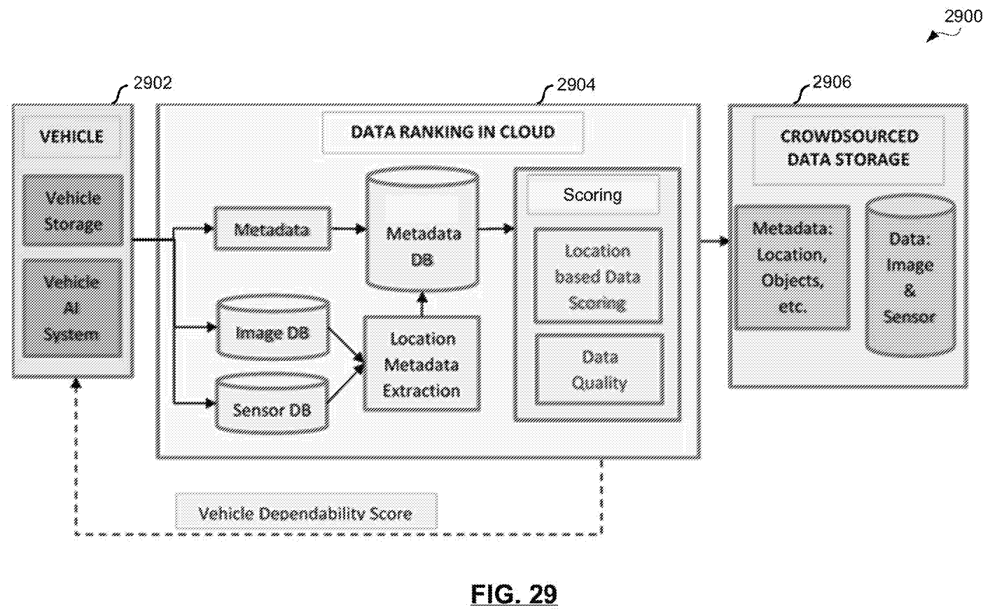

FIG. 28 is a simplified diagram of an example environment 2800 for autonomous vehicle data collection in accordance with at least one embodiment. The example environment 2800 includes an autonomous vehicle data scoring server 2802, a crowdsourced data store 2806, and multiple autonomous vehicles 2810, each connected to one another via the network 2808. Although not shown, each of the autonomous vehicles 2810 includes one or more sensors that are used by the autonomous vehicle to control the autonomous vehicle and negotiate trips by the autonomous vehicle between locations. As described further, the example environment 2800 may be used to crowdsource data collection from each of the autonomous vehicles 2810. In particular, as each of the autonomous vehicles 2810 drives, the autonomous vehicle will gather sensor data from each of a plurality of sensors coupled to the autonomous vehicle, such as camera data, LIDAR data, geolocation data, temperature or other weather data. The autonomous vehicle may, in some cases, transmit its sensor data to the autonomous vehicle data scoring server 2802 via the network 2808. The autonomous vehicle data scoring server 2802 may in turn score or rank the data as described herein, and determine based on the scoring/ranking whether to store the data in the crowdsourced data store 2806.

In some cases, the data sent by the autonomous vehicles comprises Image Data and Sensor Data and may also have some associated metadata. Both of the data sources can be used in conjunction or in isolation to extract and generate metadata/tags related to location. The cumulative location specific metadata can be information like geographic coordinates for example: “45° 31′ 22.4256” N and 1220 59′ 23.3880″ W″. It can also be additional environment information indicating environmental contexts such as terrain information (e.g., “hilly” or “flat”), elevation information (e.g., “59.1 m”), temperature information (e.g., “20° C.”), or weather information associated with that geolocation (e.g., “sunny”, “foggy”, or “snow”). All of the location specific and related metadata (such as weather) may be used to score the data sent by the autonomous vehicle in order to determine whether to store the data in a crowdsourced data store. In some cases, the data scoring algorithm may achieve saturation for the geography with regards to data collection by using a cascade of location context-based heatmaps or density maps for scoring the data, as described further below.

For example, where there are a number of location metadata categories, like geographic coordinates, elevation, weather, etc. an overall goodness score for the autonomous vehicle's sensor data may be determined using a location score. The location score may be a weighted summation across all the categories, and may be described by:

Score_{Location}=Σ(α.GeoCoordinates+β.Elevation+γ.Weather+ . . . )

where each of the variables GeoCoordinates, Elevation, and Weather are values determined from a heatmap, any type of density-plot, or any type of density distribution map (e.g., the heatmap 3000 of FIG. 30) and α,β,γ are weights (which may each be computed based on a separate density plot) associated with each location metadata category. In some cases, each of the variables of the location score are between 0-1, and the location score is also between 0-1.

After the location score computation, additional qualities associated with the sensor data (e.g., such as the noise level, objects of interest in image data, etc.) may be used to determine an overall goodness score for the sensor data. In some cases, the overall goodness score for the sensor data is a cumulative weighted sum of all the data qualities, and may be described by:

Score_{Goodness}=Σ(a.Score_{Location}+b.Score_{Noise}+c.Score_{ObjectDiversity}+ . . . )

where a, b, c are the weights associated with data quality categories. In some cases, each of the variables of the overall goodness score are between 0-1, and the overall goodness score is also between 0-1. The overall goodness score output by the autonomous vehicle data scoring algorithm (e.g., as performed by an external data repository system, or other computing system implementing a data scoring system) may be associated with the autonomous vehicle's sensor data and may be used to determine whether to pass the autonomous vehicle data to the crowdsourced data store.

In some implementations, an example autonomous vehicle data scoring server 2802 includes a processor 2803 and memory 2804. The example processor 2803 executes instructions, for example, to perform one or more of the functions described herein. The instructions can include programs, codes, scripts, or other types of data stored in memory. Additionally, or alternatively, the instructions can be encoded as pre-programmed or re-programmable logic circuits, logic gates, or other types of hardware or firmware components. The processor 2803 may be or include a general-purpose microprocessor, as a specialized co-processor or another type of data processing apparatus. In some cases, the processor 2803 may be configured to execute or interpret software, scripts, programs, functions, executables, or other instructions stored in the memory 2804. In some instances, the processor 2803 includes multiple processors or data processing apparatuses. The example memory 2804 includes one or more computer-readable media. For example, the memory 2804 may include a volatile memory device, a non-volatile memory device, or a combination thereof. The memory 2804 can include one or more read-only memory devices, random-access memory devices, buffer memory devices, or a combination of these and other types of memory devices. The memory 2804 may store instructions (e.g., programs, codes, scripts, or other types of executable instructions) that are executable by the processor 2803. Although not shown, each of the autonomous vehicles 2810 may include a processor and memory similar to the processor 2803 and memory 2804.

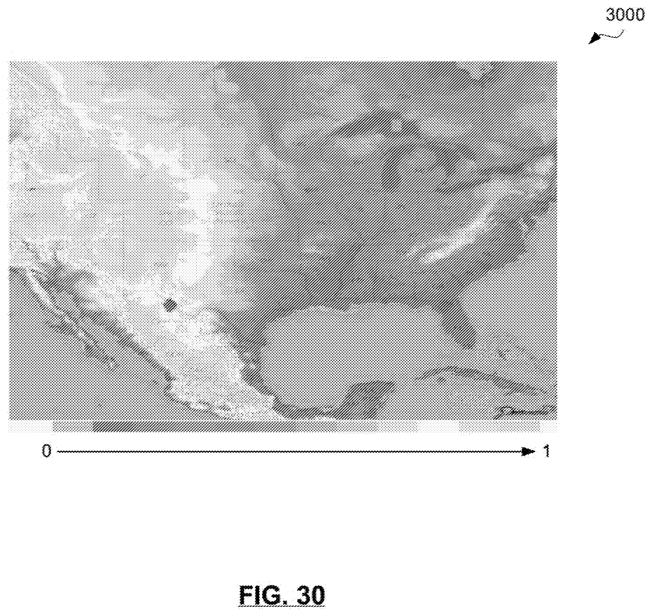

FIG. 29 is a simplified block diagram of an example crowdsourced data collection environment 2900 for autonomous vehicles in accordance with at least one embodiment. The example environment 2900 includes an autonomous vehicle 2902, an autonomous vehicle data scoring/ranking server 2904 in the cloud, and a crowdsourced data storage 2906. In the example shown, the autonomous vehicle includes its own storage for its sensor data and an AI system used to navigate the autonomous vehicle based on the sensor data. The autonomous vehicle sends all or some of its sensor data to the autonomous vehicle data scoring/ranking server, which extracts metadata included with the data and stores the metadata. The server also analyzes the image and sensor data from the autonomous vehicle to extract additional information/metadata and stores the information. The stored metadata is then used by a scoring module of the server to compute a location-based score (e.g., the location score described above) and a data quality score (e.g., the overall goodness score described above). Based on those scores, the server determines whether to pass the autonomous vehicle sensor data to the crowdsourced data storage.

In some cases, the server may also compute a Vehicle Dependability Score that is to be associated with the autonomous vehicle. This score may be based on historical location scores, goodness scores, or other information, and may be a metric used by the crowdsource governance system as some context for providing identity of the autonomous vehicle for future data scoring/ranking. The Vehicle Dependability Score may also be used for incentivizing the autonomous vehicle's participation in providing its data in the future.

FIG. 30 is a simplified diagram of an example heatmap FIG. 3000 for use in computing a sensor data goodness score in accordance with at least one embodiment. In the example shown, the heatmap signifies the crowdsourced data availability according to geographic co-ordinates metadata. Each location in the heatmap indicates a value associated with the data availability. In the example shown, the values range from 0-1. The lighter areas on the map would indicate least amount of data available from those locations where as the darker areas indicate an area of dense collected data. The reason for the variation in the collected data density, could be one or multiple of the following factors: population density, industrial development, geographic conditions etc. Thus, the goal of the data scoring algorithm may be to score the data such that enough data is collected in the geographic co-ordinates of the lighter areas of the heatmap. Since the collected data is scarce in the lighter regions, it will be scored leniently. On the other hand, if data is collected from the darker region of the map, which has dense data, factors such as noise in the data will have more influence on data score.

Each variable/factor of the location score may have a separate heatmap associated with it. For example, referring to the location score above, the GeoCoordinates variable would have a first heatmap associated therewith, the Elevation variable would have a second heatmap associated therewith, and the Weather variable would have a third heatmap associated therewith. Each of the heatmaps may include different values, as the amount of data collected for each of the variables may vary depending on the location. The values of the different heatmaps may be used in computing the location score, e.g., through a weighted summation as described above.

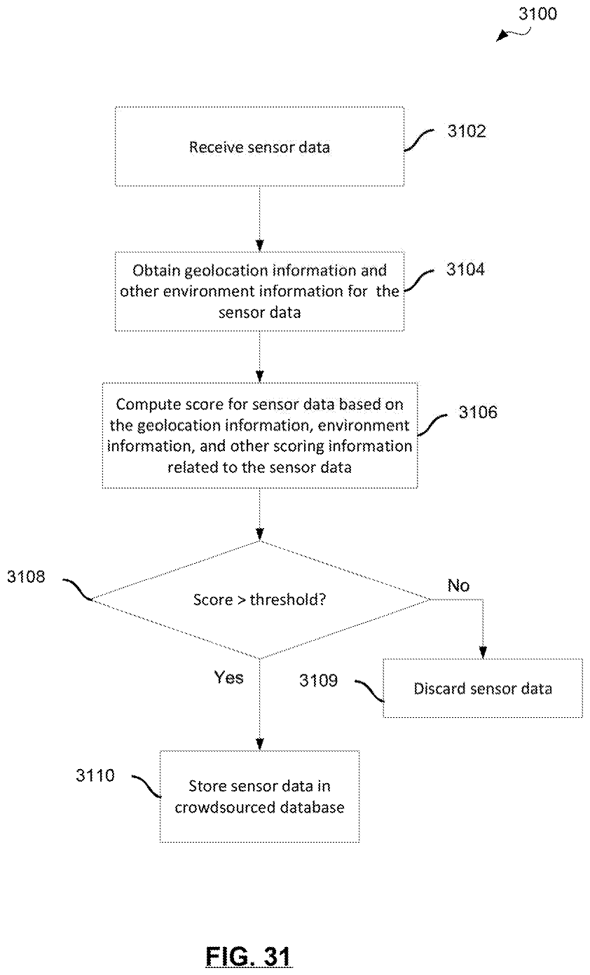

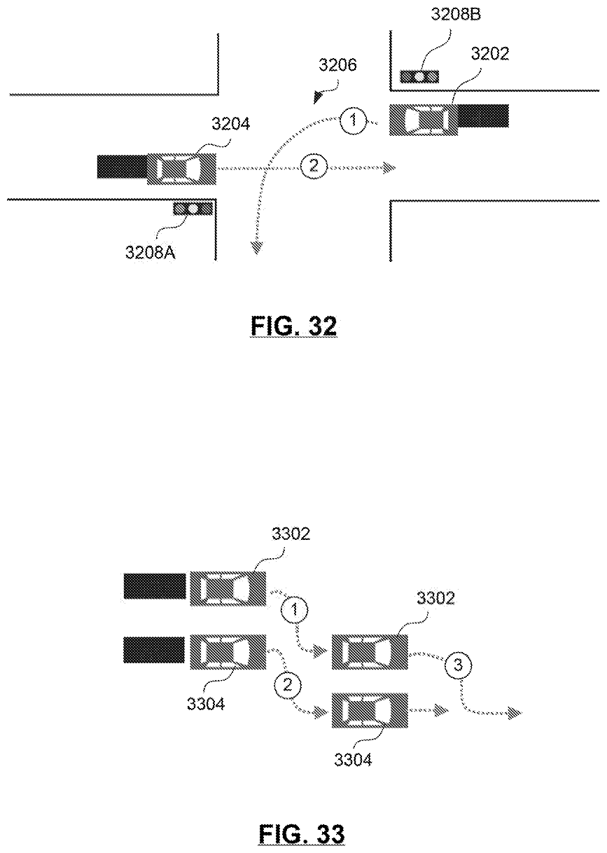

FIG. 31 is a flow diagram of an example process 3100 of computing a goodness score for autonomous vehicle sensor data in accordance with at least one embodiment. Operations in the example process 3100 may be performed by components of, or connected to, an autonomous vehicle data scoring server 2802 (e.g., server of FIG. 28). The example process 3100 may include additional or different operations, and the operations may be performed in the order shown or in another order. In some cases, one or more of the operations shown in FIG. 3100 are implemented as processes that include multiple operations, sub-processes, or other types of routines. In some cases, operations can be combined, performed in another order, performed in parallel, iterated, or otherwise repeated or performed another manner.

At 3102, sensor data is received from one or more autonomous vehicles. The sensor data may include one or more of video or image data (e.g., from cameras) and point data values (e.g., temperature, barometric pressure, etc.).

At 3104, geolocation and other environmental information is obtained from the sensor data.

At 3106, a score is computed for the sensor data that indicates its overall goodness or quality. The score is based on the geolocation and environmental information obtained at 3104. For example, the score may be based on a location score computed from the geolocation and environmental information as described above. In some cases, the score may also be based on additional scoring information associated with the sensor data. For example, the score may be based a noise score, object diversity score, or other scores computed for the sensor data.

At 3108, it is determined whether the score computed at 3106 is above a threshold value, or within a range of values. If so, the sensor data is stored at 3110 in a database used for collecting crowdsourced autonomous vehicle sensor data. When stored, the sensor data may be associated with the calculated goodness score. If the score is below the threshold value, or outside a range of values, the sensor data is discarded or otherwise not stored at 3109.

It is anticipated that autonomous vehicles will continue to share the road with human-driven vehicles (HVs) that may exhibit irregular behavior that does not conform to the documented driving practices. Human drivers may exhibit aggressive behaviors (e.g., tailgating or weaving through traffic) or timid behaviors (e.g., driving at speeds significantly slower than the posted speed limit, which can also cause accidents). Irregular human driving patterns might also arise from driving conventions in specific regions in some instances. For example, a maneuver sometimes referred to as the “Pittsburgh Left” observed in Western Pennsylvania violates the standard rules of precedence for vehicles at an intersection by allowing the first left-turning vehicle to take precedence over vehicles going straight through an intersection (e.g., after a stoplight switches to green for both directions). As another example, drivers in certain regions of the country might also drive more or less aggressively than drivers in other regions of the country.

The autonomous driving stack implemented through the in-vehicle computing system of an example autonomous vehicle may be enhanced to learn and detect irregular behavior exhibited by HVs, and respond safely to them. In some aspects, for example, an autonomous vehicle system can observe, and track the frequency of, irregular behaviors (e.g., those shown in the Table below) and learn to predict that an individual HV is likely to exhibit irregular behavior in the near future, or that a certain type of irregular behavior is more likely to occur in a given region of the country.

| Frequency | |
|---|---|
| of Irregular | |
| Behavior | Examples |
| One-off incident by | Human driver attempts to lane change when |
| single driver | autonomous vehicle is in blind spot. |
| Repeated incidents | Drunk drivers, fatigued drivers, or road rage drivers |
| by same driver | who repeatedly exhibit unsafe driving behavior. |
| Common location- | Drivers in certain city tend to drive aggressively |
| specific behavior | and tend to cut-in when there are |
| | small lateral gaps between vehicles. |

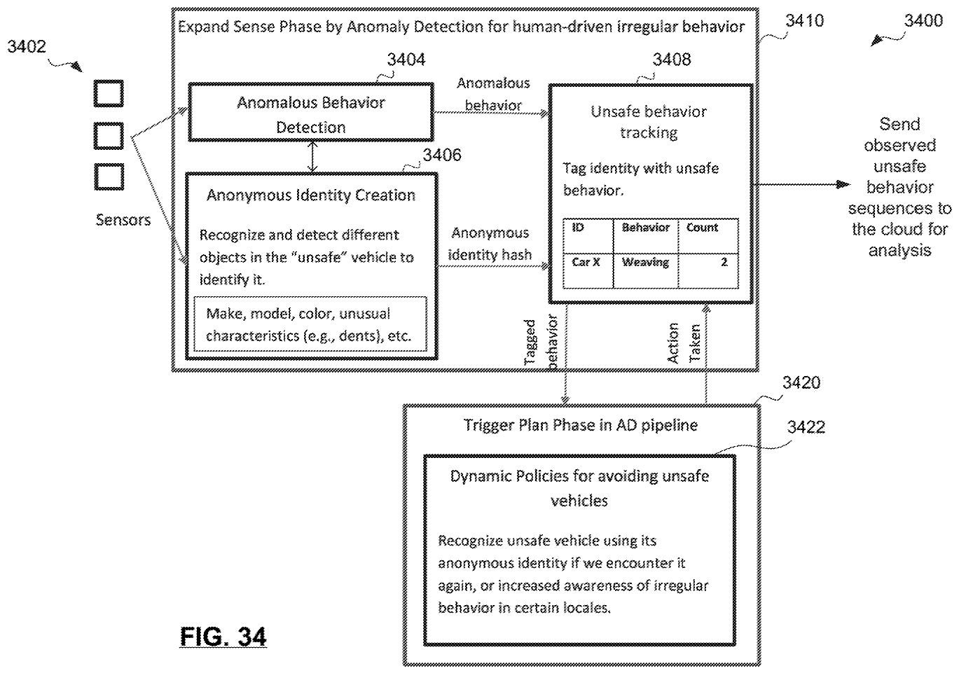

In some embodiments, irregular driving patterns can be modeled as a sequence of driving actions that deviates from the normal behavior expected by the autonomous vehicle. FIGS. 32 and 33 illustrate two examples of irregular driving patterns, and how an autonomous vehicle may learn to adapt its behavior in response to observing such behaviors.

FIG. 32 illustrates an example “Pittsburgh Left” scenario as described above. In the example shown, an HV 3202 and autonomous vehicle 3204 are both stopped at intersection 3206, when the lights 3208 turn green. In a typical scenario, the autonomous vehicle would have precedence to continue through the intersection before the HV. However, in the Pittsburgh Left scenario shown, the HV turns left first instead of yielding to the autonomous vehicle which is going straight through the intersection. Through observing this behavior multiple times in a geographical region, the autonomous vehicle may learn to anticipate behavior such as this (where the first left turning vehicle assumes precedence) so it enters intersection more cautiously when it is in the geographical region.

FIG. 33 illustrates an example “road rage” scenario by an HV. In the example shown, the driver of the HV may be angry at the autonomous vehicle and may accordingly cut in front of the autonomous vehicle and may slow down abruptly. In response, the autonomous vehicle may slow down and change lanes to avoid the HV. The HV may then accelerate further and cut in front of the autonomous vehicle again, and may then abruptly slow down again. Because the HV has seen this maneuver from the HV multiple times, the autonomous vehicle may detect that the HV is an angry driver that is repeatedly cutting in-front of the autonomous vehicle. The autonomous vehicle can accordingly take a corrective action, such as, for example, handing off control back to its human driver the next time it encounters the particular HV.

FIG. 34 is a simplified block diagram showing an irregular/anomalous behavior tracking model 3400 for an autonomous vehicle in accordance with at least one embodiment. In the example shown, the sensing phase 3410 of the autonomous vehicle software stack receives sensor data from the sensors 3402 of the autonomous vehicle and uses the sensor data to detect/identify anomalous behavior observed by a particular HV (e.g., in an anomalous behavior detection software module 3404 as shown). In response to the anomalous behavior detection, or parallel with the detection, an anonymous identity for the HV is created (e.g., in an anonymous identity creation software module 3406 as shown). The observed behavior and the associated identity of the HV are then used to track a frequency of the observed behaviors by the HV and other HVs around the autonomous vehicle (e.g., in an unsafe behavior tracking software module 3408 as shown). In some cases, the tracked behavior may be used by a planning phase 3420 of the autonomous vehicle software stack to trigger dynamic behavior policies for the autonomous vehicle in response to seeing patterns of anomalous behaviors in the HVs. Aspects of the model 3400 are described further below.

In some embodiments, the autonomous vehicle may detect anomalous or irregular behavior by a given HV by tracking sequences of driving actions that, for example:
Violate the autonomous vehicle's safety model (e.g., drivers who are not maintaining a safe lateral distance according to a Responsibility-Sensitive Safety rule set).
Drivers whose driving behavior differs significantly from other drivers in the vicinity (e.g., drivers who are driving significantly slower or faster than other drivers, or drivers weaving through traffic). Studies have shown that drivers whose speed differs significantly from the surrounding traffic can increase the likelihood of accidents.
Drivers whose actions cause other drivers to react adversely to them (e.g., a driver who is avoided by multiple drivers, or a driver who is honked at by multiple drivers).

In addition to tracking sequences of driving actions, in some embodiments, the autonomous vehicle can also use audio and visual contextual information to categorize types of drivers (e.g., a distracted driver vs. a safe driver observing safe distances from other cars), driver attributes (e.g., paying attention to the road vs. looking down at a phone), or vehicle attributes (e.g., missing mirrors, broken windshields, or other characteristics that would may the vehicle un-roadworthy) that may be more likely to result in unsafe behavior in the near future. For example, video from external-facing cameras on the autonomous vehicle may be used to train computer vision models to detect vehicle or driver attributes that increase the risk of accidents, such as a human driver on their cell phone, or limited visibility due to snow-covered windows. The computer vision models may be augmented, in certain instances, with acoustic models that may recognize aggressive behavior such as aggressive honking, yelling, or unsafe situations such as screeching brakes. The Table below lists certain examples of audio and visual contextual information that may indicate an increased likelihood of future unsafe behavior.

| Type of | |
|---|---|
| unsafe | Audio-visual |
| behavior | Context |
| Angry | Aggressive flashing headlights |
| driver | Raised fists |
| | Aggressive honking |
| | Driver yelling |
| | Angry driver (e.g., angry facial |
| | expression, raised fists) |
| Distracted | Driver on cell-phone |
| driver | Driver repeatedly taking their eyes of road |
| | Driver taking hands off wheel |
| Obscured | Vehicle with limited visibility due |
| vision | to snow-covered windows |
| | Missing side-view or rear-view mirrors |
| | Non-functional headlights |
| Braking | Excessive brake noises |
| issues | Balding tires |

In some embodiments, the autonomous vehicle may track the frequency of observed irregular behaviors by particular vehicles (e.g., HVs) to determine whether it is a single driver exhibiting the same behavior in a given window of time (which may indicate one unsafe driver), or whether there are multiple drivers in a given locale exhibiting the same behavior (which may indicate a social norm for the locale).

To preserve the privacy of the human drivers, the autonomous vehicle may create an anonymous identity for the unsafe HV and may tag this identity with the unsafe behavior to track recurrence by the HV or other HVs. The anonymous identity may be created without relying on license plate recognition, which might not always be available or reliable. The anonymous signature may be created, in some embodiments, by extracting representative features from the deep learning model used for recognizing cars. For example, certain layers of the deep learning network of the autonomous vehicle may capture features about the car such as its shape and color. These features may also be augmented with additional attributes that we recognize about the car such as its make, model, or unusual features like dents, scrapes, broken windshield, missing side view mirrors, etc. A cryptographic hash may then be applied on the combined features and the hash may be used as an identifier for the HV during the current trip of the autonomous vehicle. In some cases, this signature may not be completely unique to the vehicle (e.g., if there are similar looking vehicles around the autonomous vehicle); however, it may be sufficient for the autonomous vehicle to identify the unsafe vehicle for the duration of a trip. License plate recognition may be used in certain cases, such as where the autonomous vehicle needs to alert authorities about a dangerous vehicle.

The autonomous vehicle can determine that the unsafe behavior is escalating, for example, by monitoring whether the duration between unsafe events decreases, or whether the severity of the unsafe action is increasing. This information can then be fed into the plan phase of the AD pipeline to trigger a dynamic policy such as avoiding the unsafe vehicle if the autonomous vehicle encounters it again or alerting authorities if the unsafe behavior is endangering other motorists on the road. The autonomous vehicle may also define a retention policy for tracking the unsafe behavior for a given vehicle. For example, a retention policy may call for an autonomous vehicle to only maintain information about an unsafe driver for the duration of the trip, for a set number of trips, for a set duration of time, etc.

In some embodiments, the autonomous vehicle may transmit data about the anomalous behavior that it detects to the cloud, on a per-vehicle basis. This data may be used to learn patterns of human-driven irregular behavior, and determine whether such behaviors are more likely to occur in a given context. For example, it may be learned that drivers in a given city are likely to cut into traffic when the lateral gap between vehicles is greater than a certain distance, that drivers at certain intersections are more prone to rolling stops, or that drivers on their cell-phones are more likely to depart from their lanes. The data transmitted from the autonomous vehicle to the cloud may include, for example:
trajectories of the unsafe vehicle, the vehicles adjacent to it, and the autonomous vehicle
driver and vehicle attributes for unsafe vehicle, e.g., driver on cellphone, obscured vision due to snow-covered windows
geographic location, weather conditions, traffic sign and traffic light data
type of unsafe action—can be tagged as either a known action such as abrupt stop that violated the autonomous vehicle's safety model, or an unknown anomalous behavior flagged by the system

In some embodiments, learning the context-based patterns of human-driven irregular behavior may involve clustering the temporal sequences of driving actions associated with unsafe behavior using techniques such as Longest Common Subsequences (LCS). Clustering may reduce the dimensionality of vehicle trajectory data and may identify a representative sequence for driving actions for each unsafe behavior. The Table below provides examples of certain temporal sequences that may be clustered.

| ID | Sequence |
|---|---|
| 1 | Traffic light turns red −> Autonomous Vehicle (AV) |
| | arrives at intersection −> Human-driven Vehicle (HV) |
| | arrives at intersection −> Light turns green −> HV turns left |
| | instead of yielding to AV which is going straight. |
| 2 | Traffic light turns red −> HV arrives at intersection −> AV |
| | arrives at intersection −> Light turns green −> HV turns left |
| | instead of yielding to AV which is going straight. |

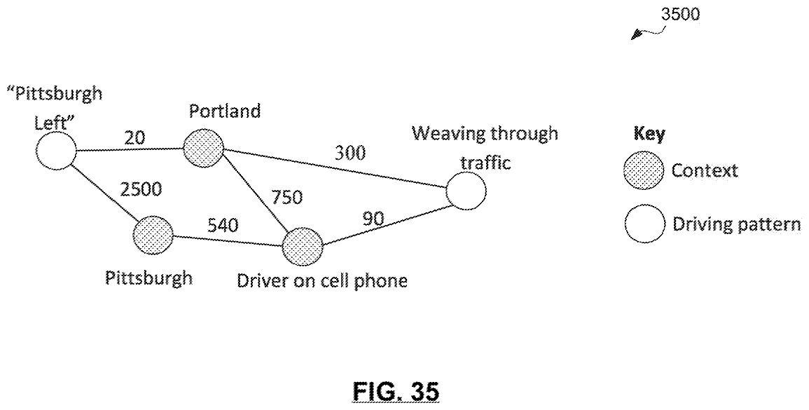

Further, in some embodiments, driving patterns that are more likely to occur in a given context may be learned. For example, based on the tracked sequences, it may be learned whether a certain irregular driving pattern is more common in a given city when it snows, or whether certain driving actions are more likely to occur with angry drivers. This information may be used to model the conditional probability distributions of driving patterns for a given context. These context-based models allow the autonomous vehicle to anticipate the likely sequence of actions that an unsafe vehicle may take in a given scenario. For example, a contextual graph that tracks how often a driving pattern occurs in a given context is shown in FIG. 35. As shown, the contextual graph may track the identified sequences (“driving patterns” nodes in FIG. 35) along with context information (“context” nodes in FIG. 35) and the associated frequency of observation of the sequences and context (the weights of the edges in FIG. 35) to identify whether there are particular behavior patterns that occur more often in certain contexts than others (e.g., patterns that occur overwhelmingly in certain geographical contexts, time contexts, etc.). The identified patterns can also be used to train reinforcement learning models which identify the actions that the autonomous vehicle should take to avoid the unsafe behavior. For example, the learned contextual behavior patterns may be used to modify a behavioral model of an autonomous vehicle, such as, for example, dynamically when the autonomous vehicle enters or observes the particular context associated with the contextual behavior pattern.

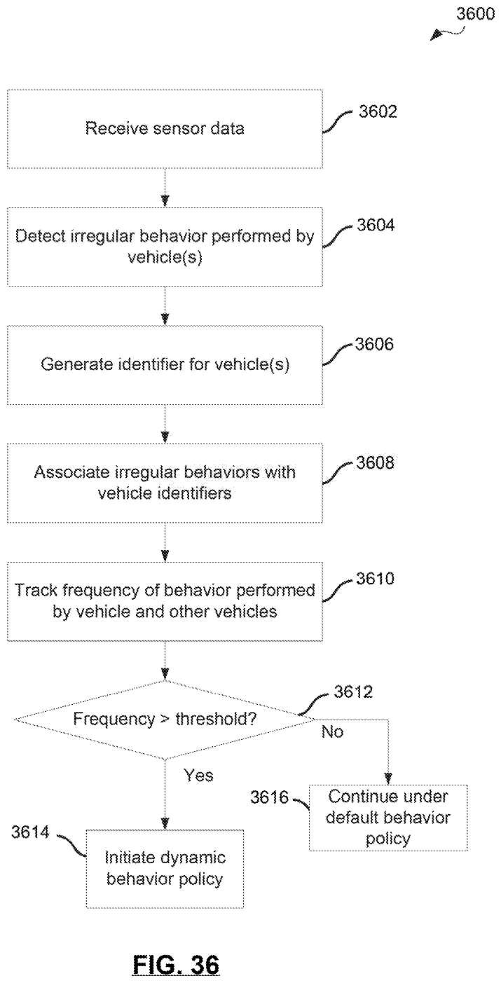

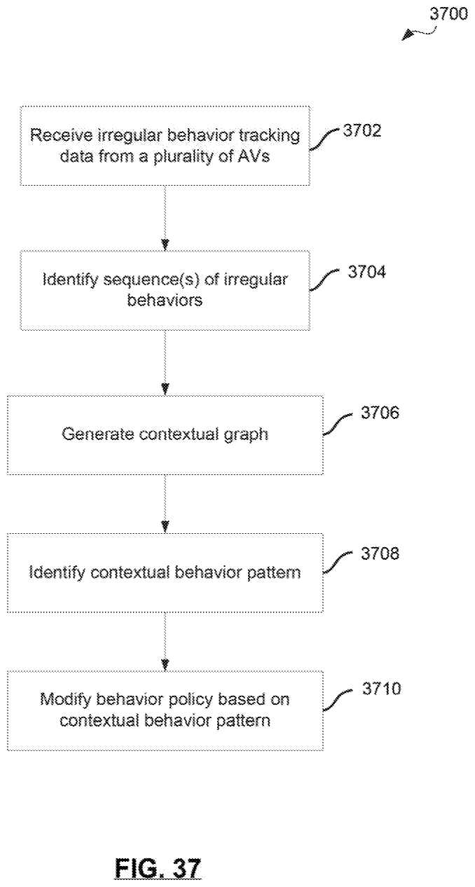

FIG. 36 is a flow diagram of an example process 3600 of tracking irregular behaviors observed by vehicles in accordance with at least one embodiment. Operations in the example process 3600 may be performed by one or more components of an autonomous vehicle or a cloud-based learning module. The example process 3600 may include additional or different operations, and the operations may be performed in the order shown or in another order. In some cases, one or more of the operations shown in FIG. 3600 are implemented as processes that include multiple operations, sub-processes, or other types of routines. In some cases, operations can be combined, performed in another order, performed in parallel, iterated, or otherwise repeated or performed another manner.

At 3602, sensor data is received from a plurality of sensors coupled to the autonomous vehicle, including cameras, LIDAR, or other sensors used by the autonomous vehicle to identify vehicles and surroundings.

At 3604, irregular or anomalous behaviors are detected as being performed by one or more vehicles. In some cases, detection may be done by comparing an observed behavior performed by the particular vehicle with a safety model of the autonomous vehicle; and determining, based on the comparison, that the observed behavior violates the safety model of the autonomous vehicle. In some cases, detection may be done by comparing an observed behavior performed by the particular vehicle with observed behaviors performed by other vehicles; and determining, based on the comparison, that the observed behavior performed by the particular vehicle deviates from the observed behaviors performed by the other vehicles. In some cases, detection may be done by comparing an observed behavior performed by the particular vehicle with observed behaviors performed by other vehicles; and determining, based on the comparison, that the observed behavior performed by the particular vehicle deviates from the observed behaviors performed by the other vehicles. Detection may be done in another manner. Detection may be based on audio and visual contextual information in the sensor data.

At 3606, an identifier is generated for each vehicle for which an irregular behavior was observed. The identifier may be generated by obtaining values for respective features of the particular vehicle; and applying a cryptographic has on a combination of the values to obtain the identifier. The values may be obtained by extracting representative features from a deep learning model used by the autonomous vehicle to recognize other vehicles. The identifier may be generated in another manner.

At 3608, the irregular behaviors detected at 3604 are associated with the identifiers generated at 3606 for the vehicles that performed the respective irregular behaviors.

At 3610, the frequency of occurrence of the irregular behaviors is tracked for the identified vehicles.

At 3612, it is determined whether an observed irregular behavior has been observed as being performed by a particular vehicle more than a threshold number of times. If so, at 3614, a dynamic behavior policy is initiated (e.g., to further avoid the vehicle). If not, the autonomous vehicle continues operating under the default behavior policy.

FIG. 37 is a flow diagram of an example process 3700 of identifying contextual behavior patterns in accordance with at least one embodiment. Operations in the example process 3700 may be performed by a learning module of an autonomous vehicle or a cloud-based learning module. The example process 3700 may include additional or different operations, and the operations may be performed in the order shown or in another order. In some cases, one or more of the operations shown in FIG. 37 are implemented as processes that include multiple operations, sub-processes, or other types of routines. In some cases, operations can be combined, performed in another order, performed in parallel, iterated, or otherwise repeated or performed another manner.

At 3702, irregular behavior tracking data is received from a plurality of autonomous vehicles. The irregular behavior tracking data may include entries that include a vehicle identifier, an associated irregular behavior observed as being performed by a vehicle associated with the vehicle identifier, and contextual data indicating a context in which the irregular behavior was detected by the autonomous vehicles. In some cases, the contextual data may include one or more of trajectory information for the vehicles performing the irregular behaviors, vehicle attributes for the vehicles performing the irregular behaviors, driver attributes for the vehicles performing the irregular behaviors, a geographic location of the vehicles performing the irregular behaviors, weather conditions around the vehicles performing the irregular behaviors, and traffic information indicating traffic conditions around the vehicles performing the irregular behaviors.

At 3704, one or more sequences of irregular behaviors are identified. This may be done by clustering the behaviors, such as by using Longest Common Subsequences (LCS) techniques.

At 3706, a contextual graph is generated based on the sequences identified at 3704 and the data received at 3702. The contextual graph may include a first set of nodes indicating identified sequences and a second set of nodes indicating contextual data, wherein edges of the contextual graph indicate a frequency of associations between the nodes.

At 3708, a contextual behavior pattern is identified using the contextual graph, and at 3710, a behavior policy for one or more autonomous vehicles is modified based on the identified contextual behavior pattern. For example, behavior policies may be modified for one or more autonomous vehicles based on detecting that the one or more autonomous vehicles are within a particular context associated with the identified contextual behavior pattern.

As discussed herein, principles and features of modern computer vision (CV) and artificial intelligence (AI) may be utilized in in-vehicle computing systems to implement example autonomous driving stacks used for highly automated and autonomous vehicles. However, CV and AI models and logic may sometimes be prone to misclassifications and manipulation. A typical Intrusion Detection System (IDS) is slow and complex and can generate a significant amount of noise and false positives. A single bit flip in a deep neural network (DNN) algorithm can cause misclassification of an image entirely. Accordingly, improved autonomous driving systems may be implemented to more accurately identify faults and attacks on highly automated and autonomous vehicles.

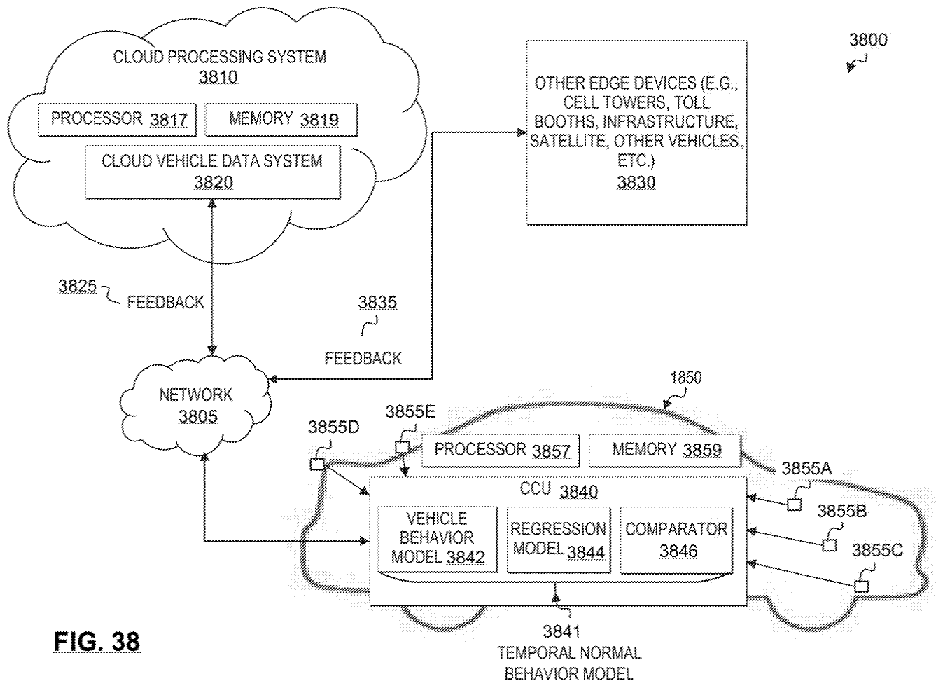

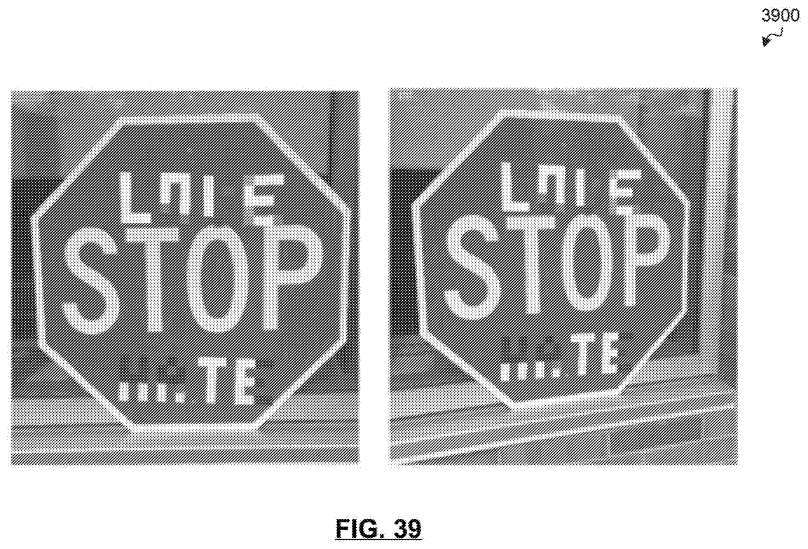

The following disclosure provides various possible embodiments, or examples, for implementing a fault and intrusion detection system 3800 for highly automated and autonomous vehicles as shown in FIG. 38. In one or more embodiments, vehicle motion prediction events and control commands, which are both a higher level of abstraction, are monitored. Based on the current state of vehicle motion parameters and road parameters, a vehicle remains within a certain motion envelope. A temporal normal behavior model 3841 is constructed to maintain adherence to the motion envelope. In at least one embodiment, at least two algorithms are used to build the temporal normal behavior model. The algorithms include a vehicle behavior model 3842 (e.g., based on a Hidden Markov Model (HMM)) for learning normal vehicle behavior and a regression model 3844 to find the deviation from the vehicle behavior model. In particular, the regression model is used to determine whether the vehicle behavior model correctly detects a fault, where the fault could be a vehicle system error or a malicious attack on the vehicle system.

For purposes of illustrating the several embodiments of a fault and intrusion detection system for highly automated and autonomous vehicles, it is important to first understand possible activities related to highly automated and autonomous vehicles. Accordingly, the following foundational information may be viewed as a basis from which the present disclosure may be properly explained.

Modern computer vision (CV) and artificial intelligence (AI) used for autonomous vehicles is prone to misclassifications and manipulation. For example, an attacker can generate stickers that can trick a vehicle into believing a sign really means something else. FIG. 39 illustrates such a manipulation, as seen in the “love/hate” graphics 3900 in which “LOVE” is printed above “STOP” on a stop sign, and “HATE” is printed below “STOP” on the stop sign. Although the graffiti-marked sign is obvious to English-speaking drivers as being a stop sign, this graffiti can make at least some computer vision algorithms believe the stop sign is actually a speed limit or yield notice. In addition, a single bit-flip error in a deep neural network (DNN) algorithm that classifies images can cause misclassification of an image. For example, instead of a huge truck, just a single bit-flip could cause the classifier to see a small animal or a bird.

Current (rule-based) intrusion detection systems (IDS) generate too much noise and too many false positives due to the non-deterministic nature of automotive networks, rendering them inadequate to cover the full range of abnormal behavior. Error correction code (ECC) algorithms have limitations and are generally not helpful in artificial intelligence. Generative adversarial networks (GANs) have value but depend heavily on the selection of adversarial data in a training set. Current machine learning-based intrusion detection systems are not adequate for use in automotive systems due to high complexity and the many internal networks and external connections that are monitored.

Fault and intrusion detection system 3800, as shown in FIG. 38, resolves many of the aforementioned issues (and more). System 3800 includes temporal normal behavior model 3841 with two algorithms: vehicle behavior model 3842 for learning normal behavior of a vehicle and regression model 3844 for predicting the likelihood of a behavior of the vehicle for time interval t. The vehicle behavior model can be a probabilistic model for normal vehicle behavior. The vehicle behavior model learns a baseline low-rank stationary model and then models the deviation of the temporal model from the stationary one. As the event set is generally static over time, the vehicle behavior model can be updated through occasional parameter re-weighting given previous and new, vetted training samples that have passed the fault and intrusion detection system and been retained. A regression algorithm compares the likelihood of a change of motion based on new received control events computed from the vehicle behavior model to the model (e.g., motion envelope) predicted by the regression algorithm.

Fault and intrusion detection system 3800 offers several potential advantages. For example, system 3800 monitors vehicle motion prediction events and control commands, which are a higher level of abstraction than those monitored by typical intrusion detection systems. Embodiments herein allow for detection at a higher level where malicious attacks and intent can be detected, rather than low level changes that may not be caught by a typical intrusion detection system. Accordingly, system 3800 enables detection of sophisticated and complex attacks and system failures.

Turning to FIG. 38, fault and intrusion detection system 3800 includes a cloud processing system 3810, a vehicle 3850, other edge devices 3830, and one or more networks (e.g., network 3805) that facilitate communication between vehicle 3850 and cloud processing system 3810 and between vehicle 3850 and other edge devices 3830. Cloud processing system 3810 includes a cloud vehicle data system 3820. Vehicle 3850 includes a CCU 3840 and numerous sensors, such as sensors 3855A-3855E. Elements of FIG. 38 also contain appropriate hardware components including, but not necessarily limited to processors (e.g., 3817, 3857) and memory (e.g., 3819, 3859), which may be realized in numerous different embodiments.

In vehicle 3850, CCU 3840 may receive near-continuous data feeds from sensors 3855A-3855E. Sensors may include any type of sensor described herein, including steering, throttle, and brake sensors. Numerous other types of sensors (e.g., image capturing devices, tire pressure sensor, road condition sensor, etc.) may also provide data to CCU 3840. CCU 3840 includes temporal normal behavior model 3841, which comprises vehicle behavior model 3842, regression model 3844, and a comparator 3846.

Vehicle behavior model 3842 may train on raw data of sensors, such as a steering sensor data, throttle sensor data, and brake sensor data, to learn vehicle behavior at a low-level. Events occurring in the vehicle are generally static over time, so the vehicle behavior model can be updated through occasional parameter re-weighting given previous and new, vetted training samples that have passed the fault and intrusion detection system and that have been retained.

In at least one example, vehicle behavior model 3842 is a probabilistic model. A probabilistic model is a statistical model that is used to define relationships between variables. In at least some embodiments, these variables include steering sensor data, throttle sensor data, and brake sensor data. In a probabilistic model, there can be error in the prediction of one variable from the other variables. Other factors can account for the variability in the data, and the probabilistic model includes one or more probability distributions to account for these other factors. In at least one embodiment, the probabilistic model may be a Hidden Markov Model (HMM). In HMM, the system being modeled is assumed to be a Markov process with unobserved (e.g., hidden) states.

In at least one embodiment, the vehicle behavior model is in the pipeline to the physical vehicle actuation. Actuation events (also referred to herein as ‘control events’) may be marked as actuation events by a previous software layer. Vector structures may be used by vehicle behavior model 3842 for different types of input data (e.g., vector for weather, vector for speed, vector for direction, etc.). For each parameter in a vector structure, vehicle behavior model 3842 assigns a probability. Vehicle behavior model 3842 can run continuously on the data going to the vehicle's actuators. Accordingly, every command (e.g., to change the motion of the vehicle) can go through the vehicle behavior model and a behavioral state of what the vehicle is doing can be maintained.

Typically, control events are initiated by driver commands (e.g., turning a steering wheel, applying the brakes, applying the throttle) or from sensors of an autonomous car that indicate the next action of the vehicle. Control events may also come from a feedback loop from the sensors and actuators themselves. Generally, a control event is indicative of a change in motion by the vehicle. Vehicle behavior model 3842 can determine whether the change in motion is potentially anomalous or is an expected behavior. In particular, an output of vehicle behavior model can be a classification of the change in motion. In one example, a classification can indicate a likelihood that the change in motion is a fault (e.g., malicious attack or failure in the vehicle computer system).

Regression model 3844 predicts the likelihood of a change in motion of the vehicle, which is indicated by a control event, occurring at a given time interval t. A regression algorithm is a statistical method for examining the relationship between two or more variables. Generally, regression algorithms examine the influence of one or more independent variables on a dependent variable.

Inputs for regression model 3844 can include higher level events such as inputs from motion sensors other than the motion sensor associated with the control event. For example, when a control even is associated with a braking sensor, input for the regression model may also include input from the throttle sensor and the steering sensor. Input may be received from other relevant vehicle sensors such as, for example, gyroscopes indicating the inertia of the vehicle. Regression model 3844 may also receive inputs from other models in the vehicle such as an image classifier, which may classify an image captured by an image capturing device (e.g., camera) associated with the vehicle. In addition, regression model 3944 may include inputs from remote sources including, but not necessarily limited to, other edge devices such as cell towers, toll booths, infrastructure devices, satellite, other vehicles, radio station (e.g., for weather forecast, traffic conditions, etc.), etc. Inputs from other edge devices may include environmental data that provides additional information (e.g., environmental conditions, weather forecast, road conditions, time of day, location of vehicle, traffic conditions, etc.) that can be examined by the regression model to determine how the additional information influences the control event.

In at least one embodiment, regression model 3844 runs in the background and, based on examining the inputs from sensors, other models, remote sources such as other edge devices, etc., creates a memory of what the vehicle has been doing and predicts what the vehicle should do under normal (no-fault) conditions. A motion envelope can be created to apply limits to the vehicle behavior model. A motion envelope is a calculated prediction based on the inputs of the path of the vehicle and a destination of the vehicle during a given time interval t assuming that nothing goes wrong. Regression model 3844 can determine whether a control event indicates a change in motion for the vehicle that is outside a motion envelope. For example, if a control event is a hard braking event, the vehicle behavior model may determine that the braking event is outside a normal threshold for braking and indicates a high probability of fault in the vehicle system. The regression model, however, may examine input from a roadside infrastructure device indicating heavy traffic (e.g., due to an accident). Thus, regression model may determine that the hard braking event is likely to occur within a predicted motion envelope that is calculated based, at least in part, on the particular traffic conditions during time interval t.

Fault and intrusion detection system 3800 is agonistic to the type of the regression algorithm used. For example, an expectation maximization (EM) algorithm can be used, which is an iterative method to find the maximum likelihood of parameters in a statistical model, such as HMM, which depends on hidden variables. In at least one embodiment, the regression algorithm (e.g., linear or lasso) can be selected to be more or less tolerant of deviations depending on the desired motion envelope sizes. For example, one motion envelope may be constrained (or small) for vehicles to be used by civilians, whereas another motion envelope may be more relaxed for vehicles for military use.

Comparator 3846 can be used to apply limits to the vehicle behavior model 3842. The comparator can compare the output classification of vehicle behavior model 3842 and the output prediction of regression model 3844 and determine whether a change in motion indicated by a control event is a fault or an acceptable change in motion that can occur within a predicted motion envelope. The output classification of vehicle behavior model can be an indication of the likelihood that the change in motion indicated by the control event is a fault (e.g., malicious attack or failure in the vehicle computer system). The output prediction of the regression model 3844 can be a likelihood that the change in motion would occur in the given time interval t, based on input data from sensors, edge devices, other models in the vehicle, etc. The comparator can use the regression model to apply limits to the output classification of a control event by the vehicle behavior model.

In one example of the comparator function, if the vehicle behavior model indicates a braking event is potentially anomalous, but the regression model indicates that, for the particular environmental conditions received as input (e.g., high rate of speed from sensor, stoplight ahead from road maps, rain from weather forecast), the braking event that is expected is within an acceptable threshold (e.g., within a motion envelope). Because the braking event is within an acceptable threshold based on a motion envelope, the comparator can determine that the vehicle behavior model's assessment that the braking event is potentially anomalous can be overridden and a control signal may be sent to allow the braking action to continue. In another illustrative example, regression model 3844 knows that a vehicle has been doing 35 mph on a town street and expects a stop sign at a cross street because it has access to the map. The regression model also knows that the weather forecast is icy. In contrast, vehicle behavior model 3842 receives a control event (e.g., command to an actuator) to accelerate because its image classifier incorrectly determined that an upcoming stop sign means higher speed or because a hacker manipulated control data and sent the wrong command to the accelerator. In this scenario, although an output classification from the vehicle behavior model does not indicate that the control event is potentially anomalous, the comparator can generate an error or control signal based on the regression model output prediction that the control event is unlikely to happen given the motion envelope, for the given time interval t, which indicates that the vehicle should brake as it approaches the stop sign.

Any one of multiple suitable comparators may be used to implement the likelihood comparison feature of the temporal normal behavior model 3841. In at least one embodiment, the comparator may be selected based on the particular vehicle behavior model and regression model being used.

Comparator 3846 may be triggered to send feedback to the vehicle behavior model 3842 to modify its model. Feedback for the vehicle behavior model enables retraining. In one example, the system generates a memory of committed mistakes based on the feedback and is retrained to identify similar scenarios, for example, based on location and time. Other variables may also be used in the retraining.

Cloud vehicle data system 3820 may train and update regression models (e.g., 3844) for multiple vehicles. In one example, cloud vehicle data system 3820 may receive feedback 3825 from regression models (e.g., 3844) in operational vehicles (e.g., 3850). Feedback 3825 can be sent to cloud vehicle data system 3820 for aggregation and re-computation to update regression models in multiple vehicles to optimize behavior. In at least some examples, one or more edge devices 3830 may perform aggregation and possibly some training/update operations. In these examples, feedback 3835 may be received from regression models (e.g., 3844) to enable these aggregations, training, and/or update operations.

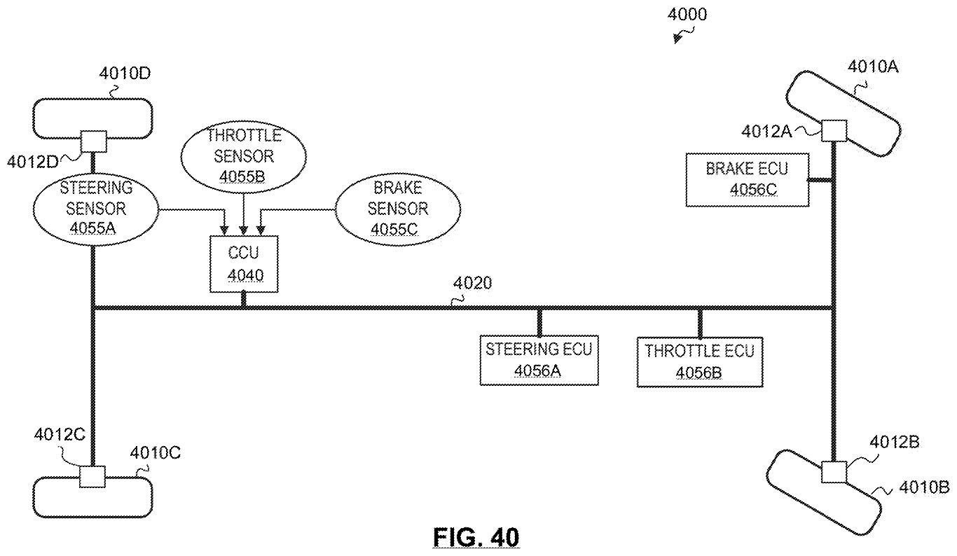

Turning to FIG. 40, a block diagram of a simplified centralized vehicle control architecture 4000 for a vehicle according to at least one embodiment is illustrated. In the vehicle control architecture, a bus 4020 (e.g., controller area network (CAN), FlexRay bus, etc.) connects tires 4010A, 4010B, 4010C, and 4010D and their respective actuators 4012A, 4012B, 4012C, and 4012D to various engine control units (ECUs) including a steering ECU 4056A, a throttle ECU 4056B, and a brake ECU 4056C. The bus also connects a connectivity control unit (CCU) 4040 to the ECUs. CCU 4040 is communicably connected to sensors such as a steering sensor 4055A, a throttle sensor 4055B, and a brake sensor 4055C. CCU 4040 can receive instructions from an autonomous ECU or driver, in addition to feedback from one or more of the steering, throttle, and brake sensors and/or actuators, sending commands to the appropriate ECUs. Vehicle behavior learning to produce vehicle behavior model often uses raw data that may be generated as discussed above. For example, wheels being currently angled a certain type of angle, brake pressure being a particular percentage, acceleration rate, etc.

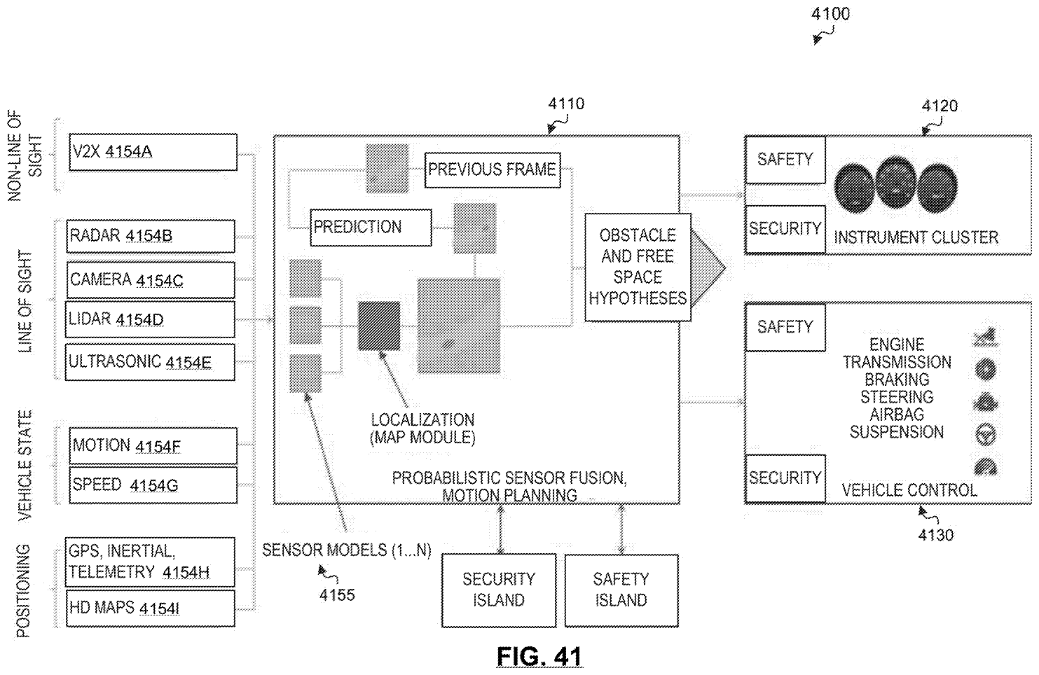

FIG. 41 is a simplified block diagram of an autonomous sensing and control pipeline 4100. Control of a vehicle goes to an engine control unit (ECU), which is responsible for actuation. FIG. 41 illustrates an autonomous processing pipeline from sensors through sensor fusion and planning ECU, and through vehicle control ECUs. FIG. 41 shows a variety of sensor inputs including non-line of sight, line of sight, vehicle state, and positioning. In particular, such inputs may be provided by V2X 4154A, a radar 4154B, a camera 4154C, a LIDAR 4154D, an ultrasonic device 4154E, motion of the vehicle 4154F, speed of the vehicle 4154G, GPS, inertial, and telemetry 4154H, and/or High definition (HD) maps 41541. These inputs are fed into a central unit (e.g., central processing unit) via sensor models 4155. Sensor models 4155 provide input to perform probabilistic sensor fusion and motion planning 4110. Generally, sensor fusion involves evaluating all of the input data to understand the vehicle state, motion, and environment. A continuous loop may be used to predict the next operation of the vehicle, to display related information in an instrument cluster 4120 of the vehicle, and to send appropriate signals to vehicle control actuators 4130.

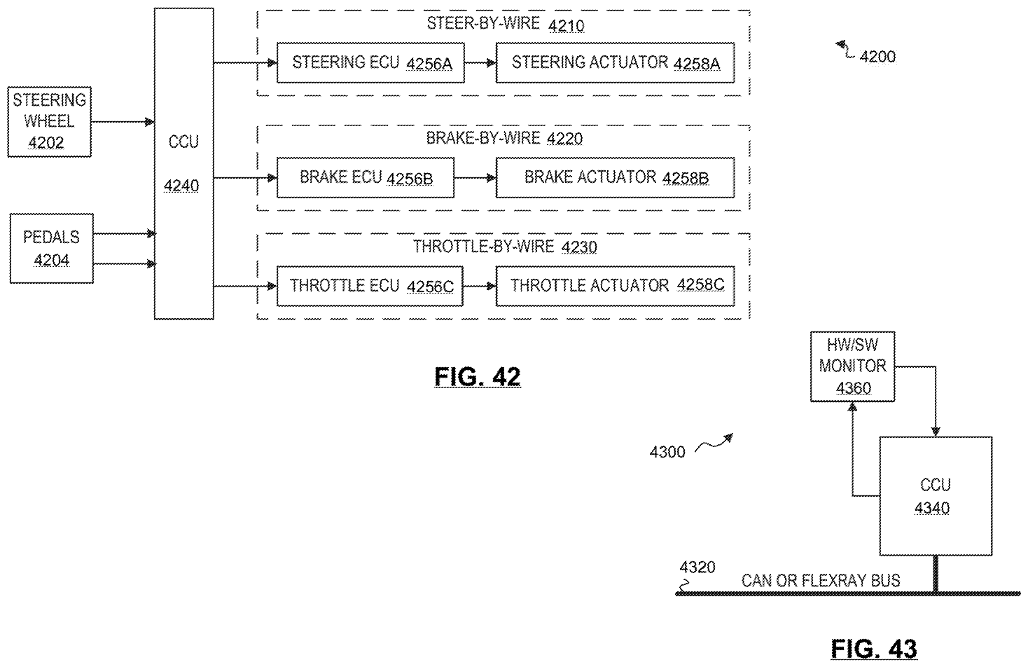

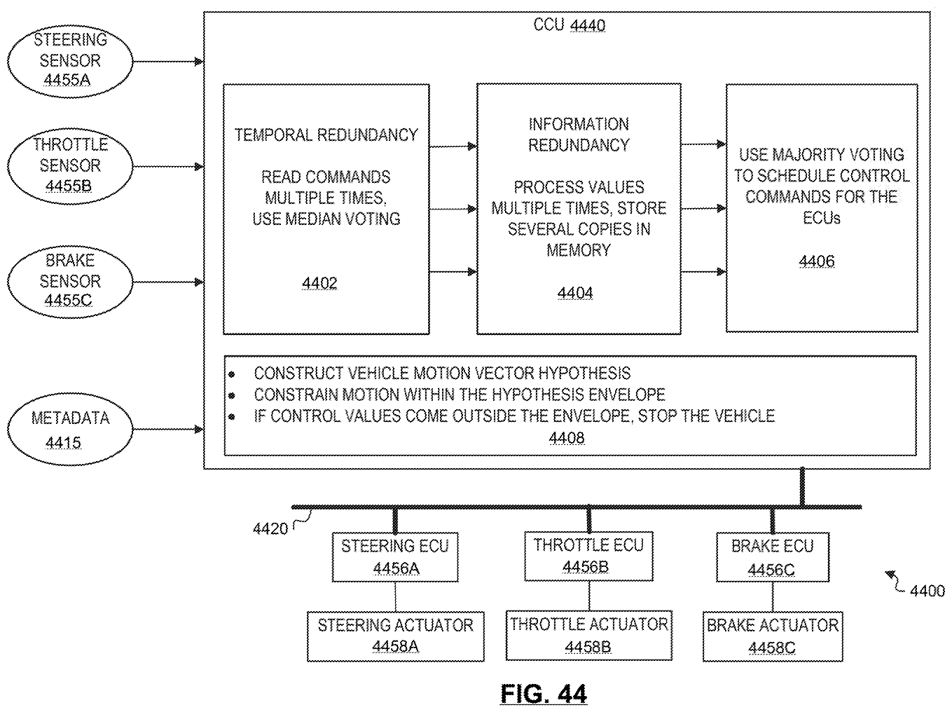

FIG. 42 is a simplified block diagram illustrating an example x-by-wire architecture 4200 of a highly automated or autonomous vehicle. A CCU 4240 may receive input (e.g., control signals) from a steering wheel 4202 and pedals 4204 of the vehicle. In an autonomous vehicle, however, the steering wheel and/or pedals may not be present. Instead, an autonomous driving (AD) ECU may replace these mechanisms and make all driving decisions.

Wired networks (e.g., CAN, FlexRay) connect CCU 4240 to a steering ECU 4256A and its steering actuator 4258A, to a brake ECU 4256B and its brake actuator 4258B, and to a throttle ECU 4256C and its throttle actuator 4258C. Wired networks are designated by steer-by-wire 4210, brake-by-wire 4220, and throttle-by-wire 4230. In an autonomous or highly autonomous vehicle, a CCU, such as CCU 4240, is a closed system with a secure boot, attestation, and software components required to be digitally signed. It may be possible, however, that an attacker could control inputs into sensors (e.g., images, radar spoofing, etc.), manipulate network traffic up to the CCU, and/or compromise other ECUs in a vehicle (other than the CCU). Networks between CCU 4240 and actuators 4258A-4258C cannot be compromised due to additional hardware checks on allowed traffic and connections. In particular, no ECU other than CCU 4240 is allowed on the wired networks. Enforcement can be cryptographic by binding these devices and/or by using other physical enforcement using traffic transceivers and receivers (Tx/Rx).

FIG. 43 is a simplified block diagram illustrating an example safety reset architecture 4300 of a highly automated or autonomous vehicle according to at least one embodiment. Architecture 4300 includes a CCU 4340 connected to a bus 4320 (e.g., CAN, FlexRay) and a hardware/software monitor 4360. HW/SW monitor 4360 monitors CCU 4340 for errors and resets the CCU if a change in motion as indicated by a control event is determined to be outside the motion envelope calculated by regression model. In at least one embodiment, HW/SW monitor 4360 may receive input from a comparator, which makes the determination of whether to send an error signal. In at least some embodiments, if an error signal is sent and a self-reset on the CCU does not effectively correct the vehicle behavior to be within a predicted motion envelope, then the CCU 4340 may safely stop the vehicle.

FIG. 44 is a simplified block diagram illustrating an example of a general safety architecture 4400 of a highly automated or autonomous vehicle according to at least one embodiment. Safety architecture 4400 includes a CCU 4440 connected to a steering ECU 4456A and its steering actuator 4458A, a throttle ECU 4456B and its throttle actuator 4458B, and a brake ECU 4456C and its brake actuator 4458C via a bus 4420 (e.g., CAN, FlexRay). CCU 4440 is also communicably connected to a steering sensor 4455A, a throttle sensor 4455B, and a brake sensor 4455C. CCU 4440 can also be communicably connected to other entities for receiving environment metadata 4415. Such other entities can include, but are not necessarily limited to, other sensors, edge devices, other vehicles, etc.

Several communications that involve safety may occur. First, throttle, steer, and brake commands and sensory feedback are received at the CCU from the actuators and/or sensors. In addition, environment metadata 4415 may be passed from an autonomous driver assistance system (ADAS) or an autonomous driver ECU (AD ECU). This metadata may include, for example, type of street and road, weather conditions, and traffic information. It can be used to create a constraining motion envelope and to predict motion for the next several minutes. For example, if a car is moving on a suburban street, the speed limit may be constrained to 25 or 35 miles an hour. If a command from AD ECU is received that is contrary to the speed limit, the CCU can identify it as a fault (e.g., malicious attack or non-malicious error).

Other redundancy schemes can also be used to see if the system can recover. Temporal redundancy 4402 can be used to read commands multiple times and use median voting. Information redundancy 4404 can be used to process values multiple times and store several copies in memory. In addition, majority voting 4406 can be used to schedule control commands for the ECUs. If the redundancy schemes do not cause the system to recover from the error, then the CCU can safely stop the vehicle. For example, at 4408, other safety controls can include constructing a vehicle motion vector hypothesis, constraining motion within the hypothesis envelope, and stopping the vehicle if control values go outside the envelope.

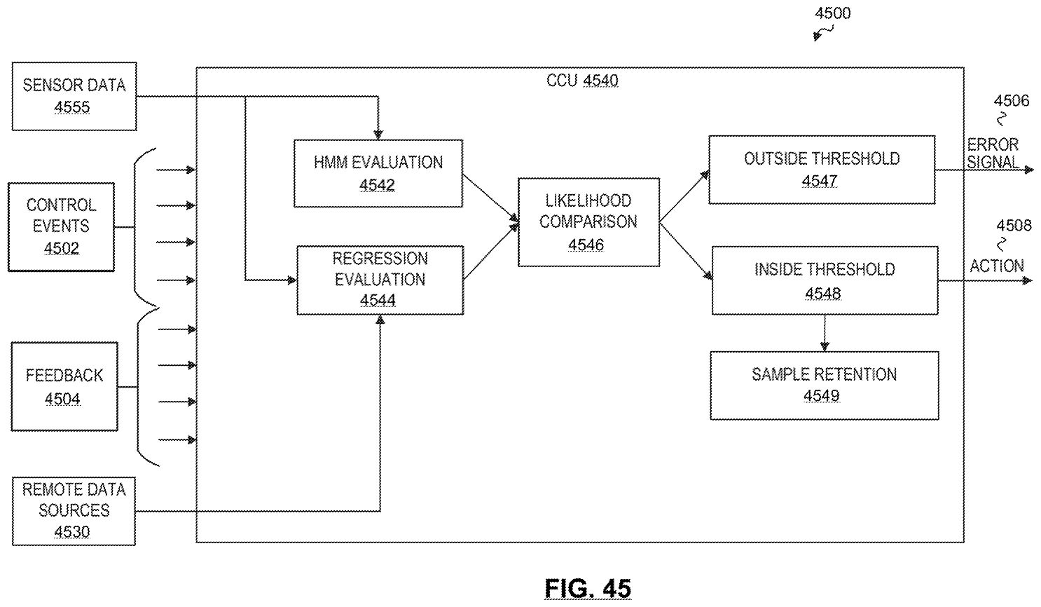

FIG. 45 is a simplified block diagram illustrating an example operational flow 4500 of a fault and intrusion detection system for highly automated and autonomous vehicles according to at least one embodiment. In FIG. 45, several operations are shown within a CCU 4540. CCU 4540 represents one example of CCU 3840 and illustrates possible operations and activities that may occur in CCU 3840. The operations correspond to algorithms of a temporal normal behavior model (e.g., 3841). An HMM evaluation 4542 corresponds to a vehicle behavior model (e.g., 3842), a regression evaluation 4544 corresponds to a regression model (e.g., 3844), and a likelihood comparison 4546 corresponds to a comparator (e.g., 3846).

Control events 4502 are received by CCU 4540 and may be used in both the HMM evaluation 4542 and the regression evaluation 4544. A control event may originate from a driver command, from sensors of an autonomous car that indicate the next action of the vehicle, or from a feedback loop from the sensors or actuators. The HMM evaluation can determine a likelihood that the change in motion indicated by the control event is a fault. HMM evaluation 4542 may also receive sensor data 4555 (e.g., throttle sensor data, steering sensor data, tire pressure sensor data, etc.) to help determine whether the change in motion is a normal behavior or indicative of a fault. The vehicle behavior model may receive feedback 4504 from a comparator (e.g., 3846), for example, where the feedback modifies the vehicle behavior model to recognize mistakes previously committed and to identify similar cases (e.g., based on location and/or time). Accordingly, HMM evaluation 4542 may perform differently based upon feedback from a comparator.

The regression evaluation 4544 predicts the likelihood of a change in motion, which is indicated by a control event, occurring at a given time interval t under normal conditions. Inputs for the regression evaluation can include sensor data 4555 and input data from remote data sources 4530 (e.g., other edge devices 3830). In addition, feedback 4504 from the cloud (e.g., from cloud vehicle data system 3820) may update the regression model that performs regression evaluation 4544, where the regression model is updated to optimize vehicle behavior and benefit from learning in other vehicles.

In one example, regression evaluation 4544 creates a motion envelope that is defined by one or more limits or thresholds for normal vehicle behavior based on examining the inputs from sensors, other models, other edge devices, etc. The regression evaluation 4544 can then determine whether the change in motion indicated by a control event is outside one or more of the motion envelope limits or thresholds.

The likelihood comparison 4546 can be performed based on the output classification of the change in motion from HMM evaluation 4542 and the output prediction from regression evaluation 4544. The output classification from the HMM evaluation can be an indication of the likelihood that a change in motion is a fault (e.g., malicious attack or failure in the vehicle computer system). The output prediction from the regression evaluation 4544 can be a likelihood that the change in motion would occur in the given time interval t, based on input data from sensors, edge devices, other models in the vehicle, etc. If the output prediction from the regression evaluation indicates that the change in motion is unlikely to occur during the given time interval t, and if the output classification from the HMM evaluation indicates the change in motion is likely to be a fault, then the prediction may be outside a motion envelope limit or threshold and the output classification may be outside a normal threshold, as indicated at 4547, and an error signal 4506 may be sent to appropriate ECUs to take corrective measures and/or to appropriate instrument displays. If the output prediction from the regression evaluation indicates that the change in motion is likely to occur during the given time interval t, and if the output classification by the HMM evaluation indicates the change in motion is not likely to be a fault (e.g., it is likely to be normal), then the prediction may be within a motion envelope limit or threshold and the output classification may be within a normal threshold, as indicated at 4548, and the action 4508 to cause the change in motion indicated by the control event is allowed to occur. In at least some implementations a signal may be sent to allow the action to occur. In other implementations, the action may occur in the absence of an error signal.

In other scenarios, the output prediction by the regression evaluation 4544 and the output classification by the HMM evaluation 4542 may be conflicting. For example, if the output prediction by the regression evaluation indicates that the change in motion is unlikely to occur during the given time interval t, and if the output classification of the HMM evaluation indicates the change in motion is unlikely to be a fault (e.g., it is likely to be normal behavior), then an error signal 4506 may be sent to appropriate ECUs to control vehicle behavior and/or sent to appropriate instrument displays. This can be due to the regression evaluation considering additional conditions and factors (e.g., from other sensor data, environmental data, etc.) that constrain the motion envelope such that the change in motion is outside one or more of the limits or thresholds of the motion envelope and is unlikely to occur under those specific conditions and factors. Consequently, even though the output classification by the HMM evaluation indicates the change in motion is normal, the regression evaluation may cause an error signal to be sent.

In another example, if the output prediction by the regression evaluation indicates that the change in motion indicated by a control event is likely to occur during the given time interval t, and if the output classification by the HMM evaluation indicates the change in motion is likely to be a fault, then a threshold may be evaluated to determine whether the output classification from the HMM evaluation indicates a likelihood of fault that exceeds a desired threshold. For example, if the HMM output classification indicates a 95% probability that the change in motion is anomalous behavior, but the regression evaluation output prediction indicates that the change in motion is likely to occur because it is within the limits or thresholds of its predicted motion envelope, then the HMM output classification may be evaluated to determine whether the probability of anomalous behavior exceeds a desired threshold. If so, then an error signal 4506 may be sent to appropriate ECUs to control or otherwise affect vehicle behavior and/or to appropriate instrument displays. If a desired threshold is not exceeded, however, then the action to cause the change in motion may be allowed due to the regression evaluation considering additional conditions and factors (e.g., from other sensor data, environmental data, etc.) that relax the motion envelope such that the change in motion is within the limits or thresholds of the motion envelope and represents expected behavior under those specific conditions and factors.

Additionally, a sample retention 4549 of the results of the likelihood comparison 4546 for particular control events (or all control events) may be saved and used for retraining the vehicle behavior model and/or the regression model and/or may be save and used for evaluation.

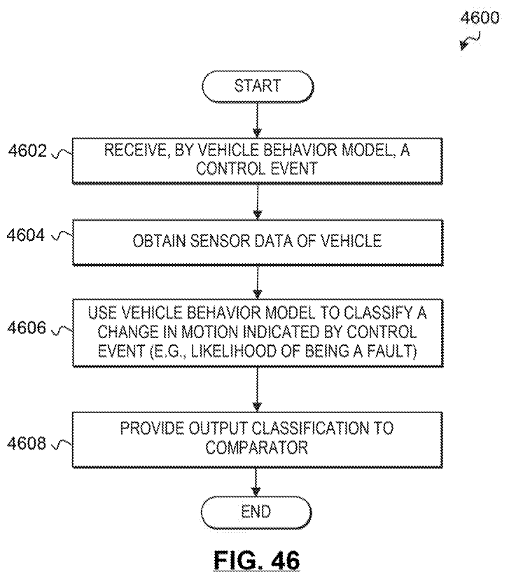

FIG. 46 is a simplified flowchart that illustrates a high level possible flow 4600 of operations associated with a fault and intrusion detection system, such as system 3800. In at least one embodiment, a set of operations corresponds to activities of FIG. 46. A CCU in a vehicle, such as CCU 3840 in vehicle 3850, may utilize at least a portion of the set of operations. Vehicle 3850 may include one or more data processors (e.g., 3857), for performing the operations. In at least one embodiment, vehicle behavior model 3842 performs one or more of the operations.

At 4602, a control event is received by vehicle behavior model 3842. At 4604, sensor data of the vehicle is obtained by the vehicle behavior model. At 4606, the vehicle behavior model is used to classify a change in motion (e.g., braking, acceleration, steering) indicated by the control event as a fault or not a fault. In at least one embodiment, the classification may be an indication of the likelihood (e.g., probability) that the change in motion is a fault. At 4608, the output classification of the change in motion is provided to the comparator.

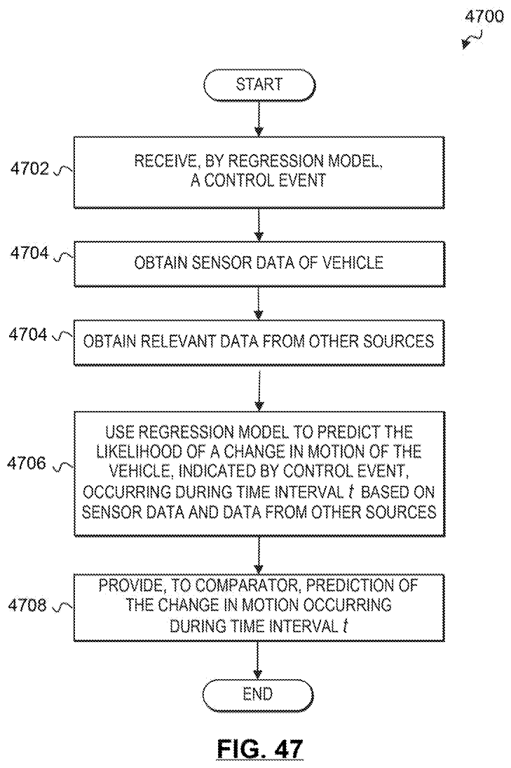

FIG. 47 is a simplified flowchart that illustrates a high level possible flow 4700 of operations associated with a fault and intrusion detection system, such as system 3800. In at least one embodiment, a set of operations corresponds to activities of FIG. 47. A CCU in a vehicle, such as CCU 3840 in vehicle 3850, may utilize at least a portion of the set of operations. Vehicle 3850 may include one or more data processors (e.g., 3857), for performing the operations. In at least one embodiment, regression model 3844 performs one or more of the operations.

At 4702, a control event is received by regression model 3844. The control event indicates a change in motion such as braking, steering, or acceleration. At 4704, sensor data of the vehicle is obtained by the regression model. At 4706, relevant data from other sources (e.g., remote sources such as edge devices 3830, local sources downloaded and updated in vehicle, etc.) is obtained by the regression model.

At 4708, the regression model is used to predict the likelihood of the change in motion indicated by the control event occurring during a given time interval t. The prediction is based, at least in part, on sensor data and data from other sources. At 4710, the output prediction of the likelihood of the change in motion occurring during time interval t is provided to the comparator.

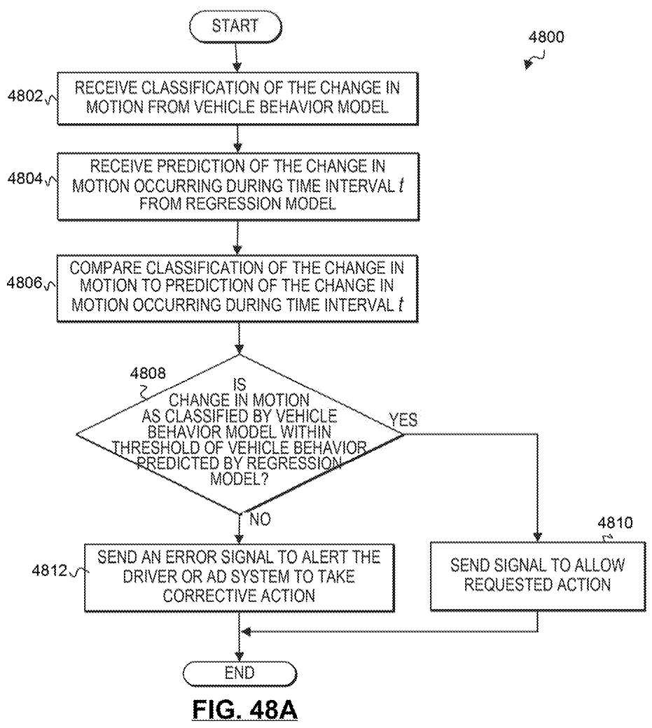

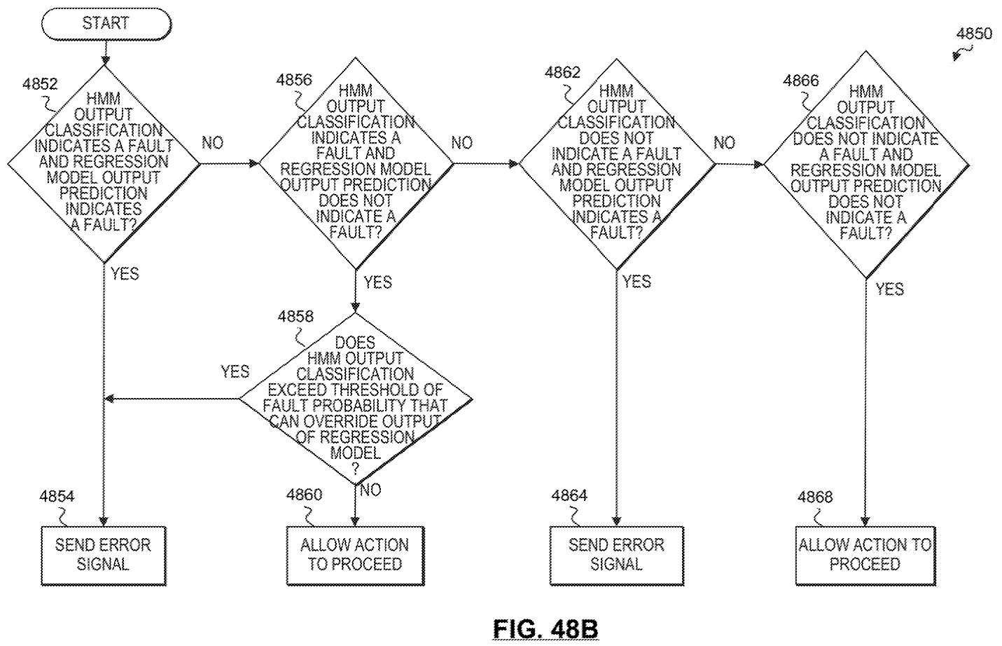

FIG. 48A is a simplified flowchart that illustrates a high level possible flow 4800 of operations associated with a fault and intrusion detection system, such as system 3800. In at least one embodiment, a set of operations corresponds to activities of FIG. 47. A CCU in a vehicle, such as CCU 3840 in vehicle 3850, may utilize at least a portion of the set of operations. Vehicle 3850 include one or more data processors (e.g., 3857), for performing the operations. In at least one embodiment, comparator 3846 performs one or more of the operations.

At 4802, a classification of a change in motion for a vehicle is received from the vehicle behavior model. The output classification provided to the comparator at 4608 of FIG. 46 corresponds to receiving the classification from the vehicle behavior model at 4802 of FIG. 48A.

At 4804, a prediction of the likelihood of the change in motion occurring during time interval t is received from the regression model. The output prediction provided to the comparator at 4710 of FIG. 47 corresponds to receiving the prediction at 4804 of FIG. 48A.

At 4806, the comparator compares the classification of the change in motion to the prediction of the likelihood of the change in motion occurring during time interval t. At 4808, a determination is made as to whether the change in motion as classified by the vehicle behavior model is within a threshold (or limit) of expected vehicle behavior predicted by the regression model. Generally, if the change in motion as classified by the vehicle behavior model is within the threshold of expected vehicle behavior predicted by the regression model, then at 4810, a signal can be sent to allow the change in motion to proceed (or the change in motion may proceed upon the absence of an error signal). Generally, if the change in motion as classified by the vehicle behavior model is not within the threshold (or limit) of vehicle behavior predicted by the regression model, then at 4812, an error signal can be sent to alert a driver to take corrective action or to alert the autonomous driving system to take corrective action. A more detailed discussion of possible comparator operations is provided in FIG. 48B.

FIG. 48B is a simplified flowchart that illustrates a high level possible flow 4850 of additional operations associated with a comparator operation as shown in FIG. 48A and more specifically, at 4808.

At 4852, a determination is made as to whether the following conditions are true: the output classification from the vehicle behavior model (e.g., HMM) indicates a fault and the output prediction by the regression model indicates a fault based on the same control event. If both conditions are true, then at 4854, an error signal (or control signal) can be sent to alert a driver to take corrective action or to alert the autonomous driving system to take corrective action.

If at least one condition in 4852 is not true, then at 4856, a determination is made as to whether the following two conditions are true: the output classification from the vehicle behavior model indicates a fault and the output prediction by the regression model does not indicate a fault based on the same control event. If both conditions are true, then at 4858, another determination is made as to whether the output classification from the vehicle behavior model exceeds a desired threshold that can override regression model output. If so, then at 4854, an error signal (or control signal) can be sent to alert a driver to take corrective action or to alert the autonomous driving system to take corrective action. If not, then at 4860, a signal can be sent to allow the vehicle behavior indicated by the control event to proceed (or the change in motion may proceed upon the absence of an error signal).

If at least one condition in 4856 is not true, then at 4862, a determination is made as to whether the following conditions are true: the output classification from the vehicle behavior model does not indicate a fault and the output prediction by the regression model does indicate a fault based on the same control event. If both conditions are true, then at 4864, an error signal (or control signal) can be sent to alert a driver to take corrective action or to alert the autonomous driving system to take corrective action.

If at least one condition in 4862 is not true, then at 4866, the following conditions should be true: the output classification from the vehicle behavior model does not indicate a fault and the output prediction by the regression model does not indicate a fault based on the same control event. If both conditions are true, then at 4868, a signal can be sent to allow the vehicle behavior indicated by the control event to proceed (or the change in motion may proceed upon the absence of an error signal).

An approach involving continuous collection of data to help train AI algorithms for an autonomous vehicle may encounter issues with scalability (due to the large volume of required data and miles to drive to obtain this data) and exact availability (chances of having data sufficient number of data sets needed to cover all possible road scenarios that an autonomous vehicle may encounter). Accordingly, autonomous vehicles may benefit from more efficient and rich data sets for training AI systems for autonomous vehicles. In various embodiments of the present disclosure, data sets may be improved by categorizing a data set to guide the collection process for each category. In some embodiments, each data set may be scored based on its category and the score of the data set may be used to determine processing techniques for the collected data.

In a particular embodiment, data collected by autonomous vehicles undergoes novel processing including categorization, scoring, and handling based on the categorization or scoring. In various embodiments, this novel processing (or one or more sub-portions thereof) may be performed offline by a computing system (e.g., remote processing system 4904) networked to the autonomous vehicle (e.g., in the cloud) and/or online by a computing system of the autonomous vehicle (e.g., autonomous vehicle computing system 4902).

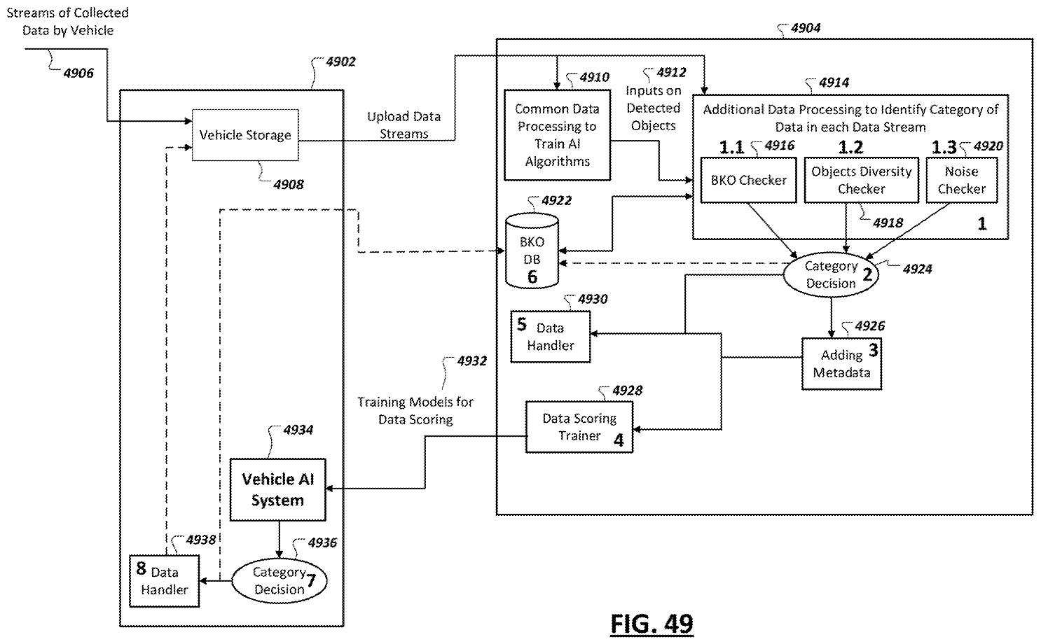

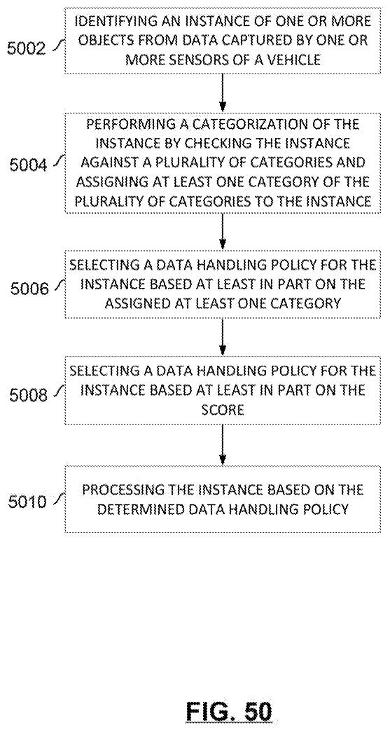

FIG. 49 depicts a flow of data categorization, scoring, and handling according to certain embodiments. FIG. 1 depicts an autonomous vehicle computing system 4902 coupled to a remote processing system 4904. Each of the various modules in systems 4902 and 4904 may be implemented using any suitable computing logic. The autonomous vehicle computing system 4902 may be coupled to remote processing system 4904 via any suitable interconnect, including point-to-point links, networks, fabrics, etc., to transfer data from the vehicle to the remote processing system (e.g., a special device that copies data from the car then re-copies the data to a Cloud cluster). In other embodiments, data from system 4902 may be made available to system 4904 (or vice versa) via a suitable communication channel (e.g., by removing storage containing such data from one of the systems and coupling it to the other). The autonomous vehicle computing system 4902 may be integrated within an autonomous vehicle, which may have any suitable components or characteristics of other vehicles described herein and remote processing system 4904 may have any suitable components or characteristics of other remote (e.g., cloud) processing systems described herein. For example, remote processing system 4904 may have any suitable characteristics of systems 140 or 150 and computing system 4902 may have any suitable characteristics of the computing system of vehicle 105.

In the flow, various streams of data 4906 are collected by vehicle 4902. Each stream of data 4906 may be collected from a sensor of the vehicle, such as any one or more of the sensors described herein or other suitable sensors. The streams 4906 may be stored in a storage device 4908 of the vehicle and may also be uploaded to remote processing system 4904.

The data streams may be provided to an artificial intelligence (AI) object detector 4910. Detector 4910 may perform operations associated with object detection. In a particular embodiment, detector 4910 may include a training module and an inference module. The training module may be used to train the inference module. For example, over time, the training module may analyze multiple uploaded data sets to determine parameters to be used by the inference module. An uploaded data stream may be fed as an input to the inference module and the inference module may output information associated with one or more detected objects 4912.

The format of the output of the inference module of the object detector 4910 may vary based on the application. As one example, detected objects information 4912 may include one or more images including one or more detected objects. For example, detected objects information 4912 may include a region of interest of a larger image, wherein the region of interest includes one or more detected objects. In some embodiments, each instance of detected objects information 4912 includes an image of an object of interest. In some instances, the object of interest may include multiple detected objects. For example, a detected vehicle may include multiple detected objects, such as wheels, a frame, windows, etc. In various embodiments, detected objects information 4912 may also include metadata associated with the detected object(s). For example, for each object detected in an instance of detected objects information 4912, the metadata may include one or more classifiers describing the type of an object (e.g., vehicle, tree, pedestrian, etc.), a position (e.g., coordinates) of the object, depth of the object, context associated with the object (e.g., any of the contexts described herein, such as the time of the day, type of road, or geographical location associated with the capture of the data used to detect the object), or other suitable information.

The detected objects information 4912 may be provided to object checker 4914 for further processing. Object checker 4914 may include any suitable number of checkers that provide outputs used to assign a category to the instance of detected objects information 4912. In the embodiment depicted, object checker 4914 includes a best-known object (BKO) checker 4916, an objects diversity checker 4918, and a noise checker 4920, although any suitable checker or combination of checkers is contemplated by this disclosure. In various embodiments, the checkers of an object checker 4914 may perform their operations in parallel with each other or sequentially.

In addition to detected objects information 4912, object checker 4914 may also receive the uploaded data streams. In various embodiments, any one or more of BKO checker 4916, objects diversity checker 4918, and noise checker 4920 may utilize the raw data streams.

In response to receiving an instance of detected objects information 4912, BKO checker 4916 consults the BKO database (DB) 4922 to determine the level of commonness of one or more detected objects of the instance of the detected objects information 4912. BKO DB 4922 is a database which stores indications of best known (e.g., most commonly detected) objects. In some embodiments BKO DB 4922 may include a list of best-known objects and objects that are not on this list may be considered to not be best known objects, thus the level of commonness of a particular object may be expressed using a binary value (best known or not best known). In other embodiments, BKO DB 4922 may include a more granular level of commonness for each of a plurality of objects. For example, BKO DB 4922 may include a score selected from a range (e.g., from 0 to 10) for each object. In particular embodiments, multiple levels of commonness may be stored for each object, where each level indicates the level of commonness for the object for a particular context. For example, a bicycle may have a high level of commonness on city streets, but a low level of commonness on highways. As another example, an animal such as a donkey or horse pulling a cart may have a low level of commonness in all but a few contexts and regions in the world. A combination level of commonness may also be determined, for example, one or more mopeds traveling in the lane are common in Southeast Asian countries even on highways than Western countries. Commonness score can be defined according to the specific rule set that applies for a specific environment.

BKO DB 4922 may be updated dynamically as data is collected. For example, logic of BKO DB 4922 may receive information identifying a detected object from BKO checker 4916 (e.g., such information may be included in a request for the level of commonness of the object) or from another entity (e.g., object detector 4910). In various embodiments, the information may also include context associated with the detected object. The logic may update information in the BKO DB 4922 indicating how many times and/or the frequency of detection for the particular object. In some embodiments, the logic may also determine whether the level of the commonness of the object has changed (e.g., if the frequency at which the object has been detected has crossed a threshold, the level of commonness of the object may rise).

In response to a request from BKO checker 4916, the BKO DB 4922 may return a level of commonness of the object. The BKO checker 4916 then provides this level to the category assigner 24.

Objects diversity checker 4918 scores an instance of detected objects information 4912 based on diversity (e.g., whether the stream including objects is diverse or not which may be based on the number of objects per stream and the commonness of each object). The diversity score of an instance of detected objects information 4912 may be higher when the instance includes a large number of detected objects, and higher yet when the detected objects are heterogenous. For example, a detected car or bicycle may include a plurality of detected objects (e.g., wheels, frame, etc.) and may receive a relatively high diversity score. However, homogenous objects may result in relatively lower diversity scores. However, multiple objects that are rarely seen together may receive a relatively high diversity score. For example, multiple bicycles in a race or multiple runners on roads (e.g., in a marathon) may be considered diverse relative to a scene of one person running. Objects diversity checker 4918 may determine diversity based on any suitable information, such as the raw sensor data, indications of detected objects from BKO checker 4916, and the number of detected objects from BKO checker 4916.

Noise checker 4920 analyzes the uploaded data streams associated with an instance of detected objects information 4912 and determines a noise score associated with the instance. For example, an instance may have a higher score when the underlying data streams have low signal to noise ratios. If one or more of the underlying data streams appears to be corrupted, the noise score will be lower.

Category assigner 4924 receives the outputs of the various checkers of object checker 4914 and selects one or more categories for the instance of detected objects information 4912 based on the outputs of the checkers. This disclosure contemplates any suitable categories that may be used to influence data handling policy. Some example categories are Common Data, Minority Class Data, Data Rich of Diverse Objects, and Noisy Data. Any one or more of these categories may be applied to the instance based on the outputs received from object checker 4914.

The Common Data category may be applied to objects that are frequently encountered and thus the system may already have robust data sets for such objects. The Minority Class Data category may be applied to instances that include first time or relatively infrequent objects. In various embodiments, both the Common Data category and the Minority Class Data may be based on an absolute frequency of detection of the object and/or a context-specific frequency of detection of the object. The Data Rich of Diverse Objects category may be applied to instances including multiple, diverse objects. The Noisy Data category may be applied to instances having data with relatively high noise. In other embodiments, any suitable categories may be used. As examples, the categories may include “Very Rare”, “Moderately Rare”, “Moderately Common”, and “Very Common” categories or “Very Noisy”, “Somewhat Noisy”, and “Not Noisy” categories.

In some embodiments, after one or more categories are selected (or no categories are selected) for an instance of detected objects information 4912, additional metadata based on the category selection may be associated with the instance by metadata module 4926. In a particular embodiment, such metadata may include a score for the instance of detected objects information 4912 based on the category selection. In a particular embodiment, the score may indicate the importance of the data. The score may be determined in any suitable manner. As one example, an instance categorized as Common Data (or otherwise assigned a category indicative of a high frequency of occurrence) may receive a relatively low score, as such data may not improve the functionality of the system due to a high likelihood that similar data has already been used to train the system. As another example, an instance categorized as Minority Class Data may receive a relatively high score, as such data is not likely to have already been used to train the system. As another example, an instance categorized as Data Rich of Diverse Objects may receive a higher score than a similar instance not categorized as Data Rich of Diverse Objects, as an instance with diverse objects may be deemed more useful for training purposes. As another example, an instance categorized as Noisy Data may receive a lower score than a similar instance not categorized as Noisy Data, as an instance having higher noise may be deemed less useful for training purposes.

In some embodiments, in addition (or as an alternative) to the score, any suitable metadata may be associated with the instance of detected objects information 4912. For example, any of the context associated with the underlying data streams may be included within the metadata and the context can impact the score (e.g., a common data in a first context may be minority data in a second context).

The instance of data, categorization decision, score based on the categorization, and/or additional metadata may be provided to data handler 4930. Data handler 4930 may perform one or more actions with respect to the instance of data. Any suitable actions are contemplated by this disclosure. For example, data handler 4930 may purge instances with lower scores or of a certain category or combination of categories. As another example, data handler 4930 may store instances with higher scores or of a certain category or combination of categories. As another example, data handler 4930 may generate a request for generation of synthetic data associated with the instance (e.g., the data handler 4930 may request the generation of synthetic data associated with an object classified as Minority Class Data). As another example, data handler 4930 may generate a request for collection of more data related to the object of the instance by the sensors of one or more autonomous vehicles. As yet another example, data handler 4930 may determine that the instance (and/or underlying data streams) should be included in a set of data that may be used for training (e.g., by object detector 4910).

The instance of data, categorization decision, score based on the categorization, and/or additional metadata may also be provided to data scoring trainer 4928. Data scoring trainer 4928 trains models on categories and/or scores. In various embodiments, the instances of the detected objects and their associated scores and/or categories may be used as ground truth by the data scoring trainer 4928. Trainer 4928 outputs training models 4932. The training models are provided to vehicle AI system 4934 and may be used by the vehicle to categorize and/or score objects detected by vehicle AI system 4934. In various embodiments, the instances of data that are used to train the models is filtered based on categories and/or scores. For example, instances including commonly encountered objects may be omitted from the training set.

Vehicle AI system 4934 may include circuitry and other logic to perform any suitable autonomous driving operations, such as one or more of the operations of an autonomous vehicle stack. In a particular embodiment, vehicle AI system 4934 may receive data streams 4906 and process the data streams 4906 to detect objects.

An in-vehicle category assigner 4936 may have any one or more characteristics of category assigner 4924. Information about an instance of the detected objects (e.g., the detected objects as well as the context) may be provided to category assigner 4936 which selects one or more categories for the instance (such as one or more of the categories described above or other suitable categories). In some embodiments, category assigner 4936 or other logic of computing system 4902 may also (or alternatively) assign a score to the instance of detected object(s). In some embodiments, the score may be based on the categorization by category assigner 4936. of the detected objects. In other embodiments, a score may be determined by the autonomous vehicle without any explicit determination of categories by the autonomous vehicle. In various embodiments, the categories and/or scores assigned to the detected objects are determined using one or more machine learning inference modules that utilize parameters generated by data scoring trainer 4928.

The output of the category assigner 4936 may be provided to an in-vehicle data handler 4938, which may have any one or more characteristics of data handler 4930. In various embodiments, the output of the category assigner 4936 may also be provided to the BKO DB 4922 to facilitate updating of the BKO data based on the online learning and scoring

Data handler 4938 may have any one or more characteristics of data handler 4930. Data handler 4938 may make decisions as to how to handle data streams captured by the vehicle based on the outputs of the in-vehicle category assigner 4936. For example, the data handler 4938 may take any of the actions described above or perform other suitable actions associated with the data based on the output of the category assigner 4936. As just one example, the data handler 4938 may determine whether data associated with a detected object is to be stored in the vehicle or purged based on the data scoring.

In various embodiments, a location-based model used to score the data may synthesize urgency and importance of data as well as provide useful guidance for better decision making by an autonomous vehicle. The location of captured data may be used by the autonomous vehicle computing system 4902 or the remote computing system 4904 to obtain other contextual data associated with capture of the data, such as the weather, traffic, pedestrian flow, and so on (e.g., from a database or other service by using the location as input). Such captured data may be collected at a particular granularity so as to form a time series of information. The same location may be associated with each data stream captured within a radius of the location and may allow the vehicle to improve its perception and decision capabilities within this region. The location may be taken into account by any of the modules described above. As just one example, BKO DB 4922 may store location specific data (e.g., a series of commonness levels of various objects for a first location, a separate list of commonness levels of various objects for a second location, and so on).

FIG. 50 depicts an example flow for handling data based on categorization in accordance with certain embodiments. At 5002, an instance of one or more objects from data captured by one or more sensors of a vehicle is identified. At 5004, a categorization of the instance is performed by checking the instance against a plurality of categories and assigning at least one category of the plurality of categories to the instance. At 5006, a score is determined based on the categorization of the instance. At 5008, a data handling policy for the instance is selected based at least in part on the score. At 5010, the instance is processed based on the determined data handling policy.

Creating quality machine learning models includes using robust data sets during training for model creation. In general, a model is only as good as the data set it uses for training. In many applications, such as training on images for object or person identification, data set collection is fairly simple. However, in other cases, data set collection for less common contexts or combinations thereof can be extremely difficult. This presents a difficult challenge for model development as the model may be tasked with identifying or classifying a context based on inadequate data. In ideal situations, data sets used to train object detection models have an equal or similar amount of data for each category. However, data sets collected from vehicle sensors are generally unbalanced, as vehicles encounter far more positive data than negative data.

In various embodiments of the present disclosure, a system may create synthetic data in order to bolster data sets lacking real data for one or more contexts. In some embodiments, a generative adversarial network (GAN) image generator creates the synthetic data. GAN is a type of generative model that uses machine learning, more specifically deep learning, to generate images (e.g., still images or video clips) based on a list of keywords presented as input to the GAN. The GAN uses these keywords used to create an image. Various embodiments also employ logic to determine which keywords are supplied to the GAN for image generation. Merely feeding random data to the GAN would result in a host of unusable data. Certain context combinations may not match up with occurrences in the real world. For example, a clown in the middle of a highway road in a snowstorm in Saudi Arabia is an event so unlikely as to be virtually impossible. As another example, it is unlikely (though far more likely than the previous scenario) to encounter bicycles on a snowy highway road. Accordingly, a system may generate images for this scenario (e.g., by using the keywords “bicycle”, “snow”, and “highway”), but not the previous scenario. By intelligently controlling the synthetic data creation, the system may create images (for training) that would otherwise require a very long time for a vehicle to encounter in real life.

Various embodiments may be valuable in democratizing data availability and model creation. For example, the success of an entity in a space such as autonomous driving as a service may depend heavily on the amount and diversity of data sets accessible to the entity. Accordingly, in a few years when the market is reaching maturity, existing players who started their data collection early on may have an unfair advantage, potentially crowding out innovation by newcomers. Such data disparity may also hinder research in academia unless an institution has access to large amounts of data through their relationships to other entities that have amassed large data sets. Various embodiments may ameliorate such pressures by increasing the availability of data available to train models.

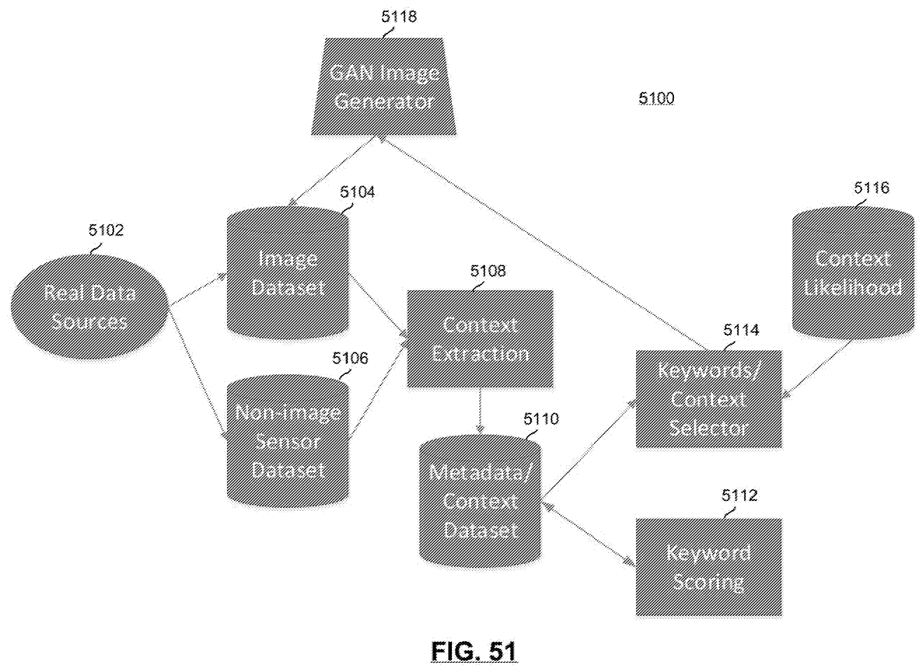

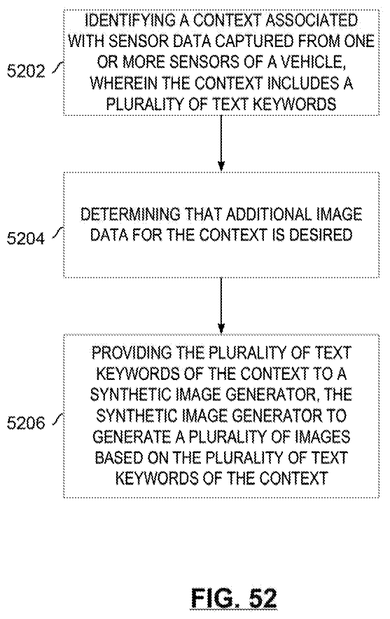

FIG. 51 depicts a system 5100 to intelligently generate synthetic data in accordance with certain embodiments. System 5100 represents any suitable computing system comprising any suitable components such as memory to store information and one or more processors to perform any of the functions of system 5100. In the embodiment depicted, system 5100 accesses real data sources 5102 and stores the real data sources in image dataset 5104 and non-image sensor dataset 5106. The real data sources 5102 may represent data collected from live vehicles or simulated driving environments. Such real data may include image data, such as video data streaming from one or more cameras, point clouds from one or more LIDARs, or similar imaging data obtained from one or more vehicles or supporting infrastructure (e.g., roadside cameras). The collected image data may be stored in image dataset 5104 using any suitable storage medium. The real data sources may also include non-image sensor data, such as data from any of numerous sensors that may be associated with a vehicle. The non-image sensor data may also be referred to as time-series data. This data may take any suitable form, such as a timestamp and an associated value. The non-image sensor data may include, for example, measurements from motion sensors, GPS, temperature sensors, or any process used in the vehicle that generate data at any given rate. The collected non-image sensor data may be stored in non-image dataset 5106 using any suitable storage medium.

Context extraction module 5108 may access instances of the image data and non-image sensor data and may determine a context associated with the data. The two types of data may be used jointly or separately to generate a context (which may represent a single condition or a combination of conditions), such as any of the contexts described herein. For example, imaging data alone may be used to generate the context “snow”. As another example, imaging data and temperature data may be used to generate the context “foggy and humid”. In yet another example, the sensor data alone may be used to generate a context of “over speed limit”. The determined context(s) is often expressed as metadata associated with the raw data.

The context extraction module 5108 may take any suitable form. In a particular embodiment, module 5108 implements a classification algorithm (e.g., a machine learning algorithm) that can receive one or more streams of data as input and generate a context therefrom. The determined context is stored in metadata/context dataset 5110 with the associated timestamp which can be used to map the context back to the raw data stream (e.g., the image data and/or the non-image sensor dataset). These stored metadata streams may tell a narrative of driving environment conditions over a period of time. For model development, the image data and non-sensor image data is often collected in the cloud and data scientist and machine learning experts are given access to enable them to generate models that can be used in different parts of the autonomous vehicle.

Keyword scoring module 5112 will examine instances of the context data (where a context may include one or more pieces of metadata) and, for each examined instance, identify a level of commonness indicating a frequency of occurrence of each context instance. This level of commonness may be indicative of how often the system has encountered the particular context (whether through contexts applied to real data sources or through contexts applied to synthetically generated images). The level of commonness for a particular context may represent how much data with that particular context is available to the system (e.g., to be used in model training). The level of commonness may be saved in association with the context (e.g., in the metadata/context dataset 5110 or other suitable storage location).

The keyword scoring module 5112 may determine the level of commonness in any suitable manner. For example, each time a context instance in encountered, a counter specific to that context may be incremented. In other examples, the metadata/context dataset 5110 may be searched to determine how many instances of that context are stored in the database 5110. In one example, once a context has been encountered a threshold number of times, the context may be labeled as “commonly known” or the like, so as to not be selected as a candidate for synthetic image generation. In some embodiments, metadata/context dataset 5110 may store a table of contexts with each context's associated level of commonness.

The keywords/context selector module 5114 may access the metadata/context dataset (or other storage) and analyze various contexts and their associated levels of commonness to identify candidates for synthetic image generation. In a particular embodiment, module 5114 looks for contexts that are less common (as the system may already have sufficient data for contexts that are very common). The module 5114 may search for such contexts in a batched manner by analyzing a plurality of contexts in one session (e.g., periodically or upon a trigger) or may analyze a context in response to a change in its level of commonness. Module 5114 may select one or more contexts that each include one or more key words describing the context. For example, referring to an example above, a selected context may include the key words “bicycle”, “snow”, and “highway”.

After selecting a context as a candidate for synthetic image generation, module 5114 may consult context likelihood database 5116 to determine whether the selected context occurs in the real world. Context likelihood database 5116 may be generated using data (e.g., text, pictures, and videos) compiled from books, articles, internet websites, or other suitable sources. The data of the context likelihood database 5116 may be enriched as more data becomes available online. The data may be harvested from online sources in any suitable manner, e.g., by crawling websites and extracting data from such websites, utilizing application programming interfaces of a data source, or other suitable methods. Image data (including pictures and video) may be processed using machine learning or other classification algorithms to determine key words associated with objects and context present in the images. The collected data may be indexed to facilitate searching for keywords in the database as searching for the proximity of keywords to other keywords. The gathered data may form a library of contexts that allow deduction of whether particular contexts occur in the real world.

After selecting a context as a candidate for synthetic image generation, module q14 may consult context likelihood database 5116 to determine how often the key words of the context appear together in the collected data sources within the context likelihood database 5116. If the key words never appear together, module 5114 may determine that the context does not appear in the real world and may determine not to generate synthetic images for the context. In some embodiments, if the key words do appear together (or appear together more than a threshold number of times), a decision is made that the context does occur in the real world and the keywords of the context are passed to GAN image generator 5118.

In a particular embodiment, an indication of whether the context occurs in real life and/or whether synthetic images have been generated for the context may be stored in association with the context in metadata/context dataset 5110 (or other suitable storage) such that module 5114 may avoid performing unnecessary lookups of context likelihood database 5116 for the particular context. Additionally, if a particular context is determined to not occur in the real world, module 5114 may determine that child contexts for that particular context do not occur in the real world either (where a child context inherits all of the keywords of the parent context and includes at least one additional key word). In some embodiments, a context may be analyzed again for occurrence in the real world under certain conditions (e.g., upon a major update to the context likelihood database 5116) even if it is determined not to occur in the real world in a first analysis.

Upon a determination that a context selected as a candidate for synthetic image generation does occur in the real world according to the information within context likelihood database 5116, the context is provided to GAN image generator 5118. Image generator 5118 may include suitable logic to generate image data (e.g., one or more pictures or video clips) representing the context. For example, to continue the example from above, if a context has keywords “bicycle”, “snow”, and “highway,” the image generator 5118 may generate one or more instances of image data each depicting a bicycle on a highway in the snow. In various embodiments, the GAN image generator 5118 may be tuned to provide image data useful for model training. As an example, the generator 5118 may generate images having various types of bicycles (optionally in different positions within the images) on various types of highways in the snow.

The image data generated by the image generator 5118 may be placed into the image dataset and stored in association with the context used to generate the images. Such images may be used to train one or more models (e.g., machine learning models) to be used by an autonomous vehicle to detect objects. Accordingly, system 5100 may identify unlikely contexts, determine whether such contexts are likely to exist in the real world, and then generate synthetic images of such contexts in order to enrich the data set to improve classification and object identification performance.

In various embodiments, system 100 may also include modules to receive input from human or other actors (e.g., computing entities) to guide any of the functions described herein. For example, explicit input may be received regarding whether a certain context is possible. In some embodiments, a subset of the queries to context likelihood database 5116 may be used to query a human operator as to whether a context is realistic. For example, if a search of the database 5116 returns very few instances of the keywords of the context together, a human operator may be queried as to whether the context is realistic before passing the context on to the image generator 5118. As another example, a human operator or computing entity may inject keywords directly to GAN image generator 5118 for generation of images for desired contexts. Such images may then be stored into the image dataset 5104 along with their associated contexts. In some embodiments, the human input may be provided via a developer of a computing model to be used by an autonomous vehicle or by a crowdsourcing platform, such as Amazon Mechanical Turk.

In some embodiments, the system may be biased towards a specific set of contexts and associated keywords. For example, if a model developer knows that the model is less accurate during fog or at night, the model developer could trigger the generation of additional synthetic image datasets using these keywords in order to train the model for improved performance. In various embodiments, the synthetic image data generated could also be used for model testing to determine the accuracy of the model. In some embodiments, synthetic data images may be used to test a model before they are added to the image dataset. For example, if a current model has a hard time accurately classifying the synthetic images, such images may be considered useful for training to improve model performance and may then be added to the image dataset 5104.

In various embodiments, all or a portion of system 5100 may be separate from an onboard computing system of a vehicle (e.g., system 5100 or components thereof may be located in a cloud computing environment). In other embodiments, all or a portion of system 5100 may be integrated with an onboard, in-vehicle computing system of a vehicle, such as discussed herein.

In a particular embodiment, an on-board context detection algorithm may be performed by a vehicle in response to data capture by the vehicle. The vehicle may store and use a snapshot of the context likelihood database 5116 (e.g., as a parallel method to the GAN). Upon upload of data associated with a rare event, the image generator 5118 may use data from a context detection algorithm performed by the vehicle as input to generate more instances of these rare contexts.

FIG. 52 depicts a flow for generating synthetic data in accordance with certain embodiments. At 5202, context associated with sensor data captured from one or more sensors of a vehicle is identified, wherein the context includes a plurality of text keywords. At 5204, it is determined that additional image data for the context is desired. At 5206, the plurality of text keywords of the context are provided to a synthetic image generator, the synthetic image generator to generate a plurality of images based on the plurality of text keywords of the context.

During the operation of autonomous vehicles, extensive amounts of vision classification and audio recognition algorithms are performed. Due to their state-of-the-art performance, deep learning algorithms may be used for such applications. However, such algorithms, despite their highly effective classification performance, may be vulnerable to attack. With respect to computer vision, adversarial attackers may manipulate the images through very small perturbations, which may be unnoticeable to the human eyes, but may distort an image enough to cause a deep learning algorithm to misclassify the image. Such an attack may be untargeted, such that the attacker may be indifferent to the resulting classification of the image so long as the image is misclassified, or an attack may be targeted, such that the image is distorted so as to be classified with a targeted classifier. Similarly, in the audio space, an attacker can inject noise which does not affect human hearing of the actual sentences, but the speech-to-text algorithm will misunderstand the speech completely. Recent results also show that the vulnerability to adversarial perturbations is not limited to deep learning algorithms but may also affect classical machine learning methods.

In order to improve security of machine learning algorithms, various embodiments of the present disclosure include a system to create synthetic data specifically mimicking the attacks that an adversary may create. To synthesize attack data for images, multiple adversaries are contemplated, and adversarial images are generated from images for which the classifiers are already known and then used in a training set along with underlying benign images (at least some of which were used as the underlying images for the adversarial images) to train a machine learning model to be used for object detection by a vehicle.

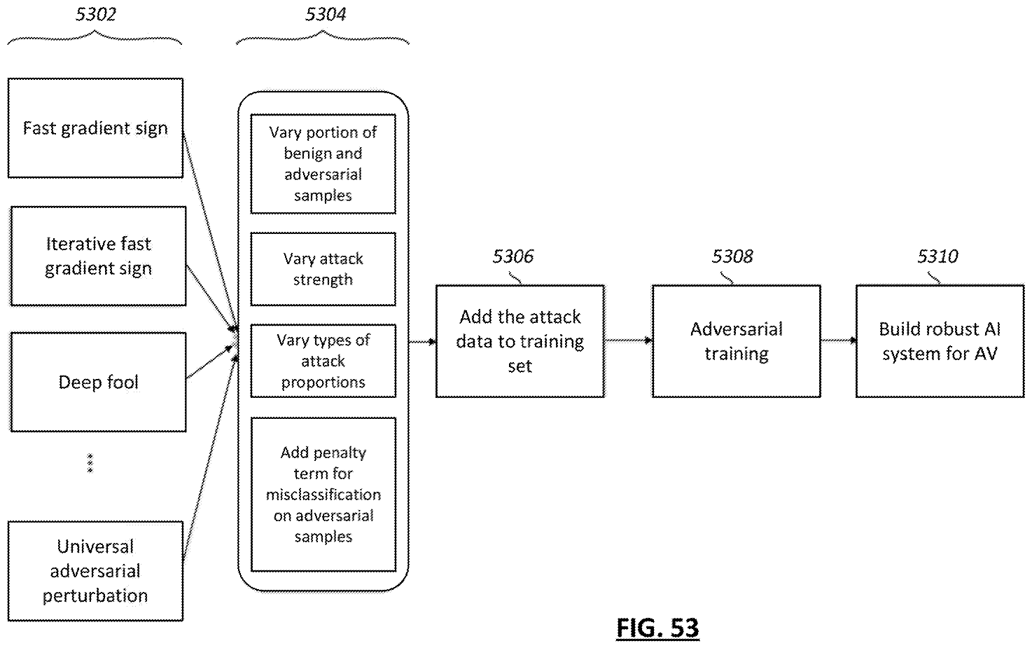

FIG. 53 depicts a flow for generating adversarial samples and training a machine learning model based on the adversarial samples. The flow may include using a plurality of different attack methods 5302 to generate adversarial samples. One or more parameters 5304 may be determined to build the training data set. The parameters may include, e.g., on or more of a ratio of benign to adversarial samples, various attack strengths to be used (and ratios of the particular attack strengths for each of the attack methods), proportions of attack types (e.g., how many attacks will utilize a first attack method, how many will utilize a second attack method, and so on), and a penalty term for misclassification of adversarial samples. The adversarial samples may be generated by any suitable computing, such as discussed herein.

After the adversarial samples are generated according to the parameters, the adversarial samples may be added to benign samples of a training set at 5306. The training set may then be used to train a classification model at 5308 by a computing system. The output of the training may be used to build a robust AI classification system for a vehicle at 5310 (e.g., an ML model that may be executed by, e.g., inference engine 254). The various portions of the flow are described in more detail below.

Any number of expected attack methods may be used to generate the synthetic images. For example, one or more of a fast gradient sign method, an iterative fast gradient sign method, a deep fool, a universal adversarial perturbation, or other suitable attack method may be utilized to generate the synthetic images.

Generating an adversarial image via a fast gradient sign method may include evaluating a gradient of a loss function of a neural network according to an underlying image, taking the sign of the gradient, and then multiplying it by a step size (e.g., a strength of the attack). The result is then added to the original image to create an adversarial image. Generating an adversarial image via an iterative fast gradient sign method may include an iterative attack of a step size over a number of gradient steps, rather than a single attack (as is the case in the fast gradient sign method), where each iteration is added to the image. Generating an adversarial image via a deep fool method may include linearizing the loss function at an input point and applying the minimal perturbation that would be necessary to switch classes if the linear approximation is correct. This may be performed iteratively until the network's chosen class switches. Generating an adversarial image via a universal adversarial perturbation method may include calculating a perturbation on an entire training set and then adding it to all of the images (whereas some of the other attack methods attack images individually).

In some embodiments, multiple adversarial images may be generated from a single image with a known classifier using different attack strengths. For example, for a particular attack method, a first adversarial image may be generated from a benign image using a first attack strength and a second adversarial image may be generated from the same benign image using a second attack strength.

In some embodiments, multiple attack methods may be applied to generate multiple adversarial images from a single benign image. For example, a first attack method may be used with one or more attack strengths to generate one or more adversarial images from a benign image and a second attack method may be used with one or more attack strengths to generate one or more additional adversarial images from the same benign image.

Any suitable number of attack methods and any suitable number of attack strengths may be used to generate adversarial images for the synthetic data set. Moreover, in some embodiments, the attack methods and attack strengths may be distributed across benign images (e.g., not all methods and/or strengths are applied to each benign image). For example, one or more attack methods and/or one or more attack strengths may be applied to a first benign image to generate one or more adversarial images, a different one or more attack methods and/or one or more attack strengths may be applied to a second benign image to generate one or more additional adversarial images, and so on. In some embodiments, the attack strength may be varied for attacks on images from each class to be trained.

In various embodiments, the proportions of each type of attack may be varied based on an estimate of real-world conditions (e.g., to match the ratio of the types of expected attacks). For example, 50% of the adversarial images in the synthetic data set may be generated using a first attack method, 30% of the adversarial images may be generated using a second attack method, and 20% of the adversarial images may be generated using a third attack method.

In various embodiments, the proportion of benign images to adversarial images may also be varied from one synthetic data set to another synthetic data set. For example, multiple synthetic data sets having different ratios of benign images to adversarial images may be tested to determine the optimal ratio (e.g., based on object detection accuracy).

Each adversarial image is stored with an association to the correct ground truth label (e.g., the class of the underlying benign image). In some embodiments, the adversarial images may each be stored with a respective attack label (e.g., the label that the adversarial image would normally receive if the classifier wasn't trained on the adversarial data which may be the attacker's desired label in a targeted attack). A collection of such adversarial images and associated classifiers may form a simulated attack data set.

A simulated attack data set may be mixed with a set of benign images (and associated known classifiers) and used to train a supervised machine learning classification model, such as a neural network, decision tree, support vector machine, logistic regression, k-nearest neighbors algorithm, or other suitable classification model. Thus, the synthetic attack data may be used as augmentation to boost the resiliency against the attacks on deep learning algorithms or classical ML algorithms. During training, the adversarial images with their correct labels are incorporated as part of the training set to refine the learning model. Furthermore, in some embodiments, the loss function of the learning model may incur a penalty if the learning algorithm tends to classify the adversarial images into the attacker's desired labels during training. As a result, the learning algorithm will develop resiliency against adversarial attacks on the images.

Any of the approaches described above may be adapted to similar attacks on audio data. Any suitable attack methods for audio data may be used to generate the adversarial audio samples. For example, methods based on perturbing an input sample based on gradient descent may be used. These attack methods may be one-time attacks or iterative attacks. As with the image attacks, multiple different attack methods may be used, the audio attacks may vary in attack strength, the ratio of adversarial samples generated from the attack methods may vary, and the ratio of adversarial samples to benign samples may vary as well. The adversarial audio samples may be used to train any suitable text-to-speech (e.g., WaveNet, DeepVoice, Tacotron, etc.) or speech recognition (e.g., deep models with Hidden Markov Models, Connectionist Temporal Classification models, attention-based models, etc.) machine learning model.

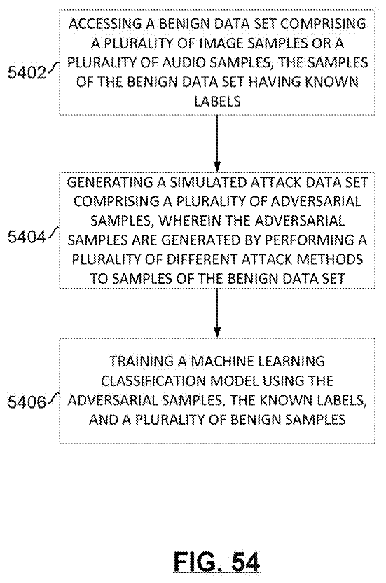

FIG. 54 depicts a flow for generating a simulated attack data set and training a classification model using the simulated attack data set in accordance with certain embodiments. At 5402, a benign data set comprising a plurality of image samples or a plurality of audio samples are accessed. The samples of the benign data set have known labels. At 5404, a simulated attack data set comprising a plurality of adversarial samples is generated, wherein the adversarial samples are generated by performing a plurality of different attack methods to samples of the benign data set. At 5406, a machine learning classification model is trained using the adversarial samples, the known labels, and a plurality of benign samples.

Semi-autonomous and autonomous vehicle systems are heavily dependent on Machine Learning (ML) techniques for object identification. As time elapses, the models that are used for classifying must be updated (including retraining) so they continue to accurately reflect the changing environments that are experienced during use, both in terms of novel events (e.g., a change in a snow storm) and changing patterns (e.g., increases in traffic density). While updates to a ML model may be performed in a periodic manner, such updates may result in excess resource usage when a valid model is unnecessarily replaced or may result in a greater number of misclassifications when updates are not frequent enough.

In various embodiments of the present disclosure, multiple classifiers, each having different properties, are used during object detection and the behavior of one classifier may be used to determine when the other classifier(s) should be updated (e.g., retrained using recently detected objects). For example, the behavior of a simple classifier (e.g., a linear classifier) may be used to determine when a more robust or complicated classifier (e.g., a non-linear classifier) is to be updated. The simple classifier may act as an early detection system (like a “canary in the coal mine”) for needed updates to the more robust classifier. While the simple classifier may not provide as robust or accurate object detection as the other classifier, the simple classifier may be more susceptible to changes in environment and thus may enable easier detection of changes in environment relative to a non-linear classifier. In a particular embodiment, a classifier that is relatively more susceptible to accuracy deterioration in a changing environment is monitored and when the accuracy of this classifier drops by a particular amount, retraining of the classifiers is triggered.

Although this disclosure focuses on embodiments using a linear classifier as the simple classifier and a non-linear classifier as the more robust classifier, other embodiments may utilize any suitable classifiers as the simple and robust classifiers. For example, in a particular embodiment, the robust classifier may be a complex non-linear classifier and the simple classifier may be a less sophisticated non-linear classifier. The simple classifier (e.g., linear classifier) and robust classifier (e.g., non-linear classifier) may be implemented by any suitable computing systems.

Although the class boundaries of the linear and non-linear classifiers in the examples below are depicted as classifying samples along two dimensions (x and y dimensions) to simplify the explanation, in various embodiments the linear classifier or the non-linear classifier may classify samples along any suitable number of dimensions (e.g., the input vector to the classifier may have any number of feature values). For example, instead of a line as a class boundary for a linear classifier, a hyperplane may be used to split an n-dimensional input space where all samples on one side of the hyperplane are classified with one label while the samples on the other side of the hyperplane are classified with another label.

A linear classifier may make a classification decision based on the value of a linear combination of multiple characteristics (also referred to as feature values) of an input sample. This disclosure contemplates using any suitable linear classifiers as the simple classifier. For example, a classifier based on regularized least squares, a logistic regression, a support vector machine, Naïve Bayes, linear discriminant classifier, perceptron, or other suitable linear classification technology may be used.

A non-linear classifier generally determines class boundaries that cannot be approximated well with linear hyperplanes and thus the class boundaries are non-linear. This disclosure contemplates using any suitable non-linear classifiers as the robust classifier. For example, a classifier based on quadratic discriminant classifier, multi-layer perceptron, decision trees, random forest, K-nearest neighbor, ensembles, or other suitable non-linear classification technology may be used.

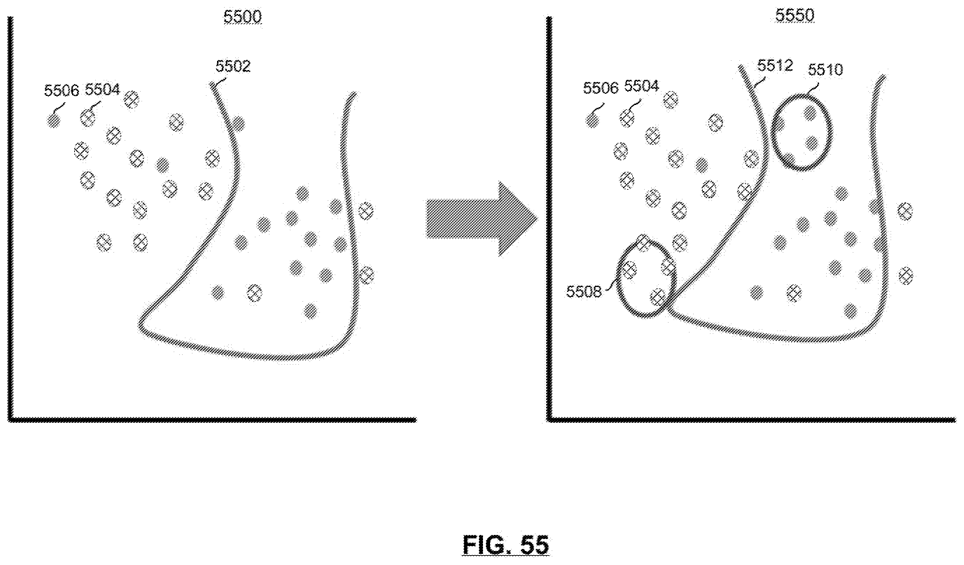

FIG. 55 illustrates operation of a non-linear classifier in accordance with certain embodiments. The non-linear classifier may be used to classify any suitable input samples (e.g., events) having one or more feature values. FIG. 55 depicts a first dataset 5500 with a plurality of samples 5504 of a first-class and a plurality of samples 5506 of a second-class. The non-linear classifier is configured to distinguish whether a sample is of the first-class or the second-class based on the feature values of the sample and a class boundary defined by the non-linear classifier.

Data set 5500 may represent samples used to train the non-linear classifier while data set 5550 represents the same samples as well as additional samples 5508 of the first type and additional samples 5510 of the second type. Class boundary 5512 represents the class boundary for the non-linear classifier after the non-linear classifier is retrained based on a training set including the new samples 5508 and 5510. While the new class boundary 5512 may still enable the non-linear classifier to correctly label the new samples, the shifting data patterns may not be readily apparent because the class boundaries 5502 and 5512 have generally similar properties.

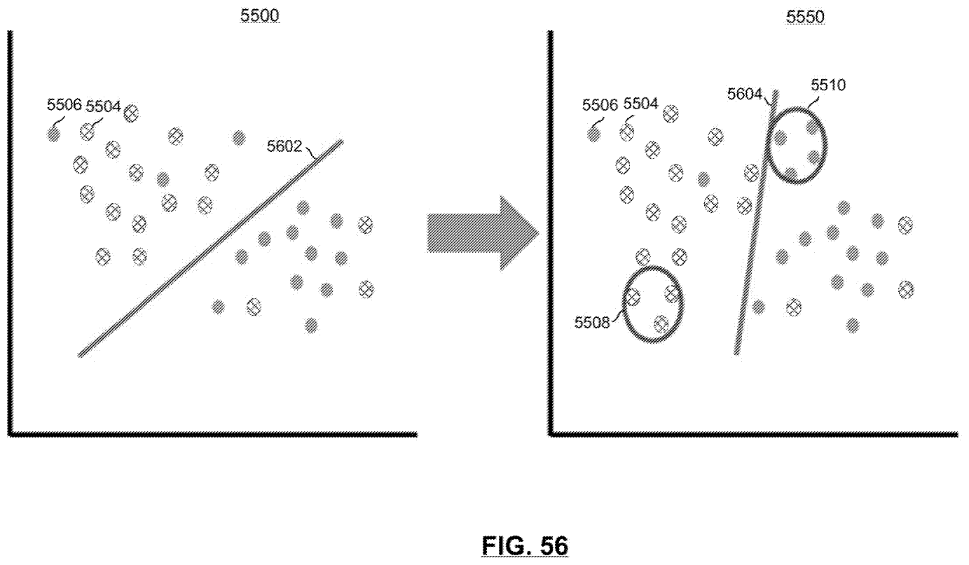

FIG. 56 illustrates operation of a linear classifier in accordance with certain embodiments. FIG. 56 depicts the same data sets 5500 and 5550 as FIG. 55. Class boundary 5602 represents a class boundary of the linear classifier after training on data set 5500, while class boundary 5604 represents a class boundary of the linear classifier after the linear classifier is retrained based on a training set including the new samples 5508 and 5510. The new data patterns (exemplified by the new samples 5508 and 5510) may be apparent since the new samples would be incorrectly categorized without retraining of the linear classifier.

Thus, the linear classifier may provide an early warning that data is changing, leading to the ability to monitor the changing dataset and proactively train new models. In particular embodiments, a system may monitor the accuracy of the linear classifier, and when the accuracy drops below a threshold amount, retraining of both the linear and non-linear classifiers may be triggered. The retraining may be performed using training sets including the more recent data.

As the combination of classifiers is designed to provide early change detection while preserving robust classification, various embodiments, in addition to detecting shifts in the environment, may be used to detect attacks. Attack data will generally be different than the training data, which is assumed to be gathered in a clean manner (e.g., from sensors of one or more autonomous vehicles) or using synthetic generation techniques (such as those discussed herein or other suitable data generation techniques). Accordingly, a loss in the accuracy of the linear classifier will provide an early indication of attack (e.g., the accuracy of the linear classifier will degrade at a faster pace than the accuracy of the non-linear classifier). Additionally, as the classifiers function differently, it may be more difficult for an attacker to bypass both systems at the same time.

In particular embodiments, changes in the linear classifier over time may allow a system to determine which data is new or interesting to maintain for further training. For example, when a change in the accuracy of the linear classifier is detected, the recently acquired data (and/or the incorrectly classified data) may be analyzed to determine data of interest, and this data of interest may be used to synthetically generate related data sets (using any of the techniques described herein or other suitable synthetic data generation techniques) to be used to train the linear and non-linear classifiers.

As the classifier will change due to data that is dissimilar from the training data, the new sample instances may be analyzed and maintained for further training. For example, in FIG. 56, samples 5508 and 5510 caused the class boundary of the linear classifier to shift. A subset of these new samples may be sampled and maintained for future training sets. In a particular embodiment, these new samples may be randomly sampled to avoid introducing data bias into the training set. In other embodiments, a disproportionate amount of a certain class may be maintained for a future training set (e.g., if the number of samples of that class is significantly less than the number of samples of the other class).

Although the example describes a two-class classifier, various embodiments may also provide multiclass classification according to the concepts described herein (e.g., utilizing simple and robust classifiers). For example, a series of hyperplanes may be used, where each class i (for 1-n) is compared against the other classes as a whole (e.g., one versus all). As another example, a series of hyperplanes may be used, where each class i (for 1-n) is compared against the other classes j (for 1-n) individually (e.g., one versus one).

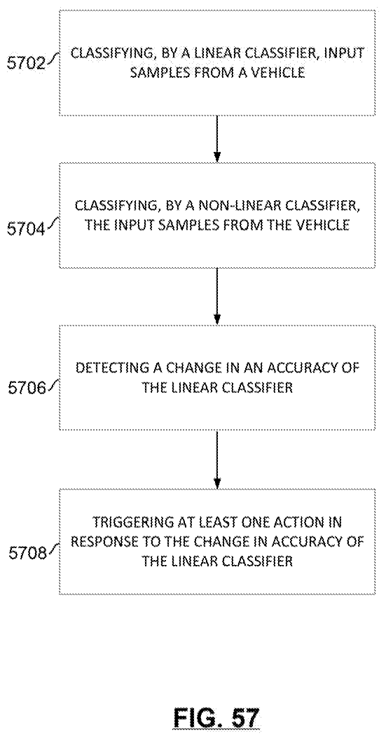

FIG. 57 depicts a flow for triggering an action based on an accuracy of a linear classifier. At 5702, a linear classifier classifies input samples from a vehicle. At 5704, a non-linear classifier classifies the same input samples from the vehicle. In particular embodiments, such classification may be performed in parallel. At 5706, a change in an accuracy of the linear classifier is detected. At 5708, at least one action is triggered in response to the change in accuracy of the linear classifier.

Road safety models may be implemented as mathematical models that guarantee safety if all road agents are compliant to the model, or correctly assigns blame in the case of an accident. For instance, road safety models may rely on mathematically calculated longitudinal and lateral minimum safe distances between two road agents to avoid collision in a worst-case scenario modeled by bounding the agents' behavior to a set of stipulated constraints.

Whenever a situation arises where a distance between two agents drops below a safe distance as stipulated by a road safety model (e.g., a “dangerous situation”), if both agents respond by enacting accelerations within the previously stipulated bounds (e.g., enact a “proper response”), a road safety model mathematically guarantees the prevention of collisions. If, on the other hand, one of the agents is noncompliant, then that agent is to be blamed if an accident occurs.

The road safety model simplifies the analysis of a situation involving two agents by focusing on its longitudinal and lateral dimensions separately. For example, the agents' velocities and accelerations, the minimum safe distances calculated using these velocities and accelerations, and the actual distances between the agents are all analyzed in terms of their longitudinal and lateral components over a coordinate system where the center of the lane is considered as lying on the y axis (therefore, the longitudinal component is expressed in terms of y, and the lateral component is expressed in terms of x).

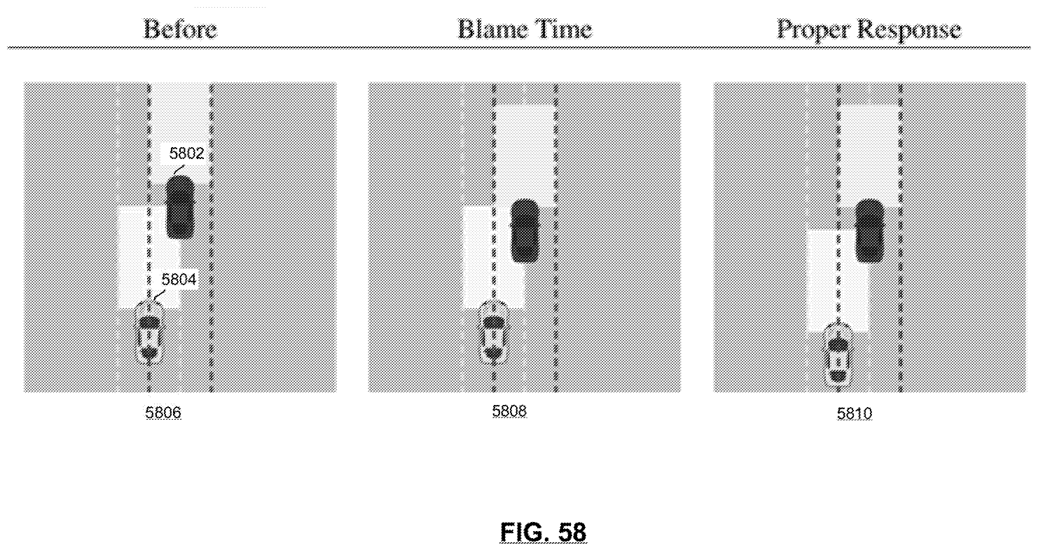

FIG. 58 depicts various road safety model driving phases in accordance with certain embodiments. In FIG. 58, agents 5802 and 5804 are depicted in three phases 5806, 5808, and 5810. To comply with a road safety model, agents are required to enact a proper response when both the longitudinal and the lateral minimum safe distances are violated, and the proper response itself depends on which violation occurred most recently. In the first phase 5806, the agents 5802 and 5804 are separated by a non-safe lateral distance, but a safe longitudinal distance. The second phase ww08 depicts the last point in time in which the longitudinal distance is still safe (referred to as “blame time”). At the next point in time after the blame time, the longitudinal safe distance is also violated. In the third phase 5810, the agents have returned back to a safe situation and avoided a collision after having enacted a proper response in the longitudinal direction.

RSS is designed to be completely decoupled from the agent's policy. In order to be compliant with RSS, an autonomous driving stack may include an additional component to check RSS compliance of decisions made by the agent's policy and to enforce default RSS-compliant decisions when the agent's policy requests actions that are not RSS compliant.

While RSS was designed with autonomous vehicles in mind, various embodiments of the present disclosure include vehicles with control systems that use RSS (or other similar accident avoidance mathematical model) as a mechanism to avoid accidents by human driver decisions. Such embodiments may potentially result in higher overall safety for a human driver, and may also provide evidence or a guarantee that the driver will not be blamed for accidents where the law in force assigns blame in a manner comparable to the RSS' blame assignment mechanism (e.g., the blame is assigned to an agent that violated the conditions of the model). Following the RSS model, various embodiments described herein present another potential, longer term advantage: for instance, as more and more agents (human or otherwise) are equipped with an RSS enforcer (or enforcer of a similar model), the overall amount of road accidents will decrease, evolving towards an ideal situation for all agents.

In a particular embodiment of the present disclosure, a vehicle includes a control system to replace driver inputs that would result in RSS-noncompliant accelerations with synthetically produced inputs guaranteed to generate an acceleration included within the range of RSS-compliant accelerations. RSS-compliant driver inputs are passed through to the actuation system unchanged, thereby implementing a system that takes over only during potentially dangerous situations.

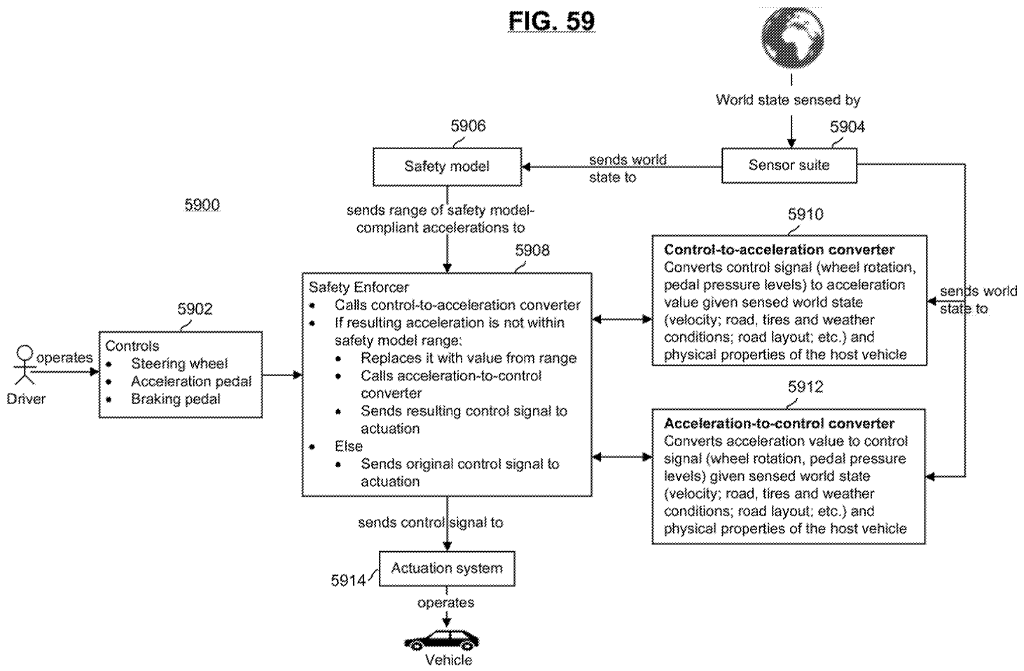

FIG. 59 depicts a diagram of a system 5900 for modifying driver inputs to ensure RSS-compliant accelerations in accordance with certain embodiments. In various embodiments, the system 5900 may be part of a vehicle, e.g., 105 and any of the modules shown may be implemented by any suitable logic of a computing system of a vehicle, e.g., 105. In other embodiments, any of the modules may be implemented outside of a vehicle (e.g., by 140 or 150) and results may be communicated to the vehicle. System 5900 includes controls 5902 (in various embodiments, controls 5902 may have any suitable characteristics of drive controls 220), sensor suite 5904 (in various embodiments, sensor suite 590r may have any suitable characteristics of sensors 225), RSS model 5906, RSS enforcer 5908, control-to-acceleration converter 5910, and acceleration-to-control converter 5912. In a particular embodiment, the components of system 5900 may all be integrated within a vehicle. In other embodiments, one or more components may be distinct from the vehicle and communicably coupled to the vehicle.

Controls 5902 may be provided to enable a human driver to provide inputs to an actuation system of the vehicle. For example, controls may include a steering wheel or other steering mechanism, an acceleration pedal or other throttle, and a brake pedal or other braking mechanism. In an embodiment, controls may include other components, such as a gear shifter, an emergency brake, joystick, touchscreen, gesture recognition system, or other suitable input control that may affect the speed or direction of the vehicle.

Sensor suite 5904 may include any suitable combination of one or more sensors utilized by the vehicle to collect information about a world state associated with the vehicle. For example, sensor suite 5904 may include one or more LIDARs, radars, cameras, global positioning systems (GPS), inertial measurement units (IMU), audio sensors, infrared sensors, or other sensors described herein. The world state information may include any suitable information, such as any of the contexts described herein, objects detected by the sensors, location information associated with objects, or other suitable information.

The world state may be provided to any suitable components of the system 5900, such as RSS model 5906, control-to-acceleration converter 5910, or acceleration-to-control converter 5912. For example, the world state information may be provided to RSS model 5906. RSS model 5906 may utilize the world state information to determine a range of RSS-compliant accelerations for the vehicle. In doing so, RSS model 5906 may track longitudinal and latitudinal distances between the vehicle and other vehicles or other objects. In addition, RSS model 5906 may also track the longitudinal and latitudinal speed of the vehicle. RSS model 5906 may periodically update the range of RSS-compliant accelerations and provide the acceleration range to RSS enforcer 5908. The RSS-compliant accelerations may specify a range of RSS-compliant accelerations in a longitudinal direction as well as a range of RSS-compliant accelerations in a latitudinal direction. The accelerations may be expressed in any suitable units, such as meters per second squared and may have positive or negative values (or may be zero valued).

RSS enforcer 5908 receives control signals from driver inputs and calls control-to-acceleration converter 5910, which converts the driver inputs into an acceleration value indicating a predicted vehicle acceleration if the driver inputs are passed to the actuation system 5914 (which in some embodiments includes both a latitudinal and longitudinal acceleration component). RSS enforcer 5908 may determine whether the acceleration value is within the most recent range of RSS-compliant accelerations received from RSS model 5906. If the acceleration value is within the range of RSS-compliant accelerations, then the RSS enforcer allows the driver input from controls 5902 to be passed to the actuation system 5914. If the acceleration value is not within the range of RSS-compliant accelerations, the RSS enforcer blocks the driver input and chooses an RSS-compliant acceleration value within the received range. The RSS enforcer 5908 may then call acceleration-to-control converter 5912 with the selected acceleration value and may receive one or more control signals in return. In a particular embodiment, the control signals provided by acceleration-to-control converter 5912 may have the same format as the control signals provided to actuation system 5914 in response to driver input. For example, the control signals may specify an amount of braking, an amount of acceleration, and/or an amount and direction of steering, or other suitable control signals. RSS enforcer 5908 may provide these new control signals to the actuation system 5914 which may use the control signals to cause the vehicle to accelerate as specified.

In various embodiments, the RSS enforcer 5908 may choose any suitable acceleration value within the range of RSS-compliant accelerations. In a particular embodiment, the RSS enforcer 5908 may choose the acceleration value at random from the range. In another embodiment, the RSS enforcer 5908 may choose the most or least conservative value from the range. In another embodiment, the RSS enforcer 5908 may choose a value in the middle of the range. In yet another embodiment, the RSS enforcer 5908 may use policy information (e.g., based on preferences of the driver or based on safety considerations) to determine the acceleration value. For example, the RSS enforcer 5908 may favor longitudinal accelerations over latitudinal accelerations or vice versa. As another example, the RSS enforcer 5908 may favor accelerations that are more comfortable to the driver (e.g., slower braking or smaller steering adjustments may be preferred over hard braking or swerving). In various embodiments, the decision may be based on both safety and comfort, with related metrics calculated from the same set of motion parameters and vehicle characteristics.

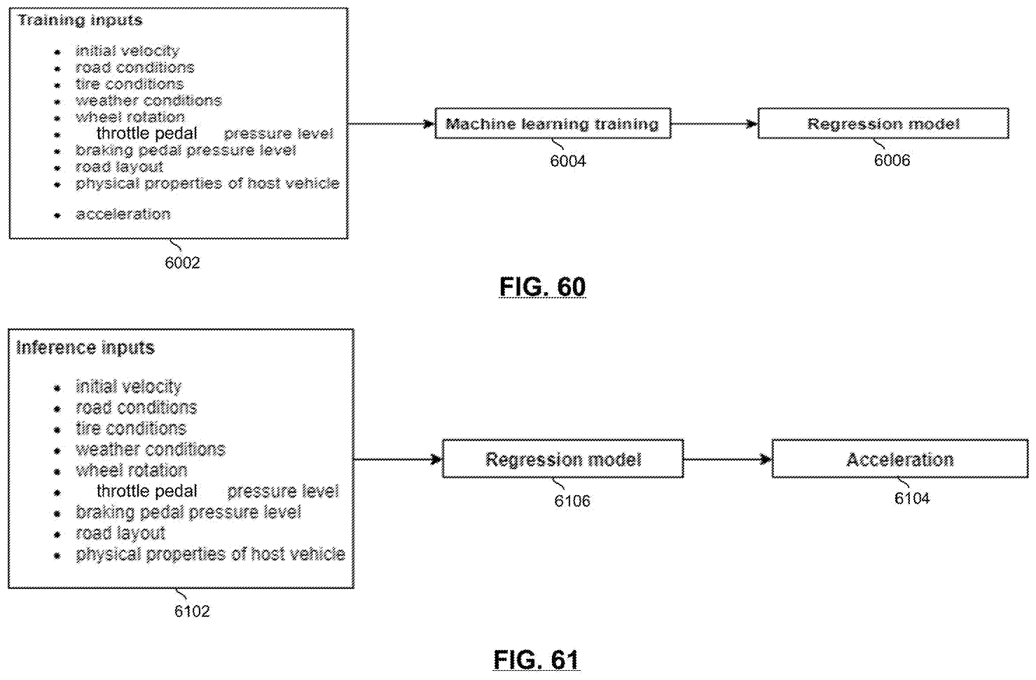

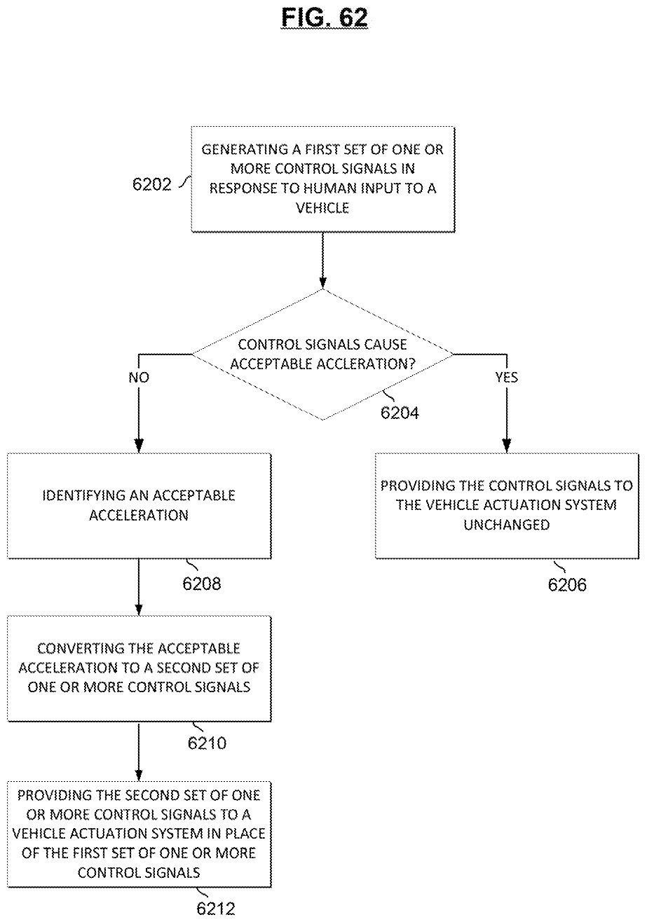

As alluded to above, the control-to-acceleration converter 5910 converts driver inputs (e.g., steering wheel rotation and throttle/braking pedal pressure) to accelerations. In various embodiments, the converter 5910 may take any suitable information into account during the conversion, such as the world state (e.g., the vehicle's velocity, weather, road conditions, road layout, etc.) and physical properties of the host vehicle (e.g., weight of vehicle, shape of vehicle, tire properties, brake properties, etc.). In one embodiment, the conversion may be based on a sophisticated mathematical model of the vehicle's dynamics (e.g., as supplied by a manufacturer of the vehicle). In some embodiments, converter 5910 may implement a machine learning model (e.g., implementing any suitable regression model) to perform the conversion. An example machine learning model for control-to-acceleration conversion will be described in more detail in connection with FIGS. 60 and 61.

An acceleration-to-control converter 5912 may include logic to convert an RSS-compliant acceleration enforced by RSS enforcer 5908 during a takeover to an input suitable for the actuation system 5914. The converter 5912 may utilize any suitable information to perform this conversion. For example, converter 5912 may utilize any one or more pieces of the information used by the control-to-acceleration converter 5910. Similarly, converter 5912 may use similar methods as converter 5910, such as a machine learning model adapted to output control signals given an input of an acceleration. In a particular embodiment, an acceleration-to-control converter may comprise a proportional integral derivative (PID) controller to determine the desired control signals based on an acceleration value. The PID controller could be implemented using classic controller algorithm with proportional, integral, and differential coefficients or could be machine learning based, wherein these coefficients are predicted using a ML algorithm (e.g., implemented by machine learning engine 232) that utilizes an optimization metric that takes into account safety and comfort.

5914 may represent any suitable actuation system to receive one or more control signals and cause a vehicle to respond to the one or more control signals. For example, actuation system may adjust an amount of gasoline or electric power (or other power source) supplied to an engine or motor of a vehicle, an amount of braking pressure applied to wheels of the vehicle, an amount of angle applied to one or more wheels of the vehicle, or make any other suitable adjustment that may affect acceleration of the vehicle.

FIG. 60 depicts a training phase for control-to-acceleration converter 5910 in accordance with certain embodiments. Training inputs 6002 for the model may include any suitable information that may affect an acceleration enacted in response to control signals. For example, training inputs may include any combination of an initial velocity of a vehicle, road conditions, tire conditions, weather conditions, wheel rotation, acceleration pedal pressure level, braking pedal pressure level, road layout, physical properties of the vehicle, or other suitable information along with a resulting acceleration under each set of such information. Such data may be used during a machine learning training phase 6004 to train a regression model 6006 that may be used by a vehicle to convert control signals and other information (e.g., world state information, physical properties of the vehicle) to acceleration values. In various embodiments, the regression model 6006 is trained on ground-truth data collected using one or more vehicles of the class of the vehicle under many different weather, road, and vehicle state conditions. In various embodiments, the training may be performed by any suitable computing system (whether in an in-vehicle computing system, in a cloud-based system, or other data processing environment).

FIG. 61 depicts an inference phase of control-to-acceleration converter 5910 in accordance with certain embodiments. During the inference phase, various inputs 6102 associated with the vehicle are provided to the regression model 6006, which outputs a predicted acceleration based on the inputs. The inputs may mirror the input types used to train the model 6006, but may include real time values for such inputs. The regression model 6006 outputs an acceleration value 6104.

A similar regression model may be used for the acceleration-to-control converter 5912. Similar input data may be used to train the model, but during inference, the model may receive a desired acceleration as input (along with real time values of the world state and/or vehicle state) and may output control signals predicted to cause the desired acceleration.

FIG. 62 depicts a flow for providing acceptable control signals to a vehicle actuation system in accordance with certain embodiments. At 6202, a first set of one or more control signals is generated in response to human input to a vehicle. At 6204, a determination is made as to whether the first set of control signals would cause an acceptable acceleration of the vehicle. If the control signals would cause an acceptable acceleration, the control signals are provided to the vehicle actuation system unchanged at 6206. If the control signals would cause an unacceptable acceleration, an acceptable acceleration is identified at 6208. At 6210, the acceptable acceleration is converted to a second set of one or more control signals. At 6212, the second set of one or more control signals is provided to the vehicle actuation system in place of the first set of one or more control signals.

Safe handover of driving responsibility to a human from an autonomous vehicle or vice versa is a very critical task. As described above, one approach to handover from a human to an autonomous vehicle may be based on the RSS model or the like, where an autonomous vehicle may intercept unacceptable human inputs and replace them with safer inputs.

In various embodiments of the present disclosure, handoff readiness may be based on a measure of overall signal quality of a vehicle's sensors relative to the context in which such a measurement is taking place. The context may be any suitable context described herein, such as a traffic situation (e.g., a highway or busy street) or weather conditions (e.g., clear skies, rainy, puddles present, black ice present, etc.). The signal quality metric may be determined using a machine learning (ML) algorithm that receives sensor data and context information as input and outputs a signal quality metric. This signal quality metric in turn is used to determine handoff readiness using another ML algorithm trained using vehicle crash information. If the signal quality metric indicates a poor signal quality in light of the context, a handoff from a human driver to an autonomous vehicle may be disallowed as such a handoff may be unsafe.

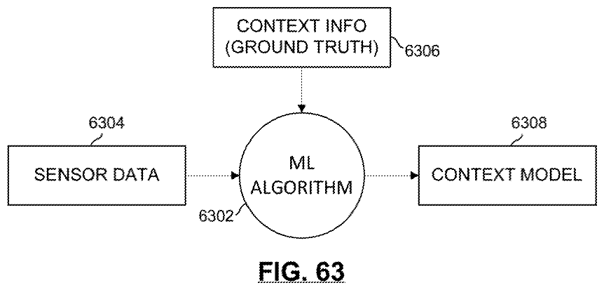

FIG. 63 depicts a training phase to build a context model 6308 in accordance with certain embodiments. In various embodiments, the context model 6308 may be a classification model built using sensor data 6304 and context information ground truth 6306. ML algorithm 6302 may represent any suitable algorithm for training the context model 6308 based on the sensor data 6304 and the context info ground truth 6306. Sensor data 6304 may include any suitable sensor data from one or more sensors of a vehicle, such as one or more LIDARs, radars, cameras, global positioning systems (GPS), inertial measurement units (IMU), audio sensors, infrared sensors, or other sensors. ML algorithm 6302 may train the context model 6308 using various instances of sensor data 6304 and context info ground truth 6306 where each instance may include a set of sensor data as well as an associated context. In various embodiments, the training data may include actual sensor data and associated contexts, simulated data and associated contexts, and/or synthetic data and associated contexts (e.g., from synthetic images generated using a method described herein). In a particular embodiment, a context may include one or more text keywords describing the context, such as “foggy” and “wet roads”, but any suitable expression of contexts is contemplated by this disclosure.

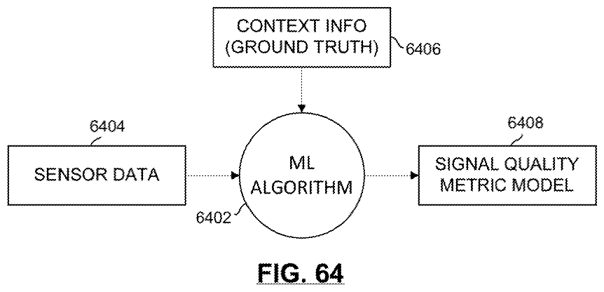

FIG. 64 depicts a training phase to build a signal quality metric model 6408 in accordance with certain embodiments. In various embodiments, the signal quality metric model 6408 may be a regression model built using sensor data and context information ground truth. In various embodiments, sensor data 6404 may be the same sensor data as sensor data 6304 or may be different, at least in part. In some embodiments, context info ground truth 6406 may be the same context info as context info ground truth 6306 or may be different, at least in part. ML algorithm 6402 may train the signal quality metric model 6408 using various instances of sensor data 6404 and context info ground truth 6406 where each instance may include a set of sensor data as well as an associated context. In various embodiments, the training data may include actual sensor data and associated contexts, simulated data and associated contexts, and/or synthetic data and associated contexts. By analyzing multiple different instance of sensor data associated with a particular context, ML algorithm 6402 may be able to train signal quality metric model 6408 to distinguish between the qualities of the various instances of sensor data 6404 for the particular context. Similar training may be done for any suitable number of different contexts.

After the signal quality metric model is trained, it may be able to receive an instance of sensor data (where an instance of sensor data comprises sensor data collected over a period of time) and an associated context and output one or more indications of sensor data quality. For example, the signal quality metric may include a composite score for the quality of an instance of sensor data. In another example, the signal quality metric may include a score for the quality of each of a plurality of types of sensor data. For example, the signal quality metric may include a score for camera data and a score for LIDAR data. In some embodiments, a score may be any of multiple types of quality metrics, such as a measurement of a signal to noise ratio, a measurement of a resolution, or other suitable type of quality metric. In some embodiments, the signal quality metric may include scores for multiple types of quality metrics or may include a single score based on multiple types of quality metrics. In some embodiments, a score of a signal quality metric may be a normalized value (e.g., from 0 to 1).

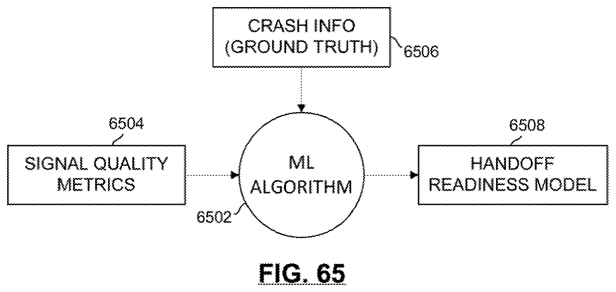

FIG. 65 depicts a training phase to build a handoff readiness model 6508 in accordance with certain embodiments. In various embodiments, the handoff readiness model 6508 may be a classification model built using signal quality metrics information 6504 and crash information ground truth 6506.

ML algorithm 6502 may represent any suitable algorithm for training the handoff readiness model 6508 based on the signal quality metrics 6504 and the crash info ground truth 6506. ML algorithm 6502 may train the context model 6308 using various instances of signal quality metrics 6504 and crash info ground truth 6506. An instance used for training may include a signal quality metric as well as a set of crash information. A set of crash information may include any suitable safety outcome associated with a particular instance of a signal quality metric. For example, an instance of crash information may indicate whether an accident occurred when an autonomous vehicle was operated under the signal quality metric. As another example, an instance of crash information may indicate whether an accident nearly occurred when an autonomous vehicle was operated under the signal quality metric. As another example, an instance of crash information may indicate whether an accident occurred or nearly occurred (e.g., near accidents may be treated the same as actual accidents) when an autonomous vehicle was operated under the signal quality metric. In various embodiments, the training data may include actual data signal quality metrics and crash info, simulated data signal quality metrics and crash info, synthetic data signal quality metrics and crash info, or a combination thereof.

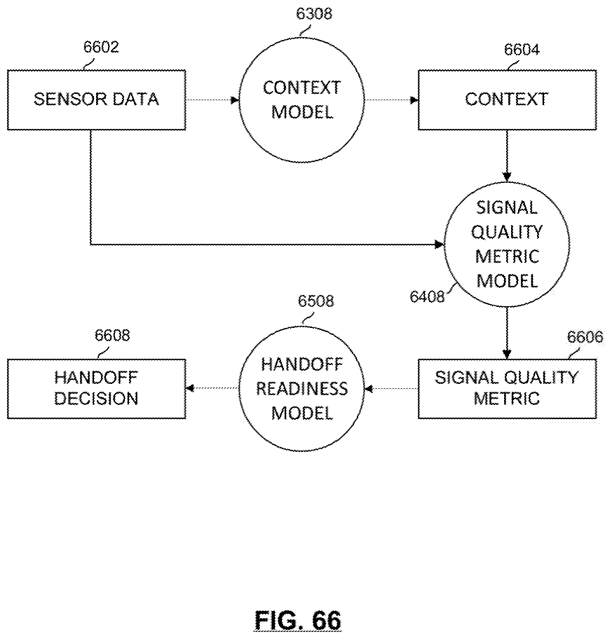

FIG. 66 depicts an inference phase to determine a handoff decision 6608 based on sensor data 6602 in accordance with certain embodiments. In the inference phase, which may be implemented, for instance, by an in-vehicle computing system at drive time, sensor data 6602 is collected and provided to the trained context model 6308. The context model analyzes the sensor data 6308 and determines a context 6604 from the sensor data 6602. The determined context 6604 is provided, along with the sensor data 6602 to signal quality metric model 6408. The signal quality metric model 6408 analyzes the sensor data 6602 and the context 6604 and determines a signal quality metric 6606 based on the quality of the sensor data 6602 in light of the context 6604. The signal quality metric 6606 is provided to handoff readiness model 6508, which determines a handoff decision 6608 based thereon. In a particular embodiment, the handoff decision 6608 is a binary indication of whether the handoff is safe or not. In other embodiments, this may be a multiclass decision having three or more possible outcomes. For example, the handoff decision could include any number of outcomes that each represents a different range of safety of the handoff. In various embodiments, the vehicle may utilize the handoff decision 6608 outcome to determine whether to handoff or not, or to carry out a partial handoff, e.g., handing off some controls but not others (e.g., steering only but not brakes or vice versa).

In various embodiments, the inference phase may be performed periodically or in response to a trigger (or both). For example, while the autonomous vehicle is handling the driving control, the inference phase may be performed periodically to determine whether the autonomous vehicle is still able to reliably handle the driving control. As another example, the inference phase may be triggered when a request is received from a human driver to transfer control to the vehicle. As yet another example, the inference phase may be triggered by a change in context or a significant change in a quality of sensor data.

In particular embodiments, preemptive planning of handoff based on known levels of static data, such as the availability of high definition maps for roads the vehicle is to travel. This type of data might be unavailable for certain areas that the vehicle has to drive in, for example because the HD map data for a certain area has not been collected yet. In such cases, the system can preemptively plan for handoff (e.g., before the start of the trip) and prepare the driver beforehand for safe handoff using any of the handoff techniques described herein. In a particular example, the inference phase to determine a handoff decision is triggered upon entry (or right before entry) of the vehicle into a zone without the HD map data. In some embodiments, the availability of HD map data may be used as an input to signal quality metric model 6408 to affect the signal quality metric positively if the HD map data is available or negatively if it is not. In some embodiments, the HD maps are basically treated as an additional sensor input.

In various embodiments, the ML algorithms or models described in reference to FIGS. 63-66 may be trained or performed by any suitable computing system, such as an in-vehicle computing systems, a support system implementing using cloud- and/or fog-based computing resources, or in another data processing environment.

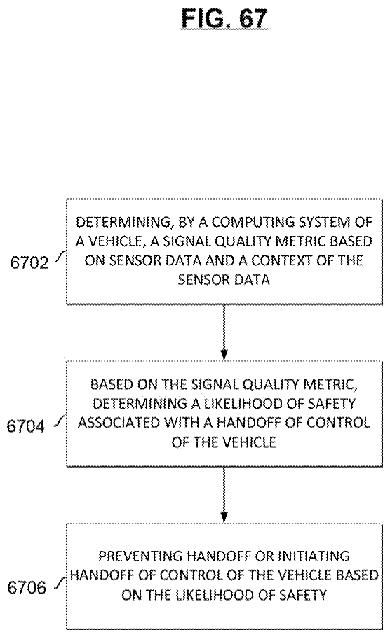

FIG. 67 depicts a flow for determining whether to handoff control of a vehicle in accordance with certain embodiments. At 6702, a computing system of a vehicle determines a signal quality metric based on sensor data and a context of the sensor data. At 6704, a likelihood of safety associated with a handoff of control of the vehicle is determined based on the signal quality metric. At 6706, a handoff is prevented or initiated based on the likelihood of safety.

Autonomous vehicles are expected to provide possible advantages over human drivers in terms of having better and more consistent responses to driving events due to their immunity to factors that negatively affect humans, such as fatigue, varying levels of alertness, mood swings, or other factors. However, autonomous vehicles may be subject to equipment failure or may experience situations in which the autonomous vehicle is not prepared to operate adequately (e.g., the autonomous vehicle may enter a zone having new features for which the vehicle algorithms are not trained), necessitating handoff of the vehicle to a human driver or pullover of the vehicle.

In various embodiments of the present disclosure, prior to handing off a vehicle to a human driver, the state of the driver (e.g., fatigue level, level of alertness, emotional condition, or other state) is analyzed to improve safety of the handoff process. Handing off control suddenly to a person who is not ready could prove to be more dangerous than not handing off at all, as suggested by a number of accidents reported recently with recent test vehicles.

Typically, autonomous vehicles have sensors that are outward facing, as perception systems are focused on mapping the environment and localization systems are focused on finding the location of the ego vehicle based on data from these sensors and map data. Various embodiments of the present disclosure provide one or more in-vehicle cameras or other sensors to track the driver state.

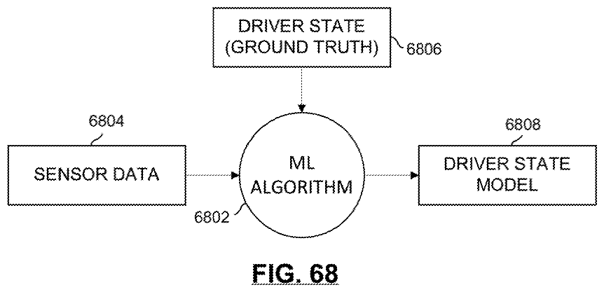

FIG. 68 depicts a training phase for a driver state model 6808 in accordance with certain embodiments. In the training phase, sensor data 6804 and driver state ground truth data 6806 is provided to ML algorithm 6802, which trains the driver state model 6808 based on this data. In various embodiments, the driver state model 6808 may be a classification model that outputs a class describing the state of a driver. In other embodiments, the driver state model 6808 may be a regression model that outputs a score for the state of the driver (with higher scores depicting a more desirable state).

In various embodiments, sensor data 6804 may represent any suitable sensor data and/or information derived from the sensor data. For example, sensor data 6804 may include or be based on image data collected from one or more cameras capturing images of the inside of the vehicle. In some embodiments, the one or more cameras or computing systems coupled to the cameras may implement AI algorithms to detect face, eyebrow, or eye movements and extract features to track a level of fatigue and alertness indicated by the detected features.

In various embodiments, sensor data 6804 may include or be based on one or more temperature maps collected from an infrared camera. In some embodiments, the infrared camera or a computing system coupled to the infrared camera may implement AI algorithms to track the emotional state or other physical state of the driver based on these temperature maps. As just one example, a rise in body temperature of a human driver (e.g., as indicated by an increased number of regions with red color in a temperature map) may be indicative of an agitated state. In various embodiments, sensor data 6804 may include or be based on pressure data collected from tactile or haptic sensors on the steering wheel, accelerator, or driver seat. In some embodiments, a computing system coupled to such tactile or haptic sensors may implement AI algorithms to analyze such pressure data to track the level of alertness or other physical state of the driver.

In various embodiments, sensor data 6804 may include or be based on electrocardiogram (EKG) or inertial measurement unit (IMU) data from wearables, such as a smart watch or health tracker band. A computing system coupled to such wearables or the wearables themselves may utilize AI algorithms to extract EKG features to track the health condition or other physical state of the driver or to analyze IMU data to extract features to track the level of alertness or other physical state of the driver.

In various embodiments, sensor data 6804 may include or be based on audio data from in-cabin microphones. Such data may be preprocessed with noise cancellation techniques to isolate the sounds produced by passengers in the vehicle. For example, if audio is being played by the in-vehicle infotainment system, the signal from the audio being played may be subtracted from the audio captured by the in-cabin microphones before any further processing. Raw audio features may be used directly to gauge user responsiveness levels or overall physical state (for example, slurred speech may be indicative of inebriation) but may also be used to classify audio events (e.g., laughing, crying, yawning, snoring, retching, or other event) that can be used as further features indicative of driver state. The analyzed audio data may also include detected speech (e.g., speech may be transformed into text by an Automatic Speech Recognition engine or the like) from dialogues the passengers are having with each other or with the vehicle's infotainment system. As one example, in addition to communicating with the driver about a handoff, the vehicle's dialogue system can attempt to get the driver's confirmation for an imminent handoff. Speech may be transformed into text and subsequently analyzed by sophisticated Natural Language Processing pipelines (or the like) to classify speaker intent (e.g., positive or negative confirmation), analyze sentiment of the interactions (e.g., negative sentiment for linguistic material such as swearwords), or model the topics being discussed. Such outputs may subsequently be used as additional features to the driver state tracking algorithm.

Features about the state of the vehicle may also provide insights into the driver's current level of alertness. As examples, such features may include one or more of media currently being played in the vehicle (e.g., movies, video games, music), a level of light in the cabin, an amount of driver interactivity with dashboard controls, window aperture levels, the state of in-cabin temperature control systems (e.g., air conditioning or heating), state of devices connected to the vehicle (e.g., a cell phone connected via Bluetooth), or other vehicle state inputs. Such features may be included within sensor data 6804 as inputs to the ML algorithm 6802 to train the driver state model 6808.

In particular embodiments, activity labels may be derived from the sensor data by an activity classification model. For example, the model may detect whether the driver is sleeping (e.g., based on eyes being closed in image data, snoring heard in audio data, and decreased body temperature), fighting with another passenger in the cabin (e.g., voice volume rises, heartbeat races, insults are exchanged), feeling sick (e.g., retching sound is captured by microphones and driver shown in image data with head bent down), or any other suitable activities.

In various embodiments, the raw sensor data may be supplied to the training algorithm 6802. In addition, or as an alternative, classifications based on the raw sensor data may be supplied to the ML algorithm 6802 to train the driver state model 6808. In some embodiments, the activity labels described above may be supplied to the training algorithm 6802 (optionally with the lower level features and/or raw sensor data as well) for more robust driver state tracking results.

Driver state ground truth 6806 may include known driver states corresponding to instances of sensor data 6804. When driver state model 6808 implements a classification algorithm, the driver state ground truth 6806 may include various classes of driver state. When driver state model 6808 implements a regression algorithm, each instance of driver state ground truth 6806 may include a numerical score indicating a driver state.

In various embodiments, the driver state ground truth 6806 and sensor data 6804 may be specific to the driver or may include data aggregated for multiple different drivers.

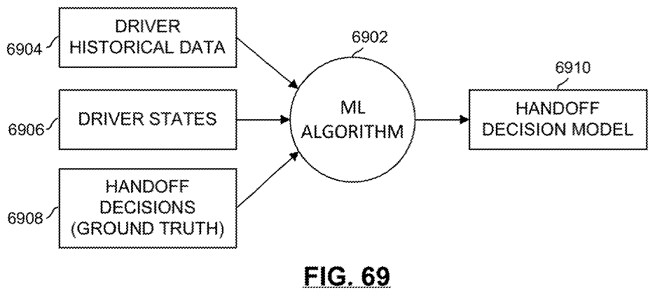

FIG. 69 depicts a training phase for a handoff decision model 6910. An ML training algorithm 6902 uses driver historical data 6904, driver states 6906, and handoff decisions ground truth 6908 to train handoff decision model 6910. In an alternate embodiment, ML algorithm 6902 may simply use driver states 6906 and handoff decisions ground truth 6908 to train the handoff decision model 6910. The handoff decisions ground truth 6908 may include actual previous handoff decisions and respective results (e.g., whether a crash or other dangerous event occurred). In particular embodiments, all or a subset of the handoff decisions ground truth 6908 may be simulated to enhance the data set.

Driver historical data 6904 may include any suitable background information that may inform the level of attentiveness of the driver. For example, historical data 6904 may include historical data for a driver including instances of driving under intoxication (DUI), past accidents, instances of potentially dangerous actions taken by a driver (e.g., veering into oncoming traffic, slamming on brakes to avoid rear ending another vehicle, running over rumble strips), health conditions of the driver, or other suitable background information. In some embodiments, the autonomous vehicle may have a driver ID slot where the driver inserts a special ID, and the autonomous vehicles connectivity system pulls out the relevant historical data for the driver. The driver's background information may be obtained in any other suitable manner.

In the embodiment depicted, during the training phase, the driver's historical data 6904 is supplied to the ML algorithm 6902 along with the driver state information 6906 to build a handoff decision model 6910 that outputs two or more classes. In one embodiment, the handoff decision model 6910 outputs three classes: handoff, no handoff, or short-term handoff. In another embodiment, the handoff decision model 6910 outputs two classes: handoff or no handoff. In yet another embodiment, one of the classes may be partial handoff. As various examples, a class of “handoff” may indicate that the handoff may be performed with a high level of confidence, a class of “no handoff” may indicate a low level of confidence and may, in situations in which continued control by the vehicle is undesirable, result in the handoff being deferred to a remote monitoring system to take over control of the car until the driver is ready or the car is brought to a safe stop; a class of “short term handoff” may represent an intermediate level of confidence in the driver and may, in some embodiments, result in control being handed off to a driver with a time limit, within which the car is forced to come to a stop (e.g., the car may be brought to safe stop by a standby unit, such as a communication system that may control the car or provide a storage location for the car). In another embodiment, a “partial handoff” may represent an intermediate level of confidence in the driver and may result in passing only a portion of control over to the driver (e.g., just braking control or just steering control). In one embodiment, a “conditional handoff” may represent an intermediate level of confidence in the driver and may result in passing handoff over to the driver and monitoring driver actions and/or the state of the user to ensure that the vehicle is being safely operated. The above merely represent examples of possible handoff classes and the handoff decision model 6910 may output any combination of the above handoff classes or other suitable handoff classes.

In various embodiments, context detected via a vehicle's outward sensors may also be taken into consideration to evaluate a driver's capability of successfully handling a handoff. For example, weather conditions, visibility conditions, road conditions, traffic conditions, or other conditions may affect the level of alertness desired for a handoff. For example, if the conditions are inclement, a different level of awareness may be required before handing off to a driver. This may be implemented by feeding context information into the machine learning algorithm 6902 or in any other suitable manner.

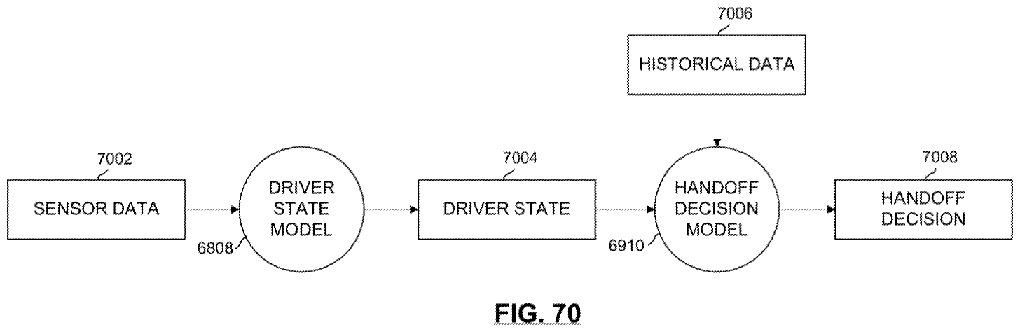

FIG. 70 depicts an inference phase for determining a handoff decision 7008 in accordance with certain embodiments. Sensor data 7002 as described above is provided to the driver state model 6808 which outputs a driver state 7004. The driver state 7004 and historical data 7006 is provided to handoff decision model 6910 which outputs a handoff decision 7008 as described above or another suitable handoff decision. In other embodiments, the handoff decision model may consider other factors (e.g., a context of the driving situation determined from one or more outward facing sensors) or omit the historical data 7006.

The inference phase may be performed in response to any suitable trigger. For example, the inference phase may be performed in response to a determination that the vehicle cannot independently operate itself with an acceptable level of safety. As another example, the inference phase may be performed periodically while a human driver is operating the vehicle and the outcome of the inference phase may be a determination of whether the driver is fit to operate the vehicle. If the driver is not fit, the vehicle may take over control of all or a part of the driving control, may provide a warning to the driver, or may take action to increase the alertness of the driver (e.g., turn on loud music, open the windows, vibrate the driver's seat or steering wheel, or other suitable action).

When the system determines to handoff to the human driver, the driver is notified of an imminent handoff. In order to do so, the system may engage with the driver in one or more of several possible manners. For example, the system may engage in a verbal manner with the driver. For example, text with correct semantics and syntax may be built by a natural language generation engine and then transformed into synthetic speech audio by a text-to-speech engine to produce a verbal message describing the handoff. As another example, the system may engage physically with the driver. For example, a motor installed on the driver's seat or steering wheel may cause the seat or steering wheel to vibrate vigorously taking into account the safety of the driver so as to not startle the driver and result in an accident. In other embodiments, the system may engage with the driver in any suitable manner to communicate the handoff.

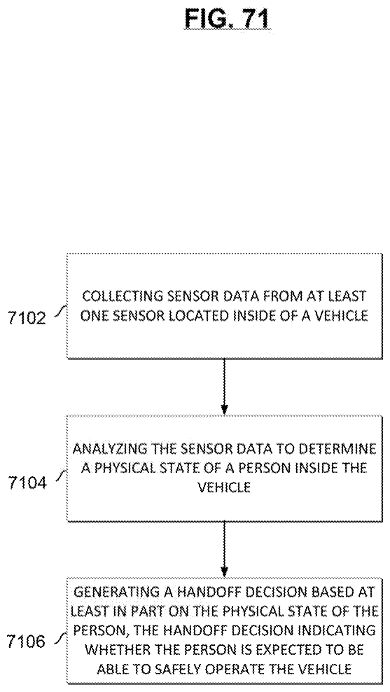

FIG. 71 depicts a flow for generating a handoff decision in accordance with certain embodiments. At 7102, sensor data is collected from at least one sensor located inside of a vehicle. At 7104, the sensor data is analyzed to determine a physical state of a person inside the vehicle. At 7106, a handoff decision is generated based at least in part on the physical state of the person, the handoff decision indicating whether the person is expected to be able to safely operate the vehicle.

As discussed herein, some autonomous driving systems may be equipped with functionality to support transfer of control from the autonomous vehicle to a human user in the vehicle or at a remote location (e.g., in a remote valet application). In some implementations, an autonomous driving system may adopt a logic-based framework for smooth transfer of control from passengers (EGO) to autonomous (agent) cars and vice-versa under different conditions and situations, with the objective of enhancing both passenger and road safety. At least some aspects of this framework may be parallelized as implemented on hardware of autonomous driving system (e.g., through a FPGA, a Hadoop cluster, etc.).

For instance, an example framework may consider the different situations under which it is safer for either the autonomous vehicle or a human driver to take control of the vehicle and to suggest mechanisms to implement these control requests between the two parties. As an example, there may be conditions where the autonomous vehicle may want to regain control of the vehicle for safer driving. The autonomous vehicle may be equipped with cameras or other internal sensors (e.g., microphones) that may be used to sense the awareness state of the driver (e.g., determine whether the driver is distracted by a phone call, or feeling sleepy/drowsy) and determine whether to takeover control based on the driver's awareness. The autonomous vehicle may include a mechanism to analyze sensor data (e.g., analytics done on the camera and microphone data from inside the car), and request and take over control from the driver if the driver's awareness level is low, or the driver is otherwise deemed unsafe (e.g., drunken driving, hands free driving, sleeping behind the wheels, texting and driving, reckless driving, etc.), or if the autonomous vehicle senses any abnormal activity in the car (e.g., a fight, or scream, or other unsafe driving behavior by the human driver or passengers). In this manner, safety of the people both inside and outside the autonomous vehicle may be enhanced.

In some implementations, an authentication-based (e.g., using a biometric) command control may be utilized to prevent unauthorized use of the autonomous car. As an example, in some embodiments, when an autonomous vehicle is stolen or falls under wrong hands, the autonomous vehicle may be able to detect this scenario and lock itself from being controlled. For instance, an authentication mechanism may be included in the autonomous vehicle that uses biometrics (e.g., fingerprints, voice and facial recognition, driver's license etc.) to authenticate a user requesting control of the autonomous vehicle. These mechanisms may prevent unauthenticated use of the autonomous vehicle. In some cases, use of the autonomous vehicle or aspects thereof may be provided based on different permission levels. For example, one user may be able to fully control the car manually anywhere, while another user may only be able to control the car in a particular geo-fenced location. As another example, in some embodiments, a passenger may request control of the autonomous vehicle when certain situations are encountered, such as very crowded roads, bad weather, broken sensors (e.g., cameras, LIDAR, radar, etc.), etc. In response to the request, the autonomous vehicle may authenticate the user based on one or more of the user's biometric, and if authenticated, may pass control of the autonomous vehicle to the user. As another example, in some embodiments, when an entity/user (e.g., law enforcement, first responder, government official, etc.) wishes to control the autonomous vehicle remotely, the autonomous vehicle may validate the user prior to transferring control to the entity/user.

In some embodiments, control of an autonomous vehicle may be crowdsourced to multiple surrounding cars (including law enforcement vehicles) or infrastructure-based sensors/controllers, for example, in an instance where surrounding autonomous vehicles believe the autonomous vehicle is driving dangerously or not within the acceptable limits of the other cars' behavioral models. In such instances, the entity/entities requesting control may be authenticated, such as, through biometrics for people requesting control or by digital security information (e.g., digital certificates) for autonomous vehicles/infrastructure sensors.

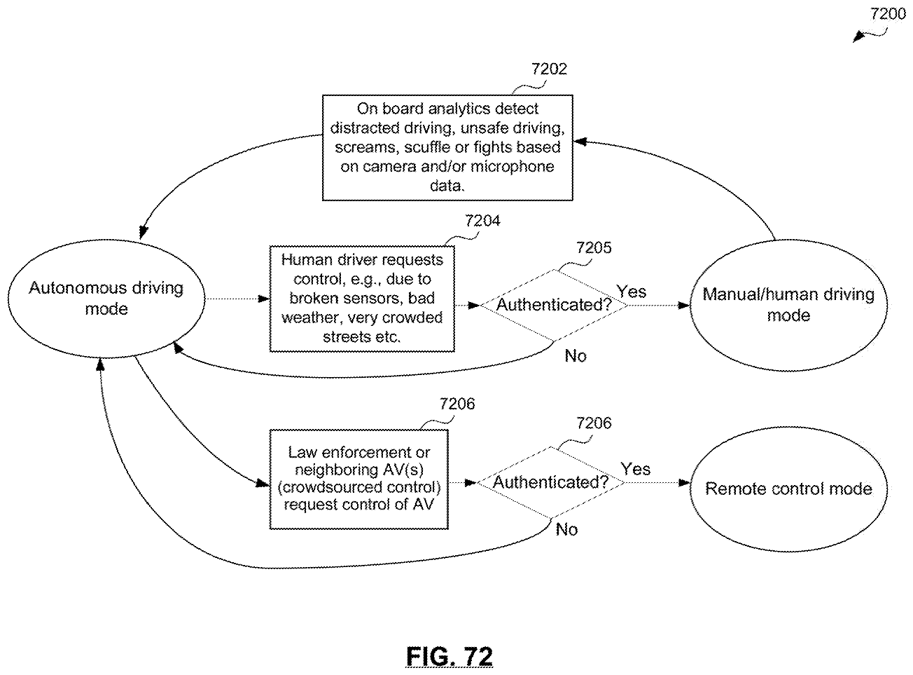

FIG. 72 illustrates a high-level block diagram of the above framework in accordance with at least one embodiment. For instance, in scenario 7202, the autonomous vehicle is operating in the human-driven/manual mode of operation when the autonomous vehicle detects (e.g., via camera or microphone data from inside the autonomous vehicle) unsafe driving conditions (e.g., those listed in FIG. 72 or other unsafe conditions) and accordingly reverts control back to the autonomous vehicle to proceed in the autonomous driving mode. In this scenario, the autonomous vehicle may present a request to the driver to regain control of the vehicle before regaining control.

In scenario 7204, a human driver requests control of the autonomous vehicle, such as in response to the driver identifying a situation (e.g., those listed in FIG. 72 or others) in which the driver does not feel comfortable proceeding in the autonomous mode of operation. The autonomous vehicle may initiate an authenticate request at 7205 to authenticate the human driver, e.g., using biometrics or other authentication methods, in response, and on valid authentication, may pass control from the autonomous vehicle to the human driver (otherwise, the autonomous vehicle will retain control).

In scenario, 7206, a law enforcement officer or neighboring autonomous vehicle(s) may request control of the autonomous vehicle, e.g., due to observed unsafe driving by the autonomous vehicle, due to the autonomous vehicle being reported stolen, due to needing to move the autonomous vehicle for crowd/road control purposes, etc. The autonomous vehicle may initiate an authenticate request at 7207 to authenticate the requesting person/entity in response, and on valid authentication, may pass control from the autonomous vehicle to the officer/neighboring autonomous vehicle(s) (otherwise, the autonomous vehicle will retain control).

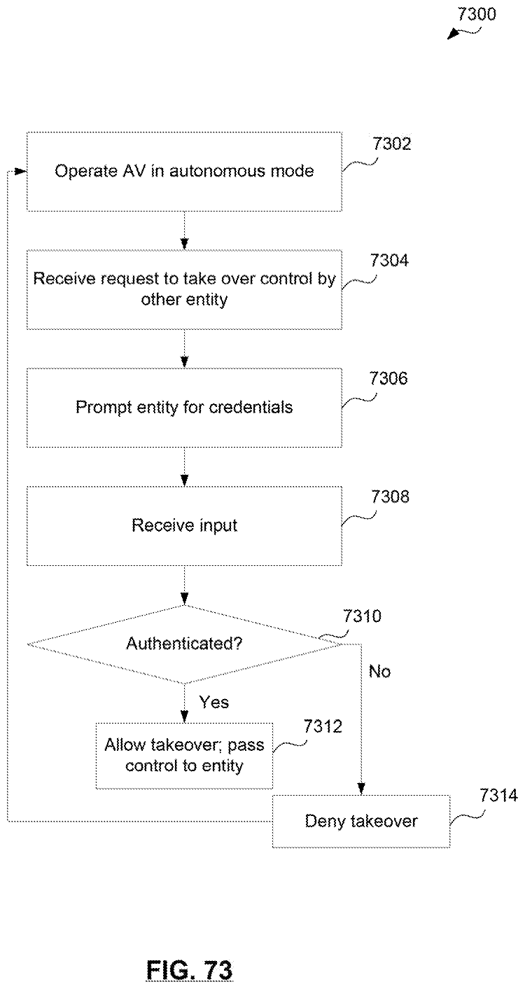

FIG. 73 is a diagram of an example process of controlling takeovers of an autonomous vehicle in accordance with at least one embodiment. Operations in the example process may be performed by aspects or components of an autonomous vehicle. The example process 7300 may include additional or different operations, and the operations may be performed in the order shown or in another order. In some cases, one or more of the operations shown in FIG. 73 are implemented as processes that include multiple operations, sub-processes, or other types of routines. In some cases, operations can be combined, performed in another order, performed in parallel, iterated, or otherwise repeated or performed another manner.

At 7302, an autonomous vehicle is operated in autonomous mode, whereby the autonomous vehicle controls many or all aspects of the operation of the autonomous vehicle.

At 7304, the autonomous vehicle receives a request from another entity to take over control of the autonomous vehicle. The entity may include a human passenger/driver of the autonomous vehicle, a person remote from the autonomous vehicle (e.g., law enforcement or government official), or another autonomous vehicle or multiple autonomous vehicles nearby the autonomous vehicle (e.g., crowdsourced control).

At 7306, the autonomous vehicle prompts the entity for credentials to authenticate the entity requesting control. The prompt may include a prompt for a biometric, such as a fingerprint, voice sample for voice recognition, face sample for facial recognition, or another type of biometric. The prompt may include a prompt for other types of credentials, such as a username, password, etc.

At 7308, the autonomous vehicle receives input from the requesting entity, and at 7310, determines whether the entity is authenticated based on the input received. If the entity is authenticated, then the autonomous vehicle allows the takeover and passes control to the requesting entity at 7312. If the entity is not authenticated based on the input, then the autonomous vehicle denies the takeover request and continues to operate in the autonomous mode of operation.

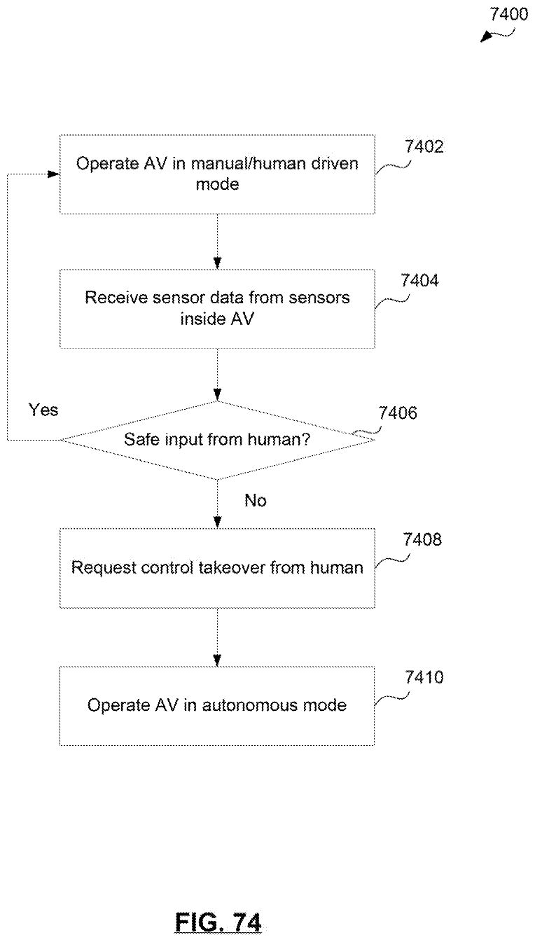

FIG. 74 is a diagram of another example process of controlling takeovers of an autonomous vehicle in accordance with at least one embodiment. Operations in the example process may be performed by aspects or components of an autonomous vehicle. The example process 7400 may include additional or different operations, and the operations may be performed in the order shown or in another order. In some cases, one or more of the operations shown in FIG. 74 are implemented as processes that include multiple operations, sub-processes, or other types of routines. In some cases, operations can be combined, performed in another order, performed in parallel, iterated, or otherwise repeated or performed another manner.

At 7402, an autonomous vehicle is operated in a manual/human driven mode of operation, whereby a human (either inside the autonomous vehicle or remote from the autonomous vehicle) controls one or more aspects of operation of the autonomous vehicle.

At 7404, the autonomous vehicle receives sensor data from one or more sensors located inside the autonomous vehicle, and at 7406 analyzes the sensor data to determine whether the input from the human operator is safe. If the input is determined to be safe, the autonomous vehicle continues to operate in the manual mode of operation. If the input is determined to be unsafe, then the autonomous vehicle requests a control takeover from the human operator at 7408 and operates the autonomous vehicle in the autonomous mode of operation at 7410.

Moving from Level 2 (“L2” or “L2+”) autonomous vehicles to Level 5 (“L5”) autonomous vehicles with full autonomy may take several years and the autonomous vehicle industry may observe progressive transition of responsibilities from the human-driver role until reaching the state of full autonomy (without driver) anywhere and everywhere. Implementing safe takeovers from machine control (autonomous mode) to human control (human-driven mode) is critical in this transition phase, but comes with several challenges. For example, one of the potential challenges is controlling the random intervention from the human driver that occurs without request from the autonomous system. Another challenge arises from event-driven interventions. Three types of takeovers that can occur in autonomous vehicles include:

Vehicle Requested Take-over: When the vehicle requests the driver to takeover and pass from autonomous mode to human-driven mode. This may happen, in some cases, when the autonomous vehicle faces a new situation for its perception system, such as when there is some uncertainty of the best decision, or when the vehicle is coming out of a geo-fenced region. The general approach for requesting human takeover is through warning the driver through one or more ways (e.g., messages popping-up in the dash board, beeps, or vibrations in steering wheel). While the human driver is accommodating the takeover, some misses in the takeover may occur due to reaction time of human that takes longer than expected, lack of concentration by the human, or another reason.

Random Take-over by Human Driver: A possible takeover can happen by the human-driver randomly (e.g., without request from the vehicle) and for unpredicted reasons. For example, the human driver may be distracted or may be awakened from an unintended sleep react inappropriately (take control the wheel quickly without full awareness). As another example, the human driver may be in a rush (e.g., to catch-up to a flight or an important event) an unsatisfied with the vehicle speed in autonomous mode, and so he may take over control to speed up. These types of random takeovers may be undesirable as it would not be feasible to put driving rules/policies in place for such unpredicted takeovers, and the random takeover itself may lead to accidents/crashes.

Event-driven Take-Over by Human: Another possible takeover can happen by the human due to unpredicted events. For example, the human driver may feel a sudden need to get out of the car (e.g., due to claustrophobia, feeling sick, etc.). As another example, a passenger riding with the human-driver may get into a sudden high-risk scenario and the human-driver may take over to stop the car. As another example, a human driver may feel uncomfortable with the road being travelled (e.g., dark and unknown road), triggering the need to take control to feel more comfortable. These types of takeovers may be undesirable as they can disturb the autonomous driving mode in an unpredicted manner, and the takeovers themselves may lead to accidents/crashes. Similar to the previous case, this type of takeover is also undesirable as it would not be feasible to put driving rules/policies for such unpredicted takeovers and the takeover that is driven by unpredicted events is not likely to be safe.

Of these types, the Random and Event-Driven takeovers may be considered as unsafe, and accordingly, autonomous driving systems may be specifically configured to detect and control these types of takeovers, which may allow for safer driving and avoidance of unpredictable behavior during the autonomous driving mode. In certain embodiments, to mitigate these potentially unsafe takeover situations:
The autonomous driving perception phase (e.g., as implemented in in the in-vehicle perception software stack) may be expanded to include a software module for unsafe takeover detection in real-time;
The autonomous driving Acting phase (e.g., vehicle control software and hardware implemented in the in-vehicle system) may be expanded to include a software module for mitigation of the detected unsafe takeover in real-time
The autonomous driving Plan Phase (e.g., route planning subsystem(s)) may be expanded, as a mean of execution to the mitigation, to include consideration of potential re-routes or other adjustments to the autonomous driving mode to avoid passengers or drivers being uncomfortable.

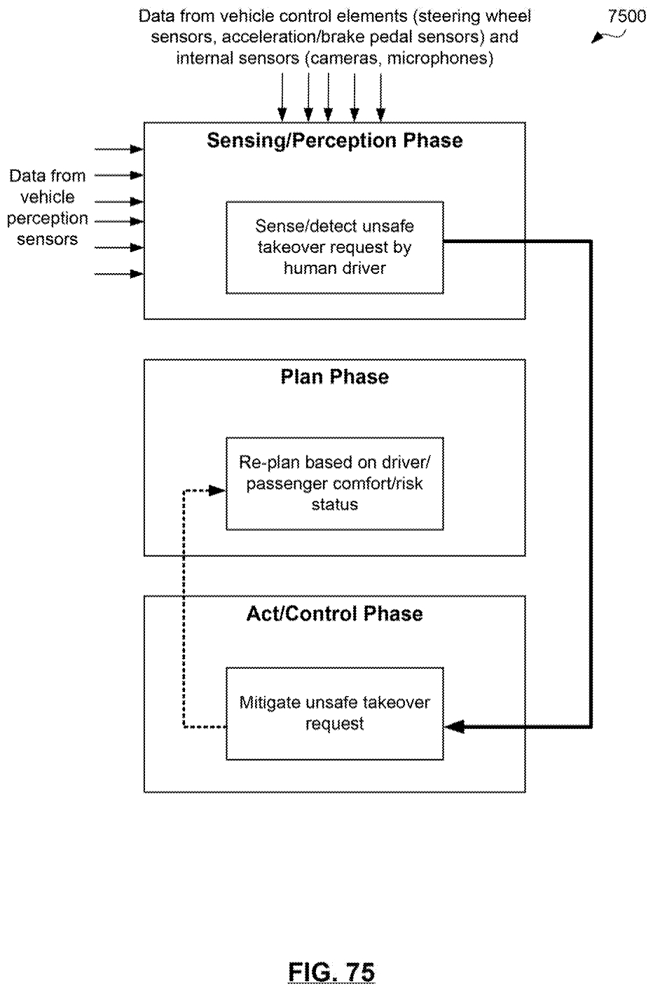

FIG. 75 is a diagram of an example perception, plan, and act autonomous driving pipeline 7600 for an autonomous vehicle in accordance with at least one embodiment. In particular, FIG. 75 gives an overview of certain considerations in autonomous vehicle perception and control to detect and mitigate, in real-time, potentially unsafe takeovers. Operations of the perception, plan, and act pipeline may be performed by an in-vehicle control system of the autonomous vehicle. As shown, the example perception, plan, and act pipeline includes a sensing/perception phase, a planning phase, and an act/control phase.

In the example shown, the control system receives sensor data from a plurality of sensors coupled to the autonomous vehicle, including vehicle perception sensors (e.g., camera(s), LIDAR, etc.) and vehicle control elements (e.g., steering wheel sensor, brake/acceleration pedal sensors, internal camera(s), internal microphones, etc.). The control system uses the sensor data in the sensing/perception phase to detect an unsafe takeover request by a human driver of the autonomous vehicle. Detection of unsafe takeovers may be based on at least a portion of the sensor data received. For example, unsafe takeovers may be detected based on sensors coupled to the accelerator pedal, brake pedal, and/or steering wheel to sense an act of takeover. In some cases, cameras and/or microphone(s) inside the car may be used (e.g., with artificial intelligence) to detect that a driver's action(s) are to take over control of the autonomous vehicle. In some embodiments, data from the pedal/steering wheel sensors and from in-vehicle cameras may be correlated to detect a potential takeover request by the human, and to determine whether the actions are actually a requested takeover or not. For instance, a suddenly-awakened or distracted driver may actuate one or more of the brake, accelerator, or steering wheel while not intending to initiate a random takeover of control.

After detection that the requested takeover is unsafe, the control system mitigates the unsafe takeover request. This can include, for example, blocking the takeover request so that the human driver may not be allowed to control the autonomous vehicle. For instance, the steering wheel, brake actuator/pedal, and accelerator actuator/pedal may be locked during the autonomous driving mode and may be unlocked only upon the autonomous vehicle requesting a takeover by the human (which may be in response to detection that a random takeover request is safe, as described below). Further, the doors may remain locked in response to an unsafe takeover request, since, in some cases, door unlocks may only be enabled when the vehicle is in a stopped state (not moving).

In some cases, mitigation of the unsafe takeover request may include modifying the autonomous driving mode to match the driver/passenger desires. For instance, the control system may re-plan a route of the autonomous vehicle (e.g., direction, speed, etc.) to guarantee comfort of the driver/passenger and minimize risk for the passenger/driver introduced by the takeover request. In some cases, the control system may prompt the human driver and/or passengers for input in response to the takeover request (e.g., using a voice prompt (for voice recognition enabled autonomous vehicles) and/or text prompt), and may modify one or more aspects of the autonomous mode based on the input received from the driver/passenger.

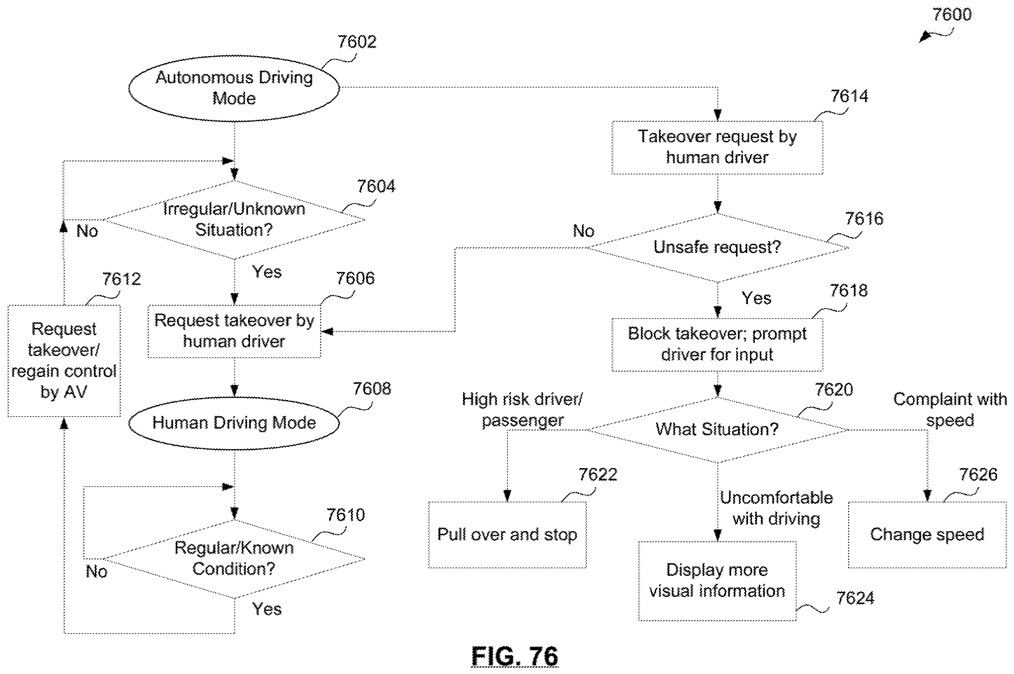

FIG. 76 is a diagram of an example process of controlling takeover requests by human drivers of an autonomous vehicle in accordance with at least one embodiment. In particular, FIG. 76 illustrates an unsafe takeover detection and mitigation scheme. Operations in the example process may be performed by components of an autonomous vehicle (e.g., a control system of an autonomous vehicle). The example process 7600 may include additional or different operations, and the operations may be performed in the order shown or in another order. In some cases, one or more of the operations shown in FIG. 76 are implemented as processes that include multiple operations, sub-processes, or other types of routines. In some cases, operations can be combined, performed in another order, performed in parallel, iterated, or otherwise repeated or performed another manner.

At 7602, an autonomous vehicle is operating in an autonomous driving mode. For example, a control system of the autonomous vehicle may be controlling one or more aspects of the operation of the autonomous vehicle, such as through a perception, plan, and act pipeline. At 7604, the autonomous vehicle determines (e.g., based on sensor data passed to the control system) whether an irregular or unknown situation is encountered. If so, at 7606, the autonomous vehicle requests that the human driver takeover control of the autonomous vehicle, and at 7608, the autonomous vehicle enters and operates in a human driving mode of operation (where a human driver controls the autonomous vehicle). The autonomous vehicle may then determine, during the human driving mode of operation, at 7610, whether a regular/known condition is encountered. If so, the autonomous vehicle may request a takeover of control or regain control of the autonomous vehicle at 7612, and may re-enter the autonomous mode of operation. If no irregular/unknown situation is encountered at 7604, the autonomous vehicle continues operation in the autonomous driving mode, whereby it may continuously determine whether it encounters an irregular/unknown situation.

At 7614, the autonomous vehicle detects a takeover request by a human driver. The takeover request may be based on sensor data from one or more sensors coupled to the autonomous vehicle, which may include sensors located inside the autonomous vehicle (e.g., sensors coupled to the steering wheel, brake actuator, accelerator actuator, or internal camera(s) or microphone(s)).

At 7616, the autonomous vehicle determines whether the takeover request is unsafe. If so, the autonomous vehicle may mitigate the unsafe takeover request in response. For example, at 7618, the autonomous vehicle may block the takeover request. In addition, the autonomous vehicle may prompt the driver for input (e.g., enable a conversation with the driver using a voice recognition software) at 7618 to understand more about the cause for takeover request or the irregular situation.

At 7620, based on input received from the driver, the autonomous vehicle determines what the situation is with the driver or the reason for the driver initiating the takeover request. If, for example, the situation is identified to be a risk for a driver or passenger (e.g., screaming, unsafe behavior, etc.), then re-planning may need to be considered for the route, and so the autonomous vehicle may modify the autonomous driving mode to pull over to stop at 7622. If, for example, the situation is identified to be discomfort with the autonomous driving mode for the driver and/or passenger (e.g., an unknown route/road, very dark environment, etc.), then the autonomous vehicle may modify the autonomous driving mode to provide more visual information to the driver/passenger (e.g., display (additional) route details; the autonomous vehicle may also adjust in-vehicle light to allow the driver to see the additional information) may be displayed at 7624 to help the driver and/or passenger attain more comfort with the autonomous driving mode. If, for example, situation is identified to be a complaint about speed (e.g., the driver would like the autonomous vehicle to slow down or speed up), then the planning phase may consider another speed and/or route and the autonomous vehicle may modify the autonomous driving mode to change the speed (or route). Other mitigation tactics may be employed in response to the driver input received.

One of the potential benefits of autonomous vehicles is the possibility of a much safer driving environment. However, despite best efforts to create an error-free system for automation, mechanical, physical, and/or electronic damage caused by wear and tear on vehicles is inevitable. Such damage may cause a malfunction of the autonomous vehicle.

Inevitably, when damage occurs to an autonomous vehicle, particularly to its sensors, the function of the vehicle can be diminished. The level of automation of an autonomous vehicle is defined relative to the amount of participation that is required from the human driver, as shown in FIG. 77. When an autonomous vehicle encounters problems, a human passenger (or a remote monitoring entity) may be required to take over driving control or the vehicle may cease operation.

Furthermore, when there are problems with a vehicle, whether the problems are sensor issues, processor or memory malfunction or any other hardware/software issues, the chances of an accident occurring increase. This can also be true if a human driver is forced to takeover control of the vehicle, especially if that driver is not prepared to takeover. The ability to track what is happening on a vehicle could prove to be invaluable to many parties. For example, insurance companies, the driver, or manufacturer of the vehicle could benefit with respect to various liability issues. Furthermore, the designers of the vehicle could benefit from an understanding of what happens in critical situations.

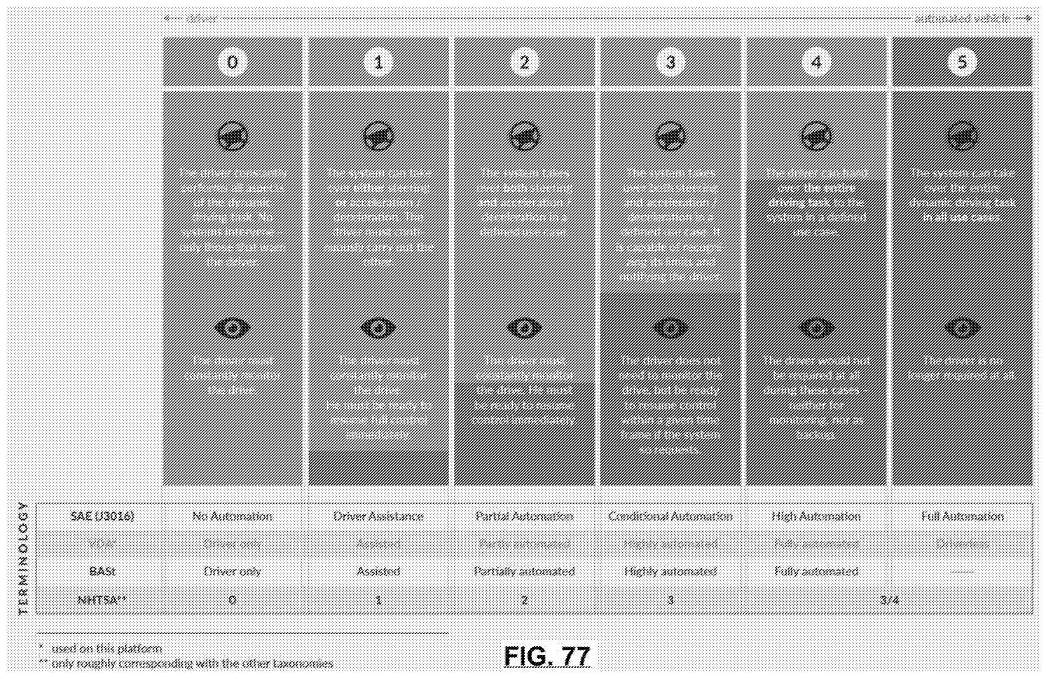

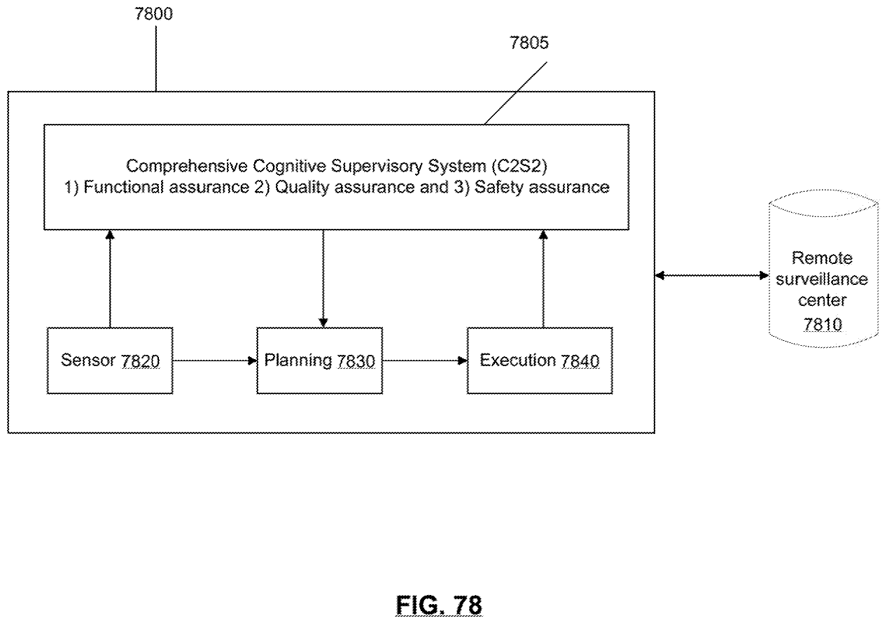

A comprehensive cognitive supervisory system 7800 is illustrated in FIG. 78. System 7800 is a computing system (such as a subsystem or implementation of the computing systems discussed herein) configured with logic to supervise and adjust the level of autonomy of a vehicle based on the continuous analysis of the driving conditions and the accuracy of the autonomous vehicle, particularly the sensing, planning, and acting layers of the autonomous vehicle. System 7800 can comprise a multi-level smart mechanism to handle problems that may arise with an autonomous vehicle by monitoring, alerting, and re-engaging a human driver and performing a safe handoff of driving control to the human driver. System 7800 can also be configured to allow remote supervision and/or control of the autonomous vehicle. System 7800 can also be considered a system to reduce the autonomy level of an autonomous vehicle, thereby relying more on a human driver in situations of sensor or component failure of the vehicle or other situations that the vehicle cannot handle.

System 7800 can monitor the level of autonomy in an autonomous vehicle. Furthermore, the system can determine whether the autonomy level is correct, and, if not, can change the autonomy level of the vehicle. In addition, if a change is required, system 7800 can alert the driver of the change. The system can also alert a remote surveillance system 7810 of the change.

The comprehensive cognitive supervisory system (C2S2) 7805 may sit on top of (e.g., may supervise) the regular automation systems of an autonomous vehicle. In one example system 7805 sits on top of the sensor (7820), planning (7830), and execution (7840) systems of the vehicle. It should be noted that, in some implementations, the C2S2 can sit on top of more or cofunction with in-vehicle computing systems of the autonomous vehicle. Particularly, the C2S2 can sit on top of any system that may affect the autonomy level of the vehicle. The system 7805 may also record the history of the autonomous driving level and the sensors health monitoring. The collected data may be very concise and accessible offline, so that it can be referred to in case of any malfunction or accident.

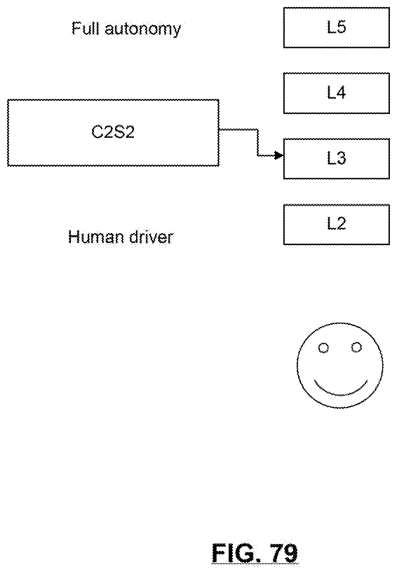

In some examples, C2S2 7805 includes logic executable to monitor the level of autonomy in the car and comprises three main modules: functional assurance, quality assurance, and safety assurance. Each of these main modules can have a set of predefined Key Performance Indicators (KPI) to accept or reject the current state of autonomy set for the vehicle. If the C2S2 determines that the level of autonomy is not acceptable due to any of the modules that are being monitored, the C2S2 can have the ability to change the autonomy level of the vehicle. Furthermore, the system will notify the human driver of the change. The ability to change the autonomy level can be very beneficial. For example, instead of completely turning off the autonomy of the vehicle if there is a sensor failure of some sort, the C2S2 can determine that the autonomy level can be lowered, as opposed to removing autonomy completely. This may mean that the vehicle goes from an L4 to an L3 level (e.g., as depicted in FIG. 79). Such a change may not require the human driver to engage the controls of the vehicle, but in some embodiments the change in autonomy may be communicated to the driver to allow the driver to pay closer attention in case he or she is needed.

Continuing with the example of FIG. 78, C2S2 7805 will evaluate the KPI of each of the three main blocks (functional assurance, quality assurance, and safety assurance) of the three systems (sensor 7820, planning 7830, and execution 7840). If the C2S2 7805 detects any problem with the systems, it can evaluate whether the autonomy level needs to be changed. Not every problem may require a change in autonomy level. For example, the vehicle may have a problem with one of the sensors. However, if this sensor produces repetitive data with respect to another sensor, the vehicle may not lose its ability to maintain its current level of autonomy.

In other examples, however, an issue with a sensor can cause a problem. Even though a manufacturer has introduced a particular vehicle capable of an L4 level of autonomy, such a designation is conditional in practice and the autonomous capability of the vehicle may vary over time. For example, when a sensor goes out of order or passenger safety gets jeopardized in scenarios like sensor/component failure, the autonomy level may have to change. C2S2 7805 can change the level of autonomy and inform both the driver and the remote surveillance system (7810).

In addition to the monitoring and changing of the autonomy level, C2S2 7805 can also report actions back to the remote surveillance system 7810. Not only can C2S2 7805 report an autonomy level change, but C2S2 7805 can report any important data to the remote system 7810. For example, in situations where there is a necessary autonomy level change, or even in situations in which there is an accident involving an autonomous vehicle, a complete record of the level change and data relating to the vehicles movements, planning, autonomy level, etc. can be sent to and stored by the surveillance system 7810. Such data can be useful in determining fault of accidents, data for improvements, etc. It is contemplated that any data that can be captured can be sent to the remote surveillance system 7810, if so desired.

The system described in FIG. 78 is merely representative of modules that may occur in particular embodiments. Other embodiments may comprise additional modules not specifically mentioned herein. In addition, not every module may be necessary, or modules may be combined in other embodiments.

Although it may be ideal to provide a completely human free driving experience with autonomous vehicles, depending on the level of autonomy in an autonomous vehicle, it may be necessary to have some human driver interaction while the vehicle is in operation. This is especially the case in an emergency, when it may be necessary for a human driver to take over the controls. In such situations, a typical handoff to a human driver, if successful, may take an average of about three seconds. However, humans are often inattentive, easily distracted, and often slow to respond to certain situations. As such, it can be challenging to keep a driver engaged while the vehicle is operating in autonomous node in order to achieve a quick and safe handoff.

Accordingly, at least in some situations, a person may be unreliable as a backup in the context of a handoff in an autonomous vehicle. If a person cannot react quickly enough, a potentially dangerous situation can be made even worse by an inattentive driver that can't react in time. Various implementations of the above systems may provide for a safer way to conduct a handoff between an autonomous driver and human driver.

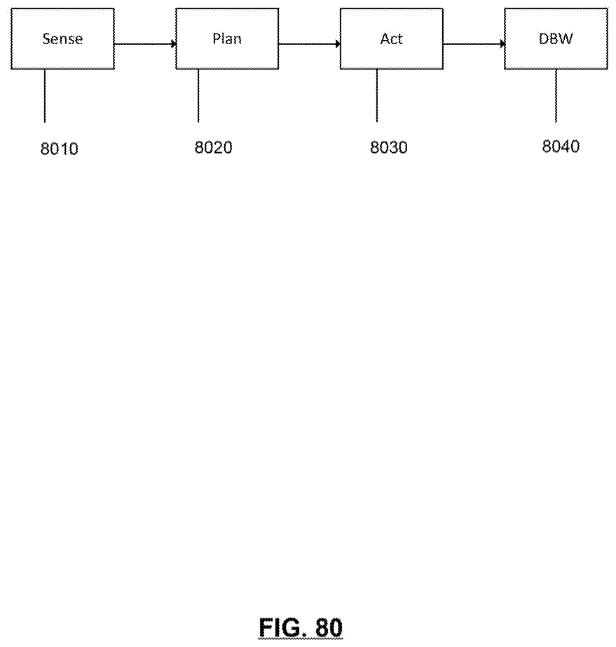

FIG. 80 illustrates an example of an architectural flow of data of an autonomous vehicle operating at an L4 autonomy level. The example flow of FIG. 80 includes a sense module 8010, a plan module 8020, an act module 8030, and a driver by wire (“DBW”) module 8040. As an example, the sense module 8010 can be responsible for processing the data from various perception sensors (e.g., cameras, radar, LIDAR, GPS, etc.). The sense module 8010 may have any suitable characteristics of sensors 225. The data output by the sense module, which can represent the vehicle's motion parameters (e.g., speed, position, orientation, etc.), along with data representing objects around the vehicle, can be passed to the plan module 8020 (which may have any suitable characteristics of path planner modules (e.g., 242), such as discussed elsewhere herein). The plan module 8020 can make relevant decisions for actions to be taken on the road while driving based on the current situation. The decision made by the plan module can be communicated to the act module 8030, which can comprise a controller, to generate specific vehicle commands to be given to the DBW module 8040. Such commands can include, for example, a specific steering angle and/or commands for acceleration. These commands are then acted out by the DBW module. It should be noted that the above flow is merely exemplary and that other flows may exist. In addition, it is possible that different levels of intelligence exist for different vehicles. For example, an L2 rated vehicle would have a different level of intelligence than an L4 rated vehicle.

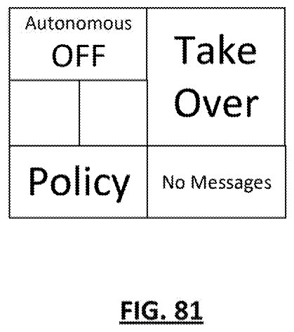

Currently in a situation in which there is a failure at one of the module levels of the example of FIG. 80, or if the planning algorithm of a vehicle is unable to take action in certain driving scenarios, the vehicle automatically will send a signal to the driver indicating that the driver is needed to take over. This signal can be visual, audio, or a combination thereof. FIG. 81 illustrates an example of a video signal to the driver.

FIG. 82 illustrates of a flow of an example autonomous vehicle handoff situation. As can be seen, at the start of the flow, the vehicle may be in autonomous mode at 8210. Once a problem is noticed and the autonomy level needs to change, a takeover signal is sent 8220. Finally, autonomous mode will be deactivated at 8230.

A handoff process that is not abrupt and sudden will help the driver engage the vehicle when necessary. In addition, it may not be necessary for the vehicle to become completely non-autonomous if there is a sensor breakdown. It may be safe to merely lower the autonomy level. For example, for an autonomous vehicle operating in L4 mode, it may not be necessary for the vehicle to handoff directly to a human driver and shutoff its autonomy. A planning algorithm (e.g., performed by planning module 8020) is dependent on multiple sensor inputs. The reliability of the autonomous system is defined by the precision with which a planning algorithm can make decisions based on these sensor inputs. Every system has its set of critical and non-critical sensor inputs which defines the confidence level of decisions being taken by planning module. An L4 level vehicle can no longer operate with the same confidence level if a subset of its sensors (primarily redundant sensors) stop operating. In an example situation, the vehicle may have simply downgraded from a L4 to L3 level of confidence, which demands a greater level of attention from the driver. However, it may not be necessary for the driver to take over completely and for the vehicle to shut off the autonomy systems.

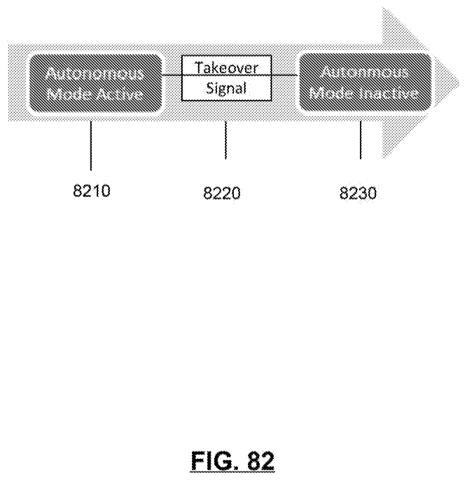

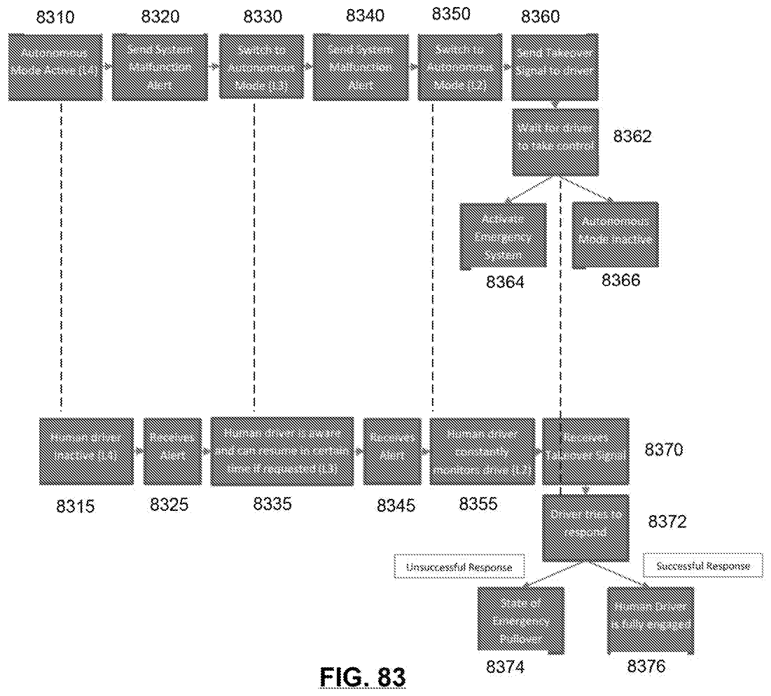

FIG. 83 illustrates an example of a flow for handing off control of an autonomous vehicle to a human driver. In addition, FIG. 83 illustrates the coordination between human reactions and the autonomous vehicle's actions. This coordination is illustrated by dotted lines. The example flow of FIG. 83 can take place in the plan module 8020 of an autonomous vehicle. It should be noted, however, that the flow of FIG. 83 may be performed by any module or combinations of a computing system, including those not mentioned herein.

The example of FIG. 83 shows initially (8310) that the autonomous vehicle is operating normally in its autonomous mode, at an L4 level for this example. As a result, the human driver is inactive (8315). This may be especially true for a high autonomy level of an autonomous vehicle.

When a problem occurs, the vehicle may send out a system malfunction alert (8320). Accordingly, the human driver will receive the alert (8325). This alert can be visual, audio, tactic, or any other type of alert.

If it is determined that the malfunction is not serious enough to need immediate driver interaction, the vehicle can switch to a lower autonomous mode (8330). In this example, the vehicle switched from L4 to L3. The human driver will accordingly be aware of this transition (e.g., based on the alert received at 8325) and may pay attention to driving conditions and can gain control of the vehicle in a certain amount of time if needed (8335). In some examples, the vehicle can confirm driver engagement though the use of certain sensors and monitoring. For example, the vehicle can use gaze monitoring, haptic feedback, audio feedback, etc.

If there is another error, the vehicle can once again send out a system malfunction alert (8340). Once again, the driver will receive that alert after it is sent (8345).

Next, if it is once again determined that the level of autonomy can be reduced again (from L3 to L2 in this example), the vehicle will lower its autonomy level again (8350). Now, in a corresponding move, the driver starts paying even closer attention (8355). In this example, the human driver will constantly pay attention because the car is in L2 mode.

If the car once again needs to lower its autonomy level, this time to L1, the driver will need to take over. Therefore, the vehicle may send out a takeover signal (8360). In a corresponding move, the driver may receive the takeover signal (8370).

Now, the vehicle may confirm whether the driver will be able to take control of the vehicle. Therefore, the vehicle will wait for the driver to take control (8362). As mentioned earlier, the vehicle can use monitoring and sensors to determine the driver's readiness state, in addition to monitoring whether the driver is actually taking control.

After a period of time, if the vehicle determines that the driver has not taken control (or is unable to safely take control), an emergency system is activated (8364). This can include performance of different actions depending on the situation. For example, it may be necessary for the vehicle to pull over. In some situations, it may not be safe to pull over and stop, so the vehicle may continue for a period of time. Therefore, the vehicle may slow down and/or pull over to one side of the road until is safe to stop. Once the emergency system is activated, correspondingly, the state of emergency action will be completed (8374).

If, however, the driver is able to take over and handoff is successful, autonomous mode can be deactivated (8366). In a corresponding action, the driver will be fully engaged and driving the vehicle (8376). As can be seen, the early alerts (multiple times before handoff is necessary) allow the driver to be ready for a handoff before system failure and it becomes imperative for the driver to take over.

An autonomous vehicle may be equipped with several sensors that produce a large amount of data, even over a relatively small period of time (e.g., milliseconds). Under the assumption of real-time data processing fashion, which is vital for such systems, the data collected at time T should be processed before the next data generated is recorded at time T+1 (where the unit 1 here is the maximum resolution of the particular sensor). For a Camera (which generally operates at 30 frames per second) and a LIDAR (which generally operates at 20 sweeps per second), 33 ms resolution and 50 ms respectively may be considered acceptable resolutions. Thus, high speed decisions are desirable. An event or situation is formed by a series of recordings over a period of time, so various decisions may be made based on a time-series problem based on the current data point as well as previous data points. In practice, a predefined processing windows is considered, as it may not be feasible to process all recorded data and the effect of recorded data over time tends to diminish.

The process of detecting patterns that do not match with the expected behaviors of sensor data is called anomaly detection. Determining the reason for an anomaly is termed anomaly recognition. Anomaly recognition is a difficult task for machine learning algorithms for various reasons. First, machine learning algorithms rely on the seen data (training phase) to estimate the parameters of the prediction model for detecting and recognizing an object. However, this is contrary to the characteristics of anomalies, which are rare events without predefined characteristics (and thus are unlikely to be included in traditional training data). Second, the concept of an anomaly is not necessarily constant and thus may not be considered as a single class in traditional classification problems. Third, the number of classes in traditional machine learning algorithms is predefined and when input data that is not relevant is received, the ML algorithm may find the most probable class and label the data accordingly, thus the anomaly may go undetected.

In various embodiments of the present disclosure, a machine learning architecture for anomaly detection and recognition is provided. In a particular embodiment, a new class (e.g., “Not known”) is added to a Recurrent Neural Network to enhance the model to enable both time-based anomaly detection and also to increase an anomaly detection rate by removing incorrect positive cases. Various embodiments may be suitable in various applications, including in object detection for an autonomous vehicle. Accordingly, in one embodiment, at least a part of the architecture may be implemented by perception engine 238.

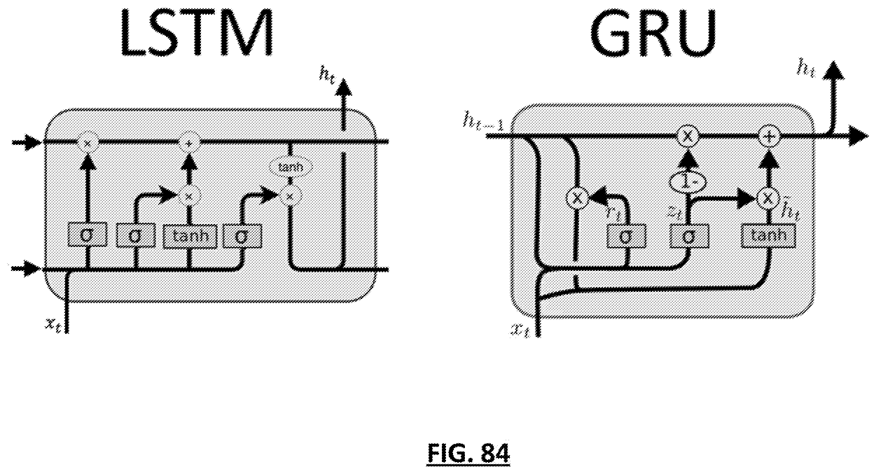

In particular embodiments, the architecture may include one or more ML models including or based on a Gated Recurrent Unit (GRU) or a Long Short Term Memory networks (LSTM) neural network. FIG. 84 represents example GRU and LSTM architectures. Such networks are popularly used for natural language processing (NLP). GRU was introduced in 2014 and has a simpler architecture than LSTM and has been used in an increasing number of applications in recent years. In the GRU architecture, both forget and input gates are merged together to form “update gates”. Also, the cell state and hidden state get combined.

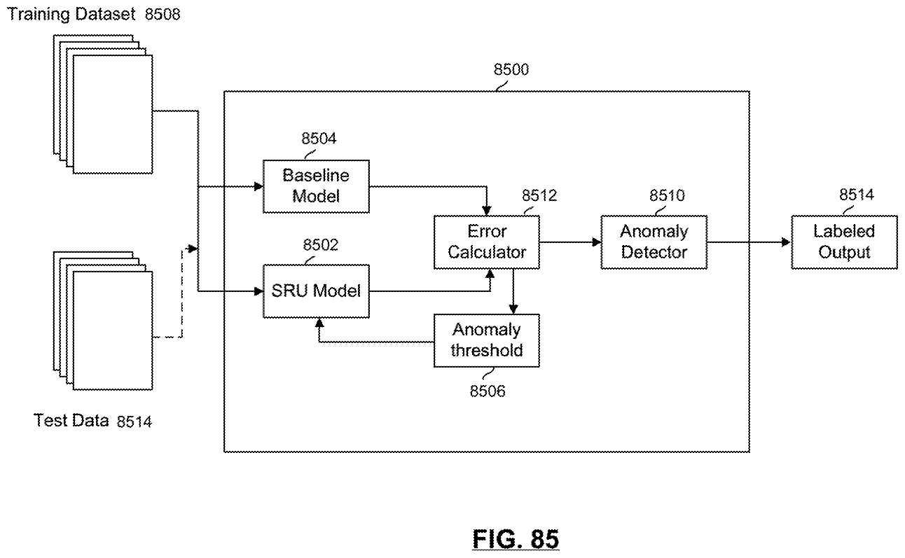

FIG. 85 depicts a system 8500 for anomaly detection in accordance with certain embodiments. The addition of an anomaly detector may enhance the intelligence of a system to enable reporting of unknown situations (e.g., time-based events) that would not have been detected previously. A new ML model based on an LSTM or GRU architecture (termed Smart Recurrent Unit (SRU) model 8502 herein) may be provided and used in conjunction with a standard LSTM or GRU model (“baseline model” 8504). In various embodiments, the architecture of the SRU model 8502 may be similar to the architecture of the baseline predictor, but may be specially tuned to detect anomalies. In various embodiments, the system 8500 is able to both encode a newly arriving sequence of anomaly data (e.g., encode the sequence as an unknown class) as well as decode a given data representation to an anomaly tag (e.g., over time, identify new anomaly classes and apply labels accordingly). Any suitable data sequence may be recognized as an anomaly by the system 8500. For example, an anomaly may be an unknown detected object or an unknown detected event sequence. In various embodiments, the addition of the SRU model may enhance the system's intelligence to report unknown situations (time-based events) that were not been seen by the system previously (either at training or test phases). The system may be able to encode a new sequence of anomaly data and assign a label to it to create a new class. When the label is generated, any given data representation to this type of anomaly may be decoded.

System 8500 demonstrates an approach to extract anomaly events on the training and inference phases. Anomaly threshold 8506 is calculated during the training phase, where the network calculates the borderline between learned, unlearned, and anomaly events. In a particular embodiment, the anomaly threshold 8506 is based on a sigmoid function used by one or both of the baseline model 8504 and the SRU model 8502. The anomaly threshold 8506 may be used to adjust parameters of the SRU model 8502 during training.

By enriching the training data set 8508 to encompass the expected normal cases, the whole network may converge to a state that only considers unknown situations as anomalies (thus anomaly samples do not need to be included in the training data set). This is the detection point when the anomaly detector 8510 will recognize that the situation cannot be handled correctly with the learned data. The training data set 8508 may include or be based on any suitable information, such as images from cameras, point clouds from LIDARs, features extracted from images or point clouds, or other suitable input data.

During training, the training dataset 8508 is provided to both the baseline model 8504 and the SRU model 8502. Each model may output, e.g., a predicted class as well as a prediction confidence (e.g., representing the assessed probability that the classification is correct). In some embodiments, the outputs may include multiple classes each with an associated prediction confidence. In some embodiments, e.g., based on GRU models, the outputs may be a time series indicative of how the output is changing based on the input. The SRU model 8502 may be more sensitive to unknown classes than the baseline model (e.g., 8504). The error calculator 8512 may determine an error based on the difference between the output of the baseline model 8504 and the output of the SRU model 8502.

During inference, test data 8514 (which in some embodiments may include information gathered or derived from one or more sensors of an autonomous vehicle) is provided to the baseline model 8504 and the SRU model 8502. If the error representing the difference between the outputs of the models is relatively high as calculated by error calculator 8512, then the system 8500 determines a class for the object was not included in the training data and an anomaly is detected. For example, during inference, the system may use anomaly detector 8510 to determine whether the error for the test data is greater than the anomaly threshold 8506. In one example, if the error is greater than the anomaly threshold 8506, an anomaly class may be assigned to the object.

In various embodiments, the anomaly detector 8510 may assign a catchall label of unknown classes to the object. In another embodiment, the anomaly detector 8510 may assign a specific anomaly class to the object. In various embodiments, the anomaly detector may assign various anomaly classes to various objects. For example, a first anomaly class may be assigned to each of a first plurality of objects having similar characteristics, a second anomaly class may be assigned to each of a second plurality of objects having similar characteristics, and so on. In some embodiments, a set of objects may be classified as a catchall (e.g., default) anomaly class, but once the system 8500 recognizes similar objects as having similar characteristics, a new anomaly class may be created for such objects.

The labeled output 8514 indicates the predicted class (which may be one of the classes of the training dataset or an anomaly class). In various embodiments, the labeled output may also include a prediction confidence for the predicted class (which in some cases may be a prediction confidence for an anomaly class).

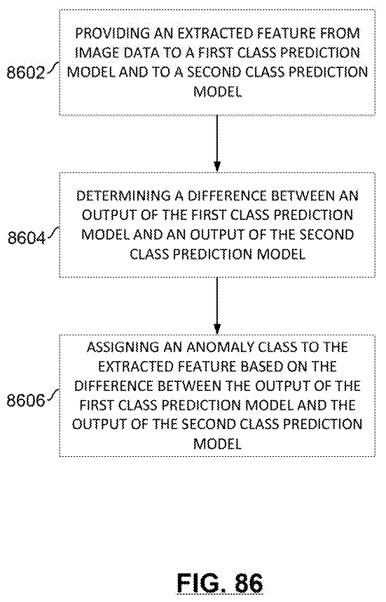

FIG. 86 depicts a flow for detecting anomalies in accordance with certain embodiments. At 8602, an extracted feature from image data is provided to a first-class prediction model and to a second-class prediction model. At 8604, a difference between an output of the first-class prediction model and an output of the second-class prediction model is determined. At 8606, an anomaly class is assigned to the extracted feature based on the difference between the output of the first-class prediction model and the output of the second-class prediction model.

Autonomous vehicles vary greatly in their characteristics. For example, the level of autonomy of vehicles can range from L1 to L5. As a further example, vehicles can have a wide variety of sensors. Examples of such sensors include LIDAR, cameras, GPS, ultrasound, radar, hyperspectral sensors, inertial measurement units, and other sensors described herein. In addition, vehicles can vary as to the number of each type of sensor with which they are equipped. For example, a particular vehicle may have two cameras, while another vehicle has twelve cameras.

In addition, vehicles have different physical dynamics and are equipped with different control systems. One manufacturer may have a different in-vehicle processing system with a different control scheme than another manufacturer. Similarly, different models from the same manufacturer, or even different trim levels of the same model vehicle, could have different in-vehicle processing and control systems. Furthermore, different types of vehicles may implement different computer vision or other computing algorithms, therefore, the vehicles may respond differently from one another in similar situations.

Given the possible differences between the autonomous vehicles (e.g., autonomy level, sensors, algorithms, processing systems, etc.,) there will be differences between the relative safety levels of the different vehicles. These differences may also be dependent on the portion of the road upon which each vehicle is traveling. In addition, different vehicles may be better at handling certain situations than others, such as, for example, inclement weather.

Since current autonomous vehicles are not capable of handling every situation that they may encounter, especially in every type of condition that they may encounter, it may be valuable to determine whether an autonomous vehicle has the capability of handling a portion of a road in the current conditions.

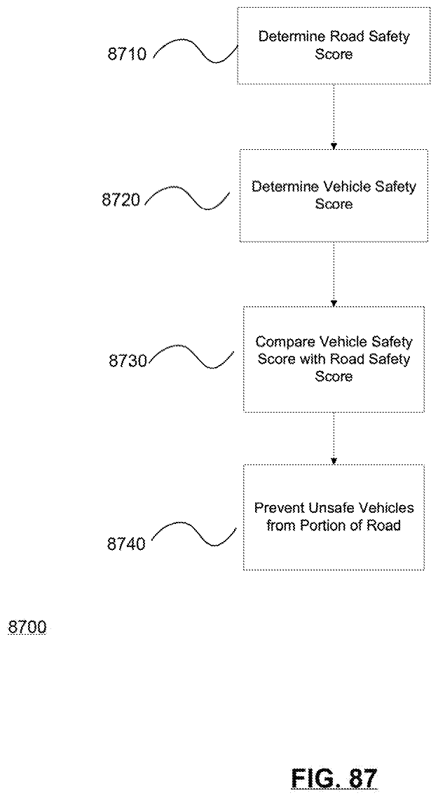

FIG. 87 illustrates an example of a method 8700 of restricting the autonomy level of a vehicle on a portion of a road, according to one embodiment. Method 8700 can be considered a method of dynamic geo-fencing using an autonomous driving safety score.

Method 8700 includes determining a road safety score for a portion of a road at 8710. This may comprise determining an autonomous driving safety score limit for a portion of a road. This road safety score can be a single score calculated by weighting and scoring driving parameters critical to the safety of autonomous vehicles. This score can represent the current safety level for an area of the road. This score can be a standardized value, which means that this value is the same for every individual autonomous vehicle on the road. In some embodiments, this safety score can be dynamic, changing constantly depending on the current conditions of a specific area of the road. Examples of criteria that can be used in the calculation of the score can include, but are not limited to: the weather conditions, time of day, the condition of the driving surface, the number of other vehicles on the road, the percentage of autonomous vehicles on the road, the number of pedestrians in the area, and whether there is construction. Any one or more of these conditions or other conditions that can affect the safety of an autonomously driven vehicle on that portion of the road can be considered in determining the road score. In some examples, the score criteria can be determined by a group of experts and/or regulators. The criteria can be weighted to allow certain conditions to affect the safety score more than others. In one example, the safety score can range from 0 to 100, although any set of numbers can be used or the safety score may be expressed in any other suitable manner.

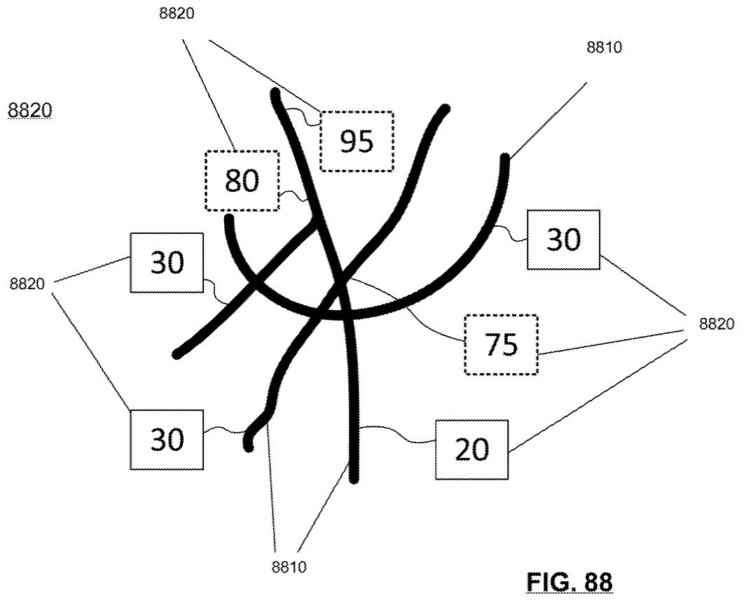

FIG. 88 illustrates an example of a map 8800 wherein each area of the roadways 8810 listed shows a road safety score 8820 for that portion of the road. This map can be displayed by a vehicle in a similar fashion to current GPS maps, wherein traffic and speed limit are displayed on the maps. In some examples, the mapping system (e.g., path planner module 242) can calculate the safety score based on inputs from sensors or other data in the geographic region of the road. In other examples, the score may be calculated externally to the vehicle (e.g., by 140 or 150) and the score is transmitted to the vehicle.

Method 8700 further includes determining a safety score for a vehicle at 8720. This safety score can be considered an autonomous vehicle safety score. The safety score can be used to represent the relative safety of an autonomous vehicle and may be used to determine the score limit of the roads that a car can drive on autonomously. Similar to the road safety score, the vehicle safety score may be a single score calculated by weighting important safety elements of the vehicle. Examples of criteria to be considered for the vehicle safety score can include: the type of sensors on the vehicle (e.g., LIDAR, cameras, GPS, ultrasound, radar, hyperspectral sensors, and inertial measurement units), the number of each sensor, the quality of the sensors, the quality of the driving algorithms implemented by the vehicle, the amount of road mapping data available, etc. Testing of each type of vehicle can be conducted by experts/regulators to determine each vehicle's safety score (or a portion thereof). In one example, a vehicle with advanced algorithms and a very diverse set of sensors can have a higher score, such as 80 out of 100. Another vehicle with less advanced algorithms and a fewer number and types of sensors will have a lower score, such as 40 out of 100.

Next, method 8700 includes comparing the vehicle safety score with the road safety score at 8730. the comparison may include a determination of whether an autonomous vehicle is safe enough to be autonomously driven on a given portion of a road. For example, if the road has a safety score of 95 and the car has a score of 50, the car is not considered safe enough to be driven autonomously on that stretch of the road. However, once the safety score of the road lowers to 50 or below, the car can once again be driven autonomously. If the car is not safe enough to be driven autonomously, the driver should take over the driving duties and therefor the vehicle may alert the driver of a handoff. In some examples, there can be a tiered approach to determining whether a car is safe enough to be driven autonomously. For example, the road can have multiple scores: an L5 score, an L4 score, and L3 score, etc. In such examples, the car safety score can be used to determine what level of autonomy an individual vehicle may use for a given portion of the road. If the car has a score of 50, and that score is within a range of scores suitable for L4 operation, the vehicle may be driven with an L4 level of autonomy.

Finally, method 8700 concludes with preventing autonomous vehicles from unsafe portions of a road at 8740. This may include alerting a vehicle that it is not capable of being driven autonomously on a particular stretch of road. Additionally or alternatively, this may include alerting the driver that the driver needs to take over the driving duties and handing over the drive duties to the driver once the driver is engaged. If the road has a tiered scoring level, as mentioned above, the proper autonomy level of the vehicle may be determined and an alert that the autonomous level is going to be dropped and the driver must engage or be prepared to engage may be provided, depending on the level of autonomy that is allowed for that vehicle on a particular portion of the road.

Image and video data may be collected by a variety of actors within a driving environments, such as by mobile vehicles (e.g., cars, buses, trains, drones, subways, etc.) and other transportation vehicles, roadside sensors, pedestrians, and other sources. Such image and video data is likely to sometimes contain images of people. Such images may be obtained, for example, by an outward or inward facing image capturing device mounted on a vehicle, or by data transmission of images from other electronic devices or networks to a computing system integrated with the vehicle. This data could be used to identify people and their locations at certain points in time, causing both safety and privacy concerns. This is particularly problematic when the images depict children or other vulnerable persons.

In some implementations, an example autonomous driving system (including in-vehicle autonomous driving systems and support systems implemented in the cloud or the fog) may utilize machine learning models to disguise faces depicted in images captured by a camera or other image capturing device integrated in or attached to vehicles. In an example embodiment, a trained Generative Adversarial Network (GAN) may be used to perform image-to-image translations for multiple domains (e.g., facial attributes) using a single model. The trained GAN model may be tested to select a facial attribute or combination of facial attributes that, when transferred to a known face depicted in an image to modify (or disguise) the known face, cause a face detection model to fail to identify the known face in the modified (or disguised) face. The trained GAN model can be configured with the selected facial attribute or combination of facial attributes. The configured GAN model can be provisioned in a vehicle to receive images captured by an image capturing device associated with the vehicle or other images received by a computing system in the vehicle from other electronic devices or networks. The configured GAN model can be applied to a captured or received image that depicts a face in order to disguise the face while retaining particular attributes (or features) that reveal information about the person associated with the face. Such information could include, for example, the gaze and/or emotion of the person when the image was captured.

As smart driving systems implemented in mobile vehicles have become more sophisticated, and even partially or fully autonomous, the amount and quality of image and video data collected by these mobile vehicles have increased significantly. Image and video data may be collected by any type of mobile vehicle including, but not necessarily limited to cars, buses, trains, drones, boats, subways, planes, and other transportation vehicles. The increased quality and quantity of image and video data obtained by image capturing devices mounted on mobile vehicles, can enable identification of persons captured in the image and video data and can reveal information related to the locations of such persons at particular points in time. Such information raises both safety and privacy concerns, which can be particularly troubling when the captured data includes children or other vulnerable individuals.

In the case of autonomous vehicles, image and video data collected by vehicles (e.g., up to 5 TB/hour) can be used to train autonomous driving machine learning (ML) models. These models aim at understanding the scene around the vehicle, detecting objects and pedestrians as well as predicting their trajectory.

In some geographies (e.g., the European Union, some states within the United States of America, etc.) identifying information is protected and stiff financial penalties may be levied on any entity retaining that protected information. Moreover, knowing that transportation vehicles are continuously collecting this data may affect the public trust and the adoption of autonomous vehicles, and may even negatively affect public sentiment towards service vehicles. Consequently, if left unaddressed, these user privacy issues could potentially hinder the adoption of at least some autonomous vehicle technology.

One approach to preserving privacy of image and video data is to blur or pixelate faces in the data. While blurring and pixilation can work in cases where basic computer vision algorithms are employed with the goal of detecting a person holistically, these approaches do not work with modern algorithms that aim at understanding a person's gaze and intent. Such information may be particularly useful and even necessary for example, when an autonomous car encounters a pedestrian and determines a reaction (e.g., slow down, stop, honk the horn, continue normally, etc.) based on predicting what the pedestrian is going to do (e.g., step into cross-walk, wait for the light to change, etc.). The gaze and intent of pedestrians are being increasingly researched to increase the “intelligence” built into vehicles. By detecting gaze and intent from a pedestrian's face, intelligence algorithms aim to predict the pedestrian trajectory and hence avoid accidents. For example, a pedestrian looking at his phone is more likely to miss a passing vehicle than another pedestrian looking directly at the vehicle. Machine learning algorithms need to extract some landmarks from the face to predict gaze. Blurring or pixelating a face renders this task impractical.

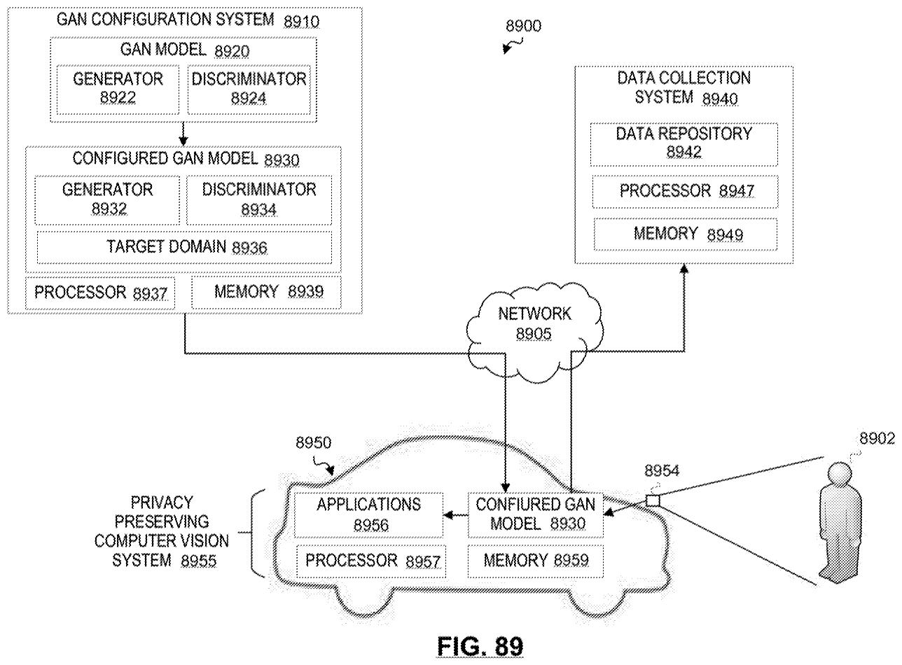

A communication system 8900, as shown in FIG. 89, resolves many of the aforementioned issues (and more). In at least one embodiment, a privacy-preserving computer vision system employs a Generative Adversarial Network (GAN) to preserve privacy in computer vision applications while maintaining the utility of the data and minimally affecting computer vision capabilities. GANs are usually comprised of two neural networks, which may be referred to herein as a “generator” (or “generative model”) and a “discriminator” (or “discriminative model”). The generator learns from one (true) dataset and then tries to generate new data that resembles the training dataset. The discriminator tries to discriminate between the new data (produced by the generator) and the true data. The generator's goal is to increase the error rate of the discriminative network (e.g., “fool” the discriminator network) by producing novel synthesized instances that appear to have come from the true data distribution.

At least one embodiment may use a pre-trained GAN model that specializes in facial attributes transfer. In communication system 8900, the pre-trained GAN model can be used to replace facial attributes in images of real people with a variation of those attributes while maintaining facial attributes that are needed by other machine learning capabilities that may be part of a vehicle's computer vision capabilities. Generally, the GAN model is pre-trained to process an input image depicting a face (e.g., a digital image of a real person's face) to produce a new image depicting the face with modifications or variations of attributes. This new image is referred to herein as a ‘disguised’ face or ‘fake’ face. Communication system 8900 may configure the pre-trained GAN model with one or more selected domain attributes (e.g., age, gender) to control which attributes or features are used to modify the input images.

The configured GAN model can be provisioned in a vehicle having one or more image capturing devices for capturing images of pedestrians, other vehicle operators, passengers, or any other individuals who come within a certain range of the vehicle. When an image of a person is captured by one of the vehicle's image capturing devices, the image may be prepared for processing by the configured GAN model. Processing may include, for example, resizing the image, detecting a face depicted in the image, and aligning the face. The processed image may be provided to the pre-configured GAN model, which modifies the face depicted in the image based on the pre-configured domain attributes (e.g., age, gender). The generator of the GAN model produces the new image depicting a modified or disguised face and provides it to other vehicle computer vision applications and/or to data collection repositories (e.g., in the cloud) for information gathering or other purposes, without revealing identifying information of the person whose face has been disguised. The new image produced by the GAN model is referred to herein as ‘disguised image’ and ‘fake image’.

Communication system 8900 may provide several example potential advantages. The continued growth expected for autonomous vehicle technology is likely to produce massive amounts of identifiable images in everyday use. Embodiments described herein address privacy concerns of photographing individuals while maintaining the utility of the data and minimally affecting computer vision capabilities. In particular, embodiments herein can render an image of a person's face unrecognizable while preserving the facial attributes needed in other computer vision capabilities implemented in the vehicle. User privacy can have both societal and legal implications. For example, without addressing the user privacy issues inherent in images that are captured in real time, the adoption of the computer vision capabilities may be hindered. Because embodiments herein mitigate user privacy issues of autonomous vehicles (and other vehicles with image capturing devices), embodiments can help increase trust in autonomous vehicles and facilitate the adoption of the technology as well as helping vehicle manufacturers, vehicle owners, and wireless service providers to comply with the increasing number of federal, state, and/or local privacy regulations.

Turning to FIG. 89, FIG. 89 illustrates communication system 8900 for preserving privacy in computer vision systems of vehicles according to at least one embodiment described herein. Communication system 8900 includes a Generative Adversarial Network (GAN) configuration system 8910, a data collection system 8940, and a vehicle 8950. One or more networks, such as network 8905, can facilitate communication between vehicle 8950 and GAN configuration system 8910 and between vehicle 8950 and data collection system 8940.

GAN configuration system 8910 includes a GAN model 8920 with a generator 8922 and a discriminator 8924. GAN model 8920 can be configured with a selected target domain, resulting in a configured GAN model 8930 with a generator 8932, a discriminator 8934, and a target domain 8936. GAN model 8920 also contains appropriate hardware components including, but not necessarily limited to a processor 8937 and a memory 8939, which may be realized in numerous different embodiments.

The configured GAN model can be provisioned in vehicles, such as vehicle 8950. In at least one embodiment, the configured GAN model can be provisioned as part of a privacy-preserving computer vision system 8955 of the vehicle. Vehicle 8950 can also include one or more image capturing devices, such as image capturing device 8954 for capturing images (e.g., digital photographs) of pedestrians, such as pedestrian 8902, other drivers, passengers, and any other persons proximate the vehicle. Computer vision system 8955 can also include applications 8956 for processing a disguised image from configured GAN model 8930 to perform evaluations of the image and to take any appropriate actions based on particular implementations (e.g., driving reactions for autonomous vehicles, sending alerts to driver, etc.). Appropriate hardware components are also provisioned in vehicle 8950 including, but not necessarily limited to a processor 8957 and a memory 8959, which may be realized in numerous different embodiments.

Data collection system 8940 may include a data repository 8942 for storing disguised images produced by configured GAN model 8930 when provisioned in a vehicle. The disguised images may be stored in conjunction with information related to image evaluations and/or actions taken by computer vision system 8952. In one example implementation, data collection system 8940 may be a cloud processing system for receiving vehicle data such as disguised images and potentially other data generated by autonomous vehicles. Data collection system 8940 also contains appropriate hardware components including, but not necessarily limited to a processor 8947 and a memory 8949, which may be realized in numerous different embodiments.

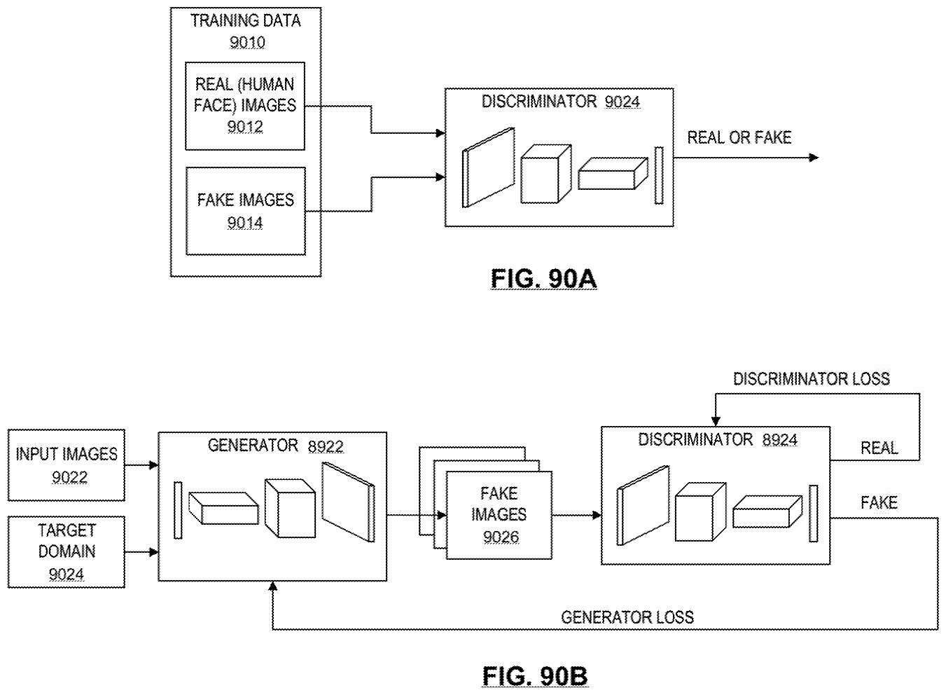

FIGS. 90A and 90B illustrate example machine learning phases for a Generative Adversarial Network (GAN) to produce a GAN model (e.g., 8920), which may be used in embodiments described herein to effect facial attribute transfers to a face depicted in a digital image.

In FIG. 90A, an initial training phase is shown for discriminator 8924. In one example, discriminator 8924 may be a standard convolutional neural network (CNN) that processes images and learns to classify those images as real or fake. Training data 9010 may include real images 9012 and fake images 9014. The real images 9012 depict human faces, and the fake images 9014 depict things other than human faces. The training data is fed to discriminator 8924 to apply deep learning (e.g., via a convolutional neural network) to learn to classify images as real faces or fake faces.

Once the discriminator is trained to classify images of human faces as real or fake, the GAN may be trained as shown in FIG. 90B. In one example, generator 8922 may be a deconvolutional (or inverse convolutional) neural network. Generator 8922 takes an input image from input images 9022 and transforms it into a disguised (or fake) image by performing facial attribute transfers based on a target domain 9024. In at least one embodiment, the domain attribute is spatially replicated and concatenated with the input image. Generator 8922 attempts to generate fake images 9026 that cannot be distinguished from real images by the discriminator.

Discriminator 8924, which was trained to recognize real or fake human faces as shown in FIG. 90A, receives the fake images 9026 and applies convolutional operations to the fake image to classify it as “real” or “fake”. Initially, the generator may produce fake images with a high loss value. Backpropagation of the generator loss can be used to update the generator's weights and biases to produce more realistic images as training continues. When a fake image “tricks” the discriminator into classifying it as “real”, then backpropagation is used to update the discriminator's weights and biases to more accurately distinguish a “real” human face from a “fake” (e.g., produced by the generator) human face. Training may continue as shown in FIG. 90B until a threshold percentage of fake images have been classified as real by the discriminator.

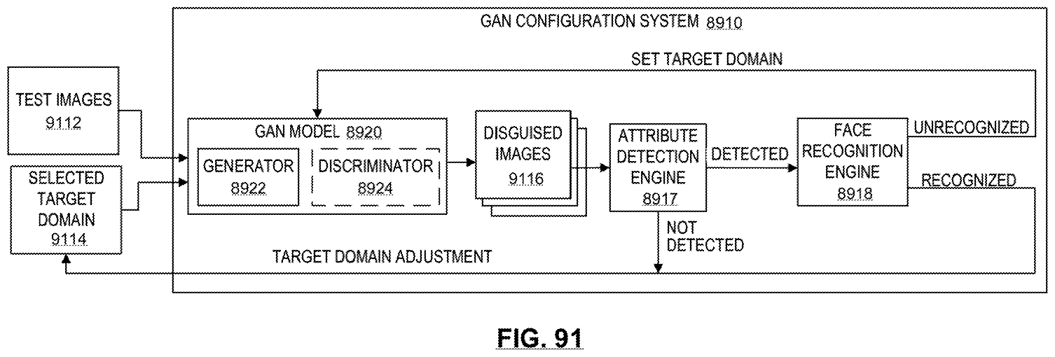

FIG. 91 illustrates additional possible component and operational details of GAN configuration system 8910 according to at least one embodiment. In GAN configuration system 8910, a target domain can be identified and used to configure GAN model 8920. A target domain indicates one or more attributes to be used by the GAN model to modify a face depicted in an input image. Certain other attributes that are not in the target domain are not modified, and therefore, are preserved in the disguised image produced by generator 8922 of the GAN model. For example, in vehicle technology, attributes that may be desirable to preserve include a gaze attribute, which can indicate the intent of the person represented by the face. A trajectory of the person can be determined based on the person's gaze and deduced intent. Another attribute that may be useful in vehicle technology is emotion. Emotion indicated by a face in a captured image can indicate whether the person represented by the face is experiencing a particular emotion at a particular time (e.g., is the passenger of a ride-sharing service pleased or not, is a driver of another vehicle showing signs of road rage, is a pedestrian afraid or agitated, etc.). Although any facial attributes may be preserved, for ease of illustration, the GAN configuration system 8910 shown in FIG. 91 will be described with reference to configuring GAN model 8920 with an optimal target domain that leaves the gaze and emotion attributes in a face unchanged, without requiring retention of other identifying features of the face.

In at least one embodiment, a target domain used for image transformation can be selected to achieve a maximum identity disguise while maintaining the gaze and/or emotion of the face. For example, an optimal target domain may indicate one or more attributes that minimizes the probability of recognizing a person while maintaining their gaze and emotional expression as in the original image or substantially like the original image. FIG. 91 illustrates one possible embodiment to determine an optimal target domain.

GAN configuration system 8910 includes GAN model 8920, an attribute detection engine 8917 (e.g., an emotion detection module and/or a gaze detection module), and a face recognition engine 8918. GAN model 8920 is pre-trained to modify a face depicted in an image to produce a new disguised image (e.g., disguised images 9116) by transferring one or more facial attributes to the face. The particular facial attributes to be transferred are based on a selected target domain 9114 provided to the generator of the GAN model. Any number of suitable GAN models may be used, including for example, StarGAN, IcGAN, DIAT, or CycleGAN.

In order to configure GAN model 8920 with an optimal target domain for anonymizing a face while simultaneously preserving desired facial attributes (e.g., gaze and intent, emotion), test images 9112 along with selected target domain 9114 can be fed into generator 8922 of GAN model 8920. For a given test image, generator 8922 can produce a disguised image (e.g., disguised images 9116), in which the attributes in the test image that correspond to the selected target domain 9114 are modified. For example, if the selected target domain includes attribute identifiers for “aged” and “gender”, then the face depicted in the disguised image is modified from the test image to appear older and of the opposite gender. Other attributes in the face such as gaze and emotion, however, remain unchanged or at least minimally changed.

In at least one embodiment, attribute detection engine 8917 may be provided to evaluate whether the desired attributes are still detectable in the disguised images 9116. For example, an emotion detector module may evaluate a disguised image to determine whether the emotion detected in the modified face depicted the disguised image is the same (or substantially the same) as the emotion detected in its corresponding real face depicted in the test image (e.g., 9112). In another example, a gaze detector module may evaluate a disguised image to determine whether the gaze detected in the modified face depicted in the disguised image is the same (or substantially the same) as the gaze detected in its corresponding real image depicted in the test image. Accordingly, in at least some embodiments, test images 9112, or labels specifying the attributes indicated in the test images (e.g., happy, angry, distracted, direction of gaze, etc.), may also be provided to attribute detection engine 8917 to make the comparison. Other desired attributes may also be evaluated to determine whether they are detectable in the disguised images. If the desired one or more attributes (e.g., emotion, gaze) are not detected, then a new target domain indicating a new attribute or a set of new attributes may be selected for input to generator 8922. If the desired one or more attributes are detected, however, then the disguised image may be fed to face recognition engine 8918 to determine whether the disguised face is recognizable.

Face recognition engine 8918 may be any suitable face recognition software that is configured or trained to recognize a select group of people (e.g., a group of celebrities). For example, Celebrity Endpoint is a face recognition engine that can detect more than ten thousand celebrities and may be used in one or more testing scenarios described herein, where the test images 9112 are images of celebrities that are recognizable by Celebrity Endpoint. In at least one scenario, prior to GAN model 8920 processing test images 9112, these test images can be processed by face recognition engine 8918 to ensure that they are recognizable by the face recognition engine. In another scenario, certain images that are recognizable by face recognition engine 8918 may be accessible to GAN configuration system 8910 for use as test images 9112.

Once a disguised image is generated (and the desired attributes are still detectable in the disguised image), the disguised image can be fed to face recognition engine 8918 to determine whether a person can be identified from the disguised image. If the face recognition engine recognizes the person from the disguised image, then the generator did not sufficiently anonymize the face. Thus, a new target domain indicating a new attribute or a set of new attributes may be selected for input to generator 8922. If the face recognition engine does not recognize the person from the disguised image, however, then the selected target domain that was used to generate the disguised image is determined to have successfully anonymized the face, while retaining desired attributes. In at least one embodiment, once a threshold number (or percentage) of images have been successfully anonymized with desired attributes being preserved, the selected target domain that successfully anonymized the image may be used to configure the GAN model 8920. In one example, the selected target domain may be set as the target domain of GAN model 8920 to use in a real-time operation of an autonomous vehicle.

It should be apparent that some of the activities in GAN configuration system 8910 may performed by user action or may be automated. For example, new target domains may be selected for input to the GAN model 8920 by a user tasked with configuring the GAN model with an optimal target domain. In other scenarios, a target domain may be automatically selected. Also, although visual comparisons may be made of the disguised images and the test images, such manual efforts can significantly reduce the efficiency and accuracy of determining whether the identity of a person depicted in an image is sufficiently disguised and whether the desired attributes are sufficiently preserved such that the disguised image will be useful in computer vision applications.

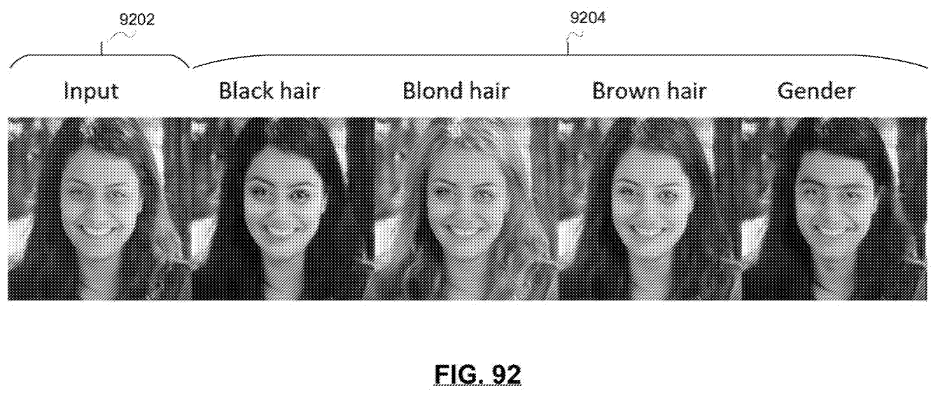

FIG. 92 shows example disguised images 9204 generated by using a StarGAN based model to modify different facial attributes of an input image 9202. The attributes used to modify input image 9202 include hair color (e.g., black hair, blond hair, brown hair) and gender (e.g., male, female). A StarGAN based model could also be used to generate images with other modified attributes such as age (e.g., looking older) and skin color (e.g., pale, brown, olive, etc.). In addition, combinations of these attributes could also be used to modify an image including H+G (e.g., hair color and gender), H+A (e.g., hair color and age), G+A (e.g., gender and age), and H+G+A (e.g., hair color, gender, and age). Other existing GAN models can offer attribute modifications such as reconstruction (e.g., change in face structure), baldness, bangs, eye glasses, heavy makeup, and a smile. One or more of these attribute transformations can be applied to test images, and the transformed (or disguised images) can be evaluated to determine the optimal target domain to be used to configure a GAN model for use in a vehicle, as previously described herein.

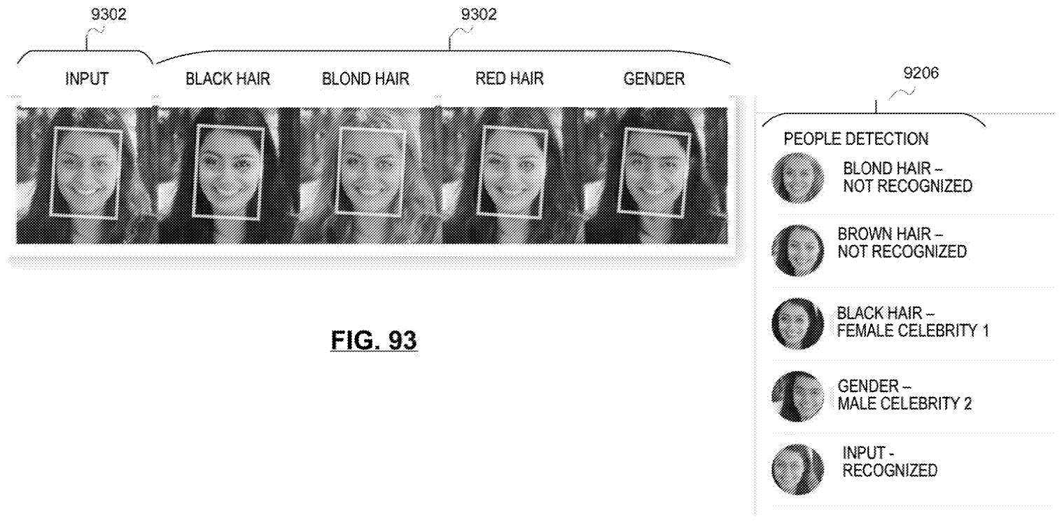

FIG. 93 shows example disguised images 9304 generated by a StarGAN based model from an input image 9302 of a real face and results of a face recognition engine (e.g., 8918) that evaluates the real and disguised images. Disguised images 9304 are generated by changing different facial attributes of input image 9302. The attributes used to modify the input image 9302 in this example include black hair, blond hair, brown hair, and gender (e.g., male). The use of the face recognition engine illustrates how the images generated from a GAN model can anonymize a face. For instance, an example face recognition engine recognizes celebrities. Accordingly, when a non-celebrity input image is processed by the face recognition engine, the results may indicate that the input image is not recognized or potentially may mis-identify the non-celebrity input image. Results 9306 of the face recognition engine, shown in FIG. 93, indicate that the person represented by input image 9302 is not a celebrity that the face recognition engine has been trained to recognized. However, the face recognition engine mis-identifies some of the disguised images 9304. For example, results 9306 indicate that the disguised image with black hair is recognized as female celebrity 1 and the disguised image with a gender flip is recognized as male celebrity 2. Furthermore, it is notable that when gender is changed, the face recognition engine recognizes the disguised image as depicting a person from the opposite gender, which increases protection of the real person's privacy.

In other testing scenarios, input images may include celebrities that are recognizable by the face recognition engine. These input images of celebrities may be fed through the GAN model and disguised based on selected target domains. An optimal target domain may be identified based on the face recognition engine not recognizing a threshold number of the disguised images and/or incorrectly recognizing a threshold number of the disguised images, as previously described herein.

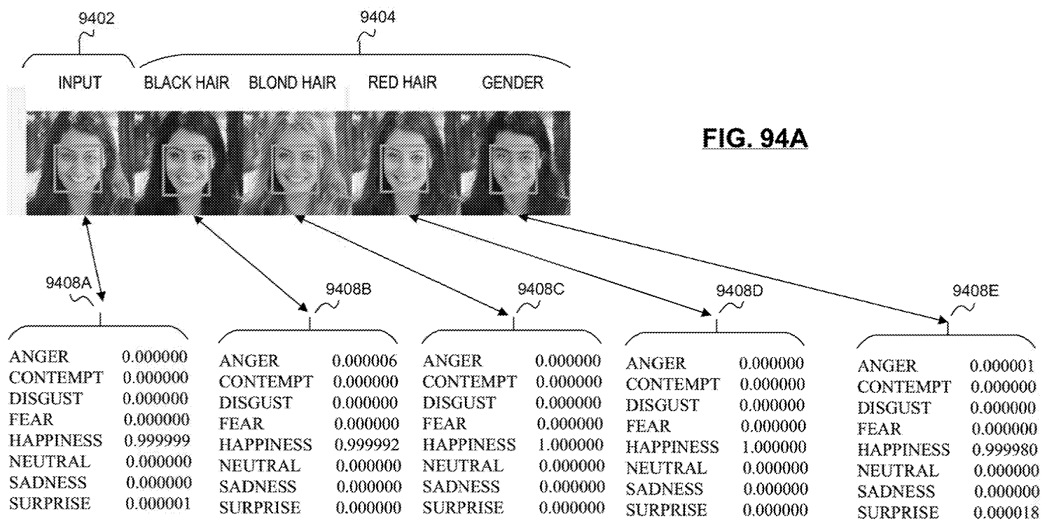

FIG. 94A shows example disguised images 9404 generated by a StarGAN based model from an input image 9402 of a real face and results of an emotion detection engine that evaluates the real and the disguised images. Disguised images 9404 are generated by changing different facial attributes of input image 9402. The attributes used to modify the input image 9402 include black hair, blond hair, brown hair, and gender (e.g., male). FIG. 94A also shows example results 9408A-9408E of an emotion detection engine. One example emotion detection engine may take a facial expression in an image as input, and detects emotions in the facial expression. As shown in results 9408A-9408E, the emotions of anger, contempt, disgust, fear, neutral, sadness, and surprise are largely undetected by the emotion detection engine, with the exception of minimal detections of anger in results 9408B for the disguised image with black hair, and minimal detections of anger and surprise in results 9408E for the disguised image with a gender flip. Instead, the engine strongly detects happiness in the input image and in every disguised image. FIG. 94A shows that, despite failing to recognize a person, the GAN model's disguise approach preserved the emotion from input image 9402 in each of the disguised images 9404.

FIG. 94B a listing 9450 of input parameters and output results that correspond to the example processing of the emotion detection engine for input image 9402 and disguised images 9404 illustrated in FIG. 94A.

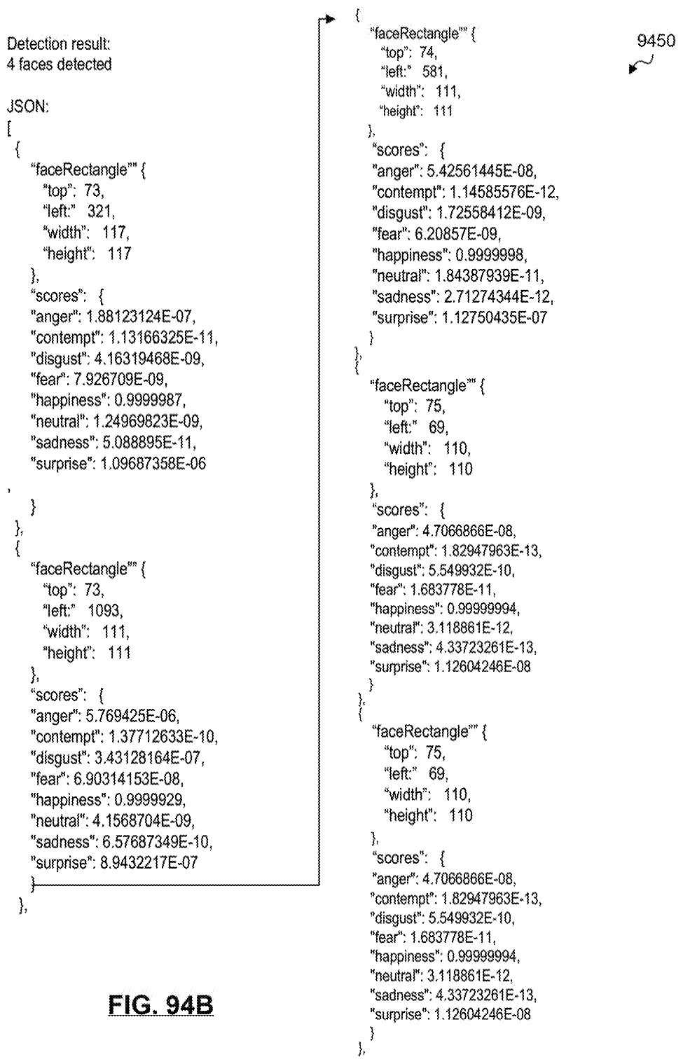

FIG. 95 shows an example transformation of an input image 9510 of a real face to a disguised image 9520 as performed by an IcGAN based model. In FIG. 95, the gaze of the person in the input image, highlighted by frame 9512, is the same or substantially the same in the disguised image, highlighted by frame 9522. Although the face may not be recognizable as the same person because certain identifying features have been are modified, other features of the face such as the gaze, are preserved. In an autonomous vehicle scenario, preserving the gaze in an image of a face enables the vehicle's on-board intelligence to predict and project the trajectory of a walking person based on their gaze, and to potentially glean other valuable information from the preserved features, without sacrificing the privacy of the individual.

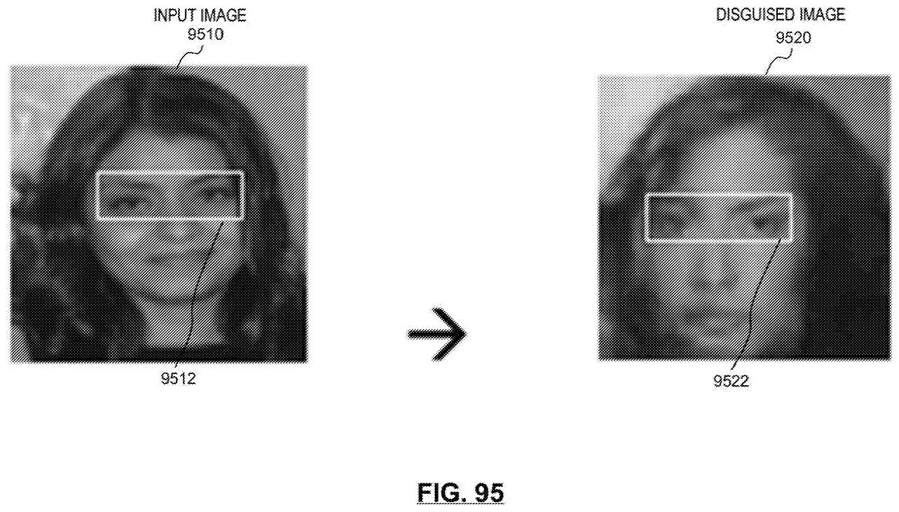

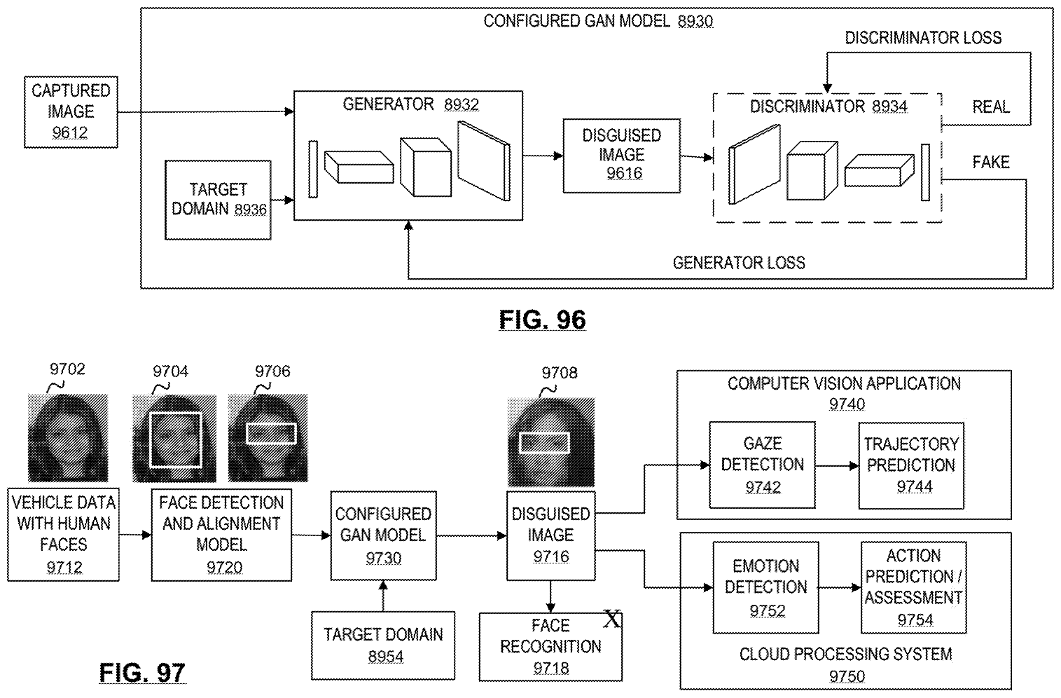

FIG. 96 illustrates additional possible operational details of a configured GAN model (e.g., 8930) implemented in a vehicle (e.g., 8950). Configured GAN model 8930 is configured with target domain 8936, which indicates one or more attributes to be applied to captured images. In at least one embodiment, target domain 8936 can include one or more attribute identifiers representing attributes such as gender, hair color, age, skin color, etc. In one example, generator 8932 can transfer attributes indicated by target domain 8936 to a face depicted in a captured image 9612. The result of this attribute transfer is a disguised image 9616 produced by the generator 8932. In one nonlimiting example, target domain 8936 includes gender and age attribute identifiers.

Captured image 9612 may be obtained by a camera or other image capturing device mounted on the vehicle. Examples of possible types of captured images include, but are not necessarily limited to, pedestrians, bikers, joggers, drivers of other vehicles, and passengers within the vehicle. Each of these types of captured images may offer relevant information for a computer vision system of the vehicle to make intelligent predictions about real-time events involving persons and other vehicles in close proximity to the vehicle.

Disguised image 9616 can be provided to any suitable systems, applications, clouds, etc. authorized to receive the data. For example, disguised image 9616 may be provided to applications (e.g., 8956) of a computer vision system (e.g., 8955) in the vehicle or in a cloud, and/or to a data collection system (e.g., 89140).

In at least some embodiments, configured GAN model 8930 may continue to be trained in real-time. In these embodiments, configured GAN model 8930 executes discriminator 8934, which receives disguised images, such as disguised image 9616, produced by the generator. Discriminator determines whether a disguised image is real or fake. If the discriminator classifies the disguised image as real, then a discriminator loss value may be backpropagated to the discriminator to learn how to better predict whether an image is real or fake. If the discriminator classifies the disguised image as fake, then a generator loss value may be backpropagated to the generator to continue to train the generator to produce disguised images that are more likely to trick the discriminator into classifying them as real. It should be apparent, however, that continuous real-time training may not be implemented in at least some embodiments. Instead, the generator 8932 of the configured GAN model 8930 may be implemented without the corresponding discriminator 8934, or with the discriminator 8934 being inactive or selectively active.

FIG. 97 illustrates an example operation of configured GAN model 8930 in vehicle 8950 to generate a disguised image 9716 and the use of the disguised image in machine learning tasks according to at least one embodiment. At 9712, vehicle data with human faces is collected by one or more image capturing devices mounted on the vehicle. To visually illustrate the operations shown in FIG. 97, an example input image 9702 depicting a real face and an example disguised image 9708 depicting a modified face is shown. These example images were previously shown and described with reference to FIG. 95. It should be noted that image 9702 is provided for illustrative purposes and that a face may be a small portion of an image typically captured by an image capturing device associated with a vehicle. In addition, in some scenarios, vehicle data with human faces 9712 may contain captured images received from image capturing devices associated with the vehicle and/or captured images received from image capturing devices separate from the vehicle (e.g., other vehicles, drones, traffic lights, etc.).

A face detection and alignment model 9720 can detect and align faces in images from the vehicle data. In at least one embodiment, a supervised learned model such as multi-task cascaded convolutional networks (MTCNN) can be used for both detection and alignment. Face alignment is a computer vision technology that involves estimating the locations of certain components of the face (e.g., eyes, nose, mouth). In FIG. 97, face detection is shown in an example image 9704, and alignment of the eyes is shown in an example image 9706.

The detected face is fed into configured GAN model 8930 along with target domain 8936. In one example, a combination of gender and age transformations to the detected face may lower the face recognition probability while maintaining the desired features of the face, such as emotion and gaze information. The generator of configured GAN model 8930 generates disguised image 9716, as illustrated in image 9708, based on the target domain 8936 and the input image from face detection and alignment model 9720.

Note that while face recognition 9718 fails in this example (e.g., the face of disguised image 9708 is not recognizable as the same person shown in the original image 9702), certain features of the face such as gaze are preserved. In an autonomous vehicle scenario, the vehicle's on-board intelligence (e.g., computer vision system 8955) can still predict and project the trajectory of a moving person (e.g., walking, running, riding a bike, driving a car, etc.) based on their gaze. Because some of the identifying features of people in image data are discarded (e.g., by being transformed or modified) at the time that the image is processed, attempts by malicious or prying actors (e.g., hackers or surveillance entities), to recover the identities of people in the data will fail, without compromising the ability of computer vision applications to obtain valuable information from the disguised images.

The disguised image can be provided to any systems, applications, or clouds based on particular implementations and needs. In this example, disguised image 9716 is provided to a computer vision application 9740 on the vehicle to help predict the actions of the person represented by the face. For example, gaze detection 9742 may determine where a person (e.g., pedestrian, another driver, etc.) is looking and trajectory prediction 9744 may predict a trajectory or path the person is likely to take. For example, if a pedestrian is looking at their phone or shows other signs of being distracted, and if the predicted trajectory indicates the person is likely to enter the path of the vehicle, then the appropriate commands may be issued to take one or more actions such as alerting the driver, honking the horn, reducing speed, stopping, or any other appropriate action or combination of actions.

In another example, disguised image 9716 can be used to determine the emotions of the person represented by the face. This may be useful, for example, for a service provider, such as a transportation service provider, to determine whether its passenger is satisfied or dissatisfied with the service. In at least some scenarios, such evaluations may be done remote from the vehicle for example, by a cloud processing system 9750 of the service provider. Thus, photos of individuals (e.g., passengers in a taxi) captured by image capturing devices on the vehicle may be shared with other systems, applications, devices, etc. For example, emotion detection 9752 may detect a particular emotion of a person depicted in the disguised image. Action prediction/assessment 9754 may predict a particular action a person depicted in the disguised image is likely to take. For example, extreme anger or distress may be used to send an alert to the driver. Embodiments herein protect user privacy by disguising the face to prevent face recognition while preserving certain attributes that enable successful gaze and emotion detection.

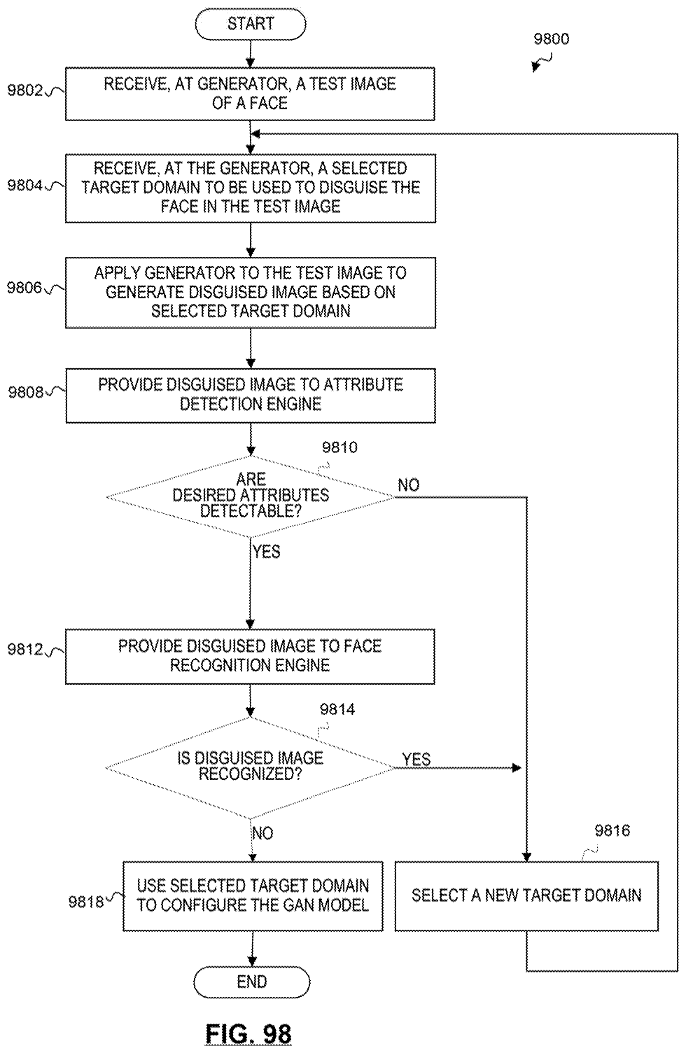

Turning to FIG. 98, FIG. 98 is a simplified flowchart that illustrates a high level of a possible flow 9800 of operations associated with configuring a Generative Adversarial Network (GAN) that is trained to perform attribute transfers on images of faces. In at least one embodiment, a set of operations corresponds to activities of FIG. 98. GAN configuration system 8910 may utilize at least a portion of the set of operations. GAN configuration system 8910 may include one or more data processors 8937, for performing the operations. In at least one embodiment, generator 8922 of GAN model 8920, attribute detection engine 8917, and face recognition engine 8918 may each perform one or more of the operations. In some embodiments, at least some of the operations of flow 9800 may be performed with user interaction. For example, in some scenarios, a user may select attributes for a new target domain to be tested. In other embodiments, attributes for a new target domain may be automatically selected at random or based on an algorithm, for example.

At 9802, the generator of the GAN model receives a test image of a face. In at least one embodiment, test images processed in flow 9800 may be evaluated a priori by face recognition engine 8918 to ensure that they are recognizable by the engine. At 9804, the generator obtains a target domain indicating one or more attributes to be used to disguise the face in the test image.

At 9806, the generator is applied to the test image to generate a disguised image based on the selected target domain (e.g., gender, age, hair color, etc.). The disguised image depicts the face from the test image as modified based on the one or more attributes.

At 9808, the disguised image is provided to an attribute detection engine to determine whether desired attributes are detectable in the disguised image. For example, a gaze attribute may be desirable to retain so that a computer vision system application can detect the gaze and predict the intent and/or trajectory of the person associated with the gaze. In another example, emotion may be a desirable attribute to retain so that a third party can assess the emotion of a person who is a customer and determine what type of experience the customer is having (e.g., satisfied, annoyed, etc.). Any other desirable attributes may be evaluated based on particular implementations and needs, and/or the types of machine learning systems that consume the disguised images.

At 9810, a determination is made as to whether the desirable attributes are detectable. If one or more of the desirable attributes are not detectable, then at 9816, a new target domain may be selected for testing. The new target domain may indicate a single attribute or a combination of attributes and may be manually selected by a user or automatically selected. Flow passes back to 9804, where the newly selected target domain is received at the generator and another test is performed using the newly selected target domain.

If at 9810, it is determined that the desired attributes are detectable in the disguised image, then at 9812, the disguised image is provided to face recognition engine to determine whether the disguised image is recognizable. At 9814, a determination is made as to whether the disguised image is recognized by the face detection engine. If the disguised image is recognized, then at 9816, a new target domain may be selected for testing. The new target domain may indicate a single attribute or a combination of attributes and may be manually selected by a user or automatically selected. Flow passes back to 9804, where the newly selected target domain is received at the generator and another test is performed using the newly selected target domain.

At 9814, if it is determined that the disguised image is not recognized by the face detection engine, then at 9818, the GAN model may be configured by setting its target domain as the target domain that was used by the generator to produce the disguised image. In at least one embodiment, the selected target domain used by the generator may not be used to configure the generator until a certain threshold number of disguised images, which were disguised based on the same selected target domain, have not been recognized by the face detection engine.

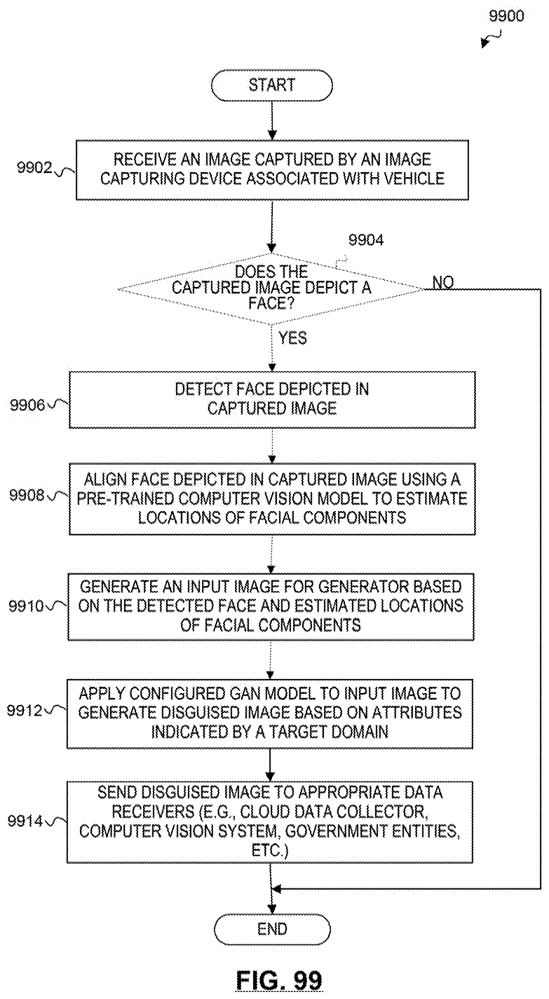

FIG. 99 is a simplified flowchart that illustrates a high level of a possible flow 9900 of operations associated with operations of a privacy-preserving computer vision system (e.g., 8955) of a vehicle (e.g., 8950) when a configured GAN model (e.g., 8930) is implemented in the system. In at least one embodiment, a set of operations corresponds to activities of FIG. 99. Configured GAN model 8930 and face detection and alignment model 9720 may each utilize at least a portion of the set of operations. Configured GAN model 8930 and face detection and alignment model 9720 may include one more data processors 8957, for performing the operations.

At 9902, a privacy-preserving computer vision system receives an image captured by an image capturing device associated with a vehicle. In other scenarios, the computer vision system may receive an image from another device in close proximity to the vehicle. For example, the image could be obtained by another vehicle passing the vehicle receiving the image.

At 9904, a determination is made as to whether the captured image depicts a face. If a determination is made that the captured image does not depict a face, then flow 9900 may end and the configured GAN model does not process the captured image.

If a determination is made at 9904 that the captured image does depict a face, then at 9906, the face is detected in the captured image. For example, a set of pixels corresponding to the face may be detected in the captured image. At 9908 the detected face is aligned to estimate locations of facial components (e.g., corners of eyes, corners of mouth, corners of nose, etc.). At 9910, an input image for the generator may be generated based on the detected face and the estimated locations of facial components. In at least one example, a supervised learned model such as multi-task cascaded convolutional networks (MTCNN) can be used for both detection and alignment.

At 9912, the generator of the configured GAN model is applied to the input image to generate a disguised image based on a target domain set in the generator. Attributes indicated by the target domain may include age and/or gender in at least one embodiment. In other embodiments, other combinations of attributes (e.g., hair color, eye color, skin color, makeup, etc.) or a single attribute may be indicated by the target domain if such attribute(s) result in a disguised image that is not recognizable but retains the desired attributes.

At 9914, the disguised image is sent to appropriate data receivers including, but not necessarily limited to, one or more of a cloud data collection system, applications in the computer vision system, and government entities (e.g., regulatory entities such as a state department of transportation, etc.).

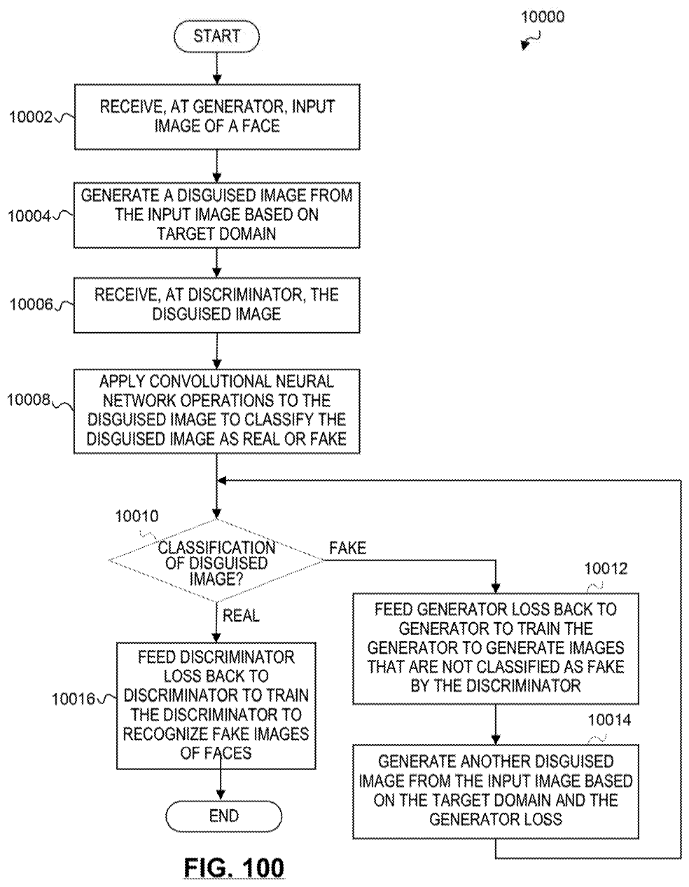

FIG. 100 is a simplified flowchart that illustrates a high level of a possible flow 10000 of operations associated with operations that may occur when a configured GAN model (e.g., 8930) is applied to an input image. In at least one embodiment, a set of operations corresponds to activities of FIG. 100. Configured GAN model 8930, including generator 8932 and discriminator 8934 may each utilize at least a portion of the set of operations. Configured GAN model 8930 may include one or more data processors 8957, for performing the operations. In at least one embodiment, the operations of flow 10000 may correspond to the operation indicated at 9912.

At 10002, the generator of a configured GAN model in a vehicle receives an input image. An input image may be generated, for example, by detecting and aligning a face depicted in an image captured by a vehicle. At 10004, the generator generates a disguised image from the input image based on the generator's preconfigured target domain (e.g., gender and age).

At 10006, a discriminator of the configured GAN model receives the disguised image from the generator. At 10008, the discriminator performs convolutional neural network operations on the disguised image to classify the disguised image as real or fake.

At 10010, a determination is made as to the classification of the disguised image. If the discriminator classifies the disguised image as fake, then at 10012, a generator loss is propagated back to the generator to continue training the generator to generate disguised images that are classified as “real” by the discriminator (e.g., disguised images that trick the discriminator). At 10014, the generator can generate another disguised image from the input image based on the target domain and the generator loss. Flow may then pass to 10010 to determine how the discriminator classified the new disguised image.

If the discriminator classifies a disguised image as real at 10010, then at 10016, a discriminator loss may be propagated back to the discriminator to continue training the discriminator to more accurately recognize fake images.

Flow 10000 illustrates an example flow in which the configured GAN model continues training its generator and discriminator in real-time when implemented in a vehicle. In some scenarios, the training may be paused during selected periods of time until additional training is desired, for example, to update the configured GAN model. In these scenarios, during at least some periods of time, only the generator may perform neural network operations when a captured image is processed. The discriminator may not execute until additional training is initiated.

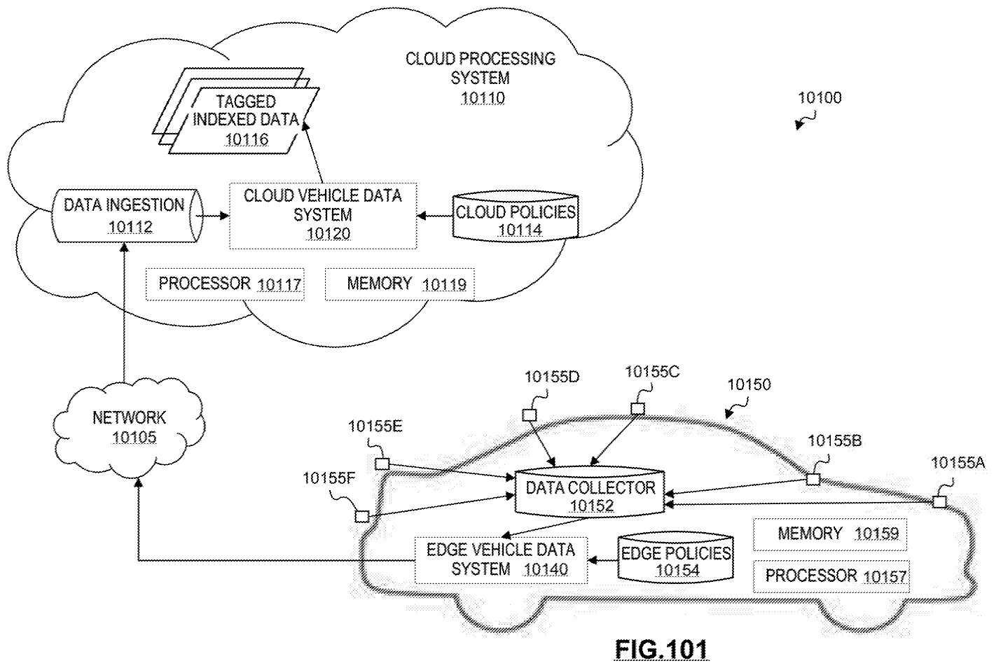

Additional (or alternative) functionality may be provided in some implementations to provide privacy protection associated with image data collected in connection with autonomous driving systems. For instance, an on-demand privacy compliance system may be provided for autonomous vehicles. In an embodiment, descriptive tags are used in conjunction with a “lazy” on-demand approach to delay the application of privacy measures to collected vehicle data until the privacy measures are needed. Descriptive tags are used to specify different attributes of the data. As used with reference to FIGS. 101 through 111, the term “attribute” is intended to mean a feature, characteristic, or trait of data. Attributes can be used to subjectively define privacy provisions for compliance with privacy regulations and requirements. Tags applied to datasets from a particular vehicle are evaluated in a cloud or in the vehicle to determine whether a “lazy” policy is to be applied to the dataset. If a lazy policy is applied, then processing to privatize or anonymize certain aspects of the dataset is delayed until the dataset is to be used in a manner that could potentially compromise privacy.

New technologies such as autonomous vehicles are characterized by (i) collections of huge amounts of sensor data, and (ii) strict laws and regulations that are in-place, in-the-making, and frequently changing that regulate the use and handling of the collected data. In some edge devices, such as L4/L5 autonomous vehicles, camera and video data may be generated at a rate of 5 TB/hour. This data may contain personal identifying information that may raise privacy and safety concerns, and that may be subject to various governmental regulations. This personal identifying information may include, but is not necessarily limited to, images of people including children, addresses or images of private properties, exact coordinates of a location of a vehicle, and/or images of vehicle license plates. In some geographies (e.g., European Union), personal identifying information is legally protected and stiff financial penalties may be levied to any entity in possession of that protected information.

In a traditional data center, data management techniques are typically implemented over an entire dataset, usually just once, using one compliance policy that can become abruptly obsolete as a result of new or modified government legislation. Further, the amount of data generated by some edge devices (e.g., 5 TB/hour) renders the application of efficient compliance policies not scalable.

Generally, current compliance policies, such as data privacy, are applied by processing all data files to ensure compliance. These policies typically employ a set of predefined search criterion to detect potential privacy violations. This approach is inefficient for data-rich environments such as autonomous vehicles and are not scalable. Currently, an autonomous vehicle can collect as much as 5 TB/hour of data across its array of sensors. When combined with other mobile edge devices, the rate at which sensor data is being generated can potentially flood standard processing channels as well as additional data management analytics that enforce compliance.

Additionally, current compliance solutions are rigid, one-time implementations that cannot adapt quickly to the continuous change and evolution of privacy regulations, as well as the disperse nature of these regulations with respect to locale, context, and industry. For example, an autonomous ambulance in the United States may collect data that is subject to both department of transportation regulations as well as the Health Insurance Portability and Accountability Act (HIPAA). Moreover, privacy regulations may be different by state and by country. An autonomous vehicle crossing state lines or country borders needs to adjust its processing, in real time, to comply with regulations in the new locale. A rigid one-time implementation can potentially create compliance liability exposure in these scenarios and others.

Modern data compliance techniques can also hinder application development and cause deployment problems. Typically, these techniques either silo data or delete unprocessed data altogether. Such actions can be a significant encumbrance to a company's capability development pipeline that is based on data processing.

An on-demand privacy compliance system 10100 for autonomous vehicles, as shown in FIG. 101, resolves many of the aforementioned issues (and more). Embodiments herein enrich data that is captured or otherwise obtained by a vehicle by attaching descriptive tags to the data. Tags specify different attributes that can be used to subjectively define the privacy provisions needed for compliance. In at least one embodiment, tags are flat and easy to assign and understand by humans. They can be used to describe different aspects of the data including for example location, quality, time-of-day, and/or usage. At least some embodiments described herein also include automatic tag assignment using machine learning based on the actual content of the data, such as objects in a picture, current location, and/or time-of-day.

Embodiments also apply a ‘lazy’ on-demand approach for addressing privacy compliance. In a lazy on-demand approach, processing data to apply privacy policies is deferred as much as possible until the data is actually used in a situation that may compromise privacy. Data collected in autonomous vehicles is often used for machine learning (ML). Machine learning typically applies sampling on data to generate training and testing datasets. Given the large quantity of data that is collected by just a single autonomous vehicle, processing these sample datasets to apply privacy policies on-demand ensures better use of computing resources. Moreover, based on tags, data can be selected for indexing and/or storage, which also optimizes resource usage.

On-demand privacy compliance system 10100 offers several advantages. The system comprises a compute-efficient and contextually-driven compliance policy engine that can be executed either within the vehicle (the mobile edge device) or in a datacenter/cloud infrastructure. The utility of vehicle data collection is enriched using tags that, unlike structured metadata, are flat and easy to assign and understand by humans, both technical and non-technical. The use of tags in embodiments herein ensures that the correct privacy compliance processes are executed on the correct datasets without the need to examine every frame or file in a dataset. Accordingly, significant data center resources can be saved. These tags ensure that the vehicle data is free from regulatory privacy violations. Thus, entities (e.g., corporations, service providers, vehicle manufacturers, etc.) that use, store, or process vehicle data remain compliant to relevant compliance and regulatory statutes. This can prevent such entities from being subjected to significant fines. Furthermore, as regulations change, embodiments herein can accommodate those changes without requiring significant code changes or re-implementation of the system. Regulations may change, for example, when regulatory bodies add or update privacy regulations, when a vehicle leaves an area subject to one regulatory body and enters an area subject to another regulatory body (e.g., driving across state lines, driving across country borders, etc.). Also, by addressing regulatory compliance, embodiments described herein can increase the trust of the data collected by vehicles (and other edge devices) and its management lifecycle. In addition to data privacy assurances, embodiments enable traceability for auditing and reporting purposes. Moreover, the modular extensible framework described herein can encompass new, innovative processes.

Turning to FIG. 101, on-demand privacy compliance system 10100 includes a cloud processing system 10110, a vehicle 10150, and a network 10105 that facilitates communication between vehicle 10150 and cloud processing system 10110. Cloud processing system 10110 includes a cloud vehicle data system 10120, a data ingestion component 10112 for receiving vehicle data, cloud policies 10114, and tagged indexed data 10116. Vehicle 10150 includes an edge vehicle data system 10140, edge policies 10154, a data collector 10152, and numerous sensors 10155A-10155F. Elements of FIG. 101 also contain appropriate hardware components including, but not necessarily limited to processors (e.g., 10117, 10157) and memory (e.g., 10119, 10159), which may be realized in numerous different embodiments.

In vehicle 10150, data collector 10152 may receive near-continuous data feeds from sensors 10155A-10155F. Sensors may include any type of sensor described herein, including image capturing devices for capturing still images (e.g., pictures) and moving images (e.g., video). Collected data may be stored at least temporarily in data collector 10152 and provided to edge vehicle data system 10140 to apply tags and edge policies 10154 to datasets formed from the collected data. A tag can be any user-generated word that helps organize web content, label it in an easy human-understandable way, and index it for searching. Edge policies 10154 may be applied to a dataset based on the tags. A policy associates one or more tags associated with a dataset to one or more processes. Processes are defined as first-class entities in the system design that perform some sort of modification to the dataset to prevent access to any personally identifying information.

In at least some scenarios, datasets of vehicle data collected by the vehicle are provided to cloud vehicle data system 10120 in cloud processing system 10110, to apply cloud policies 10114 to the datasets based on their tags. In this scenario, data collected from the vehicle may be formed into datasets, tagged, and provided to data ingestion component 10112, which then provides the datasets to cloud vehicle data system 10120 for cloud policies 10114 to be applied to the datasets based on their tags. In at least one embodiment, cloud policies 10114 applied to datasets from a particular vehicle (e.g., 10150) may be the same policies that would be applied to the datasets by edge vehicle data system 10140 if the datasets stayed with the vehicle. In at least some scenarios, cloud vehicle data system 10120 may also apply tags to the data (or additional tags to supplement tags already applied by edge vehicle data system 10140). In at least some embodiments, tagging may be performed wherever it can be most efficiently accomplished. For example, although techniques exist to enable geographic (geo) tagging in the cloud, it is often performed by a vehicle because image capturing devices may contain global positioning systems and provide real-time information related to the location of subjects.

Turning to FIG. 102, FIG. 102 illustrates a representation of data 10210 collected by a vehicle and objects defined to ensure privacy compliance for the data. Objects include one or more tags 10220, one or more policies 10230, and one or more processes 10240. In at least one embodiment, data 10210 may be a dataset that includes one or more files, images, video frames, records, or any object that contains information in an electronic format. Generally, a dataset is a collection of related sets of information formed from separate elements (e.g., files, images, video frames, etc.).

A tag, such as tag 10220, may be a characterization metadata for data. A tag can specify a data format (e.g., video, etc.), quality (e.g., low-resolution, etc.), locale (e.g., U.S.A, European Union, etc.), area (e.g., highway, rural, suburban, city, etc.), traffic load (e.g., light, medium, heavy, etc.), presence of humans (e.g., pedestrian, bikers, drivers, etc.) and any other information relevant to the data. A tag can be any user-generated word that helps organize web content, label it in an easy human-understandable way, and index it for searching. In some embodiments, one or more tags may be assigned manually. At least some tags can be assigned automatically using machine learning. For example, a neural network may be trained to identify various characteristics of the collected data and to classify each dataset accordingly. For example, a convolutional neural network (CNN) or a support vector machine (SVM) algorithm can be used to identify pictures or video frames in a dataset that were taken on a highway versus a suburban neighborhood. The latter has higher probability of containing pictures of pedestrians and private properties and would potentially be subject to privacy regulations. The dataset may be classified as ‘suburban’ and an appropriate tag may be attached to or otherwise associated with the dataset.

A process, such as process 10240, may be an actuation action that is defined as a REST Application Programming Interface (API) that takes as input a dataset and applies some processing to the dataset that results in a new dataset. Examples of processes include, but are not necessarily limited to, applying a data anonymization script to personally identifying information (e.g., GPS location, etc.), blurring personally identifying information or images (e.g., faces, license plates, private or sensitive property addresses, etc.), pixelating sensitive data, and redacting sensitive data.

Processes are defined as first-class entities in the system design. In at least one embodiment, processes may be typical anonymization, alteration, rectification, compression, storage, etc. This enables a modular pipeline design to be used in which processes are easily pluggable, replaceable and traceable. Accordingly, changes to data can be tracked and compliance requirements can be audited. In addition, this modular pipeline design facilitates the introduction of new privacy processes as new regulations are enacted or existing regulations are updated.

A policy, such as policy 10230, associates one or more tags to one or more processes. For example, a dataset that is tagged with ‘suburban’ as previously described could be subject to a policy that associates the ‘suburban’ tag with a privacy process to anonymize (e.g., blur, redact, pixelate, etc.) faces of people and private property information. The tag in that case enables the right processes to be matched to the right dataset based on the nature of that dataset and the potential privacy implications that it contains.

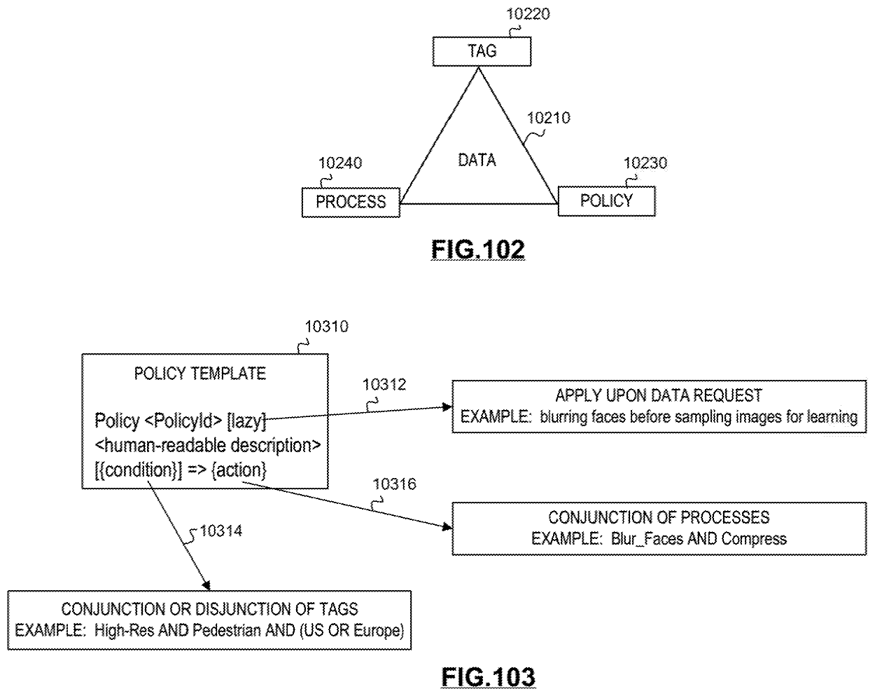

FIG. 103 shows an example policy template 10310 for on-demand privacy compliance system 10100 according to at least one embodiment. Policy template 10310 includes a ‘lazy’ attribute 10312, which defines the policy to be an on-demand policy, the application of which is deferred and subsequently applied upon request. More specifically, the policy is not applied until the dataset is to be used in a situation that could potentially compromise privacy. Upon a determination that the policy is designated as a lazy policy, the dataset is marked for later processing. For example, before a marked dataset (e.g., of images) is sampled for machine learning, the policy may be applied to blur faces in images in the dataset.

Policy template 10310 also includes a condition 10314, which is indicated by the conjunction or disjunction of tags. Thus, one or more tags may be used in condition 10314 with desired conjunctions and/or disjunctions. Examples of tags may include, but are not necessarily limited to, pedestrian, night, day, highway, rural, suburban, city, USA, EU, Asia, low-resolution, high-resolution, geographic (geo) location, and date and time.

Policy template 10310 further includes an action 10316, which indicates a single process or the conjunction of processes that are to be performed on a dataset if the condition is satisfied from the tags on the dataset. As shown in FIG. 103, an example condition could be: High-Res AND Pedestrian AND (US OR Europe), and an example conjunction of processes is to blur faces and compress the data. Thus, this example policy is applicable to dataset that contains, according to its tags, high-resolution data and pedestrians and that is collected in either the US or Europe. If the dataset satisfies this combination of tags, then one or more processes are applied to blur the faces of pedestrians in the images and to compress the data.

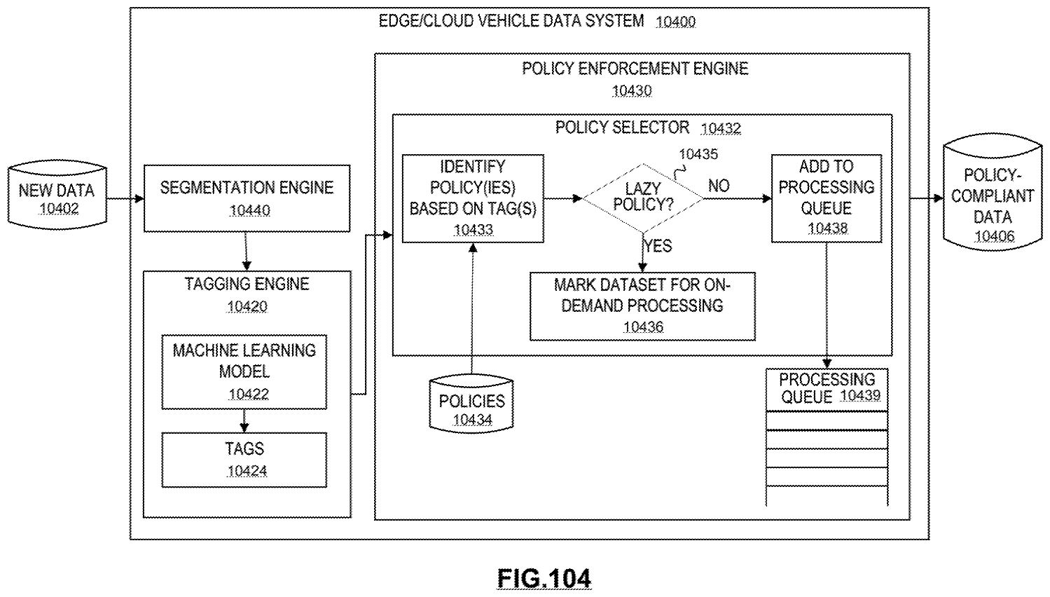

FIG. 104 is a simplified block diagram illustrating possible components and a general flow of operations of a vehicle data system 10400. Vehicle data system 10400 can be representative of a cloud vehicle data system (e.g., 10120) and/or an edge vehicle data system (e.g., 10140). Vehicle data system 10400 includes a segmentation engine 10410, a tagging engine 10420, and a policy enforcement engine 10430. Vehicle data system 10400 ensures privacy compliance for data collected from sensors (e.g., 10155A-10155F) attached to an autonomous vehicle (e.g., 10150) by tagging datasets from the vehicle and applying policies to the datasets based on the tags attached to the datasets.

Segmentation engine 10410 can receive new data 10402, which is data collected by a data collector (e.g., 10152) of a vehicle (e.g., 10150). Segmentation engine 10410 can perform a segmentation process on new data 10402 to form datasets from the new data. For example, the new data may be segmented into datasets that each contain a collection of related sets of information. For example, a dataset may contain data associated with a particular day, geographic location, etc. Also, segmentation may be specific to an application. In at least one embodiment, tags can be applied per dataset.

Tagging engine 10420 may include a machine learning model 10422 that outputs tags 10424 for datasets. Machine learning model 10422 can be trained to identify appropriate tags based on given data input. For example, given images or video frames of a highway, a suburban street, a city street, or a rural road, model 10422 can identify appropriate tags such as ‘highway’, ‘suburban’, ‘city’, or ‘rural’. Examples of suitable machine learning techniques that may be used include, but are not necessarily limited to, a convolutional neural network (CNN) or a support vector machine (SVM) algorithm. In some examples, a single machine learning model 10422 may generate one or more tags for each dataset. In other embodiments, one or more machine learning models may be used in the tagging engine to identify various tags that may be applicable to a dataset.

Policy enforcement engine 10430 may include a policy selector 10432, policies 10434, and a processing queue 10439. Policy selector 10432 can receive tagged datasets from tagging engine 10420. Policies 10434 represent edge policies (e.g., 10154) if vehicle data system 10400 is implemented in an edge device (e.g., vehicle 10150), or cloud policies (e.g., 10113) if vehicle data system 10400 is implemented in a cloud processing system (e.g., 10110). Policy selector 10432 detects the one or more tags on a dataset, and at 10433, identifies one or more policies based on the detected tags. A policy defines which process is applicable in which case. For example, a policy can say, for all images tagged as USA, blur the license plates.

As shown at 10435, policy selector 10432 determines whether the identified one or more policies are designated as lazy policies. If a policy that is identified for a dataset based on the tags of the dataset is designated as lazy, then the dataset is marked for on-demand processing, as shown at 10436. Accordingly, the lazy policy is not immediately applied to the dataset. Rather, the dataset is stored with the policy until the dataset is queried, read, copied, or accessed in any other way that could compromise the privacy of contents of the dataset. For example, if an identified policy indicates a process to blur faces in images and is designated as a lazy policy, then any images in the dataset are not processed immediately to blur faces, but rather, the dataset is marked for on-demand processing and stored. When the dataset is subsequently accessed, the dataset may be added to processing queue 10439 to apply the identified policy to blur faces in the images of the dataset. Once the policy is applied, an access request for the dataset can be satisfied.

If a policy that is identified for a dataset based on the tags of the dataset is not designated as lazy, then the dataset is added to a processing queue 10439 as indicated at 10438. The identified policy is then applied to the dataset. For example, if an identified policy for a dataset indicates a process to encrypt data in a file and is not designated as a lazy policy, then the dataset is added to processing queue 10439 to encrypt the dataset. If there are no policies associated with the dataset and designated as lazy, then once all of the policies have been applied to the dataset (e.g., encrypted), the policy is added to policy-compliant data 10406 where it can be accessed without further privacy policy processing.

Some of the capabilities of vehicle data system 10400 can be implemented in an edge device (e.g., vehicle 10150) to optimize data flow. For example, privacy filters can be applied at the edge to prevent sensitive data from being saved on a cloud (e.g., 10110) and hence ensuring compliance with data minimization rules, as enforced by recent regulations such as the European Union General Data Protection Regulation (GDPR). For example, a privacy policy can be defined to anonymize location data by replacing GPS coordinates with less precise location data such as the city. This policy can be defined as a non-lazy policy to be applied on all location data in the vehicle (edge) to prevent precise locations from being sent to the cloud.

In at least one embodiment, contextual policies may be used to affect in-vehicle processing based on real-time events or other information that adds additional context to tagged datasets. By way of illustration, but not of limitation, two examples will now be described. In a first example, many countries employ a system in which an alert (e.g., AMBER alert in the U.S.) is triggered when a child is endangered. This child-safety contextual policy can be communicated to a micro-targeted geographic region, such as a dynamic search radius around the incident, to vehicles whose owners have opted into that AMBER-alert-type system. For data tagged with ‘highway’, under an AMBER-alert-type condition, lazy policy is set to ‘No’, and the data is sent to the vehicle machine learning engine for real-time processing of license plates with optical character recognition (OCR), vehicle color if it is given, and vehicle description if it is given. In this scenario, to maintain privacy of the ‘crowd vehicles’, only GPS information obtained within ‘begin hits and end hits’ is sent to the law enforcement who can triangulate the pings or hits from the ‘crowd of vehicles’ around the actor-vehicle subject of the AMBER alert.

In a second nonlimiting example of applying contextual policies, micro-targeted geographic regions may be selected for contextual policies. For example, in some cities, large homeless populations tend to cluster around public parks and in the side or underside or highway ramp structures, which creates unique micro-targeted geographic regions. For these localized micro-regions, a contextual policy or function could be ‘likelihood of humans is high’. Even though a dataset may be tagged as ‘highway’ or ‘expressway ramp’, and the relevant policy for these tags may be designated as a lazy policy, a contextual policy could override lazy processing and direct the data to the in-vehicle vehicle data system (e.g., 10400) for processing for humans/pedestrians. While the humans/pedestrians may not be detected as being on the road itself, clusters of humans around highways may have higher instances of individuals darting across the road with very little warning. The identification of humans/pedestrians could signal the decision processing engine in the vehicle to actuate a slower-speed, to give the vehicle time to react, than would otherwise be warranted.

Vehicle data system 10400 may be used in both research and design systems, where large amounts of data are collected from vehicles to build machine learning models, and in operational systems where data is collected from vehicles to continuously update high definition maps, track traffic gridlocks, or re-train models when new use cases emerge. In a research and design system, machine learning model 10414 may be continuously trained with test data to learn how to classify datasets with appropriate tags. The test data may include real data from test vehicles.

Tagging, policy, and processing in vehicle data system 10400, are used to create a highly efficient enforcement workflow that is easily integrated into the compute resource utilization framework of the vehicle. In vehicles with over 150 Electronic Control Units, 1-2 ADAS/AV Engines, and a central-server controller, it is possible to route processing to different compute units based on compute availability and policy.

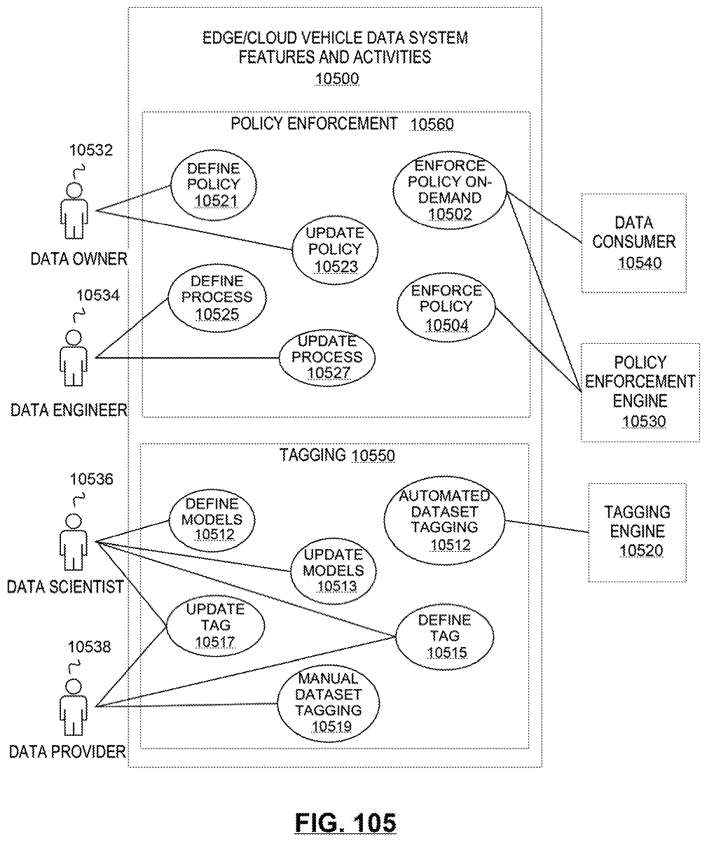

Turning to FIG. 105, FIG. 105 illustrates features and activities 10500 of an edge or cloud vehicle data system 10400, from a perspective of various possible human actors and hardware and/or software actors. In at least one example, tagging 10550 refers to applying appropriate tags (e.g., pedestrian, highway, rural, suburban, city, GPS location, etc.) to datasets. In at least one embodiment, automated dataset tagging 10412 can be performed by tagging engine 10420. As previously described, a machine learning model of tagging engine 10420 (e.g., CNN, SVM) can be trained to recognize images and other information in data collected from vehicles and to output tags that apply to the input data. Manual tagging may also (or alternatively) be used in a vehicle data system. For example, a data provider 10538 may define tags 10515, update tags 10517, and perform manual dataset tagging 10519.

A data scientist 10536 may define tags 10515 and update tags 10517, and in addition, may define models 10512 and update models 10513. Machine learning models, like CNN or SVM, may be trained to distinguish between contents of datasets to select appropriate tags. For example, a model may be trained to distinguish between images from highways and rural roads and images from suburban roads and city streets. Images from suburban roads and city streets are likely to have more pedestrians where privacy policies to blur faces, for example, should be applied. Accordingly, in one example, a trained CNN or SVM model to be used by tagging engine 10420 to classify a dataset of images as ‘highway’, ‘rural’, ‘city’, or ‘suburban’. Tagging engine 10420 can automatically attach the tags to the dataset.

For policy enforcement 10560, a data engineer 10534 may define processes 10525 and update processes 10527. For example, a first process may be defined to blur faces of an image, a second process may be defined to blur license plates of cars, a third process may be defined to replace GPS coordinates with less precise location information, a fourth process may be defined to encrypt data. A data owner 10532 may define policies 10521 and update policies 10523. For example, a policy may be defined by selecting a particular condition (e.g., conjunction or disjunction of tags) and assigning an action (e.g., conjunction of processes) to the condition. The policy can be associated with datasets that satisfy the condition. The action defined by the policy is to be performed on the tagged datasets either immediately or on-demand if the policy is designated as a ‘lazy’ policy as further described herein.

Policy enforcement engine 10430 can enforce a policy 10504 in real-time if the policy is not designated as lazy and can enforce a policy on-demand 10502 if the policy is designated as lazy. A data consumer 10540 that consumes a dataset (e.g., requests access to a dataset) may trigger the policy enforcement engine 10430 to enforce a policy associated with the dataset. This can occur when the dataset is marked for on-demand processing due to a policy that is associated with the dataset being designated as a lazy policy.

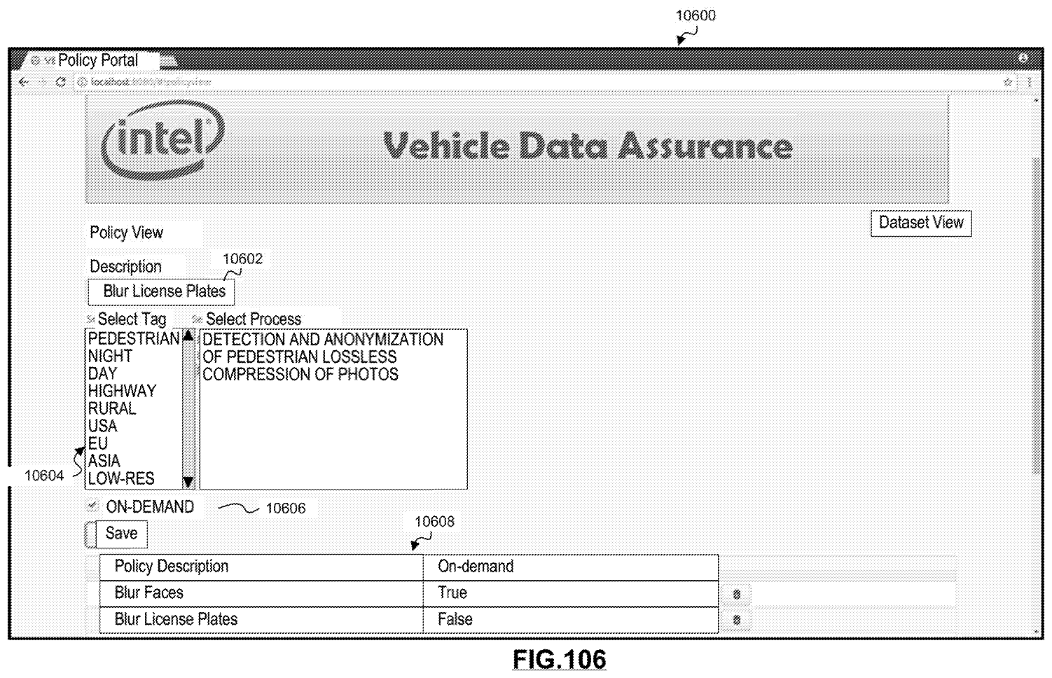

FIG. 106 is an example portal screen display 10600 of an on-demand privacy compliance system for creating policies for data collected by autonomous vehicles. Portal screen display 10600 allows policies to be created and optionally designated as ‘lazy’. A description 10602 field allows a user to provide a description of a policy, such as ‘Blur License Plates’. A tag selection box 10604 allows a user to select tags to be used as a condition for the policy. An on-demand box 10606 may be selected by a user to designate the policy as ‘lazy’. If the box is not selected, then the policy is not designated as ‘lazy’. A policy description table 10608 provides a view of which policies are designated as ‘lazy’ and which policies are not designated as ‘lazy’. For example, in the example of FIG. 106, a policy to blur faces is designated as lazy and, therefore, is to be applied to datasets on-demand. In another example, the blur license plates policy is not designated as ‘lazy’ and, therefore, is applied to datasets immediately to blur license plates in images in the dataset.

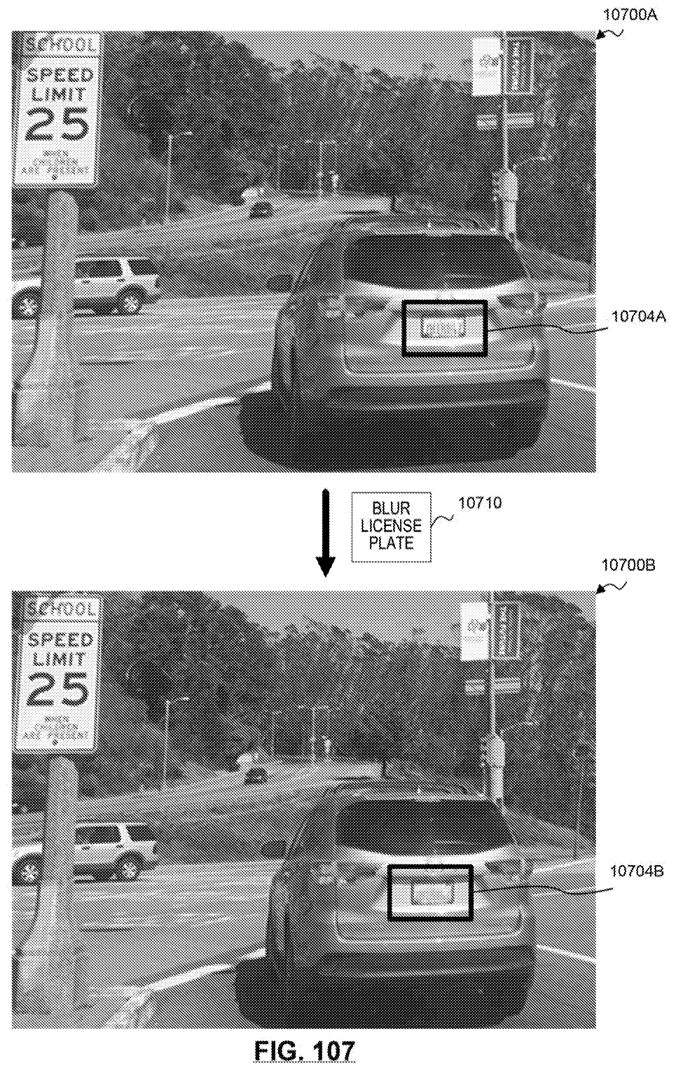

FIG. 107 shows an example image collected from a vehicle before and after applying a license plate blurring policy to the image. Image 10700A is an image with an unobscured and decipherable license place 10704A. A policy to blur the license plate is applied at 10710 and results in image 10700B, which has an obscured and undecipherable license plate 10704B due to a blurring technique applied to pixels representing the license plate in the image.

FIG. 108 shows an example image collected from a vehicle before and after applying a face blurring policy to the image. Image 10800A is an image with some unobscured and recognizable human faces (highlighted by white frames). A policy to blur faces is applied at 10810 and results in image 10800B, which has obscured and unrecognizable faces (highlighted by white frames) due to a blurring technique applied to pixels representing the faces in the image.

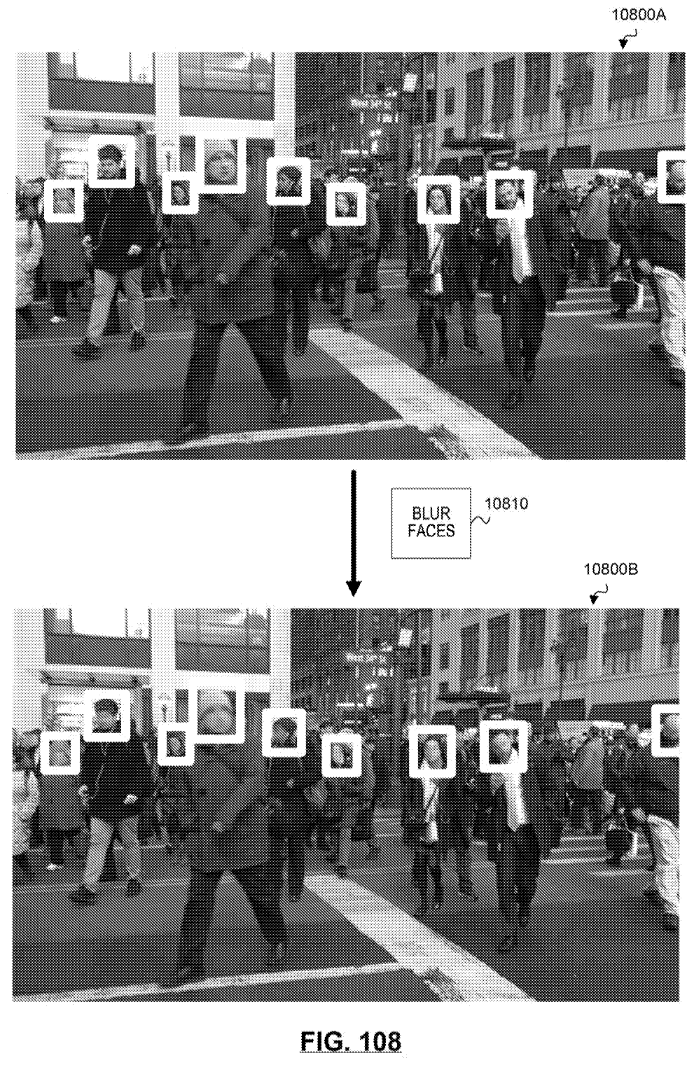

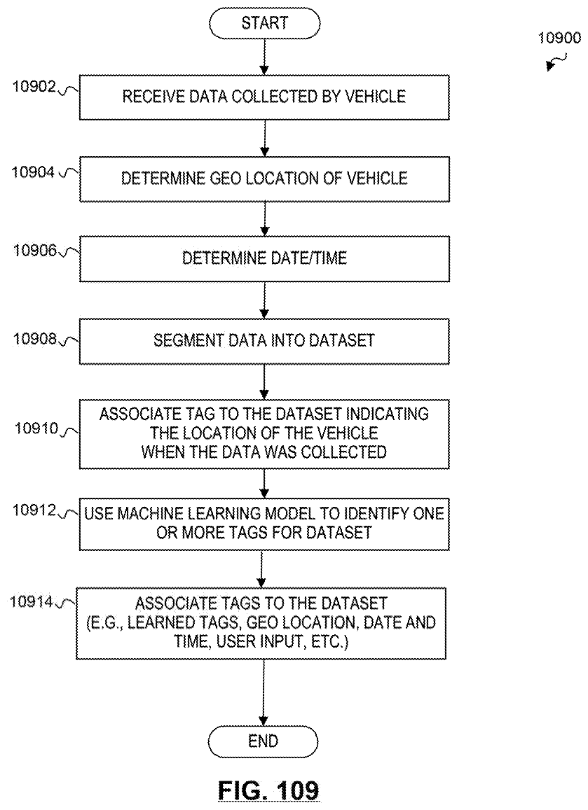

Turning to FIG. 109, FIG. 109 is a simplified flowchart that illustrates a high-level possible flow 10900 of operations associated with tagging data collected at a vehicle in an on-demand privacy compliance system, such as system 10100. In at least one embodiment, a set of operations corresponds to activities of FIG. 109. Vehicle data system 10400 may utilize at least a portion of the set of operations. Vehicle data system 10400 may comprise one or more data processors (e.g., 10127 for a cloud vehicle data system, 10157 for an edge vehicle data system), for performing the operations. In at least one embodiment, segmentation engine 10410 and tagging engine 10420 each perform one or more of the operations. For ease of discussion, flow 10900 will be described with reference to edge vehicle data system 10140 in vehicle 10150.

At 10902, data collected by vehicle 10150 is received by edge vehicle data system 10140. Data may be collected from a multitude of sensors, including image capturing devices, by data collector 10152 in the vehicle.

At 10904, a geo location of the vehicle is determined and at 10906 a date and time can be determined. In some implementations, it may be desirable for geo tagging and/or date and time tagging to be performed at the edge where the real-time information is readily available even if the collected data is subsequently sent to a corresponding cloud vehicle data system for additional tagging and policy enforcement. Accordingly, at 10908, the data may be segmented into a dataset.

At 10910, one or more tags are attached to the data indicating the location of the vehicle and/or the date and time associated with the collection of the data. In this scenario, segmentation is performed before the tag is applied and the geo location tag and/or date and time tag may be applied to the dataset. In other scenarios, a geo location tag and/or a date and time tag may be applied to individual instances of data that are subsequently segmented into datasets and tagged with appropriate geo location tag and/or date and time tag.

At 10912, a machine learning model (e.g., CNN, SVM) is applied to the dataset to identify one or more tags to be associated with the dataset. At 10914, the identified one or more tags are associated with the dataset. A policy may be ‘attached’ to a dataset by being stored with, appended to, mapped to, linked to or otherwise associated with the dataset.

In at least some scenarios, a user (e.g., vehicle owner, data provider) may manually attach a tag to the dataset. For example, if a driver sees an obstacle or accident on the road, that driver could manually enter information into the vehicle data system. The tagging engine could use the information to create a new tag for one or more relevant datasets. Thus, additional contextual information can be manually added to the data in real-time.

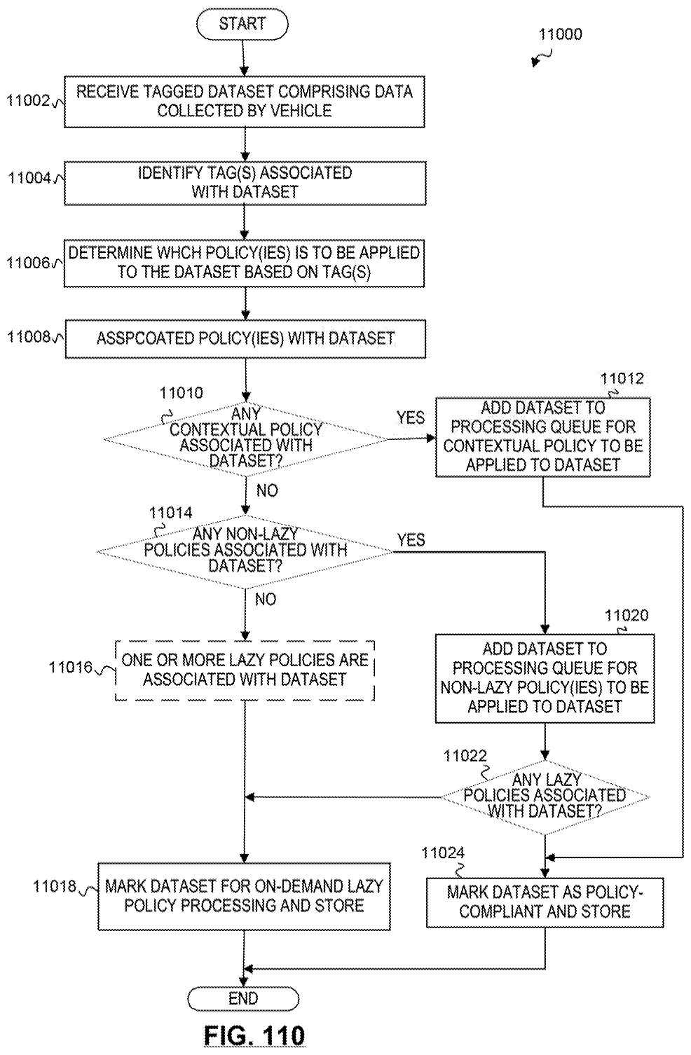

FIG. 110 is a simplified flowchart that illustrates a high-level possible flow 11000 of operations associated with policy enforcement in an on-demand privacy compliance system, such as system 10100. In at least one embodiment, a set of operations corresponds to activities of FIG. 110. A vehicle data system, such as vehicle data system 10400, may utilize at least a portion of the set of operations. Vehicle data system 10400 may include one or more data processors (e.g., 10127 for a cloud vehicle data system, 10157 for an edge vehicle data system), for performing the operations. In at least one embodiment, policy enforcement engine 10430 performs one or more of the operations. For ease of discussion, flow 11000 will be described with reference to edge vehicle data system 10140 in vehicle 10150.

At 11002, a policy enforcement engine in edge vehicle data system 10140 of vehicle 10150 receives a tagged dataset comprising data collected by the vehicle. The dataset may be received subsequent to activities described with reference to FIG. 109. For example, once data collected from the vehicle is segmented into a dataset, and tagged by a tagging engine, then the tagged dataset is received by the policy enforcement engine.

At 11004, one or more tags associated with the data are identified. At 11006 a determination is made as to which policy is to be applied to the dataset. For example, if the tags associated with the dataset satisfy a condition of a particular policy, then that policy is to be applied to the dataset. At 11008, the determined policy is associated with the dataset. A policy may be ‘associated’ with a dataset by being stored with, attached to, appended to, mapped to, linked to or otherwise associated in any suitable manner with the dataset.

At 11010, a determination is made as to whether any contextual policy is associated with the dataset. A contextual policy can override a lazy policy and/or a non-lazy policy. For example, if a vehicle receives an AMBER-type-child alert, a lazy policy for blurring license plates in datasets tagged as ‘highway’ might be set to ‘NO’. However, instead of immediately blurring license places in dataset, OCR may be used to obtain license plate information in the dataset. Accordingly, if a contextual policy is applicable, then at 11012, the dataset is added to the processing queue for the contextual policy to be applied to the dataset. Flow then may pass to 11024 where the dataset is marked as policy compliant and stored for subsequent use (e.g., sending to law enforcement, etc.). In some cases, the use may be temporary until the contextual policy is no longer valid (e.g., AMBER-type-child alert is cancelled). In this scenario, policy enforcement engine may process the dataset again to apply any non-lazy policies and to mark the dataset for processing on-demand if any lazy policies are associated with the dataset and not already applied to the dataset.

If it is determined at 11010 that a contextual policy is not associated with the dataset, then at 11014 a determination may be made as to whether any non-lazy policies are associated with the dataset. If non-lazy policies are not associated with the dataset, then this means that one or more lazy policies are associated with the dataset, as shown at 11016. That is, if one or more policies are associated with the dataset at 11008, and if the one or more policies are not contextual (determined at 11010) and not non-lazy (determined at 11014), then the policies are lazy. Therefore, at 11018, the dataset is marked for on-demand lazy policy processing and is stored.

If it is determined at 11014 that one or more non-lazy policies are associated with the dataset, then at 11020, the dataset is added to the processing queue for non-lazy policy(ies) to be applied to the dataset. At 11022, a determination is made as to whether any lazy policies are associated with the dataset. If one or more lazy policies are associated with the dataset, then at 11018, the dataset is marked for on-demand lazy policy processing and is stored. If one or more lazy policies are not associated with the dataset, then at 11024, the dataset is marked as being policy-compliant and is stored for subsequent access and/or use.

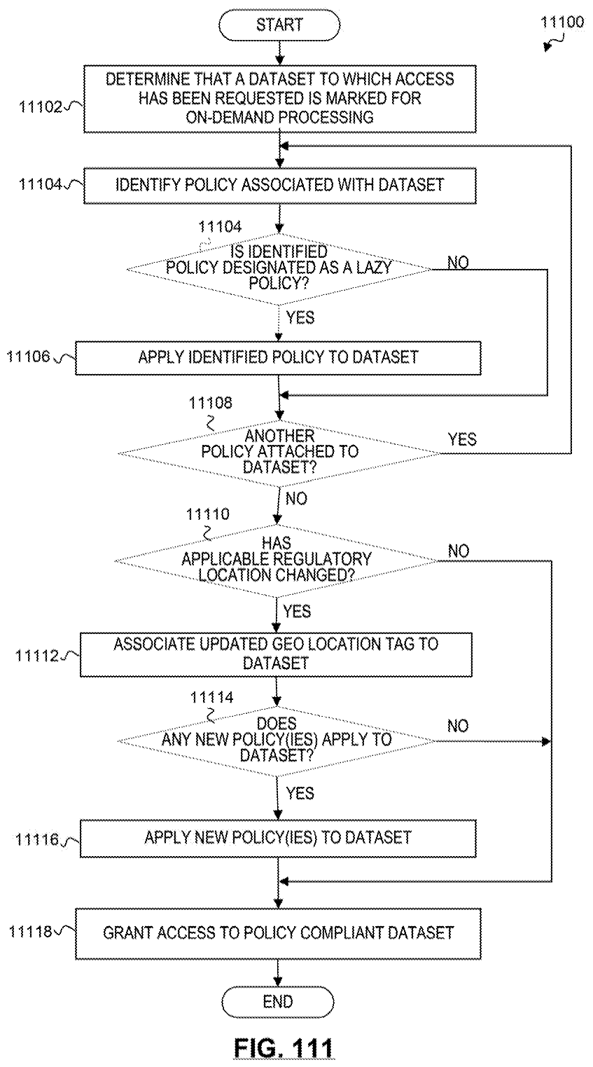

FIG. 111 is a simplified flowchart that illustrates a high-level possible flow 11100 of operations associated with policy enforcement in an on-demand privacy compliance system, such as system 10100. In at least one embodiment, a set of operations corresponds to activities of FIG. 111. A vehicle data system, such as vehicle data system 10400, may utilize at least a portion of the set of operations. Vehicle data system 10400 may include one or more data processors (e.g., 10127 for a cloud vehicle data system, 10157 for an edge vehicle data system), for performing the operations. In at least one embodiment, policy enforcement engine 10430 performs one or more of the operations. Generally, flow 11100 may be applied to a dataset that has been marked for on-demand processing.

It should be noted that, in at least one embodiment, when a request for access to a dataset is received, a determination may be made as to whether the dataset is marked for on-demand processing. If the dataset is marked for on-demand processing, then at 11102, a determination is made that the dataset to which access has been requested is marked for on-demand processing. Because the dataset has been marked for on-demand processing, at least one policy associated with the dataset is designated as a lazy policy. A request for access to the dataset may be a request from any device or application, for example, to read, share, receive, sample, or access the dataset in any other suitable manner.

At 11104, a policy associated with the dataset is identified. At 11104, a determination is made as to whether the identified policy is designated as lazy. If it is determined that the identified policy is designated as lazy, then the identified policy is applied to the dataset at 11106. If the identified policy is not designated as lazy, or once the identified policy is applied to the dataset, at 11108, a determination is made as to whether another policy is associated with the dataset. If another policy is associated with the dataset, the flow passes back to 11104 to identify another policy associated with the dataset and continue processing as previously described. Flow may continue looping until all policies associated with the dataset and designated as lazy have been applied to the dataset.

If it is determined at 11108 that another policy is not associated with the dataset, then at 11110, a determination is made as to whether the applicable regulatory location has changed. For example, if a vehicle stores a dataset locally (e.g., in the vehicle) with at least one policy designated as lazy, and if the vehicle then moves into another regulatory area, then an evaluation may be performed to determine whether the new regulatory area requires additional privacy-compliance actions. Thus, if the applicable regulatory location has not changed, then flow may pass to 11118 to grant access to the policy compliant dataset.

If the applicable regulatory location has changed, then at 11112, an updated geo location tag is associated to the dataset. At 11114, a determination is made as to whether any new one or more policies apply to the dataset. If no new policies apply to the dataset (based at least in part on the new geo location tag), then flow may pass to 11118 to grant access to the policy compliant dataset.

If at least one new policy does apply to the dataset, then at 11116, the new policy (or multiple new policies) are applied to the dataset. Then, at 11118, access can be granted to the policy compliant dataset.

It should be noted that if a dataset is not marked for on-demand processing and a request for access to the dataset is received, then in at least one embodiment, a determination is made that the dataset is policy-compliant and flow may proceed at 11110. Thus, a policy-compliant dataset may still be evaluated to determine whether a new regulatory location of the vehicle affects the policies to be applied to the dataset.

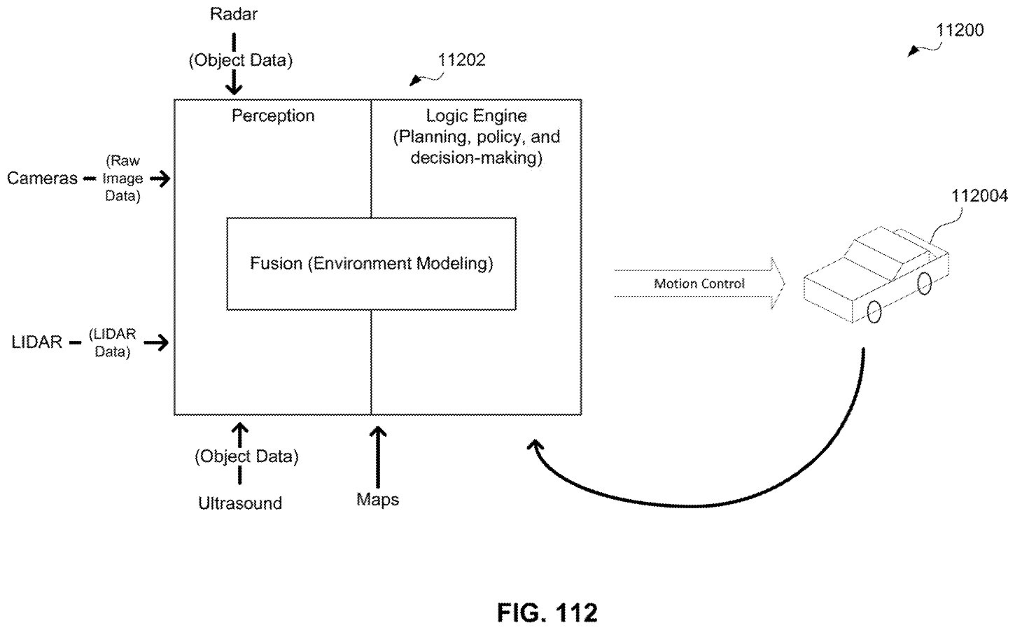

FIG. 112 is a simplified diagram of a control loop for automation of an autonomous vehicle 11210 in accordance with at least one embodiment. As shown in FIG. 112, automated driving may rely on a very fast feedback loop using a logic engine 11202 (which includes perception, fusion planning, driver policy, and decision-making aspects), and Distributed Actuation of the AV 11204 based on the output of such engines. Each of these meta-modules may be dependent on input or processing that is assumed to be trustworthy.

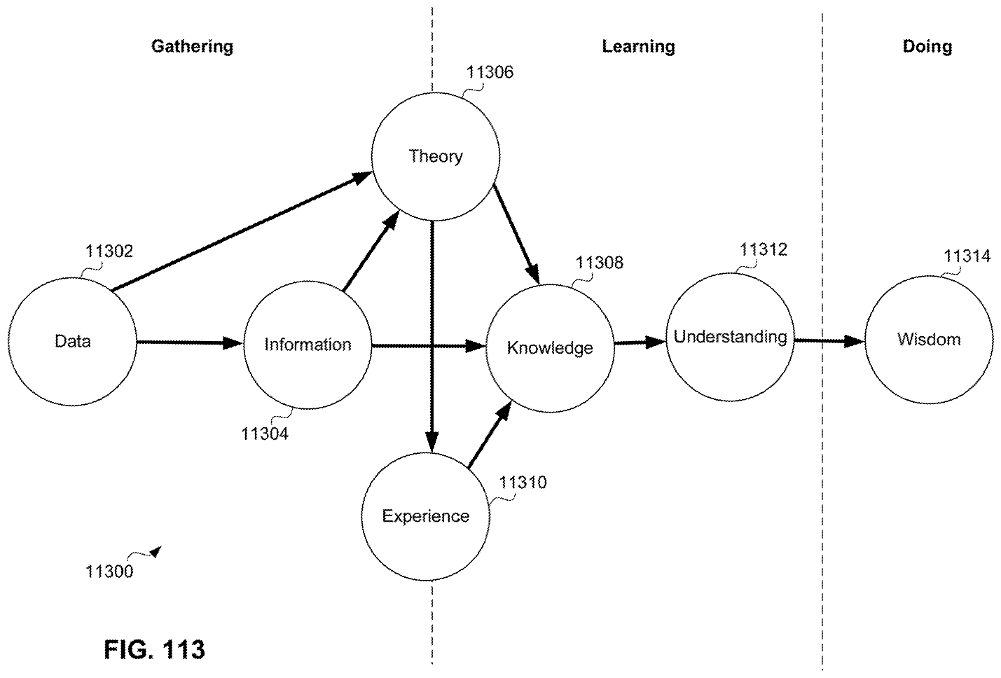

FIG. 113 is a simplified diagram of a Generalized Data Input (GDI) for automation of an autonomous vehicle in accordance with at least one embodiment. In the context of automated driving and transportation in smart cities and smart infrastructure, input can take the form of raw data 11302 (e.g., numbers, symbols, facts), information 11304 (e.g., data processed and organized to model), knowledge 11308 (e.g., collected information, which may be structured or contextual), experiences 11310 (e.g., knowledge gained through past action), theory frameworks 11306 (e.g., for explaining behaviors), or understanding 11312 (e.g., assigning meaning, explaining why a behavior occurred, or applying analysis). Each of these different types of inputs may be referred to as Generalized Data Input (GDI). As shown in FIG. 113, the GDI may be used to provide wisdom (e.g., judgment, evaluated understanding, proper/good/correct/right actions). The data displayed may be stored by any suitable type of memory and/or processed by one or more processors of an in-vehicle computing system of an autonomous vehicle.

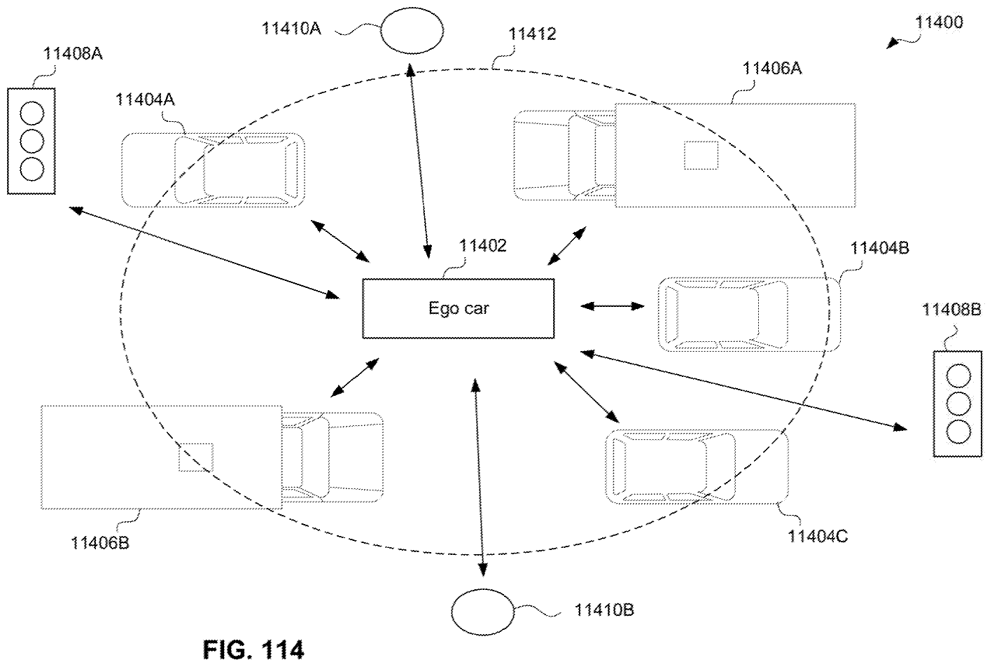

FIG. 114 is a diagram of an example GDI sharing environment 11400 in accordance with at least one embodiment. In the example shown, there is an ego vehicle (e.g., a subject autonomous vehicle) 11402 surrounded by other vehicle actors 11404, and fleet vehicle actors 11406 in a neighborhood 11412 around the ego vehicle 11402. In addition, there are infrastructure sensors around the ego vehicle 11402, including traffic light sensors 11408 and street lamp sensors 11410.

As shown, the ego vehicle 11402 may be in communication with one or more of the other actors or sensors in the environment 11400. GDI may be shared among the actors shown. The communication between the ego vehicle 11402 and the other actors may be implemented in one or more of the following scenarios: (1) self-to-self, (2) broadcast to other autonomous vehicles (1:1 or 1:many), (3) broadcast out to other types of actors/sensors (1:1 or 1:many), (4) receive from other autonomous vehicles (1:1 or 1:many), or (5) receive from other types of actors/sensors (1:1 or 1:many).

In some embodiments, the ego vehicle 11402 may process GDI generated by its own sensors, and in some cases, may share the GDI with other vehicles in the neighborhood 11400 so that the other vehicles may use the GDI to make decisions (e.g., using their respective logic engines for planning and decision-making). The GDI (which may be assumed to be trusted) can come from the ego autonomous vehicle's own heterogeneous sensors (which may include information from one or more of the following electronic control units: adaptive cruise control, electronic brake system, sensor cluster, gateway data transmitter, force feedback accelerator pedal, door control unit, sunroof control unit, seatbelt pretensioner, seat control unit, brake actuators, closing velocity sensor, side satellites, upfront sensor, airbag control unit, or other suitable controller or control unit) or from other GDI actor vehicles (e.g., nearby cars, fleet actor vehicles, such as buses, or other types of vehicles), Smart City infrastructure elements (e.g., infrastructure sensors, such as sensors/computers in overhead light posts or stoplights, etc.), third-party apps such as a Map service or a Software-update provider, the vehicles' OEMs, government entities, etc. Further, in some embodiments, the ego vehicle 11402 may receive GDI from one or more of the other vehicles in the neighborhood and/or the infrastructure sensors. Any malicious attack on any one of these GDI sources can result in the injury or death of one or more individuals. When malicious attacks are applied to vehicles in a fleet, a city, or an infrastructure, vehicles could propagate erroneous actions at scale with horrific consequences, creating chaos and eroding the public's trust of technologies.

In some instances, sharing data with potentially untrusted sources may be done via blockchain techniques. Sharing GDI may include one or more of the following elements implemented by one or more computing systems associated with a vehicle:
A Structure for packaging the GDI.
The Topology that describes how the GDI is related to other GDI
Permission Policies (e.g., similar to chmod in Linux/Unix systems), for instance:
Read-Access Policy to determine who can read the GDI
A Write-Control Policy to determine who can write the GDI
An Execute-Control Policy to determine who can actually execute executable GDI components (for instance, running a model, updating software, etc.).
A State policy to determine valid state of the Topology
Ownership Policies applied to the GDI (similar to chgrp/chown in Linux/Unix systems). For instance, Self, Group, All.

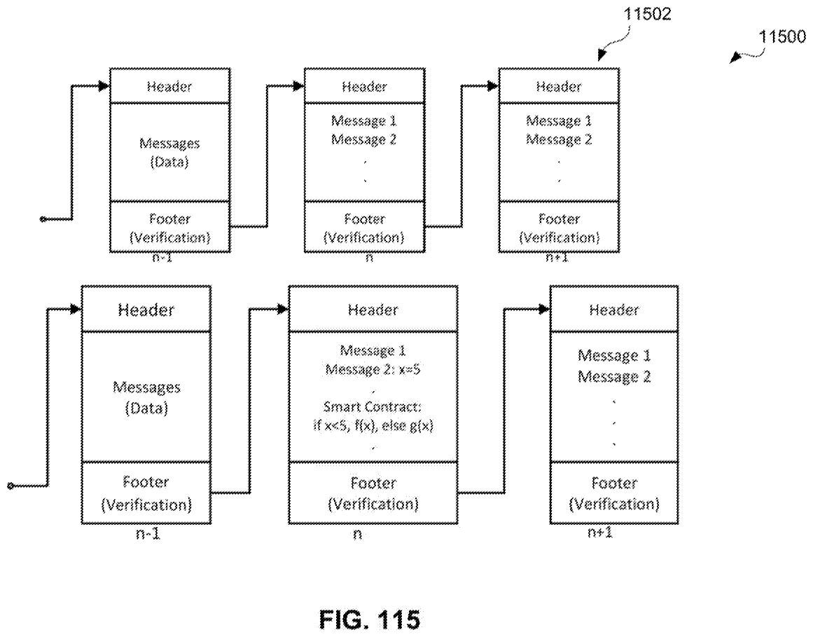

FIG. 115 is a diagram of an example blockchain topology 11500 in accordance with at least one embodiment. As shown, the structure of the GDI may include a “block” 11502 that includes a header, a body (that includes the GDI details), and a footer. The topology includes a linked-list of blocks (or, a linear network), with a cryptographic-based header and footer (see, e.g., FIG. 115). The header of a block, n, in a chain contains information that establishes it as the successor to the precursor block, n−1, in the linked-list. In some instances, computing system(s) implementing the blockchain (e.g., by storing blocks and verifying new blocks) may enforce one or more of the following elements:
Permission Policies, which may include, for instance:

1. A Read-Access Policy to indicate who can read the block information is based on public-private key pair matches generated from cryptographic hashes such Elliptic Curve Digital Signal Algorithm.

2. A Write-Control Policy to indicate who can append the blocks, and thus, who can ‘write’ the header information into the appending block is based on ability to verify the previous block with the time-to-verify being the crucial constraint.

3. An Execute-Control Policy embedded in the block information as a smart contract.
A State Policy based on distributed consensus to determine which state of the blockchain is valid when conflicting state information is presented. The reward for establishing the ‘valid state’ is write-control permission. Examples of this include Proof of Work (the first miner that solves a cryptographic puzzle, within a targeted elapsed time and whose difficulty is dynamically throttled by a central platform, is deemed to have established the ‘valid state’ and is thus awarded the write-control permission at that particular time), Proof of Stake (assigns the cryptographic puzzle to the miner with the highest stake/wealth/interest and awards the write-control permission to that miner once the puzzle is solved), Proof of Burn (awards the write-control permission in exchange for burning down their owned currency), etc.
Ownership information, which may be captured within the Message details.

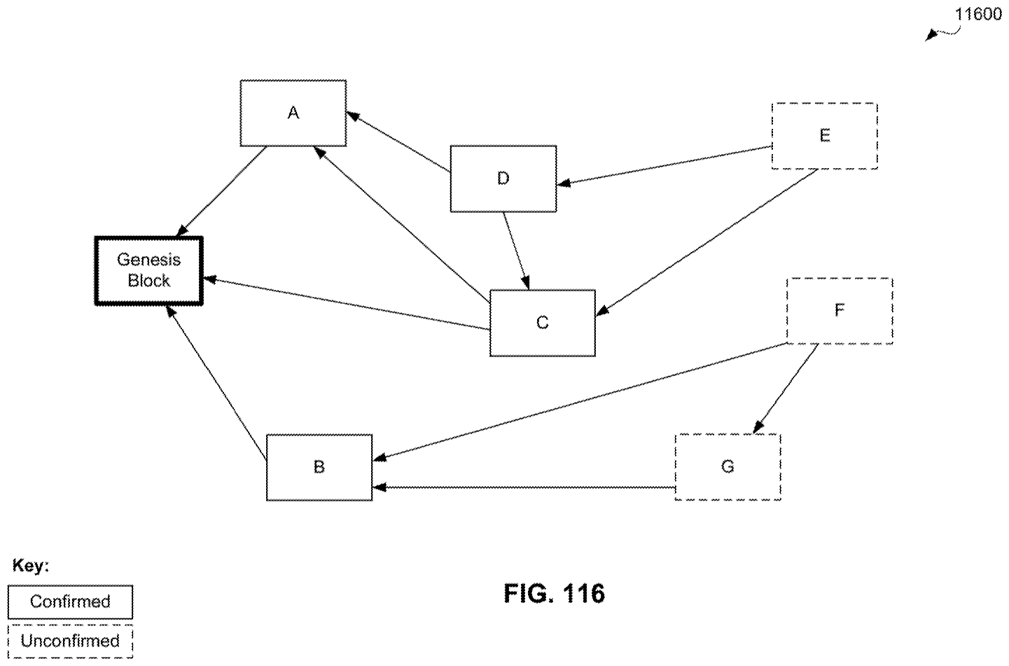

FIG. 116 is a diagram of an example “chainless” block using a directed acyclic graph (DAG) topology 11600 in accordance with at least one embodiment. In some instances, to address scalability, new platforms using DAGs, such as the IOTA platform, have been developed. In DAGs, the State policy (and thus the write-control permission) may be based on Proof of work, which may be used to confirm previous blocks to any currently unconfirmed blocks.

However, in some cases, block-like technologies such as these may present challenges, through one or more of the permission policy, the state policy, or the scalability of the given platform. For example, inherent in the permission and state policies may be the utilization of Elliptic curve cryptography (ECC) which has been sufficient to date, but these cryptography technologies may be insufficient going forward. For instance, ECC-based signatures (which are based on elliptic curve discrete log problems) may be one of the riskiest components of the technology when subjected to efficient quantum algorithms, with the most insecure components being: (1) a static address associated with the public key, and (2) unprocessed blocks (blocks not yet appended to the blockchain or to the Block-DAG). Further, such technologies may be susceptible to supply chain intercepts by bad actors (e.g., for fleet vehicle actors).

Example issues with such block-like technologies, and systems, include issues with permission policies. If the static address is stolen, all of its associated data and transactions and monetary value may become the property of the hacker-thief. This is because the hacker-thief may gain read, write, and/or execute permissions up through full ownership. Other issues may pertain to state policies. For instance, in the case of unprocessed blocks, quantum algorithms are estimated to be able to derive the private key from the public key by the year 2028. In particular, Schor's algorithm can determine prime factors using a quantum computer. And Grover's algorithm can do a key search. With the private key and the address known, it is possible to introduce new blocks (possibly with harmful data or harmful contracts) from that address. The Read-Access and Consensus (and thus Write-Control) have been based on elliptic curve cryptography. However, breaches in cryptocurrency implementations have led to significant monetary losses. With current blockchain technologies proposed for autonomous vehicles, theft of address or theft of message (inclusive of theft of smart contracts) can reverberate through the vehicle's feedback loop negatively up to loss of human life and/or catastrophic damage to infrastructure. Other issues may correspond to scalability. Modern decentralized blockchain technologies currently execute <20 transactions per second (using a decentralized peer-to-peer push model) whereas VisaNet can execute up to 56K transaction messages per second (using a centralized pull model). For Automated Driving and Smart Cities, transactions have to be executed at least on the order of VisaNet.

Accordingly, aspects of the present disclosure may include one or more of the following elements, which may be implemented in an autonomous driving computing system to help to address these issues:
Within the autonomous vehicle, one or more secure private keys (e.g., utilizing Intel SGX (Software Guard Extension)) may be created. The private keys may be used to generate respective corresponding public keys.
Digital signatures may be used for all data based on the private key. The digital signature may be a hash of the sensor data, which is then encrypted using the private key.
A permission-less blockchain may be used inside the autonomous vehicle (e.g., might not need to verify someone adding to the blockchain). All communication buses may be able to read blocks, and the internal network of the autonomous vehicle may determine who can write to the blockchain.
The autonomous vehicle may interface to a permissioned blockchain (e.g., with an access policy that may be based on a vehicle type, such as fleet vehicle (e.g., bus) vs. owned passenger vehicle vs. temporary/rented passenger vehicle (e.g., taxi); read access may be based on key agreements) or dynamic-DAG system when expecting exogenous data. Read access may be subscription based, e.g., software updates can be granted based on paid-for upgrade policies.
When broadcasting data for data sharing, ephemeral public keys (e.g., based on an ephemeral elliptic curve Diffie Hellman exchange or another type of one-time signature scheme) may be used to generate a secret key to unlock the data to be shared.

By using digital signatures, a time stamp and a truth signature may be associated with all data, for further use downstream. Static private keys may be maintained in a secure enclave. In addition, by setting the time constraints on the consensus protocol to be on the order of the actuation time adjustments (e.g., milliseconds), spoofing or hacking attempts directed at one or more sensors may be deterred. Further, network/gateway protocols (at the bus interface or gateway protocol level), within the autonomous vehicle's internal network(s), may only relay the verified blockchain. Additionally, by creating an intra-vehicle database (via the blockchain), a “black box” (auditable data recorder) may be created for the autonomous vehicle.

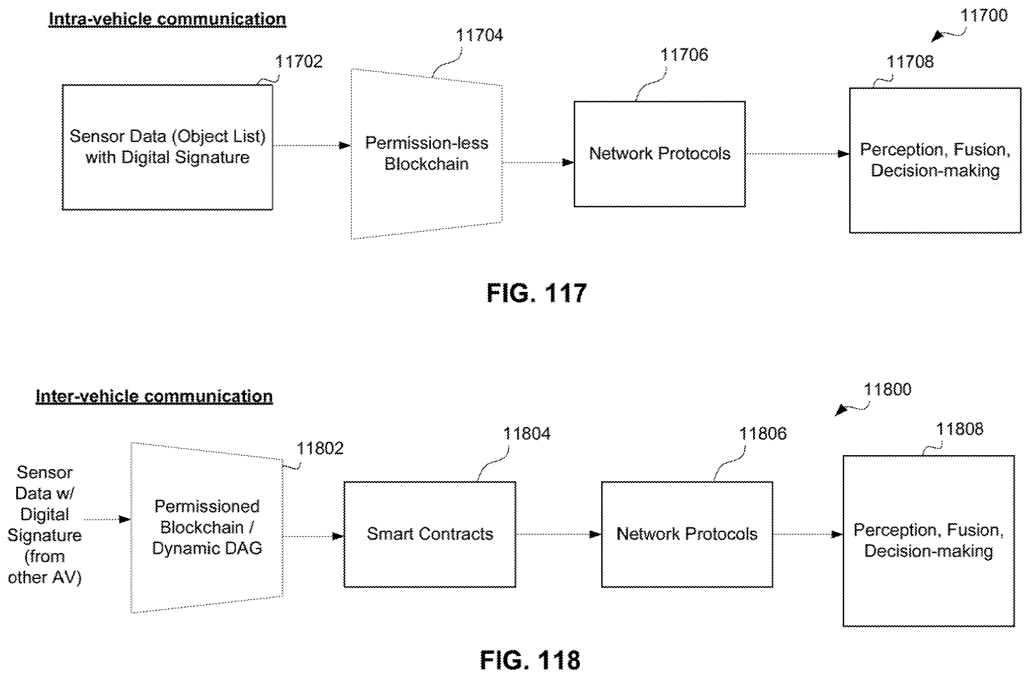

FIG. 117 is a simplified block diagram of an example secure intra-vehicle communication protocol 11700 for an autonomous vehicle in accordance with at least one embodiment. For example, the protocol 11700 may be used by the ego vehicle 11402 of FIG. 114 to secure its data against malicious actors. The example protocol may be used for communicating data from sensors coupled to an autonomous vehicle (e.g., LIDAR, cameras, radar, ultrasound, etc.) to a logic unit (e.g., a logic unit similar to the one described above with respect to FIG. 112) of the autonomous vehicle. In the example shown, a digital signature is appended to sensor data (e.g., object lists). The digital signature may be based on a secure private key for the sensor. The private key may be generated, for example, based on, for an ECC-based protocol such as secp256k1. In some cases, the digital signature may be generated by hashing the sensor data and encrypting the hash using the private key.

The sensor data 11702 (with the digital signature) is added as a block in a block-based topology (e.g., permission-less blockchain as shown) 11704 before being communicated to the perception, fusion, decision-making logic unit 11708 (e.g., an in-vehicle computing system) over certain network protocols 11706. In certain embodiments, only the data on the blockchain may be forwarded by the network/communication protocol inside the autonomous vehicle. The network protocol may verify the data of the block (e.g., comparing a time stamp of the sensor data with a time constraint in the consensus protocol of a blockchain) before communicating the block/sensor data to the logic unit. Further, in certain embodiments, the network protocol may verify the digital signature of the sensor data in the block before forwarding the block to the logic unit. For example, the network protocol may have access to a public key associated with a private key used to generate the digital signature of the sensor data, and may use the public key to verify the digital signature (e.g., by unencrypting the hash using the public key and verifying the hashes match). The blockchain 11704 may be considered permission-less because it does not require any verification before adding to the blockchain. In some cases, one or more aspects of the autonomous vehicle may determine who can write to the blockchain. For instance, during drives through unsavory neighborhoods, triggered by camera detection of ‘unsavory’ neighborhood or navigation map alert, it is possible that the autonomous vehicle's internal networks may revert to verify all until such time as the vehicle has safely exited the neighborhood.

FIG. 118 is a simplified block diagram of an example secure inter-vehicle communication protocol 11800 for an autonomous vehicle in accordance with at least one embodiment. For example, the protocol 11800 may be used by the ego vehicle 11402 of FIG. 114 to verify data from one or more of the other vehicles, backend (e.g., cloud-based) support systems, or infrastructure sensors. The example protocol may be used for communicating sensor data from an autonomous vehicle (which may include an owned vehicle, temporary/rented vehicle, or fleet vehicle) to a logic unit (e.g., a logic unit similar to the one described above with respect to FIG. 112) of another autonomous vehicle. In the example shown, sensor data from a first autonomous vehicle (which may include a digital signature as described above) is added as a block in a block-based topology (e.g., permissioned blockchain or node of a dynamic DAG) 11802 and is sent to a second autonomous vehicle, where one or more smart contracts 11804 are extracted. The Smart Contracts may contain information such as new regulatory compliance processing policies or even executable code that may override how data is processed in the perception, fusion, decision-making logic unit 11808. For instance, a new policy may override the perception flow so that the camera perception engine component that detects pedestrians/people and their faces, can only extract facial landmarks, pose, motion, but not their entire feature maps. Similarly, if the first autonomous vehicle happens to be a government police car, the smart contract may contain a temporary perception processing override and a license plate search to detect if the current autonomous vehicle's cameras have identified a license plate of interest in its vicinity.

In certain embodiments, exogenous data and software updates to the vehicle may arrive as a smart contract. If the smart contracts and/or sensor data are verified by the network protocol 11806, the sensor data is then communicated to the perception, fusion, decision-making logic unit 11808 of the second autonomous vehicle. In some cases, the network protocol may use ephemeral public keys (e.g., based on elliptic curve Diffie-Hellman). Using ephemeral public keys in dynamic environments allows public keys to be created and shared on the fly, while the car is momentarily connected to actor vehicles or the infrastructure it passes along its drive. This type of ephemeral key exchange allows secure data exchange for only the small duration of time in which the ego car is connected.

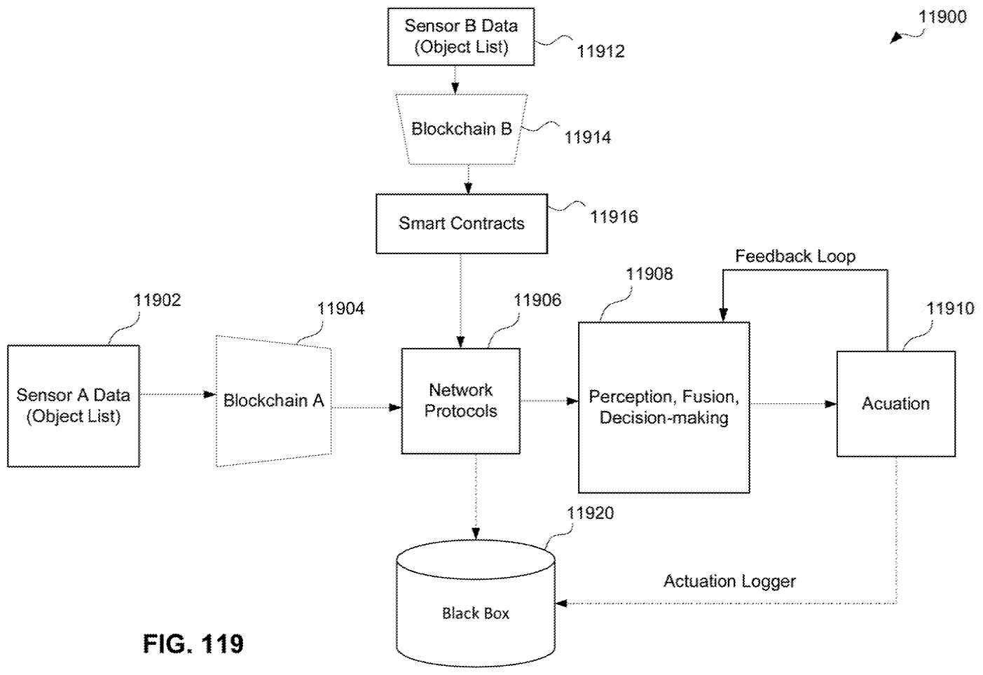

FIG. 119 is a simplified block diagram of an example secure intra-vehicle communication protocol for an autonomous vehicle in accordance with at least one embodiment. In the example shown, the secure intra-vehicle communication protocol utilizes two blockchains (A and B) that interact with each other. In addition, the intra-vehicle communication protocol utilizes an in-vehicle “black box” database 11920. The example sensor data 11902 and 11912, blockchains 11904 and 11914, network protocols 11906, and logic unit 11908 may be implemented similar to the like components shown in FIG. 117 and described above, and the smart contracts 11916 may be implemented similar to the smart contracts 11804 shown in FIG. 118 and described above.

In the example shown, the information generated by the logic unit 11908 may be provided to an actuation unit 11910 of an autonomous vehicle to actuate and control operations of the autonomous vehicle (e.g., as described above with respect to FIG. 112), and the actuation unit may provide feedback to the logic unit. After being used for actuation, the sensor data 11902, information generated by the logic unit 11908, or information generated by the actuation unit 11910 may be stored in an in-vehicle database 11920, which may in turn act as a “black box” for the autonomous vehicle.

The “black box” may act similar to black boxes used for logging of certain aspects and communication and data used for providing air transportation. For instance, because the GDI recorded in the blockchain is immutable, if it is stored in a storage system inside the autonomous vehicle, it can be recovered by government entities in an accident scenario, or by software system vendors during a software update. This GDI can then be used to simulate a large set of potential downstream actuations. Additionally, if the actuation logger also records to the storage system, then the endpoint actuation logger data, together with upstream GDI, can be used to winnow down any errant intermediate stage. This would provide a high probability of fault identification within the autonomous vehicle, with attribution of fault to internals of the ego vehicle, to errant data from actor vehicles, fleets, infrastructure, or other third party.

An autonomous vehicle may have a variety of different types of sensors, such as one or more LIDARs, radars, cameras, global positioning systems (GPS), inertial measurement units (IMU), audio sensors, thermal sensors, or other sensors (such as those described herein or other suitable sensors). The sensors may collectively generate a large amount of data (e.g., terabytes) every second. Such data may be consumed by the perception and sensor fusion systems of the autonomous vehicle stack. In many situations, the sensor data may include various redundancies due to different sensors capturing the same information or a particular sensor capturing information that is not changing or only changing slightly (e.g., while driving on a quiet highway, during low traffic conditions, or while stopped at a stoplight). These redundancies may significantly increase the requirement of resources such as hardware, special data handling big data ecosystems, sensor fusion algorithms, and other algorithm optimizations used to process data in near real time in different stages of the processing pipeline. In some systems, in order to improve a signal-to-noise ratio (SNR) of the sensor system, sensor fusion algorithms (such as algorithms based on, e.g., Kalman filters) may combine data from multiple sensors using equal weights. This may result in an improved SNR relative to data from a single sensor due to an improvement in overall variance.

In particular embodiments of the present disclosure, an improved sensor fusion system may utilize lower quality signals from cost-effective and/or power efficient sensors, while still fulfilling the SNR requirement of the overall system, resulting in a cost reduction for the overall system. Various embodiments may reduce drawbacks associated with sensor data redundancy through one or both of 1) non-uniform data sampling based on context, and 2) adaptive sensor fusion based on context.

In a particular embodiment, a sampling system of an autonomous vehicle may perform non-uniform data sampling by sampling data based on context associated with the autonomous vehicle. The sampling may be based on any suitable context, such as frequency of scene change, weather condition, traffic situation, or other contextual information (such as any of the contexts described herein). Such non-uniform data sampling may significantly reduce the requirement of resources and the cost of the overall processing pipeline. Instead of sampling data from every sensor at a set interval (e.g., every second), the sampling of one or more sensors may be customized based on context.

In one embodiment, a sampling rate of a sensor may be tuned to the sensitivity of the sensor for a given weather condition. For example, the sampling rate for a sensor that is found to produce useful data when a particular weather condition is present may be sampled more frequently than a sensor that produces unusable data during the weather condition. In some embodiments, the respective sampling rates of various sensors are correlated with a density of traffic or rate of scene change. For example, a higher sampling rate may be used for one or more sensors in dense traffic relative to samples captured in light traffic. As another example, more samples may be captured per unit time when a scene changes rapidly relative to the number of samples captured when a scene is static. In various embodiments, a sensor having a high cost, a low throughput per unit of power consumed, and/or high power requirements is used sparingly relative to a sensor with a low cost, a high throughput per unit of power consumed, and/or lower power requirements to save on cost and energy, without jeopardizing safety requirements.

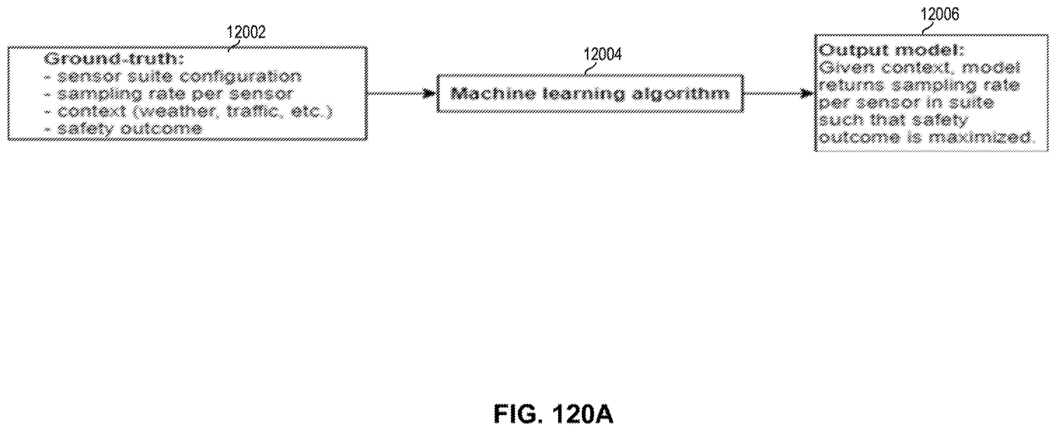

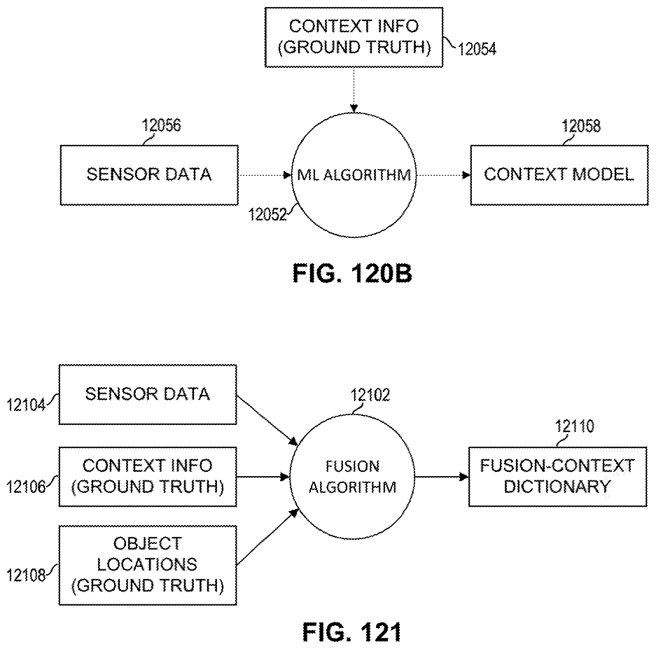

FIG. 120A depicts a system for determining sampling rates for a plurality of sensors in accordance with certain embodiments. The system includes ground-truth data 12002, a machine learning algorithm 12004, and an output model 12006. The ground-truth data 12002 is provided to the machine learning algorithm 12004 which processes such data and provides the output model 12006. In a particular embodiment, machine learning algorithm 12004 and/or output model 12006 may be implemented by machine learning engine 232 or a machine learning engine of a different computing system (e.g., 140, 150).

In the present example, ground-truth data 12002 may include sensor suite configuration data, a sampling rate per sensor, context, and safety outcome data. Ground-truth data 12002 may include multiple data sets that each correspond to a sampling time period and indicate a sensor suite configuration, a sampling rate used per sensor, context for the sampling time period, and safety outcome over the sampling time period. A data set may correspond to sampling performed by an actual autonomous vehicle or to data produced by a simulator. Sensor suite configuration data may include information associated with the configuration of sensors of an autonomous vehicle, such as the types of sensors (e.g., LIDAR, 2-D camera, 3-D camera, etc.), the number of each type of sensor, the resolution of the sensors, the locations on the autonomous vehicle of the sensors, or other suitable sensor information. Sampling rate per sensor may include the sampling rate used for each sensor in a corresponding suite configuration over the sampling time period. Context data may include any suitable contextual data (e.g., weather, traffic, scene changes, etc.) present during the sampling time period. Safety outcome data may include safety data over the sampling time period. For example, safety outcome data may include an indication of whether an accident occurred over the sampling time period, how close an autonomous vehicle came to an accident over the sampling time period, or other expression of safety over the sampling time period.

Machine learning algorithm 12004 may be any suitable machine learning algorithm to analyze the ground truth data and output a model 12006 that is tuned to provide sampling rates for each of a plurality of sensors of a given sensor suite based on a particular context. A sampling rate for each sensor is learned via the machine learning algorithm 12004 during a training phase. Any suitable machine learning algorithm may be used to provide the output model 12006. As non-limiting examples, the machine learning algorithm may include a random forest, support vector machine, any suitable neural network, or a reinforcement algorithm (such as that described below or other reinforcement algorithm). In a particular embodiment, model 12006 may be stored with machine learning models 256.

Output model 12006 may be used during an inference phase to output a vector of sampling rates (e.g., one for each sensor of the sensor suite being used) given a particular context. In various embodiments, the output model 12006 may be tuned to decrease sampling rates or power used during sampling as much as possible while still maintaining an acceptable level of safety (e.g., no accidents, rate of adherence to traffic laws, etc.). In other embodiments, the model 12006 may be tuned to favor any suitable operation characteristics, such as safety, power used, sensor throughput, or other suitable characteristics. In a particular embodiment, the model 12006 is based on a joint optimization between safety and power consumption (e.g., the model may seek to minimize power consumption while maintaining a threshold level of safety).

In addition, or as an alternative to varying the sampling rate of the sensors, in some embodiments, sensor fusion improvement is achieved by adapting weights for each sensor based on the context. The SNR (and consequently the overall variance) may be improved by adaptively weighting data from the sensors differently based on the context.

In a particular embodiment, to assist with object tracking, when the ground truth data are available for different contexts and object position at various instants under these different contexts, the fusion weights may be determined from the training data using a combination of a machine learning algorithm that predicts context and a tracking fusion algorithm that facilitates prediction of object position.

FIG. 120B depicts a machine learning algorithm 12052 to generate a context model 12058 in accordance with certain embodiments. In a particular embodiment, machine learning algorithm 12052 and context model 12058 may be executed by machine learning engine 232 or a machine learning engine of a different computing system (e.g., 140, 150). FIG. 120B depicts a training phase for building a ML model for ascertaining context. Machine learning algorithm 12052 may be any suitable machine learning algorithm to analyze sensor data 12056 and corresponding context information 12054 (as ground truth). The sensor data 12056 may be captured from sensors of one or more autonomous vehicles or may be simulated data. Machine learning algorithm 12052 outputs a model 12058 that is tuned to provide a context based on sensor data input from an operational autonomous vehicle. Any suitable type of machine learning algorithm may be used to train and output the output model 12058. As non-limiting examples, the machine learning algorithm for predicting context may include a classification algorithm such as a support vector machine or a deep neural network.

FIG. 121 depicts a fusion algorithm 12102 to generate a fusion-context dictionary 12110 in accordance with certain embodiments. FIG. 121 depicts a training phase for building a ML model for ascertaining sensor fusion weights. Fusion algorithm 12102 may be any suitable machine learning algorithm to analyze sensor data 12104, corresponding context information 12106 (as ground truth), and corresponding object locations 12108 (as ground truth). The sensor data 12104 may be captured from sensors of one or more autonomous vehicles or may be simulated data (e.g., using any of the simulation techniques described herein or other suitable simulation techniques). In some embodiments, sensor data 12104 may be the same sensor data 12056 used to train a ML model or may be different data, at least in part. Similarly, context information 12106 may be the same as context information 12054, or may be different information, at least in part. Fusion algorithm 12102 outputs a fusion-context dictionary 12110 that is tuned to provide weights based on sensor data input from an operational autonomous vehicle.

Any suitable machine learning algorithm may be used to train and implement the fusion-context dictionary. As a non-limiting example, the machine learning algorithm may include a regression model to predict the sensor fusion weights.

In various embodiments, the fusion algorithm 12102 is neural network-based. During training, the fusion algorithm 12102 may take data (e.g., sensor data 12104) from various sensors and ground truth context info 12106 as input, fuse the data together using different weights, predict an object position using the fused data, and utilize a cost function (such as a root-mean squared error (RMSE) or the like) that minimizes the error between the predicted position and the ground truth position (e.g., corresponding location of object locations 12108). In various embodiments, the fusion algorithm may select fusion weights for a given context to maximize object tracking performance. Thus, the fusion algorithm 12102 may be trained using an optimization algorithm that attempts to maximize or minimize a particular characteristic (e.g., object tracking performance) and the resulting weights of fusion-context dictionary 12110 may then be used to fuse new sets of data from sensors more effectively, taking into account the results of predicted conditions.

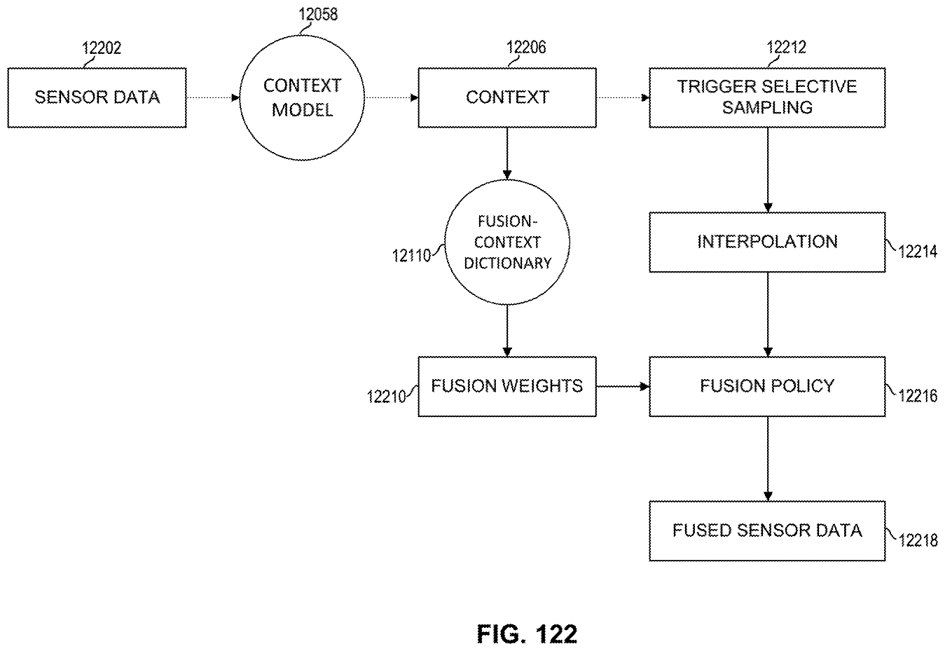

FIG. 122 depicts an inference phase for determining selective sampling and fused sensor weights in accordance with certain embodiments. In a particular embodiment, the inference phase may be performed by the machine learning engine 232 and/or the sensor fusion module 236. During the inference phase, sensor data 12202 captured by an autonomous vehicle is provided to context model 12058. The output of context model 12058 is context 12206. Context 12206 may be used to trigger selective sampling at 12212. For example, the context may be provided to output model 12006, which may provide a rate of sampling for each sensor of a plurality of sensors of the autonomous vehicle. The autonomous vehicle may then sample data with its sensors using the specified sampling rates.

At 12214, interpolation may be performed. For example, if a first sensor is being sampled twice as often as a second sensor and samples from the first and second sensor are to be fused together, the samples of the second sensor may be interpolated such that the time between samples for each sensor is the same. Any suitable interpolation algorithm may be used. For example, an interpolated sample may take the value of the previous (in time) actual sample. As another example, an interpolated sample may be the average of the previous actual sample and the next actual sample. Although the example focuses on fusion at the level of sensor data, fusion may additionally or alternatively be performed at the output also. For example, different approaches may be taken with different sensors in solving an object tracking problem. Finally, in the post analysis stage, complementary aspects of individual outputs are combined to produce fused output. Thus, in some embodiments, the interpolation may alternatively be performed after the sensor data is fused together.

The context 12206 may also be provided to the fusion-context dictionary 12110 and a series of fusion weights 12210 is output from the fusion-context dictionary 12110, where each fusion weight specifies a weight for a corresponding sensor. The fusion weights are used in the fusion policy module 12216 to adaptively weight the sensor data and output fused sensor data 12218. Any suitable fusion policy may be used to combine data from two or more sensors. In one embodiment, the fusion policy specifies a simple weighted average of the data from the two or more sensors. In other embodiments, more sophisticated fusion policies (such as any of the fusion policies described herein) may be used. For example, a Dempster-Shafer based algorithm may be used for multi-sensor fusion. The fused sensor data 12218 may be used for any suitable purposes, such as to detect object locations.

In various embodiments, simulation and techniques such as reinforcement learning can also be used to automatically learn the context-based sampling policies (e.g., rates) and sensor fusion weights. Determining how frequently to sample different sensors and what weights to assign to which sensors is challenging due to the large number of driving scenarios. The complexity of context-based sampling is also increased by the desire to achieve different objectives such as high object tracking accuracy and low power consumption without compromising safety. Simulation frameworks which replay sensor data collected in the real-world or simulate virtual road networks and traffic conditions provide safe environments for training context-based models and exploring the impact of adaptive policies.

In addition to the supervised learning techniques described above, in various embodiments, learning context-based sampling and fusion policies may be determined by training reinforcement learning models that support multiple objectives (e.g., both safety and power consumption). In various embodiments, any one or more of object detection accuracy, object tracking accuracy, power consumption, or safety may be the objectives optimized. In some embodiments, such learning may be performed in a simulated environment if not enough actual data is available. In a particular embodiment, reinforcement learning is used to train an agent which has an objective to find the sensor fusion weights and sampling policies that reduce power consumption while maintaining safety by accurately identifying objects (e.g., cars and pedestrians) in the vehicle's path. During training, safety may be a hard constraint such that a threshold level of safety is achieved, while reducing power consumption is a soft constraint which is desired but non-essential.

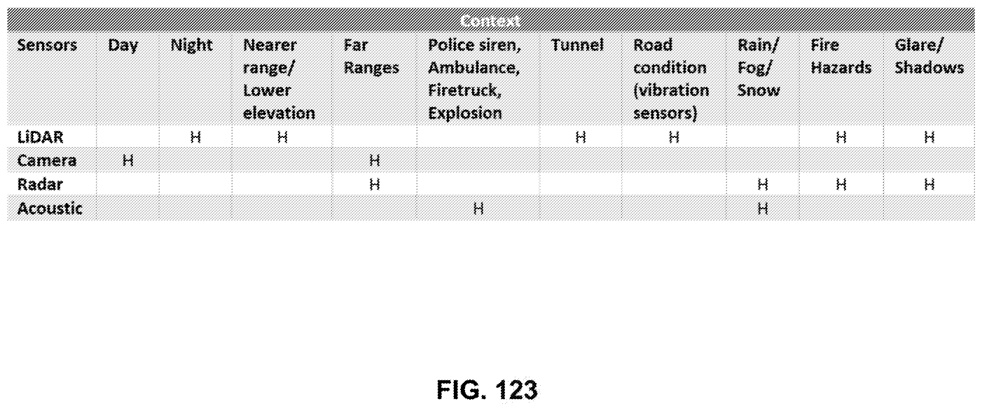

FIG. 123 presents differential weights of the sensors for various contexts. The H in the table represents scenarios where measurements from particular sensors are given a higher rating. As various examples, a LIDAR sensor is given a relatively greater weight at night than a camera sensor, radar sensor, or acoustic sensor, but during the day a camera sensor may be given a relatively greater weight.

FIG. 123 represents an example of outputs that may be provided by the fusion-context dictionary 12110 or by a reinforcement learning model described herein (e.g., this example represents relative weights of various sensors under different contexts). In other embodiments, the sensor weight outputs may be numerical values instead of the categorical high vs. low ratings shown in FIG. 123.

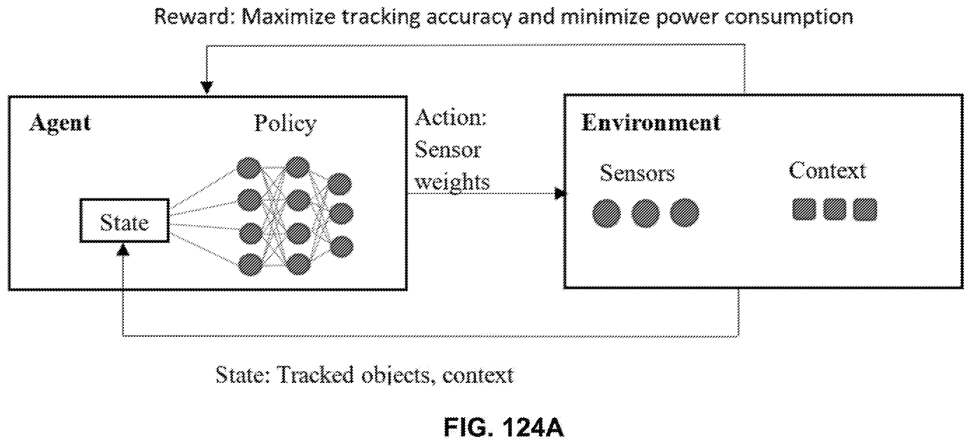

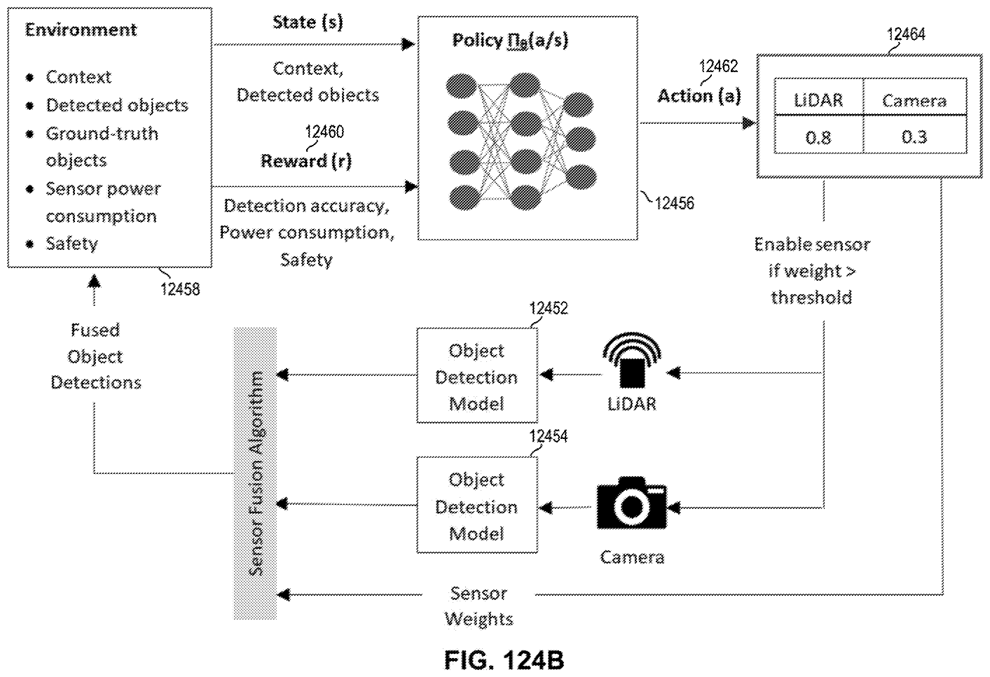

FIG. 124A illustrates an approach for learning weights for sensors under different contexts in accordance with certain embodiments. First, a model that detects objects as accurately as possible may be trained for each individual sensor, e.g., camera, LIDAR, or radar. Although any suitable machine learning models may be used for the object detection models, in some embodiments the objection detection models are supervised machine learning models, such as deep neural networks for camera data, or unsupervised models such as DBSCAN (Density-based spatial clustering of applications with noise) for LIDAR point clouds.

Next, a model may be trained to automatically learn the context-based sensor-fusion policies by using reinforcement learning. The reinforcement learning model uses the current set of objects detected by each sensor and the context to learn a sensor fusion policy. The policy predicts the sensor weights to apply at each time step that will maximize a reward which includes multiple objectives, e.g., maximizing object tracking accuracy and minimizing power consumption.

Thus, as depicted in FIG. 124A, the reinforcement learning algorithm agent (e.g., implemented by a machine learning engine of a computing system) may manage a sensor fusion policy based on an environment comprising sensor data and context and a reward based on outcomes such as tracking accuracy and power consumption and produce an action in the form of sensor weights to use during sensor fusion. Any suitable reinforcement learning algorithms may be used to implement the agent, such as a Q-learning based algorithm.

Under this framework, a weight for a particular sensor may be zero valued for a particular context. A zero-valued weight or a weight below a given threshold indicates that the sensor does not need to be sampled for that particular context as its output is not used during sensor fusion. In each time-step, the model generates a vector with one weight per sensor for the given context.

An alternative implementation of this approach may utilize a multi-agent (one agent per sensor) reinforcement learning model where each agent makes local decisions on weights and sampling rates but the model attempts to achieve a global objective (or combination of objectives) such as increased object tracking accuracy and low power consumption. In such an embodiment, a particular agent may be penalized if it makes a decision that is not achieving the global objective.

FIG. 124B illustrates a more detailed approach for learning weights for sensors under different contexts in accordance with certain embodiments. In this approach, an object detection model 12452 is trained for a LIDAR and an object detection model 12454 is trained for a camera. In a particular embodiment, the object detection model 12454 is a supervised machine learning model, such as deep neural network, and the object detection model, is an unsupervised model, such as DBSCAN for LIDAR point clouds.

As depicted in FIG. 124B, the reinforcement learning algorithm agent may manage a sensor fusion policy 12456 based on an environment 12458 comprising, e.g., context, detected objects, ground-truth objects, sensor power consumption, and safety and a reward 12460 based on outcomes such as detection accuracy, power consumption, and safety. An action 12462 may be produced in the form of sensor weights 12464 to use during sensor fusion. Any suitable reinforcement learning algorithms may be used to implement the agent, such as a Q-learning based algorithm.

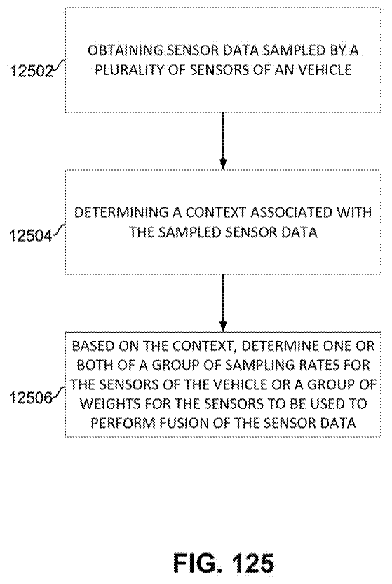

FIG. 125 depicts a flow for determining a sampling policy in accordance with certain embodiments. At 12502, sensor data sampled by a plurality of sensors of a vehicle is obtained. At 12504, a context associated with the sampled sensor data is obtained. At 12506, one or both of a group of sampling rates for the sensors of the vehicle or a group of weights for the sensors to be used to perform fusion of the sensor data are determined based on the context.

In various embodiments, any of the inference modules described above may be implemented by a computing system of an autonomous vehicle or other computing system coupled to the autonomous vehicle, while any of the training modules described above may be implemented by a computing system coupled to one or more autonomous vehicles (e.g., by a centralized computing system coupled to a plurality of autonomous vehicles) or by a computing system of an autonomous vehicle.

Although the above examples have been described with respect to object detection, the concepts may be applied to other autonomous driving operations, such as semantic segmentation and object tracking.

Level 5 (“L5”, fully autonomous) autonomous vehicles may use LIDAR sensors as a primary sending source which does not help economic scalability to wide end consumers. Level 2 (“L2”) or other lower-level autonomous vehicles (with lower levels of automation), on the other hand, may typically use cameras as a primary sensing source and may introduce LIDAR in a progressive mode (usually a low-cost version of a LIDAR sensor) for information redundancy and also correlation with the camera sensors. One piece of information that LIDAR provides over cameras is the distance between the vehicle and vehicles/objects in its surrounding, and also the height information of the surrounding vehicles and objects. However, LIDAR may be one of the most expensive sensor technologies to include in autonomous vehicles.

Accordingly, in some embodiments, a low-cost light-based communication technology may be used as a substitute for LIDAR sensors, to provide depth and height information that the LIDAR provides while providing a savings in the cost of the sensor by substituting information. Such communication modules may be deployed on autonomous vehicles, roadside units, and other systems monitoring traffic and events within a driving environment. In some implementations, Li-Fi (Light Fidelity) technology may be leveraged to convey (in real-time) the exact location of each vehicle, the vehicle's height, and any other information relevant to the vehicle's size/height that may be useful to surrounding vehicles to keep safe distance. The light-based communication technology (e.g., Li-Fi) may be applied to different types of vehicles, including automobiles, motor-cycles, and bicycles, by equipping the vehicles with light sources (e.g., LEDs) and photodetectors. Li-Fi can be applied between vehicles of different types (e.g., a bicycle can use LiFi to convey to a vehicle in its surrounding its location and any other useful information to help maintaining safe distance).

Li-Fi is an emerging technology for wireless communication between devices making use of light to transmit data (e.g., position information) over light waves. Li-Fi may be considered to be similar to Wi-Fi in terms of wireless communication (e.g., may utilize similar protocols, such as IEEE 802.11 protocols), but differs from Wi-Fi in that Li-Fi uses light communication instead of radio frequency waves, which may allow for much larger bandwidth. Li-Fi may be capable of transmitting high speed data over Visible Light Communication (VLC), where Gigabit per second (Gbps) bandwidths can be reached. Li-Fi may use visible light between 400 THz (780 nm) and 800 THz (375 nm) for communication, but may also, in some instances, use Ultra Violet (UV) or Infrared (IR) radiation for communication.

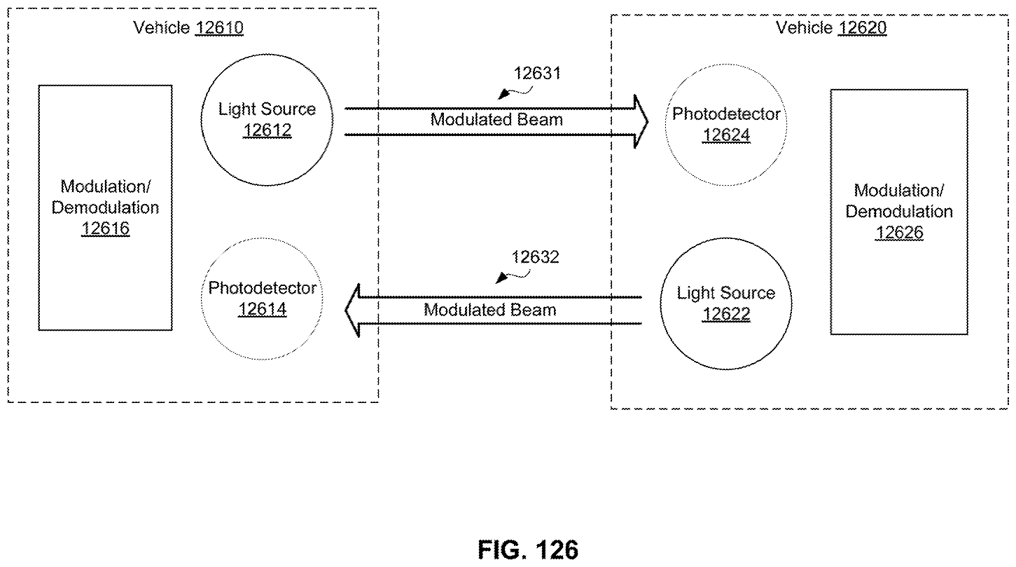

FIG. 126 is a simplified diagram of example VLC or Li-Fi communications between autonomous vehicles 12610, 12620 in accordance with at least one embodiment. In the example shown, a sending light source (e.g., 12612, 12622) of a vehicle (e.g., a lamp of the vehicle fitted with light emitting diodes (LEDs)) transmits a modulated light beam (e.g., 12631, 12632) to a photodetector (e.g., photodiode) of another vehicle. The vehicles may be equipped with signal processing modules (e.g., 12616, 12626) that modulate the light beam emitted so that the beam includes embedded data (e.g., position or height information for the sending vehicle as described above and further below) and demodulate received light signals. The photodetector (e.g., 12614, 12624) of the receiving vehicle receives the light signals from the sending vehicle and converts the changes in amplitude into an electrical signal (which is then converted back into data streams through demodulation). In some embodiments, simultaneous reception for a Li-Fi device from multiple light sources is possible through having photo sensors that include an array of photodetectors (e.g., photodiodes).

This can also allow multiple reception from multiple channels from one light source for increased throughput, in some instances, or from multiple light sources. The multiple channels may be implemented as different channels (wavelengths) on the light (visible, infrared, and/or ultraviolet) spectrum.

Position or other vehicle data (e.g., height of the vehicle, size of the vehicle, or other information that can help other surrounding vehicles create a structure of the transmitting vehicle) may be transmitted through modulation of light waves. The size of the transmitted data may be on the order of a few bytes. For example, position information for the vehicle may utilize approximately 12 digits and 2 characters if it follows the Degree Minute and Second (DMS) format (e.g., 40° 41′ 21.4″ N 74° 02′ 40.2″ W for the closest location to the statue of liberty), which may utilize approximately 7-8 bytes (e.g., 4 bits for each digit and 4 bits for each character of “ASCII code”). As another example, height information for the vehicle (e.g., in meters with one decimal digit) may utilize approximately 4 bits of data. As another example, size information for the vehicle (which may include a length and width of the vehicle in meters) may utilize approximately 1 byte of data for the length and 4 bits of data for the width (e.g., with 1-2 decimal digits for the length “considering buses” and 1 decimal digit for the width).

Any suitable modulation scheme can be used for the communication between the vehicles. Examples of modulation schemes that may be used in embodiments of the present disclosure include:
On-Off Keying (OOK) that is a form of Amplitude Shift Keying (ASK): where LEDs can be switched on or off to model a digital string of binary numbers
Variable pulse position modulation (VPPM): where M bits are encoded by transmitting single pulse in one of 2M possible required time shifts. This is repeated every T seconds (that is variable) to have bit rate (M/T bps)
Color-Shift Keying (CSK): is introduced in IEEE 802.15.7 standard that defines and it encodes data in the light using a mixture of red, green and blue LEDs and varying the flickering rate of each LED to transmit data

The sampling rate of the position, height, size or other information transmitted by a vehicle can take at least two forms. As one example, the sampling may be proactive, where each vehicle constantly sends its position (or other) information at a given frequency. For instance, proactive sampling may be chosen in highly crowded areas, high crash risk areas, or during night time. The photodetector in this case may be considered as a physical sensor bringing sensing “depth” information from the received data, with the sensor fusion constantly considering inputs from the photo-detector. As another example, the sampling may be event-based, where each vehicle sends its position information once it detects other vehicle(s) in its surrounding. The photodetector in this case may be considered as a physical sensor bringing sensing “depth” information from the received data on-demand whenever a traffic vehicle is detected in the surrounding, and the sensor fusion may consider inputs from the photodetector in an event-based manner.

In some cases, each vehicle may leverage existing light sources (front-light, back-light, side-light, or roof-placed LEDs) and modulate the light waves from those sources to transmit the required data at a particular frequency or in an event-driven form (e.g., when the vehicle cameras detect surrounding vehicles, or when the vehicle is stopped at a traffic light or stop sign).

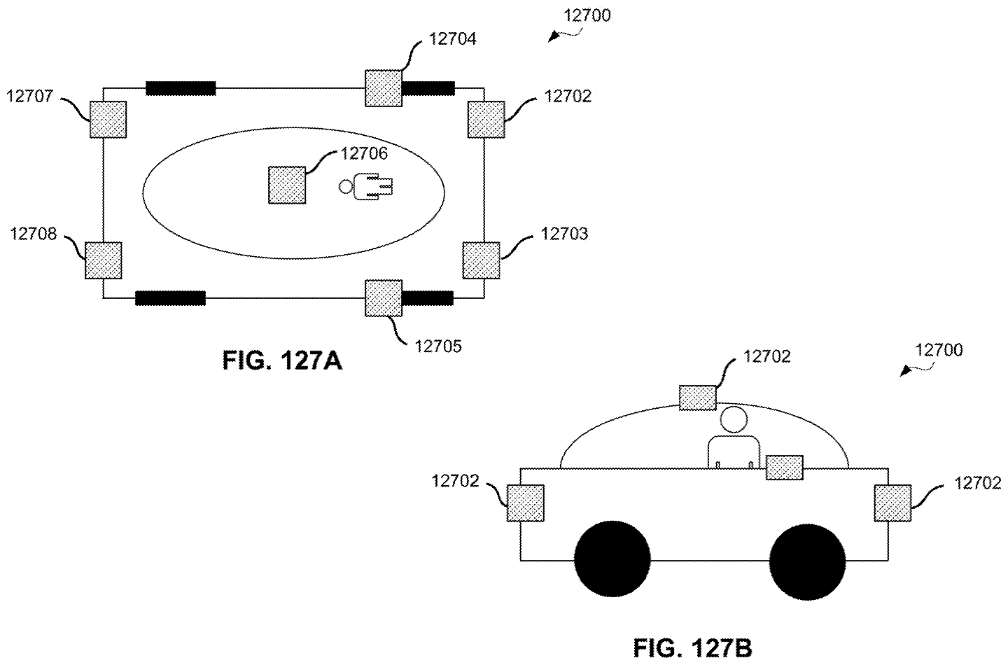

FIGS. 127A-127B are simplified diagrams of example VLC or Li-Fi sensor locations on an autonomous vehicle 12700 in accordance with at least one embodiment. FIG. 127A shows a bird's eye view of the autonomous vehicle 12700, while FIG. 127B shows a side view of the autonomous vehicle 12700. The autonomous vehicle 12700 includes sensors 12702, 12703, 12704, 12705, 12706, 12707, 12708. Each sensor may include both a light source (or multiple light sources, e.g., an array of LEDs) and a photodetector (or multiple photodetectors, e.g., an array of photodetectors). In some embodiments, existing light sources of the vehicles (e.g., front-lights (for sensors 12702, 12703), back-lights (for sensors 12707, 12708), and side-lights (for sensors 12704, 12705)) may be leveraged to communicate in real-time the position information for each vehicle to all field of view surrounding vehicles. This allows each vehicle to calculate the distance from all surrounding vehicles (substituting the depth information that the LIDAR currently provides). The height information can be provided (as well as size or any relevant information that can help maintaining safe distance and discovering the surrounding in real-time). Sensors may also be placed in other locations of the vehicle where there are no current light sources, such as on top of the vehicle as shown for sensor 12706. Sensors may also be placed in other locations on the autonomous vehicle 12700 than those shown in FIG. 127.

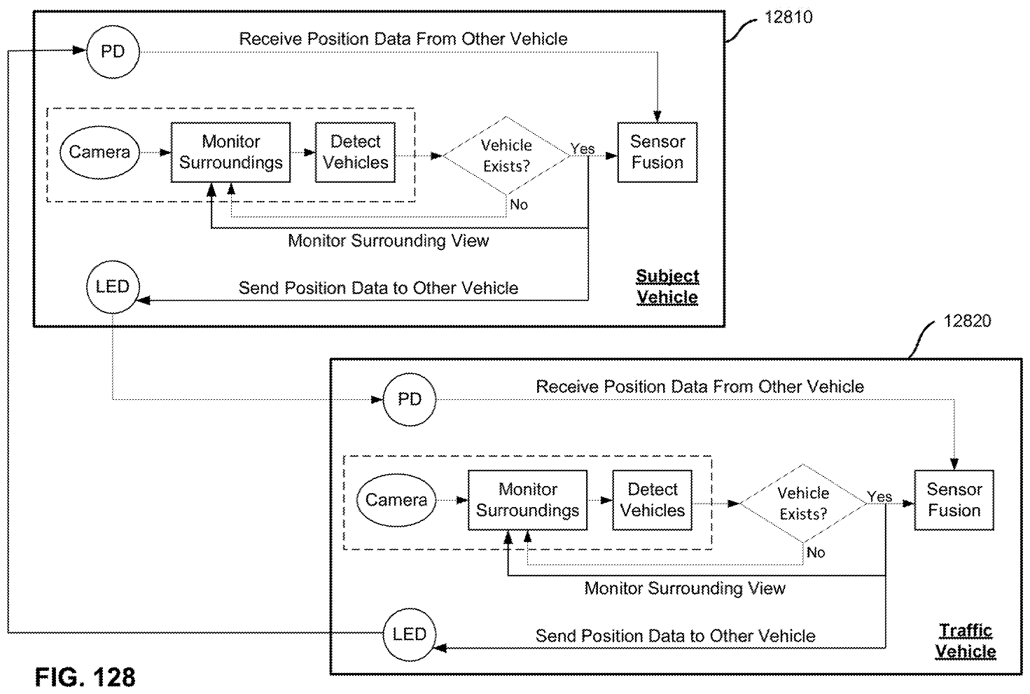

FIG. 128 is a simplified diagram of example VLC or Li-Fi communication between a subject vehicle 12810 and a traffic vehicle 12820 in accordance with at least one embodiment. In particular, FIG. 128 shows how a subject autonomous vehicle considers in its sensor fusion process the surrounding traffic vehicle(s) position information coming from a Li-Fi data transmission by a traffic vehicle (and how a traffic vehicle gets the position information of the subject vehicle in its surrounding in a similar way). The subject autonomous vehicle may utilize the same process to process other Li-Fi data transmissions from other traffic vehicles as well (not shown).

In the example shown, each vehicle is equipped with a vision system (among other sensors) and Li-Fi transmitters (e.g., LEDs and signal processing circuitry/software) and Li-Fi receivers (e.g., photodetectors (PD) and signal processing circuitry/software). As shown, the sensor fusion module/stack in each vehicle takes the usual inputs from the camera-based vision system and additional input from the photo-detector.

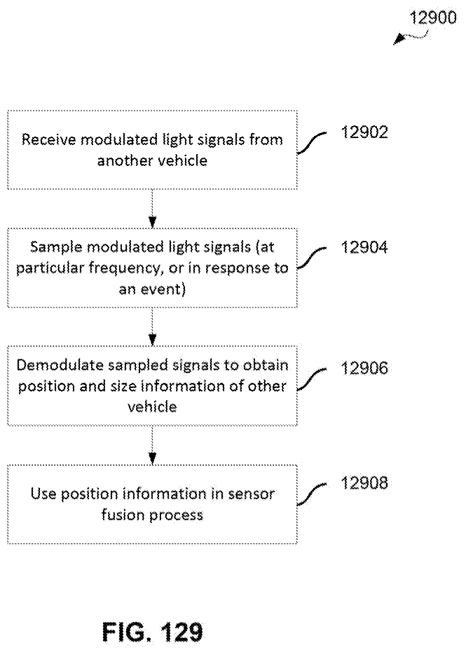

FIG. 129 is a simplified diagram of example process of using VLC or Li-Fi information in a sensor fusion process of an autonomous vehicle in accordance with at least one embodiment. Operations in the example process 12900 may be performed by components of an autonomous vehicle (e.g., one or both of the autonomous vehicles of FIG. 128). The example process 12900 may include additional or different operations, and the operations may be performed in the order shown or in another order. In some cases, one or more of the operations shown in FIG. 12900 are implemented as processes that include multiple operations, sub-processes, or other types of routines. In some cases, operations can be combined, performed in another order, performed in parallel, iterated, or otherwise repeated or performed another manner.

At 12902, an autonomous vehicle receives modulated light signals from another vehicle (a “traffic vehicle”). In some cases, the autonomous vehicle may receive modulated light signals from multiple traffic vehicles.

At 12904, the modulated light signals are sampled. The sampling may be done at a particular frequency (e.g., every few milliseconds), or in response to a detected event (e.g., detecting the presence of the traffic vehicle in the surrounding area of the autonomous vehicle).

At 12906, the sampled signals are demodulated to obtain position and size information for the traffic vehicle. The position information may include information indicating an exact location of the traffic vehicle. For example, the position information may include geocoordinates of the traffic vehicle in a DMS format, or in another format. The size information may include information indicating a size of the traffic vehicle, and may include a length, width, and/or height of the traffic vehicle (e.g., in meters).

At 12908, the position information obtained at 12906 is used in a sensor fusion process of the autonomous vehicle. For example, the autonomous vehicle may use the position information in a perception phase of an autonomous driving pipeline.

Reducing the costs of the underlying technology and components utilized to implement autonomous driving functionality may be considered a key element in making autonomous driving economically feasible for the mass consumer markets and hastening its adoption on the road. Part of the high cost of autonomous vehicles lies in the use of high performance sensors such as LIDAR sensors, radar sensors, cameras, inertial measurement units (IMU), global navigation satellite system (GNSS) receivers, and others. Part of the high cost lies in the need for high performance data processing, high bandwidth data communication, and high volume storage. Both sensors and compute capabilities need to process very large amounts of data in real-time, in a highly robust manner, using automotive-grade components, and satisfying functional safety standards. Part of the high cost lies in the development process for autonomous vehicles.

The development process for autonomous vehicles and associated sensors typically includes development, training and testing of perception, planning and control software algorithms and hardware components, through various methods of simulation and field testing. In particular, modern perception systems for autonomous vehicles may utilize machine learning methods, which require training of perception (e.g., computer vision) algorithms, resulting in trained models specific to the task and sensor at hand. Modern machine learning based methods require collection of very large data sets as well as very large efforts to obtain ground-truth algorithm output (e.g., “data labeling”), which are very costly. These data sets are commonly dependent on the specific sensor used and characteristics of the data. Efforts to ease the re-use of perception algorithms in domains other than those for which the algorithm was originally developed involve the concepts of transfer learning and domain adaptation. Despite significant efforts, re-use of these algorithms remains a difficult and unsolved problem.

One approach to reducing costs may include integration of the various sensing and planning data processing subsystems into fewer compute components, reducing the footprint and power needs of the processing pipeline gradually, and reaching economies of scale. Another approach to reducing cost is to maximize the re-use of fewer data processing components and to utilize common components across the multiple tasks that need to be performed in a single autonomous vehicle and across multiple types of autonomous vehicles. This may involve the use of common perception algorithms, common algorithm training data sets and common machine learning models.

According to some embodiments, a data processing pipeline utilizes common components for both camera (visual) data and LIDAR (depth/distance/range) data, which may enable utilization of common processing components for both camera data and LIDAR data. This may reduce the cost of the development of autonomous vehicles and may reduce the cost of the components themselves.

In some embodiments, sensor data may be abstracted away from the raw physical characteristics that both camera data and LIDAR data possess, into a more normalized format that enables processing of the data in a more uniform manner. These techniques can be considered a kind of pre-processing that may reduce noise or reduce sensor-specific characteristics of the data, while preserving the fidelity of the data and the critical scene information contained in it. The resulting abstracted and normalized data can be provided to standard perception components/algorithms (e.g., those in a perception phase/subsystem of a control process for the autonomous vehicle), for example object detection, road sign detection, traffic sign detection, traffic light detection, vehicle detection, or pedestrian detection, that are necessary for autonomous driving. The resulting abstracted and normalized data enables easier transfer learning and domain adaptation for perception algorithms and other processing components that must recognize the state of the world around the autonomous vehicle from the data. In addition to detection, the perception phase/subsystem may more generally include classification functions, e.g., detecting specific traffic signs and/or classifying the exact type of the traffic sign, or classifying vehicles into specific types such as passenger car, van, truck, emergency vehicles, and others. Furthermore, the perception phase/subsystem may involve estimation of the position and velocity of road agents and other dimensions of their state. Furthermore, the autonomous vehicle perception phase/subsystem may classify or recognize the actions or behavior of road agents. All such functions of the perception phase/system may be dependent on the specifics of the sensor(s) and may benefit from sensor data abstraction.

In some instances, sensor data abstraction and normalization may enable common processing amongst different sensors of the same type used in a single vehicle. For example, multiple types of cameras may be used in a single vehicle (e.g., a combination of one or more of the following: perspective cameras, fisheye cameras, panoramic cameras). The different types of cameras may have strongly different fields of view or different projections into the image plane. Each type of camera may also be used in specific configurations on the vehicle. Modalities such as visible light, infrared light, thermal vision, and imaging at other wavelengths each have their own characteristics. Likewise, multiple types of LIDAR, with different characteristics, may be used on a vehicle. Accordingly, in certain aspects of the present disclosure, the sensor data from the different types of cameras may be abstracted into a common format, and sensor data from different types of LIDAR may similarly be abstracted into a common format.

Aspects of the present disclosure may enable low-level fusion of sensor data within and across modalities and sensor types. Broadly speaking, low-level sensor fusion for autonomous driving and mobile robotics includes combining sensor data from multiple modalities that have an overlapping field of view. In some cases, for example, sensor fusion may include one or more of the following:
Combining data strictly within the overlapping field of view, but may also include stitching together data from different fields of view with some overlap (e.g., image mosaicking, panoramic image creation).
Combining multiple camera images captured at a given resolution to achieve super-resolution (e.g., creation of images at resolutions higher than the camera resolution). This can allow using lower-cost cameras to achieve the resolution of higher-cost cameras.
Combining multiple LIDAR data scans to increase their resolution. To the best of our knowledge, achieving super-resolution with LIDAR data is an entirely new field.
Combining multiple camera images captured at a given limited dynamic range, to achieve higher dynamic range.
Combining multiple camera images or multiple LIDAR scans to achieve noise reduction, e.g., suppressing noise present in each individual camera image or LIDAR scan.
Combining camera and LIDAR images to achieve a higher detection rate of objects present in both modalities, but with independent “noise” sources.

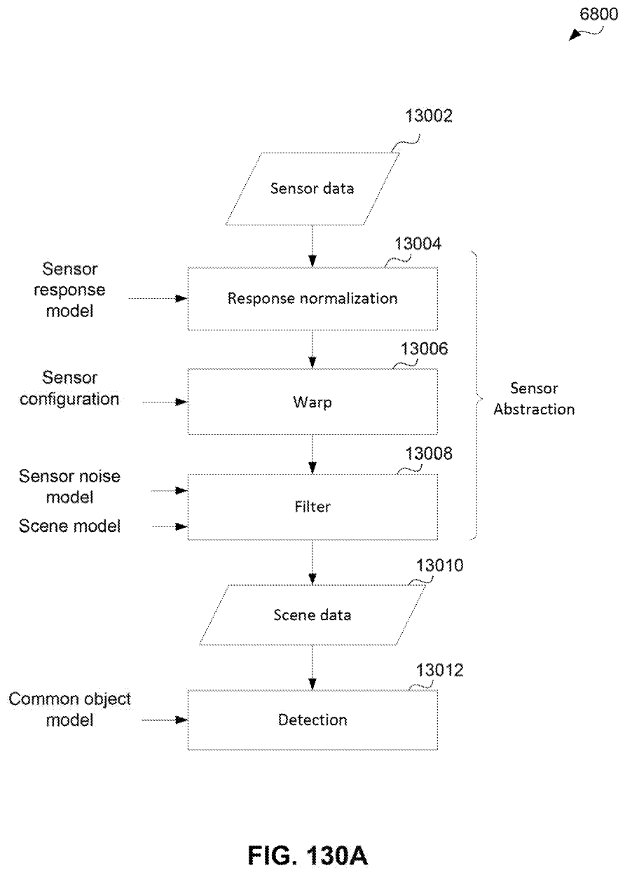

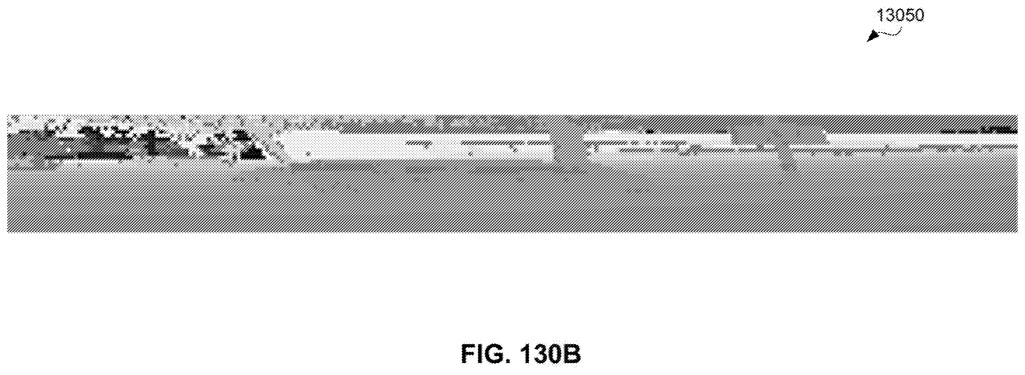

One embodiment is shown in FIG. 130A, which illustrates a processing pipeline 13000 for a single stream of sensor data 13002 coming from a single sensor. By several sensor abstraction actions 13004, 13006, 13008, the original sensor data is transformed and normalized into a “scene data” format 13010. The scene data is subsequently provided to a detection stage/algorithm 13012, which may include vehicle detection, pedestrian detection, or other detection components critical to autonomous driving. The detection stage uses a common object model, which can be used in combination with scene data originating from multiple types of sensors, since the scene data 13010 has been abstracted from the original sensor data 13002. In the case of a machine learning model, such as a deep neural net, convolutional neural net, fully connected neural net, recursive neural net, etc., the abstraction actions (13004, 13006, 13008) are applied both during training and inference. For brevity, FIG. 130A only shows the inference stage.

In one example, an example sensor abstraction process may include an action (e.g., 13004) to normalize the sensor response values. In the case of a camera image, for example, this may include normalizing the pixel values (e.g., grayscale or color values). For example, different cameras of an autonomous vehicle may have different bit depths, such as 8 bit per pixel, 10 bit or 12 bit per pixel, or different color space (often represented as RGB or as YUV (luminance, chrominance), or in different color spaces). The response normalization action may use a model of the sensor response (e.g., a camera response function) to transform the response values into a normalized range and representation. This may also enable combination of camera images captured with different exposures into a high-dynamic range image, in some embodiments. The parameters of the sensor response model may be known (e.g., from exposure and other sensors settings) or may be estimated from the data itself.

In the case of LIDAR, raw sensor data may be in the form of depth or distance values. Based on the horizontal angle (azimuth angle) and vertical angle (elevation angle), the depth values can be converted to X,Y,Z point position values. As an example, the X axis may be close to being perpendicular to the vehicle longitudinal axis, the Y axis may be close to parallel to the vehicle longitudinal axis, and the Z axis may be close to pointing upwards, away from the ground. For the purpose of object recognition, either the raw depth value or one or two of the X,Y,Z values may be most useful. Hence, LIDAR values may be represented as either a single scalar, or as a pair, or triplet of values. The values themselves may be transformed into a normalized range in some embodiments. In some instances, LIDAR sensors may provide a two-dimensional (2-D) array of depth or distance values across a horizontal and vertical field of view, and the array may be in the same form as a 2-D image. An example of such an image obtained directly from LIDAR data is shown in FIG. 130B. In certain aspects of the present disclosure, LIDAR sensor data may be retained in this 2-D array form rather than being represented as a point cloud. An important consequence from retaining the data in the 2-D array is that both camera and LIDAR data are represented as 2-D arrays or images.

Continuing with this example, the sensor abstraction process may continue by warping (e.g., 13006) the sensor data. In some embodiments, the warp stage may include a spatial upscaling or downscaling operation. A simple upscaling or downscaling may be used to change the spatial resolution of a camera image or LIDAR array. As illustrated in the example shown in FIG. 130B, the resolution of LIDAR sensor data 13050 may be high in the horizontal dimension, but low in the vertical dimension. In order to facilitate sensor abstraction, sensor fusion, and object detection using common detection models, it may therefore be desirable to increase the vertical resolution of the LIDAR array. One method of doing this is to apply an upscaling operation, using the same or similar techniques to those developed in image processing.

In some embodiments, warping also incorporates corrections for geometric effects inherent to the sensing process. As an example, warping may correct for the differences between perspective cameras and fisheye cameras. The warping action may transform a fisheye image into a perspective image or panoramic image. Again, this may enable a common detection model at a later stage. The warping action may also consider the configuration and fields of view of the camera or LIDAR sensor, which may enable combination of images or LIDAR scans from multiple sensors into a mosaic or panoramic image (a.k.a. image stitching).

In some embodiments, the warping action may also incorporate corrections for camera motion, including both motion due to the car motion as well as unintended motion due to vibration. This may enable combining multiple images or LIDAR scans captured at slightly different times and accounting for the motion of the sensor between the two capture times. This combination of multiple images of the same scene enables improved resolution (super-resolution), noise reduction, and other forms of sensor fusion. The parameters of the sensor motion and other required parameters may be measured (e.g., using other sensors) or may be estimated from the data itself. To summarize, the warping action may account for many types of geometric differences between sensor data streams, and may result in spatial and temporal alignment (or registration) of the data into a normalized configuration.

In some implementations, sensor abstraction may continue with applying filtering (e.g., 13008) to the data. This filtering may utilize data from a single time instant, or may involve filtering using data from previous and current time instants. For example, a single camera image or multiple camera images (or image frames) may be used.

In some embodiments, a time-recursive method of filtering may be used. A time-recursive image filter may use the previously filtered image at the previous time instant and combine it with image data sensed at the current time. As a specific example, a Kalman filter (or a variant of the Kalman filter) may be used. The filter (e.g., a Kalman filter or variant thereof) may incorporate a prediction action based on data from previous time instants and an update action based on data from current time. Other filters known in the art may be used as well, such as a particle filter, histogram filter, information filter, Bayes filter, Gaussian filter.

In some cases, the filtering action may use a sensor noise model to properly account and suppress noise from the different types of sensors, camera and/or LIDAR. The noise model describes the nature and strength of the noise in the original sensor data, while keeping track of the pipeline operations prior to filtering (e.g., response normalization and warping), and their effects on the noise in the data. As an example, the strength of the noise in the original data is modulated during the response normalization action. Also, the spatial characteristics of the noise may be affected during the warping action. The parameters of the sensor noise model may be based on measurement or may be estimated from the data itself. The filtering action may also use a scene model, which may capture the uncertainty or noise predicting the current data from previous data. For example, the relation between the data at the current time action and data at the previous time action is dependent on the motion of the autonomous vehicle and its sensors. This motion can be measured or estimated, within some remaining uncertainty or noise. The scene model accounts for this uncertainty. The scene model may also describe the magnitude of significant variations in the true signal due to the scene itself (without noise). This information can be used by the filtering action to weigh the significance of variations observed in the data. The filtering action may also use a model of the sensor that includes additional characteristics, such as lens, imaging, and solid-state sensor characteristics in the case of cameras, and may result in spatial blur or other effects. The filtering action may reduce the effects of these characteristics or normalize the data to a common level, for example a common level of blur. Hence, in the case of images (for example), the filtering action may operate to reduce or increase the level of blur, depending on the situation, using well-known convolution or deconvolution techniques. The sensor model keeps track of the effect of the previous data abstraction actions on the level of blur throughout the data as well. Finally, the filtering action keeps track of the level of noise and blur in its output, throughout the output data. This information may be used during the next time instant, if the filtering action is a time-recursive process, e.g., a type of Kalman filtering. This information may also be used by subsequent processes, such as sensor fusion of the abstracted sensor data, or by the detection stage.

The filter actions may also consider the validity of individual samples and may use a validity or occupancy map to indicate valid samples. In LIDAR data, for example, individual samples can be invalid in case a LIDAR return was not received or not received with sufficient signal strength. Also, given multiple sensor images or arrays captured at different angles of view and field of view, some parts of an image or sensor array may be considered not useful, e.g., when combining images with overlapping (but not identical) field of view.

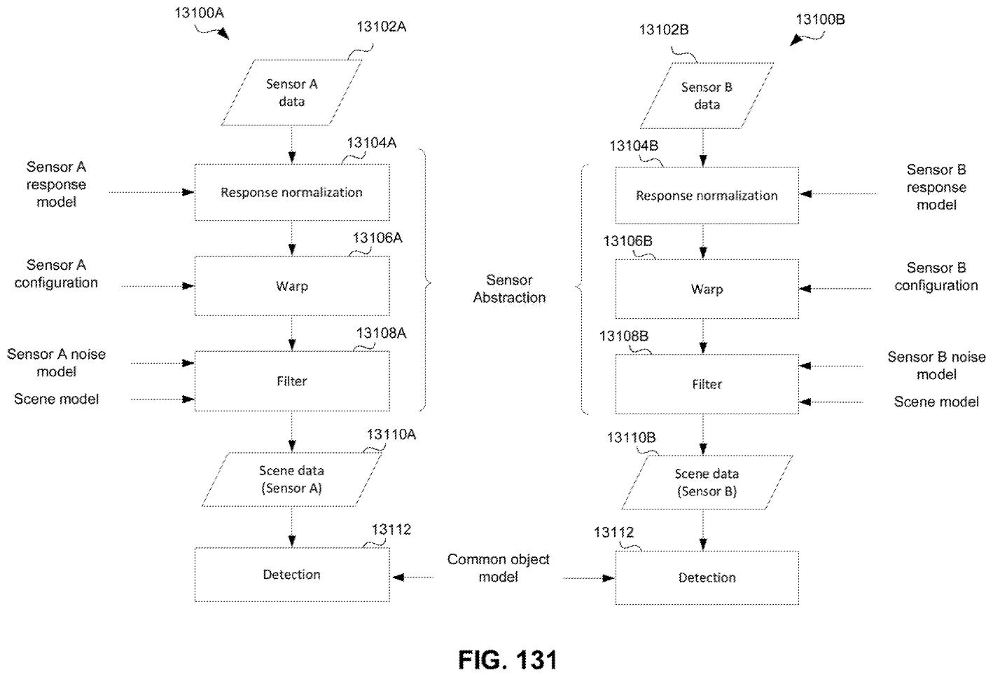

FIGS. 131, 132, and 133 show embodiments of processing pipelines for multiple streams of sensor data coming from multiple sensors.

FIG. 131 shows example parallel processing pipelines 13100 for processing multiple streams of sensor data 13102. Each aspect of the pipelines 13100 is the same as the corresponding aspect in the pipeline 13000 shown in FIG. 130A and described above, with each pipeline handline sensor data from a different sensor (Sensors A and B). In the example shown, a common detection/perception algorithm (or trained machine learning model) (e.g., 13112) is applied to more than one sensor data stream 13102, but without any fusion. For instance, in the example shown, the common object model is fed into both detection blocks 13112 of the two pipelines 13100. One benefit of the data abstraction idea is that the detection/perception algorithm can be trained on and applied to “abstracted” data from various sensors, and hence there may be less cost/effort needed to develop detection algorithms for each sensor.

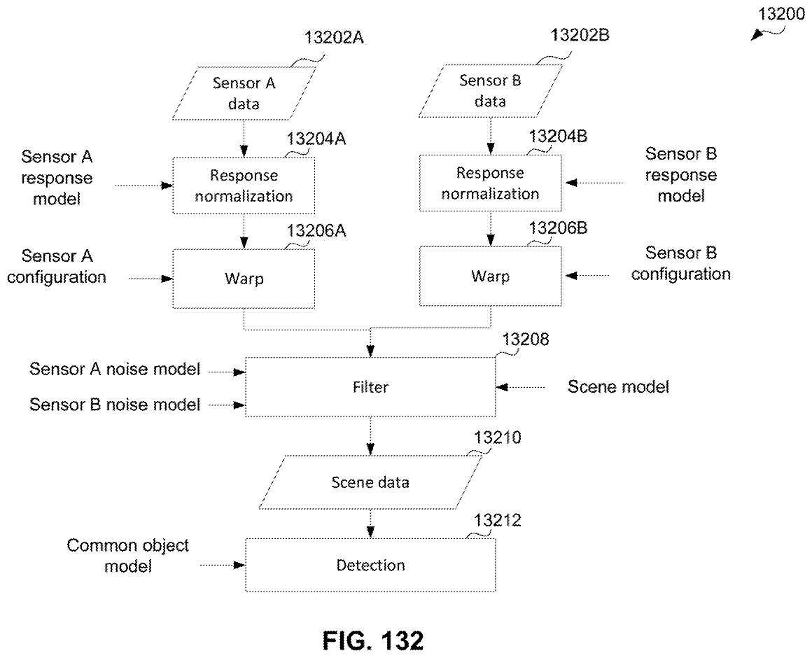

FIG. 132 shows a processing pipeline 13200 where data from multiple sensors is being combined by the filtering action. In the example shown, the sensor abstraction process includes normalizing each respective stream of sensor data 13202 at 13204 and warping each respective stream of sensor data 13202 at 13206 before combining the streams at the filtering action 13208. Each action of the sensor abstraction process may be performed in a similar manner to the corresponding sensor abstraction process actions described with respect to FIG. 130A above. The filtering action 13208 may utilize sensor noise models for each respective sensor data stream, along with a scene model to produce abstracted scene data 13210. The abstracted scene data may then be passed to a detection process/algorithm 13212 for object detection. The detection process/algorithm may be performed similar to the detection stage/algorithm described above with respect to FIG. 130A. As an example, the pipeline 13200 may be used in the case of image mosaicking, super-resolution, or high-dynamic range imaging, whereby multiple images may be combined by the filtering action.

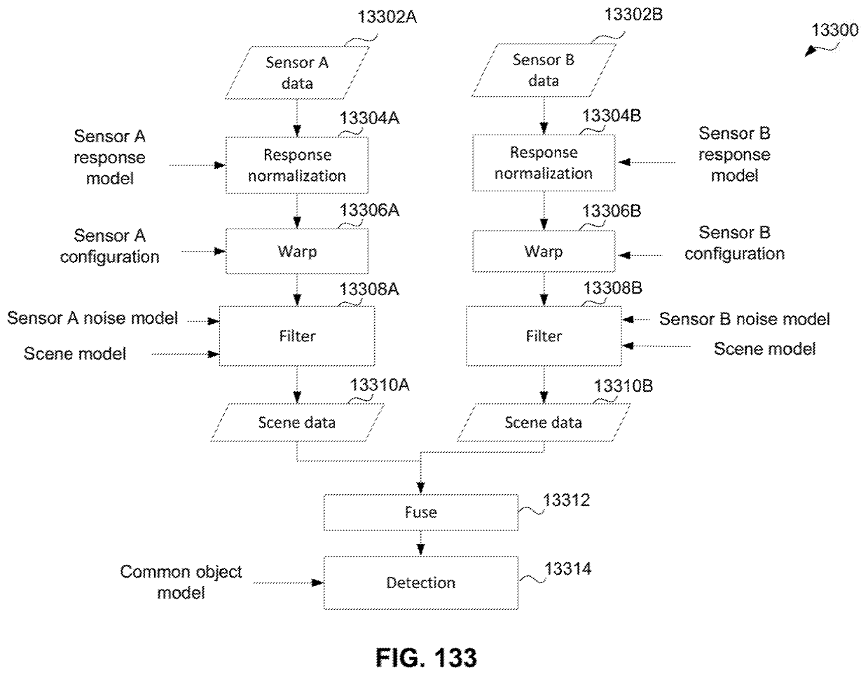

FIG. 133 shows a processing pipeline 13300 where data from multiple sensors is being combined by a fusion action after all actions of sensor abstraction outlined above. In the example shown, the sensor abstraction process includes normalizing each respective stream of sensor data 13302 at 13304, warping each respective stream of sensor data 13302 at 13306, and applying filtering to each respective stream of sensor data 13303 at 13208. Each action of the sensor abstraction process may be performed in a similar manner to the corresponding sensor abstraction process actions described with respect to FIG. 130A above. The respective filtering actions 13208 for each data stream may utilize sensor noise models for the corresponding sensor data stream, along with a scene model to produce abstracted scene data 13210 for the respective sensor data. The abstracted scene data may then be passed to a fuse stage 13312, where the abstracted scene data are fused, before providing the fused data to the detection process/algorithm 13214 for object detection. The detection process/algorithm may be performed similar to the detection stage/algorithm described above with respect to FIG. 130A. As an example, the pipeline 13300 may be used in the case of fusion of LIDAR and camera data, whereby data from a LIDAR sensor and data from a camera are combined prior to the detection stage.

Operations in the example processes shown in FIGS. 130, 132, 133 may be performed by various aspects or components of an autonomous vehicle. The example processes may include additional or different operations, and the operations may be performed in the order shown or in another order. In some cases, one or more of the operations shown in FIGS. 130, 132, 133 are implemented as processes that include multiple operations, sub-processes, or other types of routines. In some cases, operations can be combined, performed in another order, performed in parallel, iterated, or otherwise repeated or performed another manner.

An autonomous vehicle may have a variety of different types of sensors, such as one or more LIDARs, radars, cameras, global positioning systems (GPS), inertial measurement units (IMU), audio sensors, thermal sensors, or other sensors (such as those described herein or other suitable sensors). These sensors may be used to aid perception performed by the vehicle. Since perception is generally the first function performed in the autonomous vehicle stack, errors in perception will impact subsequent functions, such as sensor fusion, localization, path planning, or other phases in a detrimental manner. Such errors may lead to accidents and consequent loss of trust and acceptance of autonomous vehicles. To mitigate errors in perception, many systems utilize high quality, high-resolution cameras and other sensors. However, these high-quality components may increase the costs of autonomous vehicles and increase the power consumed, which may in turn slow down the acceptance of autonomous vehicles.

Various embodiments of the present disclosure may address this problem by providing a scalable sensors approach based on super-resolution upscaling methods. For example, sensors with relatively low-resolution may be deployed. The low-resolution data obtained from such sensors may then be upscaled to high-resolution data through the use of super-resolution processing methods. Any suitable super-resolution upscaling methods may be utilized. For example, the upscaling may be performed by various deep neural networks, such as deep generative models. As another example, the upscaling may be performed using a model trained using knowledge distillation techniques. In various embodiments, such networks may be trained on real-world data to derive high-resolution data from low-resolution data.

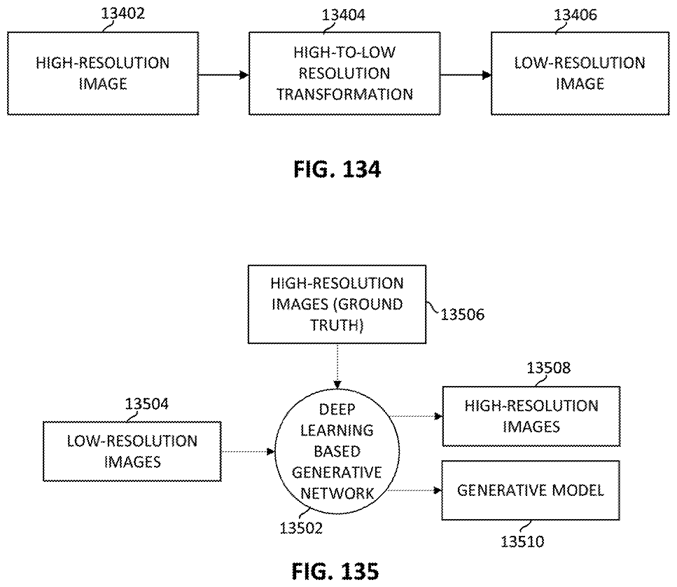

FIG. 134 depicts a flow for generating training data including high-resolution and corresponding low-resolution images in accordance with certain embodiments. The flow may begin with the capture of a high-resolution image 13402 (having high quality) using one or more high-resolution sensors. At 13404, the high-resolution image is then transformed to look like an image generated using one or more low-resolution sensors (e.g., low-resolution image 13406). The high-to-low-resolution transform 13404 may be performed in any suitable manner. In various examples, one or more low-pass filters may be applied to the high-resolution image (e.g., resulting in a smoothing of the image), sub-sampling may be performed on the high-resolution image, noise may be added to the high-resolution image (e.g., salt and pepper noise may be added to mimic weather conditions (e.g., rain or snow)), the high-resolution image may be downsampled, channels (e.g., RGB values) of a color image may be randomized (e.g., to simulate various illumination conditions), other techniques may be performed, or a combination of techniques may be performed by a computing system (e.g., an in-vehicle computing system). The flow of FIG. 134 may be performed any number of times using data from any number of sensors to generate a rich training dataset.

In addition, or as an alternative, the training data may be obtained by simultaneously capturing images using a high-resolution sensor and a low-resolution sensor. The resulting images may be calibrated in terms of position and timing such that the images represent the same field of view at the same time. Thus, each high-resolution image may have a corresponding low-resolution image.

FIG. 135 depicts a training phase for a model 13510 to generate high-resolution images from low-resolutions images in accordance with certain embodiments. During the training phase, a deep learning based generative network 13502 may receive high-resolution images 13506 as the ground truth and corresponding low-resolution images 13504. The network 13502 generates high-resolution images 13508 as an output and compares these with the ground truth high-resolution images 13506. The error between a generated high-resolution image and the corresponding ground truth image is back propagated to train the parameters of the network 13502. In some embodiments, the error is based on a loss function which also factors in robustness to adversarial attacks. Once the model 13510 is trained, it may be deployed in vehicles for inference in cars equipped with low-resolution cameras (e.g., using an inference engine). A particular advantage of this method for training is that it does not require an expensive labeling process for the ground truth, and thus is unsupervised in a sense.

In various embodiments, any suitable machine learning model may be used to generate high-resolution images from low-resolution images (also referred to as image super resolution). For example, a generative neural network may be used (where an adversary may or may not be present). In some embodiments, the model may be based on a convolutional neural network (CNN), a neighbor embedding regression, random forest, or other suitable machine learning architecture. As various examples, a Very-Deep Super-Resolution (VDSR) model, a learning method Single Image Super-Resolution (SISR) model, a reconstruction method SISR model, a Super-Resolution Convolutional Neural Network (SRCNN), or any other suitable model may be used.

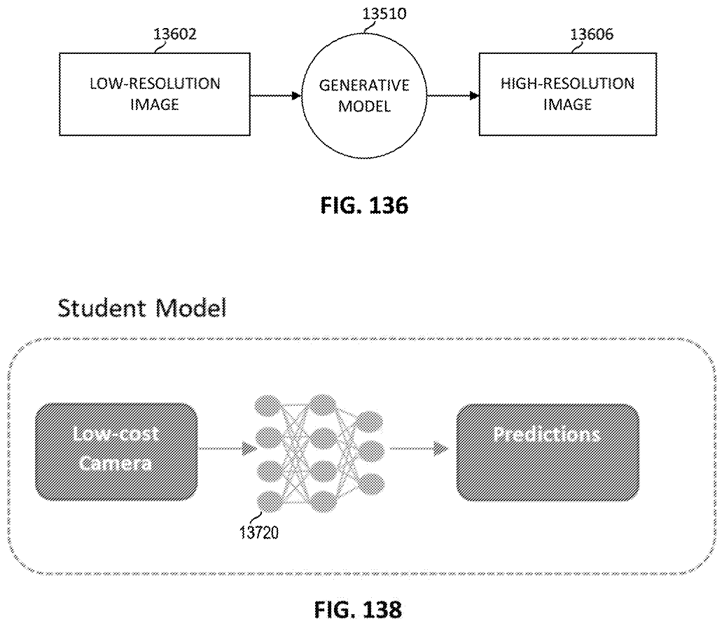

FIG. 136 depicts an inference phase for a model 13510 to generate high-resolution images from low-resolution images in accordance with certain embodiments. During the inference phase, a low-resolution image 13602 captured by one or more low-resolution cameras is supplied to the generative model 13510. The generative model 13510 processes the image 13602 using the parameters determined during training and outputs a high-resolution image 13606. The high-resolution images generated by generative model 13510 may be used for perception or other suitable blocks of the autonomous vehicle stack.

Although the examples above focus on processing of camera image data, similar super-resolution upscaling methods may be applied to other sensor data, such as LIDAR data. Raw LIDAR data may include an array of depth or distance measurements across a field of view. Super-resolution processing may be applied to such a two-dimensional (2-D) array in a very similar manner as with camera image data. As in the above, a deep learning-based generative network can be trained using collected high-resolution LIDAR data as ground truth. Subsequently, the trained network can be deployed in an autonomous vehicle to upscale low-resolution LIDAR data to high-resolution LIDAR data. In particular embodiments, a similar super-resolution processing method may also be used to upscale LIDAR data in a point cloud format.

In various embodiments of the present disclosure, knowledge distillation techniques may be used to support scalable sensing. Knowledge distillation is a technique for improving the accuracy of a student model by transferring knowledge from a larger teacher model or ensemble of teacher models to the student. Despite the differences in sensing technologies between sensors such as LIDAR and cameras, there is overlap in the features they can detect. For example, 3D cameras can provide depth information albeit at a lower resolution than LIDAR sensors which provide a high-resolution 3D mapping of a scene. In general, models trained using the lower resolution sensors tend to be less accurate than models trained using higher resolution sensors, even though a human observer might be able to correctly identify objects in the low-resolution images. In particular embodiments of the present disclosure, knowledge distillation may be used to transfer knowledge from an ensemble of teacher models trained using various types of high-cost sensors (e.g., LIDAR and high-resolution cameras) to student models that use low-cost sensors (e.g., low-resolution cameras or low-resolution LIDARs).

During training, knowledge distillation transfers knowledge from the teacher to the student using a multi-task loss which minimizes the loss for the primary task of the model (e.g., object detection), as well as the distillation loss between how the teacher network encodes its features and how the student network encodes them. Training data is generated by synchronizing data using calibration and timestamps to ensure that both the high-cost and low-cost sensors are viewing the same scene.

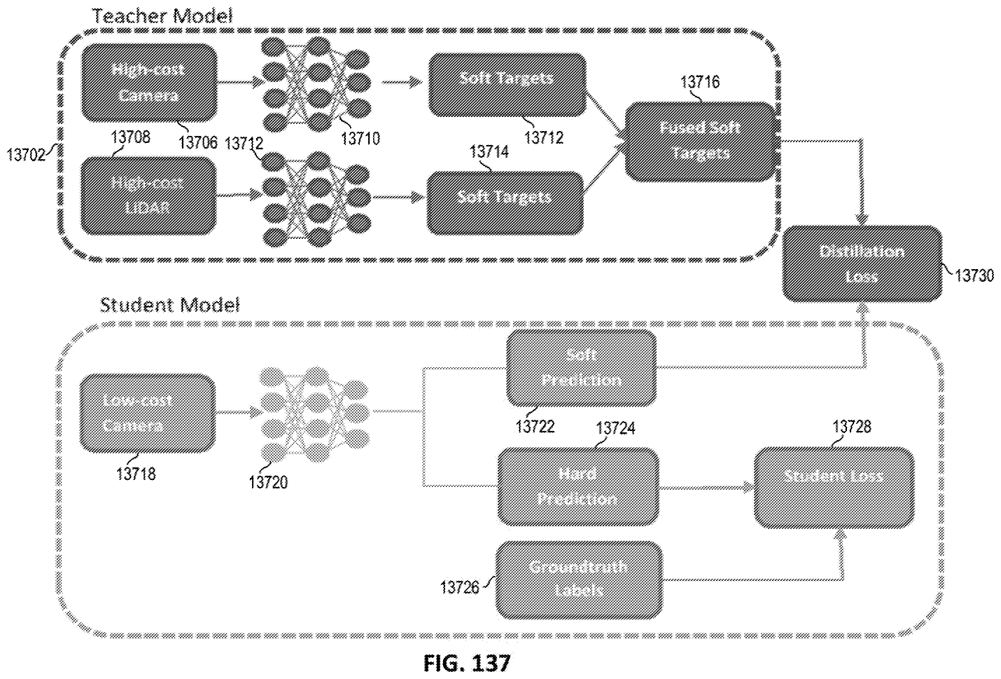

FIG. 137 depicts a training phase for training a student model 13704 using knowledge distillation in accordance with certain embodiments. First, a teacher model comprising an ensemble 13702 of models 13710 and 13712 are trained using the high-cost sensors 13706 and 13708 to detect objects as accurately as possible. Next, knowledge from the ensemble 13702 of teacher models 13710 and 13712 is transferred to the student model 13720 by computing soft targets 13712 and 13714 from the distribution of object probabilities predicted by the ensemble 13702 of teacher models and using them to teach the student model 13720 how to generalize information. The soft targets 13712 and 13714 are used in conjunction with the hard targets (predictions 13724) obtained from the ground-truth labels 13726 to improve the accuracy of the student model.

Any suitable models may be used for either the ensemble 13702 of models or the student model 13720. In particular embodiments, one or more of these models comprises a convolutional neural network (CNN). In some embodiments, one or more of these models comprises a recurrent neural network (RNN) (e.g., in a segmentation model learning how to categorize pixels in a scene by predicting the sequence of polygon coordinates that bound objects). Yet other embodiments may include models that include any suitable neural network or other machine learning models.

In a particular embodiment, soft targets 13712, 13714, and 13722 may be extracted from a layer of a respective classification algorithm (e.g., neural network) that is not the final output. For example, in an object detection model, a soft target may indicate one or more of dimensions of a bounding box of an object, one or more classes determined for the object, or a likelihood associated with each class (e.g., 0.7 cat, 0.3 dog). In a segmentation model, a soft target may indicate, for each pixel, softmax probabilities of that pixel with respect to different semantic categories. In a particular embodiment, a soft target may include information from a feature map of a particular layer of a neural network.

The fused soft targets 13716 may be determined from the soft targets 13712 and 13714 in any suitable manner. As various examples, the soft targets may be combined using weighted averages, Dempster-Shafer theory, decision trees, Bayesian inference, fuzzy logic, any techniques derived from the context-based sensor fusion methods described herein, or other suitable manners. In one embodiment, a union operation may be performed for the bounding boxes wherein the area that is common to a bounding box predicted by model 13710 and a bounding box predicted by model 13712 is determined to be the bounding box of the fused soft target in 13716. In various embodiments, the soft targets may be fused together in any suitable manner.

The hard prediction 13724 may be the final output of the model 13720. As an example, the hard prediction 13724 may include the class predicted for a detected object or pixel.

The distillation loss 13730 is the difference between the fused soft targets 13716 predicted by the high cost sensors and the corresponding soft targets 13722 predicted by the low cost camera 13718.

Instead of merely optimizing the student model 13720 on the student loss 13728, e.g., the differences between the hard predictions 13724 and the ground truth labels 13726, a multi-task loss (including the student loss 13728 and the distillation loss 13730) is used to tune the parameters of the student model 13720.

FIG. 138 depicts an inference phase for a student model trained using knowledge distillation in accordance with certain embodiments. During inference, the student model detects objects using only the data from one or more low-cost sensors, in the case of camera image data. In other embodiments, a similar inference process may involve LIDAR data input (e.g., from a low cost LIDAR with a lower resolution). In that case, the student model would also be trained with LIDAR data as input.

In various embodiments, the model depicted may be adapted for any suitable sensors. The parent ensemble 13702 or the student model may include any number, qualities of, and/or types of sensors. For example, the student model may be trained using data from a low-cost LIDAR sensor (e.g., having lower resolution than a high-resolution LIDAR sensor that is part of the teacher ensemble). In another embodiment, the student model may be trained with data from both a low-resolution camera 13718 as well as a low-resolution LIDAR (or any other suitable quality or types of sensors) with fused soft and hard targets used to determine the student loss 13728 and compared against the fused soft targets 13716 to determine the distillation loss 13730. In such embodiments, a similar inference process may be utilized for a combination of LIDAR and camera data input when deployed in a vehicle.

In a particular embodiment, high-resolution sensor data is captured from an autonomous vehicle. The high-resolution sensor data is transformed to low-resolution sensor data using techniques such as low-pass filtering, subsampling, or other suitable techniques. A generative machine learning model is trained to transform low-resolution sensor data into high-resolution sensor data. During inference, object detection operations are performed at a vehicle by using the trained generative machine learning model to transform low-resolution sensor data into high-resolution sensor data.

In another particular embodiment, an ensemble of machine learning models are trained to perform a task of an autonomous vehicle stack by using high-resolution data from different types of sensors (e.g., camera, LIDAR, etc.). Knowledge from the ensemble of machine learning models trained using high-resolution sensor data is transferred to a student machine learning model trained using low-resolution sensor data by incorporating a distillation loss between the fused soft prediction targets of the ensemble of machine learning models and soft prediction targets of the student machine learning model. During inference, object detection operations are performed at a vehicle by using the trained student machine learning model using low resolution sensor data.

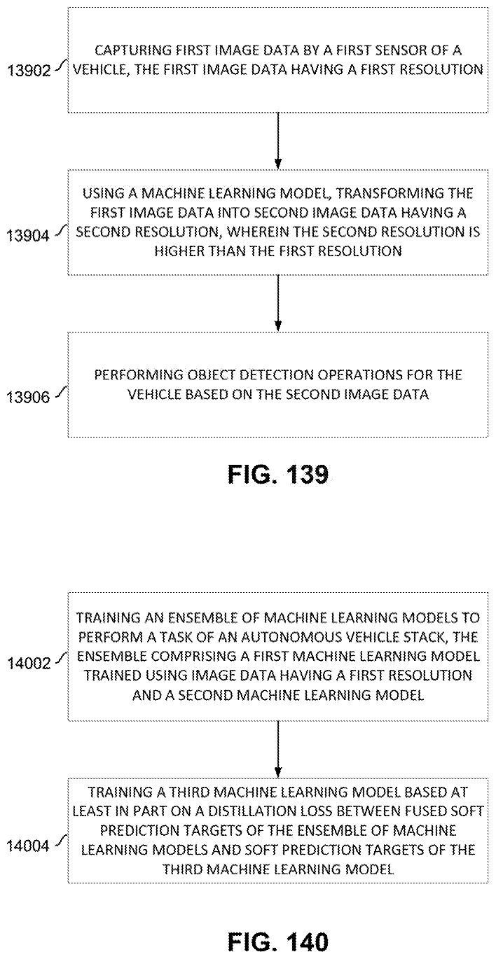

FIG. 139 depicts a flow for increasing resolution of captured images for use in object detection in accordance with certain embodiments. At 13902, first image data is captured by a first sensor of a vehicle, the first image data having a first resolution. At 13904, the first image data is transformed, using a machine learning model, into second image data having a second resolution, wherein the second resolution is higher than the first resolution. At 13906, object detection operations are performed for the vehicle based on the second image data.

FIG. 140 depicts a flow for training a machine learning model based on an ensemble of methods in accordance with certain embodiments. At 14002, an ensemble of machine learning models is trained to perform a task of an autonomous vehicle stack, the ensemble comprising a first machine learning model trained using image data having a first resolution and a second machine learning model. At 14004, a third machine learning model is trained based at least in part on a distillation loss between fused soft prediction targets of the ensemble of machine learning models and soft prediction targets of the third machine learning model.

It is widely known that humans have limited sensing capabilities. One of the possible benefits of autonomous vehicles is the capability of receiving a greater amount of information about the road, given the number of sensors on an autonomous vehicle, thereby increasing safety. However, even autonomous vehicles, with their array of sensors, are prone to errors and blind spots. It is important to acknowledge and account for these limitations in the perception and motion planners of the autonomous vehicles.

LIDARs and radars installed on road side units can exist along roadways, which can give additional information to vehicles on the road. Similarly, the use of cooperative sensing fits well with cooperative driving of autonomous vehicles. As one example, the platooning of trucks and service fleets can make use of cooperative sensing as cooperative driving is being used. As another example, consumer vehicles on roads (who may not know each other) may also contribute to cooperative driving and conduct cooperative sensing.

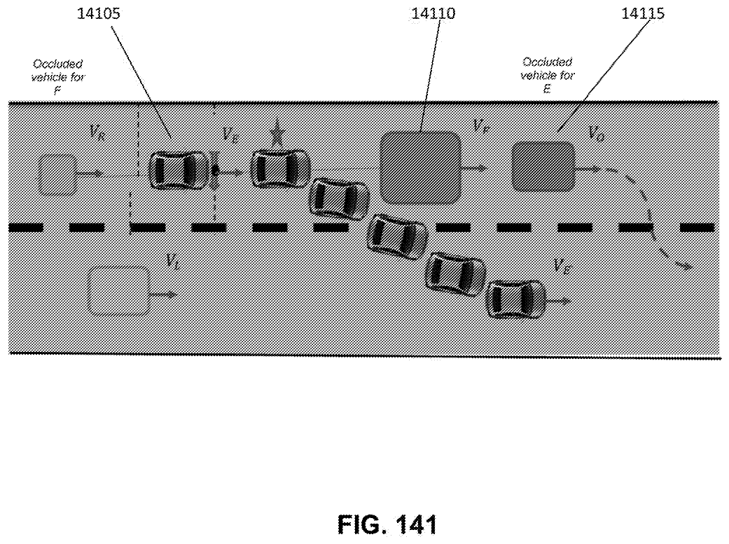

FIG. 141 illustrates an example of a situation in which an autonomous vehicle has occluded sensors, thereby making a driving situation potentially dangerous. As can be seen, vehicle 14105 is trailing vehicle 14110. Given the size of vehicle 14110, vehicle 14115 is occluded for vehicle 14105. In the situation depicted in FIG. 141, vehicle 14105 moves to pass vehicle 14110. However, vehicle 14115 is changing lanes at the same time and vehicle 14105 is not aware of the potential dangers of this situation. However, when an autonomous vehicle is capable of receiving additional information from surrounding vehicles and/or other external sensors, some of the dangers can be mitigated. In addition, the use of other communication between vehicles can create an even safer driving environment.

The concept of virtual reality perception contemplates a car seeing its environment through the eyes of the surrounding traffic agents, such as, for example, dynamic cars on the road, surveillance cameras, cameras installed at intersections or turns, traffic signs, and traffic lights. This information can be used for occlusion detection when the perception and/or dynamic map of a vehicle is not up-to-date. In addition, the enhanced perception can improve decision making by enhancing the field of perception in a manner that is not achievable by only relying on the on-vehicle set of sensors. For example, having information from sensors not on the vehicle can improve safety as a vehicle approaches an occluded pedestrian crosswalk. The speed of the approaching vehicle can properly be determined if the car can now see the occluded crosswalk using sensors from other traffic agents.

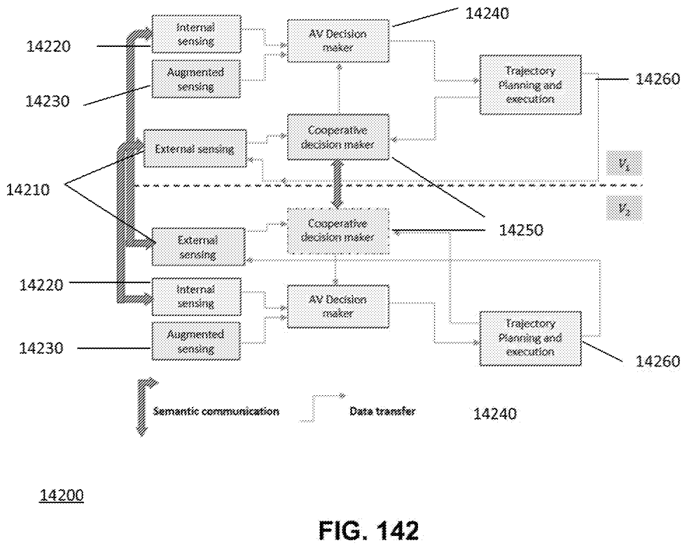

Systems and methods that combine cooperative sensing, cooperative decision making, and semantic communication language can greatly improve the safety of autonomous vehicles. An example of a system that uses vehicle cooperation is illustrated in the high-level architecture diagram shown in FIG. 142. The system 14200 of FIG. 142 may provide cooperative sensing, decision making, and common semantic communication language for autonomous vehicles. Cooperative sensing occurs when vehicles communicate with one or more surrounding vehicles to communicate data based on data sensed by the sensors of the respective vehicles.

The example of FIG. 142 shows a system that includes two vehicles (V₁ and V₂) communicating cooperatively. According to the example depicted in FIG. 142, each vehicle comprises an internal sensing module 14220, an augmented sensing module 14230, an external sensing module 14210, a cooperative decision maker 14250, an autonomous vehicle decision maker module 14240 and a trajectory planning and execution module 14260.

The internal sensing modules 14220 comprise sensing information of an autonomous vehicle, such as data traditionally used by autonomous vehicles in route planning and execution. As an example, sensing modules 14220 may comprise information sensed by on-vehicle sensors. The external sensing modules 14210 comprise information obtained from another vehicle (for example, sensing module 14210 of V1 may include sensed information received from V₂.) This data may take any form. In some embodiments, the data is exchanged via semantic communication. In various embodiments of the present disclosure, a novel semantic language utilized by traffic elements (e.g. vehicles or roadside computing units) allows the vehicles to manage their communication in a fast and secure mode. This generalized language for communication in transport can include both sensing and planning data and may be shared and exploited by other traffic components. The semantic communication can be carried out as either a broadcast or based on request/response manner. Furthermore, the semantic language can be transmitted using any available transmission protocol, such as, for example, Bluetooth or ZigBee. If two vehicles try to share all the data they receive from their sensors, the size of the data transfer may be too big and take too long to transmit and to analyze. In a situation in which decisions need to be made immediately, the semantic communication will allow a quick communication concerning important safety issues on the road. As an example, the semantic language will allow the vehicles to share specifics from one another, such as the location of a vehicle or other object and a movement pattern or plan for the vehicle or object, such as a plan for the vehicle to change lanes.

The transmission of sensed data from one vehicle to another, as mentioned above, can be considered cooperative sensing. Autonomous vehicles are usually equipped with a wide range and number of sensors. The data provided by these sensors can be analyzed in real-time using computer vision algorithms or LIDAR/RADAR-based data processing methods. Data from the sensors can be processed and analyzed and the results may be shared among vehicles in accordance with embodiments presented herein. Each of the physical sensors has its own limitations in range, field of view, weather conditions, etc. As discussed with reference to the example of FIG. 141, there are many instances on the road in which a vehicle has one or more of its sensors occluded. Cooperative sensing allows a vehicle to use the data from another vehicle, or other traffic objects (e.g., traffic sensors and cameras along the road such as any of those illustrated in FIG. 1 or other suitable sensors) to augment the field of vision of the autonomous vehicle.

With reference to the example of FIG. 142, system 14200 can also include a cooperative decision maker module 14250 on each vehicle. The cooperative decision maker modules 14250 can receive data related to another vehicle's decision making, such as a planned route for the vehicle. Thus, the autonomous vehicle can adjust its own path planning and, in particular, motion planning given the new data set. The data related to another vehicle's decision making can comprise data that relates to a decision the other vehicle makes. For example, if two vehicles are planning to switch lanes, they can alert each other, and the two vehicles can coordinate and plan their actions accordingly. Cooperative decision making can be more general and reliable than using pure negotiation between autonomous vehicles, and in some embodiments may take into account additional objects sensed by the vehicles or other sensors. Cooperative decision making may allow a more complex optimization problem to be solved and the result may be shared with surrounding traffic components (e.g., other vehicles or roadside assistance computing units). According to some examples, cooperative decision maker modules 14250 communicate to one another using semantic language.

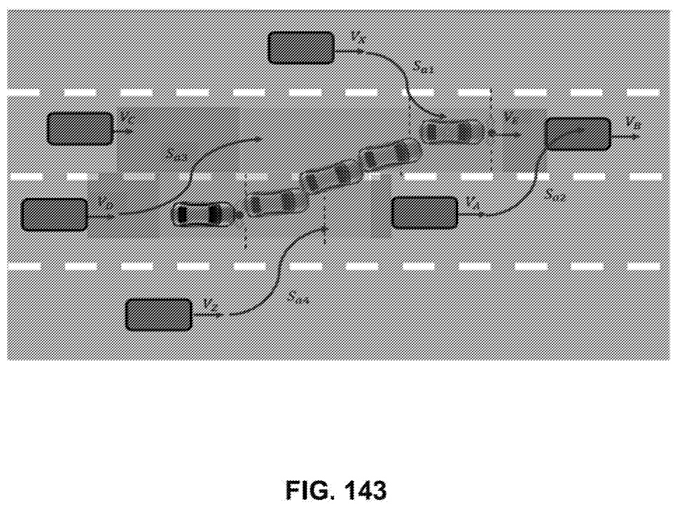

Any one or more of cooperative decision making, cooperative sensing, and semantic language may allow autonomous vehicles to travel more efficiently and safely. As an example, two main potential collision situations involve a high-speed difference between two vehicles and/or a small distance between forward and rear vehicles. Time-based collision indicators can be defined mathematically. Such indicators can be used to distinguish between safe and unsafe trajectories. In some embodiments, a vehicle may analyze a thorough picture of a potentially dangerous situation without repeating the calculation and analysis on the raw data perceived by another vehicle. When the data set is compacted, a smaller bandwidth is utilized to send the information. FIG. 143 illustrates an example of a situation in which multiple actions are contemplated by multiple vehicles. The combination of cooperative decision making, cooperative sensing, and semantic language will enable the vehicles to safely maneuver in this situation and other situations.

System 14200 also includes augmented sensing modules 14230. These modules receive sensor information from outside sources (e.g., any source outside of the vehicle, such as any of the sources shown in FIG. 1). This data may supplement sensor data received from other vehicles via an external sensing module 14210 and the semantic communication. In one example, module 14230 can receive a full data stream comprising data collected by (or based on data collected by) one or more sensors from another vehicle or traffic agent nearby.

The autonomous vehicle decision maker module 14240 may make autonomous vehicle driving decisions based on the information received from sensors, whether internally or externally. According to one example embodiment, the cooperative decision maker module 14250 is separate from the autonomous vehicle decision maker module 14240, allowing additional information to be considered by the autonomous vehicle in its decision making and planning.

System 14200 also includes a trajectory planning and execution module 14260 for each vehicle. Module 14260 may execute the driving decisions that have been made by a vehicle's decision maker modules 14240 or 14250; or can plan the vehicle's trajectory based on the decisions determined by these modules.

The system described in FIG. 142 is merely representative of modules that may occur in particular embodiments. Other embodiments may comprise additional modules not specifically mentioned herein. In addition, one or more modules may be omitted, or modules may be combined in other embodiments.

In order to achieve 360-degree awareness around an autonomous vehicle, various systems may include numerous sensors with different modalities. In some situations, such sensors may result in redundancies among the sensors. However, the increased number of sensors may add to the hardware cost (e.g., both in terms of the price of the sensors the associated processing unit) and may result in dependence by the autonomous vehicle stack on a specific sensor configuration. This inhibits the scalability of the autonomous vehicle solution across various types of vehicles (e.g., a compact vehicle may utilize a configuration that is very different from the configuration of a sport utility vehicle). When fixed sensors are used, the sensor configuration (e.g., the types of sensors and the positions of sensors on vehicle) is customized for each autonomous vehicle type to achieve full redundancy in the range of perception around vehicle.

Various embodiments of the present disclosure provide adaptive image sensors to enable variable field of view (FOV) and range of focus. Similar to the human visual system, particular embodiments may add physical movement to the sensors by enabling vertical and horizontal rotation of the sensors (similar to eye globe and neck movement to expand the vision field). A particular embodiment may utilize one or more Pan-Tilt-Zoom (PTZ) cameras that may rotate to cover larger FOVs. After rotation of a camera, a calibration phase may be performed using one or more markers that are attached to the vehicle. In some embodiments, a machine learning algorithm may be trained to automate the calibration process, invoking the use of the markers when a particular sensor is to be recalibrated. Various embodiments remove the dependency on the fixed position of a sensor on a vehicle and the number of redundant sensors utilized to achieve a full coverage for the field of view. In various embodiments, external mechanical enforcements and intelligence (e.g., pre-processing of the raw sensor data) may add functionality to already existing sensors. Various advantages, such as a reduction in the number of sensors, a reduction in the amount of data that needs to be sensed, or a reduction in the power used during sensing may be achieved by one or more of the embodiments described herein.

A standard field of view of a standard monocular camera is 40° by 30° which, in the context of autonomous vehicles, is a relatively narrow and limited field of view. Due to this restricted field of view of the sensor, many autonomous vehicles include multiple sensors on a vehicle at different positions. Depending on the trajectory of an AV, the data sensed by various sensors around the vehicle are not equally important nor do they have equally useful information. For instance, for an AV driving on an empty highway, the most useful information for the AV may be obtained from one or more front facing sensors (while the data from a rear sensor is not as important, but may be checked occasionally).

In various embodiments of the present disclosure, a vehicle may include automated mechanical mounts for sensors to enable the sensors to rotate in left, right, up and down directions. Although a camera's fixed gaze may be limited (e.g., to 40° by 30°), motion of the mechanical mount will effectively increase the field of view. Thus, the useful information from a vehicle's environment may be captured by moving the gaze/attention of one or more sensors. In particular embodiments, the movement of the sensor is intelligently automated based on motion detected around the vehicle.

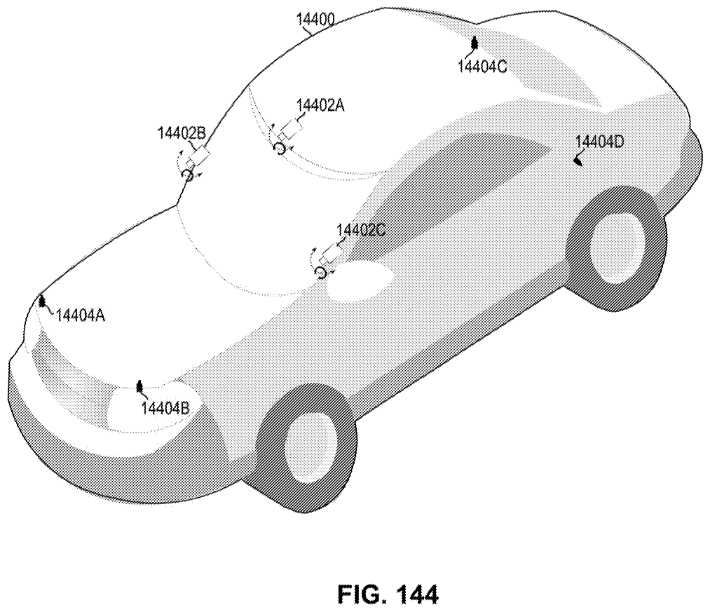

FIG. 144 depicts a vehicle 14400 having dynamically adjustable image sensors 14402A-C and calibration markers 14404A-D. Vehicle 144 may have any one or more of the characteristics of any of the vehicles (e.g., 105) described herein. Image sensors 14402 may include any suitable logic to implement the functionality of the sensors. Although the example depicts particular numbers and positions of image sensors 14402 and calibration markers 14404, various embodiments may include any suitable number of image sensors and calibration markers mounted at any suitable locations of the vehicle.

In various embodiments, the calibration markers 14404 are attached to the vehicle 14400. The markers 14404 may be placed on the exterior of the vehicle at any suitable locations. The markers 14404 may have any suitable shape (e.g., a small sphere, dot, cylinder, etc.). The markers may be of a color that is different from the exterior portion of the vehicle 14400 to which the markers are attached so as to aid detection during image capture performed during calibration. The specific locations of the markers and cameras (and the distances between them) may be used during calibration to dynamically adjust the field of view or other parameters of the image sensors 14402.

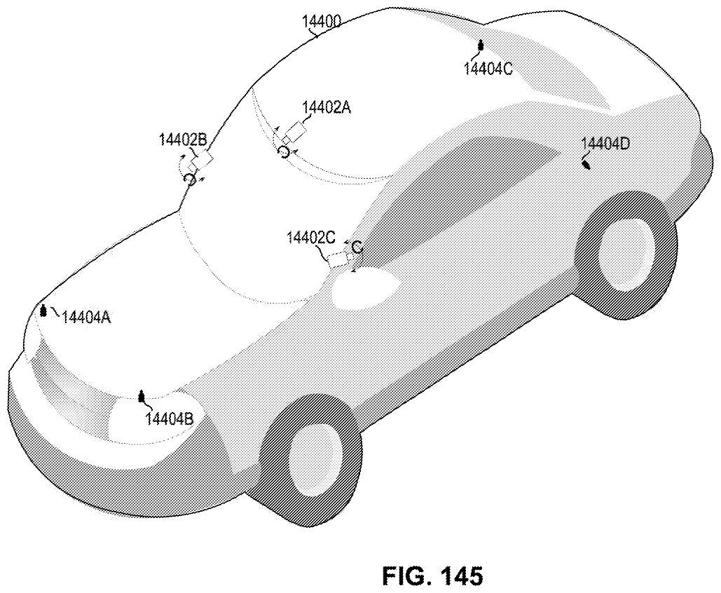

In response to a control signal from a control unit (e.g., system manager 250) of the vehicle 14400, an image sensor 14402 may rotate in a horizontal and/or vertical direction. In some embodiments, an image sensor 14402 may also be mounted on a rail or other mechanical apparatus such that the image sensor may be vertically or horizontally displaced in response to a control signal. The image sensors 14402 may be moved (e.g., rotated and/or displaced in a horizontal and/or vertical direction) into any suitable position in response to any suitable condition. For example, in the embodiment depicted, the vehicle, during normal operation, may have three forward facing cameras 14402A, 14402B, and 1440C. In response to an upcoming lane change, image sensor 14402C may be rotated horizontally as depicted in FIG. 145 (e.g., to capture a field of view that is to the side and rear of the vehicle 14400). Once the lane change has been completed (or, e.g., in response to a determination that no potentially dangerous objects are in the field of view), the image sensor may return to its original position. Sensor 14402B may be rotated in a similar manner to capture the other side of the vehicle in response to a control signal. In another example, a sensor that normally faces forward (e.g., 14402A), may rotate in a horizontal direction (e.g., 180 degrees) to periodically capture images to the rear of the vehicle 14400.

One or more markers 14404 may be used to calibrate the movement of one or more of the image sensors 14402. As an example, when an image sensor 14402 is to be moved, the control unit may provide adjustment instructions (wherein the instructions may include, e.g., units of adjustment directly or an identification of a sensor configuration that the image sensor 14402 can translate into units of adjustment). In various examples, the units of adjustment may include a degree of horizontal rotation, a degree of vertical rotation, a horizontal distance, a vertical distance, a zoom level, and/or other suitable adjustment. The sensor 14402 may affect the instructed adjustment and may initiate capture of image data (e.g., pictures or video).

Image data from the sensor 14402 is fed back to the control unit of the vehicle. The control unit may process the image and detect the location and/or size of one or more markers 14404D in the image data. If the one or more markers are not in the correct location in the image and/or are not the correct size, the control unit may determine additional adjustment instructions and provide them to the sensor. Additional image captures and adjustments may be performed until the marker(s) are the desired size and/or have the desired location within the image data (in some embodiments, after the second adjustment the image sensor may be assumed to be in a suitable configuration without an additional analysis of the marker(s)). In various embodiments, the adjustment instructions and the results (e.g., as reflected by the locations and sizes of the markers in the images) are stored by the control unit and used to refine future adjustment instructions.

In particular embodiments, instead of explicit markers embedded in the vehicle 14400, contours of the car may be used as the markers for calibration, though such embodiments may invoke more intensive processing for calibration.

In some embodiments, calibration is not performed each time a sensor 14402 is moved. In other embodiments, calibration may not be performed each time a sensor 14402 is moved, but e.g., periodically, once every n times a sensor is moved, or in response to a determination that calibration would be useful.

In various embodiments, the control unit may direct movement of one or more sensors in response to a detected condition associated with the car. In particular embodiments, such conditions may be detected based on a time-based analysis of sensor data (e.g., from one or more image sensors 14402 or other sensors of the vehicle or associated sensors). In some embodiments, movement of a sensor may be directed in response to motion in a field of view of one or more sensors (e.g., a particular image sensor 14402 may have its motion adjusted to track an object, e.g., to track another vehicle passing or being passed by the vehicle 100). In various embodiments, the movement may be directed in response to a detection of a change in driving environment (e.g., while driving on a highway, the sensors may predominately face in a forward direction, but may face towards the side more often during city driving). In some embodiments, a condition used to direct sensor movement may be a predicted condition (e.g., a predicted merge from a highway into a city based on slowing of speed, detection of objects indicating city driving, and/or GPS data). In various embodiments, machine learning may be utilized to detect conditions to trigger movement of one or more sensors.

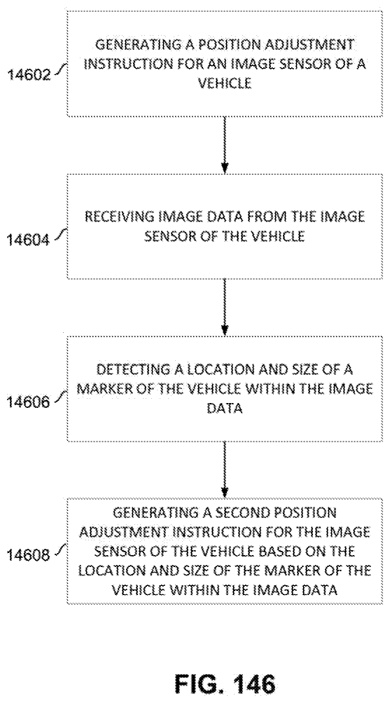

FIG. 146 depicts a flow for adjusting an image sensor of a vehicle in accordance with certain embodiments. At 14602, a position adjustment instruction for an image sensor of a vehicle is generated. At 14604 image data from the image sensor of the vehicle is received. At 14606, a location and size of a marker of the vehicle within the image data is detected. At 14608, a second position adjustment instruction for the image sensor of the vehicle is generated based on the location and size of the marker of the vehicle within the image data.

Depending on the level of autonomy of an autonomous vehicle, it may be necessary to have some human driver interaction while the vehicle is in operation. Even when a vehicle is normally able to operate in a completely autonomous fashion, there may be some situations (e.g., emergencies) in which it may be necessary for a human driver to take over the controls. In other situations, it may be desirable for a driver to take over the controls of an autonomous vehicle, e.g., when the human driver has a desire to drive or when there is a beneficial reason for a person to control the vehicle. However, humans are often inattentive, easily distracted, and slow to respond to certain situations. Accordingly, at least in some situations, a person may be unreliable as a backup in the context of a handoff in an autonomous vehicle. Furthermore, response times and reactions of humans can vary depending on situational contexts. For example, some people have slower reaction times than others. As another example, some people react calmly in emergency situations, while others panic.

It may be beneficial for an autonomous vehicle's handoff system and procedure to implement a personalized approach to handing off controls of the vehicle to a human. Such systems and procedures can enhance the safety and effectiveness of the handoff. This can be especially true in a level 5 autonomous vehicle, where the human driver is generally not needed. In some situations, the human driver may be sleeping or distracted, thus increasing the danger associated with a handoff. A personalized and coordinated approach to a handoff can take the human driver's attention level and/or reaction characteristics in such situations into account when planning a handoff.

In various embodiments, a personalized and coordinated approach to handoffs can be applied in both planned and unplanned handoffs in an autonomous vehicle. Although full autonomy may be desirable, real-world scenarios (such as, for example, critical sensor failure, unexpected and sudden road condition changes (e.g., flash floods), etc.) may create situations that exceed the capabilities of an autonomous vehicle.

According to embodiments herein, solutions to the handoff problem can comprise a multi-pronged approach taking into account one or more of the driver's activity, personal capability, and the target route when planning the handoff. This approach allows the system (e.g., in-vehicle processing system 210) to make a better judgement as to if and when to hand off the control of the vehicle to a human driver. In addition, various embodiments can also provide driver personalization over time and can constantly maintain contextual information references to progressively improve the hand off process.

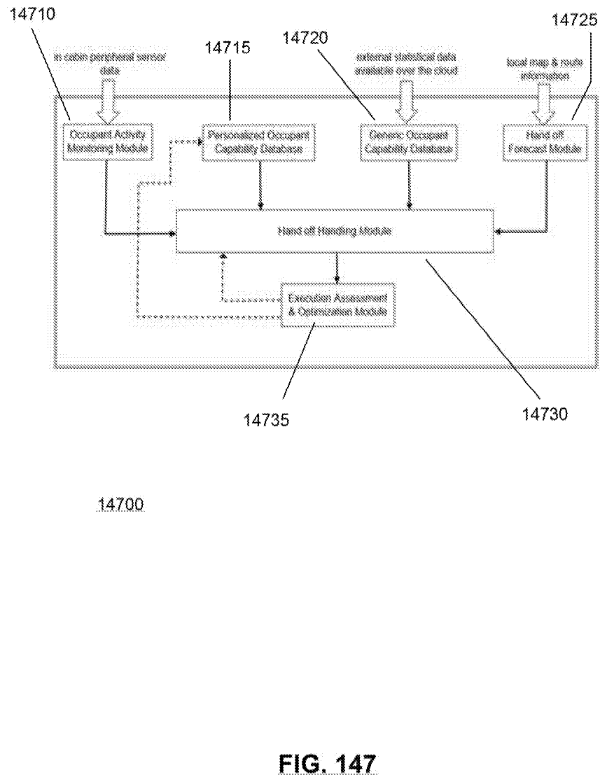

FIG. 147 illustrates an example system 14700 for the handoff of an autonomous vehicle to a human driver. The system can also be considered a system for safe, timely, and adaptive handoff of an autonomous vehicle to a human driver. In some embodiments, the various modules may be implemented by an in-vehicle processing system (e.g., 210). In other embodiments, one or more of the modules may be implemented by a cloud-based computing system (e.g., 140 or 150). System 14700 includes an occupant activity monitoring module 14710, a personalized occupant capability database 14715, a generic occupant capability database 14720, a handoff forecast module 14725, a handoff handling module 14730, and an execution assessment and optimization module 14735. System 14700 is merely exemplary and is not limited to the embodiments specifically presented herein.

The occupant activity monitoring (“OAM”) module 14710 extracts information related to the human driver of an autonomous vehicle. In a particular embodiment, OAM module 14710 implements a combination of rule based, machine learning as well as deep learning methods. The OAM may determine status characteristics associated with a human driver, e.g., the direction the driver is facing (e.g., whether the person is seated facing the road or the rear of the vehicle), the positioning of the driver's seat, (e.g., the distance of the driver's seat to the steering wheel, the inclination angle of the backrest of the seat, or any other characteristics of a driver's seat relative to the steering wheel), whether the driver is awake or asleep, whether the driver is engaged in another activity (e.g., reading, watching a video, playing games, etc.), or other status characteristic. The determinations made by the OAM module 14710 listed here are merely exemplary and the OAM can be used to determine any characteristics of the driver that are deemed relevant to the driver's ability to take full or partial control of the vehicle.

The OAM module 14710 may use data from several different sensors as input. For example, in-vehicle sensors that may provide information to OAM module 14710 include, e.g., a camera, inertial measurement unit, seat and backrest sensors, ultrasonic sensors, or biometric sensors (e.g., heart rate monitor, body temperature monitor, etc.). The data from the sensors can be in a raw format or pre-processed. The sensors listed herein are merely exemplary and any type of sensor, whether listed herein or not, can be used as a data input to the OAM module 14710.

The generic occupant capability (“GOC”) database 14720 can include data related to statistical information of the characteristic of a generic driver similar to the actual driver of the autonomous vehicle. For example, the GOC database 14720 can contain information for characteristic responses for a driver that has similar characteristics (e.g., gender, age, physical fitness level) to the actual driver. Furthermore, the information stored in the database 14720 can either be global or specific to one or more particular geographic areas. In some embodiments, the GOC database 14720 can be external to the vehicle and made available to the autonomous vehicle over the cloud. The GOC database 14720 can be updated at any suitable time or interval so that handoff operation of the autonomous vehicle can be improved over time. It should be noted that DOC database 14720 can comprise more than one database.

Examples of the types of data in the GOC database can include the amount of time it takes for a characteristic driver (e.g., a person having similar characteristics, e.g., age, gender, etc. as the driver) to: respond to a prompt, rotate a seat by 180 degrees, move the seat longitudinally a certain distance, place his or her hands on a the steering wheel from resting on his or her lap, get engaged to the road when away (this can depend on the activity of the driver before being alerted to the engagement), or other suitable activity associated with a handoff. In addition, characteristics of the driver (e.g., health conditions of the driver) can be used to produce statistical data that corresponds to context of the driver's situation. For example, the database may capture information indicating that an average driver with the same lower back problem as the driver of the autonomous vehicle may take a certain amount of time on average to bring the seat to an upright position or to move the seat forward towards the steering wheel.

Besides utilizing available statistical data, machine learning models implemented by, e.g., in-vehicle processing system 210 can also be used to process raw data onboard the autonomous vehicle. In other embodiments, such machine learning models may be run on the cloud (rather than locally onboard the autonomous vehicle) and inference output may be utilized onboard the vehicle.

The personalized occupant capability (“POC”) database 14715 may contain data that is similar in nature to the GOC database 14720. The POC database, however, includes driver and vehicle-specific information rather than information aggregated from multiple drivers as with the GOC database. The data in the POC database 14715 can help improve the function of system 14700 because each person will vary from the baseline established by GOC database 14720. The data in the POC database 14715 can be observed and measured over time. The POC module 14715 of system 14700 can be considered the central location that keeps track of the differences between the driver and the hypothetical driver.

In addition to driver specific information, the POC database 14715 can also contain vehicle specific information. For example, the time that a driver will turn around a seat 180 degrees may be reliant on the vehicle's technical capabilities, and the driver cannot speed up or slow down this process.

As examples, the following types of data may be stored in the POC database: the driver takes X1 seconds longer to respond to an audio prompt than the average driver; the driver takes X2 seconds less than average to rotate his seat (e.g., this may be because the vehicle has a quick turnaround operation and/or the driver responds relatively quickly), the driver is X3 seconds slower than an average driver to move his seat longitudinally, the driver is X4 seconds faster than average to place his hands on the steering wheel, and the driver is X5 seconds faster than an average driver to engage the road when awake. While these examples discuss measurements relative to the average driver, in some embodiments information stored by the POC database may include absolute measurements (e.g., the driver takes Y1 seconds on average to respond to an audio prompt, the driver takes Y2 seconds on average to rotate his seat, etc.). In addition, similar to the GOC database, the POC database can contain other characteristics of the driver that can be used to produce statistical data that may provide more context to the driver's situation. As examples, the POC databased may include information indicating how quickly the driver will move to bring his seat to an upright position or to move his seat forward due to a back injury.

The handoff forecast (HOF) module 14725 determines when a handoff may be needed. The HOF module can consider road conditions, such as, for example, accidents, overcrowded roads, public events, pedestrians, construction, etc. to determine where and when a handoff from an autonomous driver to a human driver may be needed. The HOF module can receive, e.g., local map and route information with real-time traffic, accident, hazard, and road maintenance updates. Portions or all of this information may be locally stored within the autonomous vehicle or in the cloud (and the vehicle may receive updates on such information through the cloud).

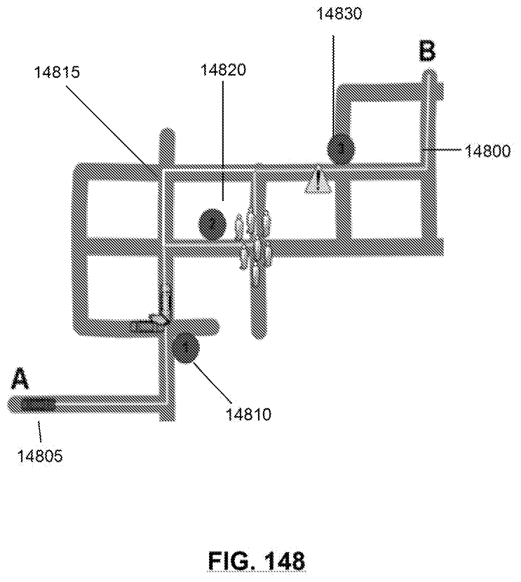

FIG. 148 illustrates an example route 14800 that vehicle 14805 is taking to get from point A to point B. Route 14800 has been selected by the navigation system of car 14805 (e.g., path planner module 242). HOF module 14725 may consider road conditions such as accidents, overcrowded road segments, and road construction sites to determine where a handoff to the human driver may be needed. In the example of FIG. 148, three areas (14810, 14820, and 14830) where such a handoff may be required have been determined. After identifying the likely handoff locations, HOF module 14725 may rank the locations based on different criteria. Examples of such criteria can include:

1—Is there an alternative route that may be less preferable but does not require handoff to the human driver at the identified location? As an example, location 14820 may be associated with an alternative route 14815.

2—Can the autonomous vehicle handle an identified handoff location by reducing speed and/or by intermittently stopping if needed? As an example, location 14830 has ongoing road construction that is likely to slow the traffic in a controlled and safe way.

3—Is there any segment along the route that the autonomous vehicle will not be able to handle without human intervention? As an example, location 14810 may be such a location, since an accident may have caused serious disruption to traffic. The autonomous vehicle needs to make sure that the human driver is prepared in advance when approaching this particular location.

In various embodiments, the HOF module 14725 may determine the handoff locations along the route as well as rate their relative importance (e.g., which handoff locations are more likely to require a handoff).

Returning to FIG. 147, the handoff handling (“HOH”) module 14730 may consider the handoff related information to make handoff decisions. The HOH module 14730 accepts the outputs of the OAM module 14710, the POC database 14715, the GOC database 14720, and the HOF module 14725 and makes handoff decisions based on one or more of these.

Finally, the execution assessment and optimization (“EAO”) module 14735 compares the expected outcome of the handoff with the driver's actions. The results of the comparison are fed back to the POC Database 14715 and the HOH module 14730 for improving the handoff in the future. To collect the information, the EAO Module 14735 can use the following example criteria at each handoff event along the route: how long it took the driver to respond to a hand off request; whether the driver was within the expected steering range after the hand off; whether the driver's acceleration/deceleration was within the expected acceleration/deceleration range after the hand off; and how long it took the driver to engage with the road shortly after the hand off. The criteria listed here are merely exemplary, and in various embodiments not all the criteria are used or criteria not listed may be used.

Updates within the POC database 14715 allow the handoff process to consider the more personalized information according to the driver and the technical capabilities of the autonomous vehicle. As such, over time, as the number of rides in an autonomous vehicle increases, the POC database 14715 starts to differentiate itself more from the GOC database 14720.

The HOH module 14730 uses the feedback information coming from the EAO module 14735 to calculate when and where the driver has shown anomalies from typical behavior. This may be different from what the POC database 14715 stores for the driver as it is related to deviations from the expected behavior of the driver and may be considered in future handoffs. If the HOH module 14730 takes such anomalies into account for future hand offs, the road safety can be improved as the autonomous vehicle will be making the hand off decisions and the hand off execution assessments based on data that is more representative of the driver and autonomous vehicle because it is based on real world observations.

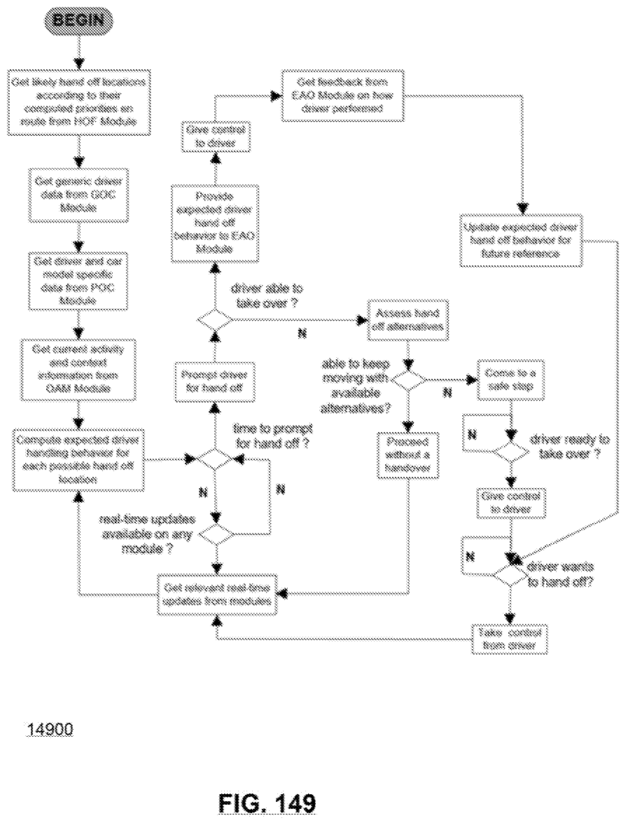

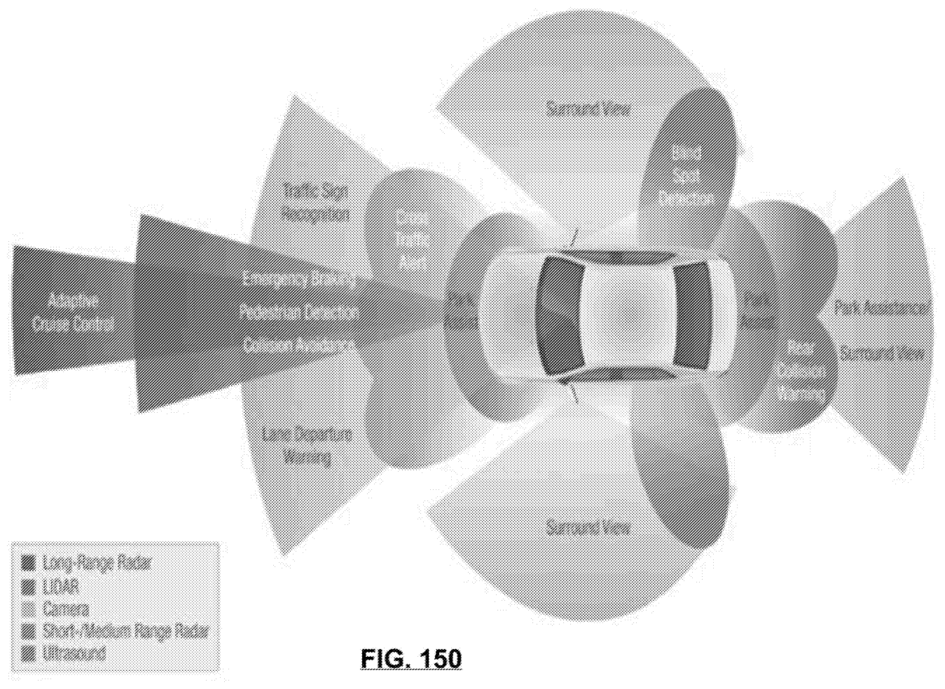

FIG. 149 illustrates an example of the HOH module 14730's high level operational flow 14900. This operational flow can also be considered a method for handing off an autonomous vehicle to a human driver. Initially the method begins with obtaining the determined handoff locations from the HOF module 14725. These can be determined from the computed priorities of the route.

Next, method 14900 continues with getting the generic driving data from the GOC database 14720. It should be noted that it may not be necessary to obtain any generic driving data. For example, when there is an adequate amount of data stored in the POC database 14715 the data from the GOC database 14720 may be omitted from certain determinations. It should also be noted that it may be possible to transfer the personalized data from one location to another, such as, for example, when a driver purchases a new vehicle the information may be transferred from the old vehicle or the cloud to the new vehicle.

After obtaining the generic data (if utilized), the HOH module continues with obtaining the personalized data from the POC database 14715. It should be noted that there may be situations in which there is no personalized data, such as, for example, when the vehicle is brand new and no data has been obtained yet.

Next, method 14900 continues with obtaining data from the OAM module 14710. This data can comprise information about the driver as it relates to the driver's level of attention, activities, etc.

The HOH module then can determine the expected driver handling behavior for each of the possible handoff locations as determined by the HOF Module 14725. If the HOH module 14730 determines that it is time for a handoff, then the driver is prompted. If not, the HOH module 14730 can determine whether there are any real-time updates from any of the other modules. If there are, the update or updates can be used to redetermine the expected driver handling behavior.

Continuing with the example of FIG. 149, after the driver has been prompted, the HOH module 14730 will determine whether the driver is capable of taking over. If so, the HOH module can provide the expected driver behavior to the EAO module 14735 and then can pass control of the vehicle to the driver. Furthermore, data can be obtained from the EAO module 14735 on how well the driver performed during the handoff and the expected driver behavior can be updated in response. The driver can continue to drive, e.g., until the driver is ready to relinquish control or a determination is made that the AV may safely resume control.

If the driver is not ready to take over when prompted, the HOH module 14730 can assess whether there are alternatives to a handoff. This can include, for example, taking an alternate route, slowing down, etc. If there are alternatives, then an alternative can be chosen. If there are no alternatives that will allow the vehicle to continue moving, then the HOH module can bring the vehicle to a stop. It should be noted that this could involve a change in the desired route to ensure that the vehicle can stop in a safe location and manner. If the vehicle comes to a stop, then the vehicle can remain at a stand-still until the driver is ready to take over. Then the driver can drive until he or she is ready for the autonomous vehicle to take over once again and it is safe to do so. In other embodiments it may also be possible for the vehicle to remain at a stop until there is an alternative that allows the vehicle to move again. This can include, for example, a change in the road conditions that caused the vehicle to stop, or even a new route that has opened.

The example below illustrates the operation of the HOH module 14730 by utilizing the example operational flow of FIG. 149 in combination with the example of the route of FIG. 148.

Before the Journey:

1. The optimal route (14800) between A and B has been calculated and provided to the HOF Module.

2. HOF module 14725 uses the real-time updates to identify the three hand off areas (14810, 14820, and 14830.)

3. The HOF module decides that location 14810 is where driver support is most likely to be needed (because there is little information on the accident in that spot.)

4. Location 14830 is chosen as the next most probable location where another hand off may be needed due to the ongoing road construction.

5. Location 14820 is identified as another potential hand off area where an increased pedestrian traffic on the road is observed. The autonomous vehicle can easily handle this section of the ride by taking an alternate route 14815 without requiring assistance from the driver.

6. The GOC database 14720 provides the generic information on drivers to HOH module 14730.

7. The POC database is empty (as the driver has just bought his car, which has limited personalized information based on him).

8. The OAM module 14710 confirms that the driver is sitting behind the wheel and his son is seated in the back.

9. The model of the vehicle that the driver is driving has fully rotatable driver seat to allow him to interact with the passengers in the back freely during the drive. As such, the driver turns his back to the road and starts to talk to his son.

10. The in-cabin cameras have full coverage of what is happening in the car so the OAM module 14710 is notified of this conversation activity as well as the driver's seating position in real-time. The OAM module 14710 also notices that the driver has slightly moved his seat closer to his son while talking and is leaning forward.

During the journey:

11. The autonomous vehicle starts to move forward towards the first hand off location 14810. Since this first hand off location is the most critical one and where the vehicle will require the driver's intervention, the HOH module 14730 starts to notify the driver early for an upcoming hand off.

12. The HOH module 14730 knows how long it is likely to take the driver to turn around and to place hands on the steering wheel.

13. The HOH module 14730 also knows from the GOC database 14720 that it generally takes longer for a senior driver to become fully aware than a younger driver. Therefore, as an example, if the driver is a 50-year-old male, it can take 15 to 20 seconds for the driver to become fully aware of the driving context as soon as he puts his hands on the wheel. Therefore, this additional time is also considered by the HOH module 14730 as the hand off in location 14810 nears.

14. The HOH module 14730 also provides the expected response times by the driver to the EAO module 14735 for it to assess how the hand off will be executed. The driver responds to the hand off request by the vehicle and he successfully guides the car through the accident on the road.

15. The driver hands off to the autonomous vehicle after leaving the accident location behind when he receives an incoming call on his smart phone.

16. The EAO module 14735 starts making the assessment of the hand off in location 14810. It appears that the driver has responded 10 seconds later than what was expected by the HOH module 14730. The timestamp on the OAM module 14710 indicates that when the driver was supposed to receive the control of the car, he was busy handing over a toy to his son at the time which caused this unexpected delay.

17. This anomaly is reported back to HOH module 14730 for future reference in order to leave additional time for planned hand offs.

18. The driver's performance during the handoff has also been reported back to the POC module 14715 for internal updates.

19. As the vehicle is approaching handoff 14820, the OAM module 14710 confirms that the driver is still on the phone and seems to be giving signals of elevated distress.

20. The HOH module 14730 knows that handoff location 14820 can be avoided by following the alternate route 14815. This route will add an extra 2 minutes to the journey but will allow the driver to continue his phone conversation without interruptions.

21. The HOH module 14730 decides not to request a handoff at location 14820 and the vehicle continues autonomously.

22. The HOH module 14730 is aware of the road construction in handoff location 14830 and while the handoff in this location is not as critical as location 14810, with a human intervention, the journey time may be a bit shorter.

23. The OAM module 14710 indicates that the driver is no longer talking on the phone and he is facing forward casually watching the traffic in front of the car.

24. The HOH module 14730 decides that the driver may be able to take over quite easily and notifies him of an optional hand over to save journey time.

25. Upon deciding that saving a few more minutes by taking over is a good idea, the driver agrees to take over and the handoff in location 14830 is executed successfully.

26. The POC module 14715 is updated by the EAO module 14735 after the handoff and, since no anomalies were detected, the HOH module 14730 receives no notifications this time.

27. For the rest of the journey, the driver decides not to handoff and drives to his destination in manual mode.

The example above is merely exemplary and more or less, and even different, actions may be taken. Similarly, the example method of FIG. 149 is also exemplary and more or less steps in that method may be taken.

It should also be noted that there may be situations where the autonomous vehicle has no option but to handoff to the human driver (in order to fulfill the journey's original objectives in terms of routes, ETA etc.) while the human driver is in no position to take over. In such scenarios, the autonomous vehicle may choose the following safer options: pull over and come to a safe stop until a time when the human driver is able to take over; pull towards the slow lane and reduce cruising speed according to the traffic and the road conditions at the cost of increased travel time; calculate alternative routes that will allow the vehicle to proceed without handing over (such routes may be longer and/or slower); or calculate alternative routes that will not allow the vehicle to proceed without a hand off all the way to the final destination, but will allow the vehicle to come to a safe stop until a time when the human driver is prepared to take over. These solutions are merely exemplary and there may be other solutions to a mandatory handoff of the vehicle.

The level of autonomy of an autonomous vehicle depends greatly on the number and type of sensors with which the autonomous vehicle is equipped. In addition, many of the different functionalities of the autonomous vehicle, such as, for example, autonomous highway driving, are achieved with a specific set of well-functioning sensors that provides the autonomous vehicle with the appropriate information that is processed by the algorithms of the vehicle's control systems.

Since sensors play such a vital role in the operation of autonomous vehicles, it is important that the health of the various sensors is known. In addition to the safety concerns of the health of the sensors (if there is a sensor failure there is a chance that the vehicle cannot keep driving autonomously), there are other benefits to knowing the health of the sensors of the vehicle. This can include, for example, increasing the confidence of the driver/passenger and improving the efficiency of the autonomous vehicle.

As autonomous vehicle technology improves, the number of sensors on autonomous vehicles increases. For example, to reach level 3 of automation, some car manufacturers have equipped a car with 14 or more sensors. FIG. 150 illustrates an example of sensor's arrays commonly found on autonomous vehicles. Sensors can include, for example, radars, LIDAR, cameras, and ultrasonic sensors. Having more sensors can account for redundancy and increased functionality, however, in the event of a sensor failure, the autonomous vehicle may be configured to be self-aware and be able to determine the vehicle's capabilities after the failure.

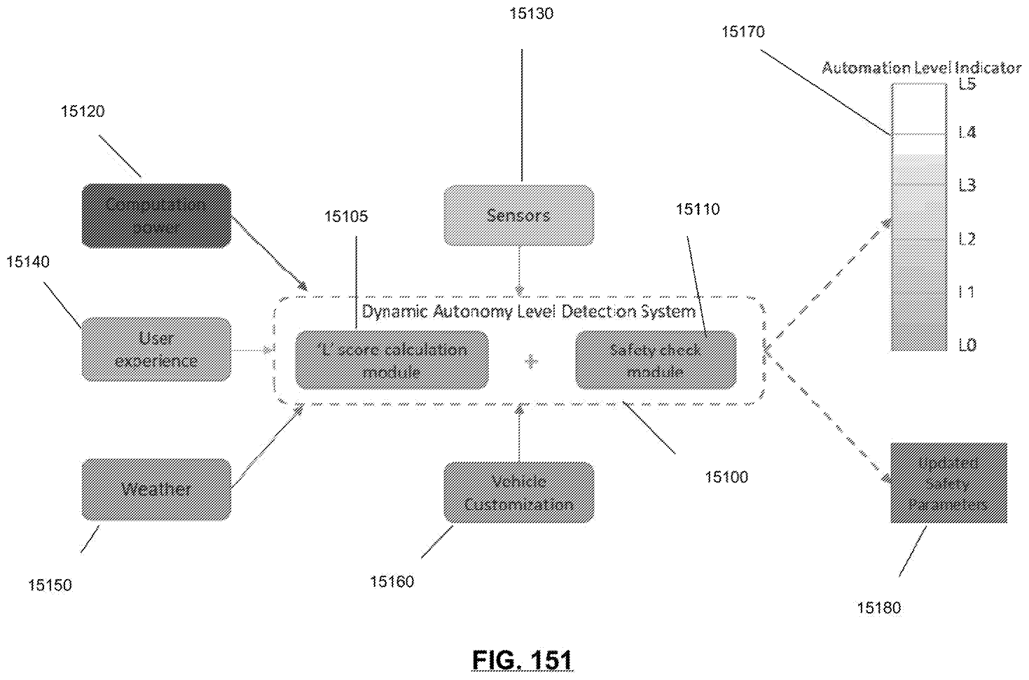

FIG. 151 illustrates an example of a Dynamic Autonomy Level Detection (“DALD”) System 15100 that adapts the autonomous vehicle functionalities based on the sensing and processing capabilities available to the vehicle. In some embodiments, system 15100 can consider the driver's desired experience (e.g., the level of autonomy the driver desires) and the current course of action of the vehicle. This DALD system leverages different inputs, such as, for example, one or more of weather conditions, sensor performance, vehicle customization, and the driver's plans to dynamically determine the maximum necessary level of autonomy the vehicle should function at for a defined route. As such, the vehicle can adapt its functionalities based on the health of the existing sensors, vehicle customization (e.g., a vehicle with trailer blocking rear sensors), weather conditions, etc.

With continued reference to FIG. 151, system 15100 comprises a score module 15105 and a safety module 15110. The score module 15105 can also be considered an “L” score calculation module. The score module estimates the level (“L”) of autonomy that the vehicle can implement based on different inputs received by system 15100. Examples of inputs received by the DALD system 15100 can include: sensor state (or health) information 15130, desired user experience 15140, weather conditions 15150, computation resources 15120, and vehicle customization state 15160. It should be noted that the list of inputs herein is merely exemplary and more or less inputs than those listed can be considered as inputs for system 15100.

As an example, the ‘L’ score can be defined as:

$${L}_{score} = {\sum }_{i = 1}^{N} {w}_{i} * {input}_{i}$$

Where inputᵢ is one of the N different inputs to the DALD system 15100 depicted in FIG. 151, and where wᵢ are the different weights associated with each inputᵢ. The weights can dynamically change as the autonomous vehicle capabilities change overtime and are dependent on the autonomous vehicle's architecture, such as, for example the vehicle's sensors and algorithms. Having a wᵢ=0 means that input; was disabled. The autonomous vehicle should then adapt that L_{score} into a number that corresponds to the different levels of automation available on the car, which can be an integer from 0 to 5, if the maximum automation level available in the car is Level 5.

Note that in at least some embodiments the weights shall also satisfy the following condition to generate the L_{score} consistently when the number of contributing inputs change:

$$1 = {\sum }_{i = 1}^{N} {w}_{i}$$

Accordingly, in an embodiment, when one or more inputs have zero weights, the remaining non-zero weights are adjusted to add up to unity at all times.

Although the example of the L_{score} above illustrates a linear relationship, it is possible that the L_{score} can be defined in terms of higher order polynomials, which would utilize a more complex calculation and calibration. Therefore, the above linear relationship has been provided as an example that represents a relatively simple way of calculating the L_{score}.

With continued reference to FIG. 151, the ‘L’ score calculation module 15105 is vehicle dependent and is intended to illustrate the capabilities of the vehicle based on its current state. Examples of inputs that can affect the “L” score can include: computation power 15120 of the vehicle, the sensors 15130 of the vehicle, the user experience 15140, weather 15150, and vehicle customization 15160. This list is not exhaustive of all the factors that may be used to calculate the “L” score and not all of the factors listed have to be used in the “L” score calculation.

As stated above, the sensors 15130 are instrumental in the autonomy level of autonomous vehicles. As such, the sensors 15120 can affect the “L” score greatly. When a sensor or multiple sensors are damaged the DALD system 15100 can disable a sensor or set a smaller input weight for the impacted/affected sensor or sensors. Thus, demonstrating a lower trust level, and likely lowering the “L” score. Besides a damaged sensor, the following are examples of reasons why the weighted score of the sensor input may be lowered in the “L” score calculation: a poorly performing sensor, abnormally functioning sensor (e.g., a sensor that starts performing abnormally due to gradual deterioration), sensor drift, and an intentional disabling of the sensor if it is not needed for the current driving performance, which can save computational and battery power.

The weather 15150, which can include other environmental conditions, can also have an impact on the autonomy level of vehicles. As an example, the autonomous vehicle could lower its autonomy level if it detects a hazardous weather condition, such as, for example, snow along the route that it is not prepared to manage properly. Such environmental conditions can adversely affect the sensing capabilities of the autonomous vehicle or significantly decrease the tire traction, which may prompt an autonomy level regression.

Vehicle customization 15160 can also influence the autonomy level of the vehicle. If a person adds elements to a vehicle after sensors are calibrated, some sensors may be occluded. In some examples a sensor may need to be disabled when making vehicle modifications. In such situations, the sensors may need to be weighted less heavily because of temporary or permanent modifications. Examples of vehicle modifications can include, for example, attached trailers/others at the back of the vehicle, an attached roof rack, or even and additional payload (e.g., suitcases, furniture, etc.) It should be noted than any change to the vehicle that can affect the sensors or handling of the vehicle can be included in vehicle customization 15160.

A driver/passenger of the vehicle may want to prioritize certain aspects of the drive/route. This user experience 15140 can also affect the autonomy level of the vehicle. As an example, the driver might want to prioritize time of travel no matter how many times the autonomous vehicle could request a takeover (driving through urban areas) or the driver might want to prioritize a scenic view that will take more time. The driver may even prioritize routes where higher levels of autonomy aren't needed, like highway driving (that can be achieved with minimal set of sensors.) In some situations, the level of autonomy may be completely irrelevant, such as, for example, when the driver simply enjoys driving a car or enjoys the scenery.

Another factor in the “L” score is the computational power 15120 available. For example, if the car's battery isn't fully charged or if it is faulty, then there may not be enough power for the extra computation needed to reach higher levels of automation on an autonomous vehicle. As another example, a component relevant to the self-driving capabilities of the autonomous vehicle, such as a hard drive, is malfunctioning or has limited space for keeping data, then the autonomous vehicle should adapt its level of autonomy based on the computation capabilities it possesses.

After receiving the inputs mentioned above, the DALD system 15100 can determine which functionalities to enable along the route. As such, system 15100 provides an advanced contextual awareness to the autonomous vehicle before a journey. For example, if there is an abnormal functioning sensor, the vehicle can disable that sensor and can determine how that sensor contributed to the current autonomy level and which algorithms were dependent on that sensor information. If the car can function by disabling that sensor, thanks to sensor redundancy, then the ‘L’ score may remain the same. However, if that sensor was critical for the performance of the autonomous vehicle, such as, for example, a 360 degrees LIDAR sensor used for localization in Level 4, then the autonomous vehicle should reduce its level of autonomy to where it can maximize the automation functions without that sensor. This may mean dropping the autonomy level, such as to L3 or L2, depending on the vehicle's design. In another example, it may also be necessary to drop the autonomy level if a trailer is attached to the vehicle, thus blocking any rear sensors. As yet another example, the autonomy level may be dropped when a roof rack with snowboards are interfering with the GPS signal of the car.

With continued reference to FIG. 151, an automation level indicator 15170 can display the current “L” score for better visualization, which can increase the user's awareness and trust in the autonomous vehicle. The indicator 15170 allows the user to see how the autonomy level changes after events that may affect the vehicle's abilities. As a result, the user can be aware of how changes to the vehicle (e.g., sensor damage, customization, etc.) affect the autonomy level of the vehicle and could consider other alternatives, such as, for example, not hitching a trailer, if the user is more concerned on the safety and automation capabilities along the route. As another example, it could even impact the level of self-confidence in the user's abilities to handle situations along a route or may prompt the driver/owner to take the vehicle for service if vehicle consistently, or occasionally, is performing below capabilities/expectations.

The DALD system 15100 also comprises a safety check module 15180 that is responsible for determining which of the autonomous vehicle's parameters are important for path planning algorithms. Examples of such parameters can include the coefficient of friction in certain areas of the route, which may change due to different weather conditions; the weight of the autonomous vehicle, which can change due to vehicle customization and that affects the maximum acceleration and maximum and minimum brake of the autonomous vehicle. Being able to modify the parameters intrinsic of each route and path planning algorithm will play an important role in the safety of the autonomous vehicles. Safety modules rely on the accuracy of these parameters in order to estimate the best control parameters for the user.

In addition to the obvious safety benefits, an additional benefit of the system 15100 is that by making the autonomous vehicle self-aware and to dynamically adapt its functionalities, the power consumption of the car and the cost of maintenance of the autonomous vehicle can be reduced in the long term. Thus, the user's input may be important to system 15100. Depending on the user's desire to go on the fastest route, or the scenic one, for example, an L5 autonomous vehicle could choose to stay on L3 mode along the route (or parts of the route) after checking the sensors status and predicted weather conditions, which could avoid wearing out expensive sensors and computation resources.

As autonomous vehicles become ubiquitous, they will become a common part of family households, replacing the regular family vehicle. As they become more universal, they will be expected to perform the functions of the traditional human driven vehicles and not just the regular day-to-day commutes to work or school. This means that people will expect autonomous vehicles to provide more versatility, such as, for example, facilitating camping trips, weekend getaways to the beach or lake, or a tailgate party at a sporting event. Therefore, autonomous vehicles be expected to be able to perform temporary hauling of equipment. As examples, such equipment may include camping gear, bikes, boats, jet-skis, coolers, grills, etc. Accordingly, autonomous vehicles may include the ability to hitch a trailer, hooks, platforms, extension, or the like.

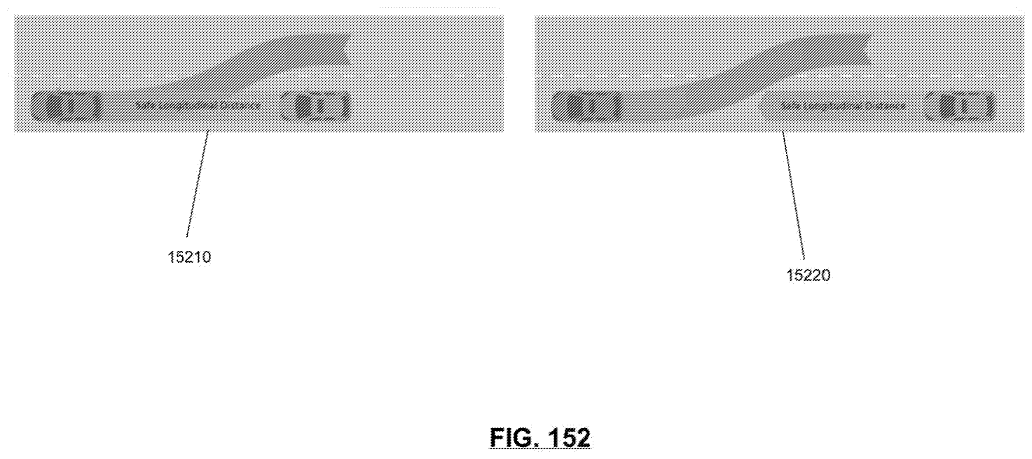

However, such attachments on an autonomous vehicle may result in sensor occlusion, and may result in a change of the vehicle behavioral model with respect to the vehicle's dimensions. This is particularly true for the pre-existing parameters that are an integral part for keeping a safe distance for which the vehicle will now need to compensate when maneuvering along roadways. As an example, and with reference to FIG. 152, if an autonomous vehicle thinks that it has enough room to pull in front of another vehicle, but it instead is much longer than its control system realizes, it could prevent the trailing car from having enough space to stop, or worse, hit the vehicle that the autonomous vehicle is passing.

As other examples, similar considerations need to be taken if vehicle owners start making vehicle customizations, such as lowering the vehicle, or incorporating oversized tires (that may protrude outside the wheel wells), spoilers, or other add-ons. These customizations may alter the modeling and calibration of vehicle parameters.

As such, it may be important to obtain the new vehicle dimensions to the extent that the dimensions of the vehicle have been extended by the modifications. This will allow the autonomous vehicle to determine how much guard-band is needed to alter the safe distance clearance models to compensate for the extensions. This distance is crucial for navigation, which allows the autonomous vehicle to avoid accidents, and applicable to systems, such as adaptive cruise control, when backing out of a parking spot, and performing similar autonomous actions.

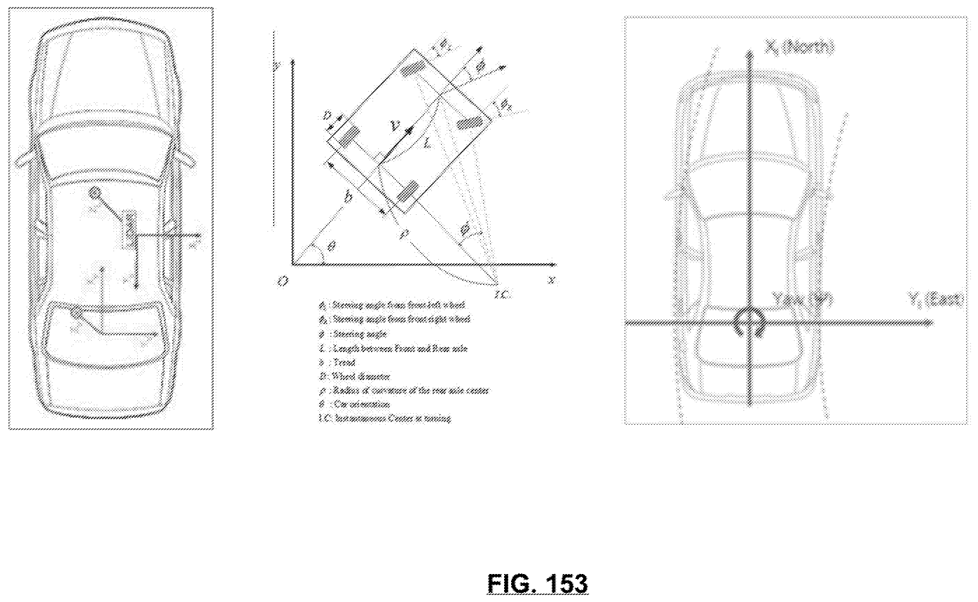

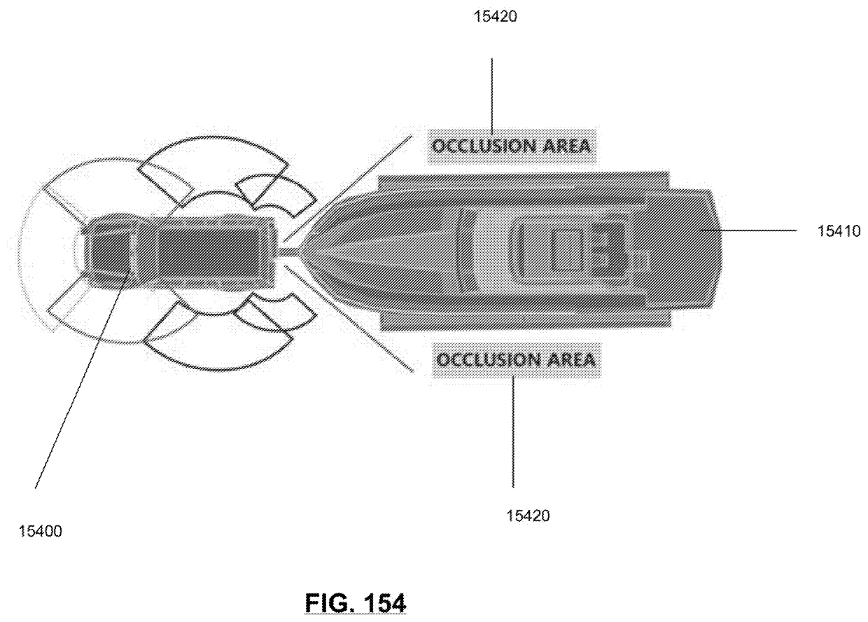

While models exist for driving safety, such as, for example, safe driving distances, the safety of an autonomous vehicle can be increased if an autonomous vehicle knows that the dimensions of the vehicle have changed. Furthermore, robotic drivers of autonomous vehicles rely on sensors and rigorous calibration for proper execution. As part of vehicle sensor calibration, a coordinate system is adopted in which a vehicle reference point is very unlikely to be moved/altered, except for perhaps, elevation. One example, the Ackerman model, as shown in FIG. 153, comprises the vehicle's rear axis center point between the two wheels. Any changes to this model may be considered and referenced with respect to such coordinates. As an example, when the extension to the vehicles dimensions are the result of a hitch being attached to the vehicle, the coordinates are offset to account for the hitch point

In addition to the disruption of the vehicle modeling system, customizations, such as the addition of a trailer hitch can disrupt both the sensors of the vehicle and the maneuverability o the vehicle. These disruptions will likely impact the level of autonomy of the vehicle. FIG. 154 illustrates an example of a vehicle 15400 with an attachment 15410 (e.g., a boat being towed by the vehicle in this example.) As shown in this example, the customization produces occluded areas 15420.

One possible solution to dealing with the new dimensions of the vehicle would be to furnish the trailer or hitch with corresponding sensors. This would, however, add to the complexity of the system and could be both time consuming and expensive. For example, a user would have to worry about compatibility of the new sensors systems with existing vehicle system; it would be expensive and time consuming to complete the rigorous steps for calibration; there may be exposure to elements (e.g., the sensors could be submerged into water if the extension is a boat, jet-ski, canoe, etc.); and there may be poles or other hardware extending beyond the trailer (e.g., a boat can be much larger than its trailer.) In addition, the use of such a trailer (for a boat, for example) would be temporary (a weekend outing), which would make this solution impractical and unlikely to be enforced/observed.

Another possible alternative would be the implementation of an array of ultrasonic sensors along the same coordinate system as the vehicle model, capable of 3D modeling, that could capture, with some approximation, the width and depth of the customization causing the occlusion of the sensors.

As yet another example, a simple and low-cost solution includes a method that captures and traces the new exterior vehicle dimension as a result of the customization (e.g., an attached trailer/hitch). The autonomous vehicle could then compensate as needed (while the trailer/hitch are attached) on a temporary basis.

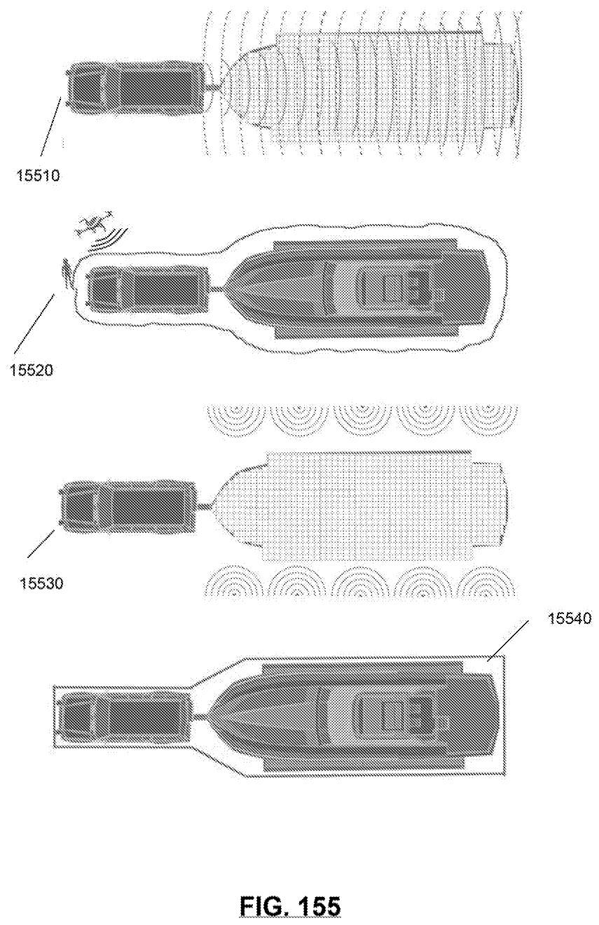

FIG. 155 illustrates an example of the use of a simple method of tracing the new dimensions of the vehicle incorporating dimensions added by an extension coupled to the vehicle. As a comparison, 15510 shows a 3D ultrasound map of the vehicle and extension, which may be sensed by an ultrasonic sensor which may or may not be attached to the vehicle. In some examples, the example of 15510 can be automated. In such examples, when the vehicle detects an occlusion or that a trailer is attached, an automatic ultrasonic scan can begin, creating the rendering of the 3D model. Another example is illustrated at 15530. In the example of 15530, the new dimensions of the vehicle are captured using LIDARs, such as, for example with the use of a LIDAR based station. 15520 illustrates an example of a user performing a manual walkthrough to facilitate tracing of the vehicle's new dimensions. After the walkthrough, the new model 15540 for the vehicle's dimensions is created. To conduct the walk through, the vehicle owner can walk along the path of the vehicle and extensions at a given length (e.g., arm length) while carrying a sensor. In some examples, this sensor can be paired with (e.g., communicatively coupled to) a smart phone. In other examples, the sensor can be paired with the vehicle. In various embodiments, as illustrated by 15520, the dimensions of the vehicle can be traced using a drone and camera, as opposed to physically walking around the vehicle. The tracing results can then be delivered to the autonomous vehicle and a polygon model representation 15540 can be approximated. This model can be incorporated into the autonomous vehicle's driving algorithms.

A system for incorporating the above options can comprise one or more of the following elements: a vehicle with an integrated hitch on the vehicle with a sensor that registers when a hitch is attached to or disconnected from an extension; an alarm that warns driver that a ‘safety-walkthrough’ is needed responsive to sensing of a hitch attachment; a sensing element/device to create the tracing; non-occluded sensors that validate/serve as cross-reference while tracing in progress; and a vehicle warning system that warns the driver of changes on its level-of-autonomy as a result of the tracing and the remaining functional sensors. In one embodiment, the sensing element/tracing device may comprise a smart phone app that calculates the new autonomous vehicle dimensions based on one or more images captured by the smartphone camera. The user may simply walk around the perimeter of the car, or a drone may be used, to scan the new dimensions. In another example, the scanning device can comprise an integrated detachable vehicle camera that performs functions similar to those described above. After the scanning, if gaps exist in the trace, or if the result is not exactly a straight-line trace (or does not exactly stop at the point of origin), the trace can still be converted into a closed polygon/loop around the vehicle based on the captured points of the trace. The vehicle can consider the original dimensions to compensate effects of a ‘pivot’ point on curvatures and the new model of the dimensions can include an offset that will guarantee the model will be outside of the vehicle limits, which can be an added safety buffer. In other embodiments, other methods of determining the new dimensions can be used, such as, for example, ultrasound and LIDAR sensors, which may or may not be attached to the vehicle.

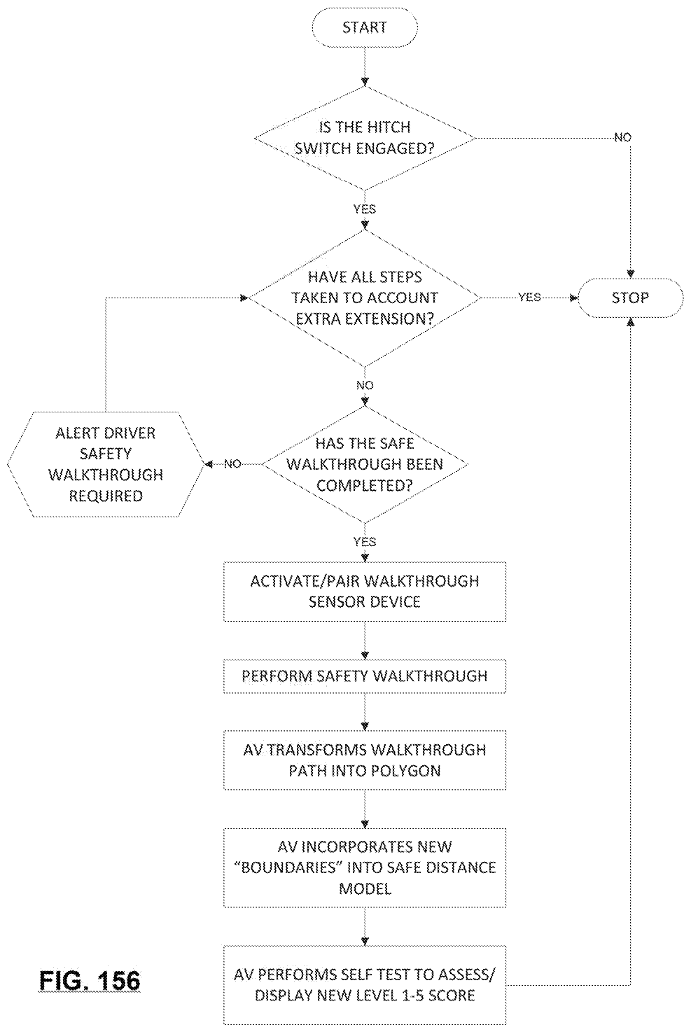

FIG. 156 illustrates an example of a vehicle model occlusion compensation flow according to at least one embodiment. The example of FIG. 156 can also be considered a method of updating the vehicle dimensions of an autonomous vehicle.

The example of FIG. 156 comprises actions that include determining whether a hitch switch has been engaged. In some embodiments the hitch can include an automatic sensor (e.g., switch) that indicates whether the hitch has been engaged. In various embodiments, the autonomous vehicle can additionally or alternatively include a manual switch to indicate that the hitch has been engaged.

If the hitch switch has been engaged, the vehicle can perform a check to determine if all the necessary safety actions have been performed before the vehicle moves with the added dimensions. If they have, the flow ends. If not, the vehicle can determine whether a safety walkthrough that captures the new vehicle dimensions has been completed. If not, the driver can be warned that a walkthrough is necessary, and the walkthrough can begin.

To perform the walkthrough, the vehicle will first activate and/or pair with a sensing device. This can be a sensing device integrated within or paired to a smart phone or similar device, or a separate device that connects directly to the vehicle. After the device is paired/active, the owner conducts a walkthrough around the vehicle.

Next, the sensing device will transfer the data obtained during the walkthrough to the autonomous vehicle. The autonomous vehicle can then transform the data obtained by the sensing device into a polygon model. The autonomous vehicle can then use the new dimensions in its autonomous vehicle algorithms, including for example, the safe distance algorithm. Finally, the autonomous vehicle can perform a self-test to determine whether the new dimensions affect the autonomy level at which the vehicle is operated. If the level has changed, this new level can be displayed (or otherwise communicated) to the driver (or an indication that the level has not changed may be displayed or otherwise communicated to the driver).

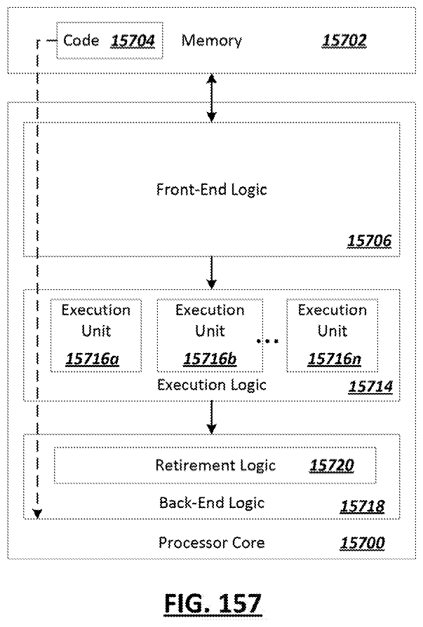

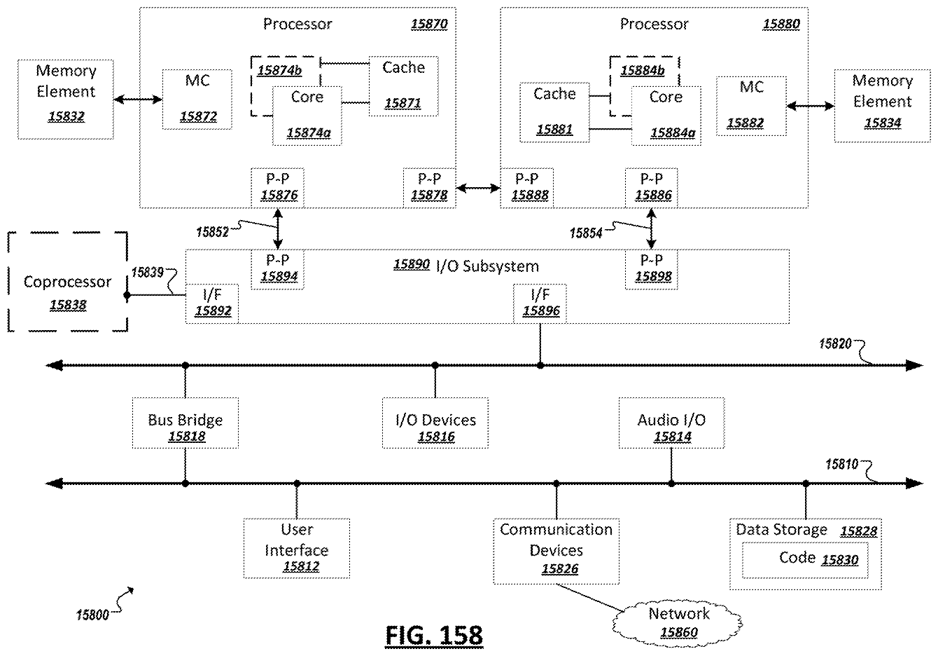

FIGS. 157-158 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 157-158.

FIG. 157 is an example illustration of a processor according to an embodiment. Processor 15700 is an example of a type of hardware device that can be used in connection with the implementations above. Processor 15700 may be any type of processor, such as a microprocessor, an embedded processor, a digital signal processor (DSP), a network processor, a multi-core processor, a single core processor, or other device to execute code. Although only one processor 15700 is illustrated in FIG. 157, a processing element may alternatively include more than one of processor 15700 illustrated in FIG. 157. Processor 15700 may be a single-threaded core or, for at least one embodiment, the processor 15700 may be multi-threaded in that it may include more than one hardware thread context (or “logical processor”) per core.

FIG. 157 also illustrates a memory 15702 coupled to processor 15700 in accordance with an embodiment. Memory 15702 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 15700 can execute any type of instructions associated with algorithms, processes, or operations detailed herein. Generally, processor 15700 can transform an element or an article (e.g., data) from one state or thing to another state or thing.

Code 15704, which may be one or more instructions to be executed by processor 15700, may be stored in memory 15702, or may be stored in software, hardware, firmware, or any suitable combination thereof, or in any other internal or external component, device, element, or object where appropriate and based on particular needs. In one example, processor 15700 can follow a program sequence of instructions indicated by code 15704. Each instruction enters a front-end logic 15706 and is processed by one or more decoders 15708. The decoder may generate, as its output, a micro operation such as a fixed width micro operation in a predefined format, or may generate other instructions, microinstructions, or control signals that reflect the original code instruction. Front-end logic 15706 also includes register renaming logic 15710 and scheduling logic 15712, which generally allocate resources and queue the operation corresponding to the instruction for execution.

Processor 15700 can also include execution logic 15714 having a set of execution units 15716a, 15716b, 15716n, etc. Some embodiments may include a number of execution units dedicated to specific functions or sets of functions. Other embodiments may include only one execution unit or one execution unit that can perform a particular function. Execution logic 15714 performs the operations specified by code instructions.

After completion of execution of the operations specified by the code instructions, back-end logic 15718 can retire the instructions of code 15704. In one embodiment, processor 15700 allows out of order execution but requires in order retirement of instructions. Retirement logic 15720 may take a variety of known forms (e.g., re-order buffers or the like). In this manner, processor 15700 is transformed during execution of code 15704, at least in terms of the output generated by the decoder, hardware registers and tables utilized by register renaming logic 15710, and any registers (not shown) modified by execution logic 15714.

Although not shown in FIG. 157, a processing element may include other elements on a chip with processor 15700. For example, a processing element may include memory control logic along with processor 15700. The processing element may include I/O control logic and/or may include I/O control logic integrated with memory control logic. The processing element may also include one or more caches. In some embodiments, non-volatile memory (such as flash memory or fuses) may also be included on the chip with processor 15700.

FIG. 158 illustrates a computing system 15800 that is arranged in a point-to-point (PtP) configuration according to an embodiment. In particular, FIG. 158 shows a system where processors, memory, and input/output devices are interconnected by a number of point-to-point interfaces. Generally, one or more of the computing systems described herein may be configured in the same or similar manner as computing system 15700.

Processors 15870 and 15880 may also each include integrated memory controller logic (MC) 15872 and 15882 to communicate with memory elements 15832 and 15834. In alternative embodiments, memory controller logic 15872 and 15882 may be discrete logic separate from processors 15870 and 15880. Memory elements 15832 and/or 15834 may store various data to be used by processors 15870 and 15880 in achieving operations and functionality outlined herein.

Processors 15870 and 15880 may be any type of processor, such as those discussed in connection with other figures herein. Processors 15870 and 15880 may exchange data via a point-to-point (PtP) interface 15850 using point-to-point interface circuits 15878 and 15888, respectively. Processors 15870 and 15880 may each exchange data with a chipset 15890 via individual point-to-point interfaces 15852 and 15854 using point-to-point interface circuits 15876, 15886, 15894, and 15898. Chipset 15890 may also exchange data with a co-processor 15838, such as a high-performance graphics circuit, machine learning accelerator, or other co-processor 15838, via an interface 15839, which could be a PtP interface circuit. In alternative embodiments, any or all of the PtP links illustrated in FIG. 158 could be implemented as a multi-drop bus rather than a PtP link.

Chipset 15890 may be in communication with a bus 15820 via an interface circuit 15896. Bus 15820 may have one or more devices that communicate over it, such as a bus bridge 15818 and I/O devices 15816. Via a bus 15810, bus bridge 15818 may be in communication with other devices such as a user interface 15812 (such as a keyboard, mouse, touchscreen, or other input devices), communication devices 15826 (such as modems, network interface devices, or other types of communication devices that may communicate through a computer network 15860), audio I/O devices 15814, and/or a data storage device 15828. Data storage device 15828 may store code 15830, which may be executed by processors 15870 and/or 15880. In alternative embodiments, any portions of the bus architectures could be implemented with one or more PtP links.

The computer system depicted in FIG. 158 is a schematic illustration of an embodiment of a computing system that may be utilized to implement various embodiments discussed herein. It will be appreciated that various components of the system depicted in FIG. 158 may be combined in a system-on-a-chip (SoC) architecture or in any other suitable configuration capable of achieving the functionality and features of examples and implementations provided herein.

While some of the systems and solutions described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Computing systems may be provided, including in-vehicle computing systems (e.g., used to implement at least a portion of an automated driving stack and enable automated driving functional of the vehicle), roadside computing systems (e.g., separate from vehicles; implemented in dedicated roadside cabinets, on traffic signs, on traffic signal or light posts, etc.), on one or more computing systems implementing a cloud- or fog-based system supporting autonomous driving environments, or computing system remote from an autonomous driving environments may include logic implemented using one or a combination of one or more data processing apparatus (e.g., central processing units, graphics processing units, tensor processing units, ASICs, FPGAs, etc.), accelerator hardware, other hardware circuitry, firmware, and/or software to perform or implement one or a combination of the following:

Example 1 is a non-transitory machine-readable storage device with instructions stored thereon, the instructions when executed by the machine to cause the machine to: receive sensor data from a plurality of sensors, where the plurality of sensors includes a first set of sensors and a second set of sensors, and at least a portion of the plurality of sensors are coupled to a vehicle; automate control of the vehicle, using a data processor on the vehicle, based on at least a portion of the sensor data generated by the first set of sensors; determine, using a data processor on the vehicle, passenger attributes of one or more passengers within the autonomous vehicles from sensor data generated by the second set of sensors; and modify vehicle attributes of the vehicle based on the passenger attributes and the sensor data generated by the first set of sensors.

Example 2 includes the subject matter of Example 1, where automatic control of the vehicle includes determining a first path of the vehicle, and modifying the vehicle attributes based on the passenger attributes causes the first path to be changed to a second path and subsequent automated control of the vehicle to be based on the second path.

Example 3 includes the subject matter of any one of Examples 1-2, where the vehicle attributes include physical attributes of a cabin of the vehicle and the passengers are within the cabin.

Example 4 includes the subject matter of Example 3, where the cabin includes one or more devices configured to facilitate comfort of the passengers and modifying the vehicle attributes includes autonomously adjusting the one or more devices.

Example 5 includes the subject matter of any one of Examples 1-4, where modifying the vehicle attributes includes presenting a recommendation to the passengers using a presentation device based on a path determined in association with automated control of the vehicle and the passenger attributes.

Example 6 includes the subject matter of Example 5, where the recommendation includes a recommendation to change a destination or the path of the vehicle based on the passenger attributes.

Example 7 includes the subject matter of any one of Examples 1-6, where the passenger attributes include attributes affecting comfort or preferences of the one or more passengers within the vehicle.

Example 8 includes the subject matter of any one of Examples 1-7, where automated control of the vehicle is determined using a first machine learning model and the passenger attributes are determined using a second machine learning model.

Example 9 includes the subject matter of any one of Examples 1-8, where the vehicle attributes include a driving style to be realized through the automated control of the vehicle, and modifying the vehicle attributes causes the driving style to be changed based on the passenger attributes.

Example 10 includes the subject matter of any one of Examples 1-9, where the first and second sets of sensors include at least one sensor in common.

Example 11 includes the subject matter of any one of Examples 1-10, where at least one sensor of the first and second sets of sensors is extraneous to the vehicle.

Example 12 includes the subject matter of any one of Examples 1-11, where the instructions are further executable to cause the machine to: determine identity of each one of the passengers based on sensor data from the second set of sensors; and access preference information corresponding to the identities of one or more of the passengers, where the passenger attributes include the preference information.

Example 13 includes the subject matter of any one of Examples 1-12, where the passenger attributes describe human attributes of the passengers.

Example 14 includes the subject matter of Example 13, where the passengers include a plurality of passengers and the human attributes include combined attributes of a group of passengers including the plurality of passengers, and the vehicle attributes are modified based on the combined attributes.

Example 15 includes the subject matter of any one of Examples 1-14, where the instructions are further executable to cause the machine to: sending particular sensor data including data from the first set of sensors or the second set of sensors over a wireless communication channel to a remote computing system; and receiving recommendation data from the remote computing system based on the particular sensor data, where the vehicle attributes are modified based on the recommendation data.

Example 16 is a method including: receiving sensor data from a plurality of sensors, where the plurality of sensors includes a first set of sensors and a second set of sensors, and at least a portion of the plurality of sensors are coupled to a vehicle; automating control of the vehicle, using a data processor on the vehicle, based on at least a portion of the sensor data generated by the first set of sensors; determining, using a data processor on the vehicle, passenger attributes of one or more passengers within the autonomous vehicles from sensor data generated by the second set of sensors; and modifying vehicle attributes of the vehicle based on the passenger attributes and the sensor data generated by the first set of sensors.

Example 17 includes the subject matter of Example 16, where automatic control of the vehicle includes determining a first path of the vehicle, and modifying the vehicle attributes based on the passenger attributes causes the first path to be changed to a second path and subsequent automated control of the vehicle to be based on the second path.

Example 18 includes the subject matter of any one of Examples 16-17, where the vehicle attributes include physical attributes of a cabin of the vehicle and the passengers are within the cabin.

Example 19 includes the subject matter of Example 18, where the cabin includes one or more devices configured to facilitate comfort of the passengers and modifying the vehicle attributes includes autonomously adjusting the one or more devices.

Example 20 includes the subject matter of any one of Examples 16-19, where modifying the vehicle attributes includes presenting a recommendation to the passengers using a presentation device based on a path determined in association with automated control of the vehicle and the passenger attributes.

Example 21 includes the subject matter of Example 20, where the recommendation includes a recommendation to change a destination or the path of the vehicle based on the passenger attributes.

Example 22 includes the subject matter of any one of Examples 16-21, where the passenger attributes include attributes affecting comfort or preferences of the one or more passengers within the vehicle.

Example 23 includes the subject matter of any one of Examples 16-22, where automated control of the vehicle is determined using a first machine learning model and the passenger attributes are determined using a second machine learning model.

Example 24 includes the subject matter of any one of Examples 16-23, where the vehicle attributes include a driving style to be realized through the automated control of the vehicle, and modifying the vehicle attributes causes the driving style to be changed based on the passenger attributes.

Example 25 includes the subject matter of any one of Examples 16-24, where the first and second sets of sensors include at least one sensor in common.

Example 26 includes the subject matter of any one of Examples 16-25, where at least one sensor of the first and second sets of sensors is extraneous to the vehicle.

Example 27 includes the subject matter of any one of Examples 16-26, further including: determining identity of each one of the passengers based on sensor data from the second set of sensors; and accessing preference information corresponding to the identities of one or more of the passengers, where the passenger attributes include the preference information.

Example 28 includes the subject matter of any one of Examples 16-27, where the passenger attributes describe human attributes of the passengers.

Example 29 includes the subject matter of Example 28, where the passengers include a plurality of passengers and the human attributes include combined attributes of a group of passengers including the plurality of passengers, and the vehicle attributes are modified based on the combined attributes.

Example 30 includes the subject matter of any one of Examples 16-29, further including:
sending particular sensor data including data from the first set of sensors or the second set of sensors over a wireless communication channel to a remote computing system; and
receiving recommendation data from the remote computing system based on the particular sensor data, where the vehicle attributes are modified based on the recommendation data.

Example 31 is a system including means to perform the method of any one of Examples 16-30.

Example 32 is a non-transitory machine-readable storage medium with instructions stored thereon, the instructions when executed by the machine to cause the machine to: receive first sensor data generated by a first set of sensors, where the first sensor data identifies attributes of a driving environment; receive second sensor data generated by a second set of sensors, where the second sensor data identifies attributes of a set of passengers within a particular vehicle in the driving environment; determine a recommendation based on the first sensor data and the second sensor data; send recommendation data, via a wireless communication channel, to an on-board computing system of the particular vehicle, where the recommendation data identifies the recommendation and is consumable by the on-board computing system to affect operation of the particular vehicle.

Example 33 includes the subject matter of Example 32, where the first set of sensors includes one or more sensors integrated on the particular vehicle.

Example 34 includes the subject matter of any one of Examples 32-33, where the first set of sensors includes one or more sensors extraneous to the particular vehicle.

Example 35 includes the subject matter of Example 34, where the instructions are further executable to cause the machine to: determine a location of the particular vehicle; identify one or more particular sensors in the location; and access particular sensor data from the particular sensors, where the first sensor data includes the particular sensor data.

Example 36 includes the subject matter of Example 35, where the first set of sensors include one or more sensors mounted on another vehicle in the location.

Example 37 includes the subject matter of any one of Examples 35-36, where the first set of sensors includes a road side unit in the location.

Example 38 includes the subject matter of any one of Examples 32-37, where the instructions are further executable to cause the machine to determine, from the second sensor data, one or more profiles associated with the set of passengers, where the recommendation is based on the one or more profiles.

Example 39 includes the subject matter of any one of Examples 32-38, where the recommendation is consumable by the on-board computing system to cause the on-board computing system to change automated control of the particular vehicle based on the recommendation.

Example 40 includes the subject matter of Example 39, where the change in the automated control causes the vehicle to deviate from a previously determined path.

Example 41 includes the subject matter of any one of Examples 39-40, where the change in the automated control causes the vehicle to change from a first driving style to a second driving style based on the recommendation.

Example 42 is a method including: receiving first sensor data generated by a first set of sensors, where the first sensor data identifies attributes of a driving environment; receiving second sensor data generated by a second set of sensors, where the second sensor data identifies attributes of a set of passengers within a particular vehicle in the driving environment; determining a recommendation based on the first sensor data and second sensor data; and sending recommendation data, via a wireless communication channel, to an on-board computing system of the particular vehicle, where the recommendation data identifies the recommendation and is consumable by the on-board computing system to affect operation of the particular vehicle

Example 43 includes the subject matter of Example 42, where the first set of sensors includes one or more sensors integrated on the particular vehicle.

Example 44 includes the subject matter of any one of Examples 42-43, where the first set of sensors includes one or more sensors extraneous to the particular vehicle.

Example 45 includes the subject matter of Example 44, where the instructions are further executable to cause the machine to: determine a location of the particular vehicle; identify one or more particular sensors in the location; and access particular sensor data from the particular sensors, where the first sensor data includes the particular sensor data.

Example 46 includes the subject matter of Example 45, where the first set of sensors include one or more sensors mounted on another vehicle in the location.

Example 47 includes the subject matter of any one of Examples 45-46, where the first set of sensors includes a road side unit in the location.

Example 48 includes the subject matter of any one of Examples 42-47, where the instructions are further executable to cause the machine to determine, from the second sensor data, one or more profiles associated with the set of passengers, where the recommendation is based on the one or more profiles.

Example 49 includes the subject matter of any one of Examples 42-48, where the recommendation is consumable by the on-board computing system to cause the on-board computing system to change automated control of the particular vehicle based on the recommendation.

Example 50 includes the subject matter of Example 49, where the change in the automated control causes the vehicle to deviate from a previously determined path.

Example 51 includes the subject matter of any one of Examples 49-50, where the change in the automated control causes the vehicle to change from a first driving style to a second driving style based on the recommendation.

Example 52 is a system including means to perform the method of any one of Examples 42-51.

Example 53 is a system including: an on-board computing system for a vehicle, where the on-board computing system includes processor hardware, where the processor hardware includes machine-learning hardware; a set of local sensors; a set of actuators; and a recommendation system executable by the processor hardware to: identify first sensor data to describe driving conditions in an environment, where the vehicle is positioned in or near the environment, where the on-board computing system uses the first sensor data to automate control of the vehicle; identify second sensor data, where at least a portion of the second sensor data is generated by the set of local sensors; determine, from the second sensor data, one or more passenger attributes of a set of passengers within the vehicle; determine a recommendation for the on-board computing system based on the first and second sensor data; where the on-board computing system is to consume the recommendation to actuate one or more of the set of actuators to change conditions of the vehicle.

Example 54 includes the subject matter of Example 53, where the one or more actuators include actuators to control one of steering, acceleration, or braking of the vehicle.

Example 55 includes the subject matter of Example 54, where the on-board computing system includes a path planning engine to: determine a first path plan for the vehicle; and augment the first path plan to form a different, second path plan for the vehicle based on the recommendation.

Example 56 includes the subject matter of Example 53, where the one or more actuators includes actuators to adjust physical conditions within a cabin of the vehicle, where the passengers ride within the cabin of the vehicle.

Example 57 includes the subject matter of Example 53, where at least a portion of the first sensor data is generated by the set of local sensors.

Example 58 includes the subject matter of Example 53, where the recommendation system is to: communicate over a wireless communication channel with a remote computing system; and receive recommendation data from the remote computing system, where the recommendation is determined based further on the recommendation data.

Example 59 includes the subject matter of Example 53, where a portion of the first sensor data or the second data is received from sensors extraneous to the vehicle.

Example 60 includes the subject matter of any one of Examples 53-59, where the recommendation system is further to generate recommendation data to describe the recommendation and cause the recommendation data to be transmitted to another system associated with the environment

Example 61 is a method including: receiving sensor data from a plurality of sensors, where the plurality of sensors includes a first set of sensors and a second set of sensors, and at least a portion of the plurality of sensors are coupled to a vehicle; determining, using a data processor on the vehicle, a path for the vehicle from data generated by at least the first set of sensors; and determining, using a data processor on the vehicle, attributes affecting comfort or preferences of passengers within the autonomous vehicles from data generated by at least the second set of sensors.

Example 62 includes the subject matter of Example 61, further including determining a change to the path based on the human attributes.

Example 63 includes the subject matter of any one of Examples 61-62, further including automatically adjusting one or more devices within a cabin of the vehicle based on the attributes.

Example 64 includes the subject matter of Example 63, where the one or more devices include a device integrated with the cabin.

Example 65 includes the subject matter of any one of Examples 63-64, where the one or more devices include a device extraneous to the vehicle.

Example 66 includes the subject matter of any one of Examples 61-65, where the path is determined using a first machine learning model and the attributes are determined using a second machine learning model.

Example 67 includes the subject matter of any one of Examples 61-66, further including adjusting a style of driving applied by autonomous driving controls of the vehicle based on the attributes.

Example 68 includes the subject matter of any one of Examples 61-67, where the first and second sets of sensors include at least one sensor in common.

Example 69 includes the subject matter of any one of Examples 61-68, where one or more sensors in the second set of sensors collect environmental information relating to environment surrounding the vehicle.

Example 70 includes the subject matter of any one of Examples 61-69, where one or more sensors in the second set of sensors collect information concerning characteristics of passengers in the vehicle.

Example 71 includes the subject matter of any one of Examples 61-70, further including: determining identity of each one of the passengers; and accessing preference information corresponding to identifies of one or more of the passengers.

Example 72 includes the subject matter of any one of Examples 61-71, where the attributes describe human attributes of the passengers.

Example 73 includes the subject matter of Example 72, where the passengers include a plurality of passengers and the human attributes include combined attributes of a group of passengers including the plurality of passengers.

Example 74 includes the subject matter of any one of Examples 61-73, where the attributes describe attributes of a roadway corresponding to an autonomous driving path plan.

Example 75 includes the subject matter of any one of Examples 61-74, where the attributes describe weather conditions on an autonomous driving path plan.

Example 76 is a system including means to perform the method of any one of Examples 61-75.

Example 77 includes the subject matter of Example 76, where the means include a computer-readable medium to store instructions, where the instructions, when executed by a machine, causes the machine to perform at least a portion of the method of any one of Examples 61-75.

Example 78 is a non-transitory machine-readable storage medium with instructions stored thereon, the instructions when executed by the machine to cause the machine to: receive sensor data from a plurality of sensors, where the plurality of sensors includes a first set of sensors and a second set of sensors, and at least a portion of the plurality of sensors are coupled to a vehicle; determine, using a data processor on the vehicle, a path for the vehicle from data generated by at least the first set of sensors; and determine, using a data processor on the vehicle, attributes affecting comfort or preferences of passengers within the autonomous vehicles from data generated by at least the second set of sensors.

Example 79 includes the subject matter of Example 78, where the instructions are further executable to determine a change to the path based on the human attributes.

Example 80 includes the subject matter of any one of Examples 78-79, where the instructions are further executable to automatically adjust one or more devices within a cabin of the vehicle based on the attributes.

Example 81 includes the subject matter of Example 80, where the one or more devices include a device integrated with the cabin.

Example 82 includes the subject matter of any one of Examples 80-81, where the one or more devices include a device extraneous to the vehicle.

Example 83 includes the subject matter of any one of Examples 78-82, where the path is determined using a first machine learning model and the attributes are determined using a second machine learning model.

Example 84 includes the subject matter of any one of Examples 78-83, where the instructions are further executable to adjust a style of driving applied by autonomous driving controls of the vehicle based on the attributes.

Example 85 includes the subject matter of any one of Examples 78-84, where the first and second sets of sensors include at least one sensor in common.

Example 86 includes the subject matter of any one of Examples 78-85, where one or more sensors in the second set of sensors collect environmental information relating to environment surrounding the vehicle.

Example 87 includes the subject matter of any one of Examples 78-86, where one or more sensors in the second set of sensors collect information concerning characteristics of passengers in the vehicle.

Example 88 includes the subject matter of any one of Examples 78-87, where the instructions are further executable to: determine identity of each one of the passengers; and access preference information corresponding to identifies of one or more of the passengers.

Example 89 includes the subject matter of any one of Examples 78-88, where the attributes describe human attributes of the passengers.

Example 90 includes the subject matter of Example 89, where the passengers include a plurality of passengers and the human attributes include combined attributes of a group of passengers including the plurality of passengers.

Example 91 includes the subject matter of any one of Examples 78-90, where the attributes describe attributes of a roadway corresponding to an autonomous driving path plan.

Example 92 includes the subject matter of any one of Examples 78-91, where the attributes describe weather conditions on an autonomous driving path plan.

Example 93 is a method including: identifying a particular vehicle within a particular locale; determining capabilities of the particular vehicle, where the capabilities include sensor capabilities of the particular vehicle; and sending recommendation data to the particular vehicle, where the recommendation data is based on sensor data generated by one or more sensors extraneous to the particular vehicle, where the recommendation data is to cause a recommendation to be presented to passengers within the particular vehicle.

Example 94 includes the subject matter of Example 93, where the one or more extraneous sensors include sensors on one of an aerial drone, an autonomous vehicle, or a roadside unit.

Example 95 includes the subject matter of any one of Examples 93-94, where the one or more extraneous sensors include a plurality of sensors from a plurality of different devices.

Example 96 includes the subject matter of any one of Examples 93-95, further including collecting the sensor data from the one or more extraneous sensors at a computing system extraneous to the particular vehicle, where the computing system sends the recommendation data to the particular vehicle.

Example 97 includes the subject matter of Example 96, where the computing system generates the recommendation data from an analysis of the sensor data.

Example 98 includes the subject matter of Example 97, where the analysis includes application of a machine learning model.

Example 99 includes the subject matter of any one of Examples 93-98, further including determining a type of recommendation data to provide to the particular vehicle based on the capabilities of the particular vehicle.

Example 100 includes the subject matter of any one of Examples 93-99, further including determining timing for sending the recommendation data to the particular vehicle based on the capabilities of the particular vehicle.

Example 101 is a system including means to perform the method of any one of Examples 93-100.

Example 102 includes the subject matter of Example 101, where the means include a computer-readable medium to store instructions, where the instructions, when executed by a machine, causes the machine to perform at least a portion of the method of any one of Examples 93-100.

Example 103 is a method including: receiving data generated by one or more connected sensors fixedly connected to a first vehicle; receiving recommendation data from a source external to the first vehicle, where the recommendation data is based on sensor data generated by one or more sensors extraneous to the first vehicle; determining a recommendation for one or more passenger within a cabin of the first vehicle; and presenting the recommendation within the first vehicle.

Example 104 includes the subject matter of Example 103, where the one or more extraneous sensors include sensors on one of an aerial drone, another vehicle, or a roadside unit.

Example 105 includes the subject matter of any one of Examples 103-104, where the extraneous sensors include sensors not present in the one or more connected sensors.

Example 106 includes the subject matter of any one of Examples 103-105, further including determining identities of one or more passengers in the cabin of the first vehicle using data generated by the connected sensors.

Example 107 includes the subject matter of Example 106, further including determining preferences of one or more of the passengers based on the identities, where the recommendation is determined based at least in part on the preferences.

Example 108 includes the subject matter of any one of Examples 103-107, where the recommendation includes a recommendation of one of a retail establishment, restaurant

Example 109 includes the subject matter of any one of Examples 103-108, where the recommendation includes a recommendation to change a path determined for the first vehicle.

Example 110 includes the subject matter of Example 109, where the first vehicle includes autonomous driving logic and the recommendation causes the autonomous driving logic to apply the change to the path.

Example 111 is a system including means to perform the method of any one of Examples 103-110.

Example 112 includes the subject matter of Example 111, where the means include a computer-readable medium to store instructions, where the instructions, when executed by a machine, causes the machine to perform at least a portion of the method of any one of Examples 103-110.

Example 113 includes the subject matter of Example 111, where the means include an in-vehicle computing system within the first vehicle.

Example 114 is a non-transitory machine-readable storage medium with instructions stored thereon, the instructions when executed by the machine to cause the machine to: identify a particular vehicle within a particular locale; determine capabilities of the particular vehicle, where the capabilities include sensor capabilities of the particular vehicle; and send recommendation data to the particular vehicle, where the recommendation data is based on sensor data generated by one or more sensors extraneous to the particular vehicle, where the recommendation data is to cause a recommendation to be presented to passengers within the particular vehicle.

Example 115 includes the subject matter of Example 114, where the one or more extraneous sensors include sensors on one of an aerial drone, an autonomous vehicle, or a roadside unit.

Example 116 includes the subject matter of any one of Examples 114-115, where the one or more extraneous sensors include a plurality of sensors from a plurality of different devices.

Example 117 includes the subject matter of any one of Examples 114-116, where the instructions are further executable to cause the machine to collect the sensor data from the one or more extraneous sensors at a computing system extraneous to the particular vehicle, where the computing system sends the recommendation data to the particular vehicle.

Example 118 includes the subject matter of Example 117, where the computing system generates the recommendation data from an analysis of the sensor data.

Example 119 includes the subject matter of Example 58, where the analysis includes application of a machine learning model.

Example 120 includes the subject matter of any one of Examples 114-119, where the instructions are further executable to cause the machine to collect determine a type of recommendation data to provide to the particular vehicle based on the capabilities of the particular vehicle.

Example 121 includes the subject matter of any one of Examples 114-120, where the instructions are further executable to cause the machine to collect determine timing for sending the recommendation data to the particular vehicle based on the capabilities of the particular vehicle.

Example 122 is a non-transitory machine-readable storage medium with instructions stored thereon, the instructions when executed by the machine to cause the machine to: receive data generated by one or more connected sensors fixedly connected to a first vehicle; receive recommendation data from a source external to the first vehicle, where the recommendation data is based on sensor data generated by one or more sensors extraneous to the first vehicle; determine a recommendation for one or more passenger within a cabin of the first vehicle; and present the recommendation within the first vehicle.

Example 123 includes the subject matter of Example 122, where the one or more extraneous sensors include sensors on one of an aerial drone, another vehicle, or a roadside unit.

Example 124 includes the subject matter of any one of Examples 122-123, where the extraneous sensors include sensors not present in the one or more connected sensors.

Example 125 includes the subject matter of any one of Examples 122-124, where the instructions are further executable to cause the machine to determine identities of one or more passengers in the cabin of the first vehicle using data generated by the connected sensors.

Example 126 includes the subject matter of Example 125, where the instructions are further executable to cause the machine to determine preferences of one or more of the passengers based on the identities, where the recommendation is determined based at least in part on the preferences.

Example 127 includes the subject matter of any one of Examples 122-126, where the recommendation includes a recommendation of one of a retail establishment, restaurant

Example 128 includes the subject matter of any one of Examples 122-127, where the recommendation includes a recommendation to change a path determined for the first vehicle.

Example 129 includes the subject matter of Example 128, where the first vehicle includes autonomous driving logic and the recommendation causes the autonomous driving logic to apply the change to the path.

Example 130 is a method including: determining, using at least one data processor of an autonomous vehicle, that operation of at least one particular sensor on the autonomous vehicle is compromised; receiving recommendation data, at the autonomous vehicle over a wireless communication channel, where the recommendation data is based on sensor data generated by one or more sensors extraneous to the autonomous vehicle; and using the recommendation data to support autonomous driving of the autonomous vehicle based on determining that operation of the at least one sensor is compromised.

Example 131 includes the subject matter of Example 130, where the recommendation data includes the sensor data.

Example 132 includes the subject matter of any one of Examples 130-131, further including generating local sensor data using a set of sensors of the autonomous vehicle, where the particular sensor is outside the set of sensors; where the recommendation data is used together with the local sensor data to support the autonomous driving of the autonomous vehicle.

Example 133 includes the subject matter of any one of Examples 130-132, further including: determining a location of the particular sensor on the autonomous vehicle; identifying that the recommendation data corresponds to a position external to the autonomous vehicle, where the particular sensor is to sense information corresponding to the position based on the location of the particular sensor, where the recommendation data is to provide information to at least partially replace information to be obtained through the particular sensor.

Example 134 includes the subject matter of any one of Examples 130-133, where losing the particular sensor causes a maximum level of autonomy supported by the autonomous vehicle to drop from a particular level to another, lower level, and using the recommendation data allows the autonomous vehicle to maintain operation at the particular level.

Example 135 includes the subject matter of any one of Examples 130-134, further including: applying a machine learning model to inputs at the autonomous vehicle to predict a likelihood that one or more of the sensors on the autonomous vehicle will be compromised during the trip; and configuring a recommender system based on the likelihood.

Example 136 includes the subject matter of Example 135, where configuring the recommender system based on the likelihood includes preemptively triggering operation of the recommender system to begin receiving and processing recommendation data prior to detecting that the particular sensor is compromised.

Example 137 includes the subject matter of any one of Examples 130-136, where the particular sensor is one of a suite of sensors on the autonomous vehicle to generate collection of sensor data for use as inputs to support autonomous driving, and the method further includes filtering the recommendation data to keep the portion of the recommendation data corresponding to a portion of the collection of sensor data missing as a result of the particular sensor being compromised.

Example 138 includes the subject matter of any one of Examples 130-137, where the one or more extraneous sensors include sensors on a plurality of other devices.

Example 139 includes the subject matter of Example 138, where the plurality of other devices include one or more of other autonomous vehicles, aerial drones, and roadside sensors.

Example 140 includes the subject matter of any one of Examples 130-139, further including generating a travel plan for the autonomous vehicle, where the recommendation data describes conditions on an upcoming stretch of road based on the travel plan.

Example 141 is a system including means to perform the method of any one of Examples 130-140.

Example 142 includes the subject matter of Example 141, where the means include a computer-readable medium to store instructions, where the instructions, when executed by a machine, causes the machine to perform at least a portion of the method of any one of Examples 130-140.

Example 143 is a non-transitory machine-readable storage medium with instructions stored thereon, the instructions when executed by the machine to cause the machine to: determine, using at least one data processor of an autonomous vehicle, that operation of at least one particular sensor on the autonomous vehicle is compromised; receive recommendation data, at the autonomous vehicle over a wireless communication channel, where the recommendation data is based on sensor data generated by one or more sensors extraneous to the autonomous vehicle; and use the recommendation data to support autonomous driving of the autonomous vehicle based on determining that operation of the at least one sensor is compromised.

Example 144 includes the subject matter of Example 143, where the recommendation data includes the sensor data.

Example 145 includes the subject matter of any one of Examples 143-144, where the instructions are further executable to cause the machine to generate local sensor data using a set of sensors of the autonomous vehicle, where the particular sensor is outside the set of sensors; where the recommendation data is used together with the local sensor data to support the autonomous driving of the autonomous vehicle.

Example 146 includes the subject matter of any one of Examples 143-145, where the instructions are further executable to cause the machine to: determine a location of the particular sensor on the autonomous vehicle; identify that the recommendation data corresponds to a position external to the autonomous vehicle, where the particular sensor is to sense information corresponding to the position based on the location of the particular sensor, where the recommendation data is to provide information to at least partially replace information to be obtained through the particular sensor.

Example 147 includes the subject matter of any one of Examples 143-146, where losing the particular sensor causes a maximum level of autonomy supported by the autonomous vehicle to drop from a particular level to another, lower level, and using the recommendation data allows the autonomous vehicle to maintain operation at the particular level.

Example 148 includes the subject matter of any one of Examples 143-147, where the instructions are further executable to cause the machine to: apply a machine learning model to inputs at the autonomous vehicle to predict a likelihood that one or more of the sensors on the autonomous vehicle will be compromised during the trip; and configure a recommender system based on the likelihood.

Example 149 includes the subject matter of Example 148, where configuring the recommender system based on the likelihood includes preemptively triggering operation of the recommender system to begin receiving and processing recommendation data prior to detecting that the particular sensor is compromised.

Example 150 includes the subject matter of any one of Examples 143-149, where the particular sensor is one of a suite of sensors on the autonomous vehicle to generate collection of sensor data for use as inputs to support autonomous driving, and the storage medium further includes filtering the recommendation data to keep the portion of the recommendation data corresponding to a portion of the collection of sensor data missing as a result of the particular sensor being compromised.

Example 151 includes the subject matter of any one of Examples 143-150, where the one or more extraneous sensors include sensors on a plurality of other devices.

Example 152 includes the subject matter of Example 151, where the plurality of other devices include one or more of other autonomous vehicles, aerial drones, and roadside sensors.

Example 153 includes the subject matter of any one of Examples 143-152, where the instructions are further executable to cause the machine to generate a travel plan for the autonomous vehicle, where the recommendation data describes conditions on an upcoming stretch of road based on the travel plan.

Example 154 is a method including: generating sensor data at an autonomous vehicle from a set of one or more sensors on the vehicle; determining, from the sensor data, conditions of an environment in which the autonomous vehicle is to operate; autonomously determining, by providing the conditions as inputs to at least one machine learning model, one or more procedures to manage sensor data generated at the autonomous vehicle; and applying the one or more procedures to at least one of collection of the sensor data at the vehicle and offloading the sensor data to one or more computing systems external to the vehicle.

Example 155 includes the subject matter of Example 154, where the one or more procedures include procedures to offload at least a portion of the sensor data to one or more computing systems external to the vehicle.

Example 156 includes the subject matter of Example 155, where the conditions include conditions of wireless communication channels available to the vehicle.

Example 157 includes the subject matter of any one of Examples 155-156, where the conditions include an amount of the portion of data and an urgency of the portion of the data.

Example 158 includes the subject matter of any one of Examples 155-157, where the procedures to offload the portion of the data include sending the portion of the data at a particular resolution.

Example 159 includes the subject matter of any one of Examples 155-158, where the procedures to offload the portion of the data include sending the data to a particular target external computing system.

Example 160 includes the subject matter of any one of Examples 155-159, where the one or more computing systems external to the vehicle include one or more of other vehicles, roadside units, fog-based computing systems, and cloud-based computing systems.

Example 161 includes the subject matter of any one of Examples 154-160, where the one or more procedures include procedures to filter sensor data generated at the vehicle to be collected in a data repository within the vehicle.

Example 162 includes the subject matter of Example 161, where the procedures to filter sensor data cause a filtered portion of the sensor data to be dropped.

Example 163 includes the subject matter of any one of Examples 154-162, further including determining a path plan for the vehicle using one or more autonomous driving machine learning models, where at least some of the sensor data is to be provided to the autonomous driving machine learning models as inputs.

Example 164 includes the subject matter of Example 163, where the conditions include events detected as affecting a route section in the determined path plan.

Example 165 includes the subject matter of any one of Examples 163-164, where the conditions include identification of a driving environment on the determined path plan, and the driving environment includes one or more of weather affecting the path plan, traffic conditions affecting the path plan, and road conditions affecting the path plan.

Example 166 includes the subject matter of any one of Examples 154-165, where the one or more procedures are to be provided as a recommendation of a machine-learning-based recommender system implemented on the vehicle.

Example 167 includes the subject matter of any one of Examples 154-166, where the one or more procedures are to enhance efficiency of the vehicle's use of one or more of the internal compute resources of the vehicle, internal memory resources of the vehicle, network bandwidth, and resource of external computing systems.

Example 168 includes the subject matter of any one of Examples 154-167, further including adjusting a quality level of one or more of the set of sensors based on the conditions.

Example 169 is a system including means to perform the method of any one of Examples 154-168.

Example 170 includes the subject matter of Example 16, where the means include a computer-readable medium to store instructions, where the instructions, when executed by a machine, causes the machine to perform at least a portion of the method of any one of Examples 154-168.

Example 171 is a non-transitory machine-readable storage medium with instructions stored thereon, the instructions when executed by the machine to cause the machine to: generate sensor data at an autonomous vehicle from a set of one or more sensors on the vehicle; determine, from the sensor data, conditions of an environment in which the autonomous vehicle is to operate; autonomously determine, by providing the conditions as inputs to at least one machine learning model, one or more procedures to manage sensor data generated at the autonomous vehicle; and apply the one or more procedures to at least one of collection of the sensor data at the vehicle and offloading the sensor data to one or more computing systems external to the vehicle.

Example 172 includes the subject matter of Example 171, where the one or more procedures include procedures to offload at least a portion of the sensor data to one or more computing systems external to the vehicle.

Example 173 includes the subject matter of Example 172, where the conditions include conditions of wireless communication channels available to the vehicle.

Example 174 includes the subject matter of any one of Examples 172-173, where the conditions include an amount of the portion of data and an urgency of the portion of the data.

Example 175 includes the subject matter of any one of Examples 172-174, where the procedures to offload the portion of the data include sending the portion of the data at a particular resolution.

Example 176 includes the subject matter of any one of Examples 172-175, where the procedures to offload the portion of the data include sending the data to a particular target external computing system.

Example 177 includes the subject matter of any one of Examples 172-176, where the one or more computing systems external to the vehicle include one or more of other vehicles, roadside units, fog-based computing systems, and cloud-based computing systems.

Example 178 includes the subject matter of any one of Examples 171-177, where the one or more procedures include procedures to filter sensor data generated at the vehicle to be collected in a data repository within the vehicle.

Example 179 includes the subject matter of Example 178, where the procedures to filter sensor data cause a filtered portion of the sensor data to be dropped.

Example 180 includes the subject matter of any one of Examples 171-179, where the instructions are further executable to cause the machine to determine a path plan for the vehicle using one or more autonomous driving machine learning models, where at least some of the sensor data is to be provided to the autonomous driving machine learning models as inputs.

Example 181 includes the subject matter of Example 180, where the conditions include events detected as affecting a route section in the determined path plan.

Example 182 includes the subject matter of any one of Examples 180-181, where the conditions include identification of a driving environment on the determined path plan, and the driving environment includes one or more of weather affecting the path plan, traffic conditions affecting the path plan, and road conditions affecting the path plan.

Example 183 includes the subject matter of any one of Examples 171-182, where the one or more procedures are to be provided as a recommendation of a machine-learning-based recommender system implemented on the vehicle.

Example 184 includes the subject matter of any one of Examples 171-183, where the one or more procedures are to enhance efficiency of the vehicle's use of one or more of the internal compute resources of the vehicle, internal memory resources of the vehicle, network bandwidth, and resource of external computing systems.

Example 185 includes the subject matter of any one of Examples 171-184, where the instructions are further executable to cause the machine to adjust a quality level of one or more of the set of sensors based on the conditions.

Example 186 is a method including: generating sensor data from a set of sensors on a vehicle; determining a path plan for the vehicle; autonomously controlling driving of the vehicle according to the path plan based on one or more machine learning models and the sensor data; determining that autonomous control of the vehicle should cease; sending a handoff request to a remote computing system, where the remote computing system provides a remote valet service; receiving driving instruction data from the remote computing system; and resuming automated driving of the vehicle responsive to instructions included in the instruction data.

Example 187 includes the subject matter of Example 186, where the driving instruction data is generated based on inputs of a human user at the remote computing system.

Example 188 includes the subject matter of any one of Examples 186-187, further including: detecting a pull-over event, where the vehicle is to pull-over and cease driving in association with the pull-over event, where the handoff request is sent in response to the pull-over event.

Example 189 includes the subject matter of any one of Examples 186-188, where determining that autonomous control of the vehicle should cease includes predicting, using a particular machine learning model, that conditions on an upcoming section of the path plan presents difficulties to autonomous driving during the upcoming section.

Example 190 includes the subject matter of any one of Examples 186-189, where it is determined that autonomous control should cease based on detection of one or more compromised sensors on the vehicle.

Example 191 includes the subject matter of any one of Examples 186-190, further including determining that no qualified passengers are present within the vehicle, where the handoff request is sent based at least in part on determining that no qualified passengers are present.

Example 192 includes the subject matter of any one of Examples 186-191, further including sending the sensor data to the remote computing system to present a dynamic representation of surroundings of the vehicle to a user of the remote computing system.

Example 193 includes the subject matter of Example 192, where the sensor data includes video data.

Example 194 includes the subject matter of any one of Examples 192-193, where the sensor data is sent and driving instruction data is received over one or more low latency, high priority communication channels

Example 195 includes the subject matter of any one of Examples 186-194, further including presenting an alert for consumption by passengers of the vehicle to identify that control of the vehicle is handed over to the remote valet service.

Example 196 includes the subject matter of any one of Examples 186-195, further including: detecting a change in conditions along the path plan; restoring control of the driving of the vehicle from the remote valet service to autonomous driving logic of the vehicle.

Example 197 is a system including means to perform the method of any one of Examples 186-196.

Example 198 includes the subject matter of Example 197, where the means include a computer-readable medium to store instructions, where the instructions, when executed by a machine, causes the machine to perform at least a portion of the method of any one of Examples 186-196.

Example 199 is a method including: providing a user interface for a human user at a computing terminal device; receiving a handoff request from a vehicle configured to autonomously drive; receiving sensor data from remote sensor devices describing an environment around the vehicle; presenting a representation of the environment on the user interface based on the sensor data; receiving user inputs at the computing terminal device responsive to the representation, where the user inputs include inputs to direct driving of the vehicle within the environment; and sending instruction data to the vehicle corresponding to the user inputs to remotely drive the vehicle according to the user inputs.

Example 200 includes the subject matter of Example 199, where the handoff request identifies a location of the vehicle.

Example 201 includes the subject matter of Example 200, further including: determining sensor devices corresponding to the location, where the sensor devices are external to the vehicle; and accessing supplemental sensor data from the sensor devices, where the representation is presented based at least in part on the supplemental sensor data.

Example 202 includes the subject matter of any one of Examples 199-201, where the sensor devices include sensor devices on the vehicle.

Example 203 includes the subject matter of any one of Examples 199-202, where the sensor devices include sensor devices separate from the vehicle.

Example 204 includes the subject matter of any one of Examples 199-203, further including: receiving a request from the vehicle to return control of the driving of the vehicle to the vehicle; sending a confirmation to the vehicle of the return of control; and ceasing transmission of the instruction data to the vehicle.

Example 205 includes the subject matter of any one of Examples 199-203, further including: generate reporting data describing the environment and performance of the vehicle based on the user inputs during control of the vehicle by the remote valet service; and sending the reporting data to a cloud-based system.

Example 206 is a system including means to perform the method of any one of Examples 199-205.

Example 207 includes the subject matter of Example 206, where the means include a computer-readable medium to store instructions, where the instructions, when executed by a machine, causes the machine to perform at least a portion of the method of any one of Examples 199-205.

Example 208 is a non-transitory machine-readable storage medium with instructions stored thereon, the instructions when executed by the machine to cause the machine to: generate sensor data from a set of sensors on a vehicle; determine a path plan for the vehicle; autonomously control driving of the vehicle according to the path plan based on one or more machine learning models and the sensor data; determine that autonomous control of the vehicle should cease; send a handoff request to a remote computing system, where the remote computing system provides a remote valet service; receive driving instruction data from the remote computing system; and resume automated driving of the vehicle responsive to instructions included in the instruction data.

Example 209 includes the subject matter of Example 208, where the driving instruction data is generated based on inputs of a human user at the remote computing system.

Example 210 includes the subject matter of any one of Examples 208-209, where the instructions are further executable to cause the machine to: detect a pull-over event, where the vehicle is to pull-over and cease driving in association with the pull-over event, where the handoff request is sent in response to the pull-over event.

Example 211 includes the subject matter of any one of Examples 208-209, where determining that autonomous control of the vehicle should cease includes predicting, using a particular machine learning model, that conditions on an upcoming section of the path plan presents difficulties to autonomous driving during the upcoming section.

Example 212 includes the subject matter of any one of Examples 208-211, where it is determined that autonomous control should cease based on detection of one or more compromised sensors on the vehicle.

Example 213 includes the subject matter of any one of Examples 208-212, where the instructions are further executable to cause the machine to determine that no qualified passengers are present within the vehicle, where the handoff request is sent based at least in part on determining that no qualified passengers are present.

Example 214 includes the subject matter of any one of Examples 208-213, where the instructions are further executable to cause the machine to send the sensor data to the remote computing system to present a dynamic representation of surroundings of the vehicle to a user of the remote computing system.

Example 215 includes the subject matter of Example 214, where the sensor data includes video data.

Example 216 includes the subject matter of any one of Examples 214-215, where the sensor data is sent and driving instruction data is received over one or more low latency, high priority communication channels

Example 217 includes the subject matter of any one of Examples 208-216, where the instructions are further executable to cause the machine to present an alert for consumption by passengers of the vehicle to identify that control of the vehicle is handed over to the remote valet service.

Example 218 includes the subject matter of any one of Examples 208-217, where the instructions are further executable to cause the machine to: detect a change in conditions along the path plan; restore control of the driving of the vehicle from the remote valet service to autonomous driving logic of the vehicle.

Example 219 is a non-transitory machine-readable storage medium with instructions stored thereon, the instructions when executed by the machine to cause the machine to: provide a user interface for a human user at a computing terminal device; receive a handoff request from a vehicle configured to autonomously drive; receive sensor data from remote sensor devices describing an environment around the vehicle; present a representation of the environment on the user interface based on the sensor data; receive user inputs at the computing terminal device responsive to the representation, where the user inputs include inputs to direct driving of the vehicle within the environment; and send instruction data to the vehicle corresponding to the user inputs to remotely drive the vehicle according to the user inputs.

Example 220 includes the subject matter of Example 219, where the handoff request identifies a location of the vehicle.

Example 221 includes the subject matter of Example 220, where the instructions are further executable to cause the machine to: determine sensor devices corresponding to the location, where the sensor devices are external to the vehicle; and access supplemental sensor data from the sensor devices, where the representation is presented based at least in part on the supplemental sensor data.

Example 222 includes the subject matter of any one of Examples 219-221, where the sensor devices include sensor devices on the vehicle.

Example 223 includes the subject matter of any one of Examples 219-222, where the sensor devices include sensor devices separate from the vehicle.

Example 224 includes the subject matter of any one of Examples 219-223, where the instructions are further executable to cause the machine to: receive a request from the vehicle to return control of the driving of the vehicle to the vehicle; send a confirmation to the vehicle of the return of control; and cease transmission of the instruction data to the vehicle.

Example 225 includes the subject matter of any one of Examples 219-224, where the instructions are further executable to cause the machine to: generate reporting data describing the environment and performance of the vehicle based on the user inputs during control of the vehicle by the remote valet service; and send the reporting data to a cloud-based system.

Example 226 is a method including: generating sensor data from a set of sensors on a vehicle; determining a path plan for the vehicle; autonomously controlling driving of the vehicle according to the path plan based on one or more machine learning models and the sensor data; identifying conditions on an upcoming portion of the path plan; determining an opportunity to handoff control of the driving of the vehicle to a remote valet service based on the conditions; sending a handoff request to a remote computing system based on the opportunity, where the remote computing system provides the remote valet service; receiving driving instruction data from the remote computing system; and automating driving of the vehicle responsive to instructions included in the instruction data.

Example 227 includes the subject matter of Example 226, further including sending report data to another computing system identifying the handoff and the conditions corresponding to the handoff.

Example 228 includes the subject matter of Example 227, where the report data is sent to a cloud-based application.

Example 229 includes the subject matter of any one of Examples 227-228, where the report data is sent to a roadside unit.

Example 230 includes the subject matter of any one of Examples 226-229, where the conditions are identified from data received from another computing system.

Example 231 includes the subject matter of Example 230, where the conditions are identified through application of a machine learning model and the data from the other system is provided as an input to the machine learning model.

Example 232 includes the subject matter of Example 231, where the machine learning model is trained based on data reporting other instances of either a handoff to a remote valet service or a pull-over event.

Example 233 includes the subject matter of any one of Examples 226-232, where the handoff request is sent to avoid a pull-over event.

Example 234 includes the subject matter of any one of Examples 226-233, where the opportunity corresponds to a prediction that autonomous driving functionality of the vehicle will perform poorly in light of the conditions.

Example 235 includes the subject matter of any one of Examples 226-234, where the opportunity is determined based at least in part on information included in the sensor data.

Example 236 includes the subject matter of any one of Examples 226-235, further including: accessing additional data; predicting an improvement in conditions on another portion of the path plan following the upcoming path based on the additional data; and sending request data to the remote computing system to request control to be returned to the vehicle based on the predicted improvement in conditions; and resuming autonomously control of the driving of the vehicle.

Example 237 includes the subject matter of any one of Examples 226-236, where determining the opportunity to handoff control includes detecting a pullover event.

Example 238 includes the subject matter of Example 237, further including: determining conditions from the sensor data associated with the pullover event; and uploading data describing the conditions to a remote computing system.

Example 239 is a system including means to perform the method of any one of Examples 226-238.

Example 240 includes the subject matter of Example 239, where the means include a computer-readable medium to store instructions, where the instructions, when executed by a machine, causes the machine to perform at least a portion of the method of any one of Examples 226-238.

Example 241 is a non-transitory machine-readable storage medium with instructions stored thereon, the instructions when executed by the machine to cause the machine to: generate sensor data from a set of sensors on a vehicle; determine a path plan for the vehicle; autonomously control driving of the vehicle according to the path plan based on one or more machine learning models and the sensor data; identify conditions on an upcoming portion of the path plan; determine an opportunity to handoff control of the driving of the vehicle to a remote valet service based on the conditions; send a handoff request to a remote computing system based on the opportunity, where the remote computing system provides the remote valet service; receive driving instruction data from the remote computing system; and automate driving of the vehicle responsive to instructions included in the instruction data.

Example 242 includes the subject matter of Example 241, where the instructions are further executable to cause the machine to send report data to another computing system identifying the handoff and the conditions corresponding to the handoff.

Example 243 includes the subject matter of Example 242, where the report data is sent to a cloud-based application.

Example 244 includes the subject matter of any one of Examples 242-243, where the report data is sent to a roadside unit.

Example 245 includes the subject matter of any one of Examples 241-244, where the conditions are identified from data received from another computing system.

Example 246 includes the subject matter of Example 245, where the conditions are identified through application of a machine learning model and the data from the other system is provided as an input to the machine learning model.

Example 247 includes the subject matter of Example 246, where the machine learning model is trained based on data reporting other instances of either a handoff to a remote valet service or a pull-over event.

Example 248 includes the subject matter of any one of Examples 241-247, where the handoff request is sent to avoid a pull-over event.

Example 249 includes the subject matter of any one of Examples 241-248, where the opportunity corresponds to a prediction that autonomous driving functionality of the vehicle will perform poorly in light of the conditions.

Example 250 includes the subject matter of any one of Examples 241-249, where the opportunity is determined based at least in part on information included in the sensor data.

Example 251 includes the subject matter of any one of Examples 241-250, where the instructions are further executable to cause the machine to: access additional data; predict an improvement in conditions on another portion of the path plan following the upcoming path based on the additional data; and send request data to the remote computing system to request control to be returned to the vehicle based on the predicted improvement in conditions; and resume autonomously control of the driving of the vehicle.

Example 252 includes the subject matter of any one of Examples 241-251, where determining the opportunity to handoff control includes detecting a pullover event.

Example 253 includes the subject matter of Example 252, where the instructions are further executable to cause the machine to: determine conditions from the sensor data associated with the pullover event; and upload data describing the conditions to a remote computing system.

Example 254 is a method including: receiving an environment model generated based on sensor data from a plurality of sensors coupled to an autonomous vehicle; determining, based on information in the environment model, a variation in one or more behaviors of vehicles other than the autonomous vehicle; determining, based on information in the environment model, a deviation between one or more behaviors of the vehicles other than the autonomous vehicle and the same one or more behaviors performed by the autonomous vehicle; determining, based on the determined variation and deviation, one or more constraints to a behavioral model for the autonomous vehicle; and applying the one or more constraints to the behavioral model to control operation of the autonomous vehicle.

Example 255 includes the subject matter of Example 254, further including: constructing a scenario based on the environment model and geographic location information for the autonomous vehicle; and associating the constraints with the scenario in a social norm profile for the behavioral model of the autonomous vehicle.

Example 256 includes the subject matter of Example 255, where the scenario is based on one or more of a number of vehicles near the autonomous vehicle, a speed for each of the one or more vehicles near the autonomous vehicle, a time of day, and weather condition information.

Example 257 includes the subject matter of any one of Examples 254-256, where determining the variation includes determining whether observed behavior is within current parameters of the behavioral model for the autonomous vehicle.

Example 258 includes the subject matter of Example 257, where the variation is based on a Euclidean distance to the current behavioral model from the observations of surrounding vehicles.

Example 259 includes the subject matter of any one of Examples 254-256, where determining the deviation includes determining whether the deviation of behavior is within current parameters of the behavioral model for the autonomous vehicle.

Example 260 includes the subject matter of Example 259, where the deviation is based on negative feedback transgressions that act as limits for the behavior.

Example 261 includes the subject matter of any one of Examples 254-260, where the variation and deviation are based on information in the environment model associated with dynamic obstacles.

Example 262 is an apparatus including: memory; and processing circuitry coupled to the memory to perform one or more of the methods of Examples 254-261.

Example 263 is a system including means for performing one or more of the methods of Examples 254-261.

Example 264 is a product including one or more tangible computer-readable non-transitory storage media including computer-executable instructions operable to, when executed by at least one computer processor, enable the at least one computer processor to implement operations of the methods of Examples 254-261.

Example 265 is a non-transitory machine-readable storage medium with instructions stored thereon, the instructions when executed by the machine to cause the machine to: receive an environment model generated based on sensor data from a plurality of sensors coupled to an autonomous vehicle; determine, based on information in the environment model, a variation in one or more behaviors of vehicles other than the autonomous vehicle; determine, based on information in the environment model, a deviation between one or more behaviors of the vehicles other than the autonomous vehicle and the same one or more behaviors performed by the autonomous vehicle; determine, based on the determined variation and deviation, one or more constraints to a behavioral model for the autonomous vehicle; and apply the one or more constraints to the behavioral model to control operation of the autonomous vehicle.

Example 266 includes the subject matter of Example 265, where the instructions are further executable to cause the machine to: construct a scenario based on the environment model and geographic location information for the autonomous vehicle; and associate the constraints with the scenario in a social norm profile for the behavioral model of the autonomous vehicle.

Example 267 includes the subject matter of Example 266, where the scenario is based on one or more of a number of vehicles near the autonomous vehicle, a speed for each of the one or more vehicles near the autonomous vehicle, a time of day, and weather condition information.

Example 268 includes the subject matter of any one of Examples 265-267, where determining the variation includes determining whether observed behavior is within current parameters of the behavioral model for the autonomous vehicle.

Example 269 includes the subject matter of Example 268, where the variation is based on a Euclidean distance to the current behavioral model from the observations of surrounding vehicles.

Example 270 includes the subject matter of any one of Examples 265-267, where determining the deviation includes determining whether the deviation of behavior is within current parameters of the behavioral model for the autonomous vehicle.

Example 271 includes the subject matter of Example 270, where the deviation is based on negative feedback transgressions that act as limits for the behavior.

Example 272 includes the subject matter of any one of Examples 265-271, where the variation and deviation are based on information in the environment model associated with dynamic obstacles.

Example 273 is a method including: generating sensor data from a set of sensors on a first vehicle; determining a path plan for the first vehicle; autonomously controlling driving of the first vehicle according to the path plan based on one or more machine learning models and the sensor data; receiving, at the first vehicle, a signal identifying another, second vehicle in proximity of the first vehicle; communicating with the second vehicle to obtain a behavioral model associated with the second vehicle, where the behavioral model includes a particular machine learning model to determine driving behavior of the second vehicle; determining trustworthiness of the behavioral model; and using the behavioral model to predict actions of the second vehicle.

Example 274 includes the subject matter of Example 273, where the second vehicle includes autonomous driving functionality and the behavior model corresponds to machine learning models used by the second vehicle to determine autonomous driving behavior.

Example 275 includes the subject matter of any one of Examples 273-274, where determining trustworthiness of the behavioral model includes verifying a format of the model.

Example 276 includes the subject matter of any one of Examples 273-275, where determining trustworthiness of the behavioral model includes verifying accuracy of the model.

Example 277 includes the subject matter of Example 276, where verifying accuracy of the behavioral model includes: storing inputs provided to at least one of the machine learning models and corresponding outputs by the at least one machine learning model; where the accuracy of the model is verified by providing the inputs to the behavioral model and comparing outputs of the behavioral model to the outputs of the at least one machine learning model.

Example 278 includes the subject matter of Example 276, where verifying accuracy of the behavioral model includes: providing inputs to the behavioral model corresponding to observed conditions; determining expected behavior of the second vehicle from the behavioral model based on the inputs; observing behavior of the second vehicle corresponding to the observed conditions; and comparing the observed behavior with the expected behavior.

Example 279 includes the subject matter of any one of Examples 273-278, where communicating with the second vehicle includes establishing a secure communication session between the first vehicle and the second vehicle, and the behavioral model is received in communications within the secure communication session.

Example 280 includes the subject matter of Example 279, where establishing the secure communication session includes exchanging tokens between the first and second vehicles, and each token includes a respective identifier of the corresponding vehicle, a respective public key, and a shared secret value.

Example 281 includes the subject matter of any one of Examples 273-280, where the signal includes a beacon to indicate an identity and position of the second vehicle.

Example 282 includes the subject matter of any one of Examples 273-281, further including: broadcasting a signal to other vehicles in the proximity of the first vehicle to identify the first vehicle to the other vehicles.

Example 283 includes the subject matter of any one of Examples 273-282, where the behavioral model includes a second behavioral model, the second behavioral model is obtained in an exchange of behavioral models between the first and second behavioral models, and the first vehicle sends a first behavioral model based on one or more of the machine learning models to the second vehicle in the exchange of behavioral models.

Example 284 includes the subject matter of any one of Examples 273-283, further including determining whether the behavioral model for the second model is in a model database of the first vehicle, where the behavioral model for the second model is obtained based on determining that the behavioral model is not yet in the model database.

Example 285 includes the subject matter of Example 273, where the second vehicle includes a human driving mode and the behavior model models characteristics of human drivers in the second vehicle during the human driving mode.

Example 286 includes the subject matter of any one of Examples 273-285, where the behavioral model includes one of a set of behavioral models for the second vehicle, and the set of behavioral models includes a plurality of scenario-specific behavioral models.

Example 287 includes the subject matter of Example 286, further including: determining a particular scenario based at least in part on the sensor data; determining that a particular behavioral model in the set of behavioral model corresponds to the particular scenario, where the particular behavioral model is used to predict actions of the second vehicle based on determining that the particular behavioral model corresponds to the particular scenario.

Example 288 includes the subject matter of any one of Examples 273-287, further including: providing data describing the predicted actions to of the second vehicle derived from the behavioral model as inputs to at least one of the machine learning models of the first vehicle; and causing the first vehicle to drive based on an output derived at the at least one of the machine learning models based on the inputs.

Example 289 includes the subject matter of Example 288, where driving the first vehicle based on the predicted actions yields different behavior of the first vehicle than default driving decisions of the first vehicle.

Example 290 is a system including means to perform the method of any one of Examples 273-289.

Example 291 includes the subject matter of Example 290, where the means include a computer-readable medium to store instructions, where the instructions, when executed by a machine, causes the machine to perform at least a portion of the method of any one of Examples 273-289.

Example 292 is a non-transitory machine-readable storage medium with instructions stored thereon, the instructions when executed by the machine to cause the machine to: generate sensor data from a set of sensors on a first vehicle; determine a path plan for the first vehicle; autonomously control driving of the first vehicle according to the path plan based on one or more machine learning models and the sensor data; receive, at the first vehicle, a signal identifying another, second vehicle in proximity of the first vehicle; communicate with the second vehicle to obtain a behavioral model associated with the second vehicle, where the behavioral model includes a particular machine learning model to determine driving behavior of the second vehicle; determine trustworthiness of the behavioral model; and use the behavioral model to predict actions of the second vehicle.

Example 293 includes the subject matter of Example 292, where the second vehicle includes autonomous driving functionality and the behavior model corresponds to machine learning models used by the second vehicle to determine autonomous driving behavior.

Example 294 includes the subject matter of any one of Examples 292-293, where determining trustworthiness of the behavioral model includes verifying a format of the model.

Example 295 includes the subject matter of any one of Examples 292-294, where determining trustworthiness of the behavioral model includes verifying accuracy of the model.

Example 296 includes the subject matter of Example 295, where verifying accuracy of the behavioral model includes: storing inputs provided to at least one of the machine learning models and corresponding outputs by the at least one machine learning model; where the accuracy of the model is verified by providing the inputs to the behavioral model and comparing outputs of the behavioral model to the outputs of the at least one machine learning model.

Example 297 includes the subject matter of Example 295, where verifying accuracy of the behavioral model includes: providing inputs to the behavioral model corresponding to observed conditions; determining expected behavior of the second vehicle from the behavioral model based on the inputs; observing behavior of the second vehicle corresponding to the observed conditions; and comparing the observed behavior with the expected behavior.

Example 298 includes the subject matter of any one of Examples 292-297, where communicating with the second vehicle includes establishing a secure communication session between the first vehicle and the second vehicle, and the behavioral model is received in communications within the secure communication session.

Example 299 includes the subject matter of Example 298, where establishing the secure communication session includes exchanging tokens between the first and second vehicles, and each token includes a respective identifier of the corresponding vehicle, a respective public key, and a shared secret value.

Example 300 includes the subject matter of any one of Examples 292-299, where the signal includes a beacon to indicate an identity and position of the second vehicle.

Example 301 includes the subject matter of any one of Examples 292-300, further including: broadcasting a signal to other vehicles in the proximity of the first vehicle to identify the first vehicle to the other vehicles.

Example 302 includes the subject matter of any one of Examples 292-301, where the behavioral model includes a second behavioral model, the second behavioral model is obtained in an exchange of behavioral models between the first and second behavioral models, and the first vehicle sends a first behavioral model based on one or more of the machine learning models to the second vehicle in the exchange of behavioral models.

Example 303 includes the subject matter of any one of Examples 292-302, where the instructions are further executable to cause the machine to determine whether the behavioral model for the second model is in a model database of the first vehicle, where the behavioral model for the second model is obtained based on determining that the behavioral model is not yet in the model database.

Example 304 includes the subject matter of Example 292, where the second vehicle includes a human driving mode and the behavior model models characteristics of human drivers in the second vehicle during the human driving mode.

Example 305 includes the subject matter of any one of Examples 292-304, where the behavioral model includes one of a set of behavioral models for the second vehicle, and the set of behavioral models includes a plurality of scenario-specific behavioral models.

Example 306 includes the subject matter of Example 305, where the instructions are further executable to cause the machine to: determine a particular scenario based at least in part on the sensor data; determine that a particular behavioral model in the set of behavioral model corresponds to the particular scenario, where the particular behavioral model is used to predict actions of the second vehicle based on determining that the particular behavioral model corresponds to the particular scenario.

Example 307 includes the subject matter of any one of Examples 292-306, where the instructions are further executable to cause the machine to: provide data describing the predicted actions to of the second vehicle derived from the behavioral model as inputs to at least one of the machine learning models of the first vehicle; and cause the first vehicle to drive based on an output derived at the at least one of the machine learning models based on the inputs.

Example 308 includes the subject matter of Example 307, where driving the first vehicle based on the predicted actions yields different behavior of the first vehicle than default driving decisions of the first vehicle.

Example 309 is a method including: participating in a first consensus negotiation with a first plurality of vehicles, where behavioral models of at least a portion of the first plurality of vehicles are exchanged in the first consensus negotiation, and participating in the first consensus negotiation includes receiving each of the behavioral models exchanged and determining validity of each of the behavioral models in the first consensus negotiation; participating in a second consensus negotiation with a second plurality of vehicles, where behavioral models of at least a portion of the second plurality of vehicles are exchanged in the second consensus negotiation, and participating in the second consensus negotiation includes receiving each of the behavioral models exchanged and determining validity of each of the behavioral models in the second consensus negotiation; and generating a consensus behavioral model from the first and second consensus negotiations.

Example 310 includes the subject matter of Example 309, further including distributing the consensus behavioral model to a third plurality of vehicles.

Example 311 includes the subject matter of Example 310, where the consensus behavioral model is distributed in a third consensus negotiation.

Example 312 includes the subject matter of any one of Examples 309-311, where the first and second consensus negotiations are based on a byzantine fault tolerance consensus algorithm.

Example 313 includes the subject matter of any one of Examples 309-312, where the behavioral models include neural network-based models.

Example 314 includes the subject matter of any one of Examples 309-313, where at least one of the first or second plurality of vehicles includes a non-autonomous vehicle with a human driver.

Example 315 includes the subject matter of Example 314, further including determining a behavioral model corresponding to the non-autonomous vehicle.

Example 316 includes the subject matter of Example 315, further including generating sensor data at one or more local sensors to observe a plurality of behaviors of one or more non-autonomous vehicles, where the behavioral model corresponding to the non-autonomous vehicle is based on the sensor data.

Example 317 includes the subject matter of Example 316, where the behavioral model corresponding to the non-autonomous vehicle is further based on the consensus behavioral model.

Example 318 includes the subject matter of any one of Examples 309-317, where the method if performed using a stationary computing node corresponding to a particular road segment, and the stationary computing node is positioned proximate to the particular road segment.

Example 319 includes the subject matter of Example 318, where the consensus behavioral model attempts to describe ideal driving behavior on the particular road segment.

Example 320 is a system including means to perform the method of any one of Examples 309-319.

Example 321 includes the subject matter of Example 320, where the means include a computer-readable medium to store instructions, where the instructions, when executed by a machine, causes the machine to perform at least a portion of the method of any one of Examples 309-319.

Example 322 is a non-transitory machine-readable storage medium with instructions stored thereon, the instructions when executed by the machine to cause the machine to: participate in a first consensus negotiation with a first plurality of vehicles, where behavioral models of at least a portion of the first plurality of vehicles are exchanged in the first consensus negotiation, and participating in the first consensus negotiation includes receiving each of the behavioral models exchanged and determining validity of each of the behavioral models in the first consensus negotiation; participate in a second consensus negotiation with a second plurality of vehicles, where behavioral models of at least a portion of the second plurality of vehicles are exchanged in the second consensus negotiation, and participating in the second consensus negotiation includes receiving each of the behavioral models exchanged and determining validity of each of the behavioral models in the second consensus negotiation; and generate a consensus behavioral model from the first and second consensus negotiations.

Example 323 includes the subject matter of Example 322, where the instructions are further executable to cause the machine to distribute the consensus behavioral model to a third plurality of vehicles.

Example 324 includes the subject matter of Example 323, where the consensus behavioral model is distributed in a third consensus negotiation.

Example 325 includes the subject matter of any one of Examples 322-324, where the first and second consensus negotiations are based on a byzantine fault tolerance consensus algorithm.

Example 326 includes the subject matter of any one of Examples 322-325, where the behavioral models include neural network-based models.

Example 327 includes the subject matter of any one of Examples 322-326, where at least one of the first or second plurality of vehicles includes a non-autonomous vehicle with a human driver.

Example 328 includes the subject matter of Example 327, where the instructions are further executable to cause the machine to determine a behavioral model corresponding to the non-autonomous vehicle.

Example 329 includes the subject matter of Example 328, where the instructions are further executable to cause the machine to generate sensor data at one or more local sensors to observe a plurality of behaviors of one or more non-autonomous vehicles, where the behavioral model corresponding to the non-autonomous vehicle is based on the sensor data.

Example 330 includes the subject matter of Example 329, where the behavioral model corresponding to the non-autonomous vehicle is further based on the consensus behavioral model.

Example 331 includes the subject matter of any one of Examples 322-330, where the storage medium if performed using a stationary computing node corresponding to a particular road segment, and the stationary computing node is positioned proximate to the particular road segment.

Example 332 includes the subject matter of Example 331, where the consensus behavioral model attempts to describe ideal driving behavior on the particular road segment.

Example 33 is a method including: receiving HD map data from a server; receiving sensor data from a sensor device coupled to an autonomous vehicle; computing a confidence score for the sensor data based on information associated with the collection of the sensor data; computing a delta value based on a comparison of the sensor data and information in the HD map corresponding to a location of the autonomous vehicle when the sensor data was obtained; determining, based on the confidence score and the delta value, whether to publish the sensor data to the server for updating of the HD map.

Example 334 includes the subject matter of Example 333, further including publishing the sensor data to the server in response to a determination that the confidence score is above a first threshold value and the delta value is above a second threshold value.

Example 335 includes the subject matter of Example 333, where the information associated with the collection of the sensor data includes one or more of weather data at the time of data collection sensor device configuration information, sensor device operation information, local sensor corroboration data, or sensor device authentication status information.

Example 336 includes the subject matter of any one of Examples 333-335, further including signing the sensor data with a pseudo-anonymous digital certificate.

Example 337 includes the subject matter of Example 336, where the pseudo-anonymous digital certificate is based on a V2X protocol.

Example 338 is a system including means for performing one or more of the methods of Examples 333-337.

Example 339 is a product including one or more tangible computer-readable non-transitory storage media including computer-executable instructions operable to, when executed by at least one computer processor, enable the at least one computer processor to implement operations of the methods of Examples 333-337.

Example 340 is a method including: receiving sensor data from an autonomous vehicle, the sensor data including a confidence score indicating a confidence level in the sensor data; determining whether the autonomous vehicle is trusted based at least in part on a trust score associated with the autonomous vehicle, where the trust score is based at least in part on the confidence score and one or more other confidence scores for sensor data previously received from the autonomous vehicle; and updating an HD map using the sensor data in response to a determination that the autonomous vehicle is trusted.

Example 341 includes the subject matter of Example 340, further including determining whether the confidence score is above a threshold value, where updating the HD map is further in response to the confidence score being above the threshold value.

Example 342 includes the subject matter of Example 340, where the trust score is further based on whether the sensor data is signed by the autonomous vehicle using a pseudo-anonymous digital certificate.

Example 343 includes the subject matter of Example 340, where determining whether the autonomous vehicle is trusted is further based on whether the autonomous vehicle is blacklisted.

Example 344 includes the subject matter of Example 340, where determining whether the autonomous vehicle is trusted is further based on a correlation of the sensor data with sensor data from other autonomous vehicles nearby the autonomous vehicle.

Example 345 includes the subject matter of Example 340, further including updating the trust score for the autonomous vehicle based on the confidence score.

Example 346 includes the subject matter of Example 345, where updating the trust score includes one or more of incrementing the trust score in response to the confidence score being above a first threshold value, and decrementing the trust score in response to the confidence score being below a second threshold value.

Example 347 is a system including means for performing one or more of the methods of Examples 340-346.

Example 348 is a product including one or more tangible computer-readable non-transitory storage media including computer-executable instructions operable to, when executed by at least one computer processor, enable the at least one computer processor to implement operations of the methods of Examples 340-346.

Example 349 is a non-transitory machine-readable storage medium with instructions stored thereon, the instructions when executed by the machine to cause the machine to: receive HD map data from a server; receive sensor data from a sensor device coupled to an autonomous vehicle; compute a confidence score for the sensor data based on information associated with the collection of the sensor data; compute a delta value based on a comparison of the sensor data and information in the HD map corresponding to a location of the autonomous vehicle when the sensor data was obtained; determine, based on the confidence score and the delta value, whether to publish the sensor data to the server for updating of the HD map.

Example 350 includes the subject matter of Example 349, where the instructions are further executable to cause the machine to publish the sensor data to the server in response to a determination that the confidence score is above a first threshold value and the delta value is above a second threshold value.

Example 351 includes the subject matter of Example 349, where the information associated with the collection of the sensor data includes one or more of weather data at the time of data collection sensor device configuration information, sensor device operation information, local sensor corroboration data, or sensor device authentication status information.

Example 352 includes the subject matter of any one of Examples 349-351, where the instructions are further executable to cause the machine to sign the sensor data with a pseudo-anonymous digital certificate.

Example 353 includes the subject matter of Example 352, where the pseudo-anonymous digital certificate is based on a V2X protocol.

Example 354 is a non-transitory machine-readable storage medium with instructions stored thereon, the instructions when executed by the machine to cause the machine to: receive sensor data from an autonomous vehicle, the sensor data including a confidence score indicating a confidence level in the sensor data; determine whether the autonomous vehicle is trusted based at least in part on a trust score associated with the autonomous vehicle, where the trust score is based at least in part on the confidence score and one or more other confidence scores for sensor data previously received from the autonomous vehicle; and update an HD map using the sensor data in response to a determination that the autonomous vehicle is trusted.

Example 355 includes the subject matter of Example 354, where the instructions are further executable to cause the machine to determine whether the confidence score is above a threshold value, where updating the HD map is further in response to the confidence score being above the threshold value.

Example 356 includes the subject matter of Example 354, where the trust score is further based on whether the sensor data is signed by the autonomous vehicle using a pseudo-anonymous digital certificate.

Example 357 includes the subject matter of Example 354, where determining whether the autonomous vehicle is trusted is further based on whether the autonomous vehicle is blacklisted.

Example 358 includes the subject matter of Example 354, where determining whether the autonomous vehicle is trusted is further based on a correlation of the sensor data with sensor data from other autonomous vehicles nearby the autonomous vehicle.

Example 359 includes the subject matter of Example 354, where the instructions are further executable to cause the machine to update the trust score for the autonomous vehicle based on the confidence score.

Example 360 includes the subject matter of Example 359, where updating the trust score includes one or more of incrementing the trust score in response to the confidence score being above a first threshold value, and decrementing the trust score in response to the confidence score being below a second threshold value.

Example 361 is a method including: receiving sensor data from an autonomous vehicle; obtaining geolocation information from the sensor data, the geolocation information indicating a location of the autonomous vehicle; computing a goodness score for the sensor data based at least on the geolocation information; comparing the goodness score to a threshold value; and storing the sensor data in a database in response to the goodness score being above a threshold.

Example 362 includes the subject matter of Example 361, where: the method further includes computing a location score based on the geolocation information; and computing the goodness score is based on the location score and one or more other scores associated with the sensor data.

Example 363 includes the subject matter of Example 362, where computing the location score includes: accessing a heatmap associated with the geolocation information, the heatmap indicating an amount of sensor data collected at a plurality of locations; obtaining a value from the heat map associated with the location indicated by the geolocation information; and using the value from the heat map to compute the location score.

Example 364 includes the subject matter of any one of Examples 362-363, where the goodness score is a weighted sum of the location score and the one or more other scores associated with the sensor data.

Example 365 includes the subject matter of any one of Examples 362-364, where the location score is a weighted sum of the geolocation information and one or more additional categories of environment information, each category of environment information indicating a condition of a location of the autonomous vehicle.

Example 366 includes the subject matter of Example 365, where the one or more additional categories of environment information includes one or more of elevation information indicating an elevation of the autonomous vehicle, temperature information indicating a temperature outside the autonomous vehicle, weather information indicating weather conditions near the autonomous vehicle, and terrain information indicating features of the area traversed by the autonomous vehicle.

Example 367 includes the subject matter of Example 365, where computing the location score includes, for each of the one or more additional categories of environment information: accessing a heatmap associated with the additional category, the heatmap indicating an amount of sensor data collected at a plurality of locations; obtaining a value from the heat map associated with the location indicated by geolocation information; and using the obtained value to compute the location score

Example 368 includes the subject matter of any one of Examples 362-367, where the one or more other scores include one or more of a noise score for the sensor data, and an object diversity score for the sensor data.

Example 369 includes the subject matter of any one of Examples 361-368, where obtaining the geolocation information from the sensor data includes one or more of obtaining geographic coordinate information in the sensor data and analyzing metadata of the sensor data to obtain the geolocation information.

Example 370 includes the subject matter of any one of Examples 361-369, further including computing a vehicle dependability score associated with the autonomous vehicle based on the goodness score.

Example 271 is a system including means for performing one or more of the methods of Examples 361-370.

Example 372 is a product including one or more tangible computer-readable non-transitory storage media including computer-executable instructions operable to, when executed by at least one computer processor, enable the at least one computer processor to implement operations of the methods of Examples 361-370.

Example 373 is a non-transitory machine-readable storage medium with instructions stored thereon, the instructions when executed by the machine to cause the machine to: receive sensor data from an autonomous vehicle; obtain geolocation information from the sensor data, the geolocation information indicating a location of the autonomous vehicle; compute a goodness score for the sensor data based at least on the geolocation information; compare the goodness score to a threshold value; and store the sensor data in a database in response to the goodness score being above a threshold.

Example 374 includes the subject matter of Example 373, where: the storage medium further includes computing a location score based on the geolocation information; and computing the goodness score is based on the location score and one or more other scores associated with the sensor data.

Example 375 includes the subject matter of Example 374, where computing the location score includes: accessing a heatmap associated with the geolocation information, the heatmap indicating an amount of sensor data collected at a plurality of locations; obtaining a value from the heat map associated with the location indicated by the geolocation information; and using the value from the heat map to compute the location score.

Example 376 includes the subject matter of any one of Examples 374-375, where the goodness score is a weighted sum of the location score and the one or more other scores associated with the sensor data.

Example 377 includes the subject matter of any one of Examples 374-376, where the location score is a weighted sum of the geolocation information and one or more additional categories of environment information, each category of environment information indicating a condition of a location of the autonomous vehicle.

Example 378 includes the subject matter of Example 377, where the one or more additional categories of environment information includes one or more of elevation information indicating an elevation of the autonomous vehicle, temperature information indicating a temperature outside the autonomous vehicle, weather information indicating weather conditions near the autonomous vehicle, and terrain information indicating features of the area traversed by the autonomous vehicle.

Example 379 includes the subject matter of Example 378, where computing the location score includes, for each of the one or more additional categories of environment information: accessing a heatmap associated with the additional category, the heatmap indicating an amount of sensor data collected at a plurality of locations; obtaining a value from the heat map associated with the location indicated by geolocation information; and using the obtained value to compute the location score.

Example 380 includes the subject matter of any one of Examples 374-379, where the one or more other scores include one or more of a noise score for the sensor data, and an object diversity score for the sensor data.

Example 381 includes the subject matter of any one of Examples 373-380, where obtaining the geolocation information from the sensor data includes one or more of obtaining geographic coordinate information in the sensor data and analyzing metadata of the sensor data to obtain the geolocation information.

Example 382 includes the subject matter of any one of Examples 373-381, where the instructions are further executable to cause the machine to compute a vehicle dependability score associated with the autonomous vehicle based on the goodness score.

Example 383 is a method including: receiving sensor data from a plurality of sensors coupled to an autonomous vehicle; detecting an irregular behavior performed by a particular vehicle other than the autonomous vehicle based on the sensor data; generating an identifier for the particular vehicle; and initiating a dynamic behavior policy of the autonomous vehicle in response to detecting the irregular behavior being performed by the particular vehicle a number of times greater than a threshold number.

Example 384 includes the subject matter of Example 383, where detecting the irregular behavior performed by the particular vehicle includes: comparing an observed behavior performed by the particular vehicle with a safety model of the autonomous vehicle; and determining, based on the comparison, that the observed behavior violates the safety model of the autonomous vehicle.

Example 385 includes the subject matter of Example 383, where detecting the irregular behavior performed by the particular vehicle includes: comparing an observed behavior performed by the particular vehicle with observed behaviors performed by other vehicles; and determining, based on the comparison, that the observed behavior performed by the particular vehicle deviates from the observed behaviors performed by the other vehicles.

Example 386 includes the subject matter of Example 383, where detecting the irregular behavior performed by the particular vehicle includes: comparing an observed behavior performed by the particular vehicle with observed behaviors performed by other vehicles; and determining, based on the comparison, that the observed behaviors performed by the other vehicles are performed in reaction to the observed behavior performed by the particular vehicle.

Example 387 includes the subject matter of any one of Examples 383-386, where detecting the irregular behavior is based on audio and visual contextual information in the sensor data.

Example 388 includes the subject matter of any one of Examples 383-387, where generating an identifier for the particular vehicle includes: obtaining values for respective features of the particular vehicle; and applying a cryptographic has on a combination of the values to obtain the identifier.

Example 389 includes the subject matter of Example 388, where the values are obtained by extracting representative features from a deep learning model used by the autonomous vehicle to recognize other vehicles.

Example 390 includes the subject matter of any one of Examples 383-389, further including tracking a frequency of detection of the irregular behavior by other vehicles.

Example 391 is a system including means for performing one or more of the methods of Examples 383-390.

Example 392 is a product including one or more tangible computer-readable non-transitory storage media including computer-executable instructions operable to, when executed by at least one computer processor, enable the at least one computer processor to implement operations of one or more of the methods of Examples 383-390.

Example 393 is a method including: receiving irregular behavior tracking data from a plurality of autonomous vehicles, the irregular behavior tracking data including entries that include a vehicle identifier, an associated irregular behavior observed as being performed by a vehicle associated with the vehicle identifier, and contextual data indicating a context in which the irregular behavior was detected by the autonomous vehicles; identifying one or more sequences of irregular behaviors performed by one or more vehicles; identifying a contextual behavior pattern based on the identified sequences and the irregular behavior tracking data; and modifying a behavior policy for one or more autonomous vehicles based on the identified contextual behavior pattern.

Example 394 includes the subject matter of Example 393, where identifying a contextual behavioral pattern includes: generating a contextual graph including a first set of nodes indicating identified sequences and a second set of nodes indicating contextual data, where edges of the contextual graph indicate a frequency of associations between the nodes; and using the contextual graph to identify the contextual behavior pattern.

Example 395 includes the subject matter of Example 393, where modifying the behavior policy for the one or more autonomous vehicles is based on detecting that the one or more autonomous vehicles are within a particular context associated with the identified contextual behavior pattern.

Example 396 includes the subject matter of any one of Examples 393-395, where the contextual data includes one or more of trajectory information for the vehicles performing the irregular behaviors, vehicle attributes for the vehicles performing the irregular behaviors, driver attributes for the vehicles performing the irregular behaviors, a geographic location of the vehicles performing the irregular behaviors, weather conditions around the vehicles performing the irregular behaviors, and traffic information indicating traffic conditions around the vehicles performing the irregular behaviors.

Example 397 includes the subject matter of any one of Examples 393-396, where the one or more sequences of irregular behaviors are identified based on Longest Common Subsequences (LCS).

Example 398 is a system including means for performing one or more of the methods of Examples 393-396.

Example 399 is a product including one or more tangible computer-readable non-transitory storage media including computer-executable instructions operable to, when executed by at least one computer processor, enable the at least one computer processor to implement operations of one or more of the methods of Examples 393-396.

Example 400 is a non-transitory machine-readable storage medium with instructions stored thereon, the instructions when executed by the machine to cause the machine to: receive sensor data from a plurality of sensors coupled to an autonomous vehicle; detect an irregular behavior performed by a particular vehicle other than the autonomous vehicle based on the sensor data; generate an identifier for the particular vehicle; and initiate a dynamic behavior policy of the autonomous vehicle in response to detecting the irregular behavior being performed by the particular vehicle a number of times greater than a threshold number.

Example 401 includes the subject matter of Example 400, where detecting the irregular behavior performed by the particular vehicle includes: comparing an observed behavior performed by the particular vehicle with a safety model of the autonomous vehicle; and determining, based on the comparison, that the observed behavior violates the safety model of the autonomous vehicle.

Example 402 includes the subject matter of Example 400, where detecting the irregular behavior performed by the particular vehicle includes: comparing an observed behavior performed by the particular vehicle with observed behaviors performed by other vehicles; and determining, based on the comparison, that the observed behavior performed by the particular vehicle deviates from the observed behaviors performed by the other vehicles.

Example 403 includes the subject matter of Example 400, where detecting the irregular behavior performed by the particular vehicle includes: comparing an observed behavior performed by the particular vehicle with observed behaviors performed by other vehicles; and determining, based on the comparison, that the observed behaviors performed by the other vehicles are performed in reaction to the observed behavior performed by the particular vehicle.

Example 404 includes the subject matter of any one of Examples 400-403, where detecting the irregular behavior is based on audio and visual contextual information in the sensor data.

Example 405 includes the subject matter of any one of Examples 400-404, where generating an identifier for the particular vehicle includes: obtaining values for respective features of the particular vehicle; and applying a cryptographic has on a combination of the values to obtain the identifier.

Example 406 includes the subject matter of Example 405, where the values are obtained by extracting representative features from a deep learning model used by the autonomous vehicle to recognize other vehicles.

Example 407 includes the subject matter of any one of Examples 400-406, further including tracking a frequency of detection of the irregular behavior by other vehicles.

Example 408 is a non-transitory machine-readable storage medium with instructions stored thereon, the instructions when executed by the machine to cause the machine to: receive irregular behavior tracking data from a plurality of autonomous vehicles, the irregular behavior tracking data including entries that include a vehicle identifier, an associated irregular behavior observed as being performed by a vehicle associated with the vehicle identifier, and contextual data indicating a context in which the irregular behavior was detected by the autonomous vehicles; identify one or more sequences of irregular behaviors performed by one or more vehicles; identify a contextual behavior pattern based on the identified sequences and the irregular behavior tracking data; and modify a behavior policy for one or more autonomous vehicles based on the identified contextual behavior pattern.

Example 409 includes the subject matter of Example 408, where identifying a contextual behavioral pattern includes: generating a contextual graph including a first set of nodes indicating identified sequences and a second set of nodes indicating contextual data, where edges of the contextual graph indicate a frequency of associations between the nodes; and using the contextual graph to identify the contextual behavior pattern.

Example 410 includes the subject matter of Example 408, where modifying the behavior policy for the one or more autonomous vehicles is based on detecting that the one or more autonomous vehicles are within a particular context associated with the identified contextual behavior pattern.

Example 411 includes the subject matter of any one of Examples 408-410, where the contextual data includes one or more of trajectory information for the vehicles performing the irregular behaviors, vehicle attributes for the vehicles performing the irregular behaviors, driver attributes for the vehicles performing the irregular behaviors, a geographic location of the vehicles performing the irregular behaviors, weather conditions around the vehicles performing the irregular behaviors, and traffic information indicating traffic conditions around the vehicles performing the irregular behaviors.

Example 412 includes the subject matter of any one of Examples 408-411, where the one or more sequences of irregular behaviors are identified based on Longest Common Subsequences (LCS).

Example 413 is a method including: receiving, from a vehicle behavior model, a classification of a first change in motion for a vehicle; receiving, from a regression model, a prediction of a likelihood of the first change in motion for the vehicle occurring during a given time interval; comparing the classification from the vehicle behavior model to the prediction from the regression model; determining that the first change in motion for the vehicle is a fault based, at least in part, on the comparing; and sending a first control signal to affect the first change in motion for the vehicle based on determining that the first change in motion for the vehicle is a fault.

Example 414 includes the subject matter of Example 413, further including: receiving, at the vehicle behavior model, a first control event that indicates the first change in motion for the vehicle; and generating the classification of the first change in motion based, at least in part, on the first control event and data from one or more sensors in the vehicle.

Example 415 includes the subject matter of Example 413, further including: receiving, at the regression model, a first control event; obtaining one or more variables indicative of current conditions; and generating the prediction based, at least in part, on the first control event and the one or more variables indicative of the current conditions.

Example 416 includes the subject matter of Example 415, where the current conditions include at least one environmental condition.

Example 417 includes the subject matter of any one of Examples 415-416, where the current conditions include at least one vehicle condition.

Example 418 includes the subject matter of any one of Examples 415-417, where at least one of the one or more variables are obtained from one or more remote sources.

Example 419 includes the subject matter of any one of Examples 414-418, where the first control event is associated with a braking actuator, a steering actuator, or a throttle actuator.

Example 420 includes the subject matter of any ones of Example 413-419, where the vehicle behavior model is a Hidden Markov Model (HMM) algorithm.

Example 421 includes the subject matter of any one of Examples 413-420, where the regression model is an expectation maximization (EM) algorithm.

Example 422 includes the subject matter of any one of Examples 413-421, where the fault is one of a malicious attack on a computing system of the vehicle or a failure in the computing system of the vehicle.

Example 423 is a system including means for performing one or more of the methods of Examples 413-422.

Example 424 is a machine readable medium including instructions, where the instructions when executed realize an apparatus or implement a method as Exampled in any one of Examples 413-422.

Example 425 is a non-transitory machine-readable storage medium with instructions stored thereon, the instructions when executed by the machine to cause the machine to: receive, from a vehicle behavior model, a classification of a first change in motion for a vehicle; receive, from a regression model, a prediction of a likelihood of the first change in motion for the vehicle occurring during a given time interval; compare the classification from the vehicle behavior model to the prediction from the regression model; determine that the first change in motion for the vehicle is a fault based, at least in part, on the comparing; and send a first control signal to affect the first change in motion for the vehicle based on determining that the first change in motion for the vehicle is a fault.

Example 426 includes the subject matter of Example 425, where the instructions are further executable to cause the machine to: receive, at the vehicle behavior model, a first control event that indicates the first change in motion for the vehicle; and generate the classification of the first change in motion based, at least in part, on the first control event and data from one or more sensors in the vehicle.

Example 427 includes the subject matter of Example 425, where the instructions are further executable to cause the machine to: receive, at the regression model, a first control event; obtain one or more variables indicative of current conditions; and generate the prediction based, at least in part, on the first control event and the one or more variables indicative of the current conditions.

Example 428 includes the subject matter of Example 427, where the current conditions include at least one environmental condition.

Example 429 includes the subject matter of any one of Examples 427-428, where the current conditions include at least one vehicle condition.

Example 430 includes the subject matter of any one of Examples 427-429, where at least one of the one or more variables are obtained from one or more remote sources.

Example 431 includes the subject matter of any one of Examples 426-430, where the first control event is associated with a braking actuator, a steering actuator, or a throttle actuator.

Example 432 includes the subject matter of any ones of Example 425-431, where the vehicle behavior model is a Hidden Markov Model (HMM) algorithm.

Example 433 includes the subject matter of any one of Examples 425-432, where the regression model is an expectation maximization (EM) algorithm.

Example 434 includes the subject matter of any one of Examples 425-433, where the fault is one of a malicious attack on a computing system of the vehicle or a failure in the computing system of the vehicle.

Example 435 is a method including: identifying an instance of one or more objects from data captured by one or more sensors of a vehicle; performing a categorization of the instance by checking the instance against a plurality of categories and assigning at least one category of the plurality of categories to the instance; determining a score based on the categorization of the instance; selecting a data handling policy for the instance based at least in part on the score; and processing the instance based on the determined data handling policy.

Example 436 includes the subject matter of Example 435, where a category of the plurality of categories is a category indicating a frequency of detection of the one or more objects.

Example 437 includes the subject matter of Example 436, where the frequency of detection indicates a frequency of detection of the one or more objects within a particular context associated with the capture of one or more underlying sensor data streams of the instance.

Example 438 includes the subject matter of any of Examples 435-437, where a category of the plurality of categories is a category indicating a level of diversity among multiple detected objects of the instance.

Example 439 includes the subject matter of any of Examples 435-438, where a category of the plurality of categories is a category indicating a noise level of one or more underlying data streams for the instance.

Example 440 includes the subject matter of any of Examples 435-439, further including:

determining the score based on the categorization of the instance and a context of the data captured by the one or more sensors.

Example 441 includes the subject matter of any of Examples 435-440, where the selected data handling policy is to delete the instance and one or more underlying sensor data streams for the instance.

Example 442 includes the subject matter of any of Examples 435-440, where the selected data handling policy is to save the instance and one or more underlying sensor data streams for the instance for use in training an object detection model.

Example 443 includes the subject matter of any of Examples 435-440, where the selected data handling policy is to generate synthetic data including at least one image that is the same type of object as a detected image of the instance, the synthetic data for use in training an object detection model.

Example 444 includes the subject matter of any of Examples 435-443, further including providing categorization results to a machine learning training model and providing parameters of the machine learning training model to a computing system of a vehicle for use in categorization of objects detected by the vehicle.

Example 445 is a vehicle including a computing system for performing one or more of the methods of Examples 435-444.

Example 446 is a system including means for performing one or more of the methods of Examples 435-444.

Example 447 is a machine readable medium including instructions, where the instructions when executed realize an apparatus or implement a method as Exampled in any one of Examples 435-444.

Example 448 is a non-transitory machine-readable storage medium with instructions stored thereon, the instructions when executed by the machine to cause the machine to: identify an instance of one or more objects from data captured by one or more sensors of a vehicle; perform a categorization of the instance by checking the instance against a plurality of categories and assigning at least one category of the plurality of categories to the instance; determine a score based on the categorization of the instance; select a data handling policy for the instance based at least in part on the score; and process the instance based on the determined data handling policy.

Example 449 includes the subject matter of Example 448, where a category of the plurality of categories is a category indicating a frequency of detection of the one or more objects.

Example 450 includes the subject matter of Example 449, where the frequency of detection indicates a frequency of detection of the one or more objects within a particular context associated with the capture of one or more underlying sensor data streams of the instance.

Example 451 includes the subject matter of any of Examples 448-450, where a category of the plurality of categories is a category indicating a level of diversity among multiple detected objects of the instance.

Example 452 includes the subject matter of any of Examples 448-451, where a category of the plurality of categories is a category indicating a noise level of one or more underlying data streams for the instance.

Example 453 includes the subject matter of any of Examples 448-452, where the instructions are further executable to cause the machine to determine the score based on the categorization of the instance and a context of the data captured by the one or more sensors.

Example 454 includes the subject matter of any of Examples 448-453, where the selected data handling policy is to delete the instance and one or more underlying sensor data streams for the instance.

Example 455 includes the subject matter of any of Examples 448-454, where the selected data handling policy is to save the instance and one or more underlying sensor data streams for the instance for use in training an object detection model.

Example 456 includes the subject matter of any of Examples 448-454, where the selected data handling policy is to generate synthetic data including at least one image that is the same type of object as a detected image of the instance, the synthetic data for use in training an object detection model.

Example 457 includes the subject matter of any of Examples 448-456, where the instructions are further executable to cause the machine to provide categorization results to a machine learning training model and providing parameters of the machine learning training model to a computing system of a vehicle for use in categorization of objects detected by the vehicle.

Example 458 is a method including: identifying a context associated with sensor data captured from one or more sensors of a vehicle, where the context includes a plurality of text keywords; determining that additional image data for the context is desired; and providing the plurality of text keywords of the context to a synthetic image generator, the synthetic image generator to generate a plurality of images based on the plurality of text keywords of the context.

Example 459 includes the subject matter of Example 458, where the synthetic image generator is a generative adversarial network.

Example 460 includes the subject matter of any of Examples 458-459, where determining that additional image data for the context is desired includes determining a level of commonness of the context indicating an amount of available sensor data associated with the context.

Example 461 includes the subject matter of any of Examples 458-460, where determining that additional image data for the context is desired includes analyzing results from a database to determine whether the identified context is realistic.

Example 462 includes the subject matter of Example 461, where the database includes a compilation of data obtained from a variety of internet data sources.

Example 463 includes the subject matter of any of Examples 461-462, where the database includes a plurality of text keywords extracted from image data obtained from a variety of internet data sources.

Example 464 includes the subject matter of any of Examples 458-463, further including in response to determining a level of commonness of the context, determining, whether the context is realistic, where the determination of whether the context is realistic is determined independently of the determination of the level of commonness of the context.

Example 465 includes the subject matter of any of Examples 458-464, where providing the plurality of text keywords of the context to the synthetic image generator is performed in response to determining that the context has a low level of commonness but is still realistic.

Example 466 includes the subject matter of any of Examples 458-465, where the plurality of text keywords describes an operating environment of the vehicle.

Example 467 includes the subject matter of any of Examples 458-466, where the sensor data associated with the identified context and the plurality of images generated by the synthetic image generator are added to a dataset for use in training one or more models for the vehicle.

Example 468 is a system including means for performing one or more of the methods of Examples 458-467.

Example 469 is a machine readable medium including instructions, where the instructions when executed realize an apparatus or implement a method as Exampled in any one of Examples 458-467.

Example 470 is a non-transitory machine-readable storage medium with instructions stored thereon, the instructions when executed by the machine to cause the machine to: identify a context associated with sensor data captured from one or more sensors of a vehicle, where the context includes a plurality of text keywords; determine that additional image data for the context is desired; and provide the plurality of text keywords of the context to a synthetic image generator, the synthetic image generator to generate a plurality of images based on the plurality of text keywords of the context.

Example 471 includes the subject matter of Example 470, where the synthetic image generator is a generative adversarial network.

Example 472 includes the subject matter of any of Examples 470-471, where determining that additional image data for the context is desired includes determining a level of commonness of the context indicating an amount of available sensor data associated with the context.

Example 473 includes the subject matter of any of Examples 470-472, where determining that additional image data for the context is desired includes analyzing results from a database to determine whether the identified context is realistic.

Example 474 includes the subject matter of Example 473, where the database includes a compilation of data obtained from a variety of internet data sources.

Example 475 includes the subject matter of any of Examples 473-474, where the database includes a plurality of text keywords extracted from image data obtained from a variety of internet data sources.

Example 476 includes the subject matter of any of Examples 470-475, where the instructions when executed further cause the machine, in response to determining a level of commonness of the context, determine, whether the context is realistic, where the determination of whether the context is realistic is determined independently of the determination of the level of commonness of the context.

Example 477 includes the subject matter of any of Examples 470-476, where providing the plurality of text keywords of the context to the synthetic image generator is performed in response to determining that the context has a low level of commonness but is still realistic.

Example 478 includes the subject matter of any of Examples 470-477, where the plurality of text keywords describes an operating environment of the vehicle.

Example 479 includes the subject matter of any of Examples 470-478, where the sensor data associated with the identified context and the plurality of images generated by the synthetic image generator are added to a dataset for use in training one or more models for the vehicle.

Example 480 is a method including: accessing a benign data set including a plurality of image samples or a plurality of audio samples, the samples of the benign data set having known labels; generating a simulated attack data set including a plurality of adversarial samples, where the adversarial samples are generated by performing a plurality of different attack methods to samples of the benign data set; and training a machine learning classification model using the adversarial samples, the known labels, and a plurality of benign samples.

Example 481 includes the subject matter of Example 480, further including providing the trained machine learning classification model to a vehicle for use in classifying samples detected by one or more sensors of the vehicle.

Example 482 includes the subject matter of any of Examples 480-481, where the plurality of different attack methods include one or more of a fast gradient sign method, an iterative fast gradient sign method, a deep fool method, or universal adversarial perturbation.

Example 483 includes the subject matter of any of Example 480-482, further including generating the simulated attack data set by performing the plurality of different attack methods according to a ratio based on an expected attack ratio.

Example 484 includes the subject matter of any of Examples 480-483, where generating the simulated attack data set includes utilizing a plurality of different attack strengths for at least one attack method of the plurality of different attack methods.

Example 485 includes the subject matter of any of Examples 480-484, further including measuring classification accuracy for a plurality of ratios of benign samples to adversarial samples to determine an optimal ratio of benign samples to adversarial samples to use during the training.

Example 486 includes the subject matter of any of Examples 480-485, further including imposing a penalty during the training for misclassification of an adversarial sample.

Example 487 includes the subject matter of any of Examples 480-486, where the benign data set includes a collection of image samples.

Example 488 includes the subject matter of any of Examples 480-486, where the benign data set includes a collection of audio samples.

Example 489 is a system including means for performing one or more of the methods of Examples 480-488.

Example 490 is a machine readable medium including instructions, where the instructions when executed realize an apparatus or implement a method as Exampled in any one of Examples 480-488.

Example 491 is a non-transitory machine-readable storage medium with instructions stored thereon, the instructions when executed by the machine to cause the machine to: access a benign data set including a plurality of image samples or a plurality of audio samples, the samples of the benign data set having known labels; generate a simulated attack data set including a plurality of adversarial samples, where the adversarial samples are generated by performing a plurality of different attack storage mediums to samples of the benign data set; and train a machine learning classification model using the adversarial samples, the known labels, and a plurality of benign samples.

Example 492 includes the subject matter of Example 491, where the instructions when executed further cause the machine to provide the trained machine learning classification model to a vehicle for use in classifying samples detected by one or more sensors of the vehicle.

Example 493 includes the subject matter of any of Examples 491-492, where the plurality of different attack storage mediums include one or more of a fast gradient sign storage medium, an iterative fast gradient sign storage medium, a deep fool storage medium, or universal adversarial perturbation.

Example 494 includes the subject matter of any of Example 491-493, where the instructions when executed further cause the machine to generate the simulated attack data set by performing the plurality of different attack storage mediums according to a ratio based on an expected attack ratio.

Example 495 includes the subject matter of any of Examples 491-494, where generating the simulated attack data set includes utilizing a plurality of different attack strengths for at least one attack storage medium of the plurality of different attack storage mediums.

Example 496 includes the subject matter of any of Examples 491-495, where the instructions when executed further cause the machine to measure classification accuracy for a plurality of ratios of benign samples to adversarial samples to determine an optimal ratio of benign samples to adversarial samples to use during the training.

Example 497 includes the subject matter of any of Examples 491-496, where the instructions when executed further cause the machine to impose a penalty during the training for misclassification of an adversarial sample.

Example 498 includes the subject matter of any of Examples 491-497, where the benign data set includes a collection of image samples.

Example 499 includes the subject matter of any of Examples 491-497, where the benign data set includes a collection of audio samples.

Example 500 is a method including: classifying, by a linear classifier, input samples from a vehicle; classifying, by a non-linear classifier, the input samples from the vehicle; detecting a change in an accuracy of the linear classifier; and triggering at least one action in response to the change in accuracy of the linear classifier.

Example 501 includes the subject matter of Example 500, where the triggered at least one action includes a retraining of the linear classifier and the non-linear classifier.

Example 502 includes the subject matter of any of Examples 500-501, where the triggered at least one action includes a generation of synthetic data based on recently classified input samples.

Example 503 includes the subject matter of any of Examples 500-502, where the triggered at least one action includes a determination of whether an attack has been made on the input samples.

Example 504 includes the subject matter of any of Examples 500-503, where the triggered at least one action includes a random sampling of recently classified input samples, the random sampling to be used in retraining the linear classifier and non-linear classifier, the other samples of the recently classified input samples to not be used in the retraining.

Example 505 includes the subject matter of any of Examples 500-504, where detecting the change in the accuracy of the linear classifier includes detecting that the accuracy of the linear classifier has fallen below a threshold value.

Example 506 includes the subject matter of any of Examples 500-505, further including performing object detection based at least in part on classifying the input samples using the non-linear classifier.

Example 507 includes the subject matter of any of Examples 500-506, where the input samples are collected from one or more sensors of the vehicle.

Example 508 is a system including means for performing one or more of the methods of Examples 500-507.

Example 509 is a machine readable medium including instructions, where the instructions when executed realize an apparatus or implement a method as Exampled in any one of Examples 500-507.

Example 510 is a non-transitory machine-readable storage medium with instructions stored thereon, the instructions when executed by the machine to cause the machine to: classify, by a linear classifier, input samples from a vehicle; classify, by a non-linear classifier, the input samples from the vehicle; detect a change in an accuracy of the linear classifier; and trigger at least one action in response to the change in accuracy of the linear classifier.

Example 511 includes the subject matter of Example 510, where the triggered at least one action includes a retraining of the linear classifier and the non-linear classifier.

Example 512 includes the subject matter of any of Examples 510-511, where the triggered at least one action includes a generation of synthetic data based on recently classified input samples.

Example 513 includes the subject matter of any of Examples 510-512, where the triggered at least one action includes a determination of whether an attack has been made on the input samples.

Example 514 includes the subject matter of any of Examples 510-513, where the triggered at least one action includes a random sampling of recently classified input samples, the random sampling to be used in retraining the linear classifier and non-linear classifier, the other samples of the recently classified input samples to not be used in the retraining.

Example 515 includes the subject matter of any of Examples 510-514, where detecting the change in the accuracy of the linear classifier includes detecting that the accuracy of the linear classifier has fallen below a threshold value.

Example 516 includes the subject matter of any of Examples 510-515, where the instructions when executed further cause the machine to perform object detection based at least in part on classifying the input samples using the non-linear classifier.

Example 517 includes the subject matter of any of Examples 510-516, where the input samples are collected from one or more sensors of the vehicle.

Example 518 is a method including: generating a first set of one or more control signals in response to human input to a vehicle; in response to determining that the first set of one or more control signals would cause an unacceptable acceleration: identifying an acceptable acceleration; converting the acceptable acceleration to a second set of one or more control signals; and providing the second set of one or more control signals to a vehicle actuation system in place of the first set of one or more control signals.

Example 519 includes the subject matter of Example 518, further including: receiving a range of acceptable acceleration values; and identifying the acceptable acceleration from the range of acceptable acceleration values.

Example 520 includes the subject matter of Example 519, where the range of acceptable acceleration values is determined in accordance with an accident avoidance mathematical model.

Example 521 includes the subject matter of any of Examples 519-520, where the range of acceptable acceleration values is determined in accordance with a Responsibility-Sensitive Safety model.

Example 522 includes the subject matter of any of Examples 518-521, where determining that the one or more control signals would cause an unacceptable acceleration includes converting the one or more control signals to an expected acceleration using a machine learning model.

Example 523 includes the subject matter of any of Examples 518-522, where converting the acceptable acceleration to a second set of one or more control signals includes converting the acceptable acceleration based on context associated with the vehicle, where the context is determined based on input received via one or more sensors of the vehicle.

Example 524 includes the subject matter of Example 523, where the input received via one or more sensors of the vehicle is indicative of one or more of road conditions, weather conditions, tire conditions, or road layout.

Example 525 includes the subject matter of any of Examples 518-524, where converting the acceptable acceleration to a second set of one or more control signals includes converting the acceptable acceleration based on a weight of the vehicle.

Example 526 includes the subject matter of any of Examples 518-525, where identifying an acceptable acceleration including selecting an acceptable acceleration, based on policy information provided by driver of the vehicle, from a range of acceptable accelerations.

Example 527 includes the subject matter of any of Examples 518-526, further including: generating a third set of one or more control signals in response to human input to the vehicle; and in response to determining that the third set of one or more control signals would cause an acceptable acceleration, providing the third set of one or more control signals to the vehicle actuation system unchanged.

Example 528 is a system including means for performing one or more of the methods of Examples 518-527.

Example 529 is a non-transitory machine-readable storage medium with instructions stored thereon, the instructions when executed by the machine to cause the machine to: generate a first set of one or more control signals in response to human input to a vehicle; in response to determining that the first set of one or more control signals would cause an unacceptable acceleration: identify an acceptable acceleration; convert the acceptable acceleration to a second set of one or more control signals; and provide the second set of one or more control signals to a vehicle actuation system in place of the first set of one or more control signals.

Example 530 includes the subject matter of Example 529, where the instructions when executed further cause the machine to: receive a range of acceptable acceleration values; and identify the acceptable acceleration from the range of acceptable acceleration values.

Example 531 includes the subject matter of Example 530, where the range of acceptable acceleration values is determined in accordance with an accident avoidance mathematical model.

Example 532 includes the subject matter of any of Examples 530-531, where the range of acceptable acceleration values is determined in accordance with a Responsibility-Sensitive Safety model.

Example 533 includes the subject matter of any of Examples 529-532, where determining that the one or more control signals would cause an unacceptable acceleration includes converting the one or more control signals to an expected acceleration using a machine learning model.

Example 534 includes the subject matter of any of Examples 529-533, where converting the acceptable acceleration to a second set of one or more control signals includes converting the acceptable acceleration based on context associated with the vehicle, where the context is determined based on input received via one or more sensors of the vehicle.

Example 535 includes the subject matter of Example 534, where the input received via one or more sensors of the vehicle is indicative of one or more of road conditions, weather conditions, tire conditions, or road layout.

Example 536 includes the subject matter of any of Examples 529-535, where converting the acceptable acceleration to a second set of one or more control signals includes converting the acceptable acceleration based on a weight of the vehicle.

Example 537 includes the subject matter of any of Examples 529-536, where identifying an acceptable acceleration including selecting an acceptable acceleration, based on policy information provided by driver of the vehicle, from a range of acceptable accelerations.

Example 538 includes the subject matter of any of Examples 529-537, where the instructions when executed further cause the machine to: generate a third set of one or more control signals in response to human input to the vehicle; and in response to determining that the third set of one or more control signals would cause an acceptable acceleration, provide the third set of one or more control signals to the vehicle actuation system unchanged.

Example 539 is a method including: determining, by a computing system of a vehicle, a signal quality metric based on sensor data and a context of the sensor data; based on the signal quality metric, determining a likelihood of safety associated with a handoff of control of the vehicle; and preventing handoff or initiating handoff of control of the vehicle based on the likelihood of safety.

Example 540 includes the subject matter of Example 539, further including using a machine learning model to determine the context of the sensor data based on the sensor data.

Example 541 includes the subject matter of any of Examples 539-540, further including using a machine learning model to determine the likelihood of safety based on the signal quality metric.

Example 542 includes the subject matter of any of Examples 539-541, further including using a machine learning model to determine the signal quality metric based on the sensor data and the context of the sensor data.

Example 543 includes the subject matter of any of Examples 539-542, further including periodically determining a likelihood of safety associated with a handoff of control of the vehicle while the vehicle is controlled autonomously.

Example 544 includes the subject matter of any of Examples 539-543, further including determining the likelihood of safety associated with a handoff of control of the vehicle in response to a request from a human driver to handoff control of the vehicle.

Example 545 includes the subject matter of any of Examples 539-544, further including determining the likelihood of safety associated with a handoff of control of the vehicle in response to the vehicle entering an area in which high definition maps of the area are unavailable to the vehicle.

Example 546 includes the subject matter of any of Examples 539-545, where the signal quality metric indicates at least in part a signal to noise ratio of the sensor data.

Example 547 includes the subject matter of any of Examples 539-546, where the signal quality metric indicates at least in part a resolution of the sensor data.

Example 548 is a system including means for performing one or more of the methods of Examples 539-547.

Example 549 is a non-transitory machine-readable storage medium with instructions stored thereon, the instructions when executed by the machine to cause the machine to: determine, by a computing system of a vehicle, a signal quality metric based on sensor data and a context of the sensor data; based on the signal quality metric, determine a likelihood of safety associated with a handoff of control of the vehicle; and prevent handoff or initiating handoff of control of the vehicle based on the likelihood of safety.

Example 550 includes the subject matter of Example 549, where the instructions when executed further cause the machine to use a machine learning model to determine the context of the sensor data based on the sensor data.

Example 551 includes the subject matter of any of Examples 549-550, where the instructions when executed further cause the machine to use a machine learning model to determine the likelihood of safety based on the signal quality metric.

Example 552 includes the subject matter of any of Examples 549-551, where the instructions when executed further cause the machine to use a machine learning model to determine the signal quality metric based on the sensor data and the context of the sensor data.

Example 553 includes the subject matter of any of Examples 549-552, where the instructions when executed further cause the machine to periodically determine a likelihood of safety associated with a handoff of control of the vehicle while the vehicle is controlled autonomously.

Example 554 includes the subject matter of any of Examples 549-553, where the instructions when executed further cause the machine to determine the likelihood of safety associated with a handoff of control of the vehicle in response to a request from a human driver to handoff control of the vehicle.

Example 555 includes the subject matter of any of Examples 549-554, where the instructions when executed further cause the machine to determine the likelihood of safety associated with a handoff of control of the vehicle in response to the vehicle entering an area in which high definition maps of the area are unavailable to the vehicle.

Example 556 includes the subject matter of any of Examples 549-555, where the signal quality metric indicates at least in part a signal to noise ratio of the sensor data.

Example 557 includes the subject matter of any of Examples 549-556, where the signal quality metric indicates at least in part a resolution of the sensor data.

Example 558 is a method including: collecting sensor data from at least one sensor located inside of a vehicle; analyzing the sensor data to determine a physical state of a person inside the vehicle; and generating a handoff decision based at least in part on the physical state of the person, the handoff decision indicating whether the person is expected to be able to safely operate the vehicle.

Example 559 includes the subject matter of Example 558, further including: identifying historical driving data of the person inside the vehicle; and generating the handoff decision further based on the historical driving data of the person.

Example 560 includes the subject matter of any of Examples 558-559, further including: analyzing sensor data to determine a context indicating conditions outside of the vehicle; and generating a handoff decision further based on the context.

Example 561 includes the subject matter of any of Examples 558-560, where the physical state of the person inside the vehicle is based at least in part on sensor data including image data of the person inside of the vehicle.

Example 562 includes the subject matter of any of Examples 558-561, where the physical state of the person inside the vehicle is based at least in part on sensor data including audio data of the person inside of the vehicle.

Example 563 includes the subject matter of any of Examples 558-562, where the physical state of the person inside the vehicle is based at least in part on sensor data including temperature data of the person inside of the vehicle.

Example 564 includes the subject matter of any of Examples 558-563, where the physical state of the person inside the vehicle is based at least in part on sensor data including pressure data from a tactile sensor.

Example 565 includes the subject matter of any of Examples 558-564, where the physical state of the person inside the vehicle is based at least in part on data received from a health tracking device worn by the person.

Example 566 includes the subject matter of any of Examples 558-565, further including: determining, based on the sensor data, a specific activity being performed by the person inside the vehicle; and where the physical state of the person inside the vehicle is based at least in part on the determined activity.

Example 567 includes the subject matter of any of Examples 558-566, further including: preprocessing audio data of the sensor data to isolate sounds caused by the person inside of the vehicle or one or more passengers; and where the physical state of the person inside the vehicle is based at least in part on the preprocessed audio data.

Example 568 includes the subject matter of any of Examples 558-567, where the sensor data includes one or more of the following: media being played in the vehicle; a light level inside the vehicle; an amount of interactivity between the person and one or more dashboard controls; window aperture levels, a state of an in-cabin temperature control system; or a state of a phone of the person.

Example 569 includes the subject matter of any of Examples 558-568, where the physical state of the person is performed using a machine learning algorithm using the sensor data as input.

Example 570 includes the subject matter of any of Examples 558-569, further including using a machine learning algorithm to generate the handoff decision.

Example 571 is a system including means for performing one or more of the methods of Examples 558-570.

Example 572 is a non-transitory machine-readable storage medium with instructions stored thereon, the instructions when executed by the machine to cause the machine to: collect sensor data from at least one sensor located inside of a vehicle; analyze the sensor data to determine a physical state of a person inside the vehicle; and generate a handoff decision based at least in part on the physical state of the person, the handoff decision indicating whether the person is expected to be able to safely operate the vehicle.

Example 573 includes the subject matter of Example 572, where the instructions when executed further cause the machine to: identify historical driving data of the person inside the vehicle; and generate the handoff decision further based on the historical driving data of the person.

Example 574 includes the subject matter of any of Examples 572-573, where the instructions when executed further cause the machine to: analyze sensor data to determine a context indicating conditions outside of the vehicle; and generate a handoff decision further based on the context.

Example 575 includes the subject matter of any of Examples 572-574, where the physical state of the person inside the vehicle is based at least in part on sensor data including image data of the person inside of the vehicle.

Example 576 includes the subject matter of any of Examples 572-575, where the physical state of the person inside the vehicle is based at least in part on sensor data including audio data of the person inside of the vehicle.

Example 577 includes the subject matter of any of Examples 572-576, where the physical state of the person inside the vehicle is based at least in part on sensor data including temperature data of the person inside of the vehicle.

Example 578 includes the subject matter of any of Examples 572-577, where the physical state of the person inside the vehicle is based at least in part on sensor data including pressure data from a tactile sensor.

Example 579 includes the subject matter of any of Examples 572-578, where the physical state of the person inside the vehicle is based at least in part on data received from a health tracking device worn by the person.

Example 580 includes the subject matter of any of Examples 572-579, where the instructions when executed further cause the machine to: determine, based on the sensor data, a specific activity being performed by the person inside the vehicle; and where the physical state of the person inside the vehicle is based at least in part on the determined activity.

Example 581 includes the subject matter of any of Examples 572-580, where the instructions when executed further cause the machine to: preprocess audio data of the sensor data to isolate sounds caused by the person inside of the vehicle or one or more passengers; and where the physical state of the person inside the vehicle is based at least in part on the preprocessed audio data.

Example 582 includes the subject matter of any of Examples 572-581, where the sensor data includes one or more of the following: media being played in the vehicle; a light level inside the vehicle; an amount of interactivity between the person and one or more dashboard controls; window aperture levels, a state of an in-cabin temperature control system; or a state of a phone of the person.

Example 583 includes the subject matter of any of Examples 572-582, where the physical state of the person is performed using a machine learning algorithm using the sensor data as input.

Example 584 includes the subject matter of any of Examples 572-283, where the instructions when executed further cause the machine to use a machine learning algorithm to generate the handoff decision.

Example 585 is a method including: operating, by a controller of an autonomous vehicle, the autonomous vehicle in an autonomous driving mode; receiving a request to take over control of the autonomous vehicle by an entity other than the controller; prompting the requesting entity for credentials in response to receiving the request to take over control of the autonomous vehicle; receiving input in response to the prompt; and allowing the request to take over control of the autonomous vehicle in response to authenticating the requesting entity based on the received input.

Example 586 includes the subject matter of Example 585, where prompting the requesting entity for credentials includes prompting the requesting entity to provide a biometric for authentication.

Example 587 includes the subject matter of Example 586, where the biometric includes one or more of a fingerprint, voice sample for voice recognition, and face sample for facial recognition.

Example 588 includes the subject matter of any one of Examples 585-587, where the requesting entity includes a person inside the autonomous vehicle.

Example 589 includes the subject matter of any one of Examples 585-587, where the requesting entity includes a person remote from the autonomous vehicle.

Example 590 includes the subject matter of any one of Examples 585-587, where the requesting entity includes one or more other autonomous vehicles proximate to the autonomous vehicle.

Example 591 is a system including means for performing one or more of the methods of Examples 585-590.

Example 592 is a method including: operating an autonomous vehicle in a manual mode of operation, where the autonomous vehicle is controlled based on human input; receiving sensor data from a plurality of sensors inside the autonomous vehicle; detecting, based on an analysis of the sensor data, that the human input is unsafe; and operating the autonomous vehicle in an autonomous mode of operation in response to detecting the unsafe human input.

Example 593 includes the subject matter of Example 592, where detecting that the human input is unsafe includes one or more of determining that the human providing the input is distracted, determining that the human providing the input is impaired, and determining that the human providing the input is unconscious.

Example 594 is a system including means for performing one or more of the methods of Examples 592-593.

Example 595 is a non-transitory machine-readable storage medium with instructions stored thereon, the instructions when executed by the machine to cause the machine to: operate, by a controller of an autonomous vehicle, the autonomous vehicle in an autonomous driving mode; receive a request to take over control of the autonomous vehicle by an entity other than the controller; prompt the requesting entity for credentials in response to receiving the request to take over control of the autonomous vehicle; receive input in response to the prompt; and allow the request to take over control of the autonomous vehicle in response to authenticating the requesting entity based on the received input.

Example 596 includes the subject matter of Example 595, where prompting the requesting entity for credentials includes prompting the requesting entity to provide a biometric for authentication.

Example 597 includes the subject matter of Example 596, where the biometric includes one or more of a fingerprint, voice sample for voice recognition, and face sample for facial recognition.

Example 598 includes the subject matter of any one of Examples 595-597, where the requesting entity includes a person inside the autonomous vehicle.

Example 599 includes the subject matter of any one of Examples 595-597, where the requesting entity includes a person remote from the autonomous vehicle.

Example 600 includes the subject matter of any one of Examples 595-597, where the requesting entity includes one or more other autonomous vehicles proximate to the autonomous vehicle.

Example 601 is a non-transitory machine-readable storage medium with instructions stored thereon, the instructions when executed by the machine to cause the machine to: operate an autonomous vehicle in a manual mode of operation, where the autonomous vehicle is controlled based on human input; receive sensor data from a plurality of sensors inside the autonomous vehicle; detect, based on an analysis of the sensor data, that the human input is unsafe; and operate the autonomous vehicle in an autonomous mode of operation in response to detecting the unsafe human input.

Example 602 includes the subject matter of Example 601, where detecting that the human input is unsafe includes one or more of determining that the human providing the input is distracted, determining that the human providing the input is impaired, and determining that the human providing the input is unconscious.

Example 603 is a method including: operating, by a control system of an autonomous vehicle, the autonomous vehicle in an autonomous mode of operation based on sensor data obtained from a plurality of sensors coupled to the autonomous vehicle; detecting, by the control system of the autonomous vehicle, a takeover request by a passenger of the autonomous vehicle; determining, by the control system of the autonomous vehicle based on the sensor data, whether the requested takeover is safe; and blocking the requested takeover in response to a determination that the requested takeover is unsafe.

Example 604 includes the subject matter of Example 603, further including modifying the autonomous mode of operation in response to a determination that the request takeover is unsafe.

Example 605 includes the subject matter of Example 604, further including: prompting the passenger for input in response to the determination; and receiving input from the passenger in response to the prompt; where modifying the autonomous mode of operation is based on the received input.

Example 606 includes the subject matter of Example 603, where the plurality of sensors coupled to the autonomous vehicle include interior sensors inside the autonomous vehicle, and determining whether the requested takeover is safe is based sensor data received from the interior sensors.

Example 607 includes the subject matter of Example 606, where the interior sensors include one or more of a camera and a microphone.

Example 608 includes the subject matter of any one of Examples 603-607, further including allowing the takeover request in response to a determination that the requested takeover is regular.

Example 609 includes the subject matter of any one of Examples 603-607, further including blocking the takeover request in response to a determination that the requested takeover is unsafe.

Example 610 includes the subject matter of any one of Examples 603-609, where the determination of whether the requested takeover is unsafe is performed during a sensing/perception phase of an autonomous driving pipeline.

Example 611 includes the subject matter of any one of Examples 603-609, where blocking the requested takeover is performed during an act/control phase of an autonomous driving pipeline.

Example 612 includes the subject matter of Example 605, where modification of the autonomous mode of operation is performed during a plan phase of an autonomous driving pipeline.

Example 613 is a system including means for performing one or more of the methods of Examples 603-612.

Example 614 is a non-transitory machine-readable storage medium with instructions stored thereon, the instructions when executed by the machine to cause the machine to: operate, by a control system of an autonomous vehicle, the autonomous vehicle in an autonomous mode of operation based on sensor data obtained from a plurality of sensors coupled to the autonomous vehicle; detect, by the control system of the autonomous vehicle, a takeover request by a passenger of the autonomous vehicle; determine, by the control system of the autonomous vehicle based on the sensor data, whether the requested takeover is safe; and block the requested takeover in response to a determination that the requested takeover is unsafe.

Example 615 includes the subject matter of Example 614, where the instructions when executed further cause the machine to modify the autonomous mode of operation in response to a determination that the request takeover is unsafe.

Example 616 includes the subject matter of Example 615, where the instructions when executed further cause the machine to: prompt the passenger for input in response to the determination; and receive input from the passenger in response to the prompt; where modifying the autonomous mode of operation is based on the received input.

Example 617 includes the subject matter of Example 614, where the plurality of sensors coupled to the autonomous vehicle include interior sensors inside the autonomous vehicle, and determining whether the requested takeover is safe is based sensor data received from the interior sensors.

Example 618 includes the subject matter of Example 617, where the interior sensors include one or more of a camera and a microphone.

Example 619 includes the subject matter of any one of Examples 614-618, where the instructions when executed further cause the machine to allow the takeover request in response to a determination that the requested takeover is regular.

Example 620 includes the subject matter of any one of Examples 614-618, where the instructions when executed further cause the machine to block the takeover request in response to a determination that the requested takeover is unsafe.

Example 621 includes the subject matter of any one of Examples 614-620, where the determination of whether the requested takeover is unsafe is performed during a sensing/perception phase of an autonomous driving pipeline.

Example 622 includes the subject matter of any one of Examples 614-620, where blocking the requested takeover is performed during an act/control phase of an autonomous driving pipeline.

Example 623 includes the subject matter of Example 616, where modification of the autonomous mode of operation is performed during a plan phase of an autonomous driving pipeline.

Example 624 is a method including: monitoring, by a supervisory system, at least one subsystem of an autonomous vehicle; and initiating, by the supervisory system, a change of an autonomy level of the autonomous vehicle from a first autonomous level to a second autonomous level based on the monitoring of the at least one subsystem.

Example 625 includes the subject matter of Example 624, further including communicating the change of the autonomy level of the autonomous vehicle to a remote surveillance system.

Example 626 includes the subject matter of any of Examples 624-625, further including recording a history of the autonomy level and a sensor status over time.

Example 627 includes the subject matter of any of Examples 624-626, where the at least one subsystem includes a sensor subsystem and the change of the autonomy level is based at least in part on a change to the sensor subsystem.

Example 628 includes the subject matter of any one or more of Examples 624-627, where the at least one subsystem includes a planning subsystem and the change of the autonomy level is based at least in part on a change to the planning subsystem.

Example 628 includes the subject matter of any one or more of Examples 624-628, where the at least one subsystem includes an execution subsystem and the change of the autonomy level is based at least in part on a change to the execution subsystem.

Example 630 includes the subject matter of any one or more of Examples 624-629, where the supervisory system is to monitor the functional assurance of the at least one subsystem.

Example 631 includes the subject matter of any one or more of Examples 624-630, where the comprehensive cognitive supervisory system monitors the quality assurance of the at least one subsystem.

Example 632 is a system including means for performing one or more of the methods of Examples 624-631.

Example 633 is a non-transitory machine-readable storage medium with instructions stored thereon, the instructions when executed by the machine to cause the machine to: monitor, by a supervisory system, at least one subsystem of an autonomous vehicle; and initiate, by the supervisory system, a change of an autonomy level of the autonomous vehicle from a first autonomous level to a second autonomous level based on the monitoring of the at least one subsystem.

Example 634 includes the subject matter of Example 633, where the instructions when executed further cause the machine to communicate the change of the autonomy level of the autonomous vehicle to a remote surveillance system.

Example 635 includes the subject matter of any of Examples 633-634, where the instructions when executed further cause the machine to record a history of the autonomy level and a sensor status over time.

Example 636 includes the subject matter of any of Examples 633-635, where the at least one subsystem includes a sensor subsystem and the change of the autonomy level is based at least in part on a change to the sensor subsystem.

Example 637 includes the subject matter of any one or more of Examples 633-636, where the at least one subsystem includes a planning subsystem and the change of the autonomy level is based at least in part on a change to the planning subsystem.

Example 638 includes the subject matter of any one or more of Examples 633-637, where the at least one subsystem includes an execution subsystem and the change of the autonomy level is based at least in part on a change to the execution subsystem.

Example 639 includes the subject matter of any one or more of Examples 633-638, where the supervisory system is to monitor the functional assurance of the at least one subsystem.

Example 640 includes the subject matter of any one or more of Examples 633-639, where the comprehensive cognitive supervisory system monitors the quality assurance of the at least one subsystem.

Example 641 is a method, including: determining a system failure of an autonomous vehicle; determining that an autonomous level of the autonomous vehicle can be reduced to a first level that does not require a driver takeover; alerting the driver that the autonomy level is going to be reduced to the first level; and reducing the autonomy level to the first level.

Example 642 includes the subject matter of Example 641, further including: determining that there is an additional system failure of the autonomous vehicle; determining that the autonomous level can be reduced to a second level; alerting the driver that the autonomy level is going to be reduced to the second level; and reducing the autonomy level to the second level.

Example 643 includes the subject matter of any one or more of Examples 641-642, further including confirming the engagement of the driver.

Example 644 includes the subject matter of Example 643, where confirming the engagement of the driver includes monitoring the driver.

Example 645 includes the subject matter of any one or more of Examples 641-644, further including: determining that there is an additional system failure of the autonomous vehicle; determining that the autonomy of the vehicle must be deactivated; and attempting to handoff to the driver in response to determining that the autonomy of the vehicle must be inactivated.

Example 646 includes the subject matter of Example 645, further including determining if the handoff was successful.

Example 647 includes the subject matter of Example 646, further including inactivating the autonomy of the vehicle if the handoff was successful.

Example 648 includes the subject matter of Example 646, further including activating an emergency system if the handoff was not successful.

Example 649 includes the subject matter of Example 648, where the emergency system is to bring the autonomous vehicle to a safe stop.

Example 650 is a system including means to perform any one or more of Examples 641-649.

Example 651 is a non-transitory machine-readable storage medium with instructions stored thereon, the instructions when executed by the machine to cause the machine to: determine a system failure of an autonomous vehicle; determine that an autonomous level of the autonomous vehicle can be reduced to a first level that does not require a driver takeover; alert the driver that the autonomy level is going to be reduced to the first level; and reduce the autonomy level to the first level.

Example 652 includes the subject matter of Example 651, where the instructions when executed further cause the machine to: determine that there is an additional system failure of the autonomous vehicle; determining that the autonomous level can be reduced to a second level; alerting the driver that the autonomy level is going to be reduced to the second level; and reducing the autonomy level to the second level.

Example 653 includes the subject matter of any one or more of Examples 651-652, where the instructions when executed further cause the machine to confirm the engagement of the driver.

Example 654 includes the subject matter of Example 653, where confirming the engagement of the driver includes monitoring the driver.

Example 655 includes the subject matter of any one or more of Examples 651-654, where the instructions when executed further cause the machine to: determine that there is an additional system failure of the autonomous vehicle; determine that the autonomy of the vehicle must be deactivated; and attempt to handoff to the driver in response to determining that the autonomy of the vehicle must be inactivated.

Example 656 includes the subject matter of Example 655, where the instructions when executed further cause the machine to determine if the handoff was successful.

Example 657 includes the subject matter of Example 656, where the instructions when executed further cause the machine to deactivate the autonomy of the vehicle if the handoff was successful.

Example 658 includes the subject matter of Example 656, where the instructions when executed further cause the machine to activate an emergency system if the handoff was not successful.

Example 659 includes the subject matter of Example 658, where the emergency system is to bring the autonomous vehicle to a safe stop.

Example 660 is a method including: providing an extracted feature from image data to a first-class prediction model and to a second-class prediction model; determining a difference between an output of the first-class prediction model and an output of the second-class prediction model; and assigning an anomaly class to the extracted feature based on the difference between the output of the first-class prediction model and the output of the second-class prediction model.

Example 661 includes the subject matter of Example 660, where the first-class prediction model is a baseline prediction model including a Gated Recurrent Unit (GRU) or a Long Short Term Memory networks (LSTM) neural network.

Example 662 includes the subject matter of any of Examples 660-661, where the second-class prediction model is based on a LSTM neural network.

Example 663 includes the subject matter of any of Examples 660-662, further including assigning a second anomaly class to a second extracted feature based on a second difference between a second output of the first-class prediction model and a second output of the second-class prediction model.

Example 664 includes the subject matter of any of Examples 660-663, further including determining an anomaly threshold during training of the first-class prediction model and the second-class prediction model based on differences between outputs of the first-class prediction model and the second-class prediction model.

Example 665 includes the subject matter of any of Examples 660-664, further including outputting a prediction confidence associated with the anomaly class assigned to the extracted feature.

Example 666 is a system including means for performing one or more of the methods of Examples 660-665.

Example 667 is a non-transitory machine-readable storage medium with instructions stored thereon, the instructions when executed by the machine to cause the machine to: provide an extracted feature from image data to a first-class prediction model and to a second-class prediction model; determine a difference between an output of the first-class prediction model and an output of the second-class prediction model; and assign an anomaly class to the extracted feature based on the difference between the output of the first-class prediction model and the output of the second-class prediction model.

Example 668 includes the subject matter of Example 667, where the first-class prediction model is a baseline prediction model including a Gated Recurrent Unit (GRU) or a Long Short Term Memory networks (LSTM) neural network.

Example 669 includes the subject matter of any of Examples 667-668, where the second-class prediction model is based on a LSTM neural network.

Example 670 includes the subject matter of any of Examples 667-669, where the instructions when executed further cause the machine to assign a second anomaly class to a second extracted feature based on a second difference between a second output of the first-class prediction model and a second output of the second-class prediction model.

Example 671 includes the subject matter of any of Examples 667-670, where the instructions when executed further cause the machine to determine an anomaly threshold during training of the first-class prediction model and the second-class prediction model based on differences between outputs of the first-class prediction model and the second-class prediction model.

Example 672 includes the subject matter of any of Examples 667-671, where the instructions when executed further cause the machine to output a prediction confidence associated with the anomaly class assigned to the extracted feature.

Example 673 is a method for restricting the autonomy level of a vehicle on a portion of a road, including: determining a safety score for a vehicle; determining a road score for at least a portion of a road; comparing the road score to the safety score; and determining the acceptable autonomy level of the vehicle on the at least a portion of the road.

Example 674 includes the subject matter of Example 673, where determining the acceptable autonomy level of the vehicle includes determining to allow the vehicle to be driven autonomously if the safety score is greater than or equal to the road score.

Example 675 includes the subject matter of any one or more of Examples 673-674, where the safety score is determined using multiple weighted elements.

Example 676 includes the subject matter of any one or more of Examples 673-675, where the road score is determined using multiple weighted elements.

Example 677 includes the subject matter of any one or more of Examples 673-676, where the road score is dynamically calculated to consider the current conditions of the at least a portion of the road.

Example 678 includes the subject matter of any one or more of Examples 673-677, where the safety score is calculated dynamically to consider the current condition of the vehicle.

Example 679 includes the subject matter of any one or more of Examples 673-678, further including displaying the road score for at least a portion of a road on a map user interface.

Example 680 includes the subject matter of any one or more of Examples 673-679, where the road score is determined using a weighted value for weather conditions.

Example 681 includes the subject matter of any one or more of Examples 673-680, where the road score is determined using a weighted value for the condition of the at least a portion of the road.

Example 682 includes the subject matter of any one or more of Examples 673-681, where the safety score is determined using a weighted value for the sensors of the vehicle.

Example 683 includes the subject matter of any one or more of Examples 673-682, where the safety score is determined using a weighted value for one or more autonomous driving algorithms implemented by the vehicle.

Example 684 includes the subject matter of any one or more of Examples 673-683, where calculating the safety score includes conducting testing on the vehicle.

Example 685 is a system including means to perform any one or more of Examples 673-684.

Example 686 is a non-transitory machine-readable storage medium with instructions stored thereon, the instructions when executed by the machine to cause the machine to: determine a safety score for a vehicle; determine a road score for at least a portion of a road; compare the road score to the safety score; and determine the acceptable autonomy level of the vehicle on the at least a portion of the road.

Example 687 includes the subject matter of Example 686, where determining the acceptable autonomy level of the vehicle includes determining to allow the vehicle to be driven autonomously if the safety score is greater than or equal to the road score.

Example 688 includes the subject matter of any one or more of Examples 686-687, where the safety score is determined using multiple weighted elements.

Example 689 includes the subject matter of any one or more of Examples 686-688, where the road score is determined using multiple weighted elements.

Example 690 includes the subject matter of any one or more of Examples 686-689, where the road score is dynamically calculated to consider the current conditions of the at least a portion of the road.

Example 691 includes the subject matter of any one or more of Examples 686-690, where the safety score is calculated dynamically to consider the current condition of the vehicle.

Example 692 includes the subject matter of any one or more of Examples 686-691, where the instructions when executed further cause the machine to display the road score for at least a portion of a road on a map user interface.

Example 693 includes the subject matter of any one or more of Examples 686-692, where the road score is determined using a weighted value for weather conditions.

Example 694 includes the subject matter of any one or more of Examples 686-693, where the road score is determined using a weighted value for the condition of the at least a portion of the road.

Example 695 includes the subject matter of any one or more of Examples 686-694, where the safety score is determined using a weighted value for the sensors of the vehicle.

Example 696 includes the subject matter of any one or more of Examples 686-695, where the safety score is determined using a weighted value for one or more autonomous driving algorithms implemented by the vehicle.

Example 697 includes the subject matter of any one or more of Examples 686-696, where calculating the safety score includes conducting testing on the vehicle.

Example 698 is a method, the method including: receiving an image captured by an image capturing device associated with a vehicle; detecting a face in the captured image; generating an input image for a first neural network of a Generative Adversarial Network (GAN), the input image depicting the face detected in the captured image; generating a disguised image based, at least in part, on applying the first neural network to the input image, where a gaze attribute of the face depicted in the input image is included in the disguised image, and where one or more other attributes of the face depicted in the input image are modified in the disguised image.

Example 699 includes the subject matter of Example 698, where the first neural network is a generative model, and where the GAN includes a second neural network that is a discriminative model.

Example 700 includes the subject matter of any one of Examples 698-699, where the second neural network is a convolutional neural network to classify disguised images produced by the first neural network as real or fake.

Example 701 includes the subject matter of any one of Examples 698-700, where the first neural network is an inverse convolutional neural network that generates the disguised image.

Example 702 includes the subject matter of any one of Examples 698-701, further including estimating locations of one or more facial components of the face detected in the captured image, where the input image is generated based, at least in part, on the detected image and the locations of the one or more facial components.

Example 703 includes the subject matter of any one of Examples 698-702, where the one or more other attributes that are modified in the disguised image include age and gender.

Example 704 includes the subject matter of any one of Examples 698-702, where the one or more other attributes that are modified in the disguised image are selected from a group of attributes including age, gender, hair color, baldness, bangs, eye glasses, makeup, skin color, and mouth expression.

Example 705 includes the subject matter of any one of Examples 698-704, where the first neural network generates the disguised image based, at least in part, on a target domain that indicates the one or more other attributes to modify in the face detected in the captured image.

Example 706 includes the subject matter of any one of Examples 705, where the GAN model is preconfigured with the target domain based on the GAN model generating disguised images from test images and a facial recognition model being unable to identify at least a threshold number of the disguised images.

Example 707 includes the subject matter of any one of Examples 698-706, where an emotion attribute in the face detected in the captured image is included in the disguised image.

Example 708 includes the subject matter of Example 707, further including sending the disguised image to a data collection system associated with the vehicle, where the data collection system is to detect an emotion based on the emotion attribute in the disguised image.

Example 709 includes the subject matter of any one of Examples 698-708, further including providing the disguised image to a computer vision application of the vehicle, where the computer vision application is to detect a gaze based on a gaze attribute in the disguised image and identify a trajectory of a human represented in the disguised image based on the detected gaze.

Example 710 is a system including means for performing one or more of the methods of Examples 698-709.

Example 711 is a non-transitory machine-readable storage medium with instructions stored thereon, the instructions when executed by the machine to cause the machine to: receive an image captured by an image capturing device associated with a vehicle; detect a face in the captured image; generate an input image for a first neural network of a Generative Adversarial Network (GAN), the input image depicting the face detected in the captured image; generate a disguised image based, at least in part, on applying the first neural network to the input image, where a gaze attribute of the face depicted in the input image is included in the disguised image, and where one or more other attributes of the face depicted in the input image are modified in the disguised image.

Example 712 includes the subject matter of Example 711, where the first neural network is a generative model, and where the GAN includes a second neural network that is a discriminative model.

Example 713 includes the subject matter of any one of Examples 1-712, where the second neural network is a convolutional neural network to classify disguised images produced by the first neural network as real or fake.

Example 714 includes the subject matter of any one of Examples 711-713, where the first neural network is an inverse convolutional neural network that generates the disguised image.

Example 715 includes the subject matter of any one of Examples 711-714, where the instructions when executed further cause the machine to estimate locations of one or more facial components of the face detected in the captured image, where the input image is generated based, at least in part, on the detected image and the locations of the one or more facial components.

Example 716 includes the subject matter of any one of Examples 711-715, where the one or more other attributes that are modified in the disguised image include age and gender.

Example 717 includes the subject matter of any one of Examples 711-715, where the one or more other attributes that are modified in the disguised image are selected from a group of attributes including age, gender, hair color, baldness, bangs, eye glasses, makeup, skin color, and mouth expression.

Example 718 includes the subject matter of any one of Examples 711-717, where the first neural network generates the disguised image based, at least in part, on a target domain that indicates the one or more other attributes to modify in the face detected in the captured image.

Example 719 includes the subject matter of any one of Examples 718, where the GAN model is preconfigured with the target domain based on the GAN model generating disguised images from test images and a facial recognition model being unable to identify at least a threshold number of the disguised images.

Example 720 includes the subject matter of any one of Examples 711-719, where an emotion attribute in the face detected in the captured image is included in the disguised image.

Example 721 includes the subject matter of Example 720, where the instructions when executed further cause the machine to send the disguised image to a data collection system associated with the vehicle, where the data collection system is to detect an emotion based on the emotion attribute in the disguised image.

Example 722 includes the subject matter of any one of Examples 711-721, where the instructions when executed further cause the machine to provide the disguised image to a computer vision application of the vehicle, where the computer vision application is to detect a gaze based on a gaze attribute in the disguised image and identify a trajectory of a human represented in the disguised image based on the detected gaze.

Example 723 is a method including: receiving a dataset including data collected by a vehicle, where one or more tags are associated with the dataset; determining a first policy to be applied to the dataset based on the one or more tags; determining whether the first policy is designated as a lazy policy; based on determining that the first policy is designated as a lazy policy, marking the dataset for on-demand processing without applying the first policy to the dataset; subsequent to marking the dataset for on-demand processing, receiving a first request for the dataset; and applying the first policy to the dataset in response to receiving the first request for the dataset.

Example 724 includes the subject matter of Example 723, where applying the first policy to the dataset includes at least one of obscuring one or more faces in an image in the dataset, obscuring one or more license plates in an image in the dataset, anonymizing personal identifying information in the dataset, or modifying location information in the dataset.

Example 725 includes the subject matter of any one of Examples 723-724, further including: determining a geographic location of the vehicle; and associating a tag to the dataset, the tag containing information indicating the geographic location of the vehicle.

Example 726 includes the subject matter of any one of Examples 723-725, further including: using a machine learning model to identify at least one of the one or more tags to associate with the dataset.

Example 727 includes the subject matter of any one of Examples 723-726, where the dataset is received at a policy enforcement engine in one of the vehicle or a cloud processing system remote from the vehicle.

Example 728 includes the subject matter of any one of Examples 723-727, further including: determining a second policy to be applied to the dataset based on the one or more tags; determining whether the second policy is designated as a lazy policy; and based on determining that the second policy is not designated as a lazy policy, applying the second policy to the dataset.

Example 729 includes the subject matter of Example 728, where applying the second policy to the dataset includes obscuring, anonymizing, or modifying at least some data in the dataset.

Example 730 includes the subject matter of any one of Examples 723-729, further including: receiving a second dataset including second data collected by the vehicle, where one or more second tags are associated with the second dataset; determining a second policy to be applied to the second dataset based on the one or more second tags, where the second policy is designated as a lazy policy; and based on determining that a contextual policy is applicable to the second dataset, overriding the lazy policy designation and applying the contextual policy to the second dataset.

Example 731 includes the subject matter of Example 730, where the contextual policy includes at least one action required by the second policy.

Example 732 includes the subject matter of any one of Examples 723-731, further including: based upon receiving the first request for the dataset, determining a current location of the vehicle; determining whether the current location of the vehicle is associated with different regulations than a prior location associated with the dataset; based on determining the current location of the vehicle is associated with different regulations, attach an updated tag to the dataset, the updated tag including information indicating the current location of the vehicle; determining that a new policy is to be applied to the dataset based, at least in part, on the updated tag; and applying the new policy to the dataset.

Example 733 includes the subject matter of any one of Examples 723-732, further including: receiving a third dataset including third data collected by the vehicle, where one or more third tags are associated with the third dataset; determining a third policy to be applied to the third dataset based on the one or more third tags; and based on determining that the third policy is not designated as a lazy policy, applying the third policy to the third dataset; and marking the third dataset as policy-compliant based on determining that no policy to be applied to the third dataset is designated as a lazy policy and on applying, to the third dataset, each policy determined to be applicable to the third dataset.

Example 734 includes the subject matter of any one of Examples 723-733, further including: receiving a second request for the dataset subsequent to receiving the first request for the dataset; and applying a fourth policy to the dataset in response to receiving the second request for the dataset, where the one or more tags are associated with the fourth policy in response to a regulation change applicable to the data in the dataset.

Example 735 is a system including means for performing one or more of the methods of Examples 723-734.

Example 736 is a non-transitory machine-readable storage medium with instructions stored thereon, the instructions when executed by the machine to cause the machine to: receive a dataset including data collected by a vehicle, where one or more tags are associated with the dataset; determine a first policy to be applied to the dataset based on the one or more tags; determine whether the first policy is designated as a lazy policy; based on determining that the first policy is designated as a lazy policy, mark the dataset for on-demand processing without applying the first policy to the dataset; subsequent to marking the dataset for on-demand processing, receive a first request for the dataset; and apply the first policy to the dataset in response to receiving the first request for the dataset.

Example 737 includes the subject matter of Example 736, where applying the first policy to the dataset includes at least one of obscuring one or more faces in an image in the dataset, obscuring one or more license plates in an image in the dataset, anonymizing personal identifying information in the dataset, or modifying location information in the dataset.

Example 738 includes the subject matter of any one of Examples 736-737, where the instructions when executed further cause the machine to: determine a geographic location of the vehicle; and associate a tag to the dataset, the tag containing information indicating the geographic location of the vehicle.

Example 739 includes the subject matter of any one of Examples 736-738, where the instructions when executed further cause the machine to use a machine learning model to identify at least one of the one or more tags to associate with the dataset.

Example 740 includes the subject matter of any one of Examples 736-739, where the dataset is received at a policy enforcement engine in one of the vehicle or a cloud processing system remote from the vehicle.

Example 741 includes the subject matter of any one of Examples 736-740, where the instructions when executed further cause the machine to: determine a second policy to be applied to the dataset based on the one or more tags; determine whether the second policy is designated as a lazy policy; and based on determining that the second policy is not designated as a lazy policy, apply the second policy to the dataset.

Example 742 includes the subject matter of Example 741, where applying the second policy to the dataset includes obscuring, anonymizing, or modifying at least some data in the dataset.

Example 743 includes the subject matter of any one of Examples 736-742, where the instructions when executed further cause the machine to: receive a second dataset including second data collected by the vehicle, where one or more second tags are associated with the second dataset; determine a second policy to be applied to the second dataset based on the one or more second tags, where the second policy is designated as a lazy policy; and based on determining that a contextual policy is applicable to the second dataset, override the lazy policy designation and applying the contextual policy to the second dataset.

Example 744 includes the subject matter of Example 743, where the contextual policy includes at least one action required by the second policy.

Example 745 includes the subject matter of any one of Examples 736-744, where the instructions when executed further cause the machine to: based upon receiving the first request for the dataset, determine a current location of the vehicle; determine whetherthe current location of the vehicle is associated with different regulations than a prior location associated with the dataset; based on determining the current location of the vehicle is associated with different regulations, attach an updated tag to the dataset, the updated tag including information indicating the current location of the vehicle; determine that a new policy is to be applied to the dataset based, at least in part, on the updated tag; and apply the new policy to the dataset.

Example 746 includes the subject matter of any one of Examples 736-745, where the instructions when executed further cause the machine to: receive a third dataset including third data collected by the vehicle, where one or more third tags are associated with the third dataset; determine a third policy to be applied to the third dataset based on the one or more third tags; and based on determining that the third policy is not designated as a lazy policy, apply the third policy to the third dataset; and mark the third dataset as policy-compliant based on determining that no policy to be applied to the third dataset is designated as a lazy policy and on applying, to the third dataset, each policy determined to be applicable to the third dataset.

Example 747 includes the subject matter of any one of Examples 736-746, where the instructions when executed further cause the machine to: receive a second request for the dataset subsequent to receiving the first request for the dataset; and apply a fourth policy to the dataset in response to receiving the second request for the dataset, where the one or more tags are associated with the fourth policy in response to a regulation change applicable to the data in the dataset.

Example 748 is a method including: receiving sensor data from a sensor coupled to an autonomous vehicle; applying a digital signature to the sensor data; adding a new block to a block-based topology, the new block including the sensor data and the digital signature; verifying the digital signature; and communicating the block to a logic unit of the autonomous vehicle based on the digital signature being verified.

Example 749 includes the subject matter of Example 748, where the block-based topology is a permission-less blockchain.

Example 750 includes the subject matter of Example 748, where the digital signature is based on an elliptic curve cryptographic (ECC) protocol.

Example 751 includes the subject matter of any one of Examples 748-750, where verifying the block includes verifying a time stamp of the sensor data using a time constraint of a consensus protocol.

Example 752 is a system including means for performing one or more of the methods of Examples 748-751.

Example 753 is a method including: receiving, at a first autonomous vehicle, a block of a block-based topology, the block including sensor data from a sensor coupled to a second autonomous vehicle and a digital signature associated with the sensor data; verifying the digital signature; and communicating the block to a logic unit of the first autonomous vehicle in response to verifying the digital signature.

Example 754 includes the subject matter of Example 753, where the block-based topology includes one or more of a blockchain or a dynamic acyclic graph (DAG).

Example 755 includes the subject matter of Example 753, where the block-based topology is a permissioned blockchain.

Example 756 includes the subject matter of any one of Examples 753-755, where the digital signature is verified using a secret key generated based on an ephemeral public key.

Example 757 includes the subject matter of Example 756, where the ephemeral public key is based on an elliptic curve Diffie Hellman exchange.

Example 758 includes the subject matter of any one of Examples 753-757, further including extracting one or more smart contracts from the block.

Example 759 is a system including means for performing one or more of the methods of Examples 753-758.

Example 760 is a non-transitory machine-readable storage medium with instructions stored thereon, the instructions when executed by the machine to cause the machine to: receive sensor data from a sensor coupled to an autonomous vehicle; apply a digital signature to the sensor data; add a new block to a block-based topology, the new block including the sensor data and the digital signature; verify the digital signature; and communicate the block to a logic unit of the autonomous vehicle based on the digital signature being verified.

Example 761 includes the subject matter of Example 760, where the block-based topology is a permission-less blockchain.

Example 762 includes the subject matter of Example 761, where the digital signature is based on an elliptic curve cryptographic (ECC) protocol.

Example 763 includes the subject matter of any one of Examples 760-762, where verifying the block includes verifying a time stamp of the sensor data using a time constraint of a consensus protocol.

Example 764 is a non-transitory machine-readable storage medium with instructions stored thereon, the instructions when executed by the machine to cause the machine to: receive, at a first autonomous vehicle, a block of a block-based topology, the block including sensor data from a sensor coupled to a second autonomous vehicle and a digital signature associated with the sensor data; verify the digital signature; and communicate the block to a logic unit of the first autonomous vehicle in response to verifying the digital signature.

Example 765 includes the subject matter of Example 764, where the block-based topology includes one or more of a blockchain or a dynamic acyclic graph (DAG).

Example 766 includes the subject matter of Example 764, where the block-based topology is a permissioned blockchain.

Example 767 includes the subject matter of any one of Examples 764-766, where the digital signature is verified using a secret key generated based on an ephemeral public key.

Example 768 includes the subject matter of Example 767, where the ephemeral public key is based on an elliptic curve Diffie Hellman exchange.

Example 769 includes the subject matter of any one of Examples 764-768, where the instructions when executed further cause the machine to extract one or more smart contracts from the block.

Example 770 is a method including: obtaining sensor data sampled by a plurality of sensors of a vehicle; determining a context associated with the sampled sensor data; and based on the context, determine one or both of a group of sampling rates for the sensors of the vehicle or a group of weights for the sensors to be used to perform fusion of the sensor data.

Example 771 includes the subject matter of Example 770, further including providing the context as an output of a machine learning algorithm that receives the sampled sensor data as input.

Example 772 includes the subject matter of Example 771, where the machine learning algorithm is trained using data sets as ground truth, where each data set includes a context, sampling rates for the plurality of sensors, and a safety outcome.

Example 773 includes the subject matter of any of Examples 770-772, further including providing the group of weights for the sensors using a fusion-context dictionary that receives the context from the plurality of sensors as an input and outputs the group of weights.

Example 774 includes the subject matter of Example 773, where the fusion-context dictionary is provided by training a machine learning algorithm using context information and object locations as ground truth.

Example 775 includes the subject matter of any of Examples 770-774, where the context is used to determine the group of sampling rates for the sensors of the vehicle and the group of weights for the sensors to be used to perform fusion of the sensor data.

Example 776 includes the subject matter of any of Examples 770-775, further including combining samples from the plurality of the sensors based on the group of weights.

Example 777 includes the subject matter of any of Examples 770-776, further including determining the group of weights based on the context using a reinforcement learning model.

Example 778 includes the subject matter of Example 777, where the reinforcement learning model is trained using an environment of sensor samples and contexts.

Example 779 includes the subject matter of any of Examples 777-778, where the reinforcement learning model is trained using a reward based on object tracking accuracy and minimization of power consumption.

Example 780 is a system including means for performing one or more of the methods of Examples 770-779.

Example 781 is a non-transitory machine-readable storage medium with instructions stored thereon, the instructions when executed by the machine to cause the machine to: obtain sensor data sampled by a plurality of sensors of a vehicle; determine a context associated with the sampled sensor data; and based on the context, determine one or both of a group of sampling rates for the sensors of the vehicle or a group of weights for the sensors to be used to perform fusion of the sensor data.

Example 782 includes the subject matter of Example 781, where the instructions when executed further cause the machine to provide the context as an output of a machine learning algorithm that receives the sampled sensor data as input.

Example 783 includes the subject matter of Example 782, where the machine learning algorithm is trained using data sets as ground truth, where each data set includes a context, sampling rates for the plurality of sensors, and a safety outcome.

Example 784 includes the subject matter of any of Examples 781-783, where the instructions when executed further cause the machine to provide the group of weights for the sensors using a fusion-context dictionary that receives the context from the plurality of sensors as an input and outputs the group of weights.

Example 785 includes the subject matter of Example 784, where the fusion-context dictionary is provided by training a machine learning algorithm using context information and object locations as ground truth.

Example 786 includes the subject matter of any of Examples 781-785, where the context is used to determine the group of sampling rates for the sensors of the vehicle and the group of weights for the sensors to be used to perform fusion of the sensor data.

Example 787 includes the subject matter of any of Examples 781-786, where the instructions when executed further cause the machine to combine samples from the plurality of the sensors based on the group of weights.

Example 788 includes the subject matter of any of Examples 781-787, where the instructions when executed further cause the machine to determine the group of weights based on the context using a reinforcement learning model.

Example 789 includes the subject matter of Example 788, where the reinforcement learning model is trained using an environment of sensor samples and contexts.

Example 790 includes the subject matter of any of Examples 788-789, where the reinforcement learning model is trained using a reward based on object tracking accuracy and minimization of power consumption.

Example 791 is a method including: receiving, at a subject autonomous vehicle from a traffic vehicle, modulated light signals; sampling the modulated light signals; demodulating the sampled light signals to obtain position information for the traffic vehicle; and using the position information of the traffic vehicle in a sensor fusion process of the subject.

Example 792 includes the subject matter of Example 791, where the modulated light signals are sampled at a particular frequency.

Example 793 includes the subject matter of Example 792, where the particular frequency is selected proactively.

Example 794 includes the subject matter of Example 792, where the particular frequency is selected based on events.

Example 795 includes the subject matter of Example 791, where the modulated light signals are sampled in response to detection of the traffic vehicle's presence.

Example 796 includes the subject matter of Example 791, where the position information includes geocoordinates of the traffic vehicle in a Degree Minute and Second format.

Example 797 includes the subject matter of Example 791, where the modulated light is demodulated to further obtain size information for the traffic vehicle, the size information including one or more of a length, width, or height of the traffic vehicle.

Example 798 includes the subject matter of any one of Examples 791-797, where the modulated light is transmitted according to a Li-Fi protocol.

Example 799 includes the subject matter of any one of Examples 791-797, where the modulated light signals are modulated according to On-Off Keying (OOK), Amplitude Shift Keying (ASK), Variable pulse position modulation (VPPM), or Color-Shift Keying (CSK).

Example 800 includes the subject matter of any one of Examples 791-797, where the modulated light includes one or more of visible light having a wavelength between 375 nm and 780 nm, infrared light, and ultraviolet light.

Example 801 is a system including means for performing one or more of the methods of Examples 791-800.

Example 802 is a non-transitory machine-readable storage medium with instructions stored thereon, the instructions when executed by the machine to cause the machine to: receive, at a subject autonomous vehicle from a traffic vehicle, modulated light signals; sample the modulated light signals; demodulate the sampled light signals to obtain position information for the traffic vehicle; and use the position information of the traffic vehicle in a sensor fusion process of the subject.

Example 803 includes the subject matter of Example 802, where the modulated light signals are sampled at a particular frequency.

Example 804 includes the subject matter of Example 803, where the particular frequency is selected proactively.

Example 805 includes the subject matter of Example 803, where the particular frequency is selected based on events.

Example 806 includes the subject matter of Example 802, where the modulated light signals are sampled in response to detection of the traffic vehicle's presence.

Example 807 includes the subject matter of Example 802, where the position information includes geocoordinates of the traffic vehicle in a Degree Minute and Second format.

Example 808 includes the subject matter of Example 802, where the modulated light is demodulated to further obtain size information for the traffic vehicle, the size information including one or more of a length, width, or height of the traffic vehicle.

Example 809 includes the subject matter of any one of Examples 802-808, where the modulated light is transmitted according to a Li-Fi protocol.

Example 810 includes the subject matter of any one of Examples 802-808, where the modulated light signals are modulated according to On-Off Keying (OOK), Amplitude Shift Keying (ASK), Variable pulse position modulation (VPPM), or Color-Shift Keying (CSK).

Example 811 includes the subject matter of any one of Examples 802-808, where the modulated light includes one or more of visible light having a wavelength between 375 nm and 780 nm, infrared light, and ultraviolet light.

Example 812 is a method including: obtaining sensor data from a sensor coupled to an autonomous vehicle; applying a sensor abstraction process to the sensor data to produce abstracted scene data, where the sensor abstraction process includes one or more of: applying a response normalization process to the sensor data; applying a warp process to the sensor data; and applying a filtering process to the sensor data; and using the abstracted scene data in a perception phase of a control process for the autonomous vehicle.

Example 813 includes the subject matter of Example 812, where the sensor data includes first sensor data from a first sensor and second sensor data from a second sensor, where the first sensor and second sensor are of the same sensor type, and applying the sensor abstraction process includes one or more of: applying a respective response normalization process to each of the first sensor data and the second sensor data; applying a respective warping process to each of the first sensor data and the second sensor data; and applying a filtering process to a combination of the first sensor data and the second sensor data.

Example 814 includes the subject matter of Example 812, where the sensor data includes first sensor data from a first sensor and second sensor data from a second sensor, where the first sensor and second sensor are different sensor types, and applying the sensor abstraction process includes one or more of: applying a respective response normalization process to each of the first sensor data and the second sensor data; applying a respective warping process to each of the first sensor data and the second sensor data; and applying a respective filtering process to each of the first sensor data and the second sensor data to produce first abstracted scene data corresponding to the first sensor data and second abstracted scene data corresponding to the second sensor data; and the method further includes applying a fuse process to the first and second abstracted scene data; where the fused first and second abstracted scene data are used in the perception phase.

Example 815 includes the subject matter of any one of Examples 812-814, where applying a response normalization process includes one or more of normalizing pixel values of an image, normalizing a bit depth of an image, normalizing a color space of an image, and normalizing a range of depth or distance values in LIDAR data.

Example 816 includes the subject matter of any one of Examples 812-814, where applying a response normalization process is based on a model of the sensor response.

Example 817 includes the subject matter of any one of Examples 812-814, where applying a warping process includes performing one or more of a spatial upscaling operation, a downscaling operation, a correction process for geometric effects associated with the sensor, and a correction process for motion of the sensor.

Example 818 includes the subject matter of any one of Examples 812-814, where applying a warping process is based on sensor configuration information.

Example 819 includes the subject matter of any one of Examples 812-814, where applying a filtering process includes applying one or more of a Kalman filter, a variant of the Kalman filter, a particle filter, a histogram filter, an information filter, a Bayes filter, and a Gaussian filter.

Example 820 includes the subject matter of any one of Examples 812-814, where applying a filtering process is based on one or more of a model for the sensor and a scene model.

Example 821 includes the subject matter of any one of Examples 812-814, where applying a filtering process includes determining a validity of the sensor data and discarding the sensor data in response to determining that the sensor data is invalid.

Example 822 is a system including means for performing one or more of the methods of Examples 812-821.

Example 823 is a non-transitory machine-readable storage medium with instructions stored thereon, the instructions when executed by the machine to cause the machine to: obtain sensor data from a sensor coupled to an autonomous vehicle; apply a sensor abstraction process to the sensor data to produce abstracted scene data, where the sensor abstraction process includes one or more of: applying a response normalization process to the sensor data; applying a warp process to the sensor data; and applying a filtering process to the sensor data; and use the abstracted scene data in a perception phase of a control process for the autonomous vehicle.

Example 824 includes the subject matter of Example 823, where the sensor data includes first sensor data from a first sensor and second sensor data from a second sensor, where the first sensor and second sensor are of the same sensor type, and applying the sensor abstraction process includes one or more of: applying a respective response normalization process to each of the first sensor data and the second sensor data; applying a respective warping process to each of the first sensor data and the second sensor data; and applying a filtering process to a combination of the first sensor data and the second sensor data.

Example 825 includes the subject matter of Example 823, where the sensor data includes first sensor data from a first sensor and second sensor data from a second sensor, where the first sensor and second sensor are different sensor types, and applying the sensor abstraction process includes one or more of: applying a respective response normalization process to each of the first sensor data and the second sensor data; applying a respective warping process to each of the first sensor data and the second sensor data; and applying a respective filtering process to each of the first sensor data and the second sensor data to produce first abstracted scene data corresponding to the first sensor data and second abstracted scene data corresponding to the second sensor data; and the storage medium further includes applying a fuse process to the first and second abstracted scene data; where the fused first and second abstracted scene data are used in the perception phase.

Example 825 includes the subject matter of any one of Examples 823-825, where applying a response normalization process includes one or more of normalizing pixel values of an image, normalizing a bit depth of an image, normalizing a color space of an image, and normalizing a range of depth or distance values in LIDAR data.

Example 827 includes the subject matter of any one of Examples 823-825, where applying a response normalization process is based on a model of the sensor response.

Example 828 includes the subject matter of any one of Examples 823-825, where applying a warping process includes performing one or more of a spatial upscaling operation, a downscaling operation, a correction process for geometric effects associated with the sensor, and a correction process for motion of the sensor.

Example 829 includes the subject matter of any one of Examples 823-825, where applying a warping process is based on sensor configuration information.

Example 830 includes the subject matter of any one of Examples 823-825, where applying a filtering process includes applying one or more of a Kalman filter, a variant of the Kalman filter, a particle filter, a histogram filter, an information filter, a Bayes filter, and a Gaussian filter.

Example 831 includes the subject matter of any one of Examples 823-825, where applying a filtering process is based on one or more of a model for the sensor and a scene model.

Example 832 includes the subject matter of any one of Examples 823-825, where applying a filtering process includes determining a validity of the sensor data and discarding the sensor data in response to determining that the sensor data is invalid.

Example 833 is a method including: capturing first image data by a first sensor of a vehicle, the first image data having a first resolution; using a machine learning model, transforming the first image data into second image data having a second resolution, where the second resolution is higher than the first resolution; and performing object detection operations for the vehicle based on the second image data.

Example 834 includes the subject matter of Example 833, where the first sensor of the vehicle includes a camera.

Example 835 includes the subject matter of Example 833, where the first sensor of the vehicle includes a LIDAR.

Example 836 includes the subject matter of any of Examples 833-835, where the machine learning model is trained using a training set including third images captured by a second sensor and fourth images generated by distorting the third images to appear to have a lower resolution than the third images.

Example 837 includes the subject matter of Example 836 where the fourth images are generated by distorting the third images using any one or more of: applying a low-pass filter to the third images; sub-sampling the third images; downsampling the third images; injecting noise into the third images; or randomizing channels of the third images.

Example 838 includes the subject matter of any of Examples 833-836, where the machine learning model is trained using a training set including third images captured by a second sensor having the first resolution and fourth images captured by a third sensor having the second resolution.

Example 839 includes the subject matter of any of Examples 833-838, where the machine learning model includes a convolutional neural network architecture.

Example 840 includes the subject matter of any of Examples 833-839, where the machine learning model includes a generative neural network.

Example 841 is a system including means for performing one or more of the methods of Examples 833-840.

Example 842 is a method including: training an ensemble of machine learning models to perform a task of an autonomous vehicle stack, the ensemble including a first machine learning model trained using image data having a first resolution and a second machine learning model; and training a third machine learning model based at least in part on a distillation loss between fused soft prediction targets of the ensemble of machine learning models and soft prediction targets of the third machine learning model.

Example 843 includes the subject matter of Example 842, further including training the third machine learning model further based on a loss representing a difference between ground truth labels and hard prediction targets of the third machine learning model.

Example 844 includes the subject matter of any of Examples 842-843, where the image data having the first resolution is data captured by one or more LIDARs.

Example 845 includes the subject matter of any of Examples 842-843, where the image data having the first resolution is data captured by one or more cameras.

Example 846 includes the subject matter of any of Examples 842-845, where the third machine learning model is trained using image data having a second resolution, the second resolution lower than the first resolution.

Example 847 includes the subject matter of any of Examples 842-846, where the third machine learning model is trained using image data captured by one or more cameras.

Example 848 includes the subject matter of any of Examples 842-846, where the third machine learning model is trained using image data captured by one or more LIDARs.

Example 849 includes the subject matter of any of Examples 842-848, where the third machine learning model is a combination of a fourth machine learning model trained using image data captured by one or more LIDARs and a fifth machine learning model trained using image data captured by one or more cameras.

Example 850 is a system including means for performing one or more of the methods of Examples 842-849.

Example 851 is a non-transitory machine-readable storage medium with instructions stored thereon, the instructions when executed by the machine to cause the machine to: capture first image data by a first sensor of a vehicle, the first image data having a first resolution; use a machine learning model, transforming the first image data into second image data having a second resolution, where the second resolution is higher than the first resolution; and perform object detection operations for the vehicle based on the second image data.

Example 852 includes the subject matter of Example 851, where the first sensor of the vehicle includes a camera.

Example 853 includes the subject matter of Example 851, where the first sensor of the vehicle includes a LIDAR.

Example 854 includes the subject matter of any of Examples 851-853, where the machine learning model is trained using a training set including third images captured by a second sensor and fourth images generated by distorting the third images to appear to have a lower resolution than the third images.

Example 855 includes the subject matter of Example 854 where the fourth images are generated by distorting the third images using any one or more of: applying a low-pass filter to the third images; sub-sampling the third images; downsampling the third images; injecting noise into the third images; or randomizing channels of the third images.

Example 856 includes the subject matter of any of Examples 851-854, where the machine learning model is trained using a training set including third images captured by a second sensor having the first resolution and fourth images captured by a third sensor having the second resolution.

Example 857 includes the subject matter of any of Examples 851-855, where the machine learning model includes a convolutional neural network architecture.

Example 858 includes the subject matter of any of Examples 851-856, where the machine learning model includes a generative neural network.

Example 859 is a non-transitory machine-readable storage medium with instructions stored thereon, the instructions when executed by the machine to cause the machine to: train an ensemble of machine learning models to perform a task of an autonomous vehicle stack, the ensemble including a first machine learning model trained using image data having a first resolution and a second machine learning model; and train a third machine learning model based at least in part on a distillation loss between fused soft prediction targets of the ensemble of machine learning models and soft prediction targets of the third machine learning model.

Example 860 includes the subject matter of Example 859, further including training the third machine learning model further based on a loss representing a difference between ground truth labels and hard prediction targets of the third machine learning model.

Example 861 includes the subject matter of any of Examples 859-860, where the image data having the first resolution is data captured by one or more LIDARs.

Example 862 includes the subject matter of any of Examples 859-860, where the image data having the first resolution is data captured by one or more cameras.

Example 863 includes the subject matter of any of Examples 859-862, where the third machine learning model is trained using image data having a second resolution, the second resolution lower than the first resolution.

Example 864 includes the subject matter of any of Examples 859-863, where the third machine learning model is trained using image data captured by one or more cameras.

Example 865 includes the subject matter of any of Examples 859-863, where the third machine learning model is trained using image data captured by one or more LIDARs.

Example 866 includes the subject matter of any of Examples 859-865, where the third machine learning model is a combination of a fourth machine learning model trained using image data captured by one or more LIDARs and a fifth machine learning model trained using image data captured by one or more cameras.

Example 867 is a system including: a memory to store sensed data; an internal sensing module of a first autonomous vehicle, the internal sensing module including circuitry to initiate communication of data sensed by the first autonomous vehicle to an external sensing module of a second autonomous vehicle; an external sensing module of the first autonomous vehicle, the external sensing module of the first autonomous vehicle to receive data from an internal sensing module of the second autonomous vehicle; and a cooperative decision maker of the first autonomous vehicle, the cooperative decision maker including circuitry to determine driving actions based on communication with a cooperative decision maker of the second autonomous vehicle.

Example 868 includes the subject matter of Example 867, where the internal sensing module of the first autonomous vehicle is to communicate with the external sensing module of the second autonomous vehicle using semantic language.

Example 869 includes the subject matter of any one or more of Examples 867-868, where the external sensing module of the first autonomous vehicle is to communicate with the internal sensing module of the second autonomous vehicle using semantic language.

Example 870 includes the subject matter of any one or more of Examples 867-869, where the cooperative decision maker of the first autonomous vehicle is to communicate with the cooperative decision maker module of the second autonomous vehicle using semantic language.

Example 871 includes the subject matter of any one or more of Examples 867-870, further including an augmented sensing module of the first autonomous vehicle.

Example 872 includes the subject matter of any one or more of Examples 867-871, where the data that is communicated between the cooperative decision maker of the first autonomous vehicle and the cooperative decision maker of the second autonomous vehicle includes data that relates to a plan of action of the first autonomous vehicle or the second autonomous vehicle.

Example 873 includes the subject matter of any one or more of Examples 867-872, where the internal sensing module of the first autonomous vehicle is to analyze the data sensed by the first autonomous vehicle.

Example 874 includes the subject matter of any one or more of Examples 867-873, further including a virtual reality perception module including circuitry to receive data sensed from one or more external agents to view the surroundings of the first autonomous vehicle using the data sensed from the one or more external agents.

Example 875 is a method including: sharing data from a first autonomous vehicle to a second autonomous vehicle using a semantic language.

Example 876 includes the subject matter of Example 875, where the data includes critical data related to one or more traffic situations.

Example 877 is a system including means to perform any one or more of Examples 875-876.

Example 878 includes the subject matter of Example 877, where the means includes at least one machine readable medium including instructions, where the instructions when executed implement am method of any one or more of Examples 875-876.

Example 879 is a method including: generating, by a control unit including circuitry, a position adjustment instruction for an image sensor of a vehicle; receiving, at the control unit, image data from the image sensor of the vehicle; detecting a location and size of a marker of the vehicle within the image data; and generating, by the control unit, a second position adjustment instruction for the image sensor of the vehicle based on the location and size of the marker of the vehicle within the image data.

Example 880 includes the subject matter of Example 879, where the position adjustment instruction specifies an angle of horizontal rotation of the image sensor of the vehicle.

Example 881 includes the subject matter of any of Examples 879-880, where the position adjustment instruction specifies an angle of vertical rotation of the image sensor of the vehicle.

Example 882 includes the subject matter of any of Examples 879-881, where the position adjustment instruction specifies a distance of horizontal movement of the image sensor of the vehicle.

Example 883 includes the subject matter of any of Examples 879-882, where the position adjustment instruction specifies a distance of vertical movement of the image sensor of the vehicle.

Example 884 includes the subject matter of any of Examples 879-883, further including generating the position adjustment instruction for the image sensor in response to a detected condition associated with the vehicle.

Example 885 includes the subject matter of any of Examples 879-884, where the position adjustment instruction is part of a series of periodic position adjustment instructions of the image sensor of the vehicle.

Example 886 includes the subject matter of any of Examples 879-885, where the marker of the vehicle is disposed on the exterior of the vehicle and is a different color than the exterior of the vehicle.

Example 887 is a system including means for performing one or more of the methods of Examples 879-886.

Example 888 is a non-transitory machine-readable storage medium with instructions stored thereon, the instructions when executed by the machine to cause the machine to: generate, by a control unit including circuitry, a position adjustment instruction for an image sensor of a vehicle; receive, at the control unit, image data from the image sensor of the vehicle; detect a location and size of a marker of the vehicle within the image data; and generate, by the control unit, a second position adjustment instruction for the image sensor of the vehicle based on the location and size of the marker of the vehicle within the image data.

Example 889 includes the subject matter of Example 888, where the position adjustment instruction specifies an angle of horizontal rotation of the image sensor of the vehicle.

Example 890 includes the subject matter of any of Examples 888-889, where the position adjustment instruction specifies an angle of vertical rotation of the image sensor of the vehicle.

Example 891 includes the subject matter of any of Examples 888-890, where the position adjustment instruction specifies a distance of horizontal movement of the image sensor of the vehicle.

Example 892 includes the subject matter of any of Examples 888-891, where the position adjustment instruction specifies a distance of vertical movement of the image sensor of the vehicle.

Example 893 includes the subject matter of any of Examples 888-892, where the instructions are further executable to cause the machine to generate the position adjustment instruction for the image sensor in response to a detected condition associated with the vehicle.

Example 894 includes the subject matter of any of Examples 888-893, where the position adjustment instruction is part of a series of periodic position adjustment instructions of the image sensor of the vehicle.

Example 895 includes the subject matter of any of Examples 888-894, where the marker of the vehicle is disposed on the exterior of the vehicle and is a different color than the exterior of the vehicle.

Example 896 is a method, including: determining at least one handoff location of an autonomous vehicle to a driver on a route; receiving information pertaining to characteristics of a driver; receiving information pertaining to a current state of attention of the driver; and determining the expected driver behavior during each of the at least one handoff locations.

Example 897 includes the subject matter of Example 896, where the information pertaining to the characteristics of the driver includes generic information.

Example 898 includes the subject matter of any one or more of Examples 896-897, where the information pertaining to the characteristics of the driver includes information specific to the driver.

Example 899 includes the subject matter of any one or more of Examples 896-898, further including determining whether the driver is ready for a handoff.

Example 900 includes the subject matter of Examples 899, further including handing over control of the vehicle to the driver in response to a determination that the driver is ready for the handoff.

Example 901 includes the subject matter of Example 899, further including computing an alternative to a handoff if the driver is not prepared for the handoff.

Example 902 includes the subject matter of Example 901, where the alternative includes finding an alternate route.

Example 903 includes the subject matter of Example 901, where the alternative includes bringing the vehicle to a stop.

Example 904 includes the subject matter of any one or more of Examples 896-903, further including updating the information pertaining to characteristics of the driver.

Example 905 is a system including means to perform any one or more of Examples 896-904.

Example 906 includes the subject matter of Example 905, where the means includes at least one machine readable medium including instructions, where the instructions when executed implement a method of any one or more of Examples 896-904.

Example 907 is a system including: an occupant activity monitoring module; a personalized occupant capability database; a generic occupant capability database; a handoff forecast module; an execution assessment and optimization module; and a handoff handling module.

Example 908 is a system, including: memory; a processor coupled to the memory; a safety module; and a score module to determine an autonomy level score of a vehicle based at least in part on the health of sensors of the vehicle.

Example 909 includes the subject matter of Example 908, further including an automation level indicator to display the autonomy level score.

Example 910 includes the subject matter of any one or more of Examples 908-909, where the at least one input includes data related to one or more sensors.

Example 911 includes the subject matter of any one or more of Examples 908-910, where the at least one input includes data related to weather conditions.

Example 912 includes the subject matter of any one or more of Examples 908-911, where the at least one input includes data related to computational power available to the vehicle.

Example 913 includes the subject matter of any one or more of Examples 908-912, where the at least one input includes data related to a vehicle customization.

Example 914 includes the subject matter of any one or more of Examples 908-913, where the at least one input includes data related to a user experience.

Example 915 is a method including: receiving a plurality of inputs related to a vehicle; weighting the plurality of inputs; combining the plurality of weighted inputs; and using the combined weighted inputs to determine an autonomous level score for the vehicle.

Example 916 includes the subject matter of Example 915, further including displaying the autonomous level score on an automation level indicator.

Example 917 includes the subject matter of any one or more of Examples 915-916, further including updating the information pertaining to characteristics of the driver.

Example 918 is a system including means to perform any one or more of Examples 915-917.

Example 919 includes the subject matter of Example 918, where the means includes at least one machine readable medium including instructions, where the instructions when executed implement any method of any one or more of Examples 915-917.

Example 920 is a method, including: determining whether the dimensions of a vehicle have been modified; obtaining new vehicle dimensions; producing a new vehicle model based on the new vehicle dimensions; and adjusting one or more algorithms of an autonomous vehicle stack based on the new vehicle model.

Example 921 includes the subject matter of Example 920, where determining whether the dimensions of a vehicle have been modified includes using a sensor to determine that a hitch has been engaged.

Example 922 includes the subject matter of any one or more of Examples 920-921, where obtaining new vehicle dimensions includes conducting an ultrasonic scan.

Example 923 includes the subject matter of any one or more of Examples 920-921, where obtaining new vehicle dimensions includes scanning the vehicle during a walkthrough.

Example 924 includes the subject matter of Example 923, where the scanning during the walkthrough includes using a smart phone.

Example 925 includes the subject matter of any one or more of Examples 920-924, further including prompting a driver for the new vehicle dimensions when the vehicle dimensions have changed.

Example 926 includes the subject matter of any one or more of Examples 920-925, further including determining an autonomous level of the vehicle after the dimensions of the vehicle have been modified.

Example 927 includes the subject matter of any one or more of Examples 920-926, further including using sensors to validate the new vehicle dimensions.

Example 928 is a system including means to perform any one or more of Examples 920-927.

Example 929 is a non-transitory machine-readable storage medium with instructions stored thereon, the instructions when executed by the machine to cause the machine to: determine whether the dimensions of a vehicle have been modified; obtain new vehicle dimensions; produce a new vehicle model based on the new vehicle dimensions; and adjust one or more algorithms of an autonomous vehicle stack based on the new vehicle model.

Example 930 includes the subject matter of Example 929, where determining whether the dimensions of a vehicle have been modified includes using a sensor to determine that a hitch has been engaged.

Example 931 includes the subject matter of any one or more of Examples 929-930, where obtaining new vehicle dimensions includes conducting an ultrasonic scan.

Example 932 includes the subject matter of any one or more of Examples 929-930, where obtaining new vehicle dimensions includes scanning the vehicle during a walkthrough.

Example 933 includes the subject matter of Example 932, where the scanning during the walkthrough includes using a smart phone.

Example 934 includes the subject matter of any one or more of Examples 929-933, where the instructions are further executable to cause the machine to prompt a driver for the new vehicle dimensions when the vehicle dimensions have changed.

Example 935 includes the subject matter of any one or more of Examples 929-934, where the instructions are further executable to cause the machine to determine an autonomous level of the vehicle after the dimensions of the vehicle have been modified.

Example 936 includes the subject matter of any one or more of Examples 929-935, where the instructions are further executable to cause the machine to use sensors to validate the new vehicle dimensions.

Example 937 includes an apparatus comprising at least one interface to receive sensor data from a plurality of sensors of a vehicle; and one or more processors to autonomously control driving of the vehicle according to a path plan based on the sensor data; determine that autonomous control of the vehicle should cease; send a handoff request to a remote computing system, wherein the remote computing system provides a remote valet service; receive driving instruction data from the remote computing system; and control driving of the vehicle based on instructions included in the driving instruction data.

Example 938 includes the example of Example 937, wherein the driving instruction data is generated based on inputs of a human user at the remote computing system.

Example 939 includes any one of Examples 937-938, the one or more processors to detect a pull-over event, wherein the vehicle is to pull-over and cease driving in association with the pull-over event, wherein the handoff request is sent in response to the pull-over event.

Example 940 includes any one of Examples 937-938, wherein determining that autonomous control of the vehicle should cease comprises predicting, using a particular machine learning model, that conditions on an upcoming section of the path plan presents difficulties to autonomous driving during the upcoming section.

Example 941 includes any one of Examples 937-940, the one or more processors to determine that autonomous control of the vehicle should cease based on detection of one or more compromised sensors of the vehicle.

Example 942 includes any one of Examples 937-941, the one or more processors to determine that no qualified passengers are present within the vehicle, wherein the handoff request is sent based at least in part on determining that no qualified passengers are present.

Example 943 includes any one of Examples 937-942, the one or more processors to send the sensor data to the remote computing system to present a dynamic representation of surroundings of the vehicle to a user of the remote computing system.

Example 944 includes the apparatus of Example 943, wherein the sensor data comprises video data.

Example 945 includes any one of Examples 937-944, the one or more processors to communicate an alert for consumption by passengers of the vehicle to identify that control of the vehicle is handed over to the remote valet service.

Example 946 includes the apparatus of any one of Examples 937-945, the one or more processors to detect a change in conditions along the path plan; and restore control of the driving of the vehicle from the remote valet service to autonomous driving logic of the vehicle.

Example 947 is a method comprising autonomously controlling driving of a vehicle according to a path plan based on sensor data generated from a set of sensors of a vehicle; determining that autonomous control of the vehicle should cease; sending a handoff request to a remote computing system, wherein the remote computing system provides a remote valet service; receiving driving instruction data from the remote computing system; and controlling driving of the vehicle based on instructions included in the driving instruction data.

Example 948 includes the method of Example 947, wherein the driving instruction data is generated based on inputs of a human user at the remote computing system.

Example 949 includes the method of any one of Examples 947-948, further comprising detecting a pull-over event, wherein the vehicle is to pull-over and cease driving in association with the pull-over event, wherein the handoff request is sent in response to the pull-over event.

Example 950 includes the method of any one of Examples 947-948, wherein determining that autonomous control of the vehicle should cease comprises predicting, using a particular machine learning model, that conditions on an upcoming section of the path plan presents difficulties to autonomous driving during the upcoming section.

Example 951 includes the method of any one of Examples 947-950, wherein it is determined that autonomous control of the vehicle should cease based on detection of one or more compromised sensors on the vehicle.

Example 952 includes the method of any one of Examples 947-951, further comprising determining that no qualified passengers are present within the vehicle, wherein the handoff request is sent based at least in part on determining that no qualified passengers are present.

Example 953 includes the method of any one of Examples 947-952, further comprising sending the sensor data to the remote computing system to present a dynamic representation of surroundings of the vehicle to a user of the remote computing system.

Example 954 includes the method of Example 953, wherein the sensor data comprises video data.

Example 955 includes any one of Examples 947-954, further comprising presenting an alert for consumption by passengers of the vehicle to identify that control of the vehicle is handed over to the remote valet service.

Example 956 includes the method of any one of Examples 947-955, further comprising detecting a change in conditions along the path plan; and restoring control of the driving of the vehicle from the remote valet service to autonomous driving logic of the vehicle.

Example 957 includes a system comprising means to autonomously control driving of a vehicle according to a path plan based on sensor data generated from a set of sensors of a vehicle; means to determine that autonomous control of the vehicle should cease; means to send a handoff request to a remote computing system, wherein the remote computing system provides a remote valet service; means to receive driving instruction data from the remote computing system; and means to control driving of the vehicle based on instructions included in the driving instruction data.

Example 958 includes the system of Example 957, wherein the driving instruction data is generated based on inputs of a human user at the remote computing system.

Example 959 includes the system of any of Examples 957-958, further comprising means to detect a pull-over event, wherein the vehicle is to pull-over and cease driving in association with the pull-over event, wherein the handoff request is sent in response to the pull-over event.

Example 960 includes the system of Example 957, wherein determining that autonomous control of the vehicle should cease comprises predicting, using a particular machine learning model, that conditions on an upcoming section of the path plan presents difficulties to autonomous driving during the upcoming section.

Example 961 includes a computer-readable medium to store instructions, wherein the instructions, when executed by a machine, causes the machine to perform: autonomously controlling driving of a vehicle according to a path plan based on sensor data generated from a set of sensors of a vehicle; determining that autonomous control of the vehicle should cease; sending a handoff request to a remote computing system, wherein the remote computing system provides a remote valet service; receiving driving instruction data from the remote computing system; and controlling driving of the vehicle based on instructions included in the driving instruction data.

Example 962 includes a method comprising providing a user interface for a human user at a computing terminal device; receiving a handoff request from a vehicle configured to autonomously drive; receiving sensor data from remote sensor devices describing an environment around the vehicle; presenting a representation of the environment on the user interface based on the sensor data; receiving user inputs at the computing terminal device responsive to the representation, wherein the user inputs comprise inputs to direct driving of the vehicle within the environment; and sending instruction data to the vehicle corresponding to the user inputs to remotely drive the vehicle according to the user inputs.

Example 963 includes the method of Example 962, wherein the handoff request identifies a location of the vehicle.

Example 964 includes the method of Example 963, further comprising determining sensor devices corresponding to the location, wherein the sensor devices are external to the vehicle; and accessing supplemental sensor data from the sensor devices, wherein the representation is presented based at least in part on the supplemental sensor data.

Example 965 includes the method of any one of Examples 962-964, wherein the sensor devices comprise sensor devices on the vehicle.

Example 966 includes the method of any one of Examples 962-965, wherein the sensor devices comprise sensor devices separate from the vehicle.

Example 967 includes the method of any one of Examples 962-966, further comprising receiving a request from the vehicle to return control of the driving of the vehicle to the vehicle; sending a confirmation to the vehicle of the return of control; and ceasing transmission of the instruction data to the vehicle.

Example 968 includes the method of any one of Examples 962-966, further comprising generate reporting data describing the environment and performance of the vehicle based on the user inputs during control of the vehicle by the remote valet service; and sending the reporting data to a cloud-based system.

Example 969 includes a system comprising means to perform the method of any one of Examples 962-968.

Example 970 includes the system of Example 969, wherein the means comprise a computer-readable medium to store instructions, wherein the instructions, when executed by a machine, causes the machine to perform at least a portion of the method of any one of Examples 962-968.

Example 971 includes a method comprising generating sensor data from a set of sensors on a vehicle; determining a path plan for the vehicle; autonomously controlling driving of the vehicle according to the path plan based on one or more machine learning models and the sensor data; identifying conditions on an upcoming portion of the path plan; determining an opportunity to handoff control of the driving of the vehicle to a remote valet service based on the conditions; sending a handoff request to a remote computing system based on the opportunity, wherein the remote computing system provides the remote valet service; receiving driving instruction data from the remote computing system; and automating driving of the vehicle responsive to instructions included in the instruction data.

Example 972 includes the method of Example 971, further comprising sending report data to another computing system identifying the handoff and the conditions corresponding to the handoff.

Example 973 includes the method of Example 972, wherein the report data is sent to a cloud-based application.

Example 974 includes the method of any one of Examples 972-973, wherein the report data is sent to a roadside unit.

Example 975 includes the method of any one of Examples 971-974, wherein the conditions are identified from data received from another computing system.

Example 976 includes the method of Example 975, wherein the conditions are identified through application of a machine learning model and the data from the other system is provided as an input to the machine learning model.

Example 977 includes the method of Example 976, wherein the machine learning model is trained based on data reporting other instances of either a handoff to a remote valet service or a pull-over event.

Example 978 includes the method of any one of Examples 971-977, wherein the handoff request is sent to avoid a pull-over event.

Example 979 includes the method of any one of Examples 971-978, wherein the opportunity corresponds to a prediction that autonomous driving functionality of the vehicle will perform poorly in light of the conditions.

Example 980 includes the method of any one of Examples 971-979, wherein the opportunity is determined based at least in part on information included in the sensor data.

Example 981 includes the method of any one of Examples 971-980, further comprising accessing additional data; predicting an improvement in conditions on another portion of the path plan following the upcoming path based on the additional data; and sending request data to the remote computing system to request control to be returned to the vehicle based on the predicted improvement in conditions; and resuming autonomously control of the driving of the vehicle.

Example 982 includes the method of any one of Examples 971-981, wherein determining the opportunity to handoff control comprises detecting a pullover event.

Example 983 includes the method of Example 982, further comprising determining conditions from the sensor data associated with the pullover event; and uploading data describing the conditions to a remote computing system.

Example 984 includes a system comprising means to perform the method of any one of Examples 971-983.

Example 985 includes the system of Example 984, wherein the means comprise a computer-readable medium to store instructions, wherein the instructions, when executed by a machine, causes the machine to perform at least a portion of the method of any one of Examples 971-983.

Example 986 is a method that includes obtaining sensor data from a sensor coupled to an autonomous vehicle; applying a sensor abstraction process to the sensor data to produce abstracted scene data, wherein the sensor abstraction process includes one or more of: applying a response normalization process to the sensor data; applying a warp process to the sensor data; and applying a filtering process to the sensor data; and using the abstracted scene data in a perception phase of a control process for the autonomous vehicle.

Example 987 includes the subject matter of Example 986, where sensor data includes first sensor data from a first sensor and second sensor data from a second sensor, wherein the first sensor and second sensor are of the same sensor type, and applying the sensor abstraction process comprises one or more of: applying a respective response normalization process to each of the first sensor data and the second sensor data; applying a respective warping process to each of the first sensor data and the second sensor data; and applying a filtering process to a combination of the first sensor data and the second sensor data.

Example 988 includes the subject matter of Example 986, wherein the sensor data includes first sensor data from a first sensor and second sensor data from a second sensor, wherein the first sensor and second sensor are different sensor types, and applying the sensor abstraction process comprises one or more of: applying a respective response normalization process to each of the first sensor data and the second sensor data; applying a respective warping process to each of the first sensor data and the second sensor data; and applying a respective filtering process to each of the first sensor data and the second sensor data to produce first abstracted scene data corresponding to the first sensor data and second abstracted scene data corresponding to the second sensor data; and the method further comprises applying a fuse process to the first and second abstracted scene data; wherein the fused first and second abstracted scene data are used in the perception phase.

Example 989 includes the subject matter of any one of Examples N1-988, where applying a response normalization process comprises one or more of normalizing pixel values of an image, normalizing a bit depth of an image, normalizing a color space of an image, and normalizing a range of depth or distance values in lidar data.

Example 990 includes the subject matter of any one of Examples 986-988, where applying a response normalization process is based on a model of the sensor response.

Example 991 includes the subject matter of any one of Examples 986-988, where applying a warping process comprises performing one or more of a spatial upscaling operation, a downscaling operation, a correction process for geometric effects associated with the sensor, and a correction process for motion of the sensor.

Example 992 includes the subject matter of any one of Examples 986-988, where applying a warping process is based on sensor configuration information.

Example 993 includes the subject matter of any one of Examples 986-988, where applying a filtering process comprises applying one or more of a Kalman filter, a variant of the Kalman filter, a particle filter, a histogram filter, an information filter, a Bayes filter, and a Gaussian filter.

Example 994 includes the subject matter of any one of Examples 986-988, where applying a filtering process is based on one or more of a model for the sensor and a scene model.

Example 995 includes the subject matter of any one of Examples 986-988, where applying a filtering process comprises determining a validity of the sensor data and discarding the sensor data in response to determining that the sensor data is invalid.

Example 996 is an apparatus that includes memory and processing circuitry coupled to the memory to perform one or more of the methods of Examples 986-995.

Example 997 is a system comprising means for performing one or more of the methods of Examples 986-995.

Example 998 is a product comprising one or more tangible computer-readable non-transitory storage media comprising computer-executable instructions operable to, when executed by at least one computer processor, enable the at least one computer processor to implement operations of the methods of Examples 986-995.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1.-50. (canceled)

51. At least one non-transitory machine-readable storage medium with instructions stored thereon, the instructions when executed by a machine to cause the machine to:
receive sensor data from a plurality of sensors, wherein the plurality of sensors comprises a first set of sensors and a second set of sensors, and at least a portion of the plurality of sensors are coupled to a vehicle;
automate control of the vehicle, using a processor in the vehicle, based on at least a portion of the sensor data generated by the first set of sensors;
determine, using a processor in the vehicle, passenger attributes of one or more passengers within the autonomous vehicle from sensor data generated by the second set of sensors; and
modify vehicle attributes of the vehicle based on the passenger attributes and the sensor data generated by the first set of sensors.

52. The storage medium of claim 51, wherein automatic control of the vehicle comprises determining a first path of the vehicle, and modifying the vehicle attributes based on the passenger attributes to change the first path to a second path and subsequent automated control of the vehicle to be based on the second path.

53. The storage medium of claim 51, wherein the vehicle attributes comprise physical attributes of a cabin of the vehicle and the passengers are within the cabin.

54. The storage medium of claim 53, wherein the cabin comprises one or more devices configured to facilitate comfort of the passengers and modifying the vehicle attributes comprises autonomously adjusting the one or more devices.

55. The storage medium of claim 51, wherein modifying the vehicle attributes comprises presenting a recommendation to the passengers using a user interface device based on a navigation plan associated with automated control of the vehicle and the passenger attributes.

56. The storage medium of claim 55, wherein the recommendation comprises a recommendation to change a destination or a route of the vehicle based on the passenger attributes.

57. The storage medium of claim 51, wherein the passenger attributes comprise attributes affecting comfort, preferences, or needs of the one or more passengers within the vehicle.

58. The storage medium of claim 51, wherein automated control of the vehicle is determined using a first machine learning model and the passenger attributes are determined using a second machine learning model.

59. The storage medium of claim 51, wherein the vehicle attributes comprise a driving style to be realized through the automated control of the vehicle, and modifying the vehicle attributes changes the driving style based on the passenger attributes.

60. The storage medium of claim 51, wherein the first and second sets of sensors comprise at least one sensor in common.

61. The storage medium of claim 51, wherein at least one sensor of the first and second sets of sensors is extraneous to the vehicle.

62. The storage medium of claim 51, wherein the instructions are further executable to cause the machine to:
determine identity of one or more of the passengers based on sensor data from the second set of sensors; and
access preference information corresponding to the identities of the one or more passengers, wherein the passenger attributes comprise the preference information.

63. The storage medium of claim 51, wherein the passenger attributes describe human attributes of the passengers.

64. The storage medium of claim 63, wherein the passengers comprise a plurality of passengers and the human attributes comprise combined attributes of a group of passengers comprising the plurality of passengers, and the vehicle attributes are modified based on the combined attributes.

65. The storage medium of claim 51, wherein the instructions are further executable to cause the machine to:
send particular sensor data comprising data from the first set of sensors or the second set of sensors over a wireless communication channel to a remote computing system; and
receive recommendation data from the remote computing system based on the particular sensor data, wherein the vehicle attributes are modified based on the recommendation data.

66. A method comprising:
receiving sensor data from a plurality of sensors, wherein the plurality of sensors comprises a first set of sensors and a second set of sensors, and at least a portion of the plurality of sensors are coupled to a vehicle;
automating control of the vehicle, using a data processor on the vehicle, based on at least a portion of the sensor data generated by the first set of sensors;
determining, using a data processor on the vehicle, passenger attributes of one or more passengers within the autonomous vehicles from sensor data generated by the second set of sensors; and
modifying vehicle attributes of the vehicle based on the passenger attributes and the sensor data generated by the first set of sensors.

67. The method of claim 66, wherein automatic control of the vehicle comprises determining a first path of the vehicle, and modifying the vehicle attributes based on the passenger attributes causes the first path to be changed to a second path and subsequent automated control of the vehicle to be based on the second path.

68. The method of claim 66, wherein the vehicle attributes comprise physical attributes of a cabin of the vehicle and the passengers are within the cabin.

69. The method of claim 66, wherein modifying the vehicle attributes comprises presenting a recommendation to the passengers using a presentation device based on a path determined in association with automated control of the vehicle and the passenger attributes.

70. The method of claim 66, wherein the vehicle attributes comprise a driving style to be realized through the automated control of the vehicle, and modifying the vehicle attributes causes the driving style to be changed based on the passenger attributes.

71. A method comprising:
receiving first sensor data generated by a first set of sensors, wherein the first sensor data identifies attributes of a driving environment;
receiving second sensor data generated by a second set of sensors, wherein the second sensor data identifies attributes of a set of passengers within a particular vehicle in the driving environment;
determining a recommendation based on the first sensor data and second sensor data; and
sending recommendation data, via a wireless communication channel, to an on-board computing system of the particular vehicle, wherein the recommendation data identifies the recommendation and is consumable by the on-board computing system to affect operation of the particular vehicle.

72. The method of claim 71, wherein the first set of sensors comprises one or more sensors integrated on the particular vehicle.

73. The method of claim 71, wherein the first set of sensors comprises one or more sensors extraneous to the particular vehicle.

74. The method of claim 73, further comprising:
determining a location of the particular vehicle;
identifying one or more particular sensors in the location; and
accessing particular sensor data from the particular sensors, wherein the first sensor data comprises the particular sensor data.

75. The method of claim 74, wherein the first set of sensors comprise one or more sensors external to the particular vehicle.

76. The method of claim 71, further comprising determining, from the second sensor data, one or more profiles associated with the set of passengers, wherein the recommendation is based on the one or more profiles.

77. The method of claim 71, wherein the recommendation is consumable by the on-board computing system to cause the on-board computing system to change automated control of the particular vehicle based on the recommendation.

78. The method of claim 77, wherein the change in the automated control causes the vehicle to change from a first driving style to a second driving style based on the recommendation.

79. A system comprising:
an on-board computing system for a vehicle, wherein the on-board computing system comprises processor hardware, wherein the processor hardware comprises machine-learning hardware;
a set of local sensors;
a set of actuators; and
a recommendation system executable by the processor hardware to:
identify first sensor data to describe driving conditions in an environment, wherein the vehicle is positioned in or near the environment, wherein the on-board computing system uses the first sensor data to automate control of the vehicle;
identify second sensor data, wherein at least a portion of the second sensor data is generated by the set of local sensors;
determine, from the second sensor data, one or more passenger attributes of a set of passengers within the vehicle;
determine a recommendation for the on-board computing system based on the first and second sensor data;
wherein the on-board computing system is to consume the recommendation to actuate one or more of the set of actuators to change conditions of the vehicle.

80. The system of claim 79, wherein the one or more actuators comprise actuators to control one of steering, acceleration, or braking of the vehicle.

81. The system of claim 80, wherein the on-board computing system comprises a path planning engine to:
determine a first path plan for the vehicle; and
augment the first path plan to form a different, second path plan for the vehicle based on the recommendation.

82. The system of claim 79, wherein the one or more actuators comprises actuators to adjust physical conditions within a cabin of the vehicle, wherein the passengers ride within the cabin of the vehicle.

83. The system of claim 79, wherein the recommendation system is to:
communicate over a wireless communication channel with a remote computing system; and
receive recommendation data from the remote computing system, wherein the recommendation is determined based further on the recommendation data.
